(19) United States
(12) Patent Application Publication
(10) Pub. No.: US 2026/0124112 A1
(43) Pub. Date: May 7, 2026

(54) Systems, Methods, and Apparatuses for Producing and Packaging Medical Fluids

(71) Applicant: DEKA Products Limited Partnership, Manchester, NH (US)

(72) Inventors: Jason M. Overson, Manchester, NH (US); Robert Salisbury, Brookfield, NH (US); Billie J. Strong, Northfield, NH (US); Gillian R. Cohen, Kalamazoo, MI (US); Robert Piccirillo, Salem, NH (US); Martin Klein, Hallein (AT); Rupert Gschwendtner, Bad Reichenhall (DE); Thaddeus J. Hughes, Shirley, IL (US)

(21) Appl. No.: 19/438,893

(22) Filed: Jan. 2, 2026

Related U.S. Application Data
(63) Continuation of application No. 19/223,918, filed on May 30, 2025.
(60) Provisional application No. 63/677,620, filed on Jul. 31, 2024.
(60) Provisional application No. 63/775,493, filed on Mar. 21, 2025.
(60) Provisional application No. 63/775,457, filed on Mar. 21, 2025.
(60) Provisional application No. 63/775,455, filed on Mar. 21, 2025.

(51) Int. Cl. A61J 1/10; A61J 1/14

(52) U.S. Cl. CPC A61J 1/10; A61J 1/1456

(57) ABSTRACT

A system for packaging fluid into a reservoir may comprise a fluid production assembly. The system may further comprise a reservoir chain dispenser and an enclosure having a plurality of compartments. A first compartment may include an infeed aperture. The system may further comprise a dispenser interface including an outlet cover retainer displaceable between a stowed position and an infeed aperture plugging position. The system may further comprise a reservoir singulation assembly. The system may further comprise a filling assembly including cartridge having an inlet in communication with the fluid production assembly and outlet including a sharp. The cartridge may be at least partially in the first compartment. The system may further comprise a second and third compartment. The system may further comprise a particulate inspection system and a marking assembly. The system may further comprise an outfeed assembly including a first and second array of receptacles.

### CROSS-REFERENCE TO RELATED APPLICATIONS

The present application is a Continuation of U.S. patent application Ser. No. 19/223,918, filed May 30, 2025, and entitled Systems, Methods, and Apparatuses for Producing and Packaging Medical Fluids (Attorney Docket No. 00101.00509.AB781) which claims the benefit of U.S. Provisional Application Ser. No. 63/677,620, entitled System for and Method of Detecting and Differentiating Particulates, filed Jul. 31, 2024 (Attorney Docket No. 00101.00507.AB522), and claims the benefit of U.S. Provisional Application Ser. No. 63/775,493, entitled Systems, Methods, and Apparatuses for Producing and Packaging Medical Fluids, filed Mar. 21, 2025 (Attorney Docket No. 00101.00465.AB670), and claims the benefit of U.S. Provisional Application Ser. No. 63/775,457, entitled Systems, Methods, and Apparatuses for Producing and Packaging Medical Fluids, filed Mar. 21, 2025 (Attorney Docket No. 00101.00336.AA849), and claims the benefit of U.S. Provisional Application Ser. No. 63/775,455, entitled Systems, Methods, and Apparatuses for Producing and Packaging Medical Fluids, filed Mar. 21, 2025 (Attorney Docket No. 00101.00335.AA829) each of the above being incorporated by reference herein in their entireties.

### STATEMENT REGARDING FEDERALLY SPONSORED RESEARCH OR DEVELOPMENT

This invention was made with Government support under Agreement HHSO100201900017C, awarded by the U.S. Department of Health and Human Services. The Government has certain rights in the invention.

This invention was made with Government support under Agreement N00014-23-9-0001, awarded by The Office of Naval Research. The Government has certain rights in the invention.

### BACKGROUND

### Field of Disclosure

This disclosure relates to medical fluids. More specifically, this disclosure relates to the generation and packaging of medical fluids.

### Description of Related Art

Almost every hospitalized patient is administered saline or a saline based solution. As a result, the quantity of saline solution consumed is very large. More than a billion bags of saline are used per year in the US alone. Despite the demand, there are only a small number of different saline manufactures which provide this solution for the US market. Unfortunately, manufacturing challenges which limit production from one manufacturer can and do cause shortages of saline in the United States. Compounding the issue, these manufactures have uneven market share in regards to all bagged saline products. For instance, 50% of 250 ml or smaller saline bags are provided by a single manufacture. As a result, when such a manufacturer faces production problems, the impact on the availability of that particular type of bag is much greater.

Most recently, the media spotlight has been shown on delays caused in the wake of hurricane Maria which have led to a shortage of small volume saline bags. According to the American Society of Health-System Pharmacists, shortages for large volume bags and bags of saline for irrigation purposes also currently exist. An alternative means of producing medical fluid bags which may perhaps be locatable in the institution using the bag would be desirable.

### SUMMARY

In accordance with an embodiment of the present disclosure, a multi-compartment reservoir for medical agent may comprise a first and second sheet of material sealed to one another at a peripheral seal to define an interior volume of the bag. The reservoir may further comprise a first port and a second port coupled into the peripheral seal. Each of the first port and second port may define an interior flow path in communication with the interior volume. Each of the first port and second port may have a set of projections extending therefrom and at least partially surrounding the respective port. The reservoir may further comprise a first compartment in fluid communication with the ports. The first compartment may be collapsed and devoid of contents. The reservoir may further comprise a second compartment containing a concentrate. The reservoir may further comprise a frangible partition separating the first and second compartment. The first and second sheet may be coupled together to form the frangible partition. The frangible portion may be curved such that a central region of the frangible portion is most distal to the portion of the peripheral seal into which the first and second port are coupled.

In some embodiments, the portion of the frangible partition most distal the peripheral seal into which the first and second port are coupled may be disposed 5-40% of the length of the reservoir from the peripheral seal into which the ports are coupled. In some embodiments, a capacity of the second compartment may be greater than a volume of the concentrate disposed in the second compartment. In some embodiments, the second compartment may be filled with an at least partially liquid concentrate. In some embodiments, the at least partially liquid concentrate may be selected from a list consisting of saline brine, sodium chloride brine, sugar solution, dialysate concentrate, sugar and saline solution, Ringer's solution concentrate, lactated Ringer's solution concentrate, Hartmann's solution concentrate, saturated solution, supersaturated solution, and unsaturated solution. In some embodiments, the second compartment may be filled with a solid concentrate. In some embodiments, the solid concentrate may be a concentrate for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the solid concentrate may be selected from a list consisting of, powder, lyophilized medical agent, crystalline concentrate, salt concentrate, sodium chloride concentrate, sugar concentrate, dextrose concentrate. In some embodiments, the projections in each set of projections may be ribs. In some embodiments, the set of projections extending from each port may include at least one first projection and at least one second projection. The at least one second projection may be offset from the at least one first projection along an axial dimension of the port. In some embodiments, the set of projections extending from the first port may be monolithically formed with the first port and the second of projections extending from the second port are monolithically formed with the second port. In some embodiments, the set of projections on each of the first port and the second port may be included on a ribbing clip coupled to the first and second port. In some embodiments, the set of projections on each of the first port and the second port may be included on sets of ribbed rings coupled to each of the first and second ports. In some embodiments, the first and second port may be formed of a rigid plastic. In some embodiments, the first port may include a septum disposed in an end of the port most distal the interior volume. In some embodiments, the second port may include a stopper with a spike receptacle, the stopper disposed in an end of the port most distal the interior volume. In some embodiments, the reservoir may further comprise a third compartment at an end of the reservoir opposite the first and second port. The third compartment may be segregated from the second compartment by another frangible partition. The third compartment may be collapsed and devoid of content. In some embodiments, the peripheral seal may include a first thickened region on one side of the reservoir and a second thickened regions on the opposing side of the reservoir. The frangible partition may extend from the first thickened region to the second thickened region.

In accordance with another embodiment of the present disclosure a concentrate containing reservoir for medical agent may comprise a first and second sheet of material sealed to one another at a peripheral seal to define an interior volume of the bag. The first and second sheet of material may be permeable to a solvent. The reservoir may further comprise a first port and a second port coupled into the peripheral seal. Each of the first port and second port may define an interior flow path in communication with the interior volume. The reservoir may further comprise an at least partially solid concentrate within the interior volume. The at least partially solid concentrate may be particulate free and formed within the interior volume from a filtered liquid concentrate at least one solute and the solvent.

In some embodiments, each of the first port and second port may have a set of projections extending therefrom and at least partially surrounding the respective port. In some embodiments, the projections in each set of projections may be ribs. In some embodiments, the set of projections extending from each port may include at least one first projection and at least one second projection. In some embodiments, the at least one second projection may be offset from the at least one first projection along an axial dimension of the port. In some embodiments, the set of projections extending from the first port may be monolithically formed with the first port and the second of projections extending from the second port are monolithically formed with the second port. In some embodiments, the set of projections on each of the first port and the second port may be included on one of a list consisting of a ribbing clip coupled to the first and second port and sets of ribbed rings coupled to each of the first and second ports. In some embodiments, the first and second port may be formed of a rigid plastic. In some embodiments, the at least partially solid concentrate may include a saturated solution and one or more crystallized bodies formed of a constituent of the concentrate. In some embodiments, the at least partially solid concentrate may be a number of crystallized bodies. In some embodiments, the at least partially solid concentrate may be concentrate for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the at least partially solid concentrate may include a liquid selected from a list consisting of saline brine, sodium chloride brine, sugar solution, dialysate concentrate, sugar and saline solution, Ringer's solution concentrate, lactated Ringer's solution concentrate, and Hartmann's solution concentrate. In some embodiments, the interior volume of the reservoir may include a frangible partition separating a first compartment in fluid communication with the ports from a second compartment. The first and second sheet may be coupled together to form the frangible partition. The at least partially solid concentrate being may be included in the second compartment. In some embodiments, the frangible portion may be curved such that a central region of the frangible portion is most distal to the portion of the peripheral seal into which the first and second port are coupled. In some embodiments, the first compartment may be devoid of contents. In some embodiments, the reservoir may further comprise a third compartment at an end of the reservoir opposite the first and second port. The third compartment may be segregated from the second compartment by another frangible partition. The third compartment may be collapsed and devoid of contents.

In accordance with another example embodiment of the present disclosure a method of producing a medical reservoir containing an at least partially solid concentrate may comprise transferring a precursor solution through at least one filter and into an interior volume of the medical reservoir. The method may further comprise subjecting the medical reservoir to a controlled environment. The method may further comprise evaporating at least a portion of a solvent component from the precursor solution out of the medical reservoir through the material forming the medical reservoir. The method may further comprise at least partially recrystallizing at least one solute component of the precursory solution within the medical reservoir.

In some embodiments, the controlled environment may be temperature controlled. In some embodiments, the controlled environment may be humidity controlled. In some embodiments, subjecting the medical reservoir to a controlled environment may comprise maintaining the ambient temperature in the controlled environment at at least 50° C. In some embodiments, subjecting the medical reservoir to a controlled environment may comprise maintaining the ambient humidity in the controlled environment at no more than 15%. In some embodiments, the precursor solution may be a saturated solution. In some embodiments, the method may further comprise heating a solvent to a temperature set point and adding at least one solute to the solvent to create the precursor solution such that the precursor solution is a saturated solution at the temperature set point. In some embodiments, evaporating the solvent component from the precursor solution may comprise evaporating water from the precursor solution. In some embodiments, the precursor solution may be selected from a list consisting of a saline brine, a sodium chloride brine, a sugar solution, a saline and sugar solution, a dialysate precursor, a Ringer's solution concentrate, lactated Ringer's solution concentrate, and Hartmann's solution concentrate. In some embodiments, the method may further comprise terminally sterilizing the medical reservoir. In some embodiments, the method may further comprise placing a septum in a port of the medical reservoir. In some embodiments, subjecting the medical reservoir to the control environment may comprise orienting the medical reservoir such that at least one port of the medical reservoir is disposed at a top of the medical reservoir. In some embodiments, the method may further comprise isolating the precursor solution within a compartment of the interior volume by forming a frangible partition within the interior volume.

In accordance with another example embodiment of the present disclosure a method of producing a chain of medical reservoirs each containing an at least partially solid concentrate may comprise transferring a precursor solution through at least one filter and into an interior volume of each of the medical reservoirs. The method may further comprise subjecting the chain of medical reservoirs to a controlled environment. The method may further comprise evaporating at least a portion of a solvent component from the precursor solution out of each of the medical reservoirs through the material forming the respective medical reservoirs. The method may further comprise at least partially recrystallizing at least one solute component of the precursory solution within the each of the medical reservoirs.

In some embodiments, the controlled environment may be temperature controlled. In some embodiments, the controlled environment may be humidity controlled. In some embodiments, subjecting the medical reservoir to a controlled environment may comprise maintaining the ambient temperature in the controlled environment at at least 50° C. In some embodiments, subjecting the medical reservoir to a controlled environment may comprise maintaining the ambient humidity in the controlled environment at no more than 15%. In some embodiments, the precursor solution may be a saturated solution. In some embodiments, the method further comprises heating a solvent to a temperature set point and adding at least one solute to the solvent to create the precursor solution such that the precursor solution is a saturated solution at the temperature set point. In some embodiments, evaporating the solvent component from the precursor solution in the interior volume of each medical reservoir may comprise evaporating water. In some embodiments, the precursor solution may be selected from a list consisting of a saline brine, a sodium chloride brine, a sugar solution, a saline and sugar solution, a dialysate precursor, a Ringer's solution concentrate, lactated Ringer's solution concentrate, and Hartmann's solution concentrate. In some embodiments, the method may further comprise terminally sterilizing the chain of medical reservoirs. In some embodiments, the method may further comprise placing a septum in a port of the each of the medical reservoirs. In some embodiments, subjecting the chain of medical reservoirs to the control environment may comprise orienting the medical reservoirs such that at least one port of each of the medical reservoirs is disposed at a top of the respective medical reservoir. In some embodiments, the method may further comprise isolating the precursor solution within a compartment of the interior volume of each medical reservoir by forming a frangible partition within the interior volume of each medical reservoir.

In accordance with another example embodiment of the present disclosure a spool of medical reservoirs may comprise a lead medical reservoir. The spool may further comprise a terminal medical reservoir. The spool may further comprise a plurality of intermediate medical reservoirs coupled together in series. The spool may further comprise a tail. The spool may further comprise a spool body having a core and opposing end flanges. An end of the tail may be coupled to core. The lead medical reservoir may be coupled to a first of the plurality of intermediate reservoirs. The last of the plurality of intermediate reservoirs may be coupled to the terminal medical reservoir.

In some embodiments, each of the medical reservoirs may define an interior volume containing at least one concentrate. In some embodiments, each of the at least one concentrate may be selected from a list consisting of a saline brine, a sodium chloride brine, a sugar solution, a saline and sugar solution, a peritoneal dialysate precursor solution, a hemodialysis precursor solution, a Ringer's solution concentrate, lactated Ringer's solution concentrate, and Hartmann's solution concentrate, a powder, a lyophilized agent, a crystalline solid, a salt in crystalline form, crystalline sodium chloride, crystalline sugar, a solid dialysate precursor, a saturated solution, an unsaturated solution, an at least partially liquid concentrate, and an at least partially solid concentrate. In some embodiments, each of the medical reservoirs may define an interior volume separated into multiple internal compartments by at least one frangible partition. In some embodiments, each of the medical reservoirs may define an interior volume having a first compartment at least partially filled with a concentrate and at least one second compartment which is devoid of contents. In some embodiments, the tail may include at least one reservoir. In some embodiments, the lead reservoir, plurality of intermediate reservoirs, and terminal reservoir may be chained abreast of one another. In some embodiments, the lead reservoir, plurality of intermediate reservoirs, and terminal reservoir may be chained end to end. In some embodiments, the chain may include a coupling region between each of the medical reservoir. In some embodiments, the coupling region may include a weakened section. In some embodiments, each weakened section may include at least one score line. In some embodiments, each weakened section may include a series of perforations. In some embodiments, the coupling region may include a number of bridges. In some embodiments, a score line may be present between each of the medical reservoirs. In some embodiments, the chain may include at least 50 reservoirs. In some embodiments, each of the medical reservoirs may be a bag. In some embodiments, the spool of medical reservoirs may further comprise a tensioner assembly. The tensioner assembly may be engaged with an end flange of the spool body.

In accordance with another example embodiment of the present disclosure, a medical reservoir chain may comprise a lead medical reservoir. The chain may further comprise a terminal medical reservoir. The chain may further comprise a plurality of intermediate medical reservoir coupled in series abreast of one another. A first of the plurality of intermediate medical reservoirs may be coupled to the lead medical reservoir and a second of the plurality of intermediate reservoirs. A last of the plurality of intermediate reservoirs may be coupled to a penultimate of the intermediate reservoirs and the terminal medical reservoir. Each of the medical reservoirs may define an interior volume containing at least one concentrate.

In some embodiments, each of the medical reservoirs may be a bag. In some embodiments, each of the at least one concentrate may be selected from a list consisting of a saline brine, a sodium chloride brine, a sugar solution, a saline and sugar solution, a peritoneal dialysate precursor solution, a hemodialysis precursor solution, a Ringer's solution concentrate, lactated Ringer's solution concentrate, and Hartmann's solution concentrate, a powder, a lyophilized agent, a crystalline solid, a salt in crystalline form, crystalline sodium chloride, crystalline sugar, a solid dialysate precursor, a saturated solution, an unsaturated solution, an at least partially liquid concentrate, and an at least partially solid concentrate. In some embodiments, the interior volume of each of the medical reservoirs may be divided into multiple internal compartments by at least one frangible partition. In some embodiments, the interior volume of each of the medical reservoirs may include at least one first compartment which is devoid of contents and at least one second compartment at least partially filled with a concentrate. In some embodiments, the chain of medical reservoirs may include a coupling region between each of the medical reservoirs. In some embodiments, the chain of medical reservoirs may include a weakened section between each of the medical reservoirs. In some embodiments, the chain of medical reservoirs may include at least one score line between each of the medical reservoirs. In some embodiments, the chain of medical reservoirs may include a series of perforations between each of the medical reservoirs. In some embodiments, the chain of medical reservoirs may include at least 50 medical reservoirs.

In accordance with another example embodiment of the present disclosure, a dispenser of medical reservoirs may comprise a housing having an outlet. The dispenser may further comprise a cover assembly sealing the outlet and coupled to the housing via a lock assembly. The dispenser may further comprise a reel rotatable coupled within the housing. The dispenser may further comprise a chain of abreastly coupled medical bags coupled to the reel via a tail portion of the chain. The dispenser may further comprise a tensioner assembly coupled to the reel. The dispenser may further comprise a bag holder with a set of port retainers coupled thereto. A set of ports of a lead bag of the chain of medical bags may be retained in the set of port retainers.

In some embodiments, the dispenser may further comprise at least one handle. The handle may be coupled to the housing on a side of the housing opposite the outlet. In some embodiments, the housing may include at least one handle disposed on a side of the dispenser opposite the outlet. In some embodiments, the bag holder may be formed integrally with a portion of the housing. In some embodiments, a first side of the housing may include a first and second face. The first face may be substantially parallel to an opposing side of the housing. The second face may extend from an edge of the first face at an angle toward the opposing side of the housing. In some embodiments, the outlet may be disposed in the second face. In some embodiments, the cover assembly may include a backing plate with a sealing member, an overlay body, and a pair of lock bodies of the lock assembly captured between the backing plate and overlay body. In some embodiments, the overlay body may include a number of slits therethrough. Each slit may align with an aperture extending through one of the pair of lock bodies. In some embodiments, the cover assembly may include a set of guides, each lock body including a guide slot which accepts a respective guide of the set of guides. The lock bodies may be translationally displaceable between a retracted state in which the lock bodies are disposed adjacent one another to a deployed state in which the lock bodies are spread apart from one another. In some embodiments, each of the lock bodies may include a set of bolt projections. A terminal end of each bolt projection may have a ramped surface. In some embodiments, the dispenser may further comprise a rim surrounding the outlet. The rim may include a plurality of bolt retainers of the lock assembly and sealing member directly adjacent the outlet. In some embodiments, the port retainers may be displaceable relative to the bag holder. In some embodiments, the housing may include a flange. The flange may include a set of retaining apertures. In some embodiments, each of the medical bags may contain at least one concentrate selected from a list consisting of a saline brine, a sodium chloride brine, a sugar solution, a saline and sugar solution, a peritoneal dialysate precursor solution, a hemodialysis precursor solution, a Ringer's solution concentrate, lactated Ringer's solution concentrate, and Hartmann's solution concentrate, a powder, a lyophilized agent, a crystalline solid, a salt in crystalline form, crystalline sodium chloride, crystalline sugar, a solid dialysate precursor, a saturated solution, an unsaturated solution, an at least partially liquid concentrate, and an at least partially solid concentrate. In some embodiments, each of the medical bags may include an interior volume divided into multiple internal compartments by at least one frangible partition. In some embodiments, each of the medical bags may include an interior volume with at least one first compartment which is devoid of contents and at least one second compartment at least partially filled with a concentrate. In some embodiments, the chain may include a weakened section between each of the medical bags. In some embodiments, the chain may include at least one score line between each of the medical bags. In some embodiments, the chain may include a series of perforations between each of the medical bags. In some embodiments, the chain may comprise at least 50 medical bags. In some embodiments, the tail may include at least one medical bag.

In accordance with another example embodiment of the present disclosure a dispenser of medical reservoirs may comprise a housing having an outlet. The dispenser may further comprise a removable cover sealing the outlet. The dispenser may further comprise a reel rotatably coupled within the housing. The dispenser may further comprise a chain of abreastly coupled medical bags coupled to the reel. The dispenser may further comprise a bag holder with a set of port retainers coupled thereto. A set of ports of a lead bag of the chain may be retained in the set of port retainers.

In some embodiments, each of the medical bags may contain at least one concentrate selected from a list consisting of a saline brine, a sodium chloride brine, a sugar solution, a saline and sugar solution, a peritoneal dialysate precursor solution, a hemodialysis precursor solution, a Ringer's solution concentrate, lactated Ringer's solution concentrate, and Hartmann's solution concentrate, a powder, a lyophilized agent, a crystalline solid, a salt in crystalline form, crystalline sodium chloride, crystalline sugar, a solid dialysate precursor, a saturated solution, an unsaturated solution, an at least partially liquid concentrate, and an at least partially solid concentrate. In some embodiments, each of the medical bags may include an interior volume divided into multiple internal compartments by at least one frangible partition. In some embodiments, each of the medical bags may include an interior volume with at least one first compartment which is devoid of contents and at least one second compartment at least partially filled with a concentrate. In some embodiments, the chain may include a weakened section between each of the medical bags. In some embodiments, the chain may comprise at least 50 medical bags. In some embodiments, the dispenser may be no more than 10 kg. In some embodiments, a first side of the housing may include a first and second face. The first face may be substantially parallel to an opposing side of the housing. The second face may extend from an edge of the first face at an angle toward the opposing side of the housing. The outlet may be defined in the second face. In some embodiments, the reel may be coupled to a tensioner assembly. In some embodiments, the dispenser may be devoid of metallic components. In some embodiments, the cover assembly may include a sealing member. The sealing member may be held in compression against the housing by a lock assembly. In some embodiments, the dispenser may further comprise a plurality of bolt retainers surrounding the outlet and a sealing member disposed about the outlet. In some embodiments, the cover assembly may include a sealing body having an exterior face. The sealing body may have a sealing surface along the periphery of the exterior face.

In accordance with another example embodiment of the present disclosure a method of packaging medical agent into medical reservoirs may comprise feeding a chain of reservoirs from a dispenser into a processing compartment including a filling station. The method may further comprise segregating individual reservoirs from the chain. The method may further comprise filling the individual reservoirs at the filling station. The method may further comprise segregating a last consumable reservoir from a tail of the chain. The method may further comprise retracting the tail into the dispenser.

In some embodiments, the method may further comprise docking the dispenser to the processing compartment and unsealing the dispenser. In some embodiments, feeding the chain of reservoirs into the processing compartment may comprise unspooling the chain of reservoirs from a reel disposed within the dispenser. In some embodiments, the feeding the chain of reservoirs into the processing chamber may comprise tensioning a tensioner assembly of the dispenser and retracting the tail into the dispenser may comprise driving retraction of the tail with the tensioning assembly. In some embodiments, segregating individual reservoirs from the chain may comprise driving a splitter assembly of a reservoir individualizing assembly through a weakened region between a to-be-separated reservoir and a next reservoir on the chain. In some embodiments, segregating individual reservoirs from the chain may comprise tearing the individual reservoirs from the chain along weakened regions between reservoirs of the chain. In some embodiments, filling the individual reservoirs may comprise dispensing a diluent into the individual reservoirs. In some embodiments, filling the individual reservoirs may comprise puncturing a septum of each of the individual reservoirs with a dispensing sharp and dispensing a mass of excipient into each of the individual reservoirs based on a capacity of the respective reservoir and a concentrate in the respective reservoir. In some embodiments, the method may further comprise irradiating a septum of each of the individual reservoirs. In some embodiments, the medical reservoirs may be bags and the bags may be abreastly coupled together to form the chain.

In accordance with another example embodiment of the present disclosure, a fluid dispensing cartridge for a medical fluid dispenser may comprise a midbody having a filter support, a first side, and second side. The first side may include a first set of ribs, inlet walls, and a first filter support perimeter wall extending therefrom. The second side may include a second set of ribs, outlet walls, and a second filter support perimeter wall extending therefrom. The cartridge may further comprise a first cover body coupled to the first set of ribs, the inlet walls, and the first filter support perimeter wall. The first cover body may cooperate with the inlet walls to form an inlet flow path. The cartridge may further comprise a filter disposed intermediate the filter support and a filter capture projection of the first cover body. The cartridge may further comprise a second cover body coupled to the second set of ribs, the outlet walls, and the second filter support perimeter wall. The second cover body may cooperate with the outlet walls to form an outlet flow path. The cartridge may further comprise an irradiation transmissive barrier. The cartridge may further comprise an air flow channel defined by the midbody, at least one of the first and second cover body, and the irradiation transmissive barrier. The cartridge may further comprise a dispensing sharp coupled to a hub within the airflow channel. The dispensing sharp may be in fluid communication with the outlet flow path. The cartridge may further comprise a frangible bearing connection port in fluid communication with the inlet flow path.

In some embodiments, the dispensing sharp may be a pencil tipped sharp with two side ports disposed in opposition to one another. In some embodiments, the first and second cover body may be coupled to the midbody via laser weld. In some embodiments, the first and second cover body may be formed of transparent polymer and the midbody may be formed of a dark polymer. In some embodiments, the airflow channel may vary in cross-sectional area along the length of the air flow channel. In some embodiments, the irradiation transmissive barrier may be at least partially transparent to UVC light. In some embodiments, the irradiation transmissive barrier may be formed of fused quartz. In some embodiments, the airflow channel may extend along a straight line path through the housing and has a round cross-sectional shape. In some embodiments, the irradiation transmissive barrier may be captured within a barrier retention assembly defined by the midbody and at least one of the first and second cover body. In some embodiments, the connection port may have a first section having a first diameter and a second section having a second diameter smaller than the first. The second section may extend to a terminal end of the connection port and at least one sealing member may be disposed on the exterior surface of each of the first second and second section. In some embodiments, the outlet flow path may extend into communication with the filter support through a top portion of the second filter support perimeter wall. In some embodiments, the inlet walls may be continuous with the first filter support perimeter wall and the outlet walls are continuous with the second filter support perimeter wall. In some embodiments, the filter may be a 0.2 μm filter. In some embodiments, the filter support may be a grate. In some embodiments, the filter capture projection may include a sealing member on an end of the filter capture projection most distal to a main portion of the first cover body and a support wall aperture in fluid communication with the inlet flow path.

In accordance with another example embodiment of the present disclosure, a fluid dispensing cartridge for a medical fluid dispenser may comprise a housing assembly having a flow path extending therethrough. The cartridge may further comprise an inlet port. The cartridge may further comprise an irradiation transmissive barrier coupled to the housing assembly. The cartridge may further comprise an air flow channel extending through the housing assembly. The irradiation transmissive barrier may define at least a portion of the airflow channel. The cartridge may further comprise a dispensing sharp coupled to a hub within the airflow channel. The cartridge may further comprise a filter assembly captured within the housing. The cartridge may further comprise a housing sealing member. The cartridge may further comprise a cover coupled to the housing and an end of the cover compressing the housing sealing member and establishing a sealed volume surrounding the airflow channel.

In some embodiments, the dispensing sharp may be a pencil tipped sharp with two side ports disposed in opposition to one another. In some embodiments, the airflow channel may vary in cross-sectional area along the length of the air flow channel. In some embodiments, the irradiation transmissive barrier may be at least partially transparent to UVC light. In some embodiments, the airflow channel may extend along a straight line path through the housing and has a round cross-sectional shape. In some embodiments, a frangible may be coupled to a terminal end of the inlet port. There may be a plurality of sealing members disposed on the exterior surface of the inlet port. In some embodiments, the at least one filter may include a 0.2 μm filter. In some embodiments, a catch may extend from an exterior surface of the cover. In some embodiments, the cover may be engaged to the housing via a snap fit. In some embodiments, an end of the airflow channel may include at least one medical reservoir port guide.

In accordance with another example embodiment of the present disclosure, a fluid dispensing cartridge for a medical fluid dispenser may comprise a first body having an inlet flow path extending therethrough. The cartridge may further comprise a second body having an outlet flow path extending therethrough. The cartridge may further comprise a third body including a protruding central region surrounded by a peripheral region. The protruding central region may include a hub and an airflow channel segment. A supply flow path may extend through the third body to the hub. The cartridge may further comprise an inlet port. The cartridge may further comprise a filter assembly captured between the first and second body. The cartridge may further comprise a dispensing sharp coupled to the hub. The cartridge may further comprise an irradiation transmissive barrier. The cartridge may further comprise an airflow channel extending through the cartridge. The airflow channel segment and irradiation transmissive barrier may define at least a portion of the airflow channel. One end of the airflow channel may include at least one port guide. The cartridge may further comprise a sealing member coupled to the peripheral region.

In some embodiments, the dispensing sharp may be a pencil tipped sharp with at least one side port. In some embodiments, the airflow channel may vary in cross-sectional area along the length of the air flow channel. In some embodiments, the irradiation transmissive barrier may be at least 75% transmissive to UVC light. In some embodiments, the airflow channel may extend along a straight line path through the cartridge. In some embodiments, at least a first and second sealing member may be disposed on the exterior surface of the inlet port. A frangible may be coupled to a terminal end of the inlet port. The inlet port may be monolithically formed with the first body. In some embodiments, the irradiation transmissive barrier may be captured between the air flow channel segment and a medical reservoir port guide coupled to the third body on at an end of the irradiation transmissive barrier opposite the air flow channel segment. In some embodiments, the airflow channel may be sealed within a cap. In some embodiments, a catch may extend from an exterior surface of the cap. In some embodiments, the cap may be engaged to the third body via a snap fit. In some embodiments, the sealing member may be compressed against an end of the cap. In some embodiments, a peripheral most surface of the sealing member may be uncovered by the end of the cap and surrounds the end of the cap.

In accordance with another exemplary embodiment of the present disclosure a method of installing a fluid dispensing cartridge in a fill assembly for a medical reservoir may comprise placing a cartridge in a cartridge dock. The method may further comprise displacing housing of a cover removal assembly to a sealing position in which a housing sealing member of the housing is sealed around a fenestration in a processing compartment wall on a first side of the processing chamber wall. The method may further comprise displacing the cartridge dock to an access position in which an exposed region of a cover of the cartridge is displaced into an interior bay of the housing and a protrusion at an end of the exposed region is compressed against the housing sealing member. The method may further comprise establishing a seal around the fenestration on the second side of the processing compartment wall with a cartridge sealing member. The method may further comprise actuating a cover engagement assembly within the housing into engagement with the cover of the cartridge. The method may further comprise removing the cover from the cartridge by displacing the housing away from the cartridge.

In some embodiments, the method may further comprise supplying a negative pressure to the interior bay. In some embodiments, the method may further comprise verifying that the negative pressure is stable and at least at a negative pressure set point. In some embodiments, the method may further comprise displacing a clean air supply outlet against an end of an air channel extending through the cartridge. In some embodiments, the method may further comprise displacing an end of a priming line over a dispensing sharp of the cartridge. In some embodiments, the method may further comprise flowing a volume of priming fluid through the cartridge into the priming line. In some embodiments, the method may further comprise irradiating the end of the priming line with at least a predefined dose of UVC light. In some embodiments, actuating the cover engagement assembly may comprise driving a hook of the cover engagement assembly into a catch on the cover. In some embodiments, the method may further comprise positioning an inlet port of the cartridge in a first position within a receptacle of a supply manifold and passing a disinfection fluid through the receptacle and out of a drain flow path in communication with the receptacle. In some embodiments, the method may further comprise compromising a frangible of the inlet port with a spike in the receptacle and blocking flow from the spike to the drain flow path with a sealing member on the inlet port. In some embodiments, actuating the cover engagement assembly may comprise exerting a force on the cover which pulls the protrusion of the cover against the housing sealing member.

In accordance with another example embodiment of the present disclosure a filling assembly for medical reservoirs may comprise a compartment having a wall with a fenestration. The filling assembly may further comprise a cartridge loading assembly on a first side of the wall including fluid dispensing cartridge dock coupled to a dock actuator and displaceable via the dock actuator toward and away from the fenestration. The filling assembly may further comprise a cartridge cover removal assembly on a second side of the wall including a cover retainer coupled to a retainer actuator and displaceable via the retainer actuator toward and away from the fenestration. The cover retainer may define a bay with a cover engagement assembly disposed therein. The filling assembly may further comprise an air handling assembly in fluid communication with the compartment. The air handling assembly may include an air output magnetically coupled to an air output actuator through the wall of the compartment and displaceable between a retracted position and a deployed position in which the air output is at least partially within the compartment.

In some embodiments, the filling assembly may further comprise an irradiation assembly coupled to an irradiation assembly actuator on the second side of the wall. The irradiation assembly may be displaceable via the irradiation assembly actuator toward and away from the fenestration. In some embodiments, the irradiation assembly may include a plurality of UVC LEDs. In some embodiments, the filling assembly may further comprise a fluid supply manifold coupled to a supply manifold actuation assembly on the first side of the wall. In some embodiments, the cover retainer may include a sealing member surrounding an ingress to the bay. The sealing member may compress against the wall directly surrounding the fenestration when the cover retainer is displaced toward the fenestration to an end of its displacement range. In some embodiments, the ingress to the bay may have a cross-sectional area smaller than the cross-sectional area of the fenestration. A portion of the sealing member may be accessible through the fenestration from the first side of the wall when the cover retainer is at the end of its displacement range. In some embodiments, the cover retainer may include a negative pressure inlet coupled to a negative pressure source and a pressure sensor in fluid communication with the bay. In some embodiments, the cover removal assembly may include a hook operatively coupled to a pneumatic actuator and displaceable between a raised position and a deployed position. In some embodiments, the air handling assembly may include a blower, at least one filter, and at least one flow laminarizer. In some embodiments, the air output may include an internal bore having a variable cross-sectional area. In some embodiments, the air output may include an exterior sleeve having a first and second sleeve magnet coupled thereto and the air output actuator may include a yoke surrounding an air output guide formed by the wall. The yoke may include a first and second yoke magnet which are respectively aligned with the first and second sleeve magnets. In some embodiments, the air output may include an exterior sleeve with a magnetic body coupled thereto and at least one magnetic position sensor is disposed on an exterior of an air output guide formed by the wall. In some embodiments, the cartridge dock may comprise at least one cartridge detector. In some embodiments, each of the at least one cartridge detector may be selected from a group consisting of an optical sensor, a microswitch, an imager, a beam break sensor, and a reflective sensor. In some embodiments, the cartridge dock may include an asymmetric cartridge receptacle. In some embodiments, the filling assembly may include a fill displacement stage including a set of medical bag port retainers. The fill displacement stage may be coupled to a stage actuator and displaceable toward and away from the fenestration via the stage actuator.

In accordance with another example embodiment of the present disclosure a medical bag individualizing assembly for separating a medical bag from a chain of medical bags may comprise an actuator. The bag individualizing assembly may further comprise a displacement stage coupled to the actuator and displaceable through a displacement range via the actuator. The bag individualizing assembly may further comprise a splitter coupled to the displacement stage. The splitter may have a feed end and an opposing trailing end. The feed end may define a feed guide leading to a feed channel with first and second feed rollers on opposing sides thereof. The feed channel may furcate to a first and second branch which extend on opposite sides of a set of coaxial separating rollers and to the trailing end of the splitter. The first branch may be open to an upstream side of the splitter and the second branch may be open to a downstream side of the splitter.

In some embodiments, the feed guide may be defined by two oppositely sloped ramps at the feed end of the splitter. In some embodiments, the first and second feed roller may extend parallel to one another. In some embodiments, the set of separating rollers may include two separating rollers disposed abreast of one another on a common pivot bearing. In some embodiments, the set of separating rollers may include two separating rollers each of which extending across half of the feed channel. In some embodiments, each of the first and second branch may extend across 70-90% of the width of the splitter. In some embodiments, the actuator may include a ballscrew coupled to an electromechanical motor. In some embodiments, the medical bag individualizing assembly may further comprise a controller in data communication with the actuator. The actuator may be powered based on commands from the controller and the controller may generate a fault when a current draw from the electromechanical motor exceeds a threshold.

In accordance with another example embodiment of the present disclosure a method of mixing fluid in a medical bag may comprise placing a bag in a cradle of a bag retention assembly. The method may further comprise grasping ports of the bag with a grasper of the bag retention assembly. The method may further comprise closing a set of doors of the bag retention assembly. The method may further comprise rotating the bag retention assembly in opposing directions between preset pairs of rotational orientations. The method may further comprise dwelling in each preset rotational orientation for a dwell interval specific to each pair of positions.

In some embodiments, the method may further comprise dissolving a solid concentrate selected from a list consisting of powder, lyophilized medical agent, crystalline concentrate, salt concentrate, sodium chloride concentrate, normal saline concentrate, half normal saline concentrate, sugar concentrate, dextrose concentrate, a saline and sugar solution concentrate, D5 W concentrate, peritoneal dialysate concentrate, hemodialysis dialysate concentrate, Ringer's solution concentrate, lactated Ringer's solution concentrate, and Hartmann's solution concentrate. In some embodiments, the method may further comprise waiting a predefined period of time and analyzing the medical bag for the presence of particulates. In some embodiments, the method further may comprise reading an indicium on the medical bag and selecting a motion profile based on data read from the indicium. The motion profile may define the preset pairs of rotational orientations. In some embodiments, rotating the bag retention assembly may comprise rotating the bag retention assembly at a rotation rate specific to each pair of positions. In some embodiments, rotating the bag retention assembly may comprise rotating the bag retention assembly between each pair of preset positions a number of times specific to each pair of positions. In some embodiments, rotating the bag retention assembly may comprise inverting the bag retention assembly at least once. In some embodiments, each rotational orientation in each pair of rotational positions may be equal in magnitude from a starting orientation and opposite in direction. In some embodiments, closing the set of doors on the medical bag may comprise depressing a central region of the medical bag and displacing fluid laterally within the medical bag. In some embodiments, closing the set of doors on the medical bag may comprise contacting the medical bag with a gripping material on a surface of the doors. In some embodiments, the method may further comprise collecting a plurality of images of the medical bag and analyzing the plurality of images for indications of undissolved concentrate. The method may further comprise rotating the bag retention assembly in opposing directions at between at least one preset pair of rotational orientations when at least one indication of undissolved concentrate is detected.

In accordance with another example embodiment of the present disclosure a medical reservoir mixing assembly may comprise a bag retention assembly including a cradle and a reservoir holder assembly. The mixing assembly may further comprise a rotary actuator coupled the bag retention assembly. The mixing assembly may further comprise a rotation sensor configured to output a data signal indicative of the rotational orientation of the bag retention assembly. The mixing assembly may further comprise a controller in data communication with the rotation sensor and the rotary actuator and configured to orchestrate displacement of the bag retention assembly via the rotary actuator in opposing rotational directions between preset pairs of rotational orientations. The controller may be further configured to wait for a dwell timer to elapse at each rotational orientation.

In some embodiments, the reservoir holder assembly may include a set of doors each coupled to at least one door actuator. In some embodiments, the reservoir holder assembly may include a set of doors. Each door may have an inner face and an exterior face. At least a portion of the inner face may be covered with a gripping material. In some embodiments, the reservoir holder assembly may include a set of doors displaceable between an open state and a closed state. Each door may include a set of projections. The projections of the doors may interdigitate when the doors are in a closed state. In some embodiments, the projections may be more proximal a reservoir rest surface of the cradle than a section of the door from which they extend when the doors are in the closed state. In some embodiments, the reservoir holder assembly may include a set of IV bag port grippers actuatable between an open state and a closed state. In some embodiments, the mixing assembly may further comprise a reservoir indicium reader. The controller may be in data communication with the indicium reader and may select a motion profile defining the preset pairs rotational orientations based on data from the indicium reader. In some embodiments, the controller may be further configured to orchestrate displacement of the bag retention assembly at a rotation rate specific to each pair of positions of the preset pairs of positions. In some embodiments, the controller may be further configured to orchestrate displacement of the bag retention assembly to each preset pair of positions a number of times specific to each pair of positions. In some embodiments, one of the preset pairs of positions may orient the bag retention assembly in an inverted position. In some embodiments, each rotational orientation in each pair of rotational positions may be equal in magnitude from a starting orientation and opposite in direction. In some embodiments, the cradle may be illuminated and may include a pattern of light and dark regions. The mixing assembly may further comprise an external illuminator and at least one imager with a field of view at least partially encompassing the bag retention assembly.

In accordance with another example embodiment of the present disclosure a particulate inspection system for detecting and classifying contents of interest within a medical reservoir may comprise a cradle including a reservoir rest and a reservoir retainer. The cradle may include a backlight. The rest body may be in an illumination field of the backlight and may include a pattern of light and dark regions. The system may further comprise an external illuminator including at least light emitter. The system may further comprise a vision assembly disposed opposite the cradle. The vision assembly may include at least one imager having a field of view encompassing at least a portion of the cradle. The system may further comprise a controller in data communication with each of the at least one imager. The controller may be configured to command capture of a series of images from each of the at least one imager, receive the images, pre-process the images into processed images, detect regions of interest within the processed images, analyze the regions of interest, and classify the regions of interest into at least a first content type and second content type based on the analysis.

In some embodiments, the system may further comprise a rotary actuator coupled to the cradle. In some embodiments, the backlight may emit white light. In some embodiments, the pattern may be a chessboard pattern. In some embodiments, the reservoir retainer may be a set of IV bag port graspers actuatable between an open state and port retaining state. In some embodiments, the external illuminator may be an underlight. In some embodiments, the at least one light emitter may include a plurality of LEDs electrically coupled in series. In some embodiments, each of the at least one light emitter may be a collimated light emitter. In some embodiments, each of the at least one light emitter may emit light in a narrow beam angle less than 20°. In some embodiments, the external illuminator may include a polarizer. In some embodiments, each of the at least one image may include a polarizing filter on a lens thereof. In some embodiments, the vision system may includes a plurality of imagers. Each of the field of view of each imager may overlap the field of view of at least one other imager of the vision system. In some embodiments, the optical axis or viewing axis each of the at least one imager may be oriented at an angle 30-35° from a plane extending perpendicular to the height axis of the cradle. In some embodiments, the controller may be further configured to assign each region of interest in each of the processed images to one or more track. Each of the one or more track may define the displacement of an associated region of interest over the series of images. In some embodiments, for each track, the controller may be configured to extract an extracted portion of every processed image in which the associated region of interest is detected. The extracted portion may include the associated region of interest. The controller may be configured to analyze the regions of interest by analyzing the extracted portions of the processed images for each track. In some embodiments, the controller may be configured to analyze the regions of interest with a convolutional neural network. In some embodiments, the controller may be configured generate a reservoir acceptability determination. The acceptability determination may be indicated as a failure if any contents of interest are classified as the second content type. In some embodiments, the first content type may be a gas bubble and the second content type is anything other than a gas bubble. In some embodiments, the medical reservoir may be an IV bag.

In accordance with another example embodiment of the present disclosure a method of inspecting a medical reservoir may comprise placing the medical reservoir in a cradle. The method may further comprise providing a background on first side of the medical reservoir which contrasts between light and dark. The method may further comprise illuminating the medical reservoir with an illumination assembly separate from the cradle. The method may further comprise collecting at least one series of frames of the medical reservoir from at least one imager on a second side of the medical reservoir opposite the first. The method may further comprise processing each of the frames in the at least one series of images into a series of processed frames. The method may further comprise detecting regions of interest within each of the processed frames of the series of processed frames. The method may further comprise associating each of the detected regions of interest with tracks. Each track may define the displacement of a specific tracked region of interest over a plurality of processed frames. The method may further comprise analyzing the specific tracked region of interest in each processed frame for each track. The method may further comprise classifying the specific tracked region of interest for each track as one of at least a first content type and a second content type.

In some embodiments, placing the medical reservoir in the cradle may comprise placing an IV bag in the cradle. In some embodiments, the method may further comprise agitating the medical reservoir. In some embodiments, providing the background may comprise placing a pattern of light and black regions on a rest panel of the cradle. In some embodiments, providing the background may comprise adjusting a backlight on the first side of the medical reservoir to provide a background which provides a temporal contrast between light and dark. In some embodiments, illuminating the medical reservoir may comprise directing collimated light at the medical reservoir from an underlight. In some embodiments, illuminating the medical reservoir may comprise directing polarized light at the medical reservoir. In some embodiments, the at least one imager may include a plurality of imagers each having a field of view which at least partially overlaps that of at least one other imager of the plurality of imagers and collecting the at least one series of frames may comprise collecting a plurality of series of frames. Each plurality of series of frames may be captured from a respective imager of the plurality of imagers. In some embodiments, the method may further comprise providing a polarizing filter for each of the at least one imager. In some embodiments, processing each of the frames may comprise at least one of smoothing each of the frames, generating a foreground segmented image, generating a near edge filtered foreground segmented image based on an edge detection analysis of each frame, performing at least one kernel convolution, performing at least one morphological transformation, and removing pixel clusters having yielding a contour outside of a predefined size range. In some embodiments, detecting regions of interest within each of the processed frames may comprise generating a bounding box around each pixel cluster of interest remaining in the processed frames. In some embodiments, associating each of the detected regions of interest with tracks may comprise determining track predictions for each region of interest in a starting frame and matching the track predictions to detected regions of interest in a subsequent frame. In some embodiments, analyzing the specific tracked region of interest may comprise generating a region of interest score for the specific tracked region of interest in each processed frame of each track. In some embodiments, analyzing the specific tracked region of interest may comprise feeding an extracted portion of each processed frame of each track to a convolutional neural network. Each extracted portion of each processed frame including the specific tracked region of interest. In some embodiments, classifying the specific tracked region of interest for each track as one of at least the first content type and the second content type may further comprise classifying the specific tracked region of interest as at least one content subtype. In some embodiments, the method may further comprise generating an annotated image. In some embodiments, generating the annotated image may comprise depicting a representation of the displacement path of each specific tracked region of interest on a selected frame from each of the at least one series of frames.

In accordance with another example embodiment of the present disclosure, a method of inspecting a medical reservoir may comprise agitating the medical reservoir. The method may further comprise illuminating the medical reservoir with an external illuminator. The method may further comprise illuminating a patterned background on a first side of the reservoir. The method may further comprise capturing a plurality of raw frames of the medical reservoir from a second side of the medical reservoir. The method may further comprise processing, via at least one processor, the plurality of raw frames to create processed frames. The method may further comprise analyzing, via the at least one processor, the processed frames to identify detected pixel clusters of interest. The method may further comprise associating, via the at least one processor, the detected pixel clusters of interest with tracks indicative of the displacement of each pixel cluster of interest over the plurality of frames. The method may further comprise classifying, via the at least one processor, the pixel clusters of interest associated with each track as one of at least a first content type and a second content type.

In some embodiments, agitating the medical reservoir may comprise rotating the medical reservoir through a series of rotational orientations specified in a motion profile. In some embodiments, the method further may comprise generating a log including at least the raw frames and classifications for the pixel clusters of interest associated with each track and communicating the log to an external database. In some embodiments, illuminating the medical reservoir with the external illuminator may comprise directing collimated, polarized light in a preset wavelength range at the medical reservoir. In some embodiments, illuminating the medical reservoir with the external illuminator may comprise emitting light from a plurality of light emitters at the reservoir. Each light emitter may emit light in a narrow beam angle less than 20°. In some embodiments, illuminating the patterned background may comprise illuminating a rest surface for the medical reservoir. The rest surface may include a checkered pattern of light and dark regions. In some embodiments, capturing the plurality of raw frames may comprise capturing the plurality of raw frames with a plurality of imagers. Each imager may have a field of view which overlaps with the field of view of at least one other imager of the plurality of imagers. In some embodiments, processing the raw frames may comprise at least of generating a foreground mask, detecting edges in the raw frame, generating near edge filtered foreground segmented image from each raw frame, performing at least one morphological transformation, performing at least one kernel convolution, and performing a dilation convolution. In some embodiments, analyzing the processed frames to identify detected pixel clusters of interest may comprise at least one of identifying pixel clusters yielding a contour size outside of a predefined range, identifying pixel clusters which fail at least one predefined validity criteria, performing at least one morphological transformation, performing at least one kernel convolution, performing an erosion convolution, identifying pixel clusters which fail at least one predefined validity criteria, defining bounding boxes around pixel clusters of interest. In some embodiments, processing the raw frames may comprise generating a foreground segmented image from each raw frame, detecting edges in each raw frame and generating an edge image for each raw frame, generating a dilated edge image for each raw frame, generating a near edge filtered foreground segmented image from the foreground segmented image for each raw frame using the respective dilated edge image for each raw frame, and dilating each near edge filtered foreground segmented image. In some embodiments, analyzing the processed frames to identify detected pixel clusters of interest may comprise identifying pixel clusters in each dilated near edge filtered foreground segmented image which fail at least one predefined validity criteria, generated an eroded image from each dilated near edge filtered foreground segmented image in which the identified pixel clusters have been removed, defining bounding boxes around pixel clusters of interest in each eroded image. In some embodiments, associating the detected pixel clusters of interest with tracks may comprise determining track predictions for each detected pixel cluster of interest in a starting frame and matching the track predictions to detected pixel clusters of interest in a subsequent frame. In some embodiments, classifying the pixel clusters of interest associated with each track may comprise generating at least one score for the detected pixel clusters of interest associated with each track. In some embodiments, generating the at least one score may comprise generating at least one of a color score, a trajectory score, a shape score, and a sharpness score. In some embodiments, classifying the pixel clusters of interest associated with each track may comprise classifying the pixel clusters of interest associated with each track with a convolutional neural network trained on images of medical reservoirs with known contents. In some embodiments, classifying the pixel clusters of interest associated with each track may comprise classifying the pixel regions of interest associated with each track as at least one content subtype. In some embodiments, the method may further comprise generating an annotated image. In some embodiments, generating the annotated image may comprise depicting a representation of the displacement path of the pixel cluster of interest associated with each track on a selected frame of the plurality of raw frames. In some embodiments, the method may further comprise generating a pass indication for the medical reservoir when no pixel clusters of interest are classified as the second type and generating a fail indication for the medical reservoir when at least one pixel cluster of interest is classified as the second type. In some embodiments, the method may further comprise generating a troubleshooting suggestion when the fail indication is generated. In some embodiments, the method may further comprise detecting a pattern indicative of the patterned background being distorted by an air bubble in one of the plurality of raw frames and processed frames. In some embodiments, the medical reservoir may be a bag.

In accordance with another example embodiment of the present disclosure a particulate inspection system for detecting and classifying contents of interest within a medical reservoir may comprise a reservoir rest body having a pattern of light and dark regions. The system may further comprise a rest body backlight. The system may further comprise an external illuminator. The system may further comprise a vision assembly opposite the rest body. The vision assembly may include at least one imager. Each imager may have a field of view encompassing at least a portion of rest body. The system may further comprise a controller in data communication with each of the at least one imager. The controller may be configured to command capture of a series of images from each of the at least one imager, receive the images, process the images into processed images, detect regions of interest within the processed images, analyze the regions of interest, and classify the regions of interest as one of a bubble and something other than bubble.

In some embodiments, the system may further comprise a rotary actuator coupled to the rest body. In some embodiments, the rest body backlight may emit white light. In some embodiments, the pattern may be a checkered pattern. In some embodiments, the system may further comprises a reservoir retainer container coupled to reservoir rest body. The reservoir retainer may include a set of IV bag port graspers actuatable between an open state and port retaining state. In some embodiments, the external illuminator may be an underlight. In some embodiments, the external illuminator may include a plurality of LEDs electrically coupled in series. In some embodiments, the external illuminator may include a plurality collimated light emitters with a narrow beam angle less than 20°. In some embodiments, the external illuminator may include a polarizer. In some embodiments, each of the at least one imager may include a polarizing filter on a lens thereof. In some embodiments, the vision system may includes a plurality of imagers. Each field of view of each imager may overlap the field of view of at least one other imager of the vision system. In some embodiments, the view axis each of the at least one imager is oriented at an angle 30-35° from a plane extending perpendicular to the height axis of the rest body. In some embodiments, the controller may be further configured to assign each region of interest in each of the processed images to one or more track. Each of the one or more track may define the displacement of an associated region of interest throughout the plurality of processed images. In some embodiments, for each track, the controller may be configured to extract an extracted portion of every processed image in which the associated region of interest is detected. The extracted portion may include the associated region of interest. The controller may be configured to analyze the regions of interest by analyzing the extracted portions. In some embodiments, the controller may be configured to analyze the regions of interest with a convolutional neural network. In some embodiments, the controller may be configured generate a reservoir acceptability determination. The acceptability determination may be indicated as a failure if any contents of interest are classified as something other than a bubble. In some embodiments, the medical reservoir may be an IV bag.

In accordance with another example embodiment of the present disclosure a method of capturing images of a medical reservoir for inspection may comprise positioning a first side of the medical reservoir against a reservoir rest. The method may further comprise providing, with a first illuminator, a contrasting background for the medical reservoir. The method may further comprise illuminating the medical reservoir with a second illuminator which emits collimated, polarized light in at least one predefined wavelength range. The method may further comprise capturing a plurality of images of the medical reservoir with at least one imager on a second side of the medical reservoir opposite the first side. Each of the at least one imager being associated with a polarizing filter.

In some embodiments, positioning the first side of the medical reservoir against the reservoir rest may comprise retaining the medical reservoir with a retainer assembly. In some embodiments, the medical reservoir may be an IV bag and retaining the medical reservoir may comprise retaining one or more port of the IV bag in one of a passive retainer and a set of grasper jaws. In some embodiments, the method may further comprise agitating the medical reservoir. In some embodiments, agitating the medical reservoir may comprise rotating the medical reservoir between at least one pair of predefined rotational orientations. In some embodiments, the method may further comprise waiting a dwell period after agitating the medical reservoir before capturing the plurality of images. In some embodiments, providing the contrasting background may comprise backlighting the reservoir rest. The reservoir rest may include a pattern of light and dark regions. In some embodiments, the pattern of light and dark regions may be a checker pattern. In some embodiments, providing the contrasting background may comprise adjusting the output of the first illuminator over time. In some embodiments, illuminating the medical reservoir with a second illuminator may comprise under lighting the medical reservoir with the second illuminator. In some embodiments, one of the at least one predefined wavelength range may be selected from a list consisting of 580-620 nm and 620-750 nm. In some embodiments, the at least one imager may include a plurality of imagers. A field of view of each of the plurality of imagers may overlap the field of view at least one other imager of the plurality of imagers. In some embodiments, the field of view of each of the plurality of imagers may overlap the field of view at least one other imager of the plurality of imagers by at least 10%. In some embodiments, each of the plurality of imagers may be oriented with a view axis at an angle 30-35° from a plane extending perpendicular to the height axis of the reservoir rest. In some embodiments, capturing a plurality of images of the medical reservoir with at least one imager on a second side of the medical reservoir may comprise capturing the plurality of images at a frame rate of at least 8 frames per second from each of the at least one imager.

In accordance with another example embodiment of the present disclosure a marking assembly for placing a marking on a medical reservoir may comprise an embossing head having a plurality of individually displaceable segments on a shaft. The embossing head may further comprise a plurality of marking bodies. Each segment may include at least one of the plurality of marking bodies raised from and exterior surface thereof. A first end segment of the plurality of segments may be fixed with relation to the shaft. The marking assembly may further comprise a plurality of clutches. Each of the plurality of segments excepting the end segment may be paired with a respective one of the plurality of clutches. The marking assembly may further comprise a plurality of relative rotation limiters. A first of the relative rotation limiters may be formed between the trunnion and a second end segment of the plurality of segments. The second end segment may be opposite the first end segment. The remainder of the relative rotation limiters may be formed between each of the plurality of segments. The marking assembly may further comprise a trunnion. The shaft may be rotatably coupled to the trunnion. The marking assembly may further comprise a rotary actuator coupled to the shaft. The marking assembly may further comprise a rotation sensor configured to output a data signal indicative of the rotational position of the shaft. The marking assembly may further comprise a marking actuator coupled to the trunnion. The trunnion and embossing head may be displaceable between a retracted state and an embossing state via the marking actuator.

In some embodiments, the assembly may be coupled to the shaft through a transmission. In some embodiments, the transmission may comprise a timing belt. In some embodiments, each of the individual segments may be a rotor with a polygonal cross-section. In some embodiments, each of the individual segments may include a plurality of faces. There may be at least one marking body raised from at least one of the plurality of faces of each segment. In some embodiments, the marking bodies may be at least one of a list consisting of alphabetic characters, numerical characters, punctuation characters, pictograms, and symbols. In some embodiments, the plurality of clutches may be slip clutches. In some embodiments, each of the plurality of clutches may include a member biased radially outward from the shaft against a surface of a shaft aperture in the paired segment and the surface of the shaft aperture includes a plurality of detents. In some embodiments, each of the plurality of clutches may be disposed within the segment with which it is paired and includes a member biased axially against the surface of an adjacent segment of the plurality of individual segments, the surface of the adjacent segment including a plurality of detents. In some embodiments, the first relative rotation limiter may be formed by a projection on one of the trunnion and the second end segment which rides along an interrupted annular channel in the other of the trunnion and the second end segment. In some embodiments, the remainder of the relative rotation limiters may be formed by a projection of one segment of the plurality of segments extending into an interrupted annular channel in and adjacent segment of the plurality of segments. In some embodiments, each segment may include an equal number of exterior faces. Each interrupted annular channel may have an interrupt gap over an arc of 360° divided by the number of exterior faces. In some embodiments, the marking assembly may further comprise a verification imager and a controller. The controller may be configured to command capture of a marking formed by the marking assembly and perform optical character recognition on the marking to determine a marking content. The controller may be configured to compare the marking content to an expected marking and generate a fault in the event the marking content does not conform to the expected marking. In some embodiments, the marking actuator may be pneumatic. In some embodiments, the marking assembly may further comprise a backstop assembly including a compliant body opposite the embossing head. In some embodiments, the compliant body may be coupled into a backstop receptacle having a depth less than a distance each of the marking bodies is raised from the segments. The receptacle may have a footprint with a width dimension less than the width dimension of the embossing head. In some embodiments, each of the individual segments may include a plurality of faces. There may be at least one marking body raised from at least one of the plurality of faces on each segment. The compliant body may be coupled into a backstop receptacle having a depth less than a distance each of the marking bodies is raised from the segments. The receptacle may have a footprint with a height dimension less than the height dimension of each of the plurality of faces but greater than a largest height dimension of any of the marking bodies. In some embodiments, the backstop assembly may further comprise a reservoir guide. The reservoir guide may have a reservoir introduction opening. The reservoir guide may define a reservoir receiving channel which tapers thinner in width as distance from the reservoir introduction opening increases.

In accordance with another example embodiment of the present disclosure a method of marking a medical reservoir may comprise displacing a portion of a reservoir into a guide and aligning a marking region of the reservoir with a complaint body. The method may further comprise aligning a first desired string of marking bodies of an embossing head in a marking position. The method may further comprise driving the embossing head against the reservoir such that the marking region is compressed between the compliant body and the embossing head. The method may further comprise imaging the marking region. The method may further comprise analyzing the marking region to determine a marking content present in the marking region. The method may further comprise verifying correctness of the marking content by comparing the marking content to the desired string of characters. The method may further comprise aligning a second desired string of marking bodies of the embossing head in the marking position and driving the embossing head against the reservoir such that the marking region is compressed between the compliant body and the embossing head when the marking content does not match the desired string of marking bodies.

In some embodiments, the reservoir may be an IV bag and the marking region is in a peripheral seal of the IV bag. In some embodiments, driving the embossing head against the reservoir may comprise holding the marking region in compression between the compliant body and the embossing head for a dwell period. In some embodiments, the method may further comprise storing the marking content in a log and communicating the log to an external database. In some embodiments, aligning the first desired string of marking bodies may comprise rotating a shaft of the embossing head to which a first rotor of the embossing head is fixed coupled in a first direction until a relative rotation limiter for another rotor is engaged. In some embodiments, the aligning the first desired string of marking bodies comprises continuing to rotate the shaft in the first direction until a clutch between two rotors of the embossing heads slips at least once. In some embodiments, aligning the first desired string of marking bodies may comprise rotating the shaft in a second direction opposite the first direction.

In accordance with another example embodiment of the present disclosure an outfeed assembly for a system for producing and packaging fluids may comprise a compartment. The outfeed assembly may further comprise a drawer including a first receptacle array of a first number of first receptacles and a second receptacle array of a second number of second receptacles less than the first number. The outfeed assembly may further comprise a drawer slide assembly including a carriage coupled to the drawer and including a carriage striker. The drawer slide assembly may further comprise a telescoping assembly including a telescoping assembly striker. The drawer slide assembly may further comprise a base fixed relative to the compartment including a carriage lock, a telescoping assembly lock, and a set of drawer slides coupled to the carriage. The drawer may be locked in a closed position when the carriage striker and telescoping assembly striker are respectively engaged with the carriage lock and telescoping assembly lock. The outfeed assembly may further comprise a user interface. The outfeed assembly may further comprise a controller. The controller may be configured to determine a credential associated with a user identity input to the user interface. The controller may be further configured to disengage the carriage lock upon receipt of a first input to the user interface by a user associated with either of a first credential and second credential. The controller may be further configured to disengage the telescoping lock upon receipt of a second input to the user interface by a user associated with the second credential. The drawer may be within the compartment in the closed position. The drawer may be displaceable from the closed position to a first open position when the carriage lock is disengaged and displaceable to a second open position when the carriage and telescoping assembly locks are disengaged. The second receptacle array may be within the compartment at the first open position and out of the compartment in the second open position.

In some embodiments, the outfeed assembly may further comprise a warding grid associated with the outfeed drawer. The warding grid may be disposed intermediate the outfeed drawer and the remainder of the outfeed compartment. The warding grid may include a number of apertures which align with the first and second receptacles of the outfeed drawer when the associated outfeed drawer is in the closed state. In some embodiments, the second receptacle array may be one of raised, recessed, and at even height with respect to the first receptacle array. In some embodiments, a receptacle state detector may be included in each of the first receptacles and each of the second receptacles. In some embodiments, each receptacle state detector may output a first signal when the respective receptacle is empty and a second signal when the respective receptacle contains a reservoir. In some embodiments, the outfeed assembly may further comprise a gantry assembly having a medical reservoir grasper with a pair of jaws actuatable between a closed state and an open state. In some embodiments, the gantry assembly may include an imager. In some embodiments, the drawer slide assembly may include at least one set of carriage displacement dampers. In some embodiments, the drawer slide assembly may include a first set of carriage displacement dampers positioned to engage the carriage when the carriage is displaced to the closed position. The drawer slide assembly may include a second set of displacement dampers positioned to engage the carriage when the carriage is displaced to the first open position. In some embodiments, the drawer slide assembly may include at least one set of telescoping assembly displacement dampers positioned to engage the telescoping assembly when the telescoping assembly is displaced to an end of a displacement range of the telescoping assembly. In some embodiments, the telescoping assembly may be coupled to guides on the base. In some embodiments, the base may include a bumper. The telescoping assembly may collide with the bumper when the drawer is displaced to the second open position. The bumper may prohibit further displacement of the drawer in a direction away from the compartment. In some embodiments, at least one drawer position sensor may be coupled to the base. The controller may be in data communication with each of the at least one drawer position sensor. In some embodiments, the telescoping assembly may include a set of stops. The carriage may including a set of projections. The projections may collide with the stops when the drawer is displaced to the first open position.

In accordance with another example embodiment of the present disclosure, a method of packing fluid into a medical reservoir may comprise loading a dispenser against an enclosure. The method may further comprise removing and stowing an outlet cover of the dispenser within a first compartment of the enclosure. The method may further comprise drawing a chain of reservoirs into the first compartment from the dispenser. The method may further comprise singulating an individual reservoir from the chain. The method may further comprise filling the individual reservoir with fluid from a medical fluid production assembly into the individual reservoir through a dispensing sharp which has pierced a septum of the individual reservoir. The method may further comprise displacing and isolating the individual reservoir into a second compartment of the enclosure. The method may further comprise displacing the individual reservoir into a third compartment of the enclosure. The method may further comprise inspecting the individual reservoir. The method may further comprise marking the individual reservoir with a marking dependent on the outcome of the inspection. The method may further comprise displacing the individual reservoir to a receptacle. The receptacle may depend on the outcome of the inspection.

In some embodiments, the method may further comprise environmentally controlling a plurality of zones within the enclosure. The zones may be in at least one compartment of an enclosure. In some embodiments, a first of the plurality of zones may be directly adjacent the dispensing sharp and a second of the plurality of zones may be the remainder of the first compartment. The first zone may be more stringently controlled than the second. In some embodiments, the second compartment may be one of the plurality of zones and the second compartment may be controlled to a level of control at least equal to a level of control of a zone in the first compartment of the enclosure before the individual reservoir is displaced into the second compartment. In some embodiments, removing and stowing the outlet cover may comprise forming a seal between the outlet cover and exposed portions of an interface assembly and retaining the outlet cover on the interface assembly. In some embodiments, drawing the chain into the first compartment may comprise grasping a lead reservoir of the chain and dislodging it from a retainer on a reservoir presenter of the dispenser. In some embodiments, singulating the individual reservoir from the chain may comprise tearing the individual reservoir from the chain along a weakened region of the chain. In some embodiments, singulating the individual reservoir from the chain may comprise driving a splitter of a bag individualizing assembly through a weakened region of the chain. In some embodiments, filling the individual reservoir may comprise irradiating at least an exposed portion of a septum of the individual reservoir. In some embodiments, irradiating at least the exposed portion of the septum may comprise irradiating a portion of the dispensing sharp. In some embodiments, inspecting the individual reservoir may comprise agitating the individual reservoir. In some embodiments, agitating the individual reservoir may comprise rotating the individual reservoir between pairs of rotational orientations in accordance with a predefined motion profile. In some embodiments, inspecting the individual reservoir may comprise providing a contrasting pattern on a first side of the individual reservoir and illuminating the individual reservoir with collimated, polarized light from an external illuminator. In some embodiments, inspecting the reservoir may further comprise capturing a plurality of images with an imager associated with a polarizing filter, processing the images, detecting pixel clusters of interest within the images and determining classifications for the pixel clusters of interest. In some embodiments, the classifications may be selected from a list consisting of, a first content type, a second content type, a content subtype, a content identity, gas, bubble, not a bubble, particulate, a particulate type, and a content size. In some embodiments, the marking may indicate the individual reservoir is not to be used when at least one pixel cluster of interest is assigned a class predetermined to be unacceptable. In some embodiments, when at least one pixel cluster of interest is assigned a class predetermined to be unacceptable, the receptacle may be an access controlled receptacle. In some embodiments, marking the individual reservoir may comprise embossing the marking into a portion of the individual reservoir. In some embodiments, the receptacle may be included in an outfeed drawer. In some embodiments, the method may further comprise verifying the marking matches an intended marking. The receptacle may be dependent upon the inspection and the verification. In some embodiments, filling the individual reservoir may comprise providing diluent to a concentrate disposed in the individual reservoir

In accordance with another example embodiment of the present disclosure a system for packaging fluid into a medical reservoir may comprise a medical fluid production assembly. The system may further comprise a dispenser containing a chain of reservoirs. The system may further comprise an enclosure having a plurality of compartments. A first of the compartments may include an infeed aperture. The system may further comprise a dispenser interface assembly including a dispenser outlet cover retainer assembly displaceable between a stowed position and an infeed aperture plugging position. The system may further comprise a reservoir singulation assembly in the first compartment. The system may further comprise a filling assembly including cartridge having an inlet in fluid communication with the medical fluid production assembly and outlet including a dispensing sharp. The cartridge may be at least partially in the first compartment. The system may further comprise a second compartment. There may be a first door between the first and second compartments. The system may further comprise a third compartment. There may be being a second door between the second and third compartments. The system may further comprise a particulate inspection system in the third compartment. The system may further comprise a marking assembly in the third compartment. The system may further comprise an outfeed assembly in the third compartment including at least one a first array of reservoir receptacles and at least one a second array of reservoir receptacles.

In some embodiments, the medical fluid production assembly may include a plurality of water treatment apparatuses selected from a group consisting of a carbon filter, a reverse osmosis filter, an electrodeionization assembly, and a UV light emitter. In some embodiments, the chain of reservoirs may be a chain of abreastly chained IV bags. In some embodiments, each reservoir in the chain of reservoirs may include at least one concentrate. In some embodiments, each of the at least one concentrate may be selected from a list consisting of a saline brine, a sodium chloride brine, a sugar solution, a saline and sugar solution, a peritoneal dialysate precursor solution, a hemodialysis precursor solution, a Ringer's solution concentrate, lactated Ringer's solution concentrate, and Hartmann's solution concentrate, a powder, a lyophilized agent, a crystalline solid, a salt in crystalline form, crystalline sodium chloride, crystalline sugar, a solid dialysate precursor, a concentrate for a hypotonic solution, a concentrate for an isotonic solution, a concentrate for a hypertonic solution, a saturated solution, an unsaturated solution, an at least partially liquid concentrate, and an at least partially solid concentrate. In some embodiments, the system may further comprise a reservoir displacement assembly in the first compartment. The reservoir displacement assembly may include a least one robotic gripper assembly coupled to a linear displacement stage. In some embodiments, the dispenser may include a dispenser outlet, a dispenser outlet cover, and a dispenser lock assembly. The outlet cover may be in sealing relationship with the dispenser about the dispenser outlet when the lock assembly is in a locked state. In some embodiments, the dispenser outlet cover interface may include a dispenser lock assembly actuation assembly. In some embodiments, the dispenser outlet cover interface may include a pressure port in selective fluid communication with a negative pressure source. In some embodiments, the reservoir singulation assembly may include a splitter assembly coupled to a splitter assembly actuator. The splitter assembly displaceable through a range from a raised position to an end of stroke position via the splitter assembly actuator. In some embodiments, the filling assembly may further comprise an irradiation assembly including a plurality of antimicrobial light emitter and the cartridge includes a barrier surrounding at least a portion of the dispensing sharp which is at least partially transparent to the antimicrobial light. In some embodiments, the particulate inspection assembly may include a reservoir rest coupled to a rotary actuator. In some embodiments, the system may further comprise a controller in data communication with the rotary actuator. The controller may be configured to command displacement of the rotary actuator between preset pairs or rotational orientations defined in a motion profile. In some embodiments, the particulate inspection system may include a contrasting pattern, an illuminator including at least one collimated light emitter and a polarizer, and at least one imager having a polarizing filter disposed opposite the contrasting pattern. In some embodiments, the system may further comprise a controller configured to receive image data from the at least one imager, process the image data, detect pixel clusters of interest in the image data, and determine classifications for the pixel clusters of interest. In some embodiments, the classifications may be selected from a list consisting of, a first content type, a second content type, a content subtype, a content identity, gas, bubble, not a bubble, particulate, a particulate type, and a content size. In some embodiments, the controller may be configured to supply a portion of the image data including at least the pixel clusters of interest to a convolutional neural network trained on images of reservoirs including known contents to determine the classifications. In some embodiments, the marking assembly may include an embossing head coupled to an embossing actuator. In some embodiments, one of the at least one a first array of reservoir receptacles and one of the at least one a second array of reservoir receptacles may be included in an outfeed drawer. In some embodiments, the outfeed assembly may include a first lock for the outfeed drawer and a second lock for the outfeed drawer. The outfeed drawer may be displaceable to a partially open position when the first lock is disengaged and a fully opened position when the second lock is disengaged.

In accordance with another example embodiment of the present disclosure, a fluid dispensing assembly for filling reservoirs with medical fluid may comprise a cartridge. The cartridge may comprise an irradiation transmissive barrier. The cartridge may further comprise an air flow channel. The irradiation transmissive barrier may define at least a portion of the airflow channel. The cartridge may further comprise a dispensing sharp coupled to a hub within the airflow channel. The cartridge may further comprise a connection port having a plurality of sealing members in spaced relation about an exterior surface of the connection port. The cartridge may further comprise a frangible seal at a terminal end of the connection port. The cartridge may further comprise a flow path extending from the connection port to the dispensing sharp and having at least one filter disposed in an intermediate portion of the flow path. The fluid dispensing assembly may further comprise an irradiation assembly including at least one antimicrobial light emitter. The at least one antimicrobial light emitter may be positioned about the irradiation transmissive barrier. The dispensing assembly may further comprise an antimicrobial agent dispenser.

In some embodiments, the assembly may further comprise a cartridge dock. In some embodiments, the assembly may further comprise a supply manifold having a receptacle sized to accept the connection port. The receptacle may including a spike. In some embodiments, the irradiation assembly may include a set of UVC LEDs. In some embodiments, the at least one antimicrobial light emitter may include at least three antimicrobial light emitters spaced about the irradiation transmissive barrier. Each antimicrobial light emitter may be positioned 90° from at least one other antimicrobial light emitter. In some embodiments, the dispensing sharp may be a pencil tipped sharp with two side ports disposed in opposition to one another. In some embodiments, the irradiation transmissive barrier may be at least partially transparent to UVC light. In some embodiments, the irradiation transmissive barrier may be formed of fused quartz. In some embodiments, the airflow channel may extend along a straight line path through the cartridge and has a round cross-sectional shape. In some embodiments, at least one guide may be included at a first end of the airflow channel. In some embodiments, the cross-sectional area of the airflow channel may vary over the length of the airflow channel. In some embodiments, the antimicrobial agent dispenser may include one of a sprayer and an atomizer with an outlet directed to a point below an end of the dispensing sharp. In some embodiments, the antimicrobial agent dispenser may include a removable agent source reservoir. In some embodiments, the antimicrobial agent dispenser may be an isopropyl alcohol dispenser.

In accordance with another embodiment of the present disclosure a method of packaging fluid into a medical bag may comprise positioning the medical bag in a first position in which a septum in a port of the bag is aligned with a fluid dispensing sharp. The method may further comprise dispensing an antimicrobial agent onto at least an exposed portion of the septum. The method may further comprise illuminating at least the exposed portion of the septum with at least one antimicrobial light emitter. The method may further comprise positioning the medical bag in a second position in which the fluid dispensing sharp has pierced through the septum and is in fluid communication with an empty compartment within an interior volume of medical bag. The method may further comprise dispensing a predetermined amount of fluid from the fluid dispensing sharp into the medical bag. The method may further comprise retaining the medical bag in a mix assisting assembly and rotating the medical bag in alternating clockwise and counterclockwise directions about an axis substantially perpendicular to a plane of the medical bag in which the axis of the port falls through a sequence of predetermined positions. In some embodiments, the medical bag may be rotated at at least a certain rotation rate as the medical bag is rotated through the sequence of predetermined positions. In some embodiments, the method further may comprise dwelling at each of the predetermined positions. In some embodiments, rotating the medical bag comprises fully inverting the medical bag at least once. In some embodiments, retaining the medical bag in the mix assisting assembly may comprise placing the medical bag in a cradle of the mix assisting assembly. In some embodiments, the method may further comprise mixing the fluid with a concentrate in the medical bag by compromising a temporary partition separating and empty compartment with the medical bag from the concentrate while the predetermined amount of fluid is transferred into the interior volume and dropping the fluid into the concentrate. In some embodiments, the method may further comprise further mixing the fluid with the concentrate by compromising a second temporary partition in the interior volume while the predetermined amount of fluid is transferred into the medical bag and dropping the fluid and concentrate to an end of the bag opposite the port. In some embodiments, rotating the medical bag may further comprise dissolving a concentrate within the medical bag into the predetermined amount of fluid. In some embodiments, positioning the medical bag in the first position may comprise positioning the port at least partially into an airflow channel surrounding the fluid dispensing sharp. In some embodiments, the method may further comprise flowing air through the airflow channel. In some embodiments, the method may further comprises providing a laminar flow of clean air to the airflow channel. In some embodiments, the at least one antimicrobial light emitter includes a UVC LED. In some embodiments, positioning the medical bag in the first position may comprise displacing the port within an irradiation transmissive barrier of a fluid dispensing cartridge. In some embodiments, the method may further comprise illuminating at least a portion of the fluid dispensing sharp with the at least one antimicrobial light emitter. In some embodiments, the method may further comprise mixing the predetermined amount of fluid with a concentrate within the medical bag for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the method may further comprise mixing the predetermined amount of fluid with a concentrate within the medical bas selected from a list consisting of, powder, lyophilized medical agent, crystalline concentrate, salt concentrate, sodium chloride concentrate, sugar concentrate, and dextrose concentrate. In some embodiments, positioning the medical bag in at least one of the first position and second position may comprise directing the port with at least one guide. In some embodiments, dispensing the antimicrobial agent may comprise one of spraying and atomizing the antimicrobial agent. In some embodiments, dispensing the antimicrobial agent may comprise dispensing isopropyl alcohol. In some embodiments, dispensing the antimicrobial agent may comprise drawing the agent from a removable antimicrobial agent source reservoir.

In accordance with another example embodiment of the present disclosure a multi-compartment flexible reservoir for medical agent may comprise a first sheet and second sheet of material sealed to one another along a peripheral seal. The peripheral seal may define an interior volume of the reservoir. The reservoir may further comprise a plurality for ports coupled into the peripheral seal. Each of the ports may define an interior flow path in communication with the interior volume. The reservoir may further comprise a first compartment of the interior volume in fluid communication with each of the plurality of ports. The first compartment may be collapsed and devoid of content. The reservoir may further comprise a second compartment of the interior volume defined by a first and second first frangible seal each extending across the reservoir at respective opposing ends of the second compartment. The first and second sheet may be coupled together to form each of the first and second frangible seal. The second compartment may be at least partially filled with a concentrate and separated from the first compartment by the first frangible seal. The reservoir may further comprise a third compartment at an end of the reservoir opposite the ports. The third compartment may be segregated from the second compartment by the second frangible seal. The third compartment may be collapsed and devoid of content.

In some embodiments, at least one of the plurality of ports may include a septum disposed in an end of the port most distal the interior volume. In some embodiments, at least one of the plurality of ports may include a stopper with a spike receptacle, the stopper disposed in an end of the port most distal the interior volume. In some embodiments, the plurality of ports may include a first port and a second port. In some embodiments, at least one of the plurality of ports may include a set or projections extending outwardly from an axis of the port. In some embodiments, the set of projections may include a set of ribs. In some embodiments, the set of projections may include in at least one projection bearing body coupled to the port. In some embodiments, at least one of the plurality of ports may include at least one outwardly extending projection which at least partially surrounds the port. In some embodiments, the second compartment may be filled with a solid concentrate. In some embodiments, the solid concentrate may be a concentrate for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the solid concentrate may be selected from a list consisting of, powder, lyophilized medical agent, crystalline concentrate, salt concentrate, sodium chloride concentrate, sugar concentrate, dextrose concentrate. In some embodiments, the second compartment may be closer to the ports than to an end of the reservoir opposite the ports. In some embodiments, the first frangible seal may extend across the reservoir in a direction substantially parallel to a portion of the peripheral seal into which the ports are coupled. The first frangible seal may be disposed 5-25% of the length of the reservoir from the peripheral seal into which the ports are coupled. In some embodiments, a capacity of the second compartment may be greater than a volume of the concentrate disposed in the second compartment.

In accordance with another example embodiment of the present disclosure, a multi-compartment reservoir for medical agent may comprise a first and second sheet of material sealed to one another at a peripheral seal to define an interior volume of the reservoir. The reservoir may further comprise a first port and a second port bonded into the peripheral seal. Each of the first port and second may define an interior flow path in communication with the interior volume. Each of the first port and second port may have a set of projections extending therefrom and at least partially surrounding the respective port. The reservoir may further comprise a first compartment in fluid communication with the ports. The first compartment may be collapsed and devoid of contents. The reservoir may further comprise a second compartment containing a concentrate. The reservoir may further comprise a frangible partition separating the first and second compartment. The first and second sheet may be coupled together to form the frangible partition.

In some embodiments, the frangible partition may extend across the reservoir in a direction substantially parallel to a portion of the peripheral seal into which the ports are coupled. The frangible partition may be disposed 5-25% of the length of the reservoir from the peripheral seal into which the ports are coupled. In some embodiments, a capacity of the second compartment may be greater than a volume of the concentrate disposed in the second compartment. In some embodiments, the second compartment may be filled with a solid concentrate. In some embodiments, the solid concentrate may be a concentrate for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the solid concentrate may be selected from a list consisting of, powder, lyophilized medical agent, crystalline concentrate, salt concentrate, sodium chloride concentrate, sugar concentrate, dextrose concentrate. In some embodiments, the projections in each set of projections may be ribs. In some embodiments, the set of projections extending from each port may include at least one first projection and at least one second projection. The at least one second projection may be offset from the at least one first projection along an axial dimension of the port. In some embodiments, the first port may include a septum disposed in an end of the port most distal the interior volume. In some embodiments, the second port may include a stopper with a spike receptacle, the stopper disposed in an end of the port most distal the interior volume. In some embodiments, the reservoir may further comprise a third compartment at an end of the reservoir opposite the first and second port. The third compartment may be segregated from the second compartment by another frangible partition. The third interior compartment may be collapsed and devoid of content.

In accordance with another embodiment of the present disclosure, a method of packaging fluid into a medical bag may comprise positioning the medical bag in a first position in which a septum in a port of the bag is aligned with a fluid dispensing sharp. The method may further comprise irradiating at least an exposed surface of the septum with an irradiation assembly. The method may further comprise positioning the medical bag in a second position in which the fluid dispensing sharp has pierced through the septum and is in fluid communication with an empty compartment within an interior volume of medical bag. The method may further comprise dispensing a predetermined amount of diluent from the fluid dispensing sharp into the medical bag. The method may further comprise mixing diluent with a concentrate in the medical bag by compromising a temporary partition separating the empty compartment from the concentrate while the predetermined amount of diluent is transferred into the interior volume and dropping the diluent into the concentrate.

In some embodiments, the method may further comprise further mixing the diluent with the concentrate by compromising a second temporary partition in the interior volume while the predetermined amount of diluent is transferred into the medical bag and dropping the diluent and concentrate to an end of the bag opposite the port. In some embodiments, the method may further comprise dissolving the concentrate. In some embodiments, the method may further comprise displacing the bag to a mix assisting assembly and agitating the diluent and concentrate within the interior volume. In some embodiments, positioning the medical bag in the first position may comprise positioning the port at least partially into an airflow channel surrounding the fluid dispensing sharp. In some embodiments, the method may further comprise flowing air through the airflow channel. In some embodiments, the method may further comprise providing a laminar flow of clean air to the airflow channel. In some embodiments, irradiating at least the exposed surface of the septum may comprise illuminating the exposed surface of the septum with UV light. In some embodiments, irradiating at least the exposed surface of the septum may comprise powering an array of UVC LEDs. In some embodiments, irradiating at least the exposed surface of the septum may comprise powering at least one antimicrobial light emitter. In some embodiments, positioning the medical bag in the first position may comprise displacing the port within an irradiation transmissive barrier. In some embodiments, irradiating at least the exposed surface of the septum may comprise also irradiating at least a portion of the fluid dispensing sharp. In some embodiments, irradiating at least the exposed surface of the septum may comprise irradiating the exposed surface of the septum with at least a prescribed dosage of irradiation. In some embodiments, dispensing the predetermined amount of diluent from the fluid dispensing sharp may comprise dispensing the predetermined amount of diluent from at least one side port in a pencil tip needle. In some embodiments, the concentrate may be a solid concentrate. In some embodiments, the solid concentrate may be a concentrate for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the solid concentrate may be selected from a list consisting of, powder, lyophilized medical agent, crystalline concentrate, salt concentrate, sodium chloride concentrate, sugar concentrate, dextrose concentrate. In some embodiments, positioning the bag in at least one of the first position and second position may comprise directing the port with at least one guide.

In accordance with another example embodiment of the present disclosure, a fluid dispensing cartridge for a medical fluid dispenser may comprise a housing assembly having a flow path extending therethrough. The cartridge may further comprise an irradiation transmissive barrier coupled to the housing assembly. The cartridge may further comprise an air flow channel extending through the housing assembly. The irradiation transmissive barrier may define at least a portion of the airflow channel. One end of the air flow channel may include at least one port guide. The cartridge may further comprise a dispensing sharp coupled to a hub within the airflow channel. The dispensing sharp may be in fluid communication with an output end of the flow path. The cartridge may further comprise a connection port disposed at an input end of the flow path having a plurality of sealing members in spaced relation about an exterior surface of the connection port. The cartridge may further comprise a frangible seal at a terminal end of the connection port. The cartridge may further comprise at least one filter disposed at an intermediate portion of the flow path.

In some embodiments, the dispensing sharp may be a pencil tipped sharp with a least one side port. In some embodiments, the dispensing sharp may be a pencil tipped sharp with two side ports disposed in opposition to one another. In some embodiments, the dispensing sharp may be a pencil tipped sharp with a gauge between 16-18. In some embodiments, the airflow channel varies in cross-sectional area along the length of the air flow channel. In some embodiments, the irradiation transmissive barrier may be at least partially transparent to UVC light. In some embodiments, the irradiation transmissive barrier may be formed of fused quartz. In some embodiments, the irradiation transmissive barrier may be a tube of fused quartz. In some embodiments, the airflow channel may extend along a straight line path through the housing and may have a round cross-sectional shape. In some embodiments, the connection port may have a first section having a first diameter and a second section having a second diameter smaller than the first. In some embodiments, the second section may extend to the terminal end of the connection port and at least one sealing member may be disposed on the exterior surface of each of the first second and second section. In some embodiments, the at least one filter may include a 0.2 μm filter. In some embodiments, the cartridge may further comprise a filter support for each of the at least one filter. In some embodiments, the cartridge may further comprise a filter support grate disposed on a downstream side of each of the at least one filter. In some embodiments, the filter may be captured between a first and second body of the housing assembly.

In accordance with another embodiment of the present disclosure, a fluid dispensing assembly for filling reservoirs with medical fluid may comprise a cartridge. The cartridge may comprise an irradiation transmissive barrier. The cartridge may further comprise an air flow channel. The irradiation transmissive barrier may define at least a portion of the airflow channel. The cartridge may further comprise a dispensing sharp coupled to a hub within the airflow channel. The cartridge may further comprise a connection port having a plurality of sealing members in spaced relation about an exterior surface of the connection port. The cartridge may further comprise a frangible seal at a terminal end of the connection port. The cartridge may further comprise a flow path extending from the connection port to the dispensing sharp and having at least one filter disposed in an intermediate portion of the flow path. The fluid dispensing assembly may further comprise an irradiation assembly including at least one antimicrobial light emitter. The at least one antimicrobial light emitter may be positioned about the irradiation transmissive barrier.

In some embodiments, the assembly may further comprise a cartridge dock. In some embodiments, the assembly may further comprise a supply manifold having a receptacle sized to accept the connection port. The receptacle may include a spike. In some embodiments, the irradiation assembly may include a set of UVC LEDs. In some embodiments, the at least one antimicrobial light emitter may include at least 3 antimicrobial light emitters spaced about the irradiation transmissive barrier. Each antimicrobial light emitter may be positioned 90° from at least one other antimicrobial light emitter. In some embodiments, the dispensing sharp may be a pencil tipped sharp with two side ports disposed in opposition to one another. In some embodiments, the irradiation transmissive barrier may be at least partially transparent to UVC light. In some embodiments, the irradiation transmissive barrier may be formed of fused quartz. In some embodiments, the airflow channel may extend along a straight line path through the cartridge and may have a round cross-sectional shape. In some embodiments, at least one guide may be included at a first end of the airflow channel. In some embodiments, the cross-sectional area of the airflow channel may varies over the length of the airflow channel.

In accordance with another embodiment of the present disclosure, a method of packaging fluid into a medical bag may comprise positioning the medical bag in a first position in which a septum in a port of the bag is aligned with a fluid dispensing sharp. The method may further comprise illuminating at least an exposed portion of the septum with at least one antimicrobial light emitter. The method may further comprise positioning the medical bag in a second position in which the fluid dispensing sharp has pierced through the septum and is in fluid communication with an empty compartment within an interior volume of medical bag. The method may further comprise dispensing a predetermined amount of fluid from the fluid dispensing sharp into the medical bag. The method may further comprise retaining the medical bag in a mix assisting assembly and rotating the medical bag in alternating clockwise and counterclockwise directions about an axis substantially perpendicular to a plane of the medical bag in which the axis of the port falls through a sequence of predetermined positions.

In some embodiments, the medical bag may be rotated at at least a certain rotation rate as the medical bag is rotated through the sequence of predetermined positions. In some embodiments, the method may further comprise dwelling at each of the predetermined positions. In some embodiments, rotating the medical bag may comprise fully inverting the medical bag at least once. In some embodiments, retaining the medical bag in the mix assisting assembly may comprise placing the medical bag in a cradle of the mix assisting assembly. In some embodiments, the method further comprises mixing the fluid with a concentrate in the medical bag by compromising a temporary partition separating and empty compartment with the medical bag from the concentrate while the predetermined amount of fluid is transferred into the interior volume and dropping the fluid into the concentrate. In some embodiments, the method may further comprise further mixing the fluid with the concentrate by compromising a second temporary partition in the interior volume while the predetermined amount of fluid is transferred into the medical bag and dropping the fluid and concentrate to an end of the bag opposite the port. In some embodiments, rotating the medical bag may further comprise dissolving a concentrate within the medical bag into the predetermined amount of fluid. In some embodiments, positioning the medical bag in the first position may comprise positioning the port at least partially into an airflow channel surrounding the fluid dispensing sharp. In some embodiments, the method may further comprise flowing air through the airflow channel. In some embodiments, the method may further comprise providing a laminar flow of clean air to the airflow channel. In some embodiments, the at least one antimicrobial light emitter may include a UVC LED. In some embodiments, positioning the medical bag in the first position may comprise displacing the port within an irradiation transmissive barrier of a fluid dispensing cartridge. In some embodiments, the method may further comprise illuminating at least a portion of the fluid dispensing sharp with the at least one antimicrobial light emitter. In some embodiments, the method may further comprise mixing the predetermined amount of fluid with a concentrate within the medical bag for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution. In some embodiments, the method may further comprise mixing the predetermined amount of fluid with a concentrate within the medical bas selected from a list consisting of, powder, lyophilized medical agent, crystalline concentrate, salt concentrate, sodium chloride concentrate, sugar concentrate, and dextrose concentrate. In some embodiments, positioning the medical bag in at least one of the first position and second position may comprise directing the port with at least one guide.

### BRIEF DESCRIPTION OF THE DRAWINGS

These and other aspects will become more apparent from the following detailed description of the various embodiments of the present disclosure with reference to the drawings wherein:

FIG. 1 depicts a perspective view of an exemplary system for producing an packaging fluids;

FIG. 2 depicts a top plan view of a portion of an example system;

FIG. 3 depicts a flowchart detailing a number of example actions which may be executed to package fluid into a reservoir;

FIG. 4A depicts a front view of an exemplary reservoir;

FIG. 4B-C depict views of the exemplary reservoir of FIG. 4A with a concentrate contained within the reservoir;

FIG. 5 depicts a flowchart detailing a number of example actions which may be executed to fill a reservoir including at least one frangible with a fluid;

FIG. 6A depicts a front view of another exemplary reservoir;

FIG. 6B depicts a perspective view of the example reservoir of FIG. 6A with a concentrate therein;

FIG. 7A-B depict perspective views of further example reservoirs;

FIG. 7C depicts a perspective view of the example reservoir of FIG. 7B with a concentrate contained therein;

FIG. 8A depicts a perspective view of another example reservoir having a liquid concentrate therein;

FIG. 8B depicts a perspective view of another example reservoir;

FIG. 9 depicts a flowchart detailing a number of example actions which may be executed to fill a reservoir with concentrate and remove at least some of the solvent from the concentrate through the sealed reservoir;

FIG. 10A depicts a view of an example reservoir including a partially solid concentrate;

FIG. 10B depicts a detailed view of a portion of an example reservoir including a partially solid concentrate;

FIGS. 11A-B depict perspective views of example projection bearing bodies which may, for instance, be coupled to ports of an IV bag;

FIG. 12 depicts a perspective view of a portion of an IV bag with projection bearing bodies coupled to ports of the bag;

FIG. 13 depicts a perspective view of a portion of an IV bag with projection bearing bodies coupled thereto being held by an automated grasper;

FIG. 14 depicts a perspective view of an example ribbing clip which may be coupled to ports of an IV bag;

FIGS. 15A-C depict views of an example ribbed ring which may be coupled to a port of an IV bag;

FIGS. 16A-C depict views of example graspers holding projection bearing bodies on ports of an IV bag;

FIGS. 17A-B depict cross-sectional view of example IV bag ports with projection bearing bodies coupled thereto;

FIGS. 18A-C depict views of example projection bearing bodies coupled to ports of IV bags;

FIGS. 19A-B depict views of example chaining linkages which may be used to couple IV bags to one another;

FIG. 20A depicts an example IV bag with an example chaining linkage coupled thereto;

FIG. 20B depicts a series of example IV bags coupled together with a number of example chaining linkages;

FIGS. 21A-F depict various views of an exemplary port for an IV bag;

FIG. 22 depicts a portion of an example chain of a number of example reservoirs;

FIG. 23A depicts a portion of another example chain of example reservoirs;

FIG. 23B depicts a detailed view of the indicated region of FIG. 23A;

FIG. 24A depicts a portion of another example chain of example reservoirs;

FIG. 24B depicts a detailed view of the indicated portion of FIG. 24A;

FIGS. 25A-25E depict views of a number of example chains of example reservoirs;

FIG. 26 depicts a portion of another example chain of example reservoirs;

FIGS. 27A-B depict views of an example dispenser for a chain of reservoirs;

FIG. 28 depicts a cross-sectional view of an example dispenser;

FIG. 29 depicts a cross sectional view of an example dispenser;

FIG. 30A depicts a top plan view of another example dispenser;

FIG. 30B depicts a cross-sectional view taken at the indicated cut plane of FIG. 30A;

FIGS. 31-32 depict views of another example dispenser;

FIG. 33 depicts a perspective view of an example dispenser with a portion of the dispenser broken away to show a spool of an exemplary chain of reservoirs within the dispenser;

FIG. 34A depicts a dispenser with an example removable cover assembly in a locked state;

FIG. 34B depicts a dispenser with an example removable cover assembly in an unlocked state;

FIG. 34C depicts a partially exploded view of an example dispenser;

FIG. 35 depicts a rear view of an example backing body of a removable cover assembly;

FIG. 36A depicts a perspective view of an example reel of a chain of reservoirs;

FIG. 36B depicts view of an end of an example chain of reservoirs coupled to an example spool;

FIG. 37A depicts a perspective view of the example dispenser of FIG. 34A without the removable cover assembly;

FIG. 37B depicts a detailed view of the indicated region of FIG. 37A;

FIG. 38 depicts a perspective view of an example spool which may be included in certain dispensers;

FIG. 39 depicts a view of a tensioner assembly exploded away from an example spool;

FIGS. 40A-B depict exploded views of an example tensioner assembly;

FIG. 41 depicts a block diagram of an example docking assembly, an example sanitary interface assembly, and portion of a processing compartment of a system;

FIG. 42 depicts a view of an example docking assembly and example infeed plug assembly sealing an infeed aperture to a processing compartment;

FIG. 43 depicts a view of an example dispenser loaded into an example carriage of a docking assembly;

FIG. 44 depicts a view of an infeed aperture plug with a portion of the infeed aperture plug housing removed;

FIGS. 45A-B depict a flowchart detailing a number of example actions which may be executed to load and open a dispenser with a docking assembly and sanitary interface assembly;

FIG. 46 depicts a flowchart detailing a number of example actions which may be executed to remove a dispenser from a system;

FIG. 47A depicts a top plan view of an example processing chamber including an example bag displacement assembly;

FIG. 47B depicts a view of an example bag displacement assembly within an example processing chamber of a system;

FIGS. 48A-49B depict views of various portions of bag retention assemblies that may be included in certain bag displacement assemblies;

FIG. 50A depicts a view of a portion of an example bag displacement assembly;

FIG. 50B depicts another view of a portion of an example bag displacement assembly;

FIG. 50C depicts another view of a portion of an example bag displacement assembly;

FIG. 51 depicts a flowchart detailing a number of example actions which may be executed to fill and displace a reservoir through certain example systems;

FIG. 52 depicts a perspective view of an example reservoir singulating assembly which may be used to individualize a reservoir from a chain of reservoirs;

FIGS. 53A-C depict views of an example splitter assembly which may be included in certain reservoir singulating assemblies;

FIGS. 54A-D depict views of additional example splitter assemblies which may be included in certain reservoir singulating assemblies;

FIG. 55 depicts a bag retention assembly grasping a bag from a bag presenter of an example dispenser;

FIG. 56 depicts an example chain of bags pulled from a dispenser by an exemplary bag retainer assembly;

FIG. 57A depicts an example bag retainer assembly pressing ports of a bag into port retainers of an example fill station;

FIG. 57B depicts an example bag retainer assembly spaced from a bag held in port retainers of an example fill station;

FIG. 58 depicts an example bag retainer assembly aligned with ports of a bag adjacent a bag singulating assembly;

FIGS. 59A-B depict views of an example splitter assembly of an example bag singulating assembly separating a bag from an example chain of bags;

FIG. 60 depicts a bag in place at an example fill station after being individualized from an example chain;

FIG. 61 depicts a number of example actions which may be executed to singulate a bag from a chain of bags;

FIG. 62A depicts an example dispenser assembly which may be included in certain fill stations;

FIG. 62B depicts an example dispenser assembly which may be included in certain fill stations;

FIG. 63 depicts an exploded view of a portion of an example cartridge which may be installed in certain fill stations;

FIG. 64 depicts a bottom plan view of an example cartridge and irradiation assembly;

FIG. 65 depicts an example cartridge and irradiation assembly aligned with a port of an example bag;

FIG. 66A depicts a port of an example bag within an example cartridge and being irradiated by an example irradiation assembly;

FIG. 66B depicts a view of a port of an example bag disposed partially within a cartridge for a filling station;

FIG. 67A depicts a dispensing sharp of a cartridge extending through a septum of a port of an example bag;

FIG. 67B depicts a view of a port of an example bag advanced into a cartridge for a filling station;

FIGS. 68A-C depict views of another example cartridge and irradiation assembly;

FIG. 69 depicts another example cartridge and irradiation assembly;

FIG. 70 depicts a block diagram of a portion of an example filling station including an example cartridge;

FIG. 71 depicts another example cartridge and irradiation assembly;

FIG. 72 depicts a view of the example cartridge and irradiation assembly of FIG. 71 with a portion of the cartridge removed;

FIG. 73 depicts an example filter assembly which may be included in an example cartridge;

FIG. 74 depicts a view through an example air flow channel which may be included in a cartridge;

FIG. 75 depicts a view of a portion of an example fill station;

FIG. 76 depicts a flowchart detailing a number of example actions which may be executed to install a cartridge in an example fill station and fill a reservoir at the fill station;

FIG. 77A depicts a perspective view of another example cartridge;

FIG. 77B depicts an exploded view of the example cartridge of FIG. 77A;

FIG. 78A-B depict views of portions of example cartridges;

FIG. 79A depicts a perspective view of another example cartridge;

FIG. 79B depicts an exploded view of the example cartridge of FIG. 79A;

FIG. 80A-B depict exploded views of an example filter assembly which may be included in a cartridge;

FIG. 81A depicts a perspective view of another example cartridge;

FIG. 81B depicts an exploded view of the example cartridge of FIG. 81A;

FIG. 82A depicts a bottom plan view of an example cartridge;

FIG. 82B depicts a cross-sectional view taken at the indicated cut plane of FIG. 82A;

FIGS. 83A-C depict a number of cross sectional views of the example cartridge of FIG. 81A;

FIG. 84 depicts a flowchart detailing a number of example actions which may be executed to install a cartridge in a filling station;

FIG. 85 depicts an exemplary filling station;

FIG. 86 depicts a perspective view of an example cartridge mount which may be included in a filling station;

FIG. 87 depicts an example filling station with a cartridge installed therein;

FIG. 88A depicts a perspective view of an example cover removal assembly for removing a cover body from a cartridge;

FIG. 88B depicts an exploded view of an example cover removal assembly;

FIG. 89 depicts a cross-sectional view of an example fill station in a cartridge exchange state with a cartridge installed therein;

FIG. 90 depicts a cross-sectional view of an example fill station with a cartridge displaced to an access position;

FIG. 91A depicts a cross-sectional view of example sealing member which may be included in a cover removal assembly in place against a wall of a portion of an enclosure of a system;

FIG. 91B depicts the example sealing member and enclosure of FIG. 91A with an example cartridge in an access position;

FIG. 92 depicts a cross-sectional view of an example cartridge in an access position at an example fill station with a cover body for the cartridge removed by an example cover removal assembly;

FIG. 93 depicts a cross-sectional view of an example cartridge in an access position at an example fill station with a cover engagement assembly of an example cover removal assembly in an engaged state with the cover of the cartridge;

FIG. 94 depicts a cross-sectional view of an example cartridge in an access position at an example fill station with a cover of the cartridge displaced out of engagement with the cartridge by an example cover removal assembly;

FIGS. 95A-B depict views of an example clean air output;

FIG. 96 depicts a perspective view of an example clean air output and an clean air output actuator;

FIG. 97 depicts a perspective view of a portion of an enclosure;

FIG. 98 depicts a cross-sectional view of an example fill station, cartridge, and clean air output;

FIG. 99 depicts a cross-sectional view of an example clean air output with a yoke of a clean air output actuator magnetically coupled to the clean air output through the wall of the enclosure;

FIG. 100 depicts an exploded view of a portion of an example cover removal assembly;

FIG. 101 depicts a cross-sectional view of an example cartridge, filling station, and cover removal assembly;

FIG. 102 depicts a cross-sectional view of a sealing member of an example cover removal assembly compressed against a rim surrounding a fenestration in an enclosure;

FIG. 103 depicts a cross-sectional view of a sealing member of an example cover removal assembly compressed against a rim surrounding a fenestration in an enclosure and a sealing member of an example cartridge compressed against an opposing surface of the enclosure and surrounding the fenestration;

FIG. 104 depicts a cross-sectional view of an example cartridge in an access position at an example fill station with a cover body for the cartridge removed by an example cover removal assembly;

FIG. 105 depicts a perspective view of an example fill station with an irradiation assembly displaced adjacent a portion of a cartridge;

FIG. 106A depicts a cross-sectional view of a port of an example cartridge being displaced into a receptacle of an example supply manifold;

FIG. 106B depicts a cross-section view of a port of an example cartridge further displaced into the receptacle of the example supply manifold;

FIG. 107 depicts a flowchart detailing a number of example actions which may be executed to prime a cartridge installed in a filling station;

FIG. 108 depicts an example priming line;

FIG. 109 depicts another example priming line;

FIG. 110 depicts an example fill displacement stage;

FIG. 111 depicts an example filling station with a priming line in a port retainer of a fill displacement station of the example filling station;

FIG. 112 depicts a priming line advanced into an example cartridge such that the dispensing sharp of the example cartridge extends into the priming line;

FIG. 113 depicts an example irradiation assembly, irradiation assembly actuator, and priming line retainer with an example priming line therein;

FIG. 114 depicts an example fill displacement stage having a priming line retainer;

FIG. 115 depicts a flowchart detailing a number of example actions which may be executed to fill a bag at an example filling station;

FIG. 116 depicts a portion of an example fill station with a bag retained in place by port retainers of the fill displacement stage of the example fill station;

FIG. 117 depicts a cross-section of an example fill station with a port of a bag advanced into an irradiation position within an example cartridge in place at the filling station;

FIG. 118 depicts a bag being filled via an example cartridge at an example filling station;

FIG. 119 depicts a flowchart detailing a number of example actions which may be executed to remove a cartridge from a filling station;

FIG. 120A depicts a top plan view of an example processing compartment and transfer chamber which may be included in a system;

FIGS. 120B-C depict an example bag retention assembly grasping a filled bag at an example filling station;

FIG. 121 depicts a filled bag displaced into an example transfer chamber by an example bag retention assembly;

FIG. 122 depicts an example bag retainer;

FIGS. 123-124 depict a filled bag being handed off from an example bag retention assembly to an example bag retainer in an example transfer chamber;

FIG. 125 depicts a filled bag retained on an example bag retainer and isolated within an example transfer chamber;

FIG. 126 depicts a gripper assembly of a gantry assembly in an outfeed chamber of a system grasping a filled bag on an example bag retainer in a transfer chamber;

FIG. 127 depicts a filled bag held in a gripper assembly of a gantry assembly;

FIGS. 128A-139B depict a variety of example mix assisting assemblies;

FIG. 140A depicts a rear perspective view of the example mix assisting assembly of FIG. 139A with a rear panel removed;

FIG. 140B depicts a detailed view of the indicated region of FIG. 140A;

FIG. 141A depicts a view of an example mix assisting assembly including doors which are in an open state;

FIG. 141B depicts a rear view of the example mix assisting assembly of FIG. 141A;

FIG. 142A depicts a filled bag in place within an example mix assisting assembly;

FIG. 142B depicts a rear view of the example mix assisting assembly of FIG. 141A with the doors in a closed state;

FIG. 143 depicts a perspective view of an example door which may be included in a mix assisting assembly;

FIG. 144 depicts a flowchart detailing a number of example actions which may be executed to mix contents of a reservoir with a mix assisting assembly of the type shown in FIG. 141A;

FIG. 145 depicts a block diagram of an example particulate inspection system;

FIG. 146A depicts a perspective view of an example particulate inspection system;

FIG. 146B depicts a perspective view of an example particulate inspection system with a bag type reservoir installed therein;

FIG. 146C depicts a cross-sectional view of an example particulate inspection system;

FIG. 147A depicts a representation of an image of a reservoir in a particulate inspection system;

FIG. 147B depicts an enlarged view of a portion of FIG. 147A;

FIGS. 148A-B depict diagrams of collimated light passing through a bubble;

FIGS. 149A-D depict a progression of image representations of a reservoir in which a bubble is displacing over a period of time;

FIG. 150 is a representation of an image of a reservoir in place in a particulate inspection system;

FIG. 151 depicts a representation of an image of a reservoir having a number of various pieces of particulate therein;

FIGS. 152A-D depict a progression of image representations in which a piece of particulate is displacing within a reservoir of time;

FIG. 153 depicts a data flow diagram for a particulate inspection system;

FIG. 154 depicts a flowchart detailing a number of example actions which may be executed to inspect a reservoir with a particulate inspection system and route the reservoir through a system based on the inspection result;

FIG. 155 depicts a flowchart detailing a number of example actions which may be executed to detect, track, and classify regions of interest within a reservoir and generate a pass/fail determination for the reservoir;

FIG. 156 depicts a flowchart detailing a number of example actions which may be executed to detect regions of interest within a reservoir;

FIG. 157 depicts a representation of a raw image of a reservoir in place at a particulate inspection system;

FIG. 158A depicts a representation of a foreground segmented image of a reservoir in place in a particulate inspection system;

FIGS. 158B-C depict enlarged views of the indicated regions in FIG. 158A;

FIG. 159 depicts a representation of an example image of edge detections after a morphological transformation;

FIG. 160A depicts a representation of an near edge filtered foreground segmented image;

FIGS. 160B-C depict enlarged views of the indicated regions in FIG. 160A;

FIG. 161 depicts a representation of the image of FIG. 160A after a morphological transformation;

FIG. 162 depicts a representation of the image of FIG. 161 with pixel clusters having an area greater than a predefined threshold removed;

FIG. 163A depicts a representation of the image of FIG. 162 after a morphological transformation;

FIGS. 163B-C depict enlarged views of the indicated regions in FIG. 163A;

FIG. 164A depicts a representation of the image of FIG. 157 with bounding boxes applied around detected regions of interest;

FIG. 164B depicts an enlarged view of the indicated region of FIG. 164A;

FIG. 165A depicts a representation of an image of a reservoir in place at a particulate inspection systems taken some period of time after the image of FIG. 157 with bounding boxes applied around detected regions of interest;

FIG. 165B depicts an enlarged view of the indicated region of FIG. 165A;

FIG. 166 depicts a flowchart detailing a number of example actions which may be executed to track regions of interest over a series of frames of a reservoir in place in a particulate inspection system;

FIG. 167 depicts a flowchart detailing a number of example actions which may be executed to score and classify regions of interest detected in a reservoir in place at a particulate inspection system;

FIG. 168A depicts an example annotated image of a reservoir in place at a particulate inspection system showing a number of tracks for detected regions of interest;

FIG. 168B depicts an example annotated image of a reservoir in place at a particulate inspection system showing a number of tracks for detected regions of interest;

FIG. 169 depicts a block diagram of an example marking assembly which may be included in a system;

FIG. 170 depicts a perspective view of an example marking assembly;

FIG. 171 depicts another perspective view of a portion of a marking assembly including an embossing head;

FIG. 172 depicts a perspective view of a portion of a marking assembly including an embossing head;

FIG. 173 depicts a block diagram of an example embossing head;

FIG. 174 depicts a block diagram of an example embossing head;

FIG. 175 depicts a side view of an example rotor which may be included in an embossing head;

FIG. 176 depicts a flowchart detailing a number of example actions which may be executed to place a string of marking bodies in desired relative positions in an embossing head;

FIGS. 177A-B depict exploded views of an example embossing head;

FIGS. 178A-B depict exploded views of a portion of an example embossing head;

FIG. 179 depicts a side view of an example rotor which may be included in an example embossing head;

FIG. 180 depicts a cross-sectional view of a portion of an example embossing head;

FIGS. 181A-181B depict exploded views of a portion of an example embossing head;

FIG. 182A depicts a perspective view of an imager viewing a marked region of a bag held by a grasper;

FIG. 182B depicts a representation of an image of a marked region of a bag captured by the imager such as that shown in FIG. 182A;

FIG. 182C depicts a representation of an analyzed image of a marked region of a bag which may be included in a log for the respective bag;

FIG. 183 depicts a block diagram of an example outfeed assembly which may be included in a system;

FIGS. 184-186 depict views of a portion of an outfeed assembly including outfeed drawers;

FIG. 187 depicts an exploded view of an example drawer slide assembly;

FIGS. 188A-C depict views of an example drawer slide assembly;

FIG. 189 depicts a top plan view of a portion of a system showing an outfeed assembly of the system partially filled with reservoirs;

FIG. 190 depicts a gantry assembly positioning a reservoir over an example access controlled reservoir receptacle of an example outfeed assembly;

FIG. 191 depicts an example outfeed assembly including a set of drawers and a separate access controlled receptacle for rejected reservoirs;

FIGS. 192A-C depict a block diagrams of portions of a fluid handling system which may be included in example systems for producing and packaging fluids;

FIG. 193A depicts a perspective view of an example accumulator reservoir;

FIG. 193B depicts a cross-sectional view of the example accumulator reservoir of FIG. 193A;

FIG. 194 depicts a block diagram of an example pneumatic distribution assembly for an example system;

FIG. 195 depicts a block diagram of an example air preparation assembly which may be included in a pneumatic distribution assembly;

FIG. 196 depicts a block diagram depicting an exemplary set of pneumatic valve banks associated with example components of a system;

FIG. 197 depicts a block diagram of an example negative pressure distribution assembly which may be included in a pneumatic distribution system;

FIG. 198 depicts a block diagram of an example air handling assembly which may be included in example systems for producing and packaging fluids;

FIG. 199 depicts a perspective view of a portion of an example system including an air handling assembly; and

FIGS. 200A-F depict a series of cross-sections through the portion of the system depicted in FIG. 199.

### DETAILED DESCRIPTION

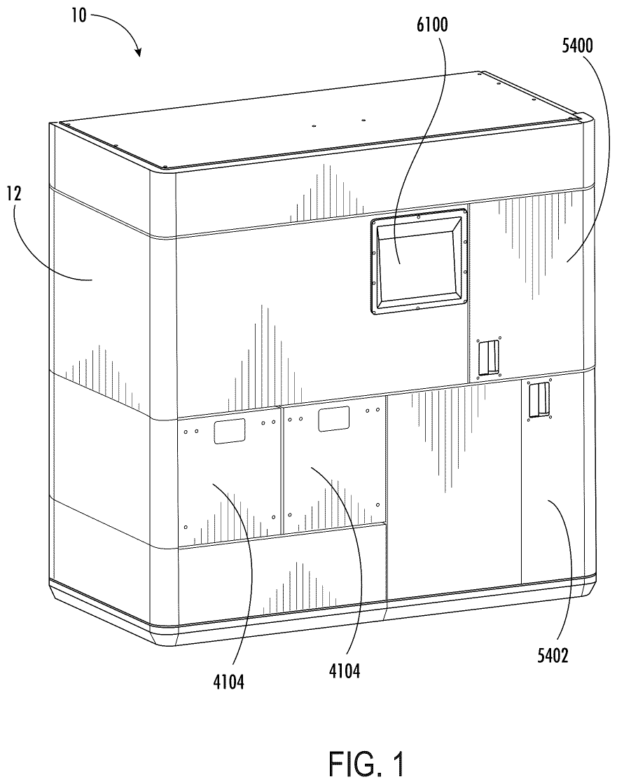

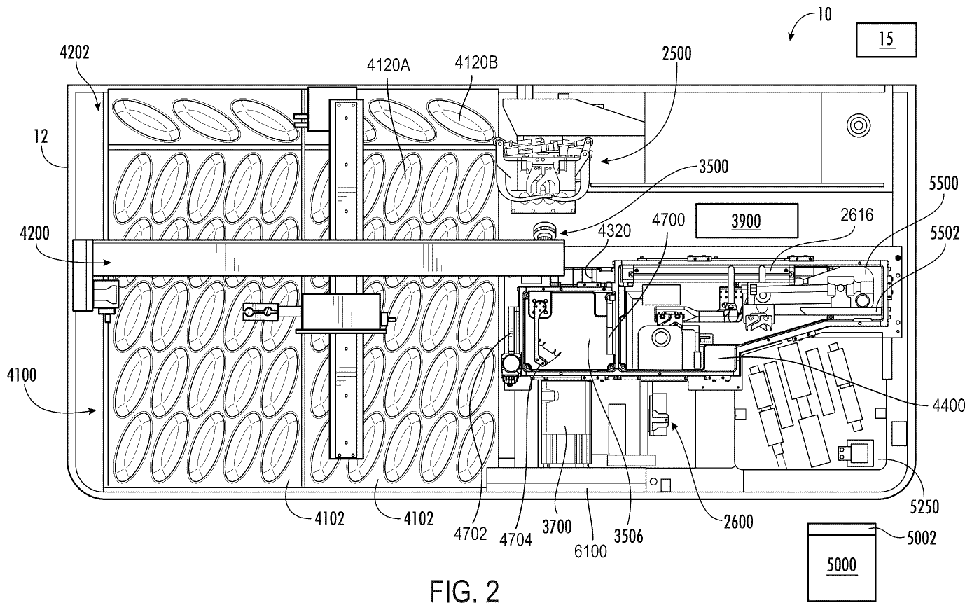

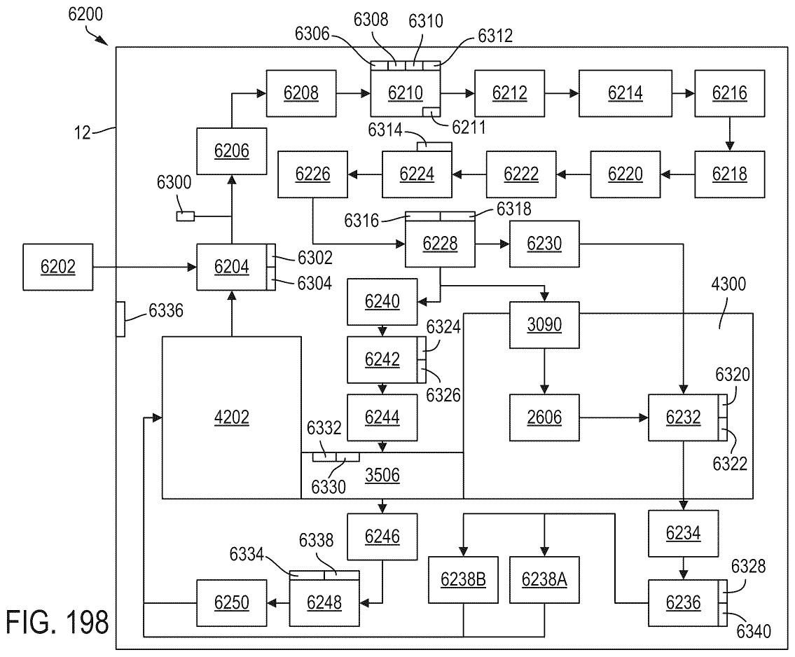

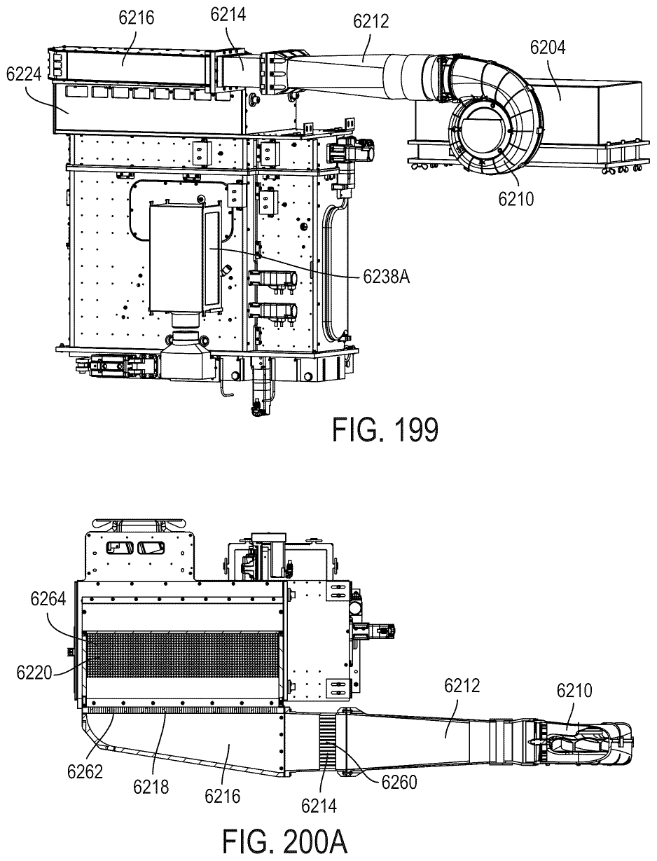

Referring now to FIGS. 1-2, a perspective view of an example system 10 and top plan view of a portion of an example system 10 are respectively depicted. As shown, a system 10 may include an enclosure 12 with a number of compartments 4300, 3506, 4202 and an exterior wall. The system 10 may also include an air handling assembly 6200 (see, e.g., FIG. 199) disposed above the compartments which is not depicted in FIG. 2 in order to better illustrate the interior compartments 4300, 3506, 4202. The air handling assembly 6200 may supply a flow of clean (e.g. HEPA or ULPA filtered air) to the interior compartments of the enclosure 12. The air may be conditioned to flow in laminar fashion and may be provided and routed through the enclosure 12 to satisfy minimum air flow rate, pressure, and particulate criteria for the various compartments or zones within each compartment. An example air supply assembly 6200 is described in greater detail in relation to FIG. 198. The enclosure 12 may include various doors 5400, 5402 to load or replace consumable components of the system 10. The enclosure 12 may also include one or more outfeed access through which filled reservoirs may be collected from the system 10. Two outfeed drawers 4102 are shown in the example embodiment.

The system 10 may receive bags 26 from a dispenser 5000 which are supplied in a state in which they are coupled to one another. The dispenser 5000 may be loaded into a system 10 via a docking assembly 5250 which may be accessed by unlocking and opening a docking assembly door 5400 of the enclosure 12. The dispenser 5000 may be sealed and terminally sterilized (e.g. ethylene oxide, e-beam, gamma irradiation, autoclaved, etc.). The dispenser 5000 may be displaced by the docking assembly 5250 relative to the enclosure 12. The system 10 may also include a sanitary interface assembly 5500. With the dispenser 5000 displaced to an access position relative to the enclosure 12, the sanitary interface assembly 5500 may expose the interior of the dispenser 5000 to a processing compartment 4300 of the enclosure 12. This may be accomplished by separating a removable cover assembly 5002 or cap from the dispenser 5000. The processing compartment 4300 may be environmentally controlled. The sanitary interface assembly 5500 may ensure that the dispenser 5000 is accessed in a manner which does not adversely impact the environment within the processing chamber 4300.

In certain examples, the sanitary interface assembly 5500 may include an infeed aperture plug 5502. Example infeed aperture plugs 5502 may also be referred to herein as dispenser outlet cover interfaces. When the removable cover assembly 5000 and infeed aperture plug 5502 are brought into contact with one another, seals may be formed. The seals may isolate surfaces of a removable cover assembly 5002 and infeed aperture plug 5502 which are exposed to the ambient, surrounding environment. The removable cover assembly 5002 and infeed aperture plug 5502 may also couple to one another (e.g. via application of a vacuum to a sealed volume between the two). The sanitary interface assembly 5500 may displace the removable cover assembly 5002 in tandem with the infeed aperture plug 5502 to a stowed position within the processing compartment 4300. This may establish communication between the interior of the dispenser 5000 and the environment of the processing compartment 4300. This may be accomplished without exposing the processing chamber 4300 or interior of the dispenser 5000 to components previously in communication with the external environment. The infeed aperture plug 5502 is shown in the stowed position in FIG. 2 for sake of illustration. Typically the infeed aperture plug 5502 would be sealingly positioned against the processing chamber wall 4301 of the enclosure 12 when a dispenser 5000 is not installed in the system 10.

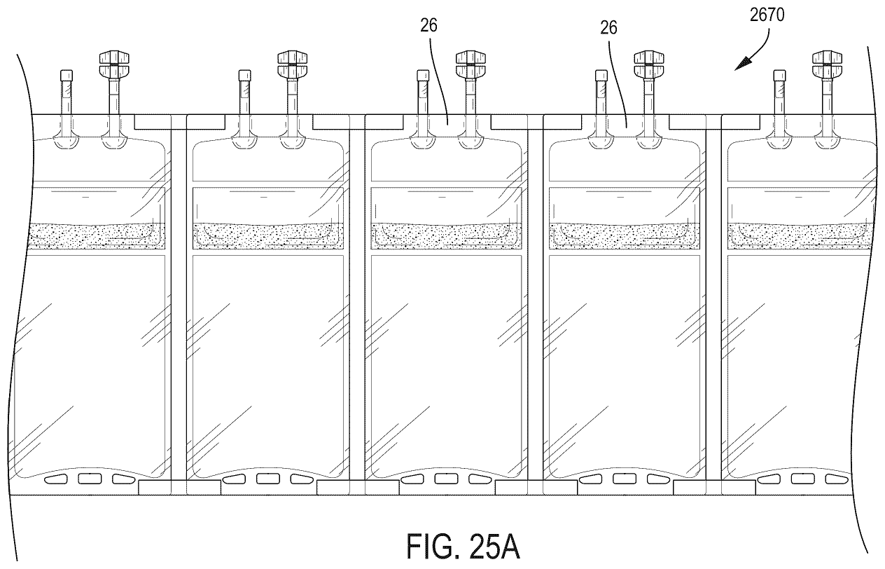

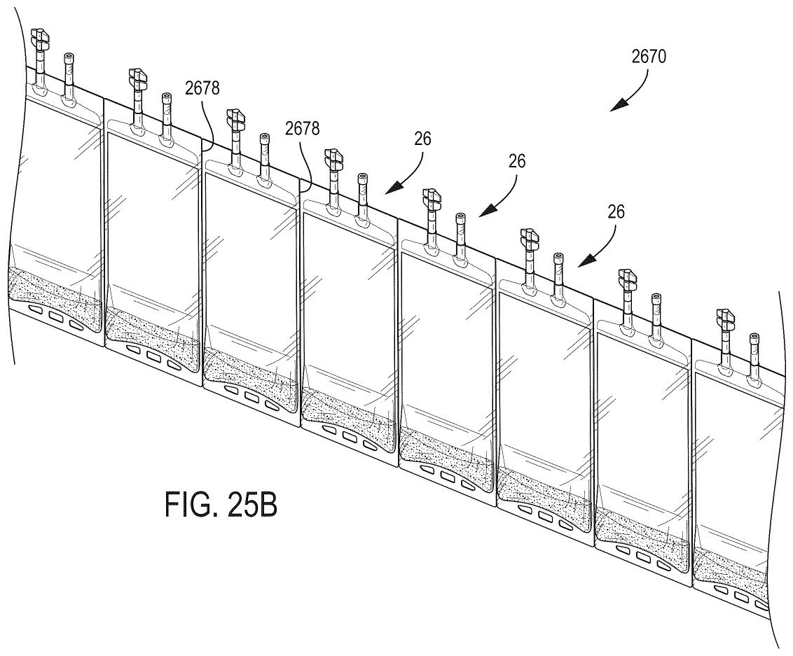

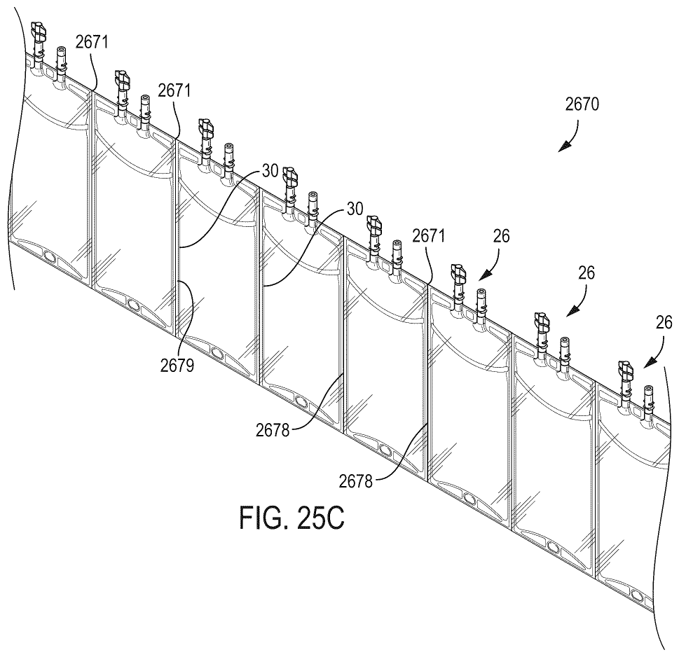

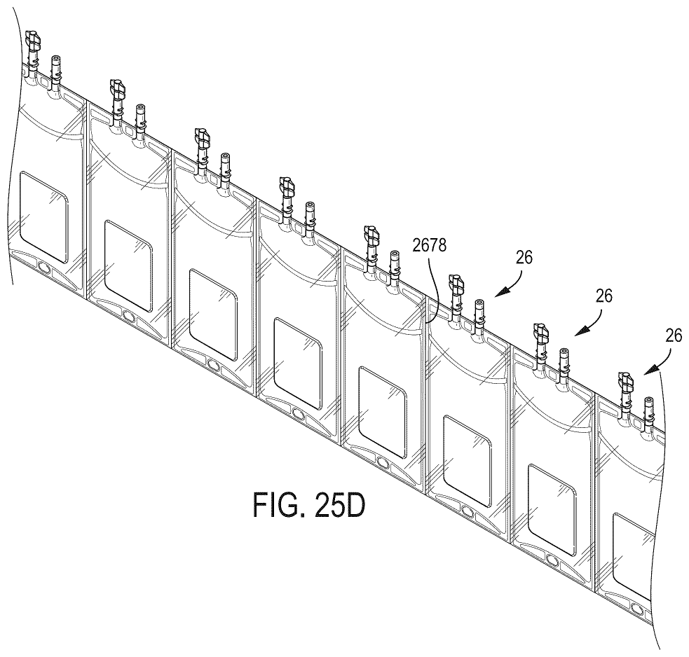

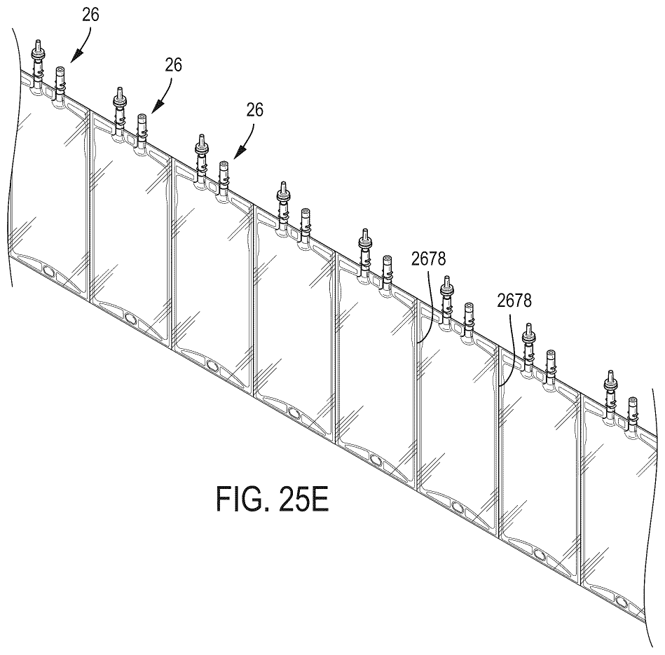

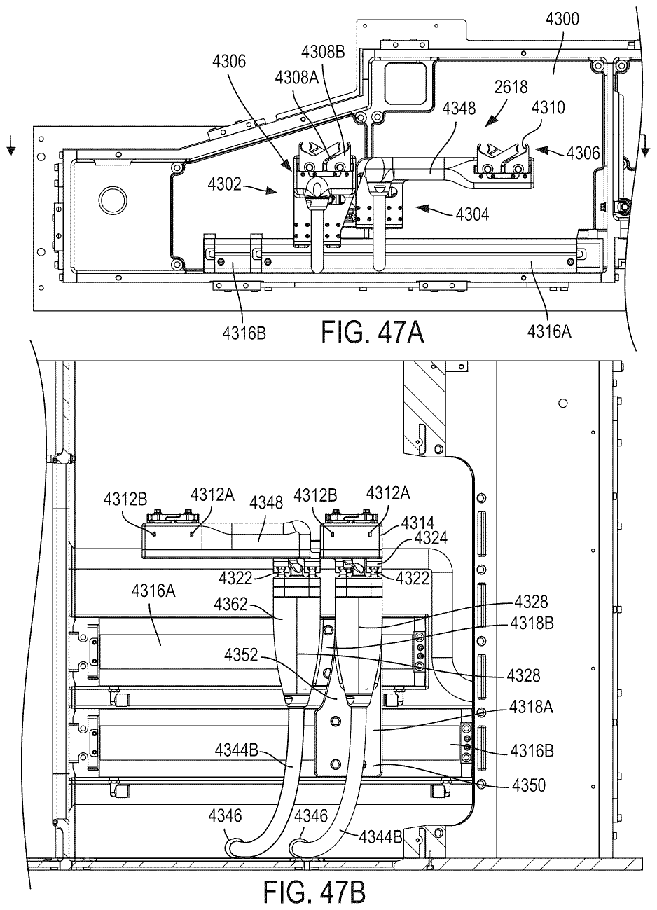

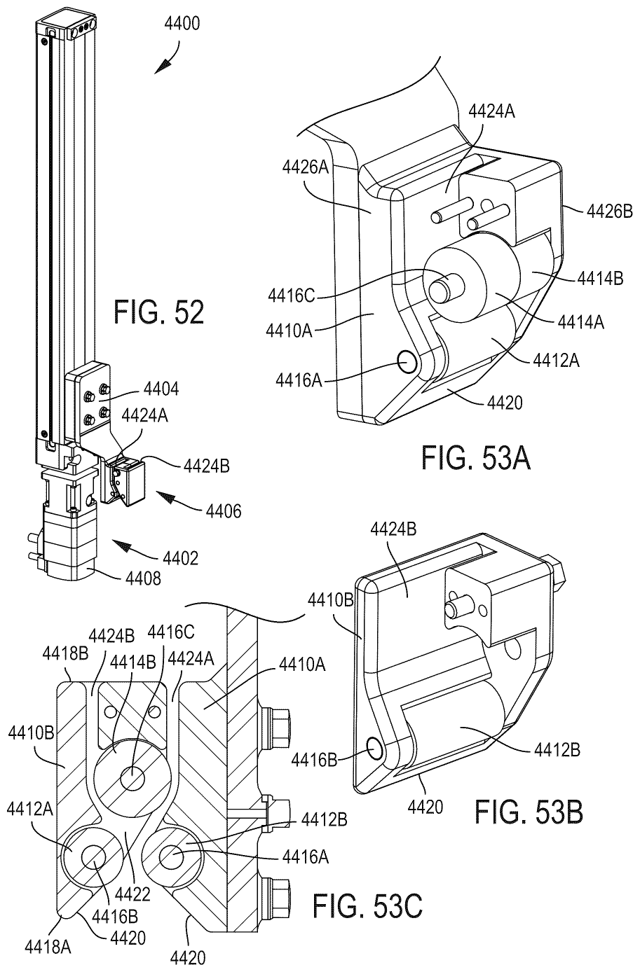

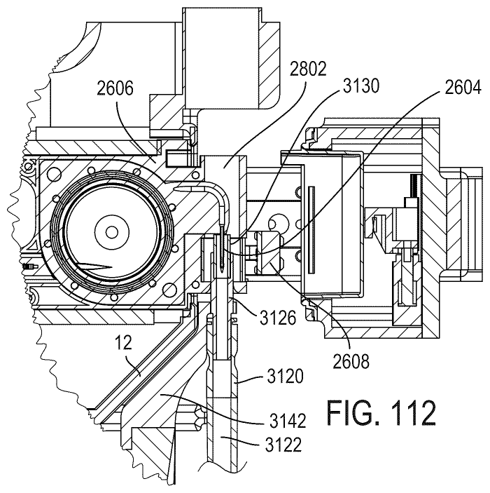

A bag displacement assembly 2618 disposed in the processing compartment 4300 may include one or more bag retainers (e.g. pneumatic graspers) disposed on a respective displacement stage (see, e.g., FIG. 47A). A filling station 2600 may also be included in the processing compartment 4300 and may include at least one bag retainer on a displaceable stage (see, e.g. FIG. 111). The bag displacement assembly 2618 may be actuated to collect and displace the chain 2670 (see, e.g., FIG. 25E) of bags 26 out of the dispenser 5000 and into the processing chamber 4300. Bags 26 may be individualized from the chain 2670 at a singulating assembly 4400 (see, e.g., FIG. 52).

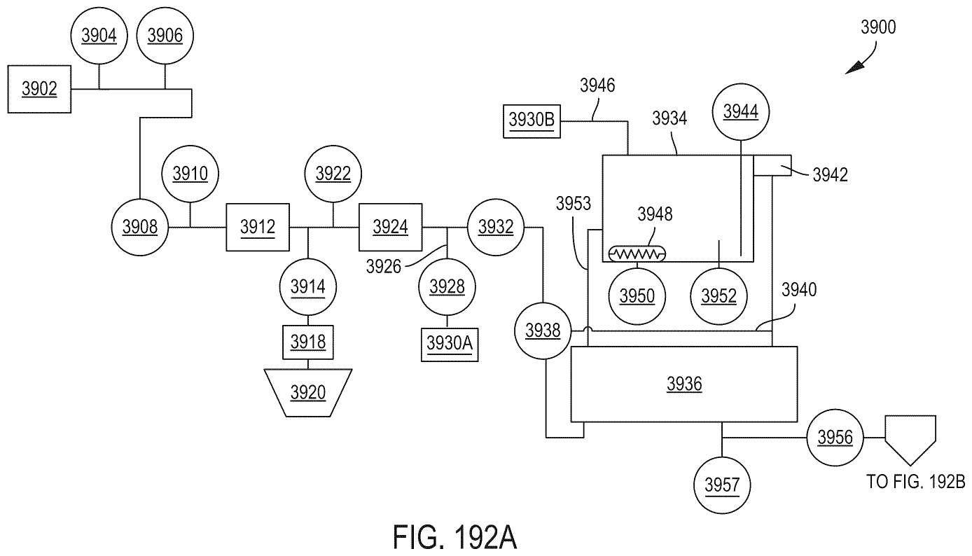

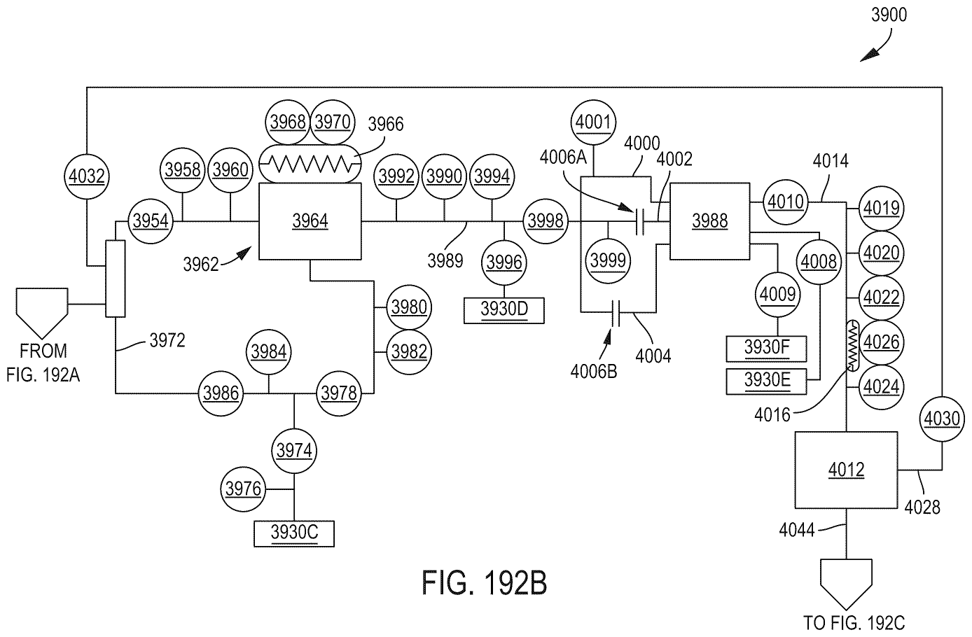

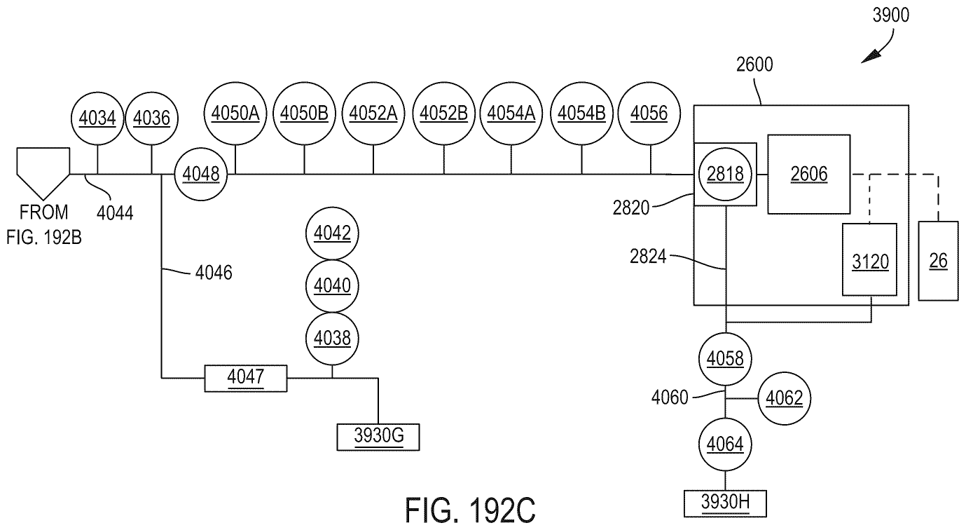

The filling station 2600 may be in fluid communication with a fluid handling system 3900 (see, e.g., FIGS. 192A-C) which provides water or diluent meeting predetermined quality criteria to the filling station 2600. For example, the fluid handling system 3900 may generate pharmacopeia grade water (e.g. Water for Injection quality water or WFI) for the filling station 2600. The fluid handling system 3900 may also precisely meter fluid supplied to the filling station 2600 to fill a predetermined target volume of fluid into bags 26 resident at the filling station 2600. In alternative examples, a fluid handling system 3900 which mixes a fluid may be included. Any fluid mixing arrangements described in U.S. Pat. No. 11,965,766, issued Apr. 23, 2024, entitled Medical Treatment System and Methods Using a Plurality of Fluid Line (Attorney Docket No. 00101.00343.Z55) or U.S. Pat. No. 11,980,587, issued May 14, 2025, entitled Systems, Methods, and Apparatuses for Producing and Packaging Fluids (Attorney Docket No. 00101.00325.AA697) each of which being incorporated by reference herein in its entirety may be used. Once a bag 26 has been filled and singulated, the bag 26 may be collected by the bag displacement assembly 2618 and displaced into a transfer chamber or compartment 3506.

Various hardware and components in communication with the processing compartment 4300 (and other compartments of the enclosure 12) may be selected to be cleanroom appropriate. For example, any fastener may be cleanroom rated. Components with moving parts may be selected to be cleanroom rated. Pneumatic actuation may be used where possible. Motors may either be cleanroom rated, positioned outside of the processing compartment 4300, or in environmentally sealed housings within the processing compartment 4300. In the latter cases, motion from the motors may be transmitted into the processing compartment 4300 through an environmentally sealed interface. Pneumatic lines, electrical lines, and other cabling may be bundled within an exterior sleeve to facilitate wipe down and may exit or enter the processing compartment 4300 (where needed) through hygienic glands. Such glands may be contoured to facilitate wipe down. Additionally, the walls 4301 defining the processing compartment 4300 may include rounded corners. Components may be selected to be suitable for any cleaning/antimicrobial agents they may be exposed to. For example, components may be compatible with repeated exposure to vaporized hydrogen peroxide (VHP). Aluminum components, for instance may all be anodized where exposure to VHP is possible. A vacuum line may be routed to or adjacent to any potential sources of particulate.

The example transfer chamber 3506 may include a first door 4700 and a second door 4702. The first door 4700 may be opened and closed to establish communication between the transfer chamber 3506 and the processing chamber 4300. The second door 4702 may be opened and closed to establish communication between the transfer chamber 3506 and an outfeed chamber 4202 of the enclosure 12. Each door 4700, 4702 may form an air tight seal when in a closed state which inhibits fluid communication between the transfer chamber 3506 and the respective adjacent compartment, 4300, 4202.

A bag retainer 4704 may be included in the transfer chamber 3506. With the first door 4700 of the transfer chamber 3506 in an open state, the bag displacement assembly 2618 may be actuated to displace a bag 26 into the transfer chamber 3506. The bag displacement assembly 2618 may hand the bag 26 off to the bag retainer 4704 and may subsequently be displaced out of the transfer chamber 3506. The first door 4700 may be closed isolating the bag 26 within the transfer chamber 3506 on the bag retainer 4704. The second door 4202 may be opened and a gantry assembly 4200 may be displaced to retrieve the bag 26 from the bag retainer 4704. The gantry assembly 4200 may remove the bag 26 from the transfer chamber 3506 and displace it into the outfeed chamber 4202. With the bag 26 removed from the transfer chamber 3506, the second door 4704 may be closed. Each time a door 4700, 4702 is opened and closed, the transfer chamber 3506 may be isolated and air may be flowed through the transfer chamber 3506. The system 10 may ensure at least a certain number of air exchanges within the transfer chamber 3506 have occurred before opening another door 4700, 4702. This may allow the transfer chamber 3506 to act as an airlock between the outfeed chamber 4202 and processing chamber 4300 (which may be more stringently controlled).

Once in the outfeed chamber 4202, a bag 26 may be manipulated and inspected at one or more station within the outfeed chamber 4202. In the example depicted in FIG. 2, a mix assisting assembly 2500 is included. A bag 26 may be passed from the gantry assembly 4200 to the mix assisting assembly 2500 and displaced according to a mixing profile or motion profile to help ensure the contents of the bag 26 are homogenized. This may also ensure that any soluble solid concentrate in the bag 26 is dissolved into solution. A particulate inspection system 3500 may image or record the bag 26 and the frames may be analyzed by a control system 15 of the system 10 to determine whether certain contents of interest (e.g. particulate) are present in the bag 26.

The gantry assembly 4200 may transport the bag 26 to a marking assembly 3700 within the outfeed compartment 4202 after inspection. The marking assembly 3700 may provide a marking on the bag 26. If the bag 26 is deemed acceptable for consumption, it may be given a marking indicative of this by the marking assembly 3700. A bag 26 may, for instance, be determined acceptable if no prohibited contents of interest are identified by the particulate inspection system 3500 and sensors of fluid handling assembly 3900 indicate the fluid supplied to the bag 26 met predefined criteria. If the bag 26 is deemed unacceptable, the marking assembly 3700 may mark the bag 26 indicating this to be the case. The gantry assembly 4200 may transfer the bag 26 from the marking assembly 3700 to a receptacle in an outfeed assembly 4100 in the outfeed compartment 4202. Depending on whether the bag 26 is accepted or rejected, the bag 26 may be placed into specific receptacles 4120A, B of an outfeed assembly 4100 (e.g. outfeed drawer 4102). Access to the receptacles 4120A, B (e.g. outfeed drawers 4102) may be controlled such that rejected bags 26 cannot be collected by a user without specialized access credentials. Receptacles 4120A for acceptable bags 26 may be accessed by users presenting a general credential while receptacles 4120B for unacceptable bags 26 may be accessed by users with more specialized credentials. Thus, receptacles 4120B may be referred to herein as access controlled receptacles.

The actuation and coordination of the various assemblies, systems, and stations within the system 10 may be orchestrated by a control system 15 including one or more processor. The control system 15 may also perform analysis and processing to ensure that components of the system 10 are behaving in an anticipated manner and that bags 26 are acceptable for consumption. The control system 15 may generate a log of all activities relating to a single bag 26 with data relevant to the production of that bag 26 from various sensors or systems within the system 10. The log may serve as proof that the bag 26 was produced in accordance with prescribed quality criteria. The control system 15 may also generate screens for display on a graphical user interface 6100 of the system 10 and receive user inputs supplied via the graphical user interface 6100 or other user interface components of the system 10. Screens presented on the graphical user interface 6100 may include instructions, graphics or animations showing an individual how to use the system 10, troubleshooting information, warnings, alerts, alarms, system status screens, login screens, order input screens, and outfeed access request screens.

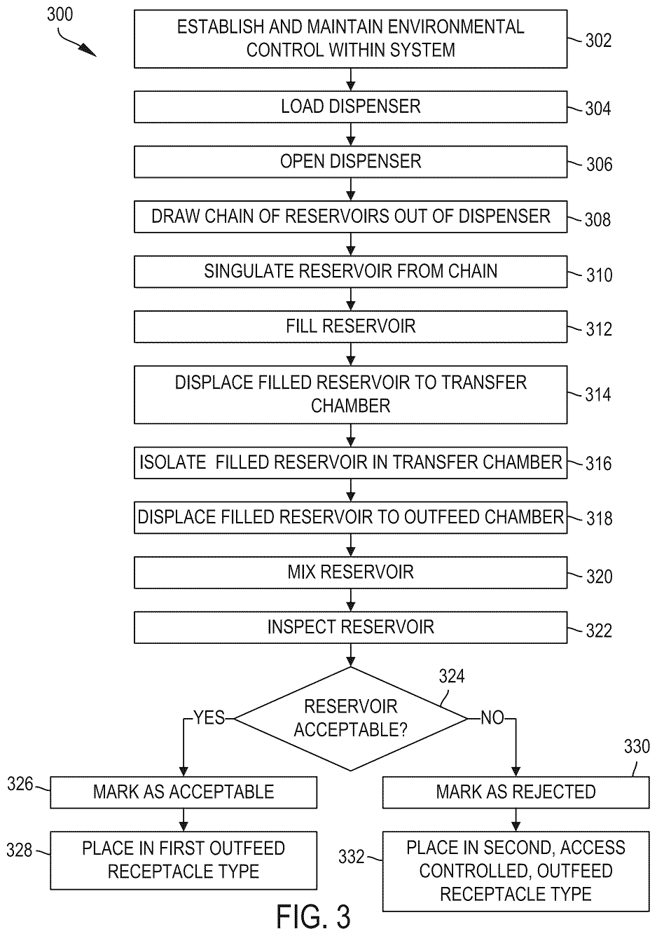

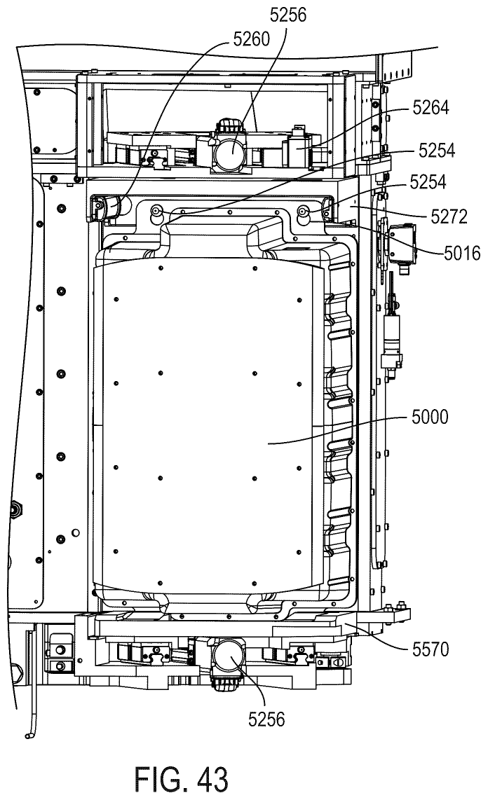

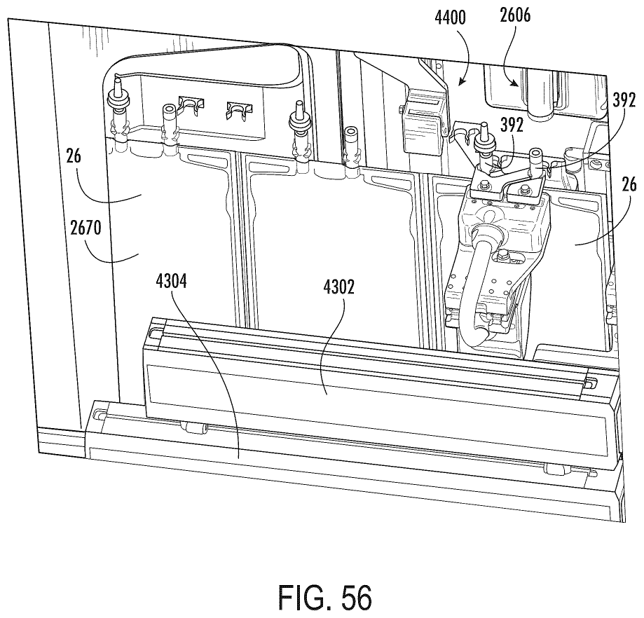

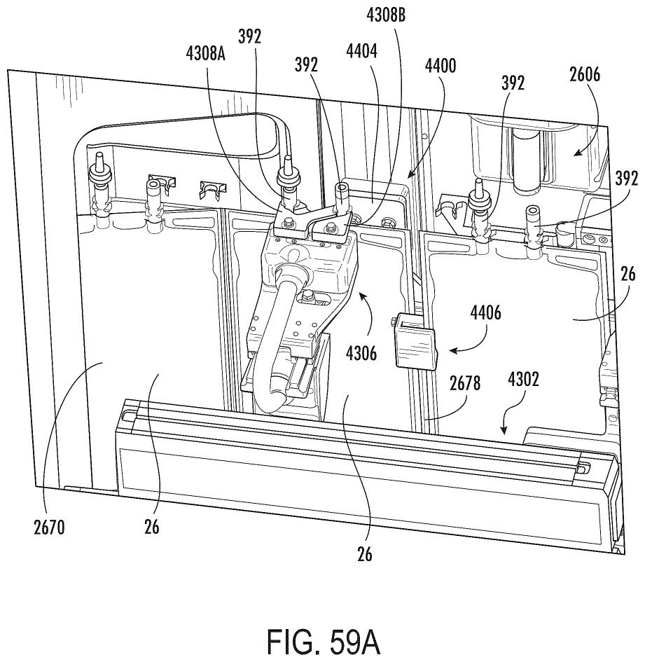

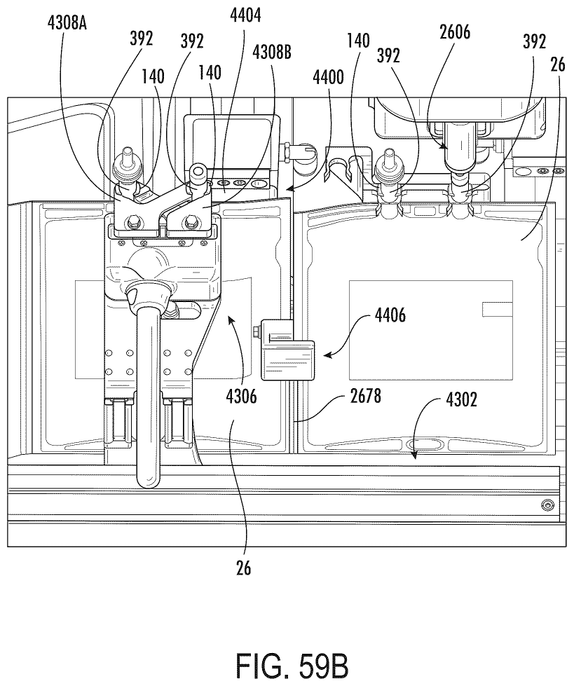

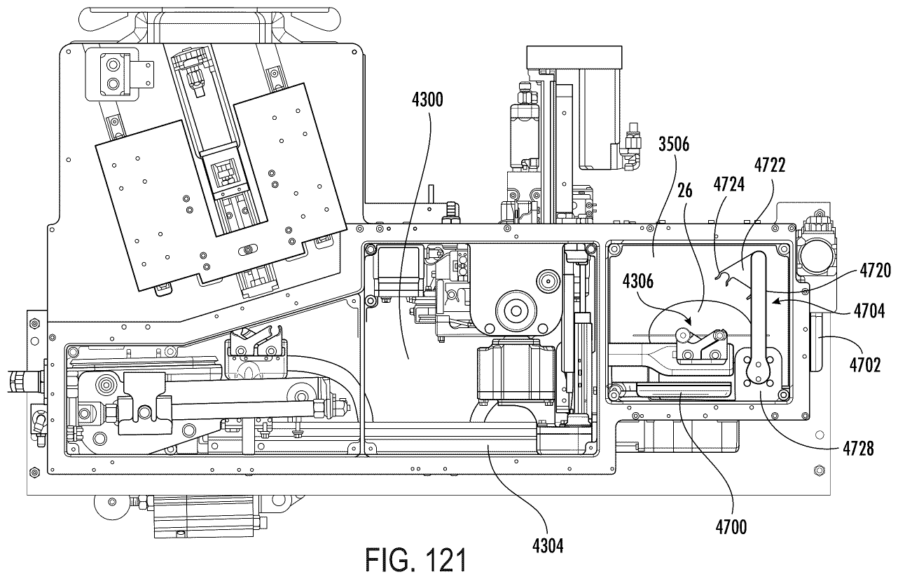

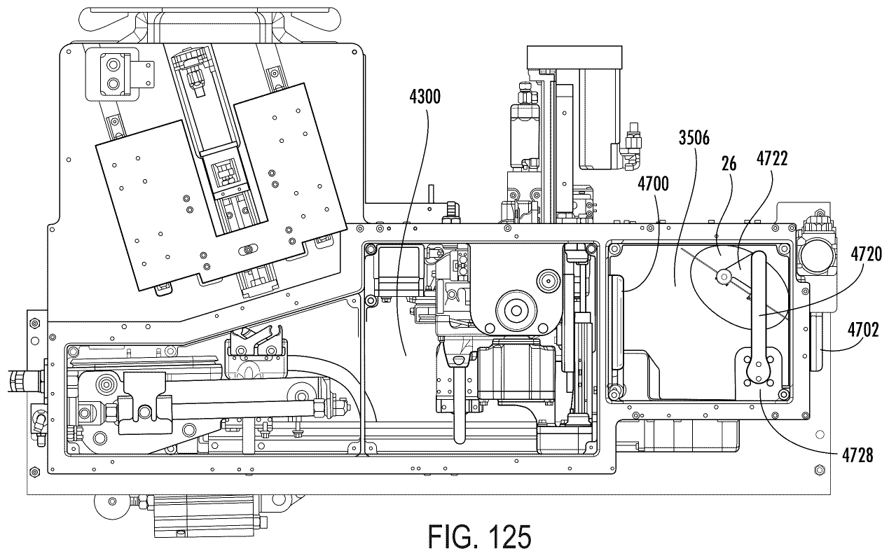

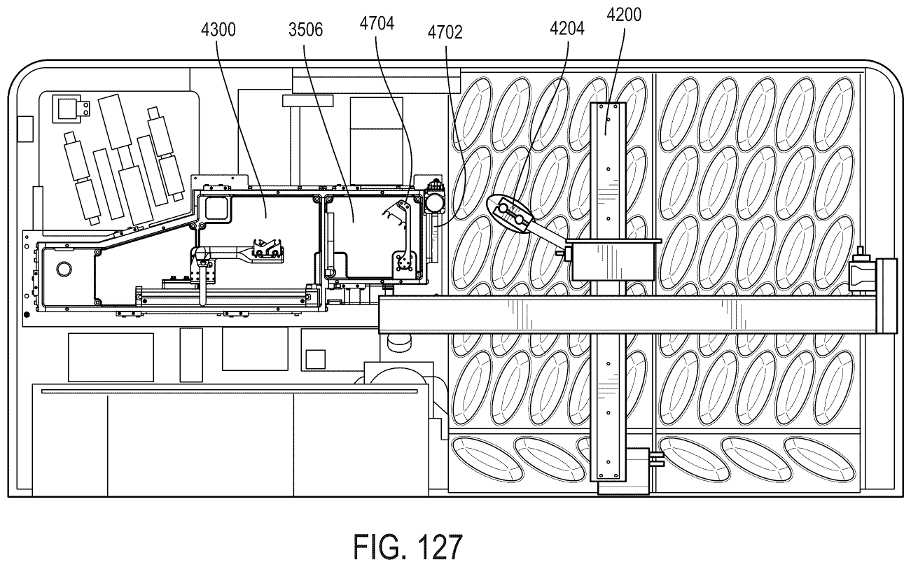

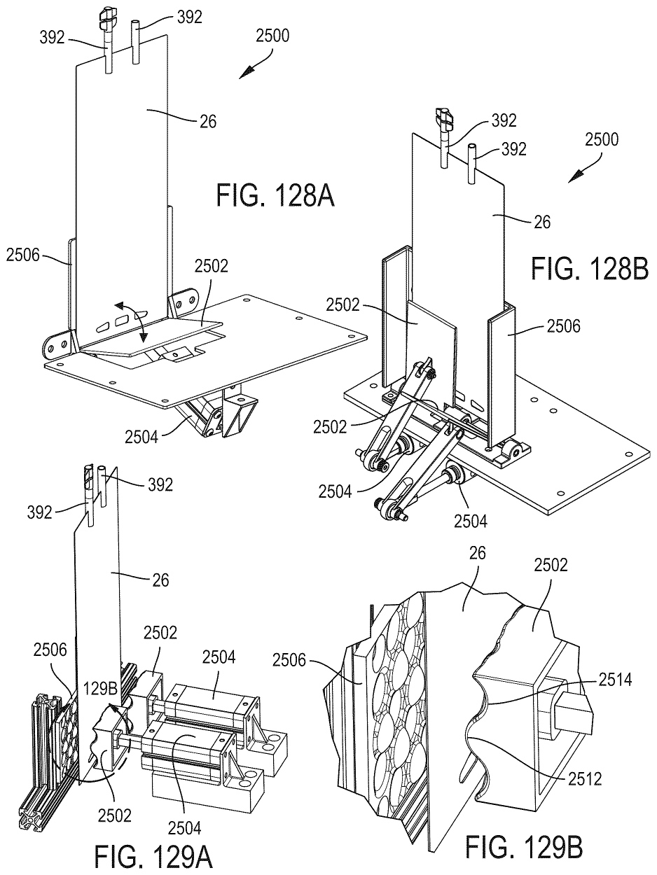

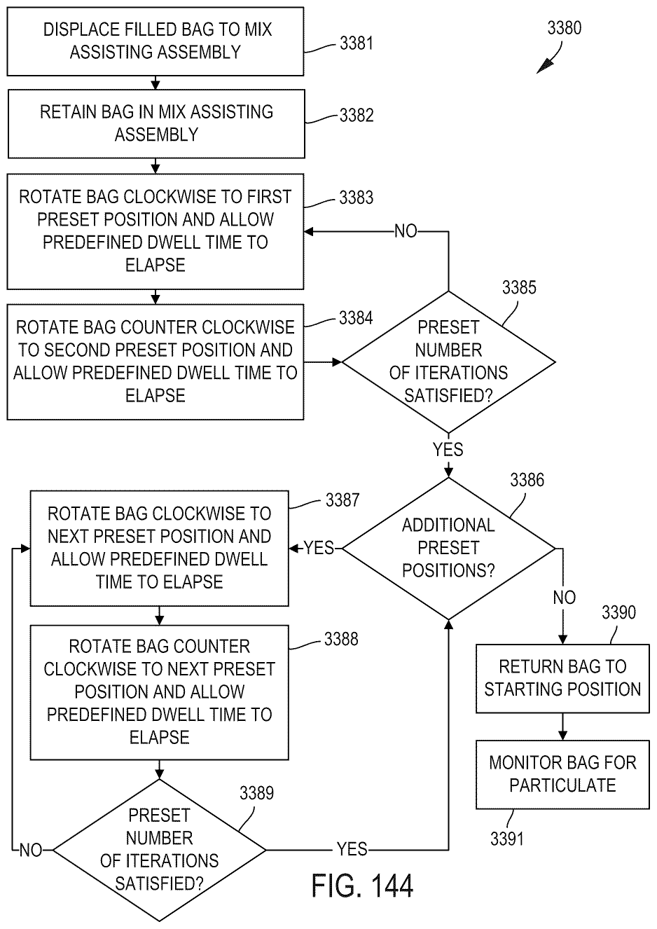

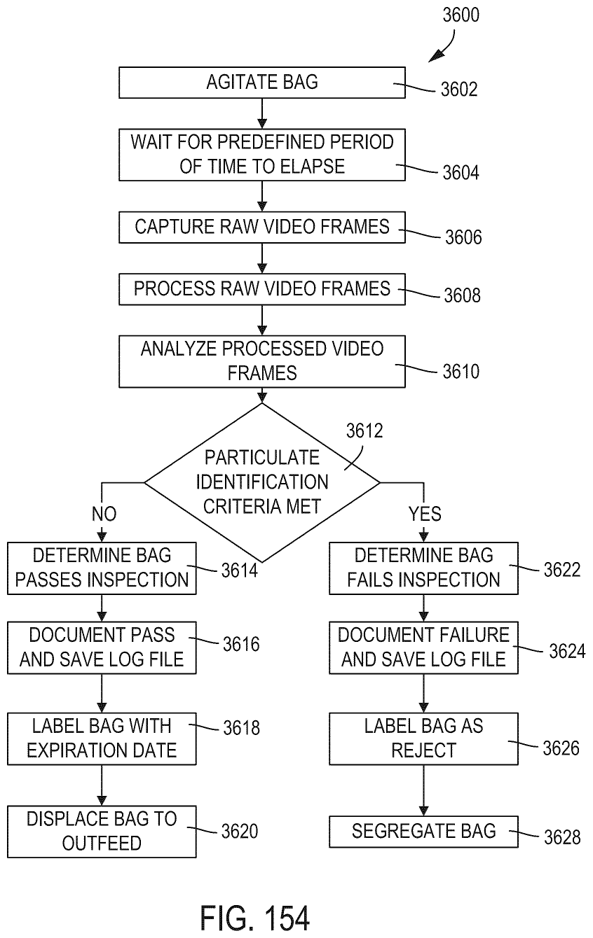

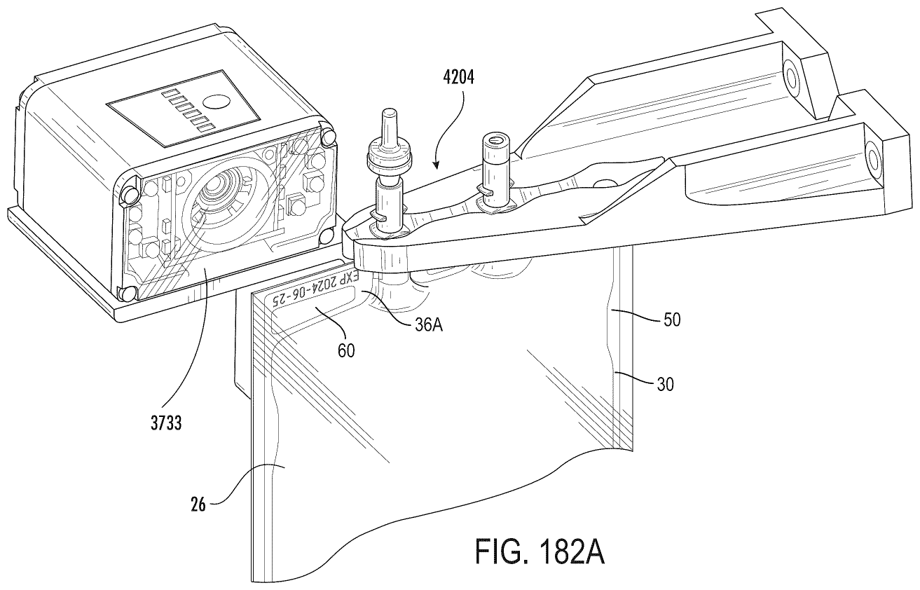

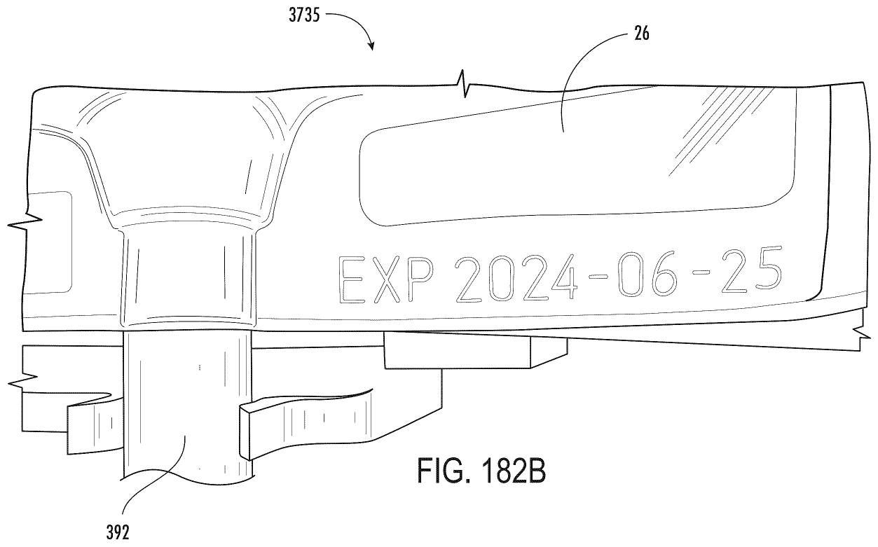

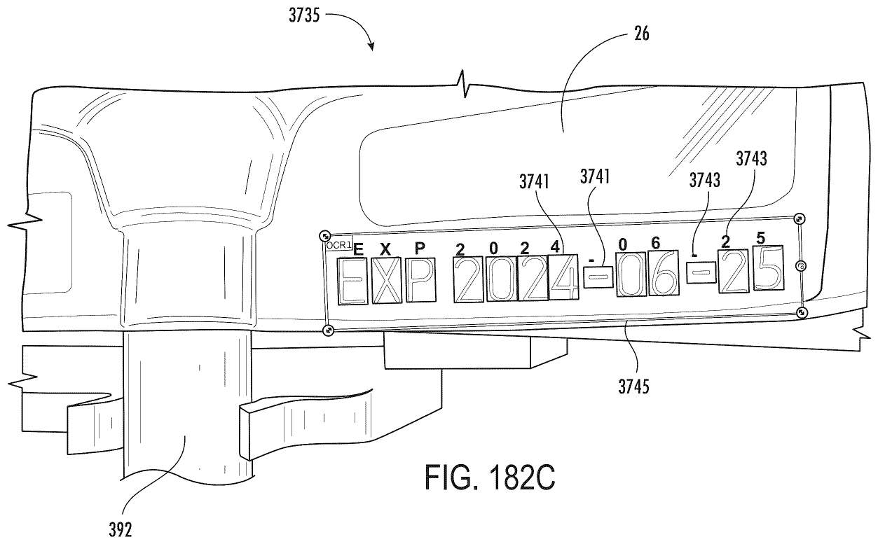

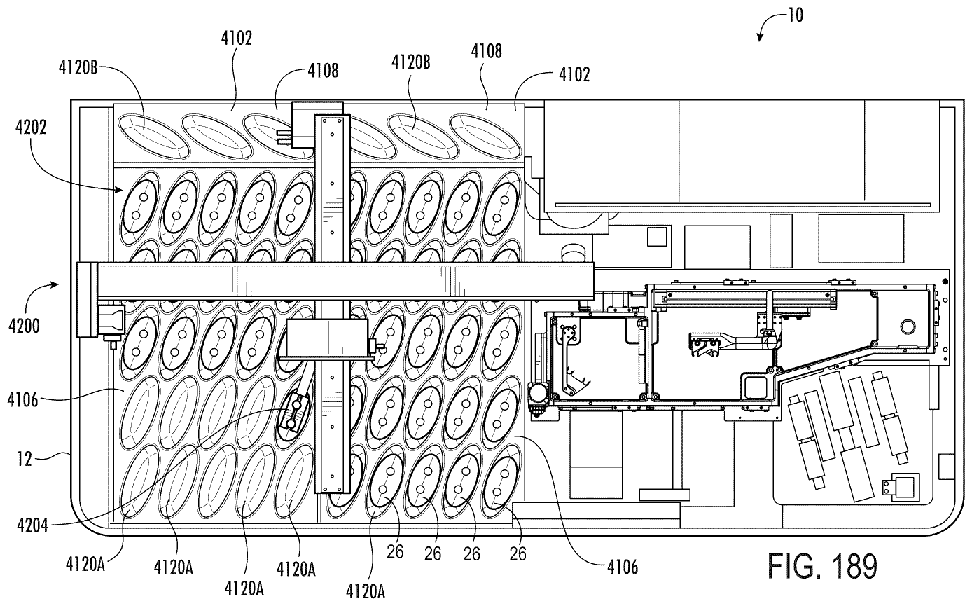

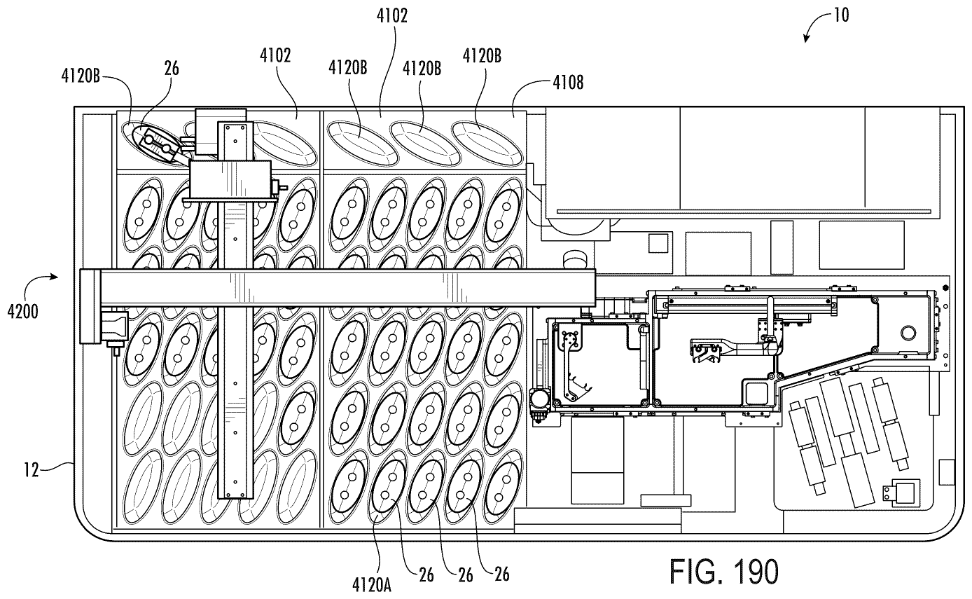

Referring now to FIG. 3 a flowchart 300 is depicted elucidating a number of example actions which may be executed to fill a reservoir with a system 10. In block 302, environmental control within zones of the system 10 may be established and maintained by an air handling assembly 6200 (see, e.g., FIG. 198). A dispenser 5000 may be loaded into a system 10 in block 304 (see, e.g., FIG. 43). In block 306, the dispenser 5000 may be opened via a sanitary interface assembly 5500 of the system 10. A chain 2670 of reservoirs may be drawn out of the dispenser 5000 and into the processing compartment 4300 in block 308 by a bag displacement assembly 2618 of the system 10 (see, e.g. FIG. 56). In block 310, a reservoir may be singulated off the chain 2670 by a singulation assembly 4400 (see, e.g., FIG. 59B). The reservoir may be filled with fluid produced by a fluid handling system 3900 in block 312 (see, e.g. FIG. 118). In block 314, the filled reservoir may be displaced into a transfer chamber 3506 of the system 10 (see, e.g., FIG. 121). The reservoir may be isolated in the transfer chamber 3506 in block 316 (see, e.g., FIG. 125). In block 318, the filled reservoir may be displaced out of the transfer chamber 3506 into an outfeed compartment 4202 (see, e.g., FIG. 127). The contents of the filled reservoir may be mixed at a mix assisting assembly 2500 of the system 10 in block 320 (further described in relation to FIG. 144 for example). In block 322, the reservoir may be inspected for prohibited contents of interest at a particulate inspection system 3500 (further described in relation to FIG. 154 for example). If, in block 324, the reservoir is determined to be acceptable, the reservoir may be marked with a marking assembly 3700 with an indicator that the reservoir is available for use in block 326 (see, e.g., FIG. 182B). The reservoir may then be displaced to a receptacle 4120A in an outfeed assembly 4100 in block 328 (see, e.g., FIG. 189). If, in block 324, the reservoir is determined to be unacceptable, the reservoir may be marked via a marking assembly 3700 with an indication that the reservoir has been rejected in block 330. The rejected reservoir may be deposited in an access controlled receptacle 4120B or an outfeed assembly 4100 in block 332 (see, e.g., FIG. 190).

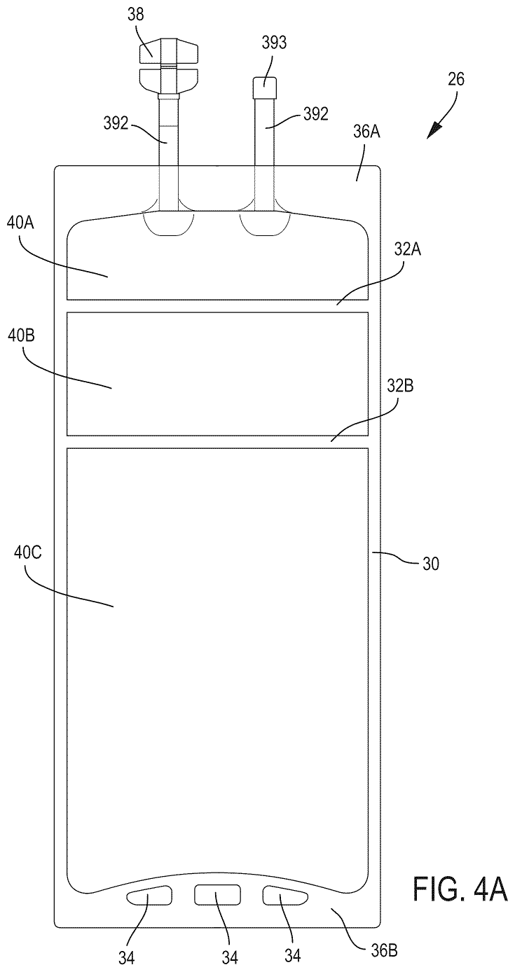

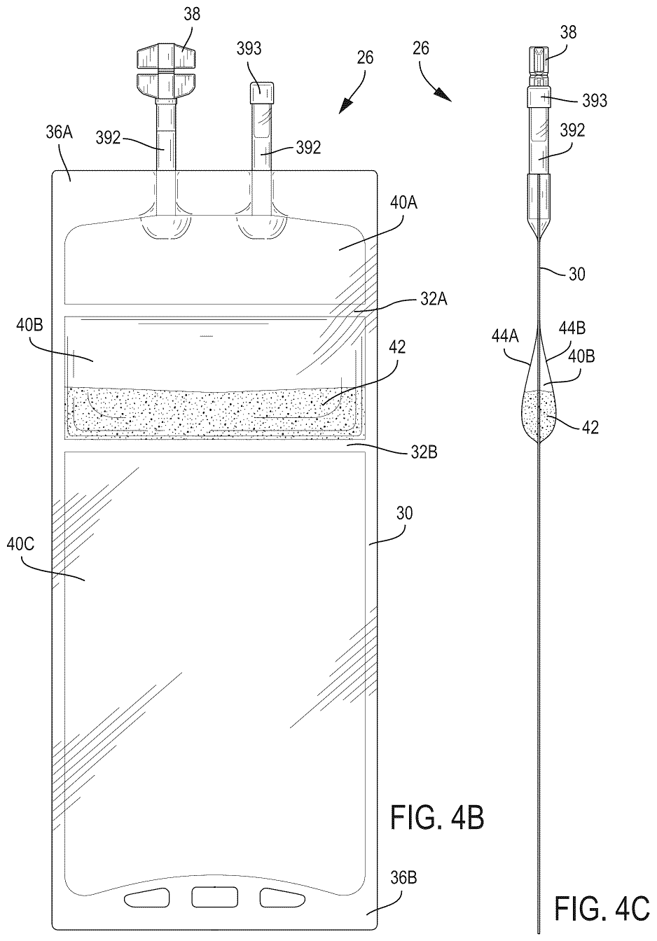

Referring now to FIGS. 4A-C, an exemplary bag 26 is depicted. As shown and as with other bags 26 described herein, the bag 26 may include a first sheet of material 44A and a second sheet of material 44B. The sheets 44A, B may be joined together at a peripheral seal 30 to define at least one interior compartment 40A-C. In alternative embodiments, a single sheet of material could be doubled over and coupled to itself to form the peripheral seal 30. Sheets 44A, B herein may be laminates of a number of different materials. Layers of the laminate may be chosen and ordered to achieve desired objectives. For example, vapor or gas impermeable layer(s) or other barrier layer(s), bonding layer(s), solution compatible layer(s), and reinforcing or durability increasing layer(s) may be included. The materials chosen may be informed by intended sterilization method, weight, optical clarity, durometer, flexibility, heat resistance, elastic modulus, required materials thicknesses, strength, light blocking ability, dielectric/polar properties, etc.

The bag 26 may include at least one port 392 coupled to the sheets 44A, B which establishes a fluid pathway through the peripheral seal 30 to at least one of the interior compartments 40A-C of the bag 26. The peripheral seal 30 may include an enlarged region 36A, B along at least one side of the bag 26. In the example, an enlarged region 36A is present at the port 392 bearing side of the bag 26 and at the side opposing the ports 392. One of the enlarged regions 36A, B may include one or more aperture 34 therethrough which may support hanging of the bag 26 for gravity based administration.

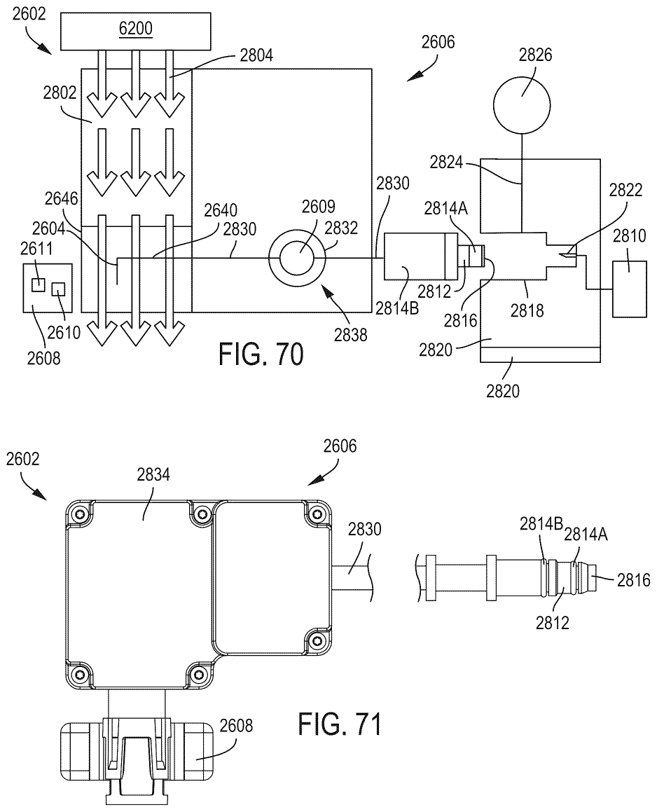

In the example embodiments, the ports 392 include a port 392 with a septum 393 and a port 392 with a stopper 38. The septum 393 may allow access to the interior volume of the bag 26 via a dispensing sharp 2604 (see, e.g., FIG. 67A) or needle of a syringe of other filling implement. A filling station 2600 (see, e.g., FIG. 75) may fill the bag 26 via puncturing the septum 393 with a dispensing sharp 2604 of a cartridge 2606 (see, e.g., FIG. 70). The septum 393 may maintain a fluid tight seal and self-close after removal of a dispensing sharp 2604 or needle. The septum 393 may also be used to load additional medical agent into a bag 26 after the bag 26 is filled by a filling station 2600. For example, a bag 26 may be filled at the filling station 2600 to generate a bag 26 of normal saline and a pharmacist may load an antibiotic into a bag 26 by accessing the interior volume of bag 26 via the septum 393 with a syringe needle. The port 392 with the stopper 38 may be accessed by a nurse or other care giver when the bag 26 is administered. For example, the stopper 38 may be manipulated to reveal a spike receptacle and the bag 26 may be spiked with an administration set. The example stopper 38 is a butterfly type stopper, however, any suitable stopper 38 variety may be used.

The peripheral seal 30 may be formed by welding the sheets 44A, B to one another in the region of the peripheral seal 30. The sheets 44A, B may be robustly coupled at the peripheral seal 30 and may not be separable without destruction of the sheeting 44A, B and bag 26. The sheets 44A, B may also be joined together in various regions to establish the various interior compartments 40A-C within the bag 26. As shown, the bag 26 includes a number of frangible partitions 32A, B. The frangible partitions 32A, B completely isolate the interior compartments 40A-C within the bag 26. The frangible partitions 32A, B may, however, be created in a manner which couples the bag 26 material more weakly than at the peripheral seal 30. The frangible partitions 32A, B may be arranged to separate as fluid is filled into the bag 26.

Referring primarily to FIGS. 4B-C, at least one of the interior compartments 40A-C of a bag 26 may contain a concentrate 42. In the example embodiment, the second interior compartment 40B contains a concentrate 42. In some specific examples, each bag 26 may include at least one compartment 40A-C filled with at least one crystalline salt (e.g. sodium chloride) which is sufficient to generate a solution of desired concentration (e.g. 0.9% normal saline or 0.45% half normal saline) when the bag 26 is filled with a prescribed volume of fluid. Sugars, and sugar salt mixtures may also be used in some examples, though any desired active pharmaceutical ingredient(s) may be included. Concentrates may include concentrates for Ringer's solution, Lactated Ringer's solution, Hartmann's solution, sugar solutions (e.g. D5 W), sugar saline solutions (e.g. D5NS, ⅔ D5 W & ⅓ NS). In other embodiments, the concentrate 42 could, for example, be dialysate precursors for hemodialysis or peritoneal dialysis. Different components of a concentrate 42 may be in different compartments 40A-C. The concentrate 42 may at least partially fill the compartment 40A-C in which it is disposed. In general, embodiments are described herein in relation to normal saline though this is merely exemplary. In various embodiments described herein, any concentrate 42 described herein may be included in any bag 26 described or shown herein and the concentrate included may be sufficient to produce a bag 26 with any desired concentration when filled (e.g. hypotonic, isotonic, or hypertonic). Any compartments of the bag 26 in which concentrate 42 is absent may be empty or devoid of contents and in a collapsed state. There may be a miniscule amount of gas (which may be kept as small as is practicable) in the non-concentrate containing compartments while still considering these compartments empty. A vacuum could also be pulled on these compartments to render them empty. This may ensure that the bag 26 has maximum packing density. It may also prevent the presence of any substantial air volume within the bag 26 when filled.

Still referring primarily to FIGS. 4B-C, isolating the concentrate 42 within a compartment 40B which is intermediate two compartments 40A, C may be particularly desirable for bags 26 intended to be filled on site shortly prior to use. It may be further desirable for bags 26 in which the concentrate is a lyophilized, powder, or a crystalline solid. The partition 32A between the first compartment 40A and the second compartment 40B inhibits displacement of concentrate 42 into the ports 392 of the bag 26. This arrangement blocks concentrate 42 from becoming stuck in a port 392 and simplifies ensuring that all concentrate 42 has homogenously mixed within the bag 26. The first partition 32A may be placed as close to the ports 392 as is practicable. For example, the first partition 32A may be placed at a location which is between 5-30% of the length of the bag 26 from side of the peripheral seal through which the ports 392 extend.

Bags 26 may typically be filled while oriented with the axes of the ports 392 extending in the vertical direction (parallel to the direction of acceleration due gravity). As the first compartment 40A of the bag 26 is filled with fluid from a filling station 2600, the first frangible partition 32A may be defeated. The fluid may drop into the now accessible second compartment 40B causing turbulence and mixing of the fluid with the concentrate 42. The second compartment 40B may be dimensioned to have an interior volume larger than the volume of concentrate 42 contained therein. Thus, the extra volume may act as a spacer which permits the fluid in the first compartment 40A to fall some distance before contacting the concentrate 42. As the joined volume of the first and second compartment 40A, B is filled, the second frangible partition 32B may eventually be defeated. The contents of the bag 26 may again drop into the now accessible third compartment 40C resulting in further mixing. The rounded corners and curved wall at the end of the bag 26 opposite the ports 392 may augment the mixing as the contents of the bag 26 drop into the third compartment 40C. The bag 26 may subsequently be filled to a predetermined amount. The amount of fluid dispensed into the bag 26 by the filling station 2600 may be appropriate to generate a fluid with a desired concentration given the concentrate 42 initially provided in the bag 26. In order for a bag 26 to accept the full volume of fluid dispensed into the bag 26 by the filling station 2600, all partitions 32A, B of the bag 26 may be defeated. This may ensure that the bag 26 does not include partitions 32A, B which a user must remember to disrupt before use reducing potential for administration errors.

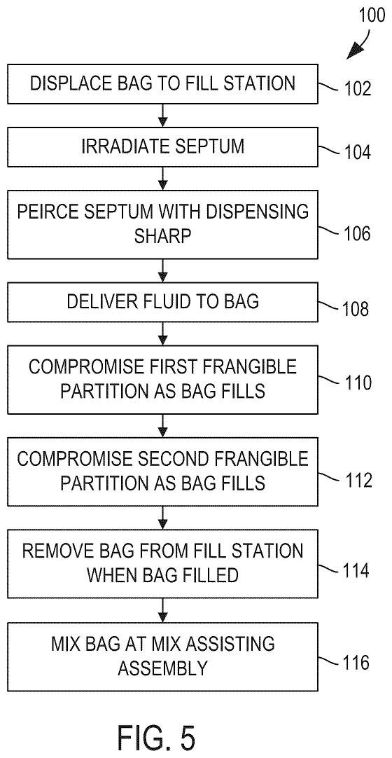

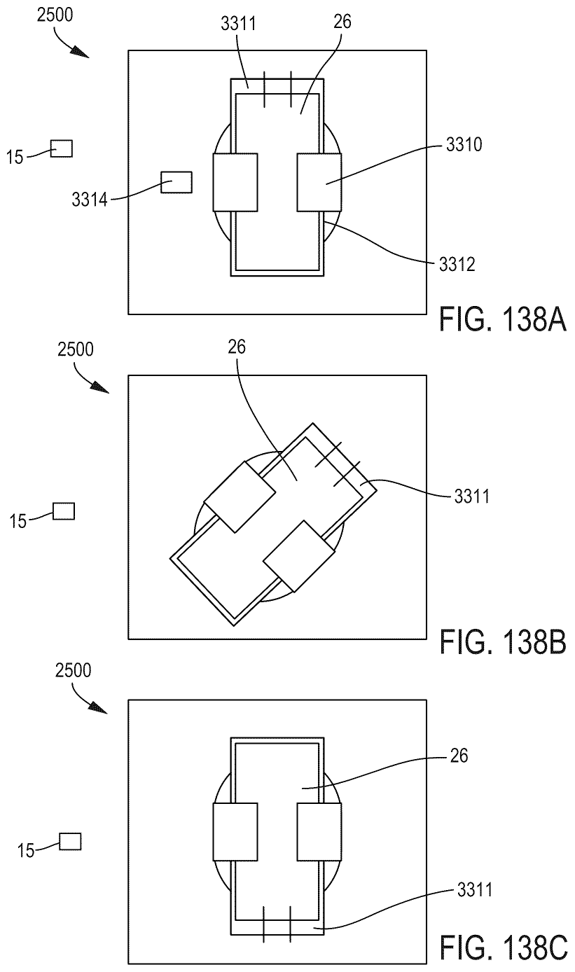

Referring now to FIG. 5, a flowchart 100 is depicted detailing a number of example actions which may be executed to fill a bag 26 of the type shown in FIGS. 4A-C. As shown, a bag 26 may be displaced to a filling station 2600 in block 102. The septum 393 of the bag 26 may be irradiated, in block 104, by an irradiation assembly 2608 (further described in relation to, e.g., FIG. 75). The septum 393 of the bag 26 may be pierced with a dispensing sharp 2604 of a cartridge 2606 (see, e.g., FIG. 75) of the filling station 2600 in block 106. In block 108, fluid may be delivered to the bag 26. As the bag 26 is filled with fluid, the first compartment 40A may reach capacity and the pressure of the fluid may compromise the first frangible partition 32A in block 110. In block 112, the combined volume of the first and second compartments 40A, B may reach capacity and the pressure of the fluid may compromise the second frangible partition 32B. The bag 26 may be removed from the filling station 2600 in block 114 once the bag 26 has been filled a desired amount. The bag 26 may then be displaced to a mix assisting assembly 2500 (further described in relation to, e.g., FIGS. 138A-C) and the contents of the bag 26 may be mixed in block 116. The mixed bag 26 may have substantially homogenous content and all solid concentrate 42 may be dissolved into solution.

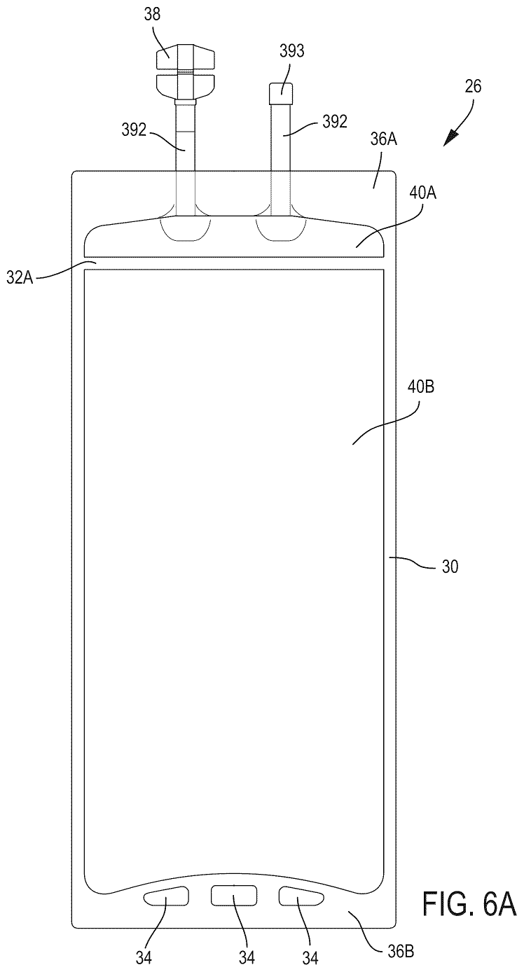

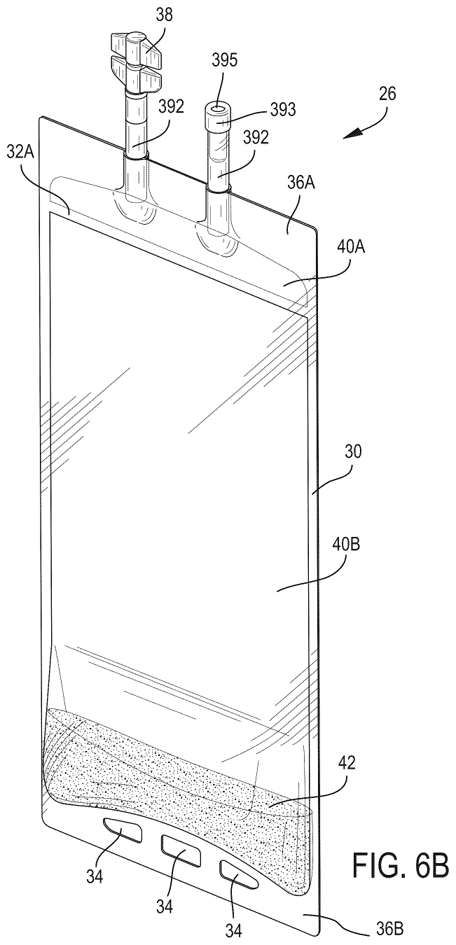

Referring now to FIGS. 6A-B, another example bag 26 with a first and second compartment 40A, B is depicted. The frangible partition 32A of the example bag 26 is placed proximate the ports 392. For example, the first partition 32A may be placed at a location which is between 5-25% of the length of the bag 26 from side of the peripheral seal through which the ports 392 extend. This may ensure that the ports 392 are segregated from any concentrate 42 in the second compartment 40B of the bag 26. The first compartment 40A may be empty, and the second compartment 40B may contain substantially only concentrate 42. The bag 26 may be filled as described in relation to FIG. 5, however, block 112 would be omitted.

As the bag 26 is filled, the first compartment 40A may reach capacity and the frangible partition 32A may be compromised as additional fluid is dispensed into the bag 26. The fluid in the first compartment 40A may drop into contact with the fluid in the second compartment 40B generating turbulence and encouraging mixing. After the frangible partition 32A is defeated, fluid dispensed into the bag 26 may fall nearly the length of the bag 26 to the solution (and yet to be dissolved concentrate 42) at the opposing side of the bag 26. This may help to encourage more vigorous mixing as the bag 26 is filled. As described in relation to FIG. 5, the bag 26 may be mixed at a mix assisting assembly 2500 (see, e.g., FIGS. 138A-C) after it is filled with the desired amount of fluid by a filling station 2600 (see, e.g., FIG. 75).

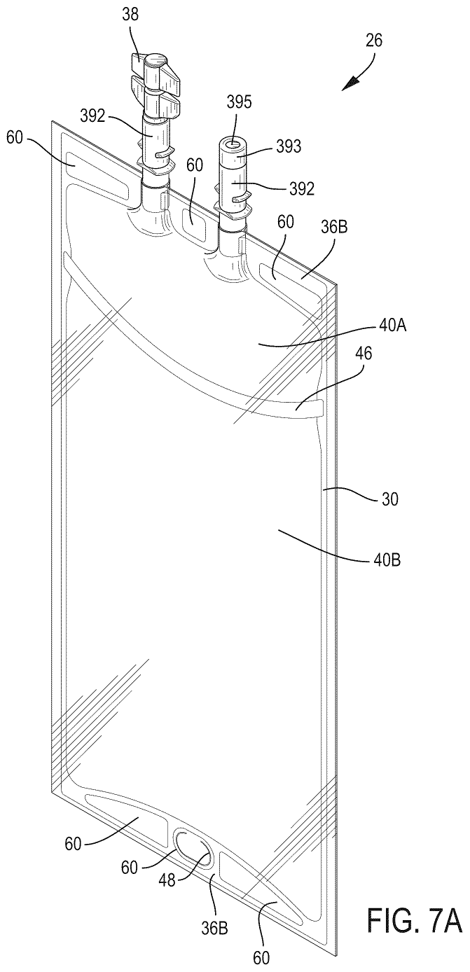

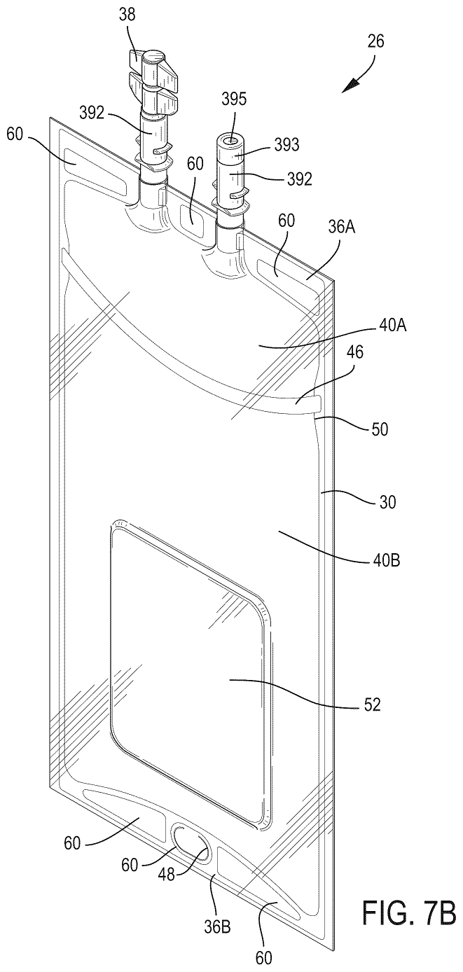

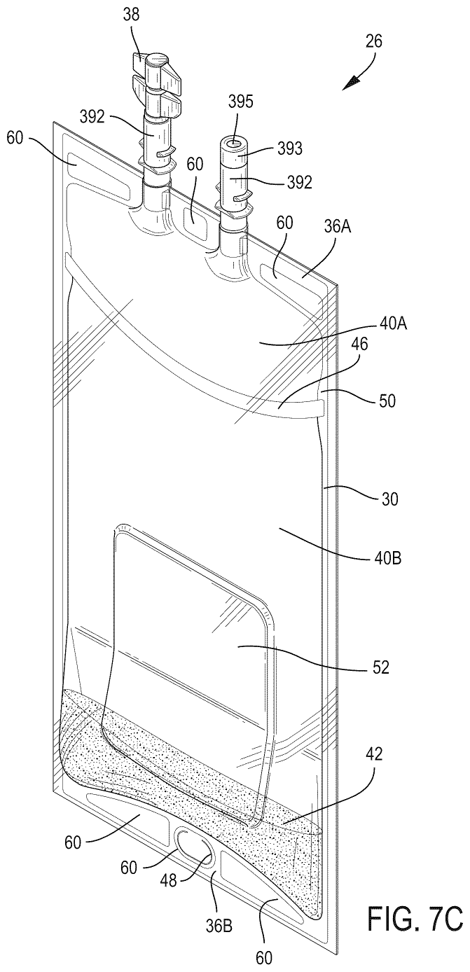

Referring now to FIGS. 7A-C, embodiments of other exemplary bags 26 are depicted. As shown, the interior volume of the bag 26 may be divided into a first compartment 40A and a second compartment 40B which are separated by a frangible curved partition 46. The first compartment 40A is typically empty and the second compartment 40B may include a concentrate 42 (see, e.g., FIG. 7C). The frangible curved partition 46 may be closest to the port 392 bearing side of the bag 26 where it extends to the peripheral seal 30. The frangible curved partition 46 may bow away from the ports 392 toward the opposing side of the bag 26 as distance to a medial plane of the bag 26 parallel to the port 392 axes increases. The distance between the frangible curved partition 46 and the side of the bag 26 opposite the ports 392 may be shortest at the mid plane of the bag 26 which extends parallel to the port 392 axes. The curved frangible partition 46 may extend to the peripheral at locations on the peripheral seal 30 which are between 5-30% of the length of the bag 26 from side of the peripheral seal 30 through which the ports 392 extend. Though shown in relation to FIGS. 7A-C, any of the bags 26 described herein may include a curved frangible seal 46. Curved frangible seals 46 may be used in place of or in addition to any frangible partitions 32A, B depicted in FIGS. 4A-C and FIGS. 6A-B, for instance. As shown, the peripheral seal 30 may include thickened regions 50 where the curved frangible seal 46 extends to the peripheral seal 30. As with FIGS. 6A-B, as the bag 26 is filled, the first compartment 40A may reach capacity. Further filling of the bag 26 may cause the curved partition 46 to be overcome. Fluid filling the first compartment 40A may fall into the now accessible second compartment 40B aiding in mixing of the concentrate 42 with the fluid being filled into the bag 26. Further mixing would occur as additional fluid is dispensed into the bag 26 and would be aided by the substantial drop which would be present in the moments after the curved partition 46 is compromised. Curved partitions 46 may be particularly desirable as they may tend to more easily separate across with width of the bag 26 as the bag 26 is filled.

As shown, the bags 26 in FIGS. 7A-C include an enlarged region 36A of the peripheral seal 30 at the side of the bag 26 through which the ports 392 extend. The opposing side of the bag 26 also includes an enlarged region 36B of the peripheral seal 30. These regions 36A, B may include uncoupled areas 60 where the sheeting 44A, B (see, e.g., FIG. 4C) is not welded together. A slit 48 may also be included in the enlarged region 36B or an uncoupled area 60 therein. The slit 48 may allow a hanger to pass through the bag 26 in this region to facilitate gravity based administration.

Bags 26 may also include a well 52 formed (e.g. vacuum or thermoformed) in at least one of the sheets 44A, B from which the bag 26 is formed. The volume of the well 52 may be at least the volume of the concentrate 42 to be contained in the bag 26. In other embodiments, the well 52 may define a volume which is at least greater than 50% of the volume of concentrate 42 to be contained in the bag 26. The well 52 may provide a receptacle to contain concentrate 42 for the bag 26 as the bag 26 is manufactured. Though the well 52 is shown as substantially rectangular, other shapes may be possible. Any desired polygon, or curved shape may be used. Oblong or obround shapes may also be used. The well 52 in the example has a substantially constant depth. In alternative embodiments, the well 52 may have a depth which varies with the distance from the sidewall of the well 52. The wall 52 may be bowl shaped or have an undulating depth in some examples. Though only a single well 52 is depicted, alternative embodiments may include a plurality of wells 52. Some bags 26 may include a row of wells 52 or an array of some number of rows and columns of well 52. The total volume of the plurality of wells 52 may be at least 50% of the volume of concentrate 42 to be contained in the bag 26 and in some embodiments may be at least equal to the volume of concentrate 42 to be contained in the bag 26. Though wells 52 are shown in relation to FIGS. 7B-C, wells 52 may be included in any bag 26 described herein.

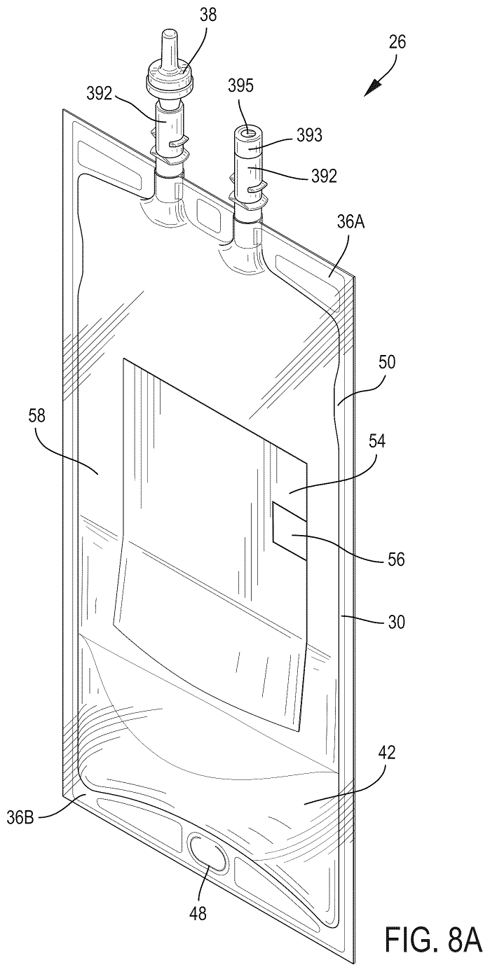

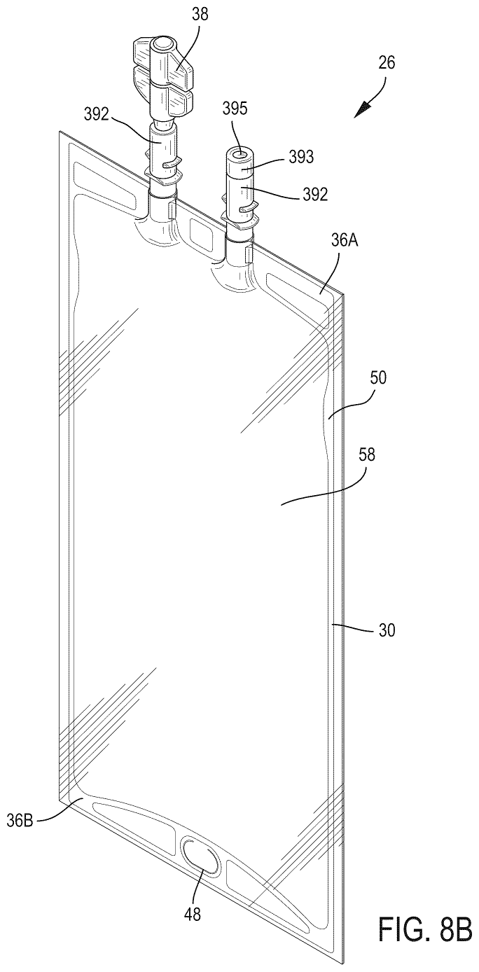

Referring now to FIGS. 8A-B, further exemplary bags 26 are depicted. In some embodiments, or for some concentrates 42, it may be desirable to have a single interior compartment 58 within the bag 26. In some embodiments, the peripheral seal 30 may include the enlarged region 50 and a curved frangible partition 46 or other partition 32A, B may not be added. The example bags 26 in FIGS. 8A-B are the bag 26 of FIG. 7A without the curved partition 46. As shown, the bag 26 may be filled with a liquid concentrate (e.g. high molarity solution or salt brine). In some specific examples an at least five molar solution of sodium chloride may be used. The stopper 38 of the bag 26 in FIG. 8A is a tulip type stopper 38. Such stoppers 28 may be used in any other bag 26 shown or described herein.

Though this may be true of any bag shown or described herein, it may be preferable that sheets 44A, B of bags 26 loaded with a liquid concentrate may each be a ply of a multiple ply stock. Two ply layers (e.g. adjacent lamina layers of the respective plies) may be separable to form a fillable interior volume which is defined by the peripheral seal 30. The sheets 44A, B may be plies of PolyCine APP-114-PB material in certain embodiments.

In some examples of bags 26 containing liquid concentrate, the liquid concentrate 42 may be placed in a compartment of the bag 26 which is segregated from at least one other compartment. A frangible partition may be created separating the liquid concentrates from the ports 392 for example. This may ensure that concentrate 42 does not become entrapped within the ports 392. In such embodiments, the concentrate 42 may be isolated within a compartment having a volume slightly larger (1-10%) than the concentrate 42 volume. This may limit the surface area in contact with any possible gas in the compartment minimizing evaporation of solvent through the bag 26. In some embodiments, the liquid concentrate 42 may be isolated in a compartment at a side of the bag 26 opposite the ports 392. Alternatively, the liquid concentrate 42 may be compartmented into an intermediate portion of the interior volume of the bag 26. The liquid concentrate 42 could, for example, be placed in a compartment similar to compartment 40B of FIG. 4B. Straight or curved frangible partitions may be used to isolate the liquid concentrate.

Any of the bags 26 described herein may include a label 54. The label 54 may be adhered to the bag 26 or printed directly to the bag 26. Any of the bags 26 described herein may include at least one indicium 56 which is machine readable. Such indicia 56 may include barcodes, QR codes, GS1 codes, data matrices, bokodes, RFID tag, NFC tag, etc. The indicia 56 may include various information about the bag 26. For example, the indicia 56 may include a unique bag 26 identity, a lot identity, production line identity, date of manufacture, an expiration or use by date, information defining the concentrate in the bag 26, a mass or volume of concentrate or brine provided to the bag 26 during manufacture, bag 26 capacity information, etc.

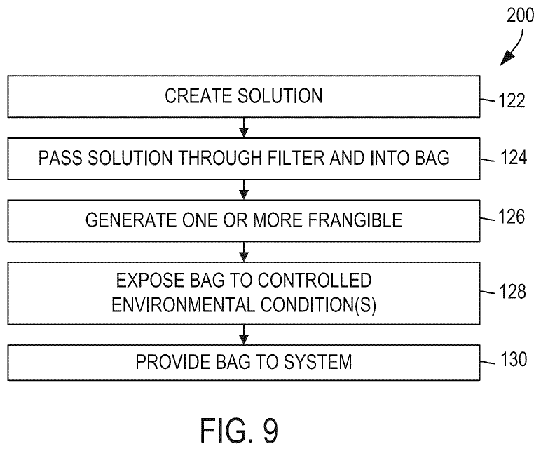

Referring now to FIG. 9, a flowchart 120 is depicted showing a number of example actions which may be executed to prepare a bag 26 before providing it to a system 10 for filling. In some examples, a bag 26 may be filled with a liquid concentrate 42 and a component of the concentrate 42 may be at least partially removed from the sealed bag 26. For example, the solvent component of the concentrate 42 may be evaporated from the bag 26. Using the example of a salt brine, the bag 26 may be formed of sheeting 44A, B (see, e.g. FIG. 4C) which displays some permeability to water vapor. Any biocompatible sheeting permeable to water vapor may be used. As least some of the water content in the bag 26 may be evaporated out to dehydrate the bag 26. This may lower the weight and volume of the bag 26 which may allow the bag 26 to be more easily handled. It may also make shipping of the bag 26 simpler. For example, concerns relating to shipping a corrosive liquid brine could be mitigated by evaporating the water component of the brine through the sheeting 44A, B before shipping. Evaporation may also allow for more bags 26 to be placed in a dispenser 5000 of the same size. It may further simplify spooling or packing of the bags 26 into the dispenser 5000. The at least partial evaporation would make the already osmotically challenging interior of the bag 26 yet more osmotically challenging for microbial growth. Additionally, the variability between lots of bags 26 would be minimized and better tracked as the majority of evaporation (or all) through the bag 26 sheeting 44A, B would be controlled and may be subject to monitoring.

As shown, a solution may be formed in block 122. The solution may be a solution of a desired molarity (e.g. 5 Molar or greater saline) or a saturated solution. The solution may be made from water for injection quality water and a pharmaceutical grade solid agent. In some embodiments, the solution may be a super saturated solution. In some embodiments, the solution may also be a high temperature solution. For example, a sugar solution may be created and maintained substantially above ambient (e.g. 80° C. or greater) in order to dissolve more of a desired ingredient into the concentrate 42. This may allow the total volume of concentrate 42 loaded into the bag 26 to be kept as low as is practicable. Note the above may be done in any bag 26 herein including a liquid concentrate 42 in order to lower the overall weight and volume of the bag 26. It is not necessary that solvent be subsequently removed from the bag 26 as described in relation to flowchart 120 in FIG. 9.

In block 124, the solution may be passed through a filter 124 and into the bag 26. The amount of solution dispensed into the bag 26 may be dependent on the desired concentration of solution intended to be filled into the bag 26 once filled by the system 10. Concentration of the solution may be monitored or otherwise determined. Temperature of the solution and volume of the solution dispensed into the bag 26 may be used to determine the mass of solute transferred into the bag 26. Metering of fluid into the bag 26 may be controlled to ensure a desired mass of solute is dispensed into the bag 26. Certain solid crystalline concentrates (even those for pharmaceutical purposes) may not be available in a particulate free from due to the manner in which they are produced. The filter may ensure that the solution supplied to the bag 26 is particulate free.

In block 126, at least one frangible partition 32A or curved partition 46 may be generated in the bag 26. The partition may be formed proximate the ports 392 making a small compartment 40A within the bag 26. This may ensure that any crystallized solute does not become lodged in the ports 392 prior to use. In alternative embodiments, no frangible may be formed and block 126 is optional.

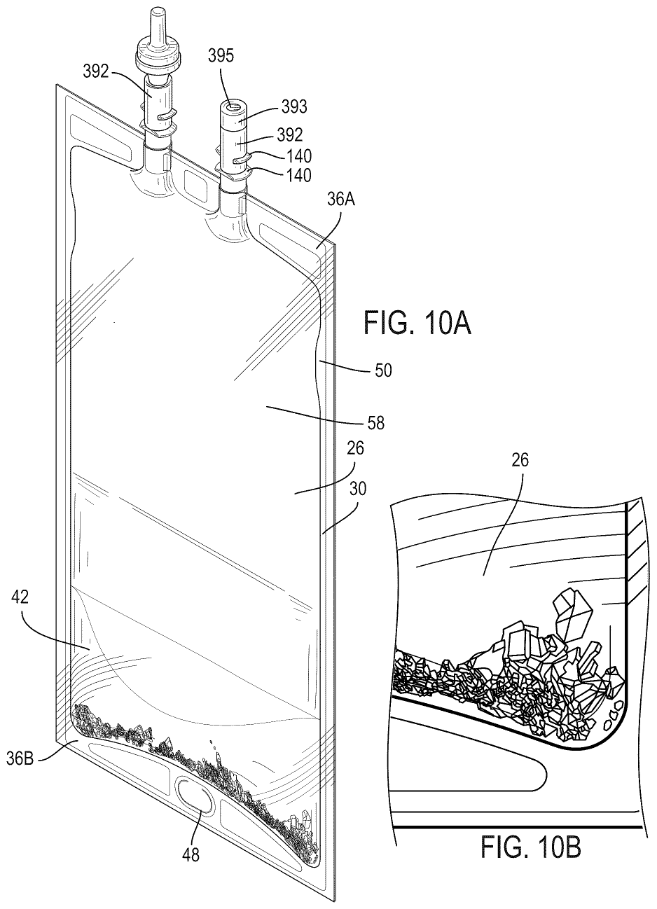

The bag 26 may then be exposed to controlled environmental conditions which facilitate removal of the solvent from the bag 26 in block 128. For example, the controlled environment may be an elevated temperature environment. The temperature may held in a defined temperature range. This range may ensure that the bag 26 is subjected to an environment at a temperature of 50-60° or higher, for instance. The controlled environment may alternatively or additionally be held within a predetermined humidity range. For example, the controlled environment may be maintained at a humidity of 5-10% or lower. This may facilitate removal of solvent from the bag 26 through the sheeting 44A, B of the bag 26. In some embodiments, the bag 26 may be substantially completely dehydrated. Alternatively, least a majority of the original liquid in the bag 26 may be removed. Some solutes may fall out of solution as the solvent is evaporated through the sheeting 44A, B, material. The bag 26 may preferably be oriented vertically with the ports 392 superior to the opposing end of the bag 26. This may ensure any recrystallization does not occur in the ports 392. Thus, a bag 26 filled with filtered, particulate free liquid concentrate may be processed to generate a bag 26 containing an at least partially solid concentrate. An illustration of the example bag 26 depicted in FIG. 8A containing a partially solid concentrate is depicted in FIG. 10A. An illustration of a region of an example bag 26 containing a partially solid concentrate is shown in FIG. 10B.

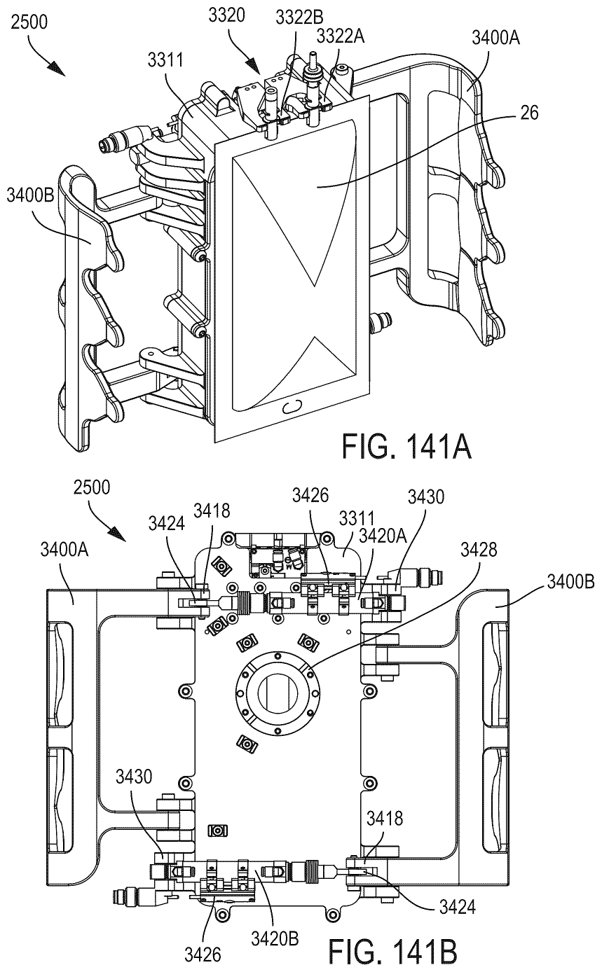

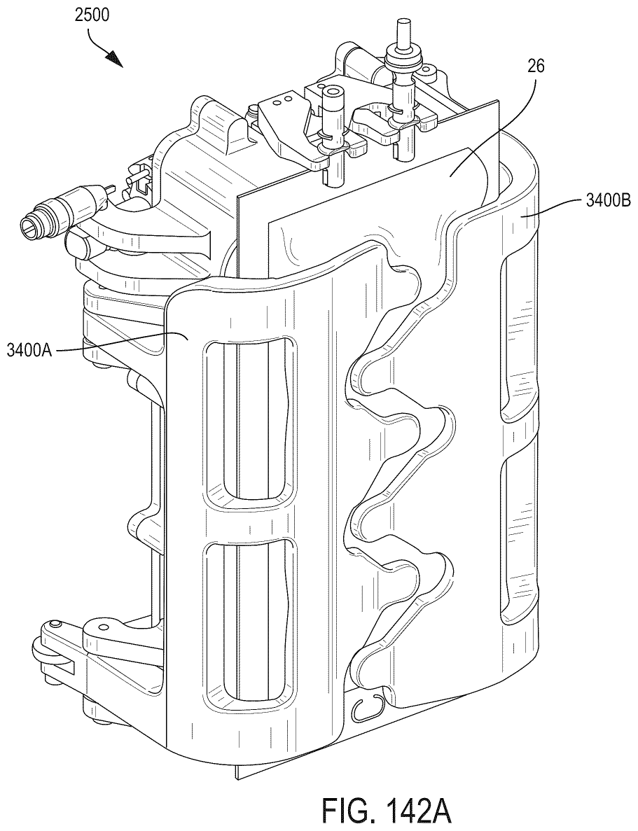

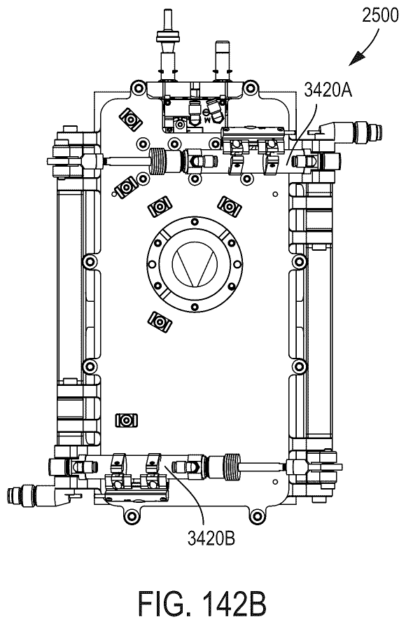

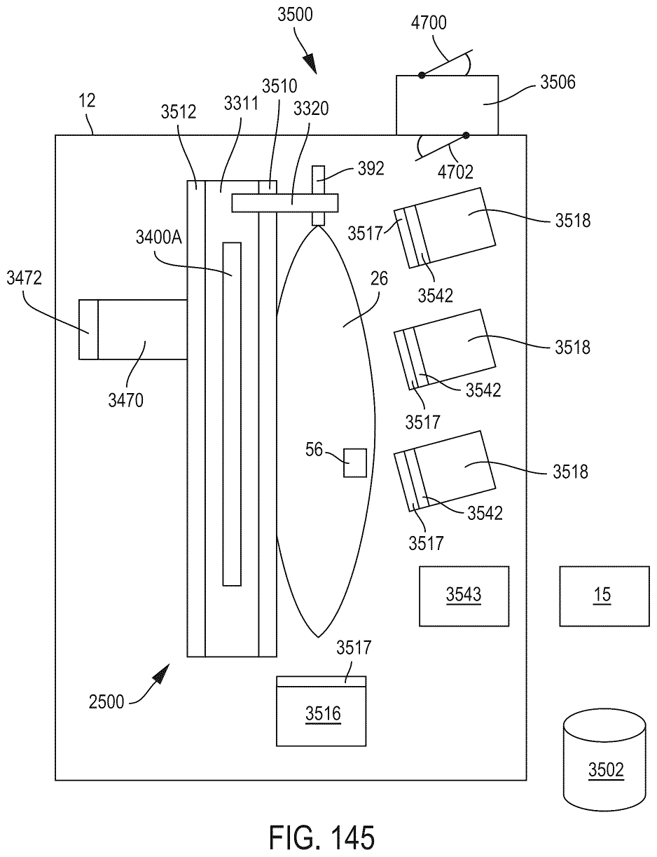

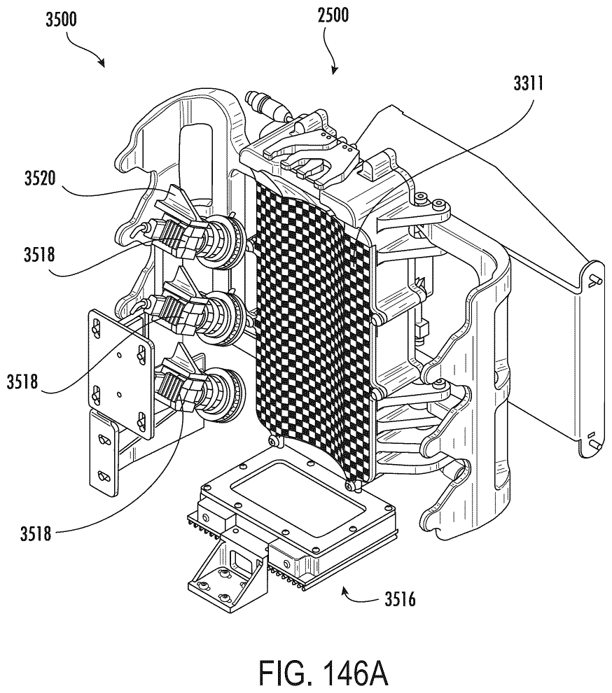

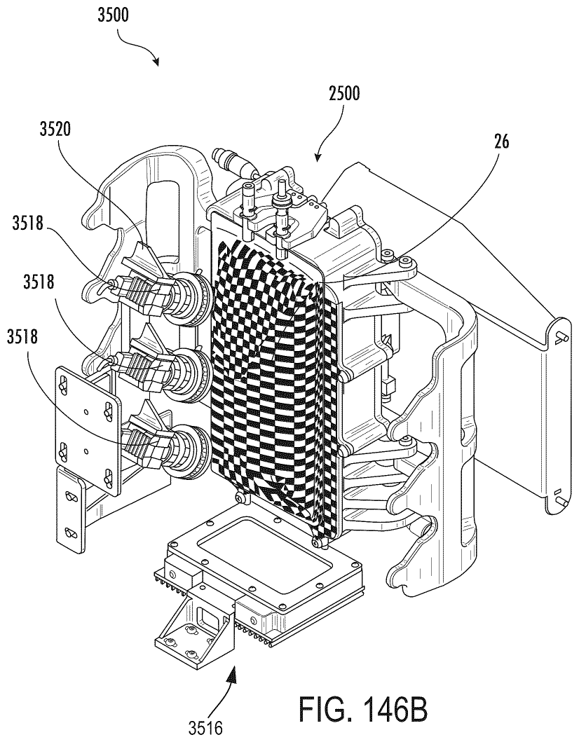

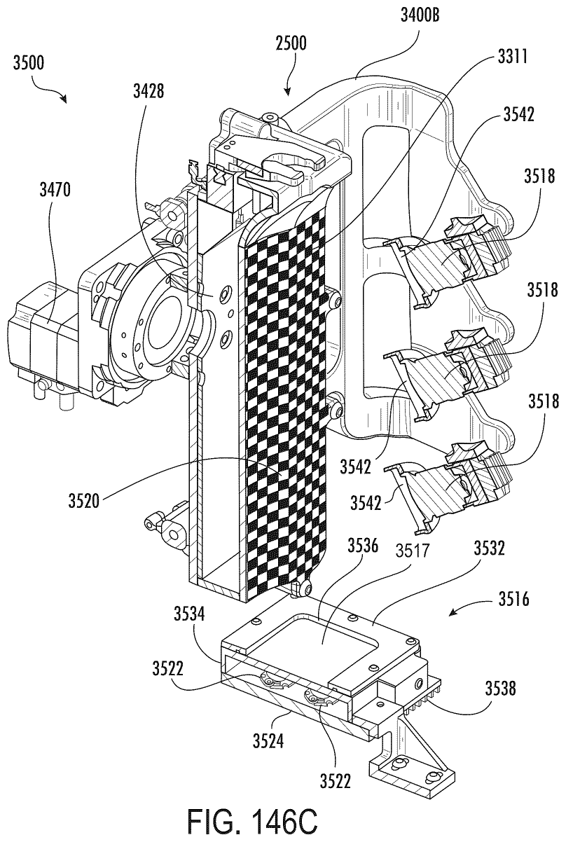

The bag 26 may be provided to a system 10 in block 130. The bag 26 may be subjected to vigorous mixing in a mix assisting assembly 2500 after filling (further described in relation to FIGS. 141A-142B). The bag 26 may also be monitored for undissolved crystallized concentrate in a particulate inspect system 3500 (further described in relation to FIG. 145 and FIGS. 146A-C). In the event undissolved crystalline concentrate is detected or if contents other than air are detected in the bag 26, the bag 26 may be subjected to further mixing in a mix assisting assembly 2500. The bag 26 may be re-inspected with a particulate inspection system 3500 to confirm the concentrate 42 is fully dissolved. In some embodiments, the bag 26 may be subjected to further mixing and inspection up to a predetermined cap on the number of retries.

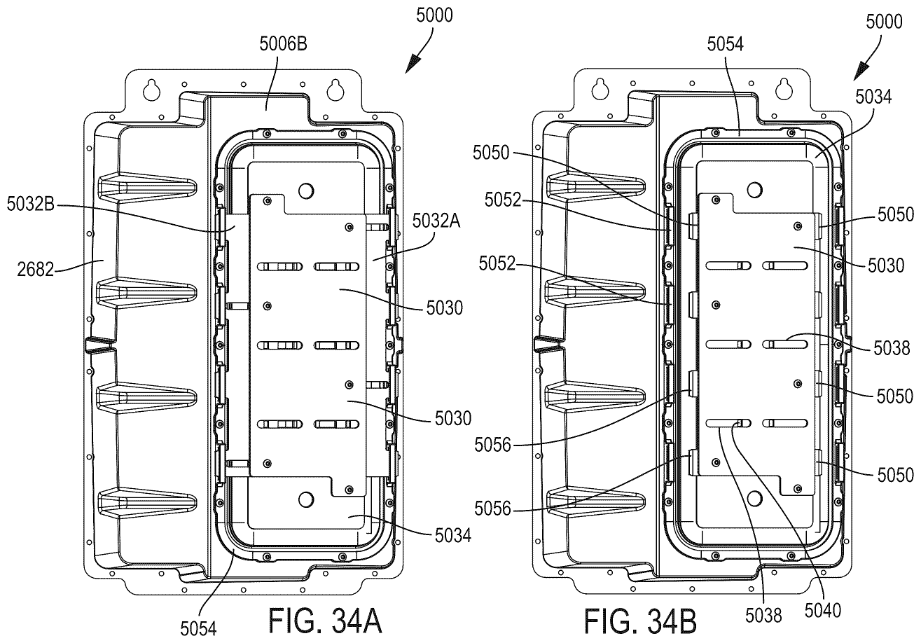

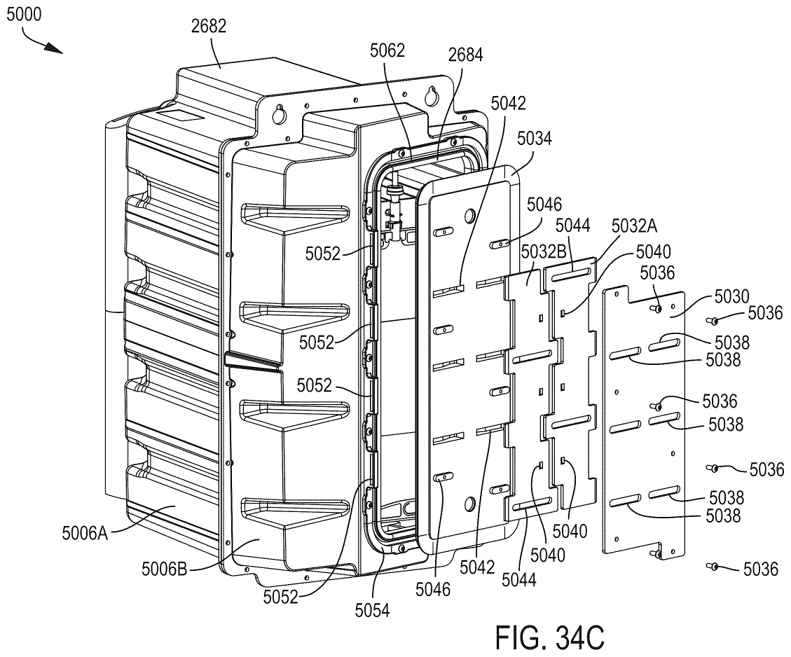

Though the flowchart 120 of FIG. 9 is described in the context of single bags 26, is should be understood that an entire chain 2670 (see, e.g., FIG. 25E) of bags 26 may be used. Each of the individual bags 26 would be filled as described in relation block 124. The entire chain 2670 of bags 26 would then be placed in the controlled environment described in relation to block 128. An entire dispenser 5000 (see, e.g., FIG. 32) loaded with a chain 2670 of bags 26 may be placed in a controlled environment as well. The removable cover assembly 5002 (see, e.g., FIGS. 34A-C) may, for example, be absent or removed to allow communication between the interior of the dispenser 5000 and the controlled environment.

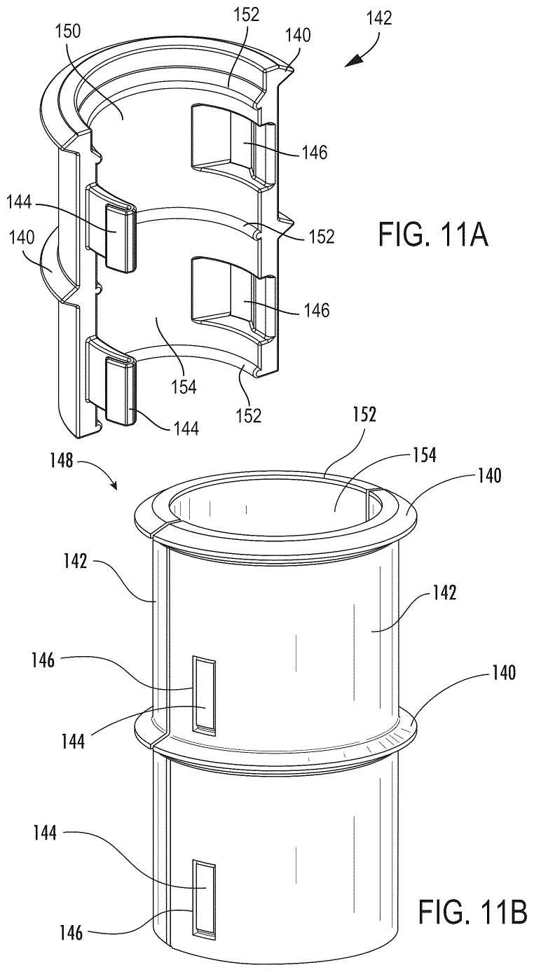

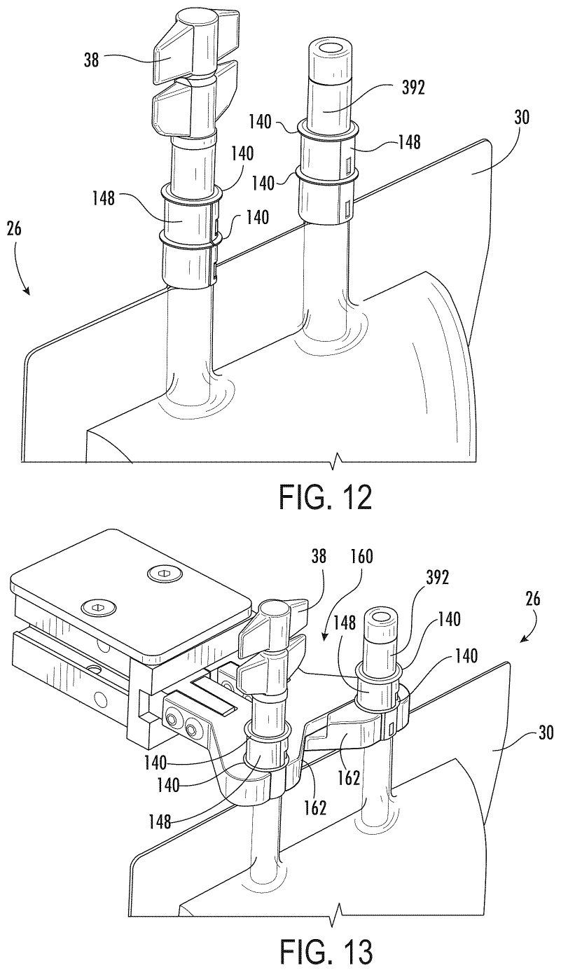

Referring now to FIGS. 11A-B, the ports 392 of a bag 26 may include a set of projections which extend outwardly from the ports 392. The projections may generally extend in a direction perpendicular to the axis of the port 392 to which they belong. Each projection may at least partially surround the port 392 from which it extends. Though a variety of projection types may be used, the example embodiment shown in FIGS. 11A-B includes ribs 140. The projections may assist in retaining a bag 26 with automation equipment such as a grasper 160 (see, e.g., FIG. 12). Jaws 162 (see, e.g., FIG. 12) of the grasper 160 may be adjacent a projection on the port 392. For example, the jaws 162 could close on a port 192 in a location between a set of projections on the port 392. The projections may overhang the grasper jaws 162 limiting the displacement of the bag 26 relative to the grasper 160 in the direction parallel to the axis of the port 392. Projections may be spaced apart a distance slightly (5-10%) greater than the thickness of the grasper jaw 162.

Still referring to FIGS. 11A-B, the projections may, in some examples, be coupled to the ports 392. As shown, a set of projection bearing bodies 142 may be included. The projection bearing bodies 142 may each have at least one clip projection 144 and at least one retention catch 146 (best shown in FIG. 11A). The clip projections 144 of one projection bearing body 142 may be advanced into the retention catches 146 of a cooperating projection bearing body 142 to form a ribbed sleeve 148 as shown in FIG. 11B. The projection bearing bodies 142 may snap fit together and the ribs 140 on each may align to form a single rib 140 which extends around the sleeve 148. In the example embodiment, the ribbed sleeve 148 is substantially cylindrical and the projection bearing bodies 142 include arced walls 150 which extend across a substantially 180° arc. Any suitable sleeve shape may be used so long as a port 392 may be accommodated therein.

Referring now also to FIG. 12, a ribbed sleeve 148 may be formed around each port 392 of a bag 26. The ribbed sleeve 148 may be held in place via an adhesive, solvent bonding, interference fit, etc. In the example, the projection bearing bodies 142 include ridges 152 on their interior surfaces 154 which may press or “bite” into the port 392 helping to prevent displacement of a sleeve 148 along the port 392. In some embodiments, the ribbed sleeve 148 may be loose on the port 392 and extend from the bag 26 to the stopper 38 (or septum 392). The bag 26 and stopper 38 (or septum 392) may block axial displacement of the ribbed sleeve 148. The ribs 140 may be positioned at even height across the ports 392 of the bag 26.

Referring now also to FIG. 13, in addition to providing a port 392 with ribs 140, a ribbed sleeve 148 may also help constrain the port 392 in a more tightly controlled range of positions. The ports 392 may typically be formed of a relatively flexible and floppy material. The ribbed sleeve 148 may be constructed of a rigid material (e.g. rigid polymer). Thus, the ribbed sleeve 148 may hold the port 392 such that the port 392 tends to extend in a direction parallel to the axial dimension of the sleeve 148. This may assist in ensuring reliable positioning of the port 392 when grasped by a grasper 160.

As best shown in FIG. 13, the projections on the ports 392 may also facilitate handoff between different graspers 160 or other bag retainers. As shown, the jaws 162 of the grasper 160 in the example are closed around port 392 below the first rib 140. The first rib 140 may abut against the jaws 162 inhibiting displacement of the bag 26 along the axial dimension of port 392. Thus, a form closure type arrangement engendered by the port 392 and grasper 160 geometries may be established. The space intermediate the two ribs 140 is unoccupied by a grasper 160. A second grasper 160 may close around the port 392 in the space between the two ribs 140. The first grasper 160 could then release the bag 26. The bag 26 would be inhibited from displacing due to the other rib 140 overhanging the jaws 162 of the second grasper 160. Such ribs 140 may also facilitate use of passive retainers. The ribs 140 may rest upon cradle shaped passive retainers and prevent the bag 26 from falling through the retainer. Additionally, jaws 162 of a grasper 160 may be allowed to loosely hold the ports 392. This may remove the need for a dedicated jaw 162 actuator capable of maintaining a fictional, force closure, type engagement with the port 392. The surfaces of the ribs 140 are slanted or angled to help guide a port 392 into a grasper 160 or other retainer.

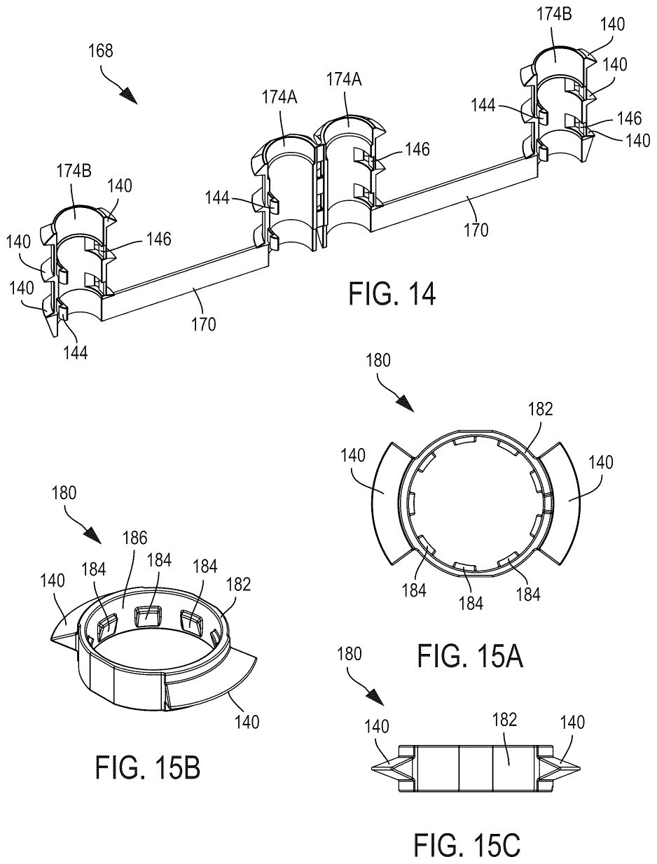

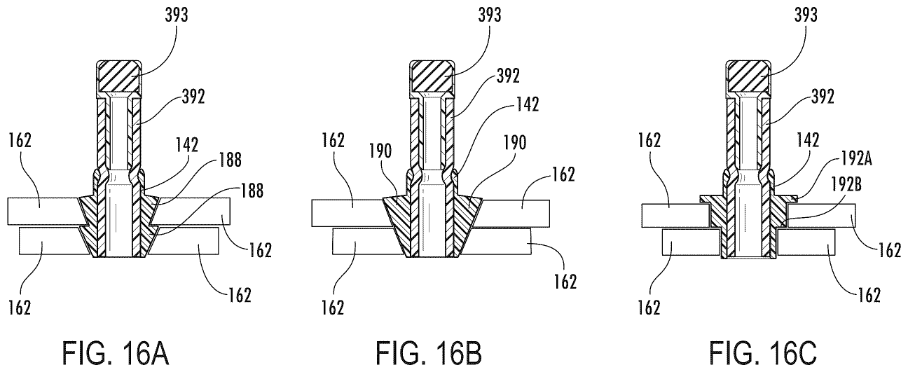

Referring now to FIG. 14, an exemplary ribbing clip 168 is depicted. A ribbing clip 168 may include integrally formed ribbed bodies 174A, B similar to the projection bearing bodies 142 depicted in FIGS. 11A-13. Projection varieties other than ribs 140 may be included in alternative examples (see, e.g., FIGS. 16A-C). The ribbed bodies 174A, B may be included in sets on each half of the ribbing clip 168. The number of ribbed bodies 174A, B in each set may be equal to the number of ports 392 on the bag 26 the ribbing clip 168 is to be coupled to. The ribbing clip 168 may include bridges 170 spacing the ribbed bodies 174A, B of each set apart. Two ribbed bodies 174A at the central region of the ribbing clip 168 may be hinged together. The ribbing clip 168 may be substantially symmetric about a plane of symmetry extending through the axis of the hinge. A living hinge 172 is used in the ribbing clip 168 shown in FIG. 14. Each of the ribbed bodies 172A, B includes a number of ribs 140. Three ribs 140 on each ribbed body 174A, B are included with one rib 140 adjacent the bridge 170, one at the terminal region of the ribbed body 174A, B opposite the bridge 170, and one in a central region of the ribbed body 174A, B. Ports 392 or projection bearing bodies 142 may include any suitable number of projections and other embodiments of projection bearing bodies described herein may include a differing number of projections in alternative embodiments.

Still referring to FIG. 14, the ribbed bodies 172B each include at least one clip projection 144 and at least one retention catch 146. One of the ribbed bodies 172A includes a clip projection 144, the other includes a retention catch 146. As one side of the ribbing clip 168 is folded over against the other, the clip projections 144 may snap into retention catches 146 on the opposing side of the ribbing clip 168. This may allow the ribbing clip 168 to be closed and retained in place about the ports 392 of a bag 26. The ribbed bodies 174A, B may form sleeves similar to the ribbed sleeve 148 of FIG. 11B around ports 392. In other embodiments, ultrasonic welding may be used to couple the sides of the clip 168 together after they have been folded against one another. Solvent bonding, adhesive, or any other suitable coupling method may be used. Projection bearing bodies 142 described herein may be similarly coupled to form a sleeve around a port 392 with a variety of coupling methods such as any of those described above.

Still referring to FIG. 14, the bridges 170 may be relatively resilient and assist in keeping the ports 392 spaced apart at a controlled distance. In some embodiments, the ribbing may be absent from the ribbed bodies 172A, B. The clip 168 would then a bridging clip which assists in controlling the spacing of the ports 392.

In still other examples, and referring now to FIGS. 15A-C, ribbed rings 180 may be included. The ribbed rings 180 may include a band 182 which includes a set of ribs 140 extending outwardly therefrom. The interior of the band 182 may include a set of teeth 184. The teeth 184 are ramped so as to increase in height from the interior surface 186 of the band 182 as proximity to an end of the band 182 increases. Thus, the band 182 may define a dogged aperture through which a port 392 may extend. A ribbed ring 180 may be slid over a port 392 and the dogged aperture will cause the ribbed ring 180 to frictionally and compressively resist movement relative to the port 392. In some embodiments adhesive may additionally be used or be used in place of the teeth 184. Any desired number of ribbed rings 180 may be installed on a port 392. A fixture may be utilized to assist in creating appropriate positioning and spacing of ribbed rings 180 on a port 392.

Referring now to FIGS. 16A-C, as mentioned above, the projections on a port 392 need not exclusively be ribs 140. In some examples, the projections may be barbs 188 as shown in FIG. 16A. The barbs 188 may be ramped so as to decrease in thickness as proximity to the bag 26 increases. The jaws 162 of a gripper 160 (see, e.g., FIG. 13) may be complimentarily angled. When the jaws 162 are closed about the port 392 the ramped surface of the barb 188 may interact with the slanted surface of the jaw 162 to help guide the jaw 162 into place on the port 392. Additionally, the ramped surface of the barb 188 may prevent the bag 26 from displacing about the axis of the port 392 and falling through the grasper 160. The thicker regions of the barb 188 may give the port 392 a width that is greater than the shortest distance between the jaws 162 when the jaws 162 are closed on the port 392. Thus the jaw 162 may present an interference to such displacement of the bag 26. Alternatively, and as shown in FIG. 16B, the projections on the ports 392 may be wedges 190 which decrease in thickness as proximity to the bag 26 increases. Thus wedges 190 may similarly inhibit a bag 26 from falling through a gripper 160 when the jaws 162 of that gripper 160 are closed upon the port 392.

In still other examples, the projections may be a set of steps or tiers 192A, B on the port 392. The tiers 192A, B may incrementally increase the width of the port 392 in a stepwise manner. The width of the port 392 may increase as distance from the bag 26 increases. Jaw 162 of a gripper 160 (see, e.g., FIG. 13) may close about the port 392 below a respective tier 192A, B. The step presented by the tier 192A, B may rest upon the jaws 162 of the gripper 160 preventing the bag 26 from falling through the jaws 162. Barbs 188, wedges 190, or tiers 192A, B may be defined on a projection bearing body 142. A ribbing clip 168 may include barbs 188, wedges 190, or tiers 192A, B in place of ribs 140 is some examples.

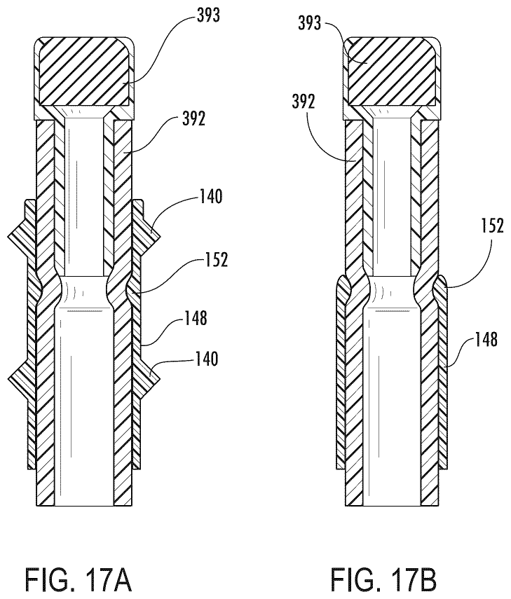

Referring now to FIGS. 17A-B, where projection bearing bodies 142 are used, the interior surfaces of the projection bearing bodies 142 may include interior ridges 152. At least one of the ridges 152 may be positioned to compress the port 392 directly adjacent a rigid insert in the port 392. A septum 393 is depicted in FIGS. 17A-B, but the rigid insert could alternatively be a spike port or stopper 38 (see, e.g., FIG. 7A). The rigid insert may prevent compression of the port 392 by the interior ridge 152. Thus, the projection bearing body 142 may be inhibited from sliding over the portion of the port 392 through which the rigid insert extends. This may assist in fixing the location of the sleeve 148 formed by the projection bearing bodies 142. Such interior ridges 152 may also be included on a ribbing clip 168.

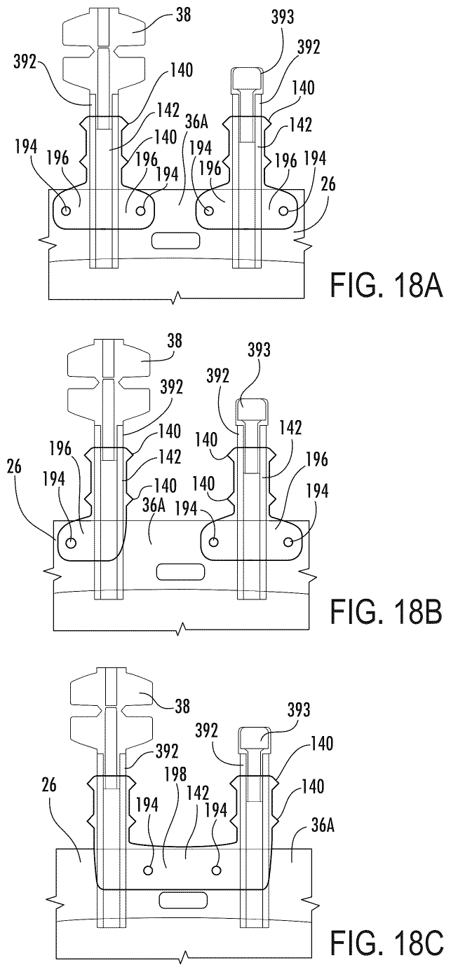

Referring now to FIGS. 18A-C, certain projection bearing bodies 142 are provided in pairs with complimentary snap fit features. One projection bearing body 142 of the pair may include at least one male snap fit protrusion 194 while the other may include a matching number of female snap fit retention catches. The bag 26 may include an enlarged region 36A of the peripheral seal 30 through which the ports 392 extend. The enlarged region 36A have passages therethrough. The male snap fit protrusions 194 of a projection bearing body 142 may extend through the passages in the enlarged region 36A. The snap fit retention catches of a cooperating projection bearing body 142 may be pressed into engagement with the snap fit protrusions 194 extending through the passages. This may form a sleeve around the port 392. It may also fix the position of the sleeve relative to the port 392 as the bag 26 material though which the snap fit engagement is achieved anchors the sleeve in place. The projection bearing bodies 142 may additionally include clip projections 144 and retention catches as described in relation to FIGS. 11A-B.

As shown in FIG. 18A, the projection bearing bodies 142 may each include a pair of opposing wings 196. The male and female snap fit features may be defined in the wings 196. Alternatively, and as depicted in FIG. 18B, only one wing 196 may be included on a projection bearing body 142. Projection bearing bodies 142 of differing varieties may be used for each port 392 of the bag 26. In other embodiments, the projection bearing bodies 142 may be included on a connecting bridge 198. The snap fit features may be included in a portion of the connecting bridge 198.

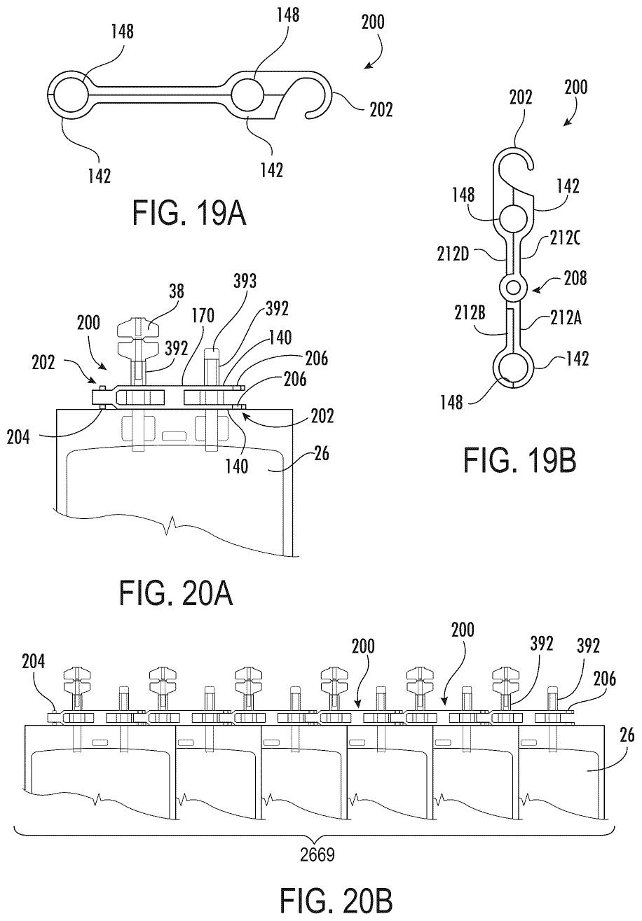

Referring now to FIGS. 19A-20B, in certain examples, projection bearing bodies 142 may be incorporated into a chaining linkage 200. Bags 26 may be coupled together with the chaining linkages 200 to form a linked assembly of bags 2669 (see, e.g., FIG. 20B) or may be placed on bags 26 abreastly coupled to one another in a chain 2670. Chains 2670 of bags 26 are further described in relation to FIGS. 25A-E, for example. Each chaining linkage 200 may include a bridge 170 connecting a set of projection bearing bodies 142. Any desired projection variety may be included on the projection bearing bodies 142. The chaining linkages 200 may also include at least one linkage body 202. In the examples shown in FIGS. 19A-B, the linkage body 202 is a hook. The hook is included as an extension off of one of the projection bearing bodies 142. The hook may receive (snap around) a projection bearing body 142 of a chaining linkage 200 on an adjacent bag 26. This may pivotally couple the adjacent chaining linkages 200. In other embodiments, and as depicted in FIG. 20A, the chaining linkage 200 may include a linkage body 202 extending from the projection bearing bodies 142 on each end of the bridge 170. One of the linkage bodies 202 may include a post 204. The opposing linkage body 202 may include a clip 206 which may engage with a post 204 of an adjacent linkage body 202. Again, a pivotal coupling may be formed between chaining linkages 200 on adjacent bags 26. A linked assembly of bags 2669 coupled together by chaining linkages 200 is depicted in FIG. 20B.

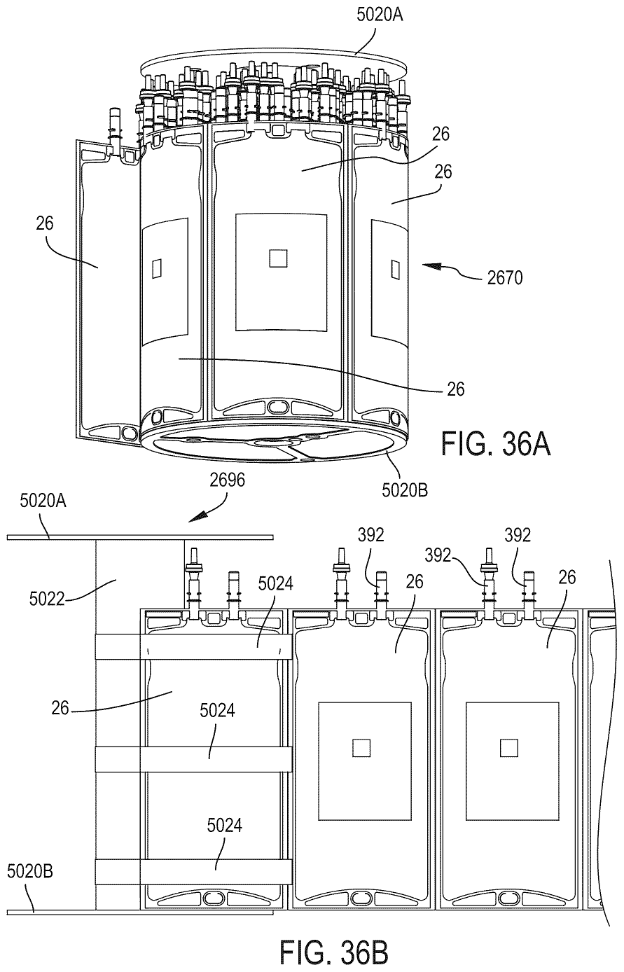

The pivotal coupling established when adjacent chaining linkages 200 are engaged with one another may allow for the bags 26 to be rolled on a spool (see, e.g., FIG. 36A). In some embodiments, at least one hinge 208 may be included in an intermediate portion of the bridge 170 between the projection bearing bodies 142. The hinge(s) 208 may facilitate rolling of a bag 26 onto a spool. The hinge(s) 208 allow the ports 392 of the bag 26 freedom to displace relative to one another. Thus, the ports 392 will more easily assume positions which allow the bag 26 to be curved around the spool. In alternative embodiments, the bridge 170 may be formed of a highly flexible material and the bridge 170 itself may bend to adapt to curvature of the bag 26 on the spool.

Referring primarily to FIGS. 19A-B, the chaining linkages 200 may be an assembly of multiple sections. In FIG. 19A, the chaining linkage 200 includes a first and second portion 210A, B. Alternatively, each portion 210A, B may be integrally formed and connected via a living hinge. The first and second portion 210A, B may be coupled together (e.g. sonically welded, snap fit, solvent bonded, adhered, etc.) around the ports 392 of the bag 26 to form the chaining linkage 200. The ports 392 would extend through sleeves 148 formed by the chaining linkage 200 when the two portions 210A, B are coupled together. The chaining linkage 200 of FIGS. 20A-B may be similarly constructed.

The embodiment of FIG. 19B may include a first side and a second side which are coupled to one another at the hinge 208. The first side may be constructed of a first body 212A and second body 212B. The first and second body 212A, B may be coupled to one another in any suitable manner. The second side may be constructed of a third body 212C and a fourth body 212D which may be coupled together in any suitable manner. The hinge portion of the first side may be pivotally coupled to the hinge portion of the second side to complete the chaining linkage 200.

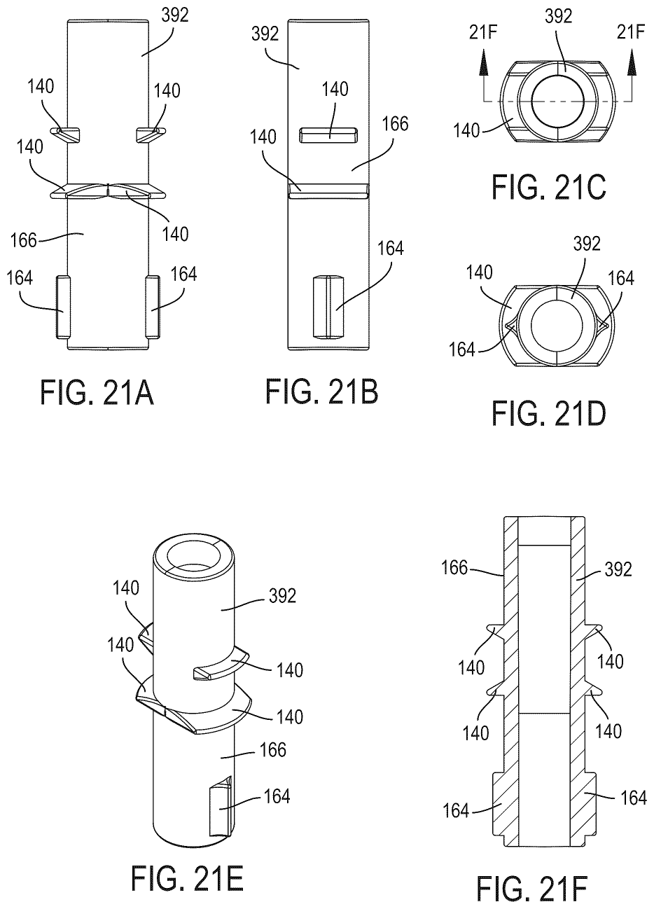

Referring now to FIGS. 21A-F, in certain examples, the ribs 140 may be formed integral to the ports 392. Though the example embodiment is described as including ribs 140 any desired variety of projection may be included and ribs 140 are merely exemplary. The ports 392 may be formed from a rigid material. Various injection moldable plastics may be used such as a polypropylene blend. In certain examples PolyCine App-147 may be used. The polymer used may be selected based on its ability to bond with the sheeting 44A, B material used in a given bag 26 during welding. As the ports 392 are formed of a rigid material, the ports 392 have less tendency to flop, bow, or bend and have better constrained positions. Ports 392 may optionally be connected via a bridge 170 in some examples.

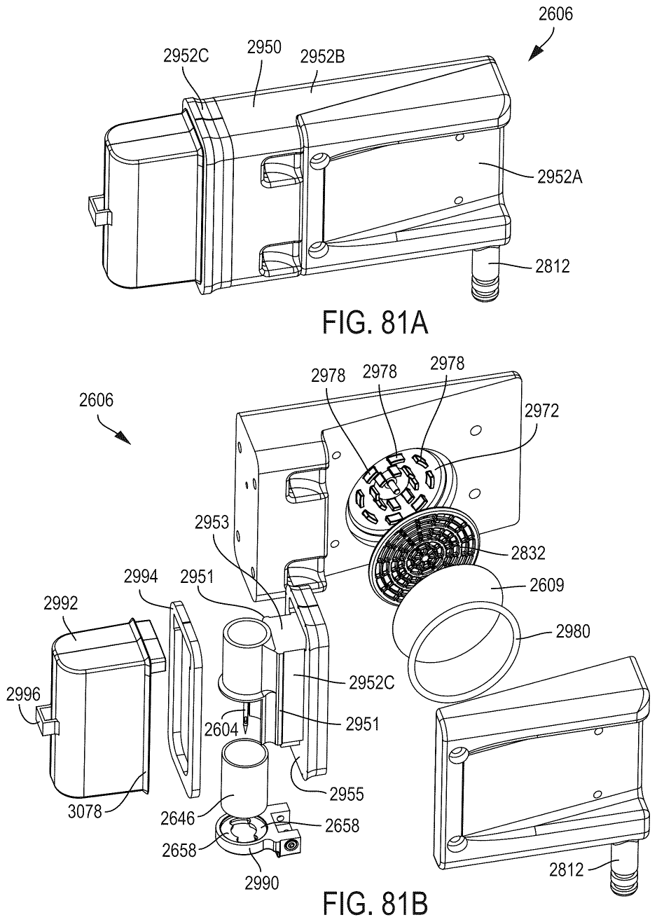

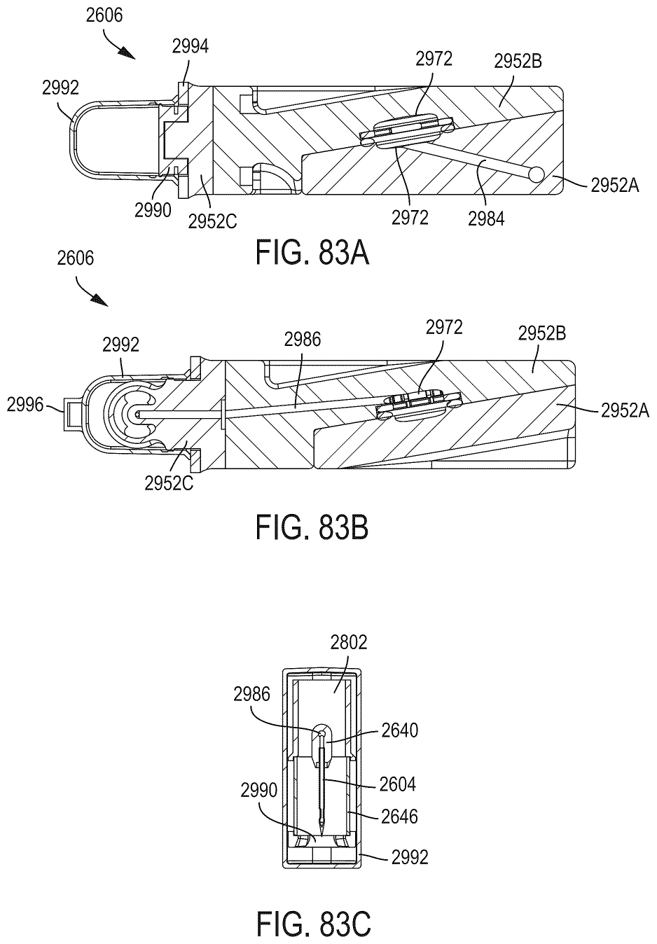

As shown, the ribs 140 may not surround the entirety of the exterior surface 166 of the ports 392 (though could in alternative examples). The example ribs 140 are positioned in pairs. Each pair includes a set of ribs 140 disposed in opposition to one another at the same height on the port 392. One pair of ribs 140 may be present along respective arcs on opposing portions of the exterior surface 166 of the port 392. The other pair of ribs 140 may be present along respective larger arcs on opposing portions of the exterior surface 166 of the port 392. At least the ribs 140 (or other projection) most proximate the septum 393 may be shaped (e.g. extend over a smaller arc) so as to facilitate introduction of the port 392 into an airflow channel 2802 of a cartridge 2606 (see, e.g., FIG. 81B and FIG. 83C).

The port 392 may be symmetric about a medial plane extending along the axial dimension of the port 392. The faces of each set of ribs 140 most proximal to those in the other set of ribs 140 may be slanted away from one another. Thus, the thickness of the ribs 140 may decrease as distance from the exterior surface 166 increases. The slanted faces may assist in guiding jaws 162 of a grasper (or a passive port retaining clip or cradle) into position between the two ribs 140. The faces of each set of ribs 140 most distal to those in the other set ribs 140 may be oriented substantially perpendicular to the axis of the port 392. This may provide a lip which resists slippage of a port 392 through a grasper or passive clip positioned under the rib 140.

As shown in FIGS. 21A-F, the ports 392 each include a set of opposing spines 164 on their exterior surface 166. Each spine 164 may taper to a smaller width as distance from the exterior surface 166 of the port 392 increases. The spine 164 may be present along a section of the port 392 length which is coupled to the bag 26 within the enlarged region 36A of a peripheral seal 30 (see, e.g., FIG. 7B). The portion or apex of the spine 164 most distal to the exterior surface 166 of the port 392 may extend along a direction parallel to the axial dimension of the port 392. The spines 164 may facilitate welding of the sheeting 44A, B of a bag 26 to the ports 392 in a robust, fluid tight manner. Such spines 164 may be included in any ports 392 shown or described herein.

The ports 392 may be molded with to have a relatively smooth surface finish. A semi-gloss, near glossy, or high gloss finish may be used. Molds for the ports 392 may be polished to an SPI B-1 finish or greater. This may provide a mold with a Ra surface roughness of 0.1 μm or less. In some examples, the mold may be finished to an SPI A-2 surface finish. The smooth finish may facilitate creation of a robust seal when septa 393 (see, e.g., FIG. 8B) or other stoppers 38 (see, e.g., FIG. 8B) are assembled into the ports 392. It may also facilitate use of a wider range of materials for use in molding of the ports 392 while still achieving a robust seal against an insert. Additionally, the flexural modulus of the polymer used for the ports 392 may be in the range of 470-630 MPa (at 23°, 50% rH) though values above and below that range are also possible.

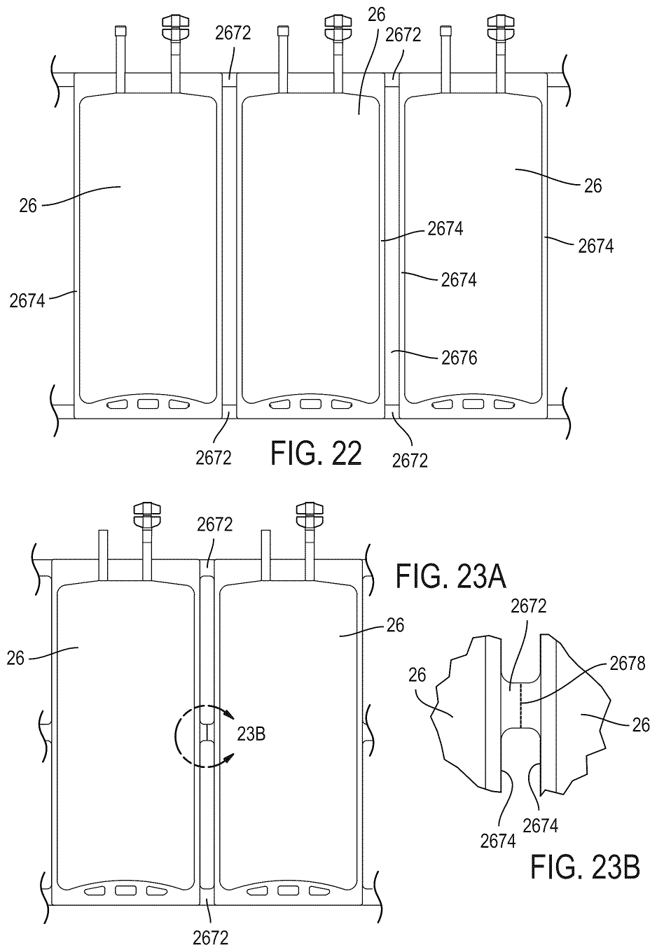

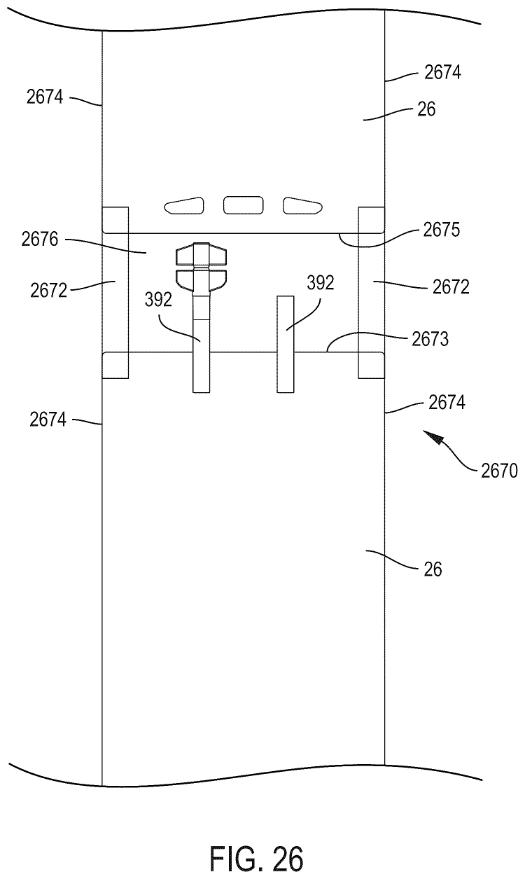

Referring now to FIGS. 22-23B, in certain examples, a system 10 may receive a supply of bags 26 which are provided coupled to one another. The bags 26 may be fed into or installed in the system 10 in a coupled state and may be separated or individualized as needed when filled or prior to being filled. Individualization of each bag 26 may be done in an automated manner (see, e.g., FIG. 52). Bags 26 may, for instance, be provided coupled together in a chain 2670. Portions of example chains 2670 of bags 26 are depicted in FIGS. 22-26. Each bag 26 may be coupled to at least one adjacent bag 26 in a side by side or end to end manner. Where bags 26 are coupled side by side, a chain 2670 may include a number of coupled bags 26 positioned abreast or laterally to one another. Where bags 26 are coupled end to end (see, e.g., FIG. 26), an end of a bag 26 including ports 392 may be coupled to an end of an adjacent bag 26 opposite the ports 392 of that bag 26 to form the chain 2670. The terminal bags 26 on each end of a chain 2670 may only be coupled to a single adjacent bag 26 which in turn is coupled to the rest of the chain 2670. The bag 26 at the beginning of a chain 2670 may optionally be coupled to a leader. The bag 26 at the opposing end of the chain 2670 may be coupled to a sacrificial tail 2683. Any chain 2670 arrangement described herein may, for example, be used with any of the exemplary bags 26 described herein. Any bags 26 of the types described in U.S. Pat. No. 11,965,766, issued Apr. 23, 2024, entitled Medical Treatment System and Methods Using a Plurality of Fluid Line (Attorney Docket No. 00101.00343.Z55) or U.S. Pat. No. 11,980,587, issued May 14, 2025, entitled Systems, Methods, and Apparatuses for Producing and Packaging Fluids (Attorney Docket No. 00101.00325.AA697) which are each hereby incorporated by reference herein in their entireties may additionally be coupled together to form the chains 2670 described herein.

A chain 2670 may include any desired number of bags 26 and in certain examples may include anywhere from 5-500 bags 26. Some chains 2670 may include 50 bags or more, others may include 100 bags 26 or more. In some embodiments, 3-5 unconsumable bags 26 may be attached to the chain 2670 to form a sacrificial tail 2683 (further described elsewhere herein). The chain 2670 may include, for example, a desired number of bags 26 (e.g. 100 or 50) plus the bags 26 of the sacrificial tail 2683. At least some bags 26 in the chain 2670 may be multi-compartment bags 26 with at least one of the compartments, for example, being filled with a solid or liquid concentrate. Any bags 26 containing concentrate shown or described herein may, for example, be used (see, e.g., FIGS. 4B-C, FIG. 6B, FIG. 7C, FIG. 8A, FIG. 10A). Single compartment bags 26 are depicted in FIGS. 22-23A solely for exemplary purposes. The bags 26 may, in some embodiments, be provided in a roll or on a reel and may be spooled out to another component of the system 10.

Where compartmented bags 26 are used, the position of the concentrate 42 containing compartment may differ from bag 26 to bag 26. The concentrate 42 containing compartments may be in a staggered pattern over a series of bags 26. This may facilitate spooling of the bags 26 onto a reel. For instance, a concentrate 42 containing compartment for a first bag 26 may be disposed near the bottom of the bag 26. A concentrate 42 containing compartment of a second bag 26 may be disposed near the top of the bag 26. A concentrate containing compartment for a third bag 26 may be disposed intermediate the position of the concentrate 42 containing compartments in the first and second bags 26. The staggered pattern of concentrate 42 containing compartments may repeat over the length of the chain 2670. This may prevent the spool of bags 26 from having a bulged region where all of the concentrate 42 containing compartments are rolled on top of one another.

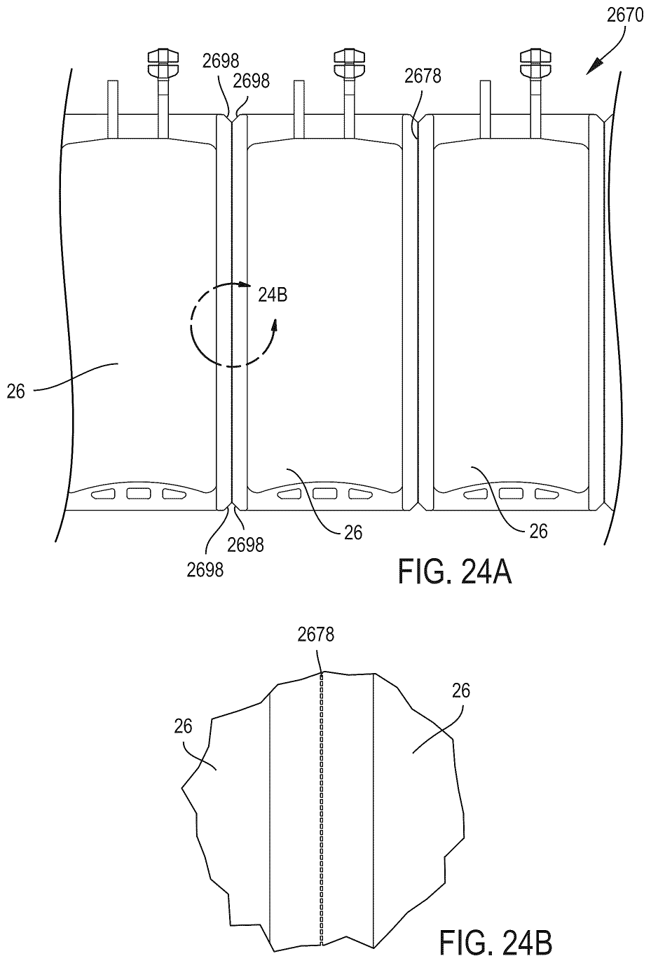

As shown in FIG. 22, in some embodiments, there may be a gap 2676 between each bag 26 though in alternative embodiments, no such gap 2676 (see, e.g., FIGS. 24A-B) may be present between adjacent bags 26. Where a gap 2676 is present, the lateral edges 2674 of each bag 26 in a chain 2670 may be coupled to respective adjacent bags 26. Each bag 26 may be coupled to an adjacent bag 26 at at least one point along a given lateral edge 2674. In the example embodiment depicted in FIG. 22, adjacent bags 26 are coupled together by bridges 2672 of material at opposing ends of the lateral edges 2674. In the example embodiment in FIG. 23A, adjacent bags 26 are additionally coupled together in a central region of the lateral edges 2674 as well. The bridges 2672 may be formed of the same material from which the bags 26 are made, though a dissimilar material may be used in alternative embodiments.

In some examples, the connection or at least one of the connections between adjacent bags 26 may include a weakened region 2678. In some embodiments, the weakened region 2678 may be a score line. Alternatively and as shown in FIG. 23B, the weakened region 2678 may be perforated. The weakened region 2678 may be formed by cutting at least partially through, punching at least partially through, and/or otherwise weakening the sheeting 44A, B material forming the bags 26. Bags 26 may preferentially separate from the chain 2670 at the weakened region 2678. The weakened region 2678 may be referred to herein as a tear guide in relation to certain exemplary embodiments.

Referring now to FIGS. 24A-25E, in some examples, a bridge 2672 between adjacent bags 26 may be present along the majority or entirety of the lateral edges of adjacent bags 26. As shown in FIG. 24A, bags 26 of the chain 2670 may be coupled together at coupling regions 2677 (e.g. formed integrally with one another or joined by a strip of material) present between each adjacent bag 26. Each coupling region 2677 may include a weakened region 2678 at which two adjacent bags 26 may be more easily separated. A perforation is included in the exemplary embodiment shown in FIGS. 24A-B, however, any suitable weakened region 2678 may be included. Score lines are depicted in FIGS. 25B-E for example. When bags 26 are separated, a portion of the coupling region 2677 may remain with each bag 26. This portion of the coupling region 2677 may also form a section of the peripheral seal 30 of a separated bag 26 and partially define the interior volume of that bag 26. Alternatively, the coupling region 2677 may be an unsealed region 2679 extending between the lateral most peripheral seal 30 edges of adjacent bags 26 of the chain 2670. The opposing ends (or at least one end) of each coupling region 2677 of exemplary chains 2670 may define guide edges 2698 which lead toward the weakened region 2678. The guide edges 2698 may aid in directing a separating sled (see, e.g., FIGS. 53A-C) toward the weakened region 2678 to facilitate automated separation of bags 26 in the chain 2670. Guide edges 2698 which form a notch or recess substantially in the shape of the Latin character “V” are shown in the example embodiment in FIG. 24A. The guide edges 2698 may also assist in forming a stress concentration where separation preferentially starts as bags 26 are individualized from the chain 2670. Alternatively, the weakened region 2678 may be broken apart or be provided with a pre-separated region 2671 at at least one of the opposing ends of the weakened region 2678. A small fraction of the weakened region 2678 may be pre-separated (e.g. less than 5%). This may similarly facilitate automated separation of bags 26 from the chain 2670. A pre-separated region 2671 in combination with guide edges 2689 may also be used in certain examples.

Referring now to FIG. 26, a portion of another exemplary chain 2670 of bags 26 is depicted. The chain 2670 in FIG. 26 includes bags 26 coupled in an end to end as opposed to a side by side manner. A gap 2676 between each bag 26 may be included to accommodate any ports 392 of the bags 26. The gap 2676 may be sized to be slightly larger than the longest projection distance of a port 392 from the bag 26. Each bag 26 may be coupled to an adjacent bag 26 by at least one bridge 2672 of material. In the example embodiment depicted in FIG. 26, two bridges 2672 are included. Each bag 26 may include a ported end 2673 and an opposing second end 2675. Bridge(s) 2672 may extend from the ported end 2673 to the second end 2675 of an adjacent bag 26 to form the chain 2670. In the example, the bridges 2672 are arranged such that their most lateral edges are in line with the lateral edges 2674 of the bags 26 forming the chain 2670.

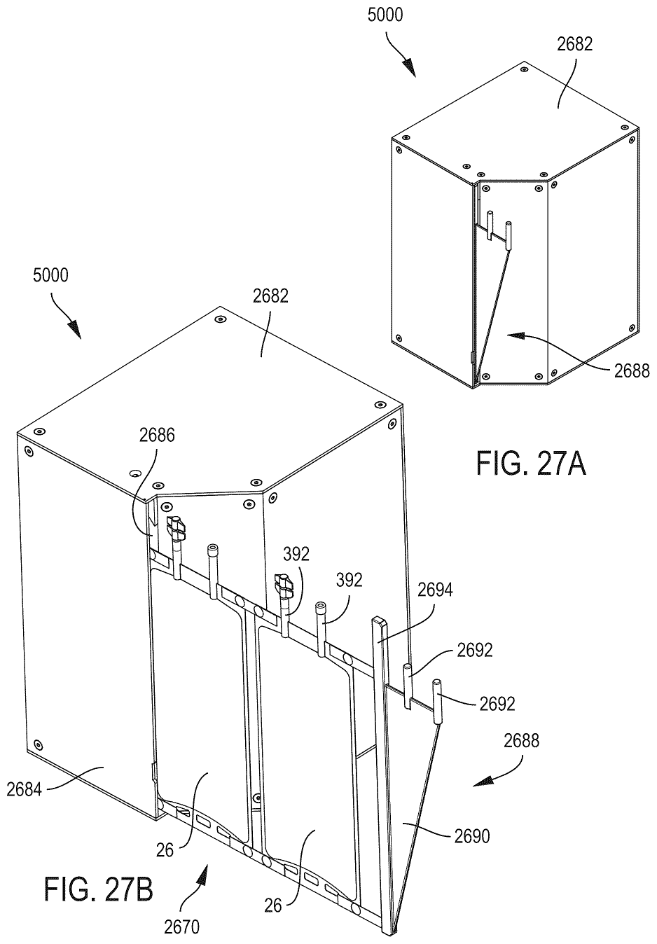

Referring now to FIGS. 27A-29, in some embodiments, chains 2670 of bags 26 may be provided in a dispenser 5000. Example dispensers 5000 may include a housing 2682. The housing 2682 may enclose a chain 2670 of bags 26 which may, for example, be placed on a reel or spool 2696 which may rotate within the housing 2682. The dispenser 5000 may include an outlet 2684. The outlet 2684 may include a slit 2686 through which bags 26 may be dispensed out of the dispenser 5000. The leading end of the chain 2670 of bags 26 may be attached to a leader 2688. The leader 2688 may include a main body 2690 with at least one dummy port 2692 projecting therefrom. The dummy port(s) 2692 may be sized and spaced to mimic the ports 392 on bags 26 of a chain 2670 such that automation equipment of the system 10 may easily interface with the leader 2688. For example, a grasper of a bag retainer assembly 4306 (see, e.g., FIG. 47A) may approach and grasp the dummy port(s) 2692 allowing the leader 2688 to be displaced within the system 10 in the same manner as a bag 26. As the leader 2688 is displaced, the chain 2670 of bags 26 may advance out of the slit 2686 and into the system 10 as shown in, for example, FIG. 27B.

Example leaders 2688 may also include a sealing member 2694. The sealing member 2694 may be a bar or plug which seats in the slit 2686 of the dispenser 5000 until the dispenser 2680 is ready for use. The sealing member 2694 may be formed of or covered at least partially with a complaint material. In certain examples, the walls of the slit 2686 may alternatively or additionally be covered by a compliant material. When in place within the slit 2686 the complaint material on the sealing member 2694 may be compressed against the walls of the slit 2686 and form an environmental seal which separates the interior of the dispenser 5000 from the surrounding environment. The dispenser 5000 may be provided in a terminally sterilized state (e.g. within an over pack) and the interior of the dispenser 5000 may remain in this state until the sealing member 2694 is dislodged from the slit 2686.

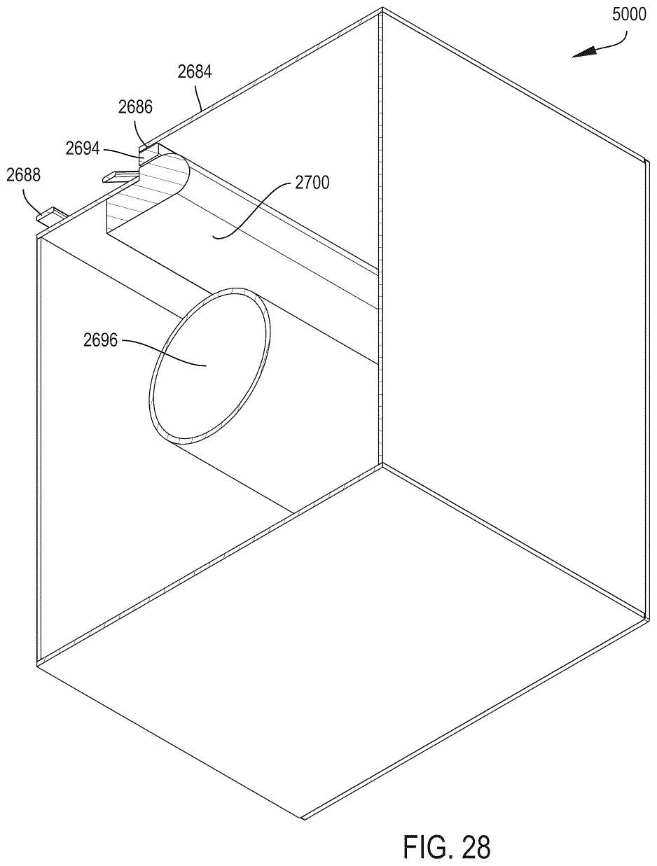

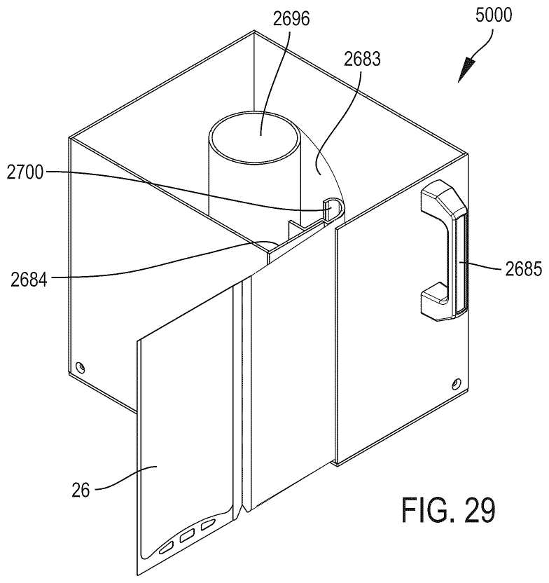

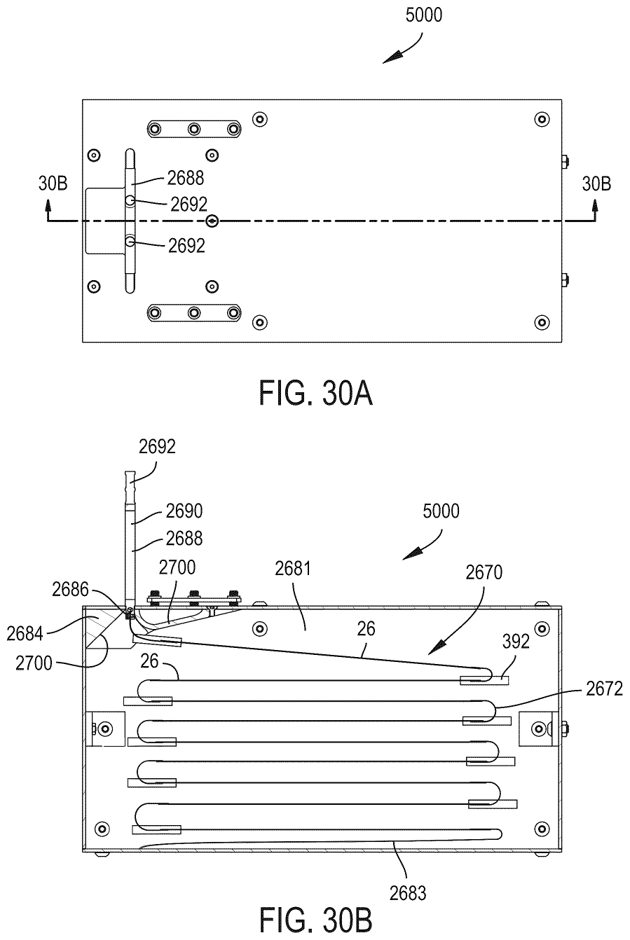

With reference primarily to FIG. 28, a sectioned view of the example dispenser 5000 shown in FIGS. 27A-B is depicted. The chain 2670 of bags 26 is omitted to better illustrate the interior of the dispenser 5000. The leader 2688 is shown in place with the plug portion 2694 of the leader 2688 sealing the slit 2686 of the dispenser 5000. As shown, the dispenser 5000 includes a reel 2696. The chain 2670 of bags 26 may be wrapped around the reel 2696 when packaged into the dispenser 5000 such that it may be spooled out of the dispenser 5000 during use. In some embodiments, the reel 2696 may be paired with a tensioning assembly 5100 (see, e.g., FIGS. 40A-B) so that the bags 26 are kept under some degree of tension as they are spooled out of the dispenser 5000. The outlet 2684 of the dispenser 5000 may include one or more guide 2700 (see also, e.g., FIG. 30B). Referring now also FIG. 29, guides 2700 may be included to mitigate potential for bags 26 to snag or catch as they are advanced out of a dispenser 5000. In various embodiments, the guides 2700 may be formed of (or at least partially covered with) a low friction coefficient material such as PTFE. Walls of the dispenser 5000 may similarly be formed or at least partially covered with such a material.

Referring now to FIGS. 27B-29, the last bag 26 in the chain 2670 may be coupled to a sacrificial tail 2683 (see, e.g., FIG. 29 and FIG. 30B). The sacrificial tail 2683 may couple to a portion of a reel 2696 or dispenser 5000. The sacrificial tail 2683 may provide a length of material which may be at least long enough to reach the slit 2686 or dispensing outlet of the dispenser 5000. As the chain 2670 is consumed, the sacrificial tail 2683 allows the final bags 26 of the chain 2670 to be advanced through the outlet 2684 and out of the slit 2686 as best shown in FIG. 29. The sacrificial tail 2683 may remain in the dispenser 5000 once the bags 26 in the chain 2670 have been completely consumed. In some embodiments, a tensioner assembly 5100 (see, e.g., FIGS. 40A-B) may be included and would automatically retract the sacrificial tail 2683 into the dispenser 5000 when the supply of bags 26 in the dispenser 5000 has been exhausted.

In some examples, the sacrificial tail 2683 may be a set of bags 26. The bags 26 forming the sacrificial tail 2683 may optionally be simplified. For example, the bags 26 in the sacrificial tail 2683 may not include ports 392 and may include a single interior compartment. Weakened regions between the bags 26 forming the sacrificial tail 2683 may be absent. The bags 26 forming a sacrificial tail 2683 may include reinforced couplings therebetween. Alternatively, the sacrificial tail 2683 may be a strip of sheeting 44A, B material which has no bags 26 defined therein (see, e.g., FIG. 29). In still other embodiments, the sacrificial tail 2683 may include a sacrificial bag 26 adjacent a last consumable bag 26 in the chain 2670. The remainder of the sacrificial tail 2683 may be plain sheeting 44A, B. In other embodiments, the sacrificial tail 2683 may be sheeting 44A, B which includes a set of ports 392 coupled thereto. The ports 392 may be spaced from one another at a spacing which mimics that of ports 392 on a bag 26. The ports 392 may be positioned in the sacrificial tail 2683 at a distance from the last consumable bag 26 which is substantially equal to the distance between ports 392 on adjacent bags 26 in the chain 2670. Including a sacrificial bag 26 or sacrificial ports 392 in the sacrificial tail 2683 may allow the sacrificial tail 2683 to be more easily held in place as the last consumable bag 26 is removed from the chain 2670. The sacrificial tail 2683 may be coupled to the reel 2696 in any suitable manner. In some embodiments a tape or adhesive may be used.

Referring now to FIGS. 30A-B, another example embodiment of a dispenser 5000 is depicted. The example dispenser 5000 includes an interior bay 2681 sized to accept a chain 2670 of bags 26 coupled together in an end to end manner. The bags 26 may be placed atop one another such that ports 392 of adjacent bags 26 in the chain 2670 face opposite directions. The bridges 2672 of the chain 2670 may be sufficiently flexible to allow the chain 2670 to be folded upon itself at the bridges 2672 such that the bags 26 may be placed in the bay 2681 in a stacked configuration. The bags 26 are shown with some spacing between one another in FIG. 30B for illustrative purposes, but would rest upon one another in practice.

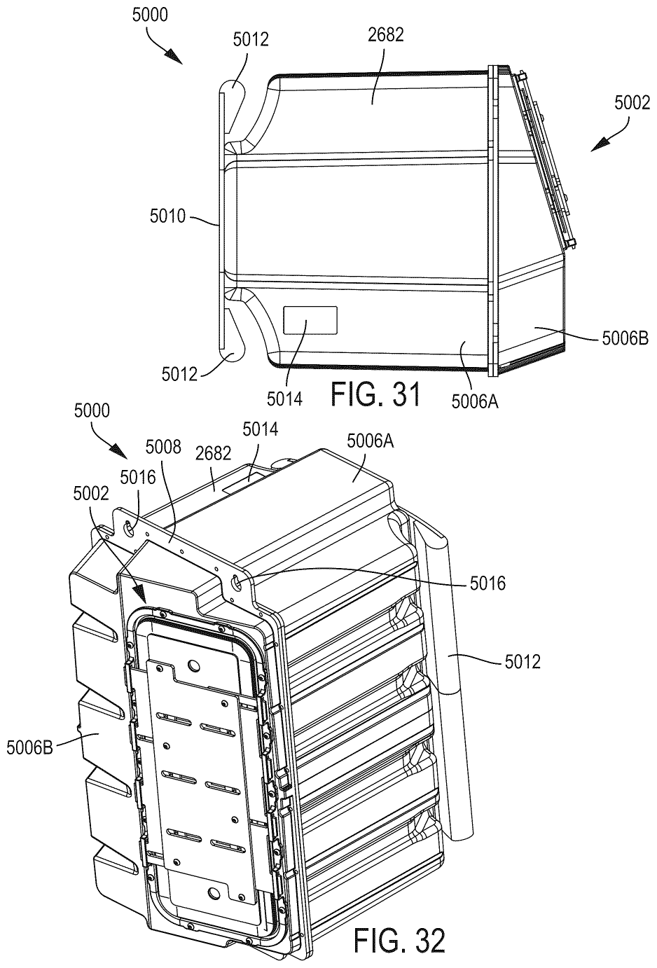

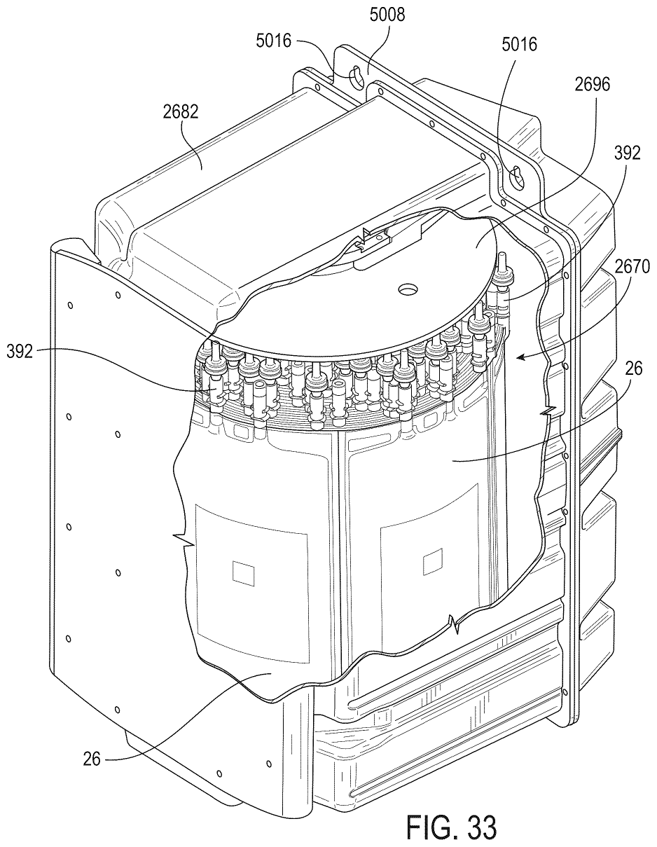

Referring now to FIGS. 31-33, another exemplary dispenser 5000 is depicted. As shown, a dispenser 5000 may include a housing 2682. A chain 2670 of bags 26 coupled to a reel 2696 may be included in the housing 2682 (best shown in FIG. 33). The housing 2682 may include a side panel 5010 including a set of handles 5012. The housing 2682 may be formed of a first housing portion 5006A and a second housing portion 5006B which may each be injection molded components. The handles 5012 may be include on a face of the first housing portion 5006A most distal the second housing portion 5006B. In some examples, one or more handle or grasping recess may be included near the top of the dispenser 5000. The first and second portion 5006A, B may be corrugated or ridged to add strength. In some examples, a recess in a series of corrugations for the first portion 5006A may double as a handle for lifting the dispenser 5000.

The first and second housing portion 5006A, B may be coupled together with fasteners or in any other suitable manner. One or more compliant member may be included to form a fluid tight seal between the first and second housing portions 5006A, B when the housing 2682 is assembled. A flange 5008 may be included in at least one of the first and second housing portions 5006A, B along a portion of the peripheral edge of the respective housing portion 5006A, B. The flange 5008 may include a set of retaining apertures which in the example are depicted as pin retainers 5016. The pin retainers 5016 may be passages through the flange 5008 which have a wider portion and a narrower portion. The pin retainers 5016 may be shaped as teardrop shaped passages through the flange 5008 in some embodiments. Though two pin retainers 5016 are shown, the flange 5008 may include additional pin retainers 5016.

The housing 2682 may also include at least one indicia 5014 such as barcodes, QR codes, GS1 codes, data matrices, bokodes, RFID tag, NFC tag, etc. The indicia 5014 may include various information about the dispenser 5000. For example, the indicia 5014 may include a unique dispenser 5000 identity, a lot identity for the dispenser 5000, production line identity, manufacturing date, an expiration or use by date, information defining the type of bags 26 contained therein (e.g. the fill capacity and type or volume of concentrate in the bags 26), number of bags 26 contained in the dispenser 5000, etc.

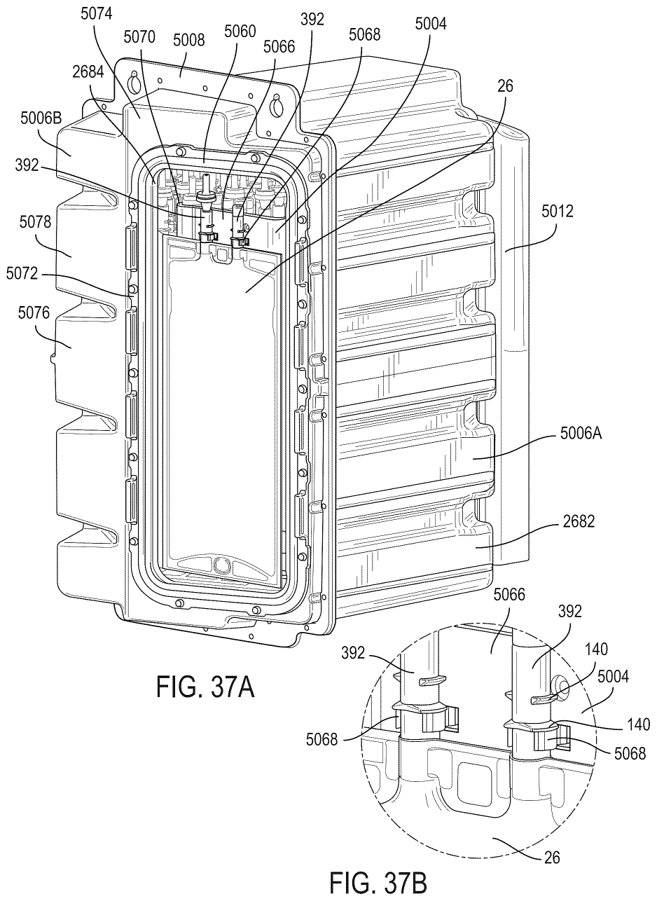

The housing 2682 may also include a removable cover assembly 5002. The removable cover assembly 5002 may be disposed on the side of the dispenser 5000 opposite the handles 5012. The removable cover assembly 5002 may cover and block the outlet 2684 (see, e.g., FIG. 34C) of the dispenser 5000 during shipping and handling of the dispenser 5000. The removable cover assembly 5002 may preferably be machine removable and arranged to make manual removal difficult without a tool. Typically a lock assembly 5090 may be included which may allow the removable cover assembly 5002 to be locked in place on the dispenser 5000. The removable cover assembly 5002 may include or compress against one or more sealing member 5060 (see, e.g., FIG. 37A) which isolates the interior volume of the dispenser 5000 from the surrounding environment when the removable cover assembly 5002 is in place. Thus, the removable cover assembly 5002 may maintain the interior volume of the dispenser 5000 in a sterilized state.

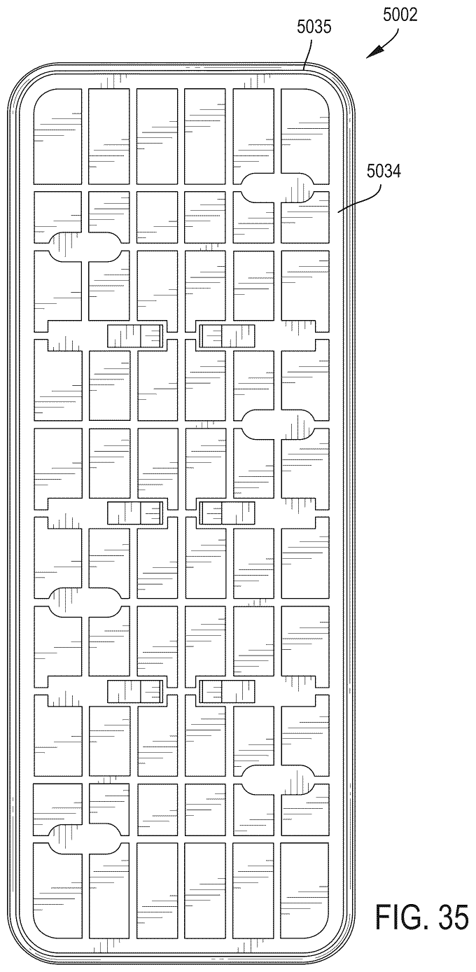

Referring now to FIGS. 34A-35, the removable cover assembly 5002 may include an overlay body 5030, a set of lock bodies 5032A, B, and a backing body 5034. The locking bodies 5032A, B may be disposed intermediate the overlay body 5030 and the backing or sealing body 5034. The backing body 5034 may have a sealing member 3035 or gasket (best shown in FIG. 35) about the periphery of the side of the backing body 5034 opposite the locking bodies 5032A, B. The locking bodies 5032A, B may be captured between the overlay body 5030 and backing body 5034 when the overlay body 5030 is coupled to the backing body 5034. In the example, the overlay body 5030 is coupled to the backing body 5034 via fasteners 5036. In alternative embodiments, the overlay body 5030 may be coupled to the backing body 5034 via welding (e.g. sonic), adhesive, solvent bonding, rivets, heat stake, or any other suitable manner. Each locking body 5032A, B may include a set of bolt projections 5050.

As shown, the example overlay body 5030 is a plate and includes a number of overlay slits 5038. The backing body 5034 includes a number of variable depth troughs 5042 recessed therein. The overlay slits 5038 may be aligned with the troughs 5042 when the removable cover assembly 5002 is assembled. The locking bodies 5032A, B each include a set of apertures 5040. When the removable cover assembly 5002 is in an assembled state, the apertures 5040 may be in alignment with the overlay slits 5038 and troughs 5042.

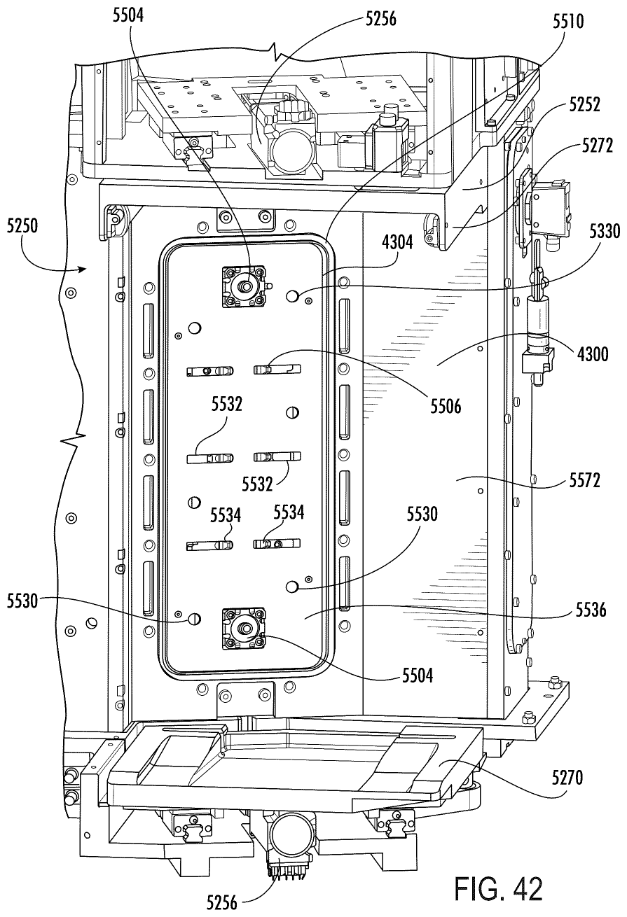

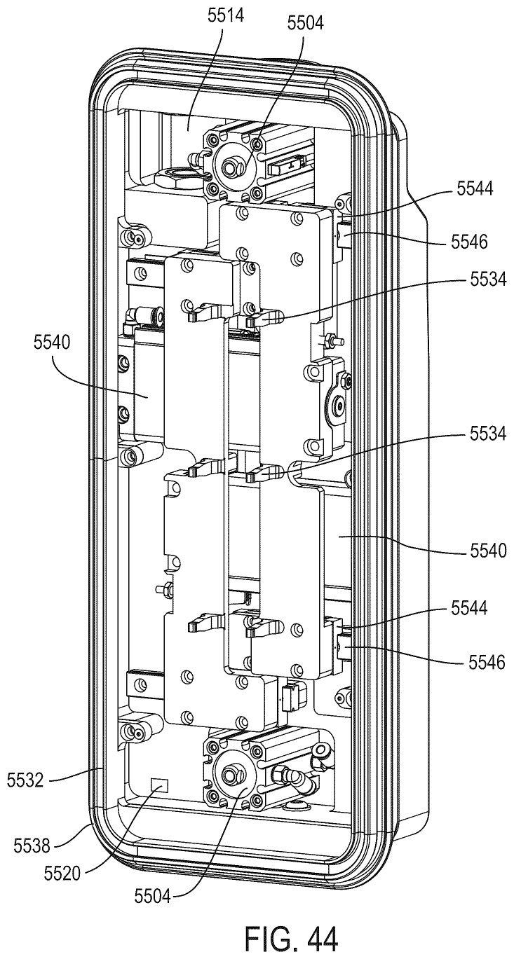

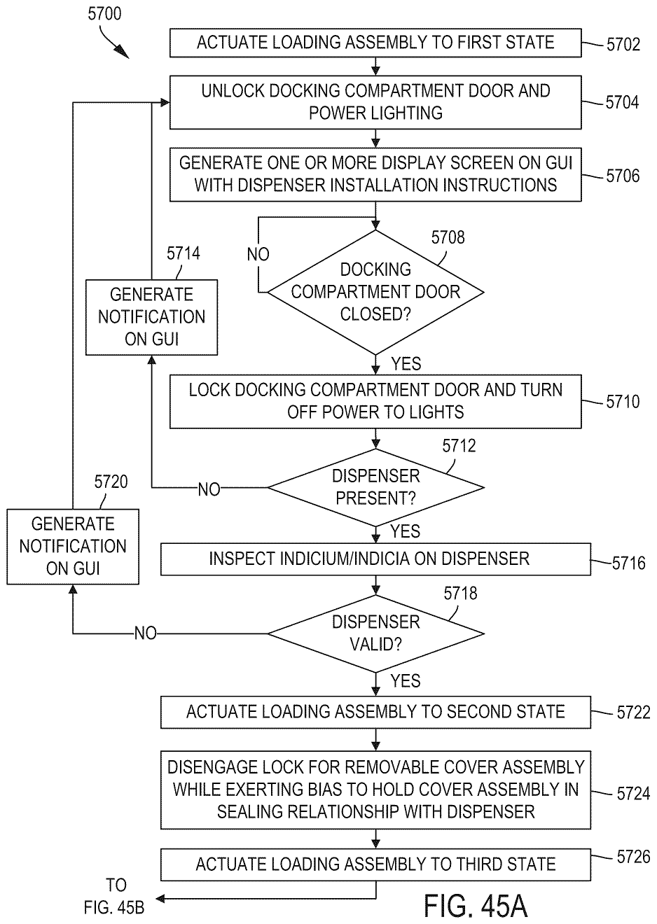

Each locking body 5032A, B also includes a number of guide slots 5044. The guide slots 5044 may accept respective elongate guide rails 5046 which extend proud of the adjacent face of the backing body 5034. A sanitary interface assembly 5500 (see, e.g., FIG. 2) may include a number of projections 5534 (e.g. pins, rods, fingers see FIG. 42) which are translationally displaceable via actuators 5540 (see, e.g., FIG. 44) in the sanitary interface assembly 5500. A projection 5534 may be passed into each of the overlay slits 5038, through the aligned aperture 5040 in a lock body 5032A, B and to the trough 5042. Translational displacement of the projections 5534 would engender a translational displacement of the lock body 5032A, B through which it extends. Thus, the lock bodies 5032A, B may be translated toward and apart from one another. The lock bodies 5032A, B may be displaced until the ends of the guide slots 5044 collide with edge of the guide rails 5046. Thus, the displacement range of the lock bodies 5032A, B may be limited.

In the spread apart position (see, e.g. FIG. 34A), the bolt projections 5050 of the lock bodies 5032A, B may extend into respective bolt retainers 5052 defined in a rim 5054 surrounding the outlet 2684 of the dispenser 5000. The rim 5054 may be constructed of one more pieces of rigid material and may be rigid plastic or metallic (e.g. stainless steel or anodized aluminum) in some embodiments. As shown, the terminal regions 5056 of the bolt projections 5050 may be ramped. As the bolt projections 5050 are advanced into the bolt retainers 5052, the ramped terminal region 5056 may cause the removable cover assembly 5002 to be driven or wedged against the housing 2682. This, in turn, may press a sealing member 3035 (best shown in FIG. 35) of the backing body 5034 against a surface of the housing 2682 surrounding the outlet 2684. Thus, when the lock bodies 5032A, B are in a spread apart or locked state, a fluid tight seal may be formed between the removable cover assembly 5002 and the interior of the dispenser 5000.

The lock bodies 5032A, B may be considered to be in an unlocked state or position when retracted toward one another (see, e.g., FIG. 34B). In the unlocked position, the lock bodies 5032A, B may be out of contact with the bolt retainers 5052 of the rim 5054. The removable cover assembly 5002 may be free to be removed from the dispenser 5000 when the lock bodies 5032A, B are disengaged from the bolt retainers 5052.

Referring now to FIGS. 36A-B, an exemplary chain 2670 of bags 26 on a reel 2696 is depicted. The chain 2670 may include any desired number of bags 26 and the dispenser 5000 may be sized accordingly. Preferably the weight of the dispenser 5000 with a full chain 2670 of bags 26 may be under 10 kg. Though the bags 26 depicted are those shown in FIGS. 8A-B, any bags 26 shown or described herein may be included and may include any type of concentrate described herein. Bags 26 forming the chain 2670 may have a capacity of 50 ml, 100 ml, 250 ml, 500 ml, 1000 ml, 2000 ml, or 5000 ml, though other sizes may also be used. The example includes 1000 ml bags 26.

As shown, the reel 2696 includes a set of opposing end flanges 5020A, B. A barrel or core 5022 extends between the end flanges 5020A, B. The chain 2670 of bags 26 is shown coupled to the core 5022 of the reel 2696 by adhesive bearing tape 5024 in the example embodiment. Any other cleanroom suitable manner of anchoring the chain 2670 to the core 5022 may be used. Though the portion of the chain 2670 coupled to the core 5022 is a series of bags 26, any sacrificial tail 2683 shown or described herein may be used.

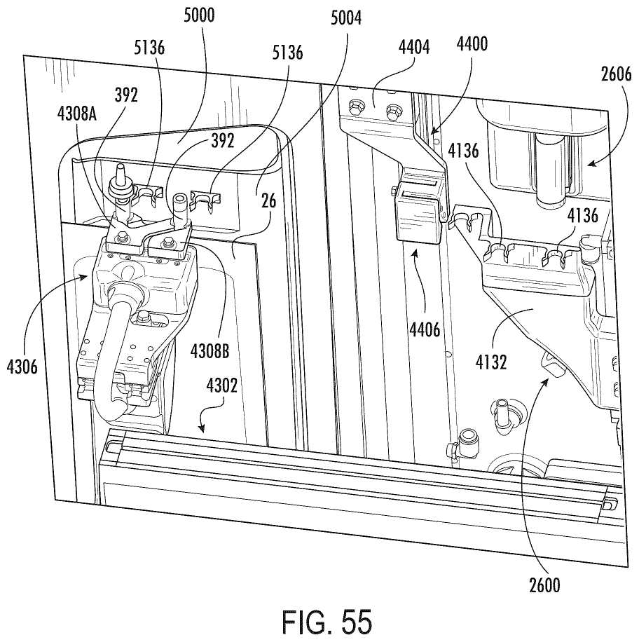

Referring now to FIGS. 37A-B, when the removably cover assembly 5002 has been unlocked from the dispenser 5000 and removed, the chain 2670 of bags 26 within the dispenser 5000 may be accessed. As shown, the dispenser 5000 includes a bag presenter 5004. The bag presenter 5004 may be coupled to the housing 2682 or may be formed as an integral part of the first or second housing portion 5006A, B. A bag presenter 5004 may include a guide body 5066 on which a set of port retainers 5068 are disposed. The ports 392 of a lead bag 26 in the chain 2670 may be engaged with the port retainers 5068. This may hold the lead bag 26 in place against any bias force exerted against the chain 2670 by a tensioning assembly 5100 (see, e.g., FIGS. 40A-B) of the dispenser 5000. The port retainers 5068 may be the same as those included on the fill displacement stage 3142 and may passively retain the ports 392 of the lead bag 26. The port retainers 5068 may keep the lead bag 26 in an expected position within the dispenser 5000. This may facilitate retrieval of the lead bag 26 by a bag retention assembly 4306 (see, e.g., FIG. 55) of a bag displacement assembly 2618 of the system 10.

The guide body 5066 may be formed as a cantilevered panel. The unsupported end of the guide body 5066 may be rounded or include a lip 5070. The guide body 5066 may also be formed of a low friction coefficient material such as PTFE in some examples. As the chain 2670 is pulled out of the dispenser 5000, the guide body 5066 may assist in directing the chain 2670 as it unravels from the reel 2696. The guide body 5066 may constrain the chain 2670 such that it will tend to exit the dispenser 5000 near the upstream edge 5072 of the outlet 2684. As shown, the outlet 2684 of the dispenser 5000 may be included in an angled face 5074 of the housing 2682. The angled face 5074 may be at a 10-25° angle (e.g. 16.5°) to a second portion 5078 of the front face 5076 of the housing 2682. The second portion of the front face 5076 may be substantially parallel to the opposing side of the housing 2682 including the side panel 5010. The chain 2670 of bags 26 may generally be removed from the dispenser 5000 such that the chain 2670 extends out of the dispenser 5000 substantially parallel (e.g. within 15°) to the second portion 5078 of the front face 5076. Providing the angled face 5074 may assist in providing clearance for the chain 2670 as the chain 2670 is advanced out of the dispenser 5000 and may further help encourage the chain 2670 to extend through the outlet 2684 near the upstream edge 5072 of the outlet 2684. The angled face 5074 also allows the bag presenter 5004 to be recessed with respect to the exit point of the chain 2670 from the outlet 2684 of the dispenser 5000. This may help to inhibit bags 26 from snagging on the port retainers 5068 as the chain 2670 is consumed.

In certain examples, the port retainers 5068 may be pivotally coupled to the bag presenter 5004 and may be pivoted against the main portion of the bag presenter 5004 after the lead bag 26 is removed. In some embodiments, a bias member (e.g. torsion spring) may be associated with each port retainer 5068 to assist in displacing the port retainers 5068 to a stowed position once the lead bag 26 has been collected.

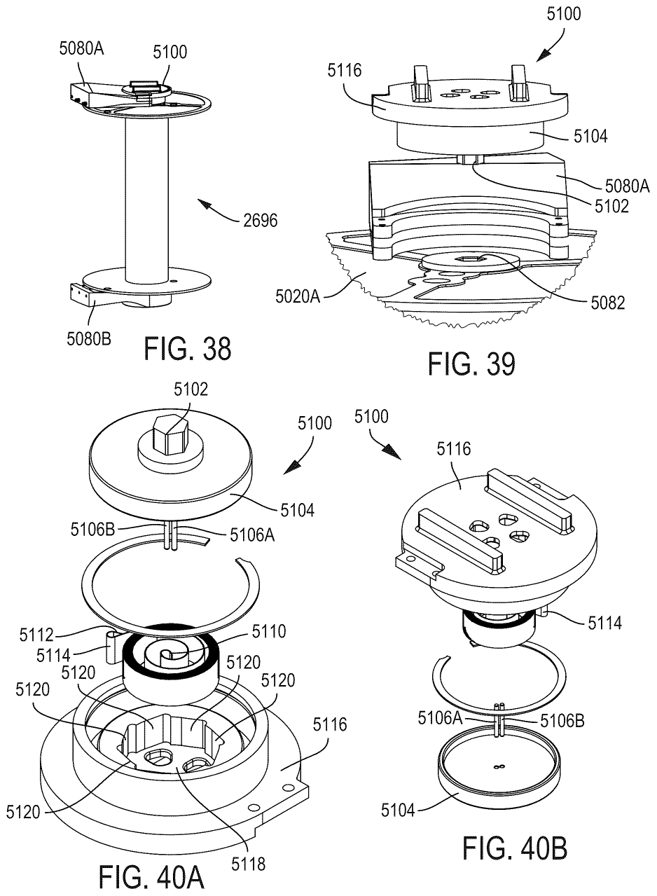

Referring now to FIGS. 38-40B, the spool 2696 of the dispenser 5000 may be associated with a tensioner assembly 5100. As shown, the spool 2969 may be retained within the dispenser 5000 by spool brackets 5080A, B. A plain bearing type interface may be present between the spool flange 5020B and spool bracket 5080B. The spool flange 5020B may, for example, include a bearing projection which seats in a receptacle of the spool bracket 5080B. The bearing projection and/or bracket receptacle may be formed of a low friction coefficient material such as PTFE.

The opposing spool flange 5020A may include a keyed receptacle 5082 which interfaces with a keyed projection 5102 of the tensioner assembly 5100. Alternatively, the tensioner assembly 5102 may include a keyed receptacle and the spool flange 5020A may include a keyed projection. In the example shown, the keyed projection 5102 is included on a base 5104 of the tensioner assembly 5100. In the example, the projection 5102 and receptacle 5082 have a hexagonal cross-section. In other embodiments, any other polygon, elongate round shape, obround, star shape, semi-circular or other cross-section may be used. Due to the keyed interface between the spool 2696 and the tensioner assembly 5100, the spool 2696 may rotate in tandem with the base 5104 of the tensioner assembly 5100.

The exemplary tensioner assembly 5100 includes a bias member 5108. The bias member 5108 may be a coiled ribbon spring or constant force spring. A set anchors such as a set of pins 5106A, B may be coupled to the base 5104 and may capture a first end 5110 of the bias member 5108. The opposing end 5112 of the bias member 5108 may be routed or bent so as to generate a rounded end region 5114. The rounded end region 5114 may be tear drop shaped in certain examples.

The tensioner assembly 5100 may further include a cover body 5116 which is fixedly coupled to the spool bracket 5080A. The cover body 5116 includes a recess 5118 sized to accept the bias member 5108. The side walls of the recess 5118 are formed of a plurality of detents 5120 which the rounded end region 5114 of the bias member 5108 may seat in. As the spool 2696 rotates about its axis, the base 5104 of the tensioner assembly 5100 rotates with the spool 2696 while the cover body 5116 is stationary. Since the first end 5110 of the bias member 5108 is retained by the pins 5106A, B this may cause distortion of the bias member 5108. The bias member 5108 may exert a restoring force when distorted which applies tension through the base 5104 and spool 2696 to the chain 2670 of bags 26 (see, e.g., FIG. 36A). When the supply of consumable bags 26 in the dispenser 5000 is exhausted, the chain 2670 may be released from any grippers or retainers in the system 10. The bias member 5108 would then be allowed to return to a relaxed state. As the bias member 5108 transitions to the relaxed state, the spool 2696 would be rotated and the sacrificial tail 2683 of the chain 2670 would be wound back on to the spool 2696 or at least into the interior volume of the dispenser 5000. After the bias member 5108 is sufficiently relaxed, all remnants of the chain 2670 may be retracted into the dispenser 5000 and the removable cover assembly 5002 may be reinstalled.

The sidewall of the recess 5118 of the cover body 5116 may be formed of a series of detents 5120 to prevent excessive tension being built up by the tensioner assembly 5100. As a threshold tension force is breached, the bias member 5108 may relieve tension on the chain 2670 by slipping out of one detent 5120 and into an adjacent detent 5120. Thus, the tension generated by the tensioning assembly 5100 may be limited and may be maintained within a predetermined range dependent on the detent 5120 arrangement. The dispenser 5000 may be provided pre-tensioned to ensure outfeed from the dispenser 5000 is generally consistent from the first bag 26 of the chain 2670 to the end of the chain 2670.

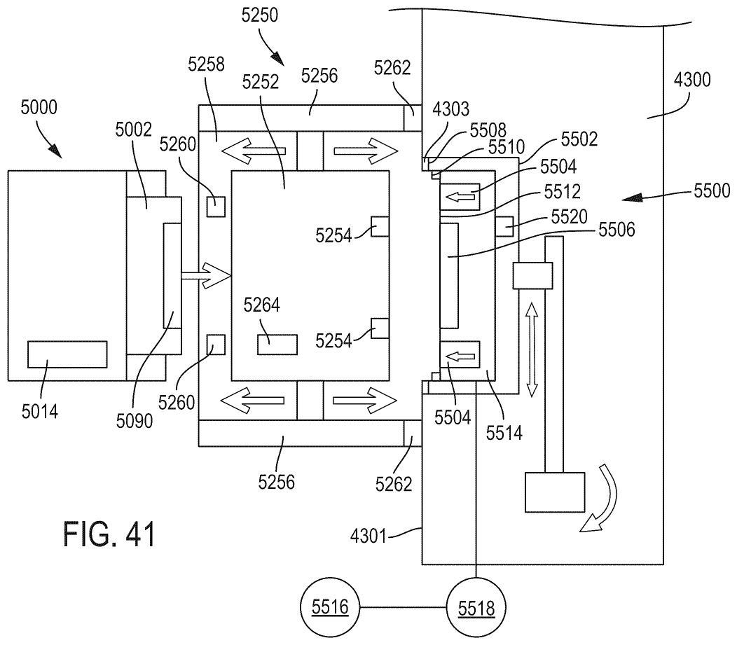

Referring now to FIG. 41, a block diagram of a portion of a docking assembly 5250 and a processing compartment 4300 with a sanitary interface assembly 5500 is depicted. To install a dispenser 5000 in a system 10, a user may place the dispenser 5000 in a dispenser carriage 5252 in a docking compartment 5258 of the docking assembly 5250. To do so, a docking assembly door 5400 (see, e.g., FIG. 1) may be unlocked by the system 10 and opened by a user. The carriage 5252 may include a set of retainers 5254. The retaining apertures of the dispenser 5000 may be engaged with the retainers 5254 to locate the dispenser 5000 within the carriage 5252. At least one lighting assembly 5260 including one or more light emitters (e.g. LEDs) may be included in the docking assembly compartment 5258. The lighting assembly 5260 may be powered when the door 5400 is in an open state to facilitate placement of the dispenser 5000 into engagement with the retainers 5254 (or removal of the dispenser 5000 from the carriage 5252).

The dispenser carriage 5252 may be coupled to one or more carriage actuator 5256. The control system 15 may govern displacement of the carriage 5252 within the docking compartment 5258 via commands to the carriage actuators 5256. At least one carriage position sensor 5262 may be included. For example, each carriage actuator 5256 may be associated with a position sensor 5262 which may output a data signal indicative of the position of the carriage 5252. In some embodiments, the carriage actuators 5256 may be leadscrew or ballscrew type actuators and the position sensors 5262 may be rotary encoders. Commands from the control system 15 to the carriage actuators 5256 may be based on the data signals received from any carriage position sensors 5262. The carriage 5252 may be displaced between a loading position (most distal the processing chamber 4300), a partially installed position, and a fully installed position in which a sealing member 5060 (see, e.g., FIG. 37A) of the dispenser 5000 is sealed against the exterior of the processing chamber 4300.

After a dispenser 5000 is loaded onto a carriage 5252, the door 5400 to the docking compartment 5258 may be closed and locked. The control system 15 may command displacement of the carriage 5252 to the partially installed position. An indicia reader 5264 may be included in the docking assembly 5250 and may read at least one indicium 5014 included on the dispenser 5000. The indicia reader 5264 may be a barcode reader, QR code reader, GS1 code reader, data matrix reader, bokode reader, RFID interrogator, NFC interrogator, or other variety of reader as appropriate for the indicia 5014 on the dispenser 5000. In certain examples, the indicia reader 5264 may be an imager. The control system 15 may receive data from the indicia reader 5264 and verify that the dispenser 5000 is acceptable for use. For example, the control system 15 may verify that a use by or expiration date determined from the indicium 5014 has not passed. The control system 15 may also check a unique identifier for the dispenser 5000 against a database (e.g. cloud database) to ensure that dispenser 5000 has not already been used, subject to recall, etc. The control system 15 may also set one or more operating parameter for the system 10 based on data obtained from the indicium 5014. For example, the control system 15 may determine a fill set point (e.g. volume) for each bag 26 based on information about the capacity of the bags 26 in the dispenser 5000 or the concentrate in the bags 26 in the dispenser 5000.

In the event the dispenser 5000 is acceptable for use, a set of cover holders 5504 in the infeed aperture plug 5502 may be deployed against the removable cover assembly 5002 of the dispenser 5000. The cover holders 5504 may be air springs in certain examples and may be pressurized against the removable cover assembly 5002. A lock actuation assembly 5506 may also be included in the infeed aperture plug 5502. As the carriage 5252 is displaced to the partially installed position, the lock actuation assembly 5506 may engage the lock assembly 5090 of the dispenser 5000. With the removable cover assembly 5002 held in compression against the dispenser 5000 by the cover holders 5504, the lock actuation assembly 5506 may be powered to transition the lock assembly 5090 of the dispenser 5000 to a disengaged state. This may decouple the removable cover assembly 5002 from the dispenser 5000 while maintaining the seal between the dispenser 5000 and removable cover assembly 5002 with the cover holders 5504.

Still referring to FIG. 41, the infeed aperture plug 5002 may include a sealing member 5508 which forms a seal around the infeed aperture 4303 on the interior face of the wall 4301 of the processing compartment 4300. The infeed aperture plug 5002 may also include an exposed section spanning the infeed aperture 4303 which is in communication with the docking compartment 5258. A central region 5512 of the exposed section may be recessed. The carriage 5252 may be displaced to the fully installed position. As the carriage 5252 reaches the fully installed position, a sealing member 5060 of the dispenser 5000 may compress against the exterior of the processing compartment 4300 around the infeed aperture 4303. A perimeter region of the removable cover assembly 5002 (e.g. a face of the backing body 5034) may compress against a second sealing member 5510 of the infeed aperture plug 5502 at the perimeter of the exposed region of the infeed aperture plug 5502. In various examples, this establishes a sealed volume intermediate the removable cover assembly 5002 and the central region 5512 of the exposed section of the infeed aperture plug 5502. Surfaces of the removable cover assembly 5002 and infeed aperture plug 5502 exposed to the ambient environment may be isolated by the seal formed between the removable cover assembly 5002 and second sealing member 5510.

The central region 5512 may include one or more passages extending into an interior bay 5514 of the infeed aperture plug 5502. The interior bay 5514 may be in selective fluid communication with a vacuum source 5516 via a valve 5518. The valve 5518 may be opened to draw a vacuum within the sealed volume between the removable cover assembly 5002 and the infeed aperture plug 5502. The vacuum may serve to hold the removable cover assembly 5002 in sealing relationship with the second sealing member 5510 of the infeed aperture plug 5502. A pressure sensor 5520 may be included in the interior bay 5514 to verify an acceptable negative pressure has been established and maintained. The cover holders 5504 may be deactivated once the control system 15 determines a stable vacuum has been established. Alternatively, the cover holders 5504 may remain active and the vacuum established may be sufficient to retain the removable cover assembly 5002 in placed despite the bias exerted by the cover holders 5504.

With the removable cover assembly 5002 retained thereon, the infeed aperture plug 5502 may be displaced away from the infeed aperture via one or more plug displacement actuator 5522, 5524. In the example embodiment, a rotary actuator 5522 is included and may be powered to pivotally displace the infeed plug assembly 5502 relative to the infeed aperture 4303. A linear actuator 5524 is also included and may translationally displace the infeed aperture plug 5502. The actuators 5522, 5524 may be commanded by the control system 15 to drive the infeed aperture plug 5502 and removable cover assembly 5002 to a stowed position within the processing compartment 4300. In the stowed position, the infeed aperture plug 5502 and removable cover assembly 5002 are out of the way of any automation (e.g. a bag displacement assembly 2618) within the processing compartment 4300. The infeed aperture plug 5502 is shown displaced to a non-interfering position in FIG. 2 for instance. The rotary actuator 5522 and the linear actuator 5524 may each be associated with a brake or clamp which may be engaged to lock the actuators 5522, 5524. This may hold the infeed aperture plug 5502 in place when displacement is not desired.

Referring now to FIG. 42, a view of a docking assembly 5250 and infeed aperture plug 5502 in place in an infeed aperture 4303 to a processing compartment 4300 is depicted. As shown, the carriage 5252 includes a first and second support body 5272, 5272 for the dispenser 5000. Each of the support bodies 5270, 5272 is coupled to a respective carriage actuator 5256. The support bodies 5270, 5272 may include guide rails 5274 which ride along a set of bearings 5276 which are fixedly coupled in place within the docking assembly 5250. The support bodies 5270, 5272 may respectively accept a top and bottom portion of the dispenser 5000. The first support body 5270 may include a trough 5278 which may accept the flange 5008 of a dispenser 5000. The first support body 5270 may include at least one ramp feature 5280 extending toward the trough 5278. The ramp feature(s) 5280 may assist in directing the dispenser 5000 into position as the dispenser 5000 is loaded into the carriage 5252. A dispenser 5000 is shown in place within the example carriage 5252 in FIG. 43.

Referring now to FIGS. 42-43, the opposing second support body 5272 may include retainers 5254 which extend through the retaining apertures of a dispenser 5000 when the dispenser 5000 is installed. The retainers 5254 may be pins in some implementations. The pins may fit through a wide section of a respective pin retainer 5016 in a flange 5008 of a dispenser 5000. When the dispenser 5000 is released, the dispenser 5000 may displace or drop such that a narrow section of the pin retainers 5016 passes into a detent in the retainer 5254 pins. The head of the retainer 5254 pins may not pass through the narrow section of the pin retainers 5016. Thus, it may be necessary to lift the dispenser 5000 before decoupling it from the carriage 5252.

As shown, the infeed aperture plug 5502 includes an exposed central region 5512. The exposed central region 5512 may be formed by a housing section or panel 5536. Two cover holders 5504 are disposed extending through opposing end regions of the central region 5512. There are also a number of vacuum passages 5530 extending through the central region 5512. The vacuum passages 5530 may also provide clearance for features of the removable cover assembly 5002 when the removable cover assembly 5502 is adjacent the central region 5512. At the perimeter of the central region 5512 may be a raised ledge 5532 on which the second sealing member 5510 of the infeed aperture plug 5502 may be disposed. A rim 5538 surrounding and proud of the raised ledge 5532 may be present and the first sealing member 5508 may be associated therewith. As the infeed aperture plug 5502 is sealed against the surface of the interior wall of the processing compartment 4300 directly adjacent the infeed aperture 4303, the rim and first sealing member 5508 are not visible in FIG. 42. The central region 5512 additionally includes a number of slits 5532. Projections 5534 of the lock actuation assembly 5506 extend through the slits 5532.

Referring now also to FIG. 44, a view of an example infeed aperture plug 5502 with the housing panel 5536 removed is depicted (in some embodiments the housing panel 5536 may be entirely omitted). When the dispenser 5000 is displaced to the partially installed position by the carriage 5255, the projections 5534 may engage with the lock assembly 5090 of the dispenser 5000. Actuators 5540 within the interior bay 5514 of the infeed aperture plug 5502 may displace the projections 5534. In the example, the projections 5534 may extend from a pair of elongate bodies 5542A, B. The elongate bodies 5542A, B may each include or be outfitted with a set of guides 5544 which ride along bearings 5546 fixedly coupled to the interior bay 5514. Each elongate body 5542A, B may be driven by a dedicated pneumatic actuator 5540 in certain examples. Pressure may be supplied to the pneumatic actuators 5540 to drive the elongate bodies 5542A, B toward and away from one another. With reference to the example dispenser 5000 of FIGS. 34A-C, the projections 5534 may extend through respective overlay slits 5038 (see, e.g., FIG. 34C), through the aligned aperture 5040 in a lock body 5032A, B (see, e.g., FIG. 34C) and to a trough 5042 (see, e.g., FIG. 34C) of the backing body 5034 of the removable cover assembly 5002. Displacement of the elongate bodies 5542A, B and the projections 5534 extending therefrom may actuate the lock bodies 5032A, B as described in relation to FIGS. 34A-C. Thus, a removable cover assembly 5002 may be uncoupled and coupled to the dispenser 5000. With the lock bodies 5032A, B out of the way, the dispenser 5000 may then be advanced to a fully installed position. A sealing member 5060 on the dispenser 5000 may seal around infeed aperture 4303 when the dispenser 5000 reaches the fully installed position. The variable depth troughs 5042 may be deepest at a region aligned with the position of the projections 5534 when the lock bodies 5032A, B are disengaged. This may provide clearance for the projections 5534 as the dispenser 5000 is driven from the partially installed position to the fully installed position.

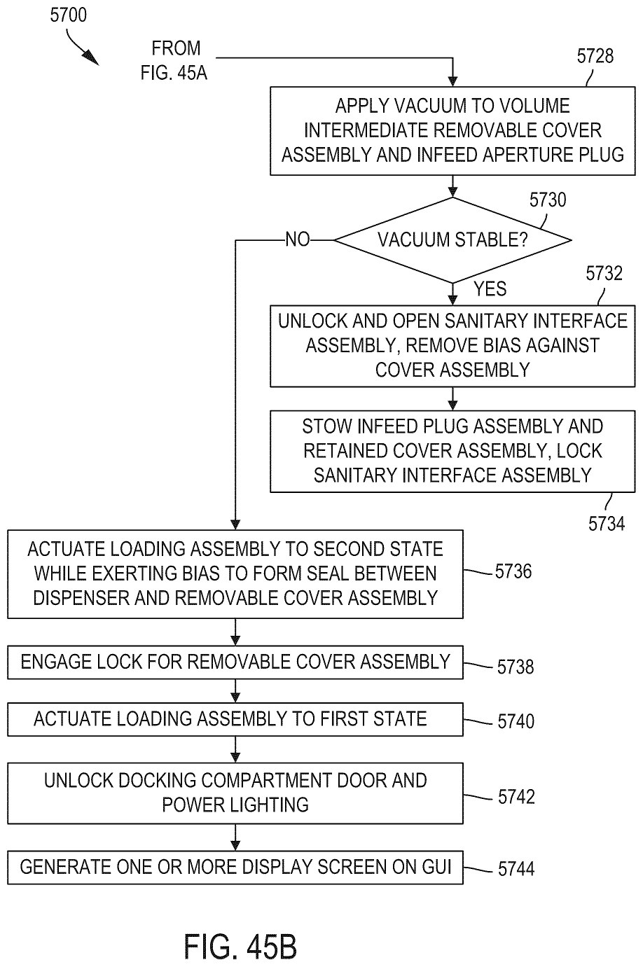

Referring now to FIGS. 45A-B, a flowchart 5700 is depicted illustrating a number of example actions which may be executed to load and access a dispenser 5000 with an example system 10. As shown, a carriage 5252 of a docking assembly 5250 may be actuated to a first state in block 5702. The first state may be a loading state in which the carriage 5252 is most distal the processing chamber 4300 of the system. In block 5704, the docking compartment door 5400 may be unlocked and any lighting assemblies 5260 in the docking assembly 5250 may be powered. In block 5706, the control system 15 may generate one or more screen for display on a graphical user interface 6100 of the system. The one or more screen may provide instructions in the form of text, images, illustrations, animations, or some combination thereof. The user may load the dispenser 5000 in accordance with the instructions on the graphical user interface 6100. When the docking compartment door 4700 is registered to be closed in block 5708, the control system 15 may actuate a lock for the door 4700 and terminate power to any lighting assemblies 5260 of the docking assembly 5250.

In some embodiments, at least one dispenser presence sensor may be included in the docking assembly 5250. The dispenser presence sensor may, for instance, be a microswitch which is depressed when the dispenser 5000 is properly loaded in the carriage 5252. Optical sensors such as a beam break or reflectivity based sensor may be used. A load cell monitoring for the presence of a payload in the carriage 5252 may also be used. In some embodiments, the indicia reader 5264 may double as the dispenser presence sensor. The control system 15 may monitor the data signal from the dispenser presence sensor to determine if a dispenser 5000 has been loaded into the docking assembly 5250. If, in block 5712, a dispenser 5000 is determined to be absent, the control system 15 may generate a notification for display on the graphical user interface 6100 in block 5714 and the flowchart 5700 may return to block 5704. If a dispenser 5000 is detected in block 5712, the indicium 5014 on the dispenser 5000 may be inspected in block 5716. For example, the control system 15 may command an indicia reader 5264 to capture an image of the indicium 5014 and analyze the image. The control system 15 may also compare data gleaned from the indicium 5014 to a database to verify that the dispenser 5000 is valid or acceptable for use in block 5716. If, in block 5718, the dispenser 5000 is determined to be invalid or unacceptable, the control system 15 may generate a notification for display on the graphical user interface 6100 in block 5720 and the flowchart 5700 may return to block 5704.

If, in block 5718, the dispenser 5000 is valid, the loading assembly or carriage 5252 may be actuated to a second position in block 5722. The second position may be referred to elsewhere herein as a partially installed position. In the second position, the lock actuation assembly 5506 of the infeed aperture plug 5502 may be in engagement with the lock assembly 5090 of the dispenser 5000. The lock assembly 5090 of the dispenser 5000 may be actuated to a disengaged or unlocked state by the lock actuation assembly 5506 in block 5724. A bias may also be applied to the removable cover assembly 5002 of the dispenser 5000 to hold the removable cover assembly 5002 in a sealing relationship with the dispenser 5000 in block 5724. This bias may be exerted via a bias member (e.g. one or more air spring) included in the infeed aperture plug 5502. The carriage 5252 may be displaced to a third position in block 5726. A sealing member 5060 of the dispenser 5000 may establish a sealing relationship around the infeed aperture 4303 in the third position. The periphery of the removable cover assembly 5002 may also form a fluid tight seal against a gasket or sealing member disposed at the periphery of the exposed surface of the infeed aperture plug 5502. In block 5728, vacuum may be applied to the sealed volume intermediate the removable cover assembly 5002 and the infeed aperture plug 5502.

The control system 15 may monitor data from one or more pressure sensor 5520 in fluid communication with the sealed volume to determine whether the pressure in the sealed volume is at least below a predefined set point. The control system 15 may also monitor the pressure to ensure that the decay rate of pressure in the sealed volume is below a predefined threshold. If, in block 5730, a stable vacuum has been established, the sanitary interface assembly 5500 may be unlocked and opened in block 5732. The bias against the removable cover assembly 5002 may also be alleviated in block 5732. This may, for instance, be accomplished by depressurizing the air springs. Alternatively, the bias may remain present and the vacuum may be sufficient to retain the removable cover assembly 5002 in place in spite of the bias. In block 5734, the infeed aperture plug 5502 and the vacuum retained removable cover assembly 5002 may be displaced to a stowed position. The infeed aperture plug 5502 may also be unlocked in block 5734. A locking clamp for a pneumatic cylinder (e.g. linear actuator 5524) may be disengaged and/or a brake for an electromechanical actuator (e.g. rotary actuator 5522) may be disengaged. Once in the stowed position, the sanitary interface assembly 5500 may be locked (e.g. any clamps and/or brakes on actuation components may be engaged).

If, in block 5730, a stable vacuum is not established, the carriage 5252 may be actuated to the second position while the bias compressing the removable cover assembly 5002 against the dispenser 5000 is exerted in block 5736. In block 5738, the lock assembly 5090 of the dispenser 5090 may be re-engaged or returned to a locked state by the lock actuation assembly 5506 of the infeed plug assembly 5502. The infeed plug assembly 5502 may also be locked in place. The carriage 5252 may then be displaced to the first position in block 5740. The docking compartment door 5400 may be unlocked and any lighting assemblies 5260 of the docking assembly 5250 may be powered in block 5742. In block 5744, one or more screens may be generated for display on the graphical user interface 6100 by the control system 15. The screens may notify the user that the dispenser 5000 could not be opened and present troubleshooting information. Alternatively, the graphical user interface 6100 may display a screen requesting the dispenser 5000 be replaced with a different dispenser 5000. In alternative examples, flowchart 5700 may pass from block 5738 to block 5724 for a capped number of retries. If a stable vacuum cannot be established after the available number of retries has been exhausted the flowchart 5700 may proceed from block 5738 to block 5740.

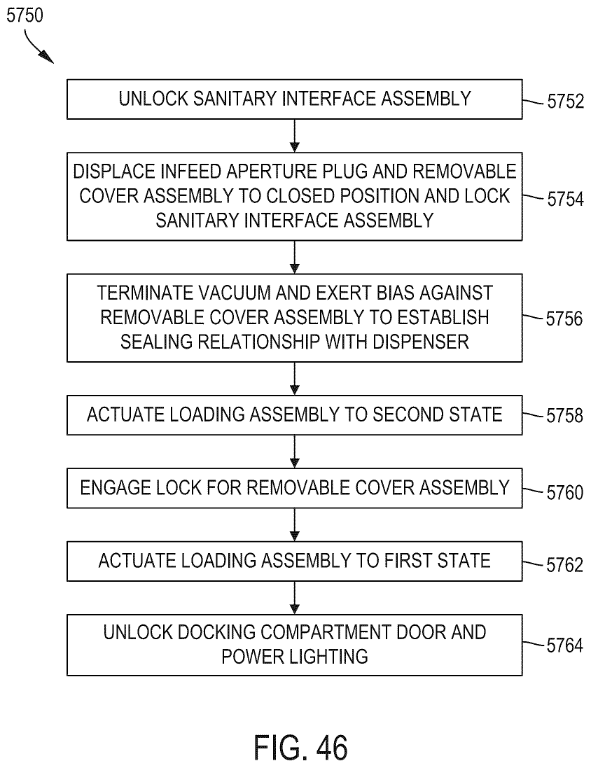

Referring now to FIG. 46, a flowchart 5750 detailing a number of example actions which may be executed to unload a dispenser 5000 from a system 10 is depicted. As shown, the sanitary interface assembly 5500 of the system 10 may be unlocked in block 5752. In block 5754, the infeed aperture plug 5502 and removable cover assembly 5002 of the to-be-removed dispenser 5000 may be displaced to a closed or occluding position and the sanitary interface assembly 5500 may be locked in place. The closed position may be a position in which the infeed aperture plug 5502 is sealed around the infeed aperture 4303 (see, e.g. FIG. 42). In block 5756, a bias pressing the removable cover assembly 5002 against the dispenser 5000 may be applied and application of vacuum to the sealed volume between the infeed aperture plug 5502 and removable cover assembly 5002 may be terminated. The carriage 5252 may be actuated to the second position in block 5758. In block 5760, the lock assembly 5090 of the dispenser 5000 may be transitioned to a locked state. The bias against the removable cover member 5002 may also be removed in block 5760 as the removable cover assembly 5002 will seal the interior volume of the dispenser 5000 when the lock assembly 5090 is in a locked state. In block 5762, the carriage 5252 may be displaced to the first state. The docking compartment door 5400 may be unlocked and any lighting assemblies 5260 of the docking assembly 5250 may be powered in block 5764. The dispenser 5000 may then be accessed and removed by a user.

Referring now to FIG. 47A, a top plan view of a portion of a system 10 is depicted. The top down view includes an example bag displacement assembly 2618 disposed in a processing compartment 4300 of the enclosure 12. Various components for the system 10 have been hidden for sake of illustration. The example bag displacement assembly 2618 may be arranged to be particularly compact as well as hygienic. This may help to ensure that the processing compartment 4300 has minimal sources of particulate and can be kept to a relatively constrained footprint.

Referring now also to FIG. 47B, the bag displacement assembly 2618 may include an upstream displacement assembly 4302 and a downstream displacement assembly 4304. Each includes a bag retainer assembly 4306 which in the example embodiment includes pneumatic graspers. The exemplary bag retainer assemblies 4306 each include a set of jaws 4308A, B. At least one of the jaws 4308A, B of each set is actuatable (e.g. pneumatically) toward the other. The jaws 4308A, B may include recesses 4310 which may accept and close around ports 392 of the bags 26 in order to retain a bag 26 in place. The ports 392 of each bag 26 may be structured to facilitate interface with the jaws 4308A, B as described in greater detail elsewhere herein (see, e.g., FIGS. 11A-21F). The bag retainer assemblies 4306 may be coupled to respective displacement stages or carriages 4318A, B. The bag retainer assembly 4306 of the downstream displacement assembly 4304 is disposed on the unsupported end of an arm 4348 extending from the displacement stage 4318B of the downstream displacement assembly 4304. The displacement stages 4318A, B may displace along dedicated linear guides 4316A, B under power of respective motors 4320 (see, e.g., FIG. 2).

Motion may be communicated from the motors 4320 to the carriages 4318A, B via any suitable transmission, though ballscrews may be preferred. The motors 4320 are positioned outside of the processing chamber 4300 to help facilitate maintenance of the controlled environment(s) within the processing chamber 4300 in the example. Alternatively, cleanroom rated motors 4320 could be utilized and positioned inside the processing chamber 4300. The position of the displacement stages 4318A, B may be tracked via a signal output from a rotary encoder monitoring the motor 4320 included in the motor assembly. Any other suitable position sensor may be utilized in alternative examples.

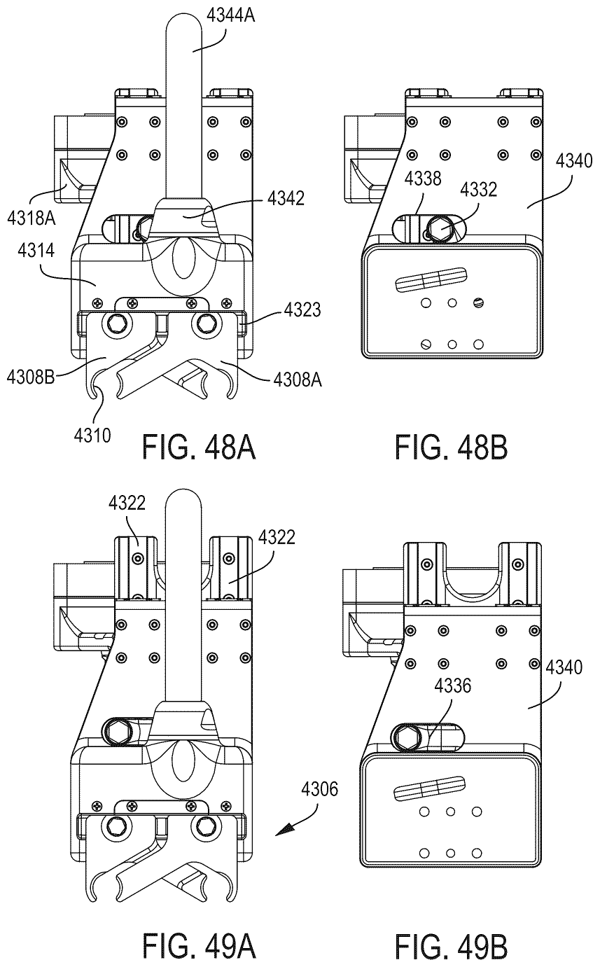

Referring now also to FIGS. 48A-50A, the bag retainers 4306 may also be translationally displaceable relative to their respective displacement stage 4318A, B. A bag retainer housing 4314 is included in each of the example bag retainer assemblies 4206. Each bag retainer housing 4314 may include bearings 4324 which may displace along guides 4322 that are fixed relative to their parent displacement stage 4318A, B. Thus, the bag retainers 4306 may be extended from and retracted towards their parent displacement stage 4318A, B. The extension actuator assembly 4330 for each bag retainer 4306 may be enclosed within an actuator housing 4328. The actuator housing 4328 may be defined by a portion of the respective displacement stage 4318A, B and a cover 4362. One or more sealing member may be included at the interface between the cover 4362 and the displacement stage 4318A, B. Each jaw 4308A, B may include a bearing 4325 which may displace along a jaw bearing guide 4323 defined on the retainer housing 4314.

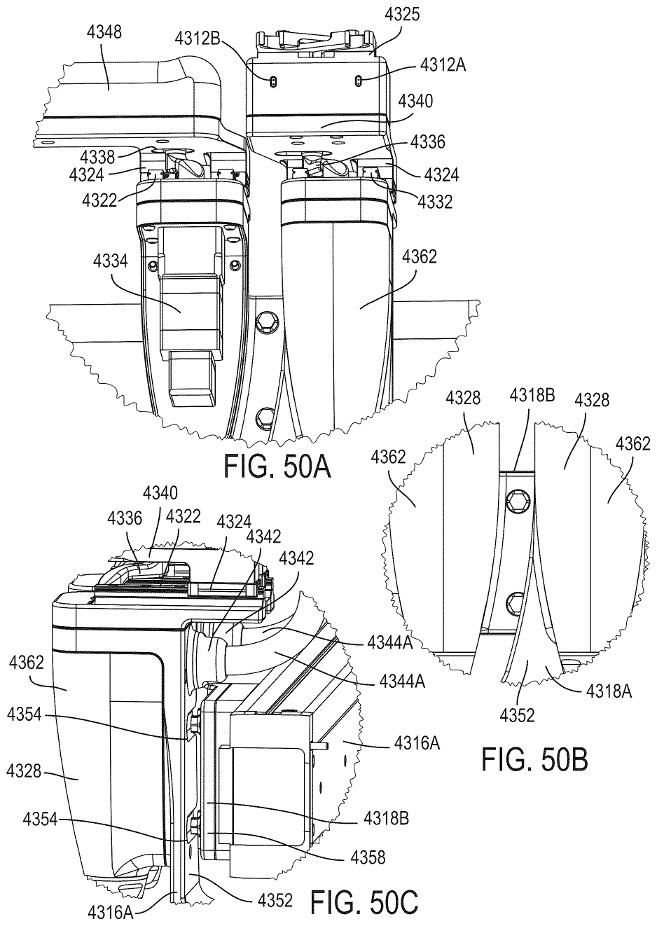

In certain examples, each extension actuation assembly 4330 includes a cam follower 4332 on a crank 4336 which is displaced about a rotation axis by a rotary actuator 4334 (see, e.g., FIG. 50A). The rotary actuator 4334 may preferably include a harmonic gear motor in various examples. The cam follower 4332 may be disposed within an elongate slot 4338 defined in a base body 4340 of the bag retainer assembly 4306. As shown best in FIG. 48B and FIG. 49B, as the crank 4336 is rotationally displaced, the cam follower 4332 may engender translational displacement of the bag retainer assembly 4306. Rotation of the crank 4336 in a first direction may displace the bag retainer assembly 4306 distal to the displacement stage 4318A, B. Rotation in a second, opposite direction retracts the bag retainer assembly 4306 toward the displacement stage 4318A, B. The displacement range of the bag retainer assembly 4306 relative to the respective displacement stage 4318A, B may be dictated by the elongated slot 4338 and the dimensions of the crank 4338. In the example embodiment, the elongate slot 4338 is sized to permit a 180° rotation of the crank 4338 (the crank 4336 could be rotated another 90° from in position in FIG. 49B). In some embodiments, the crank 4338 may be rotated in a single direction. A first 180° of each full rotation would displace the bag retainer assembly 4306 in a first translational direction and the other 180° of rotation would engender translational displacement of the bag retainer assembly 4306 in the opposing direction. The rotary actuator 4334 may include a rotary encoder (e.g. absolute rotary encoder) which may output a signal indicative of the position of the bag retainer assembly 4306 relative to the parent displacement stage 4318A, B. This signal may be monitored by the control system 15 to track the position of the bag retainer assembly 4306 and inform commands supplied to the rotary actuator 4334. In other embodiments, any other suitable position sensor may be used.

At least one bag sensor 4312A, B may be included in a housing 4314 for the bag retainers 4306. Each of the at least one sensor 4312A, B may be disposed so as to detect the presence of a port 392. The bag sensors 4312A, B may be any suitable variety of sensor. In some examples, reflectivity based sensors may be used. Reflective fiber optic based sensors may be used in certain implementations. Other embodiments could include, for example, microswitches which are actuated when the ports 392 are present. The output signal from any bag sensors 4312A, B may be checked by the control system 15 before a command to actuate the bag retainer 4306 of a respective displacement assembly 4202, 4304 is issued. The bag retainer 4306 may not be actuated in the event that the output signal from one or more bag sensor 4312A, B indicates a bag 26 is absent or improperly positioned. The control system 15 may also monitor the bag sensors 4312A, B for a change in sensor output signals indicating a bag 26 has become dislodged.

All wiring, cables, pneumatic lines, other lines, etc., in the bag retainer housing 4314 may be bundled together and passed through a gland 4342 defined in the bag retainer housing 4314 (see, e.g., FIG. 48A). A bundle sheath 4344A may be provided around the portion of the wiring, cables, pneumatic lines, etc. disposed outside of the bag retainer housing 4314 to facilitate wipe down and cable routing. In various embodiments, the bundle sheath 4344A may be routed into the actuator housing 4328 through a gland 4342. The constituent lines in the bundle are then routed through the actuator housing 4328 and joined by any wiring, cables, etc. for the rotary actuator 4334. All lines may exit the respective upstream or downstream displacement assembly 4302, 4304 via a gland 4342 into another bundle sheath 4344B. The bundle sheath 4344 may extend to the wall 4301 of the processing compartment 4300 and exit the processing compartment 4300 through a respective compartment wall gland 4346. Such bundling and gland arrangements may be used for other actuators, sensors, and assemblies described herein.

Referring now primarily to FIGS. 50A-C, to help ensure that the bag displacement assembly 2618 is particularly compact, the displacement stages 4318A, B may be arranged to nest when brought in close proximity. As shown, the base bodies 4340 of each bag retainer assembly 4306 include cooperating shapes which allow the two base bodies 4340 to be displaced directly abreast one another. The cantilevered arm 4348 of the downstream displacement assembly 4304 may provide clearance for the housing 4314 of the bag retainer assembly 4306 on the upstream displacement assembly 4302 when the base bodies 4340 are so positioned. Thus, the bag retainer assemblies 4306 may be at substantially even height while still allowing the bag displacement assembly 2816 to be relatively compact.

The linear guides 4316A, B may be positioned in substantially the same plane and may be mounted to a wall of the processing chamber 4300. The displacement stage 4318B of the upstream displacement assembly 4302 includes a main portion 4350 (best shown in FIG. 47B) which interfaces with the linear slide 4316B and a riser 4352 which extends past the superiorly disposed linear guide 4316A. The riser 4352 may be the portion of the displacement stage 4318A defining the actuator housing 4328. As shown in FIG. 50B, the riser 4352 may have a profile which accepts the actuator housing 4328 of the downstream displacement assembly 4304 when the displacement stages 4318A, B are directly abreast one another.

Additionally, the surface of the riser 4352 most proximal the linear guide 4316A may include one or more flute or recess 4354. The displacement stage 4318B for the downstream displacement assembly 4304 is shown with a main body 4358. The portion of the displacement stage 4318B defining the actuator housing 4328 is coupled to a side of the main body 4358. As best shown in FIG. 50C, the flutes 4354 accept any structures extending proud of the face of the main body 4358 (e.g. fasteners). Thus, the main body 4358 of displacement stage 4318B may be displaced to a position intermediate linear guide 4316A and the riser 4354 of displacement stage 4318A.

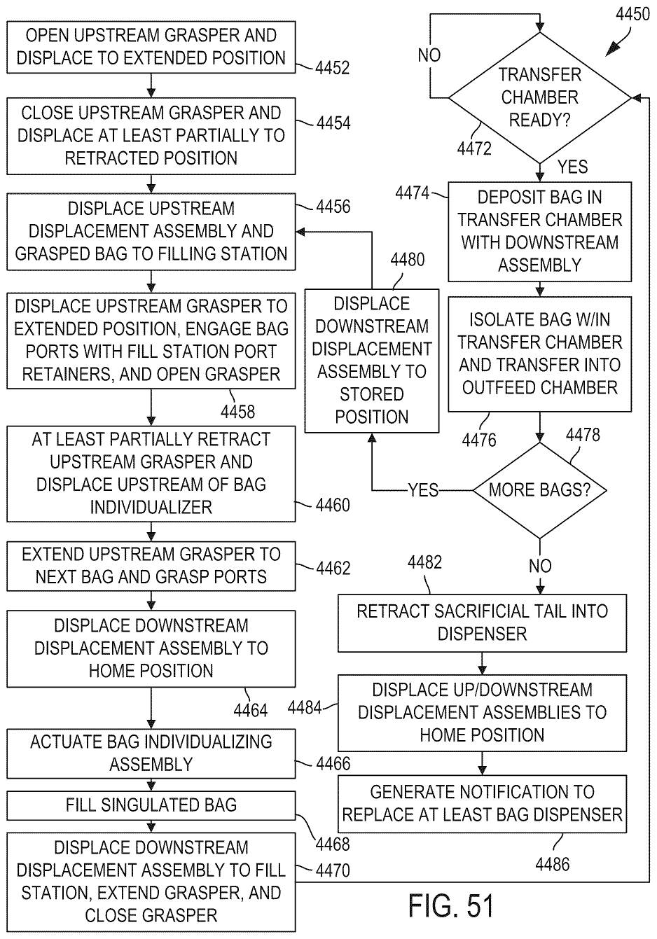

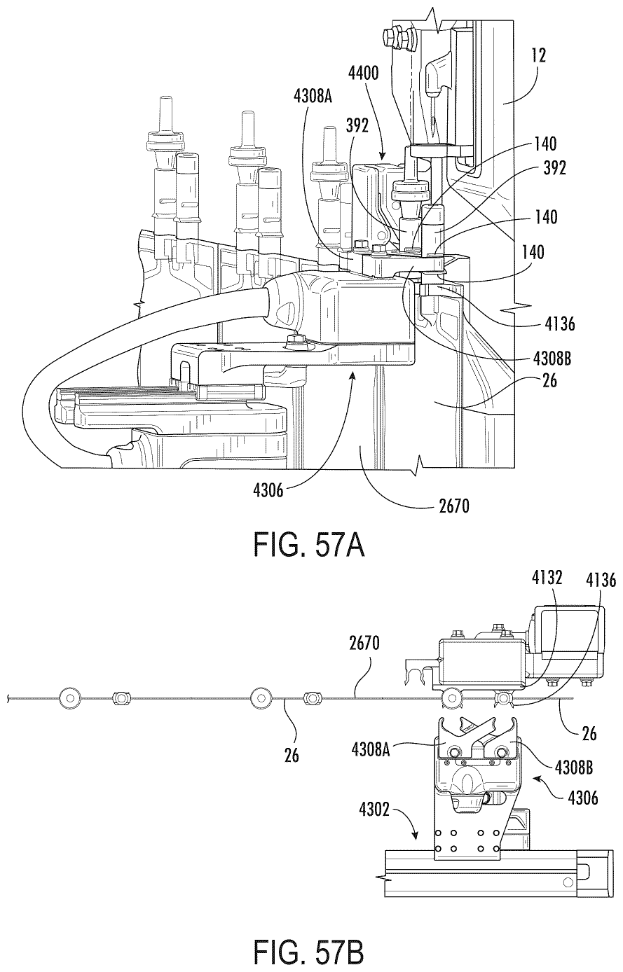

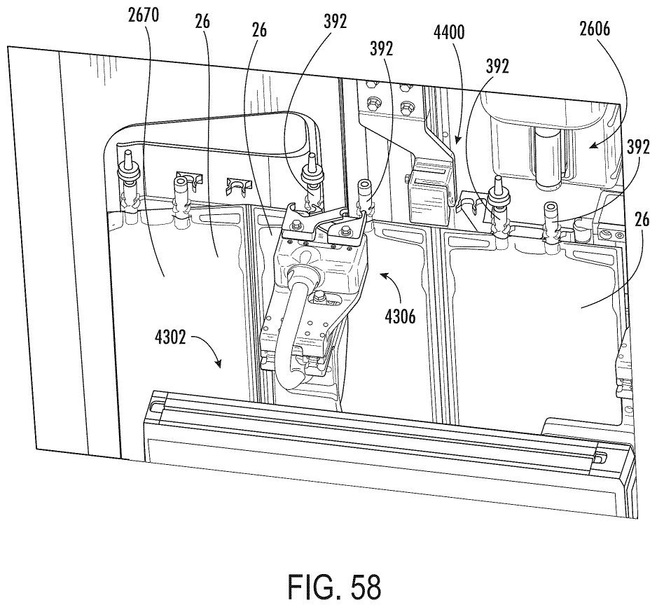

Referring now to FIG. 51, a flowchart 4450 detailing a number of example actions which may be executed to advance bags 26 through a processing chamber 4300 is depicted. The flowchart 4450 begins with a fresh dispenser 5000 loaded into the system 10 with a bag 26 retained in a bag presenter 5004 of the dispenser 5000. As shown, the bag retainer assembly 4306 of the upstream displacement assembly 4302 may be actuated (e.g. pneumatically) to an open or spread apart position in block 4452. The bag retainer assembly 4306 may also be displaced to an extended position in block 4452. In block 4454, the bag retainer assembly 4306 of the upstream displacement assembly 4302 may then be closed around ports 392 of the bag 26 at the bag presenter 5004 of the dispenser 5000 (see, e.g. FIG. 55). The bag retainer assembly 4306 may also be displaced at least partially to a retracted position in block 4452. In block 4456, the upstream displacement assembly 4302 and grasped bag 26 may be displace to a fill station 2600 (see, e.g., FIG. 56). The bag retainer assembly 4306 of the upstream displacement assembly 4302 is displaced to the extended position in block 4458. The ports 392 of the bag 26 may be engaged with the port retainers 3146 on the fill displacement stage 3142 of the fill station 2600 in block 4458 (see, e.g. FIG. 57A). The bag retainer assembly 4306 of the upstream displacement assembly 4302 may also be opened in block 4458. In block 4460, the bag retainer assembly 4306 of the upstream displacement assembly 4302 may be at least partially retracted (see, e.g., FIG. 57B) and displaced upstream of a bag individualizer assembly 4400 (see, e.g., FIG. 58). The bag retainer assembly 4306 of the upstream displacement assembly 4302 may be displaced to an extended position in block 4462. The bag retainer assembly 4306 may be closed about the ports 392 of the next bag 26 in the chain 2670 in block 4462 as well (see, e.g., FIG. 59A).

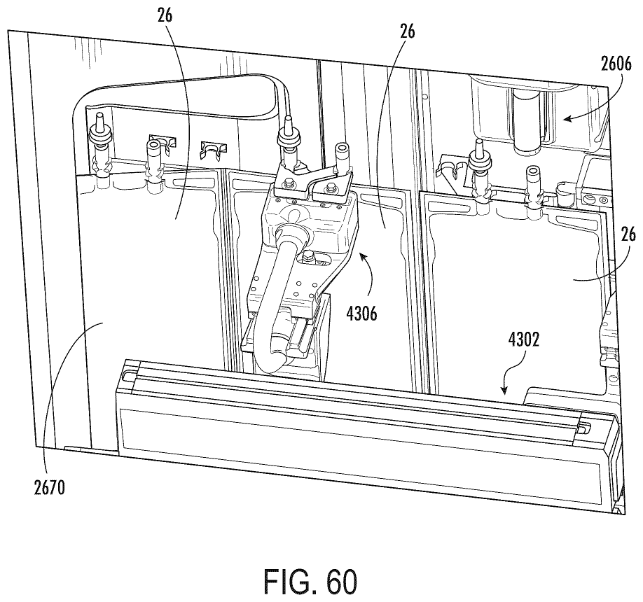

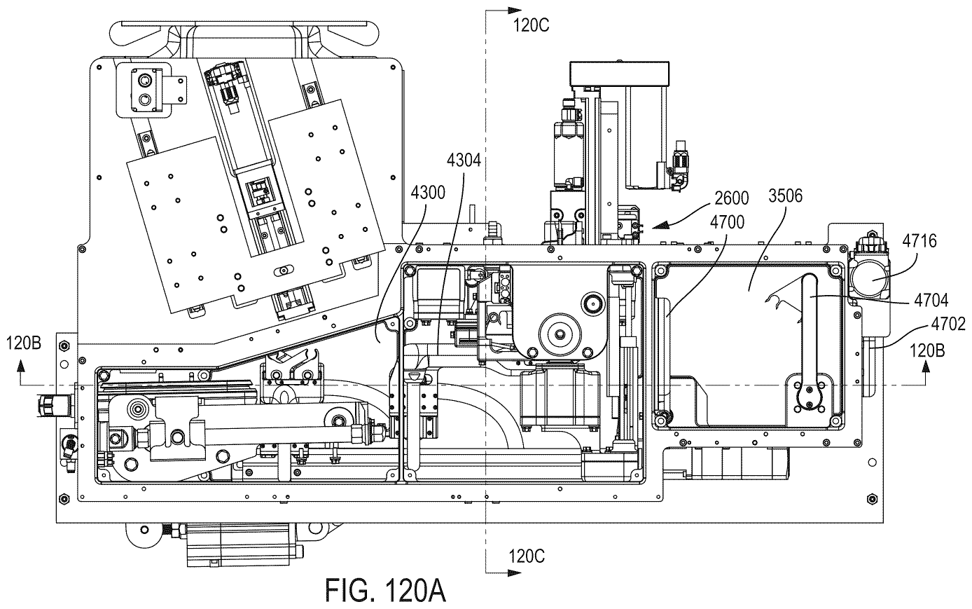

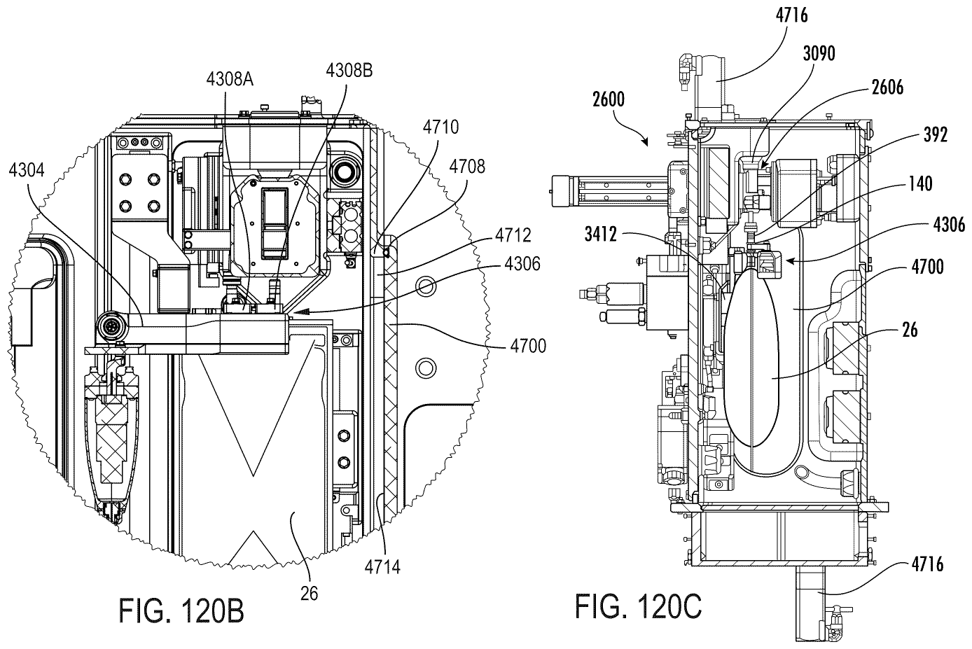

With a lead bag 26 of the chain 2670 retained at the fill station 2600 and the next bag 26 held by the bag retainer assembly 4306 of the upstream displacement assembly 4302, the downstream displacement assembly 4304 may be displaced to a home position in block 4464. The lead bag 26 may be separated from the chain 2670 in block 4466 by actuation the bag singulating assembly 4400 (see, e.g., FIGS. 59A-60). The separated bag 26 may be filled at the fill station 2600 in block 4468. The downstream displacement assembly 4304 may be displaced such that its bag retainer assembly 4306 is aligned with the ports 392 of the filled bag 26 on the fill displacement stage 4132 in block 4470. The bag retainer assembly 4306 of the downstream displacement assembly 4304 may be also displaced to an extended state and closed about the ports 392 of the filled bag 26 in block 4470 (see, e.g., FIG. 120B).

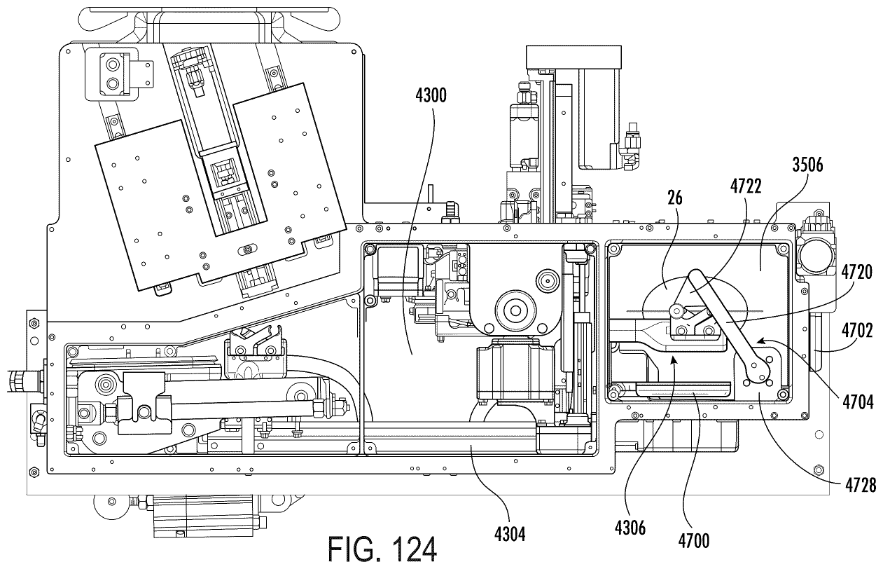

A transfer chamber 3506 may be positioned between the processing compartment 4300 and an outfeed compartment 4202 of the system 10. The transfer chamber 3506 may act as an airlock between the processing compartment 4300 and the outfeed compartment 4202. The transfer chamber 3506 may be opened to either the processing compartment 4300 or outfeed compartment 4202. Each time the transfer chamber 3506 is opened at least one recovery condition may be required to be met before it is opened again. For example, a predefined number of air exchanges through the transfer chamber 3506 may be required to occur before the control system 15 permits the transfer chamber 3506 to be accessed again. Set points for any characteristics relating to any other environmental control set point described herein may also be imposed as part of a set of recovery criteria. Alternatively, the control system 15 may permit the transfer chamber 3506 to establish communication with the outfeed chamber 4202 without recovery c condition(s) being met, but inhibit communication of the transfer chamber 3506 with the processing compartment 4300 until the recovery condition(s) is/are met. When the transfer chamber 3506 is ready in block 4472, the bag retainer assembly 4306 of the downstream displacement assembly 4304 may be displaced into the transfer chamber 3506 in block 4474 (see, e.g., FIG. 121). The filled bag 26 may also be deposited in the transfer chamber 3506 in block 4474 (see, e.g., FIG. 124).

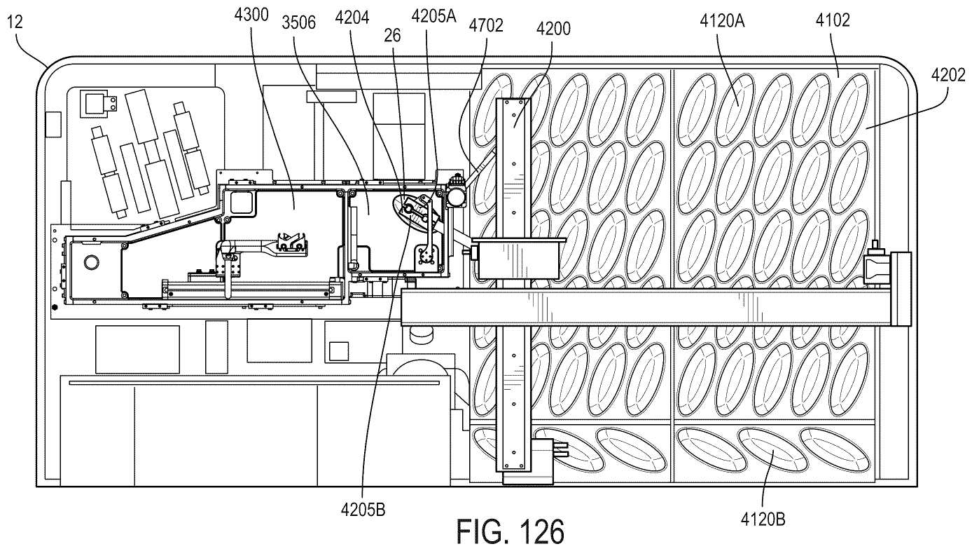

The filled bag 26 may be isolated in the transfer chamber 3506 in block 4476 (see, e.g., FIG. 125). The downstream displacement assembly 4304 may be displaced out of the transfer chamber 3506 (e.g. to the home position) to facilitate isolation of the filled bag 26. The filled bag 26 may also be displaced into the outfeed compartment 4202 in block 4476. A gantry assembly 4200 may for example, collect the bag 26 from the transfer chamber 3506 and displaced it to the outfeed compartment 4202 (see, e.g., FIGS. 126-127).

If, in block 4478, there are additional bags 26 to be filled, the downstream displacement assembly 4304 may be displaced to a stored position in block 4480. In some embodiments, the stored position may be a position in which the downstream displacement assembly 4304 extends at least partially into the transfer chamber 3506. This may assist in keeping the system 10 as compact as possible. Where part of the downstream displacement assembly 4304 is disposed in the transfer chamber 3506 in the stored position, the control system 15 may ensure any recovery condition(s) are met before commanding displacement of the downstream actuation assembly 4304 to the stored position. The flowchart 4450 may then return to block 4456.

If, in block 4478, all consumable bags 26 have been filled and the dispenser 5000 is emptied of consumable bags 26, the sacrificial tail 2683 of the bag chain 2670 may be retracted into the dispenser in block 4482. Where the sacrificial tail 2683 includes a sacrificial bag or ports 392, the bag retainer assembly 4306 of the upstream displacement assembly 4302 may displace the sacrificial tail 2683 toward the dispenser 5000. The bag retainer assembly 4306 of the upstream displacement assembly 4302 may then open to release the sacrificial tail 2683. A tensioner assembly 5100 (see, e.g., FIGS. 40A-B) within the dispenser 5000 may pull the sacrificial tail 2683 into the dispenser 5000. The upstream and downstream displacement assemblies 4302, 4304 may be displaced to home positions in block 4484. A notification may be generated for display on the user interface in block 4486. The notification may indicate that the dispenser is empty and needs to be replaced. The notification may include text, graphics, and/or animations, and may be accompanied by audio output by at least one speaker.

Referring now to FIG. 52, an example embodiment of a bag individualizer assembly or bag singulation assembly 4400 is depicted. As shown, the bag individualizer assembly 4400 includes a displaceable stage 4404. An exemplary splitter assembly 4406 is mounted to the displaceable stage 4404. The displacement stage 4404 may be displaced translationally through a displacement range by a singulation actuator 4402 from a raised position to an end of stroke position. The singulation actuator 4402 may define a guide for the displacement stage 4404. The singulation actuator 4402 may include a motor which drives a leadscrew or ball screw which is engaged with the displacement stage 4404. Alternatively a pneumatic actuator may be used. The singulation actuator 4402 may include a position sensor 4408 which may output a signal indicative of the location of the displacement stage 4404 along its displacement range. The control system 15 of the system 10 may monitor the signal from the position sensor 4408 and commands to the singulation actuator 4402 may be based, at least in part, on the output from the position sensor 4408. A linear potentiometer may be included and a wiper may be included on the displacement stage 4404. Alternatively, a motor encoder may be used as the position sensor 4408. The singulation actuator 4402 may be disposed outside of the processing chamber 4300 and may transmit motion into the processing chamber 4300 via a sealed interface.

Referring now to FIGS. 53A-53C, splitter assemblies 4406 may be driven into the coupling region 2677 between bags 26 on a chain 2670 to separate or individualize a bag 26 from the chain 2670. The splitter assembly 4406 may include a blade which cuts through the coupling region 2677 along the weakened region 2678 in some examples. Thus, bags 26 may be cut from the chain 2670 to singulate bags 26. Preferably, the splitter assembly 4406 is devoid of blades or other sharp bodies. In such embodiments, the splitter assembly 4406 may include a plow or wedge which may be driven into the weakened region 2678. Splitter assemblies 4406 incorporating a set of rollers which create a tearing action along the weakened region 2678 as shown in FIGS. 53A-53C may also be used.

As shown in FIGS. 53A-53C, example splitter assemblies 4406 may include a first body 4410A and second body 4410B which couple to one another (e.g. via a fastener or in any other suitable fashion). The first body 4410A may be integral to the stage 4404 or a separate component coupled to the stage 4404. A feed roller 4412A, B may be coupled into each of the first and second bodies 4410A, B. The feed rollers 4412A, B may be mounted on bearings 4416A, B and may be formed of a low friction coefficient material such as PTFE. A set of separating rollers 4414A, B may be captured between the first and second body 4410A, B. The separating rollers 4414A, B may share a common bearing 4416C and may not be coupled to one another. Thus the separating rollers 4414A, B may counter rotate relative to one another.

As best shown in FIG. 53C, when assembled, a splitter assembly 4406 may include a leading end 4418A and a trailing end 4418B. Each of the first and second bodies 4410A may include a ramped surface 4420. The ramped surfaces may be arranged such that the first and second bodies 4410A, B taper thinner as distance toward the leading end 4418A decreases. Thus, the leading end 4418A of the splitter assembly 4406 may form a guide in the shape of the Latin character “V”. As the leading end 4418A is displaced toward a chain 2670 of bags 26, the guide formed by the ramped surfaces 4420 allows significant tolerance in the position of the top of the chain 2670. As the chain 2670 enters the splitter assembly 4406 through the leading end 4418A, the ramped surfaces 4420 may direct the chain material 2670 generally into a feed channel 4422 generally positioned in the center of the splitter assembly 4406. The feed rollers 4412A, B may assist in directing the chain 2670 material into the feed channel 4422. The feed rollers 4412A, B may also assist in mitigating particulate generation.

Referring now also to FIG. 52, the feed channel 4422 may furcate into a first channel branch 4424A, and second channel branch 4424B. The first and second channel branch 4424A, B may extend substantially parallel to one another on opposing sides of the separating rollers 4414A, B. The first channel branch 4424B may be defined by a recess into the upstream side 4426A (that most proximate the dispenser 5000) of the splitter assembly 4406. The second channel branch 4424B may be defined by a recess into the opposite, downstream side 4426B of the splitter assembly 4406. As the splitter assembly 4406 is displaced into a chain 2670, the upstream portion of the chain 2670 may be routed through the first channel branch 4424A. This may displace the upstream portion of the chain 2670 in a first direction generally perpendicular to the plane of the unfilled bags 26 in the chain 2670. The bag 26 on the end of the chain 2670 may be routed through the second channel branch 4424B. This may displace the lead bag 26 on the chain 2670 in a second direction opposite the first. The opposite displacement directions of the lead bag 26 and the adjacent upstream bag 26 may generate tearing action which separates the bag 26 on the end of the chain 2670 as the splitter assembly 4406 is driven through the chain 2670. The tear may propagate along the tear guide or weakened region 2678 between the bags 26. As mentioned elsewhere herein, an end of the weakened region 2687 may be pre-separated or pre-torn to facilitate tearing. Counter rotation of the separating rollers 4414A, B may assist in feeding the upstream bag 26 on the chain 2670 and the end bag 26 into the respective first and second channel branches 4424A, B. This tearing type splitting action may be particularly desirable as it may mitigate potential for the splitter assembly 4406 to snag as it is displaced through the chain 2670. The absence of blades may also help to ensure that bags 26 are not compromised during separation.

The first and second channel branches 4424A, B may each extend across 70-90% of the width of the splitter assembly 4406. This may support the weakened region 2678 of the bags 26 being introduced over a wide range of positions without deleterious effect on the separation of the lead bag 26 from the chain 2670. Thus, the splitter assembly 4406 may be relatively tolerant to misalignment of the chain 2670 relative to the singulation assembly 4400.

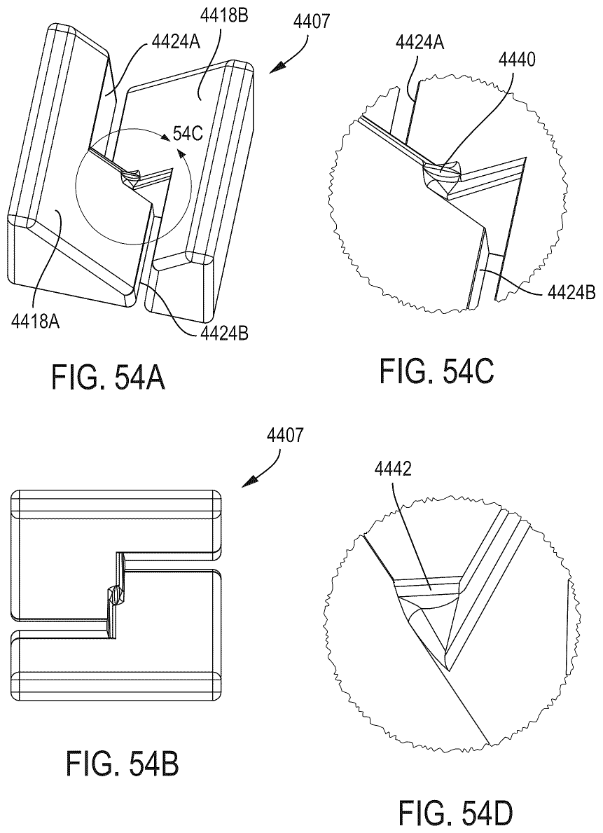

Referring now to FIGS. 54A-D, a number of exemplary splitters 4407 are depicted. As shown, the example splitter 4407 of FIGS. 54A-C is formed as a single monolithic component which includes a splitting wedge 4440. The splitting wedge 4440 may be replaced by a blade 4442 in certain examples. Where a blade 4442 is used a ceramic blade may be preferable. As shown, the splitter 4407 may include ramped surfaces 4418A, B which may direct a chain 2760 of bags 26 into the splitting wedge 4440. The splitter 4407 may include a first channel branch 4424A and second channel branch 4424B to direct bags 26 in opposite directions as the splitter is actuated through the chain 2670. Splitters 4407 may be coupled to a displacement stage 4404 similar to that shown in FIG. 52.

Referring now to the progression of FIGS. 55-60, a chain 2670 of bags 26 is shown being displaced into a processing chamber 4300 with a lead bag 26 of the chain 2670 being removed by a singulation assembly 4400. A number of components of the system 10 are not depicted or simplified in FIGS. 55-60 for ease of illustration. As shown in FIG. 55, the bag retention assembly 4306 of an upstream displacement assembly 4302 may be displaced to a bag 26 retained in a bag presenter 5004 of a dispenser 5000. The jaws 4308A, B of the bag retention assembly 4306 may be closed about the ports 392 of the bag 26 retained on the bag presenter 5004.

The upstream displacement assembly 4302 may then be displaced to the fill station 2600 as shown in FIG. 56. Since the lead bag 26 is held by the bag retention assembly 4306 of the upstream displacement assembly 4302, the chain 2670 of bags 26 may be spooled out of the dispenser 5000 as this occurs. The bag retention assembly 4306 of the upstream displacement assembly 4302 may be aligned with the port retainers 3146 on a fill displacement stage 3142 of the fill station 2600. In some examples, the fill displacement stage 3142 may be lowered by a bag displacement actuator 3144 (see, e.g., FIG. 111) such that the port retainers 3146 are at a height below projections (e.g. ribs 140) of ports 392 held in the jaws 4308A, B of port retention assembly 4306. The bag retention assembly 4306 may be driven to an extended position as depicted in FIG. 57A. This may press the ports 392 of the lead bag 26 into engagement with the port retainers 3146 on the fill displacement stage 3142. As shown, the port retainers 3146 may preferably be passive. The ribs 140 on the ports 392 may ensure that the bag 26 is held in place. Though the jaws 4308A, B are shown gripping between the ribs 140, the jaws 4308A, B may be directly below the rib 140 most proximate the bag 26 in other examples. The space intermediate the ribs 140 would then be pressed into the port retainers 3146. The bag retainer assembly 4306 of the upstream displacement assembly 4302 may then be retracted from the fill displacement stage 3142 as shown in FIG. 57B.

The upstream displacement assembly 4302 may be displaced such that the jaws 4308A, B of its bag retention assembly 4306 are aligned with the ports 392 of the bag 26 adjacent the lead bag 26 as shown in FIG. 58. The bag retention assembly 4306 may then be extended and the jaws 4308A, B of the bag retention assembly 4306 may be closed about the ports 392 as shown in FIG. 59A. This may place the coupling region 2677 between the lead bag 26 and the adjacent bag 26 in alignment with the splitter assembly 4406 (or splitter 4407) of the bag individualizing assembly 4400. The control system 15 may command the singulation actuator 4402 to drive the splitter assembly 4406 through is displacement range. As best shown in FIG. 59B, the splitter assembly 4406 may separate the lead bag 26 from the chain 2670 along the tear guide or weakened region 2678 (see, e.g., FIG. 59B) between the bags 26. The material of the lead bag 26 may exit the second channel branch 4424B of the splitter assembly 4406 while the material of the chain 2670 is directed into the first channel branch 4424A. The lead bag 26 is shown separated from the chain 2670 in FIG. 60.

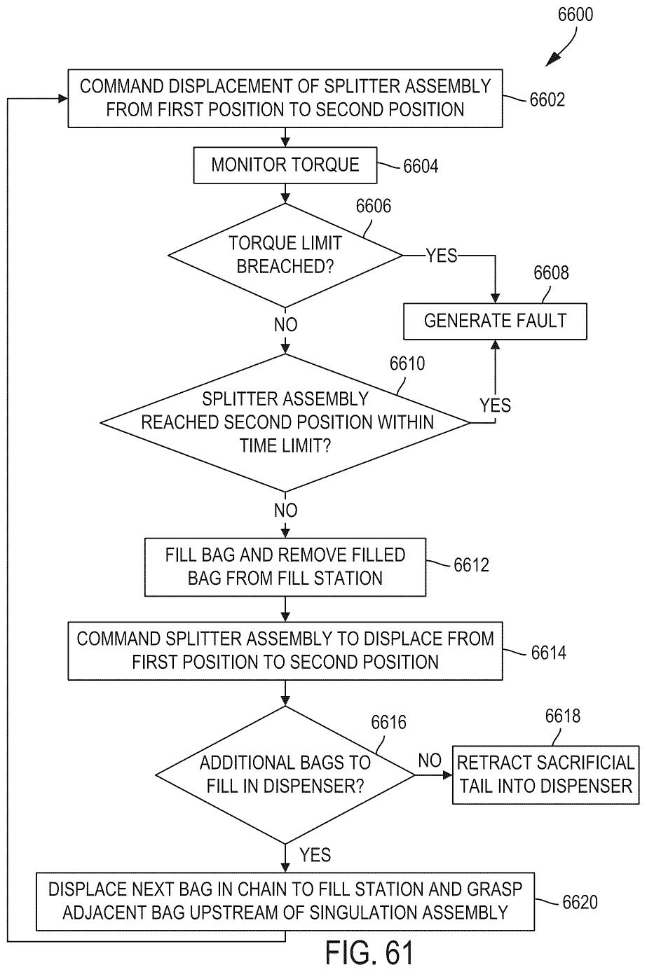

Referring now to FIG. 61, a flowchart 6200 depicting a number of example actions which may be executed to separate bags 26 from a chain 2670 at a singulating assembly 4400 is depicted. With a bag 26 in place at a fill station 2600 and a grasper 4306 holding the ports 392 of the adjacent bag 26 (see, e.g., FIG. 59A), the control system 15 may command displacement of a splitter assembly 4406 from a first position to a second position in block 6202. Though described in relation to the splitter assembly 4406 any splitter 4407 could be used. The control system 15 may monitor the singulation actuator 4402 as the splitter assembly 4406 displaces. In the example, the control system 15 monitors motor torque (which may be determined based on the current flow through the motor) in block 6604. If a torque limit (or current limit) is breached in block 6606, a fault may be generated in block 6608. The control system 15 may also monitor the travel of the splitter assembly 4406. The control system 15 may analyze data from a position sensor 4408 such as an encoder of the singulation actuator 4402 to determine the position of the splitter assembly 4406. If, in block 6610, the splitter assembly 4406 does not displace to the second position within a time limit, a fault may be generated in block 6608. If the splitter assembly 4406 reaches the second position within an appropriate time in block 6610, the bag 26 at the fill station 2600 may be filled in block 6612. The bag 26 may also be removed from the fill station 2600 in block 6612. The control system 15 may command the splitter assembly 4406 to return to the first position in block 6614. If, in block 6616, there are no further consumable bags 26 in the chain 2670, the sacrificial tail 2683 of the chain 2670 may be retracted into the dispenser 5000 in block 6618. The bag displacement assembly 2618 may, for example, grasp a portion of the sacrificial tail 2683 (e.g. a sacrificial bag) and displace it toward the outlet of the dispenser 5000. The bag 26 may then be released and a tensioning assembly 5100 of the dispenser 5000 may pull the sacrificial tail 2683 fully into the dispenser 5000. If, in block 6616, there are additional consumable bags 26, the next bag 26 in the chain 2670 may be displaced to the fill station 2600 via the bag displacement assembly 2618 in block 6620. The adjacent bag upstream of the singulation assembly 4400 may also be grasped by the bag displacement assembly 2618 in block 6622. The flowchart 6600 may then return to block 6602.

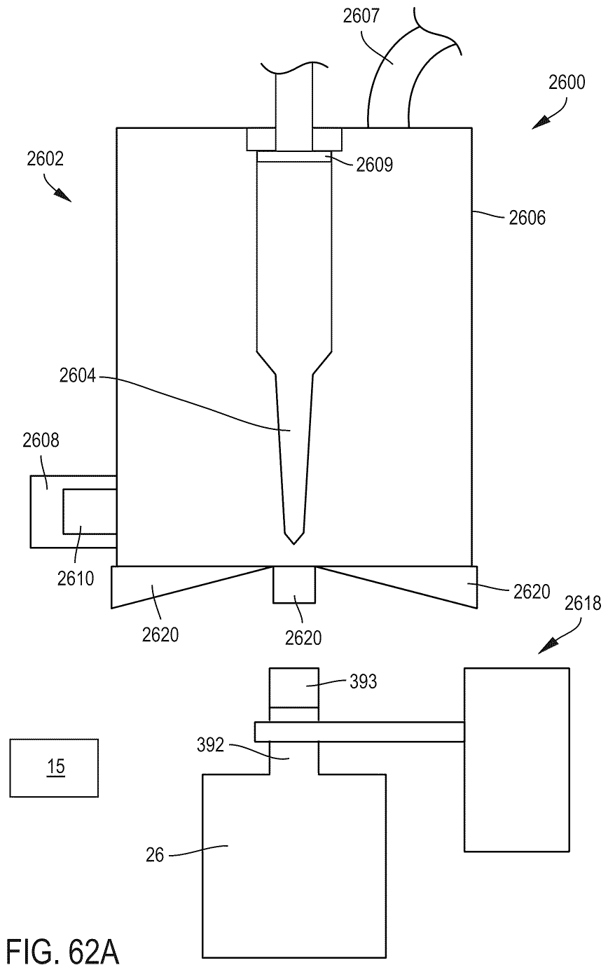

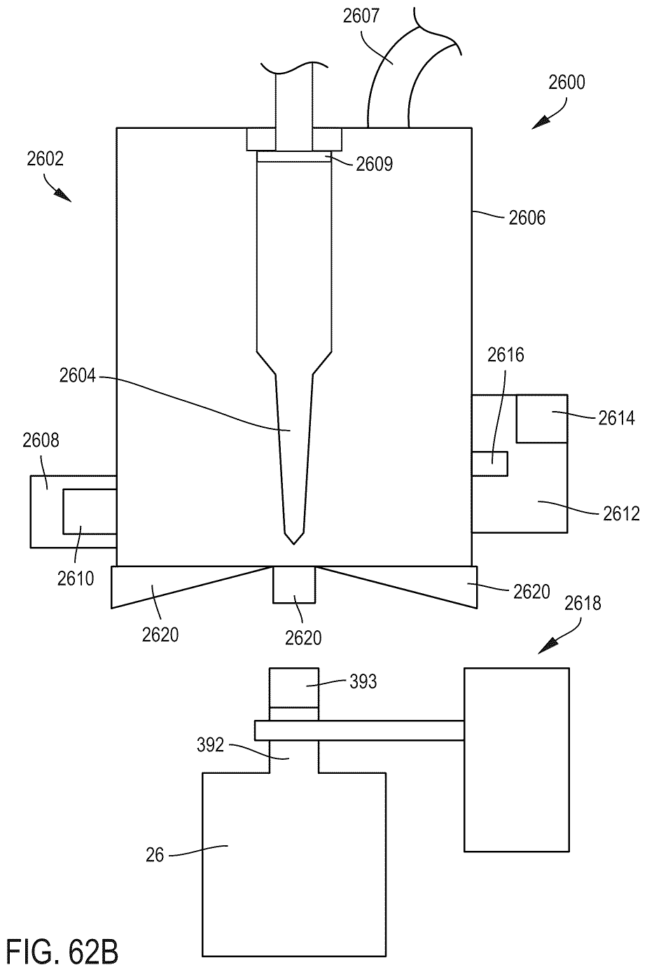

Referring now to FIG. 62A, in certain system 10 embodiments, it may be desirable to perform filling of a bag 26 while limiting requirements for tight environmental control of a large area in which bags 26 are filled. In certain systems 10, an enclosure 12 which is controlled to a clean room standard may not be included. Alternatively, in certain systems 10 it may be desired that any enclosure 12 used be controlled to the least stringent clean room standard possible to limit complexity of a system 10. In such embodiments, bags 26, which have been previously sterilized, may be filled in a locally established or miniaturized clean room like environment. This environment or fill zone may only be present in a small space, for example, a chamber or partitioned region where dispensing of fluid into a bag 26 takes place. The fill zone may also be in open communication with other less stringently controlled regions zones. A fill zone may be sized to accept a portion of a bag 26, for example, a port 392 or end portion of a port 392. In some embodiments, the fill zone may have a volume of not more than 100 ml (e.g. 75 ml or less). The fill zone volume may for example conform to particle requirements, as well as appropriate relative pressure, air exchange rate, and/or air velocity set points for a selected cleanroom level (e.g. ISO 5 clean room set points). The fill zone may also be arranged to support substantially unidirectional or laminar airflow.

Still referring to FIG. 62A, an example fill station 2600 is depicted. The fill station 2600 may include a dispenser assembly 2602. In the example embodiment, the dispenser assembly 2602 includes a dispensing sharp 2604. The dispensing sharp 2604 may be or be placed in fluid communication with a fluid source. The fluid source may be an output of a mixing system which combines injection quality water with constituent to form a desired fluid for filling of a bag 26. Any systems described in relation to U.S. Pat. No. 11,980,587, issued May 14, 2024, and entitled Systems, Methods, and Apparatuses for Producing and Packaging Fluids (Attorney Docket No. 00101.00325.AA697) may be used. Alternatively, the fluid source may be a source of purified water or water conforming to a predefined set of criteria. In one such example, fluid may be generated from a distillation device (e.g. vapor compression distillation device) and potentially one or more additional water treatment apparatus (e.g. charcoal filter(s), ultrafilter(s), electrodeionizer, capacitive deionization assembly, etc. In other examples, fluid may be generated from at least one reverse osmosis assembly and potentially one or more additional water treatment apparatuses (e.g. any of those described above). Combinations of the above are also possible. A filter 2609 may be disposed intermediate the output of the fluid source and the dispensing sharp 2604. The filter 2609 may, for example, be a 0.2 micron filter. Where a distillation device is used, any such device described in U.S. Patent Publication No. US 2021-0395109, filed Mar. 29, 2021, and entitled Water Vapor Distillation Apparatus, Method, and System (Attorney Docket No. AA542) which is hereby incorporated by reference in its entirety may be used.

The dispensing sharp 2604 may be disposed within a chamber or cartridge 2606 that surrounds the dispensing sharp 2604. Alternatively, in some embodiments, the dispensing sharp 2604 may be included as part of a replaceable cartridge 2606. Though a variety of exemplary cartridges 2606 are described herein, certain example cartridges 2606 may include a first end and a second end. In such examples, the first end may be an input end and may receive at least one fluid (e.g. clean air and/or a liquid for filling the bag 26). The second end may be a bag 26 interface end which may, for instance, accept a port 392 of a bag 26. The first end may be closed or open depending on the embodiment. The second end may be open to provide a receptacle for the portion (e.g. port 392) of the bag 26 through which the dispensing sharp 2604 gains access to the interior volume of the bag 26.

The dispensing sharp 2604 may be removably coupled to the cartridge 2606, form a part of a cartridge 2606, or may be coupled to a portion of the dispensing assembly 2602 which may be separable from the remainder of the dispensing assembly 2602. Thus, the dispensing assembly 2062 may include a durable portion and a disposable portion (e.g. cartridge 2606) or replaceable unit which is swapped out as needed. Other portions of the dispensing assembly 2602 may remain in place at the fill station 2600 as a cartridge 2606 is exchanged. This may allow for the dispensing sharp 2604 (and other cartridge 2606 components) to be replaced on some periodic schedule or in the event that the dispensing sharp 2604 dulls. Alternatively, the dispensing assembly 2602 may be a consumable which is periodically replaced as the fill station 2600 is used.

The dispensing sharps 2604 described herein may be any suitable type of sharp. Preferably, the dispensing sharp 2604 may withstand repeated punctures of septa 393 without damage or significant dulling. Additionally, the dispensing sharp 2604 may preferably be chosen based on its ability to cleanly pierce a septum 393 without compromising the septum's 393 ability to reseal. In certain example embodiments, the dispensing sharp 2604 may be a pencil tipped type sharp including at least one side port. In some embodiments, the dispensing sharp 2604 may be a Whitacre type needle with two side ports disposed in opposition to one another (see, e.g. FIG. 67A). Exemplary dispensing sharps 2604 may have a gauge of 16-18 and a length of less than one inch (e.g. 0.75 inches). Dispensing sharps 2604 may be constructed of a metallic material such as stainless steel.

A cartridge 2606 may be plumbed or otherwise coupled into communication with a source of clean air (e.g. HEPA or ULPA filtered air). A clean air supply feed 2607 is depicted coupled to the input end of the cartridge 2606 in the example embodiment depicted in FIG. 62A. Clean air may pass through the cartridge 2606 from the input end to the open end to establish a positive pressure within the cartridge 2606 relative to the surrounding or downstream environment. Additionally, the rate of air flow through the cartridge 2606 may be sufficient to ensure a predefined rate of air exchanges within the cartridge 2606 per given unit of time. The air flow passing through the cartridge 2606 may be substantially laminar and may be preconditioned to increase its laminar character.

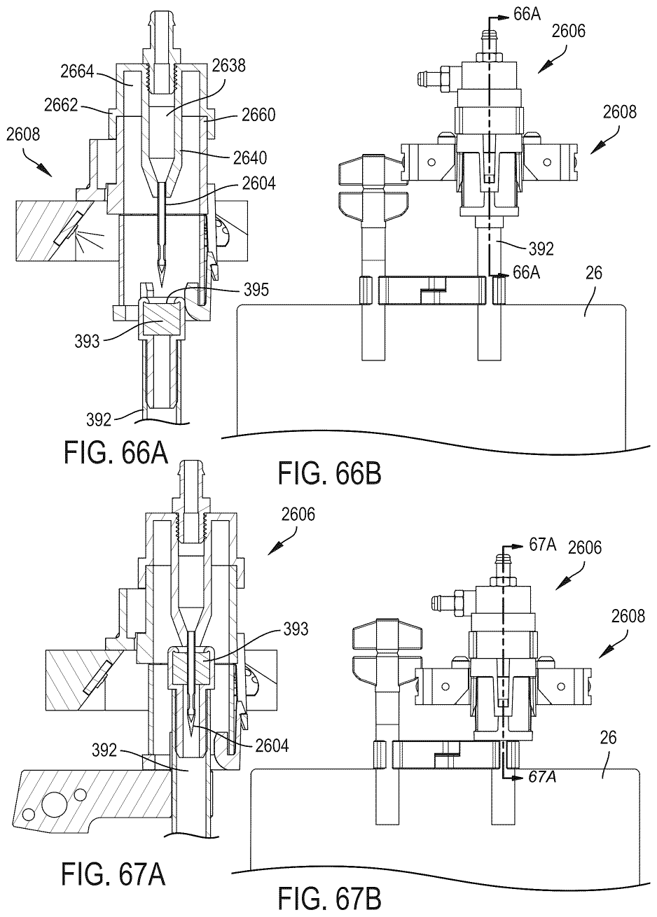

In some examples, the clean air may be directed through a volume in the immediate vicinity of the dispensing sharp 2604 and any hub 2640 (see, e.g., FIG. 66A) to which the dispensing sharp 2604 is coupled. The cartridge 2606 may include a wall or walls to define this volume and partition it off from the surrounding environment. Such wall(s) may be discrete components of example cartridges 2606 and may be installed into place when a cartridge 2606 is assembled. In such examples, certain components of the dispensing assembly 2602 may be fully outside of the clean air flow path. The clean air flow path through the cartridge 2606 or a portion thereof may define the fill zone for the fill station 2600.

An example dispensing assembly 2602 may include an irradiation assembly 2608. At least a portion of the irradiation assembly 2608 may, for example, be disposed outside of a clean air flow path around the dispensing sharp 2604. Cartridges 2606 may be separable from irradiation assemblies 2608 such that the irradiation assembly 2608 is a reusable component of the fill station 2600 which does not need to be replaced when a cartridge 2606 is replaced. Example irradiation assemblies 2608 may include at least one antimicrobial light emitter 2610. The at least one antimicrobial light emitter 2610 may emit light in a portion of the spectrum or at a wavelength which is damaging to microbes. For example, an irradiation assembly 2608 may include a plurality of UV light emitters which emit light in the UVC range (e.g. at 265 nm+/−5 nm). The antimicrobial light emitter(s) 2610 may be any suitable light emitter, but in various embodiments may be LED light emitters. Where multiple light emitters 2610 are used, the light emitters 2610 may be spaced about the cartridge 2606 at, for example, even angular intervals (e.g. 120° or 90°). The light emitters 2610 may also be arrange to direct emitted light at a common point within the interior volume or fill zone defined within the cartridge 2606. The irradiation assembly 2608 may also include one or more heat sink and/or fan to assist in dissipation of heat generated by the irradiation assembly 2608 or individual light emitters 2610 of the irradiation assembly 2608. In certain embodiments, the interior of the cartridge 2606 may be at least partially coated or covered with a reflective surface which reflects light emitted by the light emitter(s) 2610. In various embodiments, a UVC transparent or at least translucent barrier may be disposed between each of the light emitters 2610 and the dispensing sharp 2604.

In some examples and as shown in FIG. 62B, an example dispensing assembly 2602 may also include one or more agent dispensing assembly 2612. An agent dispensing assembly 2612 may include an agent source reservoir 2614 which may be removably coupled to the agent dispensing assembly 2612 and replaced once depleted. The agent dispenser 2612 may include an output 2616 which may dispense agent from the agent source reservoir 2614 into the cartridge 2606. The output 2616 may be a sprayer, atomizer, or other ejector. In certain examples, the agent source 2614 may be an antimicrobial chemical agent. For example, the agent source 2614 may be a reservoir of 70% isopropyl alcohol.

Referring again primarily to FIG. 62A, sealed bags 26 including a port 392 with a septum 393 or internal membrane may be displaced to the fill station 2600 by a bag displacement assembly 2618. The bag displacement assembly 2618 may, for example, include a gantry, one or more linear displacement stage, or robotic arm with an electromechanical, pneumatic, or hydraulic gripper though any automated assembly may be used. In some embodiments, the bag 26 may not be actively held by a gripper, but may instead be retained by a displaceable passive holder. Clean air may be provided to the cartridge 2606. The port 392 and septum 393 of the bag 26 may enter the cartridge 2606. The cartridge 2606 may be displaced to the port 392 or the bag 26 may be displaced toward the cartridge 2606 with a displacement stage. At least one guide 2620 may be provided on the cartridge 2606 to help direct a port 392 into the cartridge 2606 and help align a port 392 with the dispensing sharp 2604. A control system 15 may activate the irradiation assembly 2608 after commanding relevant actuators to displace the port 392 into place. The irradiation assembly 2608 may be active for a predetermined period of time such that any exposed surfaces of the septum 393 receive at least a prescribed dose of irradiation. The dispensing sharp 2604 may also be in the illumination field of the irradiation assembly 2608 and may receive its own prescribed dosage of irradiation as this occurs. The dispensing sharp 2604 may puncture the septum 393 (e.g. by the port 392 being driving into the dispensing sharp 2604) such that an outlet opening in the dispensing sharp 2604 is in communication with the interior volume of the bag 26. Fluid may then be delivered through the dispensing sharp 2604 into the bag 26 to fill the bag 26. Where included, an agent dispenser 2612 (see, e.g., FIG. 62B) may also direct agent onto the port 392 and/or septum 393 prior to puncturing the septum 393.

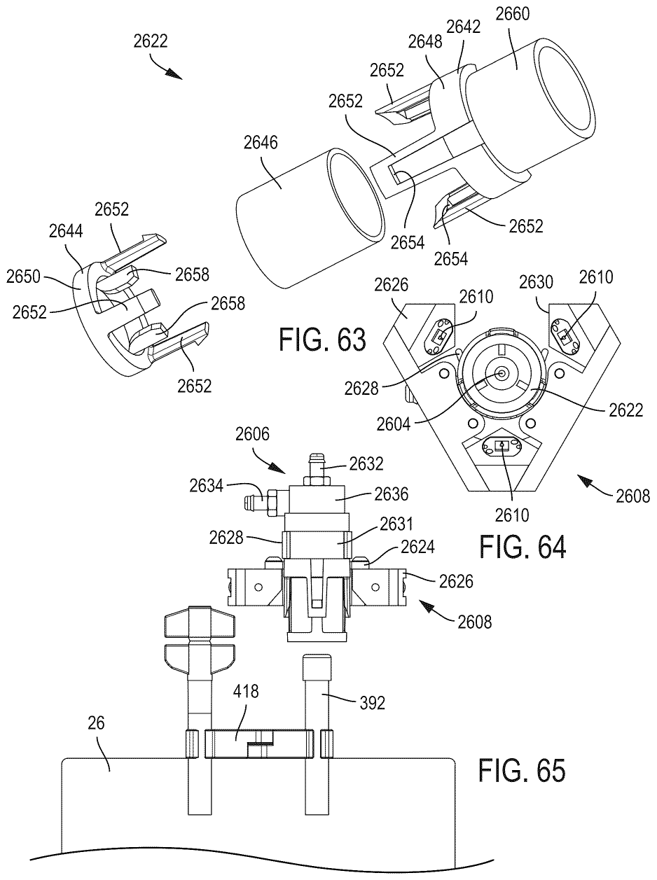

Referring now to FIGS. 63-65, an exploded view of an example cartridge section 2622 and views of an example dispensing assembly 2602 are respectively depicted. The dispensing assembly 2602 may include a dock 2624. The dock 2624 may include a retainer such as a clip 2628. Example docks 2624 may include or be attached to an irradiation assembly 2608. Though any suitable irradiation assembly 2608 may be attached to a dock 2624, the example irradiation assembly 2608 includes an array of UVC LEDs. The example irradiation assembly 2608 includes an aperture 2630 through which the cartridge 2606 of the dispensing assembly may be introduced. The irradiation assembly 2608 shown also includes a heat sink 2626. In other embodiments, additional heat dissipation assemblies may be included. For instance, a fan may be included to assist in heat dissipation. The light emitters 2610 in the example embodiment are provided at regular angular intervals of 120° and are in thermal communication with the heat sink 2626. Thermal paste may, for example, be used in certain examples to facilitate thermal communication between the heat sink 2626 and light emitters 2610. At least one temperature sensor may be included in the irradiation assembly 2608. For example, at least one temperature sensor (see, e.g. 2611 of FIG. 70) such as an RTD may be in associated with each individual light emitter 2610. A control system 15 may monitor the temperature signal output from the temperature sensor(s). In the event that the temperature sensor(s) output a signal indicative of a temperature in excess of a threshold, the control system 15 may power off the light emitters 2610 and/or require a cool down period elapses before again commanding illumination of the light emitters 2610.

Certain example cartridges 2606 of a dispensing assembly 2602 may be an assembly of a number of different cartridge sections. As shown in FIG. 63, a first cartridge section 2636 and a second cartridge section 2622 may be included. The first cartridge section 2636 may include a filling port 2632 and at least one air port 2634. The filling port 2632 may be in fluid communication with a dispensing sharp 2604 coupled to the first section 2636 via a flow path 2638 (see, e.g. FIG. 66A) defined in the first section 2636. In certain examples, the dispensing sharp 2604 may be coupled to a hub 2640 (see, e.g., FIG. 66A) defined in the first section 2636 within which the flow path 2638 extends. The dispensing sharp 2604 may be substantially centrally disposed in the in the first section 2636 and may extend along an axis of the cartridge 2606. The at least one air port 2634 may be in communication with an air flow path 2664 (see, e.g., FIG. 66A) forming the remainder of the interior volume of the first cartridge section 2636.

The second cartridge section 2622 may include a first portion 2642 and a second portion 2644. The first and second portions 2642, 2644 may be coupled together. For example, the first and second portions 2642, 2644 may be clipped, snap fit, fastened, clasped, adhered, solvent bonded, etc. together. A barrier 2646 may also be included. The barrier 2646 may be an irradiation transmissive barrier. In certain examples, the barrier 2646 is constructed at least partially of a UVC transmissive material may be captured between the first and second portions 2642, 2644 when the first and second portions 2642, 2644 are in a coupled state. The barrier 2646 may be a tube or other elongate member with open ends. The barrier 2646 may be formed of a fused quartz or fused silica material in certain examples. Any other substantially UVC transparent material may be used in alternative embodiments. Preferably a material which is at least 75% transmissive to UVC ((e.g. 87% or over 85% at 265 nm) may be used. The second portion 2644 may include a set of guides 2658 which extend toward the center axis of the cartridge 2606. The first portion 2642 may include a mating section 2660 which may couple to a cooperating mating section 2662 (see, e.g., FIG. 66A) of the first section 2636 of the cartridge 2606. In some embodiments, the mating sections 2660, 2662 may be sonically welded, threaded, solvent bonded, adhered, interference fit, etc. together.

The example first portion 2642 includes a first main body 2648. A second main body 2650 is also included as part of the example second portion 2644. In certain embodiments, each of the first and second portion 2642, 2644 have a number of cantilevered members 2652 which project from their respective main bodies 2648, 2650. The cantilevered members 2652 of the first portion 2642 include ledges 2654 near an unsupported end thereof. The cantilevered members 2652 of the second portion 2644 include latch projections 2656 at their unsupported ends. As the first and second portions 2642, 2642 are advanced together, the cantilevered members 2652 of one of the portions 2642, 2644 may deflect until the latch projections 2656 are displaced to the location of respective ledges on the opposing cantilevered members 2652. The deflected cantilevered members 2652 may restore to an undeflected or less deflected state and the latch projections 2656 may engage the ledges 2654. This may couple the first and second portions 2642, 2644 together. This may also snuggly capture the barrier 2646 within the second cartridge portion 2622. The cantilevered members 2652 may be positioned between the light emitters 2610 when the first and second portion 2622, 2636 of the cartridge 2606 are coupled and the cartridge 2606 is installed in a dispensing assembly 2602. For example, each cantilevered member 2652 may be angularly offset from the positions of the light emitters 2610 so as to be spaced an even angular amount from each of a respective pair of adjacent light emitters 2610. Thus, the cantilevered members 2652 will be positioned to provide a substantially clear line of sight through the barrier 2646 from the light emitters 2610 to the interior of the cartridge 2606.

The example cartridge 2606 may be installed in the dispensing assembly 2602 through the aperture 2630 and retained in place on the dock 2624. When the dispensing sharp 2604 dulls or a scheduled replacement comes due, the cartridge 2606 may be swapped with a new cartridge 2606. When the cartridge 2606 is assembled, a groove 2631 may be present in the exterior surface of the cartridge 2606. The groove 2631 may be placed within the clip 2628 to couple the cartridge 2606 to the dock 2624 in certain embodiments. The interaction with the clip 2628 and the groove 2631 may assisting in repeatable locating of cartridges 2606 within the dispensing assembly 2602.

Referring now primarily to FIGS. 65-67B, a progression of illustrations depicting a port 392 of a bag 26 being introduced to a dispensing assembly 2602 and accessed by a dispensing assembly 2602 are shown. Though a bag 26 with a port 392 having a septum 393 is shown in the exemplary embodiment, other reservoirs may be filled according to the descriptions below. For example, in some embodiments, vials, cartridges, cassettes, partially flexible reservoirs, collapsible reservoirs, variable volume reservoirs, or any other fluid containing reservoir may be filled as described below. Where description herein refers to displacement, positioning, piercing, etc. of a port 392 or septum 393, it should be understood that the port 392 or septum 393 may be substituted for an access to any of the reservoir types described above.

Still referring to FIGS. 65-67B, a bag 26 may be displaced to an example dispensing assembly 2602 by a gripper 418 of, for example, a robotic manipulator. Alternatively, the bag 26 may be placed in a retention assembly of a linear displacement stage associated with the dispensing assembly 2602. In either arrangement, the port 392 of the bag 26 may be aligned with an axis of the dispensing sharp 2604 (see FIG. 65). Clean, substantially laminar air may be flowing through the cartridge 2606. The port 392 may then be introduced into the interior of the cartridge 2606. The guides 2658 may help direct and support the port 392 as the port 392 is brought to a first position (see FIGS. 66A-B) with respect to the housing 2606. Once the port 392 is in the first position, an exposed surface 395 of the septum 393 of the port 392 may be disposed within the interior of the cartridge 2606. This position may be referred to as an access preparation or disinfect position. Once the port 392 is in this position, the control system 15 may command the irradiation assembly 2608 to irradiate the exposed surface 395 (shown representationally in FIG. 66A). For example, the exposed surface 395 may be irradiated with at least a predefined dose of radiation (e.g. 180-190mJ/cm²). The light emitters 2610 may be oriented to all direct emitted light to a common point. This common point may be slightly above the exposed surface 395. The port 392 may then be brought to a pierced or spiked position (see FIGS. 67A-B) in which the dispensing sharp 2604 extends through the septum 393. With the port 392 in the pierced position, fluid may be dispensed into the bag 26 through the dispensing sharp 2604 to fill the bag 26. In the various embodiments described herein, the irradiation assembly 2608 may continue to be powered while the septum 393 is pierced and/or during at least a portion of the fill. Clean air may be continually delivered through the air flow path 2664 during use of the dispensing assembly 2602.

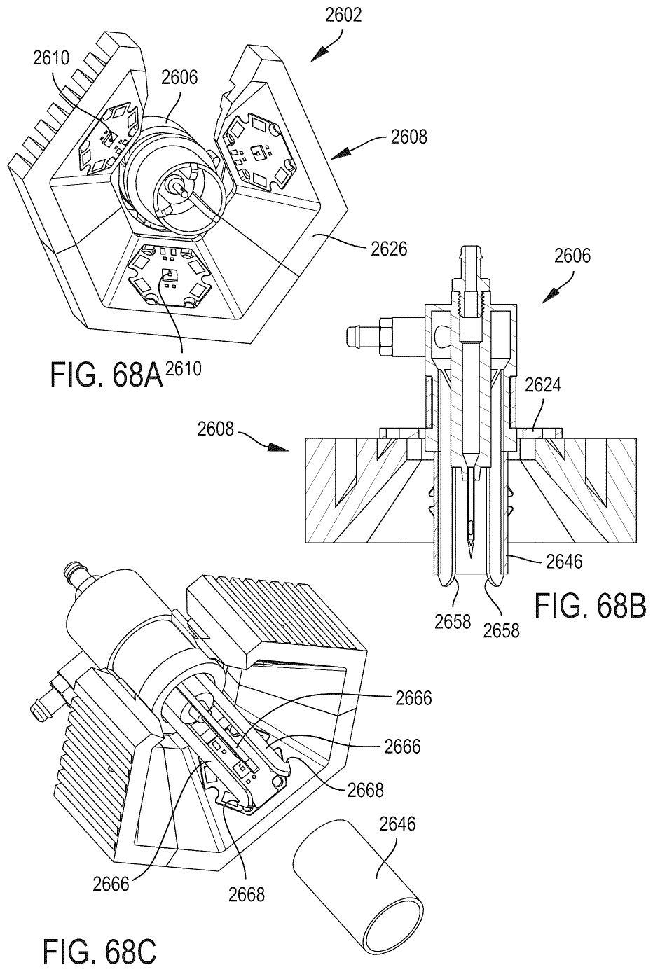

Referring now to FIGS. 68A-C, an alternative dispensing assembly 2602 is depicted. The dispensing assembly 2602 includes a dock 2624 to which an irradiation assembly 2608 is coupled. The example irradiation assembly 2608 includes a heat sink 2626 and a set of UVC LED light emitters 2610 in thermal communication with the heat sink 2626. A cartridge 2606 may be positioned on the dock 2624. The cartridge 2606 may include a set of cantilevered arms 2666. The dispensing assembly 2602 also includes a barrier 2646 formed of a UVC transmissive material (e.g. fused quartz or silica). Instead of being captured between two parts of the cartridge 2606 (see, e.g., FIG. 63), the barrier 2646 may be displaced over the cantilevered arms 2666 of the cartridge 2606. The arms 2666 may deflect inward until the barrier 2646 is in its assembled position. With the barrier 2646 advanced to the assembled position, the cantilevered arms 2666 may restore to an unstressed state and an end of the barrier 2646 may rest on a ledges 2668 formed on the unsupported ends of the arms 2666. The unsupported ends of the cantilevered arms 2666 may also form guides 2658 which may help to direct a port 392 or other reservoir access into alignment with a dispensing sharp 2604 of the dispensing assembly 2602.

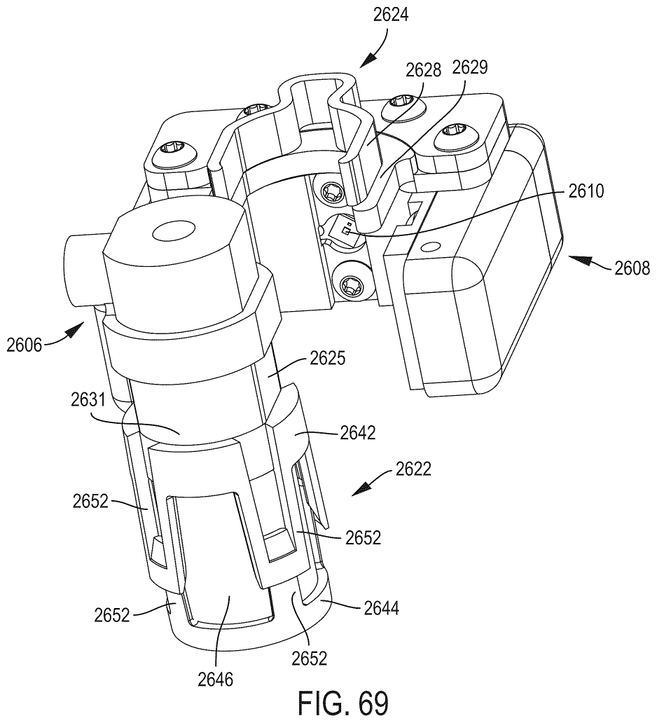

Referring now to FIG. 69, another example dispensing assembly 2602 is depicted. The example cartridge 2606 is shown exploded away from the depicted irradiation assembly 2608. As shown, the irradiation assembly 2608 includes three spans each housing a light emitter 2610. Two of the three spans extend parallel to one another and are spaced apart by the third such that the irradiation assembly 2608 is generally shaped in the manner of a Latin character “U”. The light emitters 2610 are spaced at 90° intervals. The cartridge 2606 includes a first cartridge section 2636 and second cartridge section 2622 similar to that depicted in FIGS. 63-65. The cantilevered members 2652 of the first and second section 2642, 2644 of housing portion 2622 are spaced at 90° increments.

The example dock 2624 in FIG. 69 includes a clip 2628 and a stiffener 2629 which may be constructed of metal or another rigid material. When the cartridge 2606 is installed in the dock 2624, the stiffener 2629 may abut a wall of the groove 2631. This may generate a mechanical interference which inhibits displacement of the cartridge 2606 as a septum 393 is punctured by the dispensing sharp 2604. Additionally, the exterior surface of the cartridge 2606 is shaped such that the cartridge 2606 may only be installed in the dock 2624 in a prescribed orientation. In the example, the cartridge 2606 includes a narrow region with two opposing flat faces 2625. The dock 2624 is shaped such that the cartridge 2606 may only be installed when the narrow region is properly aligned with the clip 2628. The poka-yoke arrangement may ensure that the cantilevered members 2652 of the second housing section 2622 are located in a desired position relative to the light emitters 2610 of the irradiation assembly 2608. The prescribed cartridge 2606 position may, for example, ensure that the cantilevered members 2652 are disposed in positions which provide substantially unobstructed paths through the barrier 2646 for light generated by the light emitters 2610.

Referring now to FIG. 70, another example dispensing assembly 2602 embodiment is schematically depicted. As shown, the dispensing assembly 2602 may include a cartridge 2606. The cartridge 2606 may include an air flow channel 2802 which may extend from a first side of the cartridge 2606 to an opposing second side of the cartridge 2606. The air flow channel 2802 may form a generally straight-line path through the cartridge 2606 and may have a round, and in the example shown, substantially circular cross-section. As shown in FIG. 70, the air flow channel 2802 may be partially formed by a barrier 2646 such as a section of fused quartz tubing. The barrier 2646 may be captured within the cartridge 2606 as the cartridge 2606 is assembled. The air flow channel 2802 may receive clean air from a supply such as an air handling assembly 6200 which introduces filtered, laminarized air into an enclosure 12 of the system 10. As indicated by arrows 2804, air flow displacing through the air flow channel 2802 may substantially maintain is laminar character as it transits the cartridge 2606. The dispensing sharp 2604 and a portion of a hub 2640 to which the dispensing sharp 2604 is coupled may be disposed within the air flow channel 2802. Preferably, the hub 2640 is streamlined in shape and presents a minimal profile to limit impact on the laminar flow of air through the air flow channel 2802.

The example cartridge 2606 may also receive fluid from a fluid source 2810 (e.g. injection quality water or medical fluid mixed by the system 10). As shown the cartridge 2606 may include a connection port 2812. The connection port 2812 may include a series of sealing members 2814A, B which are in spaced relation to one another about the exterior surface of the connection port 2812. In the example, the connection port 2812 has sections of different diameters with the smallest diameter section being at the end of the connection port 2812. A sealing member 2814A, B is included on each section. Additionally, a terminal end of the connection port 2812 may be covered by a frangible 2816.

To establish fluid communication with the fluid source 2810, the connection port 2812 may be introduced into a receptacle 2818 of a supply manifold 2820. A spike 2822 in the receptacle 2818 may interrupt the frangible 2816. The spike 2822 may be in fluid communication with the fluid source 2810. Fluid may flow from the fluid source 2810 through the spike 2822 and connection port 2812 and through the cartridge 2606 via one or more cartridge 2606 flow paths 2830. The supply manifold 2820 may be coupled to a manifold displacement assembly 2821 which may be actuated to displace the supply manifold 2820 relative to the connection port 2812.

In certain embodiments, the connection port 2812 may be displaced into a disinfection position within the receptacle 2818 before the frangible 2816 is contacted or compromised with the spike 2822. In the disinfect position, the connection port 2812 may be partially installed in the receptacle 2618 such that a sealing member 2814B most distal the frangible 2816 establishes a fluid seal with the side wall of the receptacle 2818. This fluid seal may be formed intermediate the open end of the receptacle 2818 and a disinfection outlet path 2824 extending from the receptacle 2818 (e.g. to a drain or other discard destination 2826). Disinfecting fluid may be dispensed through the spike 2822 and into the receptacle 2818. The disinfecting fluid may be water which has been heated to a disinfection temperature set point or range. In certain examples, injection quality water from the fluid source 2810 may be heated to 60° C. or higher and fed to the receptacle 2818. As the sealing member 2814B blocks the fluid from exiting the receptacle 2818, the fluid may flow into the disinfection outlet path 2824. As this occurs, the terminal end of the connection port 2812 up to the sealing member 2814B may be exposed to the disinfection fluid. As shown, the receptacle 2818 includes different diameter portions such that when the connection port 2812 is in the partially installed position only sealing member 2814B is in contact with the receptacle wall 2818. This ensures disinfecting fluid may reach the disinfection outlet channel 2824 and also bathes the connection port 2812 up to the sealing member 2814B on the larger diameter portion of the connection port 2812. Disinfection fluid may be supplied through the receptacle 2818 for a present period of time. The period of time may be selected based on the disinfection fluid and the temperature of the disinfection fluid. Once the disinfection cycle has completed, the connection port 2812 may be advanced to a fully installed position in the receptacle 2818. In the fully installed position, the frangible 2816 may be interrupted by the spike 2822 and the fluid source 2810 may be in fluid communication with a dispensing sharp 2604 via the cartridge flow path(s) 2630. The sealing member 2814A most proximal the end of the connection port 2812 may establish a seal against the receptacle 2818 as the connection port 2812 is brought to the fully installed position.

In various examples, at least one filter 2609 may be included in the cartridge 2606 and may be disposed in an intermediate point in the flow path through the cartridge 2606. The filter 2609 may provide redundant purification for fluid provided from the fluid source 2810. The filter 2609 may also provide greater latitude in choice of frangible 2816 as the filter 2609 may serve to catch any particulate formed as the connection port 2812 is spiked. The filter 2609 may be any suitable filter. In certain examples, the filter 2609 may be a filter membrane with a pore size down to 0.2 micron. In examples where a filter membrane is used, a filter support 2832 may also be included in the form of a grate against which the filter 2609 may be retained. The filter support 2832 may be on the downstream side of the filter 2609. The filter 2609 may be included in a filter assembly 2838 (see, e.g., FIG. 73) disposed within the cartridge 2606. The filter assembly 2838 may, in certain examples, be assembled separately and placed into the cartridge 2606.

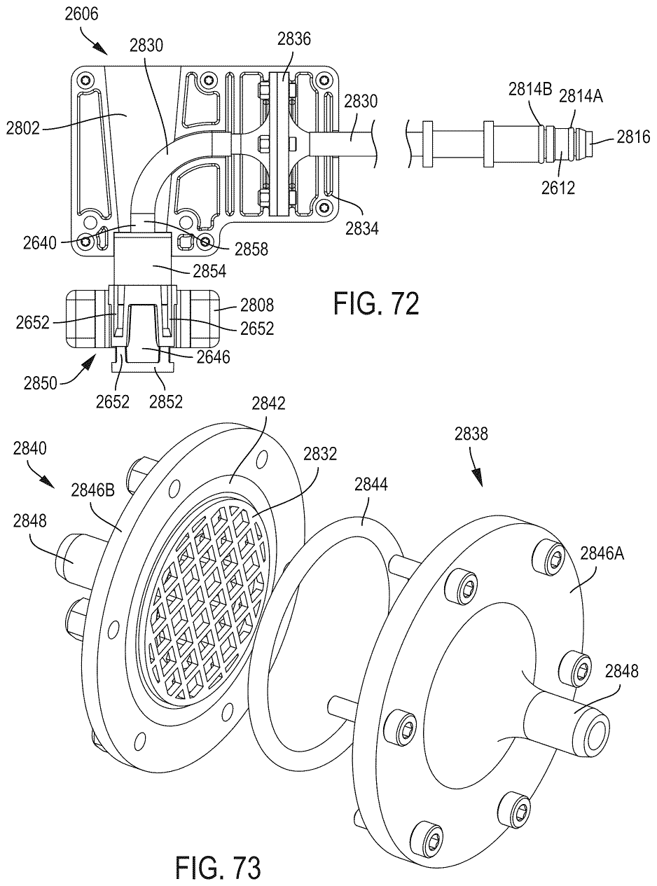

As with other embodiments described herein, the dispensing assembly 2602 may also include an irradiation assembly 2608 with one or more light emitters 2610. An irradiation assembly 2608 with an aperture 2630 for accepting a cartridge 2606 as described above may, for example, be used. A dock 2624 or other arrangement for retaining the cartridge 2606 may be included in the dispensing assembly 2602. Referring now primarily to FIGS. 71-72, an example embodiment of the cartridge 2606 described in relation to FIG. 70 is depicted. An irradiation assembly 2608 is also depicted.

As shown, the cartridge 2606 may include a connector port 2812 having a set of sealing members 2814A, B and a frangible 2816. The connector port 2812 may be disinfected and placed into fluid communication with a fluid source 2810 as described in relation to FIG. 70. The cartridge 2606 may include a housing assembly 2834 with a fluid flow path extending therethrough. A portion of the housing assembly 2834 is removed in FIG. 72 to illustrate the interior portions of the cartridge 2606. A bay 2836 for receiving a filter assembly 2838 may be defined in the housing assembly 2834. The filter assembly 2838 may be disposed at an intermediate point in the flow path through the cartridge 2606. Fluid from the fluid source 2810 may flow through a cartridge flow path 2830 to an inlet side of the filter assembly 2838 and through the filter 2609. Fluid may exit the filter assembly 2838 through an outlet side of the filter assembly 2838 and transit through another cartridge flow path 2830 to the dispensing sharp 2604.

Referring primarily to FIG. 73, a partially exploded view of an example filter assembly 2838 is depicted. The filter 2609 is hidden in FIG. 73, but could be any desired membrane filter. As shown, the filter assembly 2838 includes a filter support 2832 which in the example embodiment is a grated disk. The filter 2609 may be placed against the upstream side of any filter support 2832 such that the filter support 2832 buttresses the filter 2609 against the pressure of the fluid flowing through the cartridge 2606. The filter assembly 2838 also includes a filter housing 2840 having an inlet section 2846A and an outlet section 2846B. Each of the inlet and outlet sections 2846A, B may include a fitting 2848 for attachment of a cartridge fluid flow path 2830. The filter housing 2840 may include a seat for the filter support 2832 which is surrounded by trough 2842. The trough may accept a sealing member 2844 such as an o-ring. The filter 2609 may be placed against the filter support 2832 and overhang the sealing member 2844. When the inlet and outlet section 2846A, B of the filter housing 2840 are coupled to one another, the filter 2609 may be captured within the filter housing 2840 and a seal surrounding the portion of the filter 2609 adjacent the filter support 2832 may be established. Thus, fluid entering the filter assembly 2838 may only pass to the outlet of the filter assembly 2838 through the filter 2609. Though fasteners are shown in the example embodiment, the inlet and outlet section 2846A, B of the filter housing 2840 may be coupled to one another in any suitable manner (e.g. sonic welding, laser weld, etc.).

Referring again to FIGS. 71-72, a barrier retention assembly 2850 is included as part of the housing assembly 2834 of the example cartridge 2606. The barrier retention assembly 2850 is coupled into the portion of the air flow channel 2802 defined in the remainder of the housing assembly 2834. The barrier retention assembly 2850 may retain a barrier 2646 (e.g. fused quartz tube segment) through which an irradiation assembly 2608 may irradiate the dispensing sharp 2604 and a septum 393 advanced into the cartridge 2606. In the example embodiment, the barrier 2646 is retained by first and second bodies 2852, 2854 with cantilevered members 2652 similar to those depicted in FIG. 63. The cantilevered members 2652 may be engaged with one another to capture the barrier 2646 as described in relation to FIG. 63.

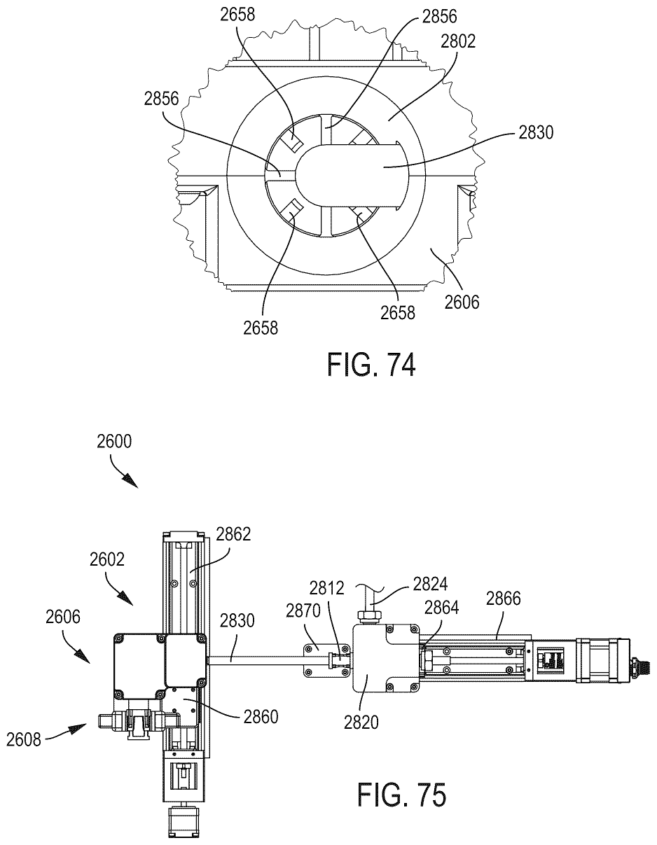

Referring now also to FIG. 74, a detailed top plan view of a portion of the example cartridge 2606 of FIGS. 71-72 is depicted. As shown, the air flow channel 2802 has a cross section which tapers from a largest area to a smaller area as distance from the input end of the cartridge 2606 increases. The hub 2640 for the dispensing sharp 2604 is suspended by a number of cross pieces 2856 in line with the axis of the air flow channel 2802. A cartridge flow path 2830 is shown extending into communication with a fitting 2858 (see, e.g., FIG. 72) of the hub 2640. Guides 2658, which may be included on the first body 2852 are also visible in FIG. 74. The guides 2658 may assist in directing a port 392 into position along the axis of the air flow channel 2802 as the port 392 is brought into proximity of the dispensing sharp 2604.

Referring now to FIG. 75, an example filling station 2600 is depicted including the dispensing assembly 2602 of FIGS. 71-72. As shown, the cartridge 2606 and irradiation assembly 2608 may be coupled to stage 2860 of a filling actuator 2862. The filling actuator 2862 may be driven via commands from the control system 15 to displace the cartridge 2606 and irradiation assembly 2608. Additionally, the supply manifold 2820 may also be placed on a stage 2864 of a connection actuator 2866. The connection actuator 2866 may be driven via commands from the control system 15 to displace the supply manifold 2820 relative to the connection port 2812. The filling station 2600 may also include a retainer 2870 to which the connection port 2812 may be coupled in order to render the connection port 2812 stationary as it introduced and spiked into the receptacle 2818 of the supply manifold 2820.

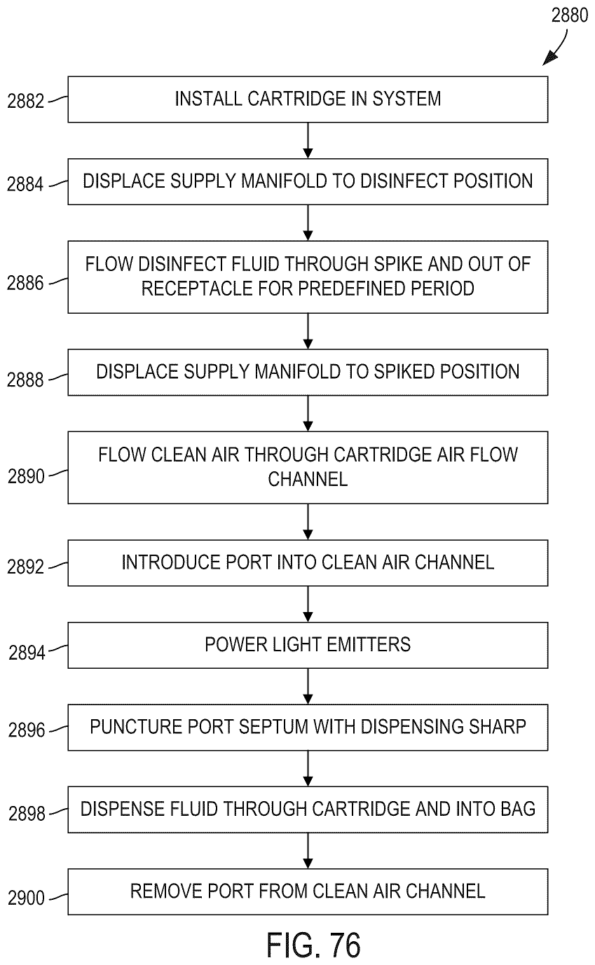

Referring now also to FIG. 76, a flowchart 2880 detailing a number of example actions which may be executed to fill a bag 26 at a fill station 2600 is depicted. As shown, in block 2882, a cartridge 2606 may be installed in a fill station 2600. In block 2884, a supply manifold 2820 may be displaced into a disinfection position. As described above in relation to FIG. 70, in this position a connection port 2812 of the cartridge 2606 may be partially inserted into a receptacle 2818 of the supply manifold 2812. Disinfecting fluid (e.g. high temperature water) may flow through the spike 2822 of the receptacle 2818 and out of an outlet 2824 of the receptacle 2818 for a predefined period of time in block 2886. The supply manifold may be displaced, in block 2888, to a spiked position. As this occurs a spike 2822 of the receptacle 2818 may puncture through a frangible 2816 on the connection port 2812 and establish a fluid communication pathway with the dispensing needle 2804 though the cartridge 2606. In block 2890, clean air may flow through the air flow channel 2802 in the cartridge 2606. A port 392 of a bag 26 may be introduced into the air flow channel 2802 in block 2892. To accomplish this, the filling actuator 2862 may be commanded to displace the cartridge 2606 and irradiation assembly 2608 to position in which a port 392 of a bag 26 is disposed within the portion of the air flow channel 2802 formed by the barrier 2646. Alternatively, the bag 26 could be retained on an actuator stage which is displaced to drive the port 392 into the air flow channel 2802. Once the port 392 is in a ready position, the irradiation assembly 2608 may be powered such that the light emitters 2610 irradiate the septum 393 in block 2894. The septum 393 may be punctured by the dispensing sharp 2804 in block 2896. In block 2898, fluid may be dispensed into the bag 26 via the dispensing sharp 2604. The port 392 may be removed from the air flow channel 2802 in block 2900. This may be accomplished by commanding an actuator to lower a stage on which the bag 26 is retained with a control system 15. Alternatively, the control system 15 may govern operation of a filling actuator 2862 to displace the irradiation assembly 2608 and cartridge 2606 away from the port 392.

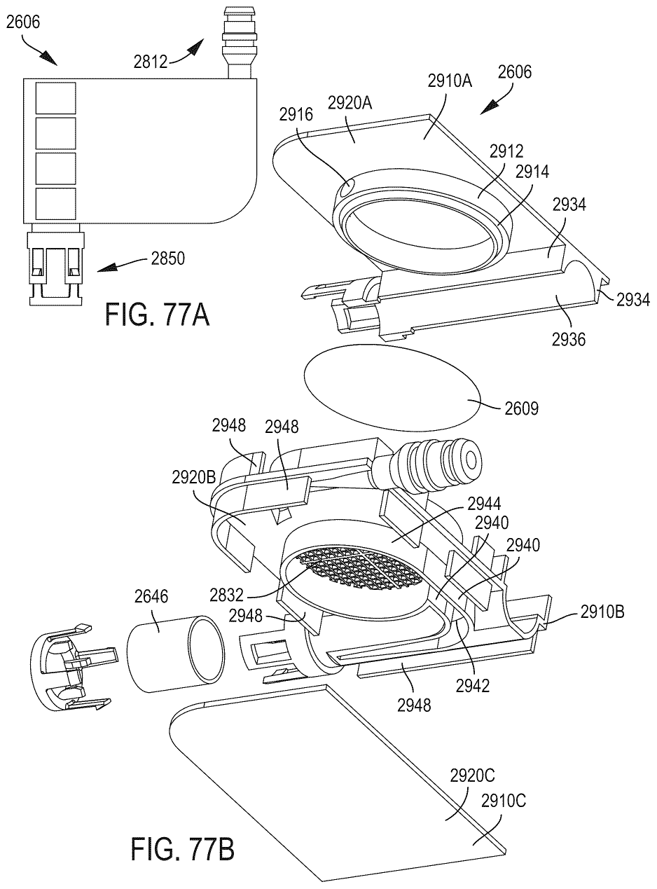

Referring now to FIGS. 77A-B, another exemplary embodiment of a cartridge 2606 which may be installed in a dispensing assembly 2602 is depicted. The cartridge 2606 includes a stack of plates 2910A-C. The plates 2910A-C may be coupled together in any suitable fashion (e.g. sonic welding, laser welding, adhesive, solvent bonding, etc.). Where laser welding is used, the second place 2910B may be formed of a material which absorbs the wavelength of light emitted by the welding laser (e.g. black polymer). The first and third plates 2910A, C may be constructed of material which is substantially translucent to the wavelength (e.g. various clear polymers). Each of the plates 2910A-C may include a main body 2920A-C which may include one or more raised or recessed features. In some examples, one of the plates 2910C may be a substantially flat member devoid of raised or recessed features. When the plates 2910A-C are coupled together, the raised and recessed features of the plates 2910A-C may cooperate to form the cartridge flow paths 2630, portions of the filter assembly 2838, and the air flow channel 2802. A portion of the barrier retention assembly 2850 may also be formed by the plates 2910A-C.

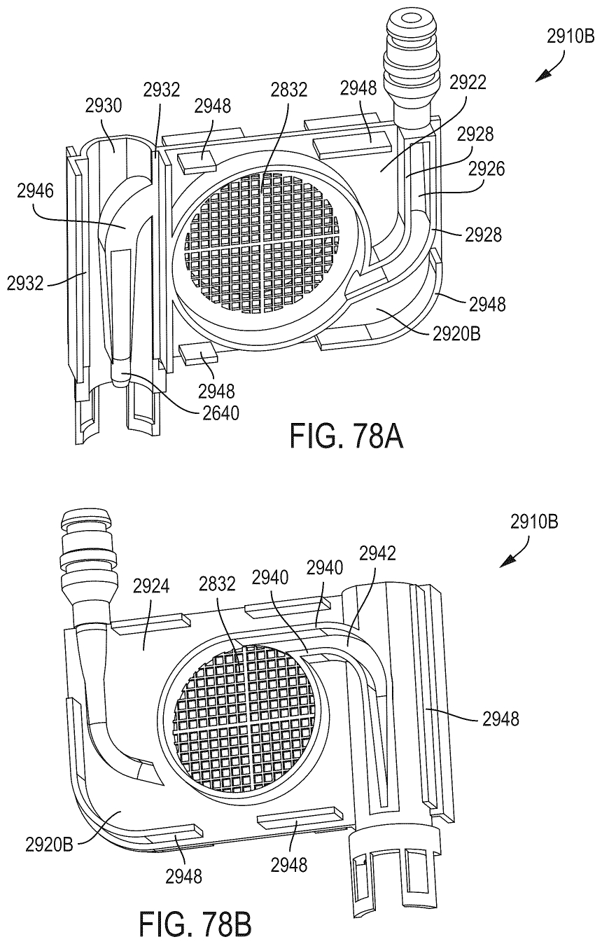

Referring now primarily to FIGS. 77B-78B, the first plate 2910A may include a filter capture ridge 2912. The filter capture ridge 2912 in the example embodiment is in the shape of a ring. The face of the filter capture ridge 2912 most distal to the main body 2920A of the first plate 2910A may include a sealing member seat 2914 which may accept a sealing member (e.g. o-ring). A filter membrane 2609 may be captured against the filter support 2832 when the first plate 2910A is coupled to the second plate 2910B or mid plate. The filter support 2832 may be grated region of the main body 2920B of the second plate 2910B. The sealing member may also be compressed between the second plate 2910B and the filter capture ridge 2912 when the first and second plates 2910A, B are coupled together.

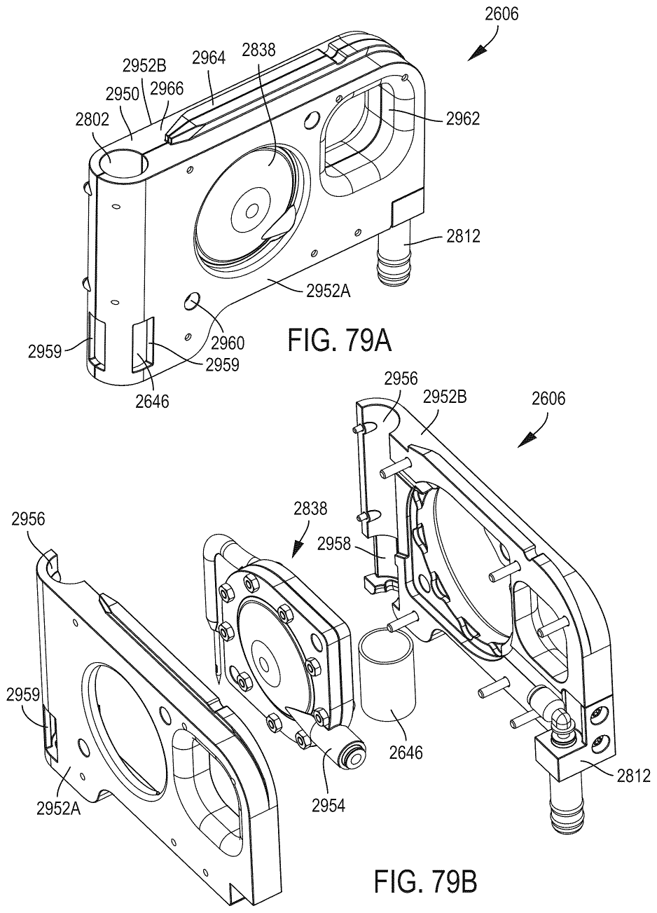

The second plate 2910B may form a midbody of the cartridge 2606 and include an inlet face 2922 (best shown in FIG. 78A) and an outlet face 2924 (best shown in FIG. 78B). The inlet face 2922 may include an inlet flow channel 2926 defined by a set of inlet walls 2928. The inlet flow channel 2926 may extend from the connection port 2812 to the filter assembly 2838. To facilitate ease of manufacture, the connection port 2812 may be a separate assembly which may couple to the cartridge 2606 (see, e.g., FIG. 79B). This may allow each of the plates 2910A-C to be injection molded. When the first plate 2910A is coupled to the second plate 2910B, the first plate 2910A may be coupled to the face of the inlet walls 2928 most distal the main body 2920B of the second plate 2910B. Thus, a sealed fluid conduit within the cartridge 2606 may be formed placing the connection port 2812 in fluid communication with the filter assembly 2938. As best shown in FIG. 77B, the filter capture ridge 2912 may include a passage 2916 therethrough which aligns with the inlet flow channel 2926. Thus, the filter capture ridge 2912 may not block flow to the filter assembly 2838 from the inlet flow channel 2926.

The inlet face 2922 may also include a recessed trough 2930. The recessed trough 2930 may form a section of the air flow channel 2802 through the cartridge 2606. As shown, the trough 2930 may be flanked by shelf regions 2932. The first plate 2910A may include a set of raised walls 2934 with a trench 2936 therebetween. In the exemplary embodiment depicted in FIG. 77B, the trench 2936 is a half-circular shape. When the second plate 2910B is coupled to the first plate 2910A, the raised walls 2934 may seat against the shelf regions 2932. In some embodiments, the raised walls 2934 may be coupled to the shelf regions 2932 (e.g. via laser or sonic weld). The trough 2930 and trench 2936 may cooperate to form the air flow channel 2802 of the cartridge 2606. In some examples, the airflow channel 2802 may have a substantially constant cross-sectional area or may have a varying cross-sectional area over its length (see, e.g., FIG. 70). Each of the first plate 2910A and the second plate 2910B include a portion of the barrier retention assembly 2850 in the example embodiment. When the first and second plates 2910A, B are coupled together, a first body 2852 of the barrier retention assembly 2850 may be formed by these plates 2910A, B. A second body 2854 may be coupled to the first body 2852 (e.g. as described in relation to FIGS. 71-72) to capture the barrier 2646 in place within the cartridge 2606.

The outlet face 2924 of the second plate 2910B may include a set of outlet walls 2940 which define an outlet flow path 2942. The outlet flow path 2942 may extend from the filter assembly 2838 to the dispensing sharp 2604. The filter support 2832 may also be surrounded by a wall 2944 which, in the example, is continuous with the outlet walls 2940. When the third plate 2910C is coupled to the second plate 2910B, the third plate 2910C may be coupled to the face of the outlet walls 2940 most distal the main body 2920B of the second plate 2910B. Thus, a sealed fluid conduit within the cartridge 2606 may be formed from the connection port 2812, through the filter assembly 2938, and to the dispensing sharp 2904. Wall 2944 may be similarly coupled to the third plate 2910C to seal the volume surrounding the filter support 2932. As shown, a relief region 2946 may be present in the trough 2930 on the inlet face 2922 to afford greater depth to the outlet flow path 2942. The relief region 2946 may also form the hub 2640 to which dispensing sharp 2604 (see, e.g., FIG. 66A) is coupled.

Preferably, and as shown in FIGS. 77A-78B, any outlet flow path 2942 leading from a filter assembly 2838 in a cartridge 2606 may be positioned at or near a top portion of the filter assembly 2838. Filter membranes 2609 tend to resist passage of gas when wetted. This position of the outlet flow path 2942 may facilitate priming of the cartridge 2606 with liquid as gas in the filter assembly 2838 may rise as the priming process transpires. Trapping of air or gas on the upstream side of the filter 2609 may thus be inhibited. In turn, this may help to ensure consistent flow rates through filter assemblies 2838 in each cartridge 2606 installed in a system 10.

Each of the inlet face 2922 and outlet face 2924 of the second plate 2910B may include peripheral ribs 2948 at the periphery of the second plate 2910B. The peripheral ribs 2948 may provide additional material which the first and third plates 2910A, C may be coupled to when the cartridge 2606 is assembled.

Referring now to FIGS. 79A-B, another example cartridge 2606 is depicted. As shown, the cartridge 2606 may include a housing 2950 formed by a first and second body 2952A, B. The first and second body 2952A, B may be coupled to one another and capture a filter assembly 2838 therebetween. The first and second body 2952A, B may be coupled to one another in any suitable manner. Though fasteners are depicted, the first and second body 2952A, B could be welded (e.g. laser, ultrasonic), adhered, solvent bonded, etc. to one another to form the housing 2950. The housing 2950 may include a set of guides 2960. The guides 2960 in the example embodiment are apertures which extend through the cartridge 2606. The guides 2960 may accept pins or projections on a mounting or docking assembly of the system 10. The housing 2950 also includes a grip passage 2962 which may provide a grasp point for a user when loading and unloading a cartridge 2606 into a system 10. A peripheral rib 2964 may also be included on at least one sidewall 2966 of the housing 2950. The peripheral rib 2964 may, for example, bestow asymmetry to the cartridge 2606 such that it may only fit into a receiver of the system 10 in a prescribed orientation.

Still referring to FIGS. 79A-B, a connection port 2812 may be coupled to the housing 2950. In the example embodiment, the connection port 2812 is coupled to the second body 2952B of the housing 2950. A cartridge flow path 2830 (e.g. tubing, not shown) may extend from the connection port 2812 to an inlet port 2954 of the filter assembly 2838 to place the connection port 2812 into fluid communication with the filter assembly 2838. The dispensing sharp 2604 and hub 2640 may be formed as part of the filter assembly 2838.

Each of the first and second body 2952A, B may include an air flow channel section 2956. The air flow channel sections 2956 may each have a recessed region 2958. A number of fenestrations 2959 which extend through the first and second body 2952A, B may be present at the recessed region 2958. A barrier 2646 (e.g. a tube segment formed of fused quartz) may be captured within the recessed regions 2958 when the housing 2950 is assembled. Thus, the first and second body 2952A, B and barrier 2646 may cooperate to form the air flow channel 2802 through the cartridge 2606. The fenestrations 2959 may align with the positions of light emitters 2610 of an irradiation assembly 2608 when the cartridge 2606 is in place within a system 10.

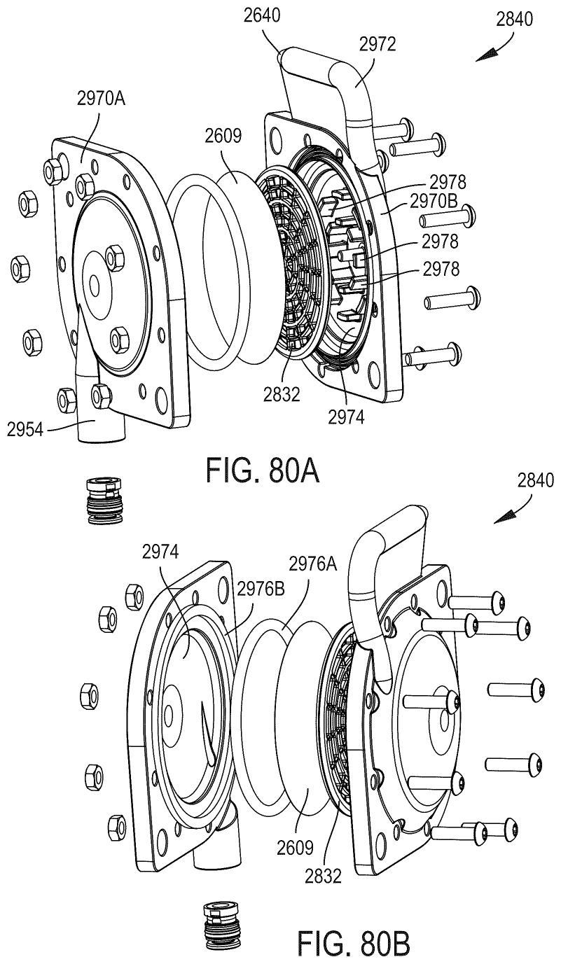

Referring now to FIGS. 80A-B, exploded views of the example filter assembly 2838 of FIG. 79B are depicted. Example filter assemblies 2838 may include a filter housing 2968 (see, e.g., FIG. 79B). The filter housing 2968 may be constructed of a first and second filter housing body 2970A, B. The filter housing bodies 2970A, B may be coupled together in any suitable manner (e.g. laser welding, ultrasonic welding, adhesive, solvent bonding, fasteners, etc.). One of the filter housing bodies 2970A, B may define a filter assembly inlet 2954. Alternatively, the filter assembly inlet 2954 may be formed when the filter housing bodies 2970A, B are coupled together and each of the filter housing bodies 2970A, B may include a portion of the filter assembly inlet 2954. One of the filter housing bodies 2970A, B may define a filter assembly outlet 2972. Alternatively, the filter housing bodies 2970A, B may cooperate to from the filter assembly outlet 2972 when coupled together. In some embodiments, and as shown, the filter assembly outlet 2972 may form the hub 2640 to which the dispensing sharp 2604 (see, e.g., FIG. 79B) is coupled. The internal face of each filter housing body 2970A, B may include a central depression 2974.

When the filter housing bodies 2970A, B are coupled together, a filter 2609 may be captured within the filter assembly 2838. One or more sealing members 2976A, B may become compressed against the filter 2609 to inhibit any flow around the filter 2609. Additionally, one or more sealing members 2976A, B may assist in preventing leaks from the filter assembly 2838 when the filter assembly 2838 is operating under high pressure. A filter support 2832 may also be retained within the filter assembly 2838 when the filter housing bodies 2970A, B are coupled. The central depression 2972 in the filter housing body 2970B on the permeate side of the filter 2609 may include a set of projections 2978 which may provide a rest for the filter support 2832 and inhibit distortion of the filter support 2932 under pressure.

Referring now to FIGS. 81A-83C, another example embodiment of a cartridge 2606 is depicted. The cartridge 2606 includes a cartridge housing 2950 formed from a first and second body 2952A, B. Each of the first and second body 2952A, B form a portion of the filter assembly 2838. In the example, the first and second body 2852A, B both include a depression 2982. The depression 2982 in the second body 2952B includes a number of projections 2978. When the first and second body 2952A, B are coupled together, the filter support 2832 may rest on the projections 2978 and the filter 2609 may be captured within the filter assembly 2838. One or more sealing member 2980 may become compressed inhibiting flow around the filter 2609 and leaks from the filter assembly 2838. Fluid may flow into the cartridge 2606 through a connection port 2812 and inlet flow path 2984 (see, e.g., FIG. 83A) which communicates with the depression 2972 in the first body 2952A. Permeate through the filter 2609 may pass to the dispensing sharp 2604 through an outlet flow path 2986 (see, e.g., FIG. 83B) extending from the depression 2972 in the second body 2952B.

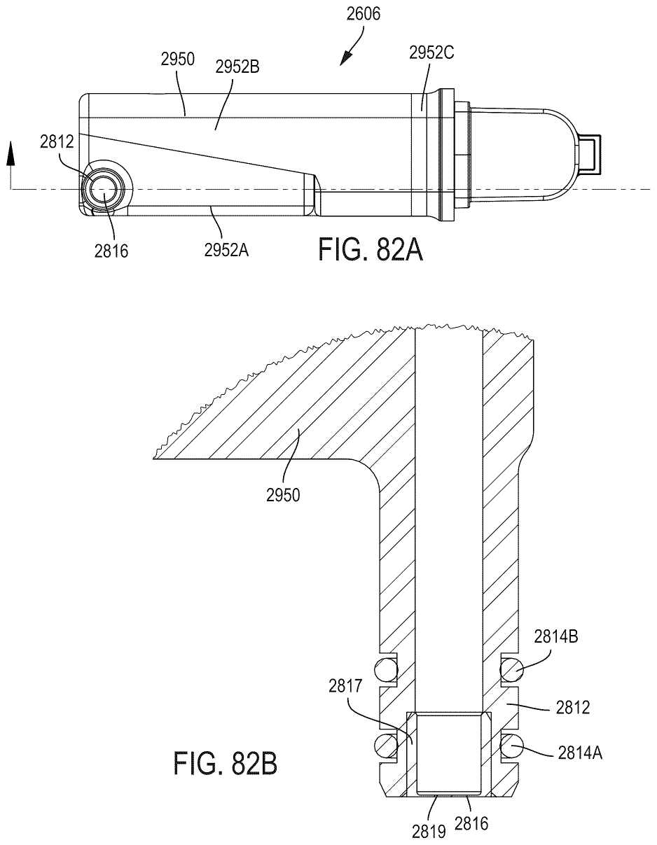

Referring primarily to FIGS. 82A-B, the connection port 2812 may be sealed with a frangible 2816. The frangible 2816 may be a plug with an elongate body 2817 which is closed on one end by an end wall 2819. The end wall 2819 may be relatively thin (e.g. 1-5 tenths of a millimeter thick). This end wall 2819 may be easily punctured by a spike 2822 (see, e.g. FIG. 106A) in a receptacle 2818 of a supply manifold 2820, but robust against inadvertent disruption. The frangible 2816 may be formed of an injection molded plastic material as a monolithic body. In some embodiments a plastic such as polyphenylsulfone (PPSU) may be used. The frangible 2816 may be retained in the connection port 2812 via a friction fit though adhesive, solvent bonding or other manners of coupling may be used in alternative embodiments. Such frangibles 2816 may be particularly desirable as they do not include aluminum or other metals which it would be undesirable to have in communication with the fluid flow path. Additionally, a PPSU frangible 2618 would be compatible with exposure to high temperature fluid which may be used during disinfection of the connection port 2812.

The example cartridge 2606 in FIGS. 81A-83C further includes a third body 2952C. The third body 2952C may include a section of the air flow channel 2802. A retainer 2990 may be coupled to the third body 2952C and may capture a barrier 2646 between the retainer 2990 and the end of the air flow channel 2802 defined in the third body 2952C. The retainer 2990 may include guides 2658 which may help to position a port 392 of a bag 26 when the port 392 is introduced into the air flow channel 2802. When the retainer 2990 and barrier 2646 are in place, they may complete the air flow channel 2802 through the cartridge 2606. This may be desirable as this may remove seams running along the axial dimension of the air flow channel 2802.

As best shown in FIGS. 83B-C, the outlet flow path 2986 may extend to a hub 2640 which may protrude into the air flow channel 2802. A sealing member 2988 may be present at the transition of the outlet flow path 2986 from the second body 2952B to the third body 2952 and may be compressed when cartridge 2606 is assembled. The dispensing sharp 2604 may be coupled to the hub 2640.

Cartridges 2606 described herein may include a cover 2992 which may be coupled in place over the air flow channel 2802 of the cartridge 2606. The cover 2992 may seal against a sealing member 2994 (e.g. compliant gasket or overmolded material) on an exterior face of the housing 2950. In the example embodiment, the cover 2992 seats against a sealing member 2994 on the third body 2952C of the cartridge 2606. The third body 2952C includes a central projecting region 2953 in which the section of the air flow channel 2802 is defined. The third body 2952C also includes a perimeter region 2955 surrounding the central region 2953. The sealing member 2994 may be coupled to the perimeter region 2955.

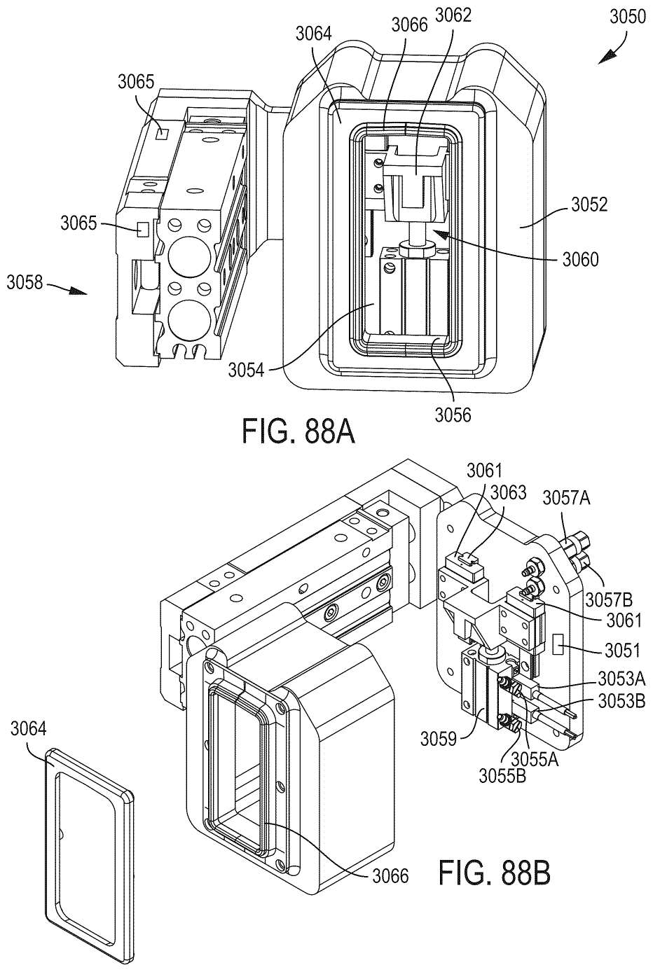

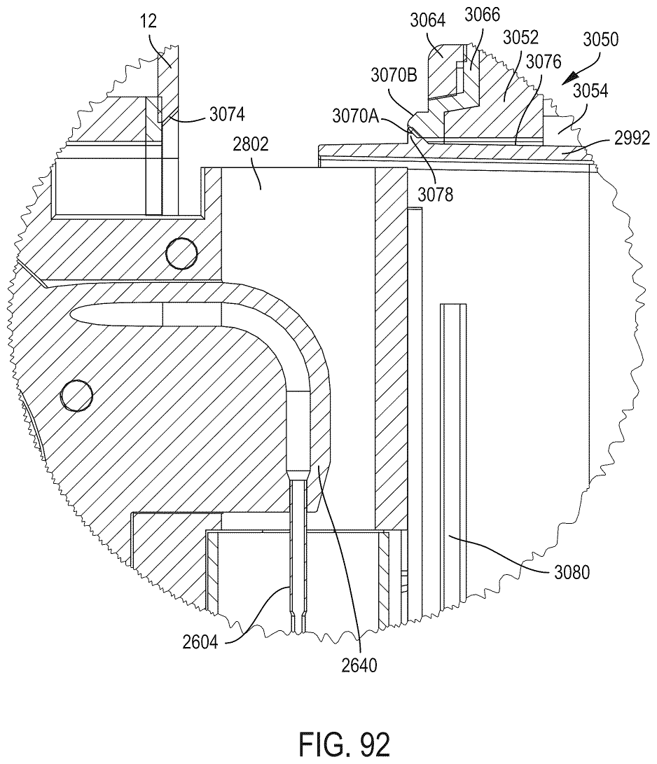

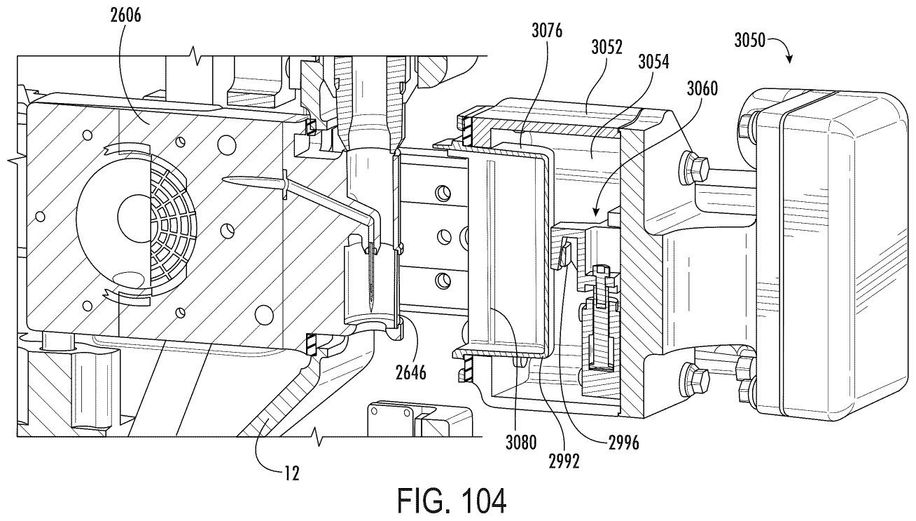

The cover 2992 may be retained in place by an interference fit, snap fit, magnets, etc. depending on the embodiment. In the example embodiment, the cartridge housing 2950 includes ridges 2951 (or alternatively recessed grooves). The interior surface of the cover 2992 may include latches 3080 (see, e.g., FIG. 92 and FIG. 104) which may snap in place or engage the ridges 2951 (or grooves) to couple the cover 2992 to the rest of the cartridge 2606. Preferably, the coupling formed by the interaction of the ridges 2951 and latches 3080 may be robust to inadvertent removal or dislodgement. When coupled in place, the cover 2992 may compress against the sealing member 2994. This forms an environmental seal which partitions and isolates the air flow channel 2802 and dispensing sharp 2604 from the surrounding environment outside of the cover 2992. The cartridge 2606 may be provided in a sterilized state and the cover 2992 may ensure that the air flow channel 2802 and the dispensing sharp 2604 maintain this state until use. The cover 2992 may remain in place when the cartridge 2606 is installed within a system 10 and may be removed by the system 10. In the example, the cover 2992 includes a catch 2996 for interfacing with a cover removal assembly 3050 (see, e.g., FIGS. 88A-B) of the system 10.

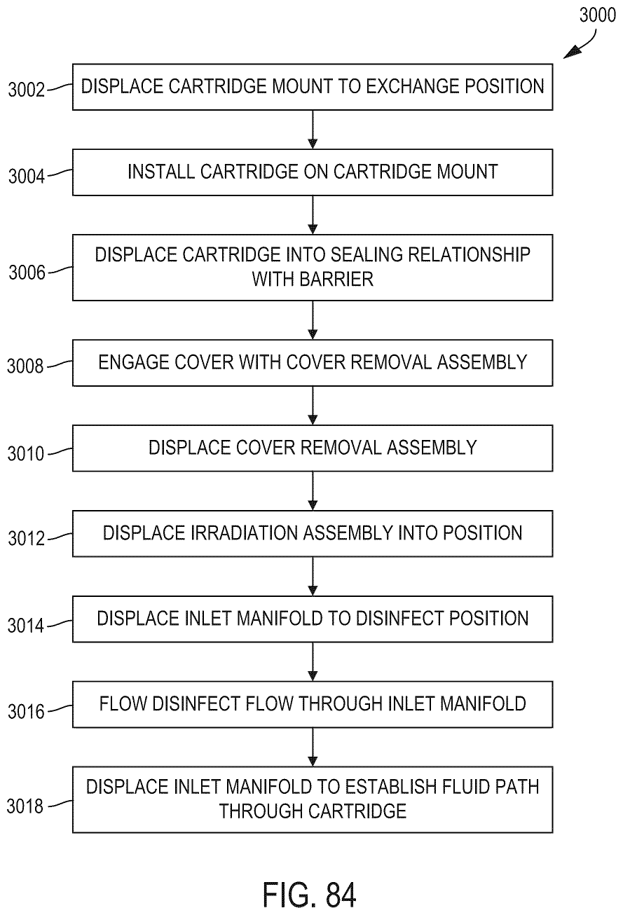

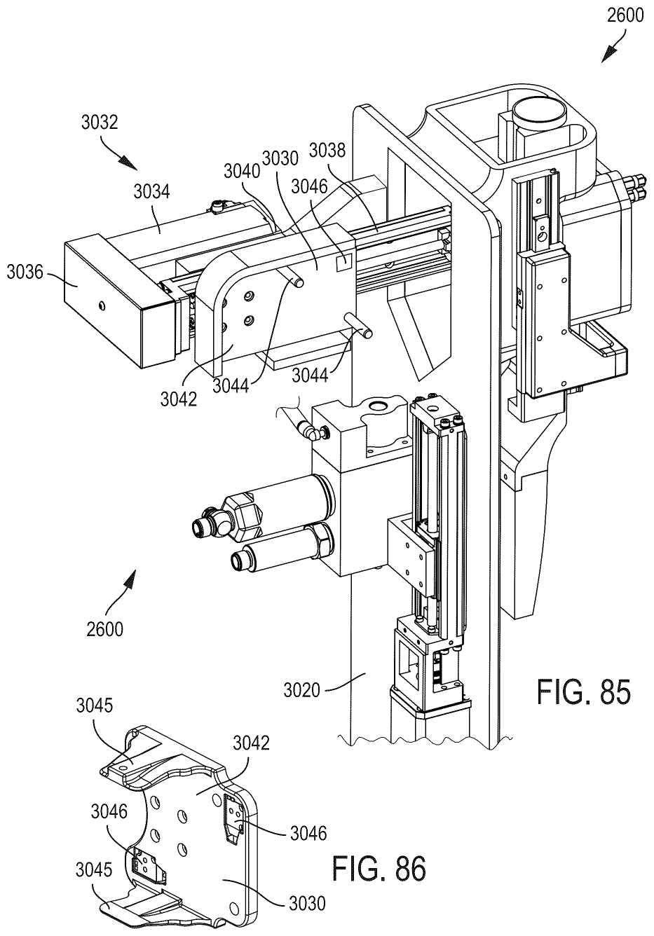

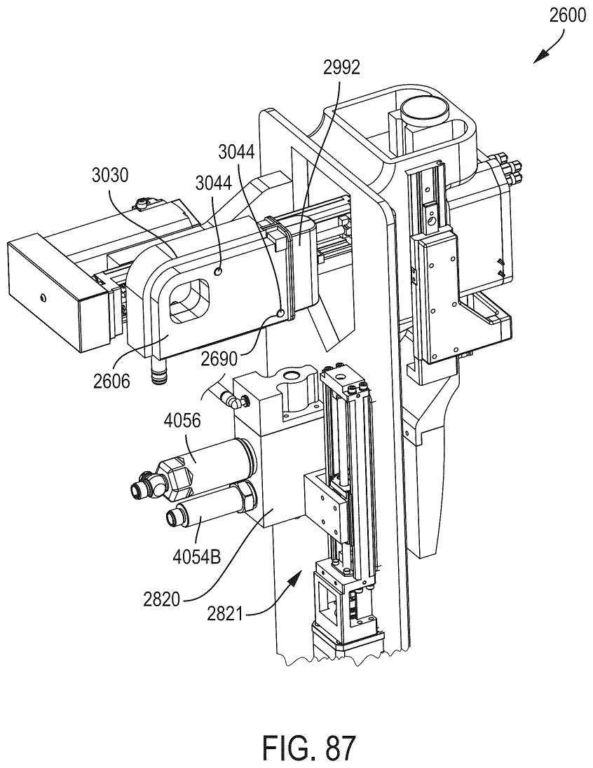

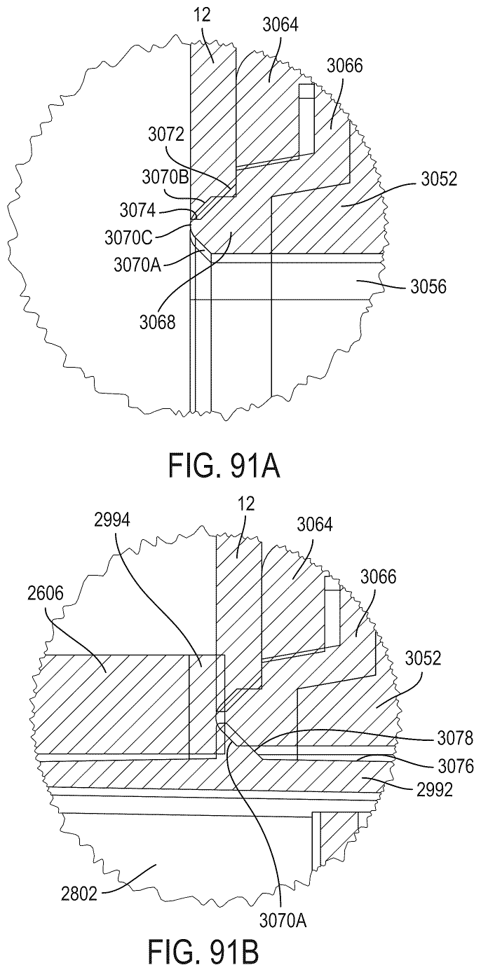

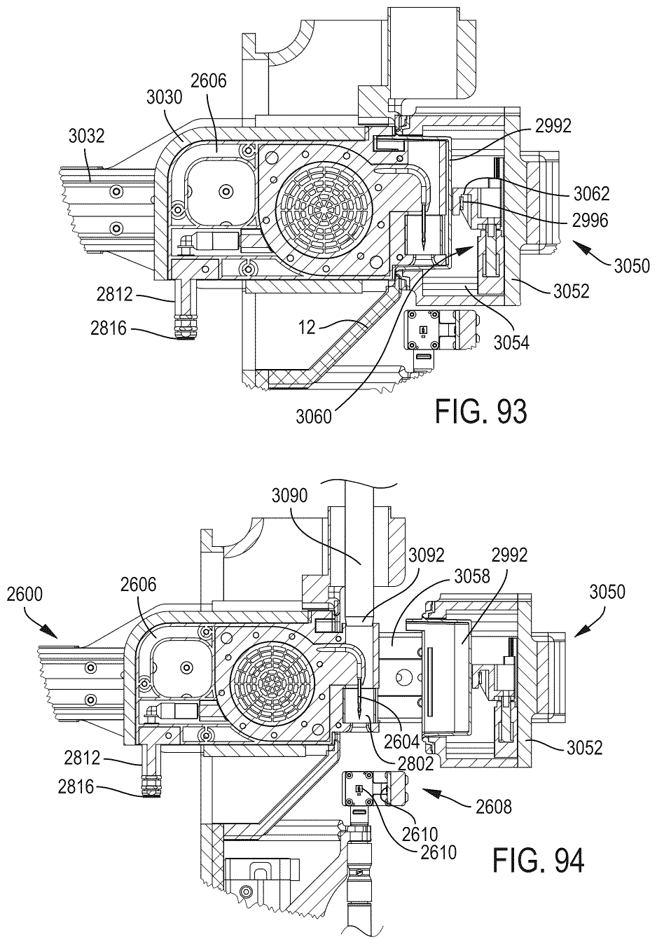

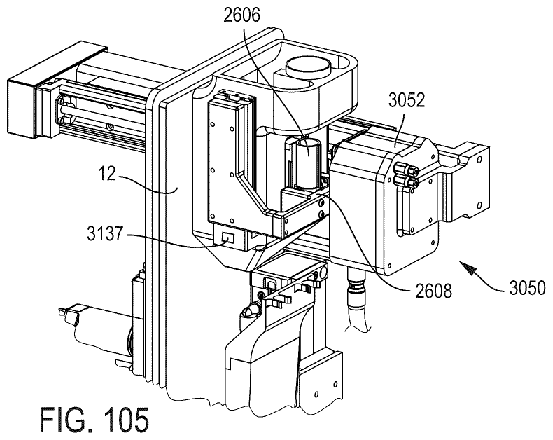

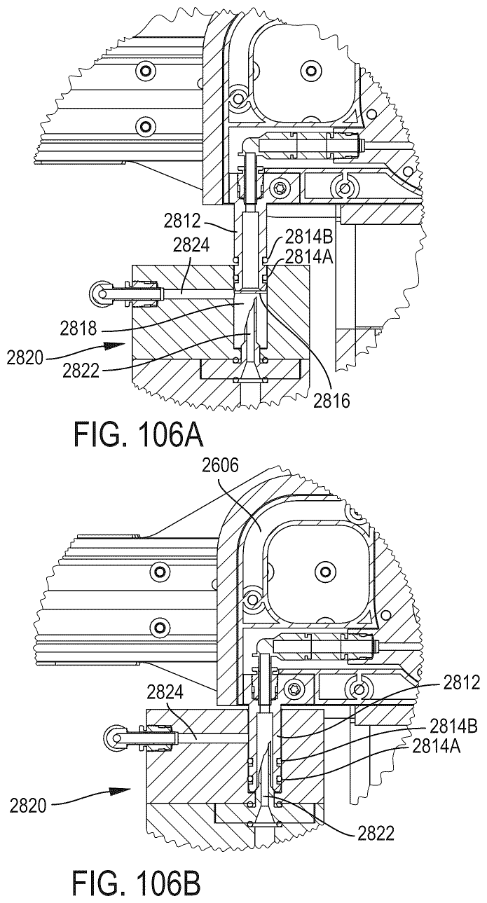

Referring now to FIG. 84, a flowchart 3000 depicting a number of example actions which may be executed to install a cartridge 2606 within a fill station 2600 is depicted. In block 3002, a cartridge mount or dock 3030 may be displaced to a cartridge exchange position (see, e.g., FIG. 85). A new cartridge 2606 may be installed into the cartridge mount 3030 in block 3004 (see, e.g., FIG. 87). In block 3006, the cartridge 2606 may be displaced to an access position (see, e.g., FIG. 90). This may be a position where the cartridge 2606 has been displaced into sealing relationship with a barrier (e.g. a portion of an enclosure 12 or wall 4301 of a processing compartment 4300). In some embodiments, the control system 15 may check the signal from one or more sensor monitoring the cartridge mount 3030 to confirm the cartridge 2606 is properly installed before displacing the cartridge 2606 to the access position. A cover removal assembly 3050 may, in block 3008 engage the cover 2992 on the cartridge 2606 (see, e.g., FIG. 93). With the cover 2992 engaged, the cover removal assembly 3050 may be displaced away from the cartridge 2606 to separate the cover 2992 from the cartridge 2606 in block 3010 (see, e.g., FIG. 94). As further described in relation to FIGS. 91A-92, this may aseptically place the air flow channel 2802 and dispensing sharp 2604 into communication with a stringently controlled environment on the interior of the enclosure 12. In block 3012, the irradiation assembly 2608 may be displaced into alignment with the barrier 2646 on the cartridge 2606 (see, e.g., FIG. 105). The supply manifold 2820 may be displaced to a disinfect position in block 3014 (see, e.g., FIG. 106A). Disinfect fluid may flow through the supply manifold 2820 in block 3016. The supply manifold 2820 may be displaced so as to interrupt the frangible 2816 of the cartridge 2606 and establish fluid communication through the cartridge 2606 in block 3018 (see, e.g., FIG. 106B).

Referring now to FIGS. 85-118, an example fill station 2600 and portions thereof are depicted. The example fill station 2600 is depicted in isolation, however, typically would be included as one of a number of stations in a system 10 (see, e.g., FIG. 2). The example fill station 2600 includes portions which are partitioned into differing levels of environmental control. An enclosure 12 may form the partition between these portions. For purposes of illustration, the enclosure 12 is shown in abbreviated form over FIGS. 85-118. An example of an enclosure 12 which may be included in a system 10 is shown in unabbreviated from in FIG. 1 and various compartments forming the enclosure 12 are shown in FIG. 2.

Referring now primarily to FIG. 85, an example fill station 2600 which may be included in a system 10 is depicted. As shown, the fill station 2600 may include a cartridge dock or mount 3030. The cartridge mount 3030 may be attached to a cartridge displacement assembly 3032 which may include a motor 3034, transmission 3036 and an output actuator 3038 to which the cartridge mount 3030 is coupled. The cartridge displacement assembly 3032 may include at least one position sensor 3040. In certain examples, the cartridge displacement assembly 3032 may include a motor encoder. A linear potentiometer could be included and may monitor the position of the cartridge mount 3030. Any other suitable sensor may be used. A control system 15 may be in data communication with the at least one position sensor 3040 and motor 3034. The control system 15 may govern displacement of the cartridge mount 3030 based on the signals received from the at least one position sensor 3040.

The cartridge mount 3030 may include a receptacle 3042 sized to accept a cartridge 2606 (e.g. any of those described herein). The receptacle 3042 may be shaped such that the cartridge 2606 may only be installed in a prescribed orientation (e.g. be asymmetric as shown). The receptacle 3042 may include at least one guide 3044 which may help direct the cartridge 2606 into place during installation. Each of the at least one guide 3044 may be a positive projection or recess in the mount 3030 which interfaces with a cooperating feature of the cartridge 2606. Cartridges 2606 may include recesses or apertures which accept positive projections in the cartridge mount 3030 and/or may include positive projections which are received in recesses of the cartridge mount 3030. In the example embodiment in FIG. 85, the at least one guide 3044 in the cartridge mount 3030 includes a set of pins.

Referring now also to the example cartridge mount 3030 of FIG. 86, in some examples, cantilevered spring clips 3045 may be included to assist in retaining a cartridge 2606 on a cartridge mount 3030. Spring clips 3045 may inhibit misalignment and may center the cartridge 2606 within the receptacle 3042. When the cartridge 2606 is in place, the spring clips 3045 may be in a deflected state and may exert a bias against the cartridge 2606 which firmly holds the cartridge 2606 in place.

The receptacle 3042 of the cartridge mount 3030 may also include at least one cartridge presence sensor 3046. Though any suitable sensor may be utilized, the cartridge presence sensor 3046 may be a microswitch which is actuated when a cartridge 2606 is properly installed in the cartridge mount 3030. Alternatively, the cartridge 2606 may include a magnet or ferromagnetic body and the cartridge presence detector 3046 may include a magnetic sensor which may alter an output when the cartridge 2606 is properly installed in the cassette mount 3030 and the magnet or ferromagnetic body of the cartridge 2606 is in close proximity. A Hall effect sensor may, for example, be used in certain embodiments. Other sensors such as reflectivity based sensors may be used. Multiple presence sensors 3046 may be included in certain examples in order to help ensure a cartridge 2606 is not only present, but seated properly.

In some embodiments, at least one cartridge presence sensor 3046 may read a cartridge indicia which may contain information associated with the cartridge 2606 (e.g. a unique identifier for the cartridge 2606). In such examples, a bar code reader, data matrix reader (e.g. imager), RFID interrogator, NFC interrogator, etc. may be used. The cartridge 2606 may include a barcode, data matrix, RFID or NFC tag as appropriate. Thus, the cartridge presence sensor 3046 may collect data related to the cartridge 2606 as an indication that a cartridge 2606 is installed in the cartridge mount 3030. The control system 15 may verify that use of the installed cartridge 2606 is permissible before, for example, commanding displacement of the output actuator 3038. If the cartridge 2606 unique identifier is indicated in a database as having been used, recalled, or expired, use of the cartridge 2606 may be prohibited.

Referring now to FIG. 87, the filling station 2600 of FIG. 85 is depicted with a cartridge 2606 in place. The cartridge 2606 shown is exemplary and is constructed similarly to that depicted in FIGS. 79A-80B. The example cartridge 2606 also includes a cover 2992 similar to that described further in relation to FIGS. 81A-83C. As shown, the cartridge 2606 includes guides 2690 which may interact with the guides 3044 of the cartridge mount 3030. The example cartridge mount 3030 may include a clasp, clip, or other retainer which may be engaged with a cartridge 2606 to maintain the cartridge 2606 in the cartridge mount 3030 after a cartridge 2606 is installed. For example, the cartridge mount 3030 may be modified to include the spring clips 3045 of FIG. 86.

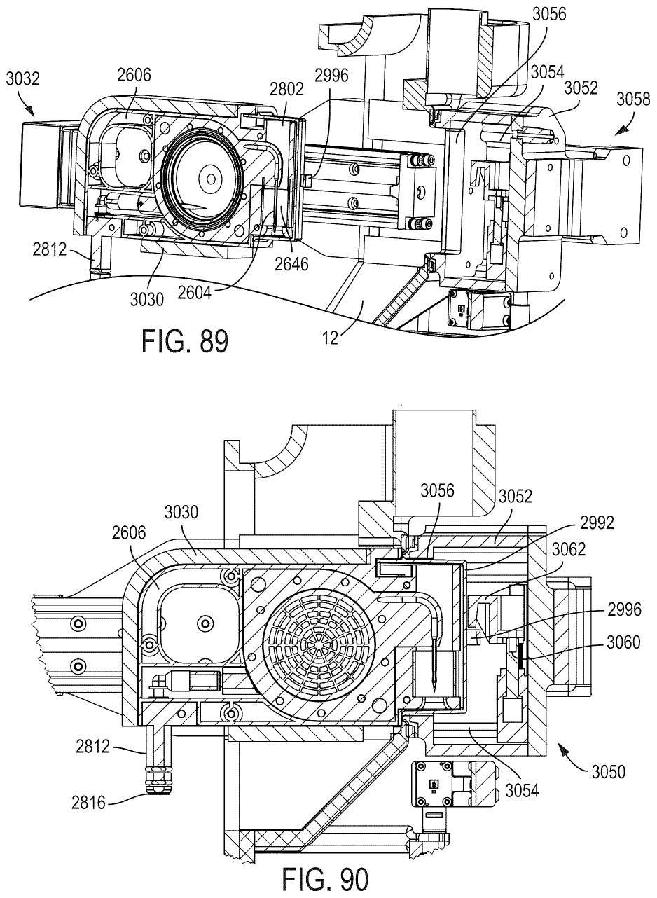

Referring now primarily to FIGS. 88A-89, views of an example cover removal assembly 3050 and perspective cross-sectional view of a portion of a fill station 2600 are respectively depicted. The cartridge 2606 in FIG. 89 is in a position where it has just been loaded onto a cartridge mount 3030. As mentioned in relation to FIG. 84, the cover 2992 of the cartridge 2606 may be removed by the cover removal assembly 3050. This may provide access to the air flow channel 2802, dispensing sharp 2604, and barrier 2646 of the cartridge 2606. As shown, an example cover removal assembly 3050 may include a housing 3052 with an interior bay 3054. The housing 3052 may define a bay ingress 3056. As shown in FIG. 90, when the cartridge 2606 is displaced to an access position by the cartridge displacement assembly 3032, the cover 2992 of the cartridge 2606 may be displaced at least partially into the bay 3054 via the bay ingress 3056.

Referring to FIGS. 88A-90, the housing 3052 may also be attached to a cover displacement assembly 3058. The cover displacement assembly 3058 may be actuated (e.g. pneumatically) by the control system 15 to displace the housing 3052 with respect to the enclosure 12. Where pneumatically actuated, the cover displacement assembly 3058 may be driven by a relatively high pressure pneumatic source (e.g. 80 psi). Pressure from the pneumatic source may be applied to the cover displacement assembly 3058 when the housing 3052 is displaced against the enclosure 12. This may ensure the sealing member 3066 of the housing 3052 is maintained in compression against the enclosure 12.

A cover engagement assembly 3060 (best shown in FIG. 88B) may be disposed within the bay 3054. In the example embodiment, the cover engagement assembly 3060 is positioned opposite the bay ingress 3056. A cover engagement assembly 3060 may be actuated (e.g. pneumatically) from a retracted state to a deployed state to retain a cover 2992 of a cartridge 2606. Once a cover 2992 is retained, the cover displacement assembly 3058 may be actuated (e.g. pneumatically) to disassociate the cover 2992 from a cartridge 2606 and displace the cover 2992 to a storage position.

The cover displacement assembly 3058 may include at least one position sensor 3065 which may output a signal indicative of the location of the housing 3052. In certain embodiments, two position sensors 3065 may be included and may output signals indicative that the housing 3052 has been displaced to respective ends of its displacement range. The control system 15 may be in data communication with any of the at least one position sensor 3065 and may command displacement of the housing 3052 via the cover displacement assembly 3058 based on data signals from the at least one position sensor 3065.

The example cover engagement assembly 3060 may include an engagement catch 3062 which may be displaced to engage and disengage a cover 2992 of a cartridge 2606. Catches 3062 may, for example, include a hook. In such embodiments, the cover 2992 may include a cover catch 2996 through or into which the hook may extend when the cover 2992 and cover engagement assembly 3060 are in an engaged state. The engagement catch 3062 of the cover engagement assembly 3060 may include wing assemblies 3061 which travel along bearing surfaces 3063 in the housing 3052. The engagement catch 3062 may be coupled to an actuator 3059 which may be operated to displace the engagement catch 3062. In the example, the actuator 3059 is a pneumatic actuator and may be selectively placed into communication with at least one pressure source (e.g. via one or more valve) to drive displacement of the engagement catch 3062. The housing 3052 includes positive and negative pressure inputs 3057A, B for connection to pneumatic pressure sources. Though not shown, pneumatic lines may run from the pressure inputs 3057A, B to pressure supply connections 3055A, B associated with the actuator 3059.

One or more position sensor 3053A, B may be included to monitor the position of the engagement catch 3062. In the example embodiment, two position sensors 3053A, B are included and may each output a signal indicative that the engagement catch 3062 is at a respective end of its displacement range (e.g. microswitches). In other embodiments, a linear potentiometer or the like may be included and may output a signal which varies in relation to the location of the engagement catch 3062 along its displacement range. Any other suitable sensor(s) may be included in alternative examples. The control system 15 may be in data communication with any of the at least one position sensor 3053A, B and may command displacement of the engagement catch 3062 based on data signals from the at least one position sensor 3053A, B.

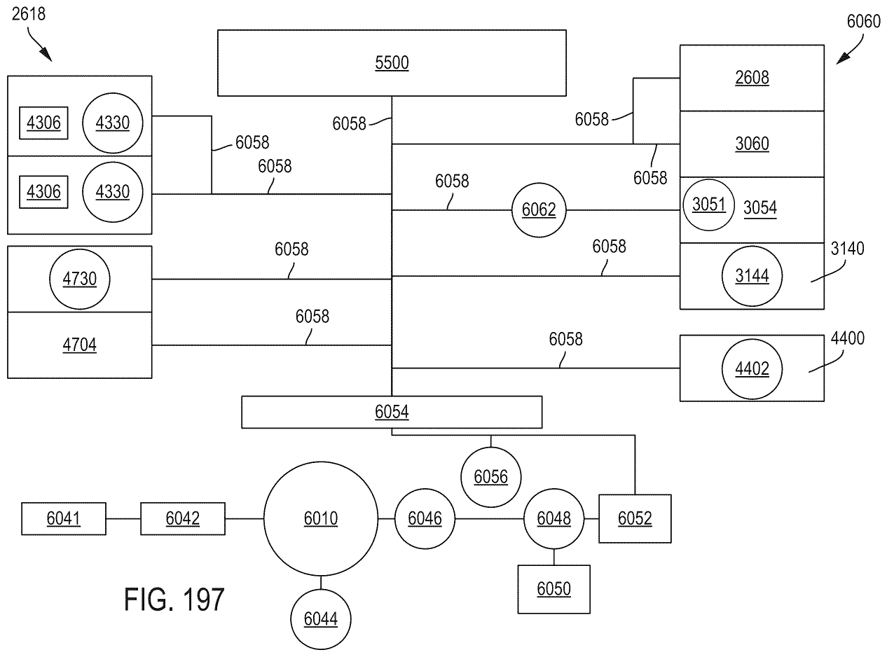

In certain examples, the bay 3054 may be placed into communication with the negative pressure supply or vacuum source 6010 (see, e.g., FIG. 197). This may be accomplished via toggling of a valve included in the cap removal assembly 3050 or in a negative pressure distribution assembly 6060 (see e.g. FIG. 197). In such embodiments at least one pressure sensor 3051 may be included to monitor pressure within the bay 3054. The control system 15 may be in data communication with the at least one pressure sensor 3051. Pressure sensors 3051 are further described in relation to FIG. 91B.

Referring now to FIGS. 91A-92, a cartridge 2606 may be loaded to the cartridge mount 3030 exterior to an enclosure 12 of the system 10. Bags 26, however, may be filled on an interior of the enclosure 12 which is under more stringent environmental control. The enclosure 12 may include a fenestration 3074 through which a portion of the cartridge 2606 may extend so as to be accessible from the interior of the enclosure 12. In various embodiments, when a cartridge 2606 is installed in a fill station 2600, the cover 2992 may be removed in an aseptic manner to access the air flow channel 2802 and dispensing sharp 2604. Thus, the environment on the interior of the enclosure 12 may not be fouled when the air flow channel 2802 and dispensing sharp 2804 are accessed. Additionally, when cartridges 2606 are exchanged, environmental communication between the exterior side of the enclosure 12 and a more stringently controlled interior side of the enclosure 12 may be inhibited.

Referring to FIG. 91A, a cross-sectional view of a portion of an enclosure 12 and cap removal assembly 3050 is depicted. As shown, the cap removal assembly 3050 may include a sealing member 3066 which surrounds the bay ingress 3056 defined in the housing 3052 (see also FIG. 88B). The sealing member 3066 may be captured in place on the housing 3052 by a retainer plate 3064. The retainer plate 3064 may couple to the housing 3052 via fasteners, snap fit, or any other suitable manner with the sealing member 3066 disposed intermediate the housing 3052 and the retainer plate 3064. In other examples, the sealing member 3066 may be coupled to the housing 3052 in other manners. For example, the sealing member 3066 may be overmolded onto the housing 3052. In such examples, the retainer plate 3064 may be omitted.

The sealing member 3066 may include a ridge 3068 which may surround the bay ingress 3056. The ridge 3068 may include an interior sidewall 3070A and an exterior sidewall 3070B which may be angled toward one another. The ridge 3068 may also include an intermediate span 3070C extending from the interior sidewall 3070A to the exterior sidewall 3070B. The intermediate span 3070C may be the portion of the ridge 3068 most distal to the housing 3052 and may be a rounded span (as shown) or plateau. In other examples, the interior and exterior side walls 3070A, B may extend until they meet substantially at a point.

When a cartridge 2606 is exchanged, the housing 3052 of the cover removal assembly 3050 may be positioned such that the sealing member 3066 is compressed against the walls 3072 of the fenestration 3074 in the enclosure 12. This may prevent communication between the environment on the exterior of the enclosure 12 and the environment on the interior of the enclosure 12. That is, the seal may isolate the interior of the enclosure 12 from the exterior of the enclosure 12. As shown, the walls 3072 may be contoured to match the angle of the exterior sidewall 3070B of the sealing member 3066. When the cover removal assembly 3050 is sealed around the fenestration 3074, the seal may be primarily or entirely established by compression of the exterior sidewall 3070B against the walls 3072 of the fenestration 3074.

Referring now to FIG. 91B, as a cartridge 2606 is displaced to the access position by the cartridge displacement assembly 3032, the cover 2992 may project through the fenestration 3074 and into the bay 3054 of the housing 3052 of the cover removal assembly 3050. When the cartridge 2606 is in the access position, the sealing member 3066 of the cover removal assembly 3050 may establish a seal around the exterior surface 3076 of the cover 2992. As shown, the cover 2992 may include a protrusion 3078 on its exterior surface 3076 with a face contoured to match the angle of the interior sidewall 3070A of the sealing member 3066. The seal may be primarily or entirely established by compression of the interior sidewall 3070A against the protrusion 3078 on the exterior surface 3076 of the cover 2992. Once this seal is formed, the bay 3054 and portion of the exterior surface 3076 of the cover 2992 previously exposed to the exterior of the enclosure 12 may be isolated from the interior as well as the exterior of the enclosure 12.

In certain examples, the control system 15 may place the bay 3054 into communication with a negative pressure source (e.g. via toggling of at least one valve). The output of at least one pressure sensor 3051 (see, e.g., FIG. 88B) in communication with the bay 3054 may be monitored by the control system 15. The signal from the one or more pressure sensor 3051 may be monitored to ensure that a proper seal has been formed between the cover removal assembly 3050 and a cover 2992. In the event a robust seal is formed between the sealing member 3066 and the cover 2992, the negative pressure in the bay 3054 will exhibit minimal decay over time. In the event that the data from the pressure sensor 3051 indicates pressure is steady (decay rate is less than a threshold), the control system 15 may proceed to remove the cover 2992 from the cartridge 2606. Negatively pressurizing the bay 3054 may also assist in retaining a cover 2992 against the cover removal assembly 3050.

In the event the pressure sensor(s) 3051 indicates the pressure in the bag 3054 is above a threshold, the control system 15 may prohibit actuation of the cover engagement assembly 3060. Additionally or alternatively, in the event that data from the pressure sensor 3051 indicates the pressure within the bay 3054 is decaying beyond a threshold rate, the control system 15 may prohibit removal of the cover 2992. In some examples, a notification may be generated for display on a user interface if one or more predefined pressure characteristic is not observed with data from the one or more pressure sensor 3051. In some examples, the control system 15 may attempt to re-establish a seal against the cover 2992 up to a preset number of retry attempts. The cartridge 2606 may, for example, be backed away from and advanced back toward the cover removal assembly 3050 by commanding actuation of the cartridge displacement assembly 3032. The control system 15 may also generate a notification and potentially prohibit one or more functionality of the system 10 if the pressure in the bay 3054 rises above a threshold after the cover 2992 is engaged and removed by the cover removal assembly 3050.

As mentioned in relation to FIG. 83A, example cartridges 2606 may include a cartridge sealing member 2994. The cartridge sealing member 2994 may establish a seal against the exterior surface 3076 of the cover 2992 when the cover 2992 is in place on the cartridge 2606. In the example, the cartridge sealing member 2994 is compressed against the protrusion 3078 on the exterior surface 3076 of the cover 2992.

Referring primarily to FIG. 91B, the cartridge 2606 may establish a seal, via the cartridge sealing member 2994, around the fenestration 3074 in the enclosure 12 when the cartridge 2606 is in the access position. This may isolate the environment on the exterior of the enclosure 12 and areas of the cartridge 2606 exposed to that environment from the interior of the enclosure 12.

Referring now to FIG. 92, when the cover 2992 is removed from the cartridge 2606, the sealing member 3066 of the cover removal assembly 3050 may maintain a sealing relationship against the cover 2992. Thus, the surfaces of the cover 2992 and bay 3054 which were exposed to the environment on the exterior of the enclosure 12 may remain isolated from the interior of the enclosure 12. The sealing member 3066 may be displaced away from the walls 3072 of the fenestration 3074 when the cover 2992 is removed from the cartridge 2606. The seal established around the fenestration 3074 by the cartridge sealing member 2994 may, however, be maintained. This may prevent communication between the interior and exterior of the enclosure 12. The exterior sidewall 3070B of the sealing member 3066 of the cover removal assembly 3050 may only be exposed to conditions on the interior of the enclosure 12.

The cartridge 2606 may be provided terminally sterilized (e.g. via gamma, ethylene oxide, etc.). When the cover 2992 is in place on the cartridge 2606, the seal between the cartridge sealing member 2994 and cover 2992 may ensure the interior of the cover 2992 and unexposed portions of the cover 2992 remain sterile. The portion of the cartridge sealing member 2994 against which the cover 2992 seals may also be maintained sterile. As these regions are in a sterile state before removal of the cover 2992, the environment on the interior of the enclosure 12 may not be negatively impacted when the cover 2992 is doffed from the cartridge 2606. Thus, the air flow path 2802 and dispensing sharp 2604 of the cartridge 2606 may be introduced into the interior of the enclosure 12 in aseptic manner.

A cartridge 2606 may also be aseptically removed from the filling station 2600 with the example arrangements described herein. The cover displacement assembly 3058 of the cover removal assembly 3050 may displace the cover 2992 back into engagement with the cartridge 2606 (into the state depicted and described in relation to FIG. 92). In this position, the interior sidewall 3070A of the sealing member 3066 of the cover removal assembly 3050 may continue to isolate the bay 3054 and received portion of the cover 2992 from the remainder of the system 10. The exterior sidewall 3070B may establish a seal isolating the interior of the enclosure 12 from the exterior of the enclosure 12. The cartridge 2606, with a reinstalled cover 2992, may then be displaced by the cartridge displacement assembly 3032 to an exchange position. The seal between the cartridge sealing member 2994 and the enclosure 12 may be eliminated as the cartridge 2606 is brought to the exchange position (see, e.g., FIG. 91A). Isolation between the exterior of the enclosure 12 and interior of the enclosure 12 may be maintained by the seal created between the exterior sidewall 3070B of the sealing member 3066 and the walls 3072 of the fenestration 3074.

Referring now to FIG. 93, a cross-sectional view of a portion of a fill station 2600 with a cover engagement assembly 3060 engaged with a cover 2992 is depicted. As shown, the cover engagement assembly 3060 may include an engagement catch 3062. The cover 2992 may include a cover catch 2996. The engagement catch 3062 is in the shape of a hook and the exemplary cover catch 2996 is a bridge of material extending proud of the exterior surface 3076 of the cover 2992. The cover catch 2996 may be a pocket or recess in alterative examples. The hook may be displaced under the bridge of material to place the cover engagement assembly 3060 into an engaged state with the cover 2992 in the example embodiment. As shown, the hook may include a ramped face 3082. Thus, the hook may taper thicker as distance from its unsupported end increases. As the hook is driven into the cover catch 2996, the cover 2992 may be cinched up against the sealing member 3066 of the cap removal assembly 3050. This may help to ensure the seal generated between the cover 2992 and the sealing member 3066 is robustly formed.

As mentioned above, in certain embodiments, the bay 3054 may be negatively pressurized and the pressure in the bay 3054 may be monitored by at least one pressure sensor 3051. Data from the pressure sensor 3051 may be analyzed by the control system 15 to verify an acceptable seal has been formed. The negative pressure within the bay 3054 may also assist in holding the cover 2992 firmly against the sealing member 3066. Data from the engagement catch position sensors 3053A, B (see, e.g., FIG. 88B) may be monitored to ensure the engagement catch 3062 is in an engaged state with the cover catch 2996. For example, in some embodiments, the engagement catch 3062 may have an over-travel position which would be reached in the event the cover catch 2996 does not present an interference. The control system 15 may prevent an attempt to remove the cover 2992 in the event data from the engagement catch position sensors 3053A, B indicates the engagement catch 3062 is in the over-travel position (or failed to displace from its retracted state, or is not within an expected position range). In some embodiments, the control system 15 may command one or more retry actuations of the cover engagement assembly 3060 (up to an allotted cap) before generating a notification.

Referring now to FIG. 94, a cross-sectional view is depicted of a portion of a fill station 2600 where the cover 2992 has been removed from a cartridge 2606 in an access position. As discussed above in relation to FIGS. 91A-92, the air flow channel 2802 and dispensing sharp 2604 may be exposed to the interior environment of the enclosure 12 in an aseptic manner when the cover 2992 is removed from the cartridge 2606. Once the air flow channel 2802 is accessible, a clean air output 3090 (best shown in FIG. 98) may be displaced against an upstream end of the air flow channel 2802. In certain embodiments, the clean air output 3090 may include a tapered end 3092 which seats against the upstream end of the air flow channel 2802. In some examples, a sealing member may be included on one or both of the tapered end 3092 and upstream end of the air flow channel 2802. Depending on, for example, the pressure and flow rate desired through the air flow channel 2802, sealing member(s) may be omitted.

Clean air may be provided to the processing chamber 4300 and clean air output 3090 from a laminar air flow source. Clean air may flow from the clean air output 3090 and through the air flow channel 2802 in a highly laminar character. The pressure, flow rate, particle count, etc. of the clean air passing through the air flow channel 2802 may be equivalent to requirements of a desired clean room standard (e.g. ISO 5 set points). Thus, the air flow channel 2802 may be held to a stringent level of environmental control. This level may, moreover, be more stringent than that imposed on the interior volume of the enclosure 12 with which the air flow channel 2802 communicates. Thus, a small fill zone volume which is under relatively strict environmental control may be established.

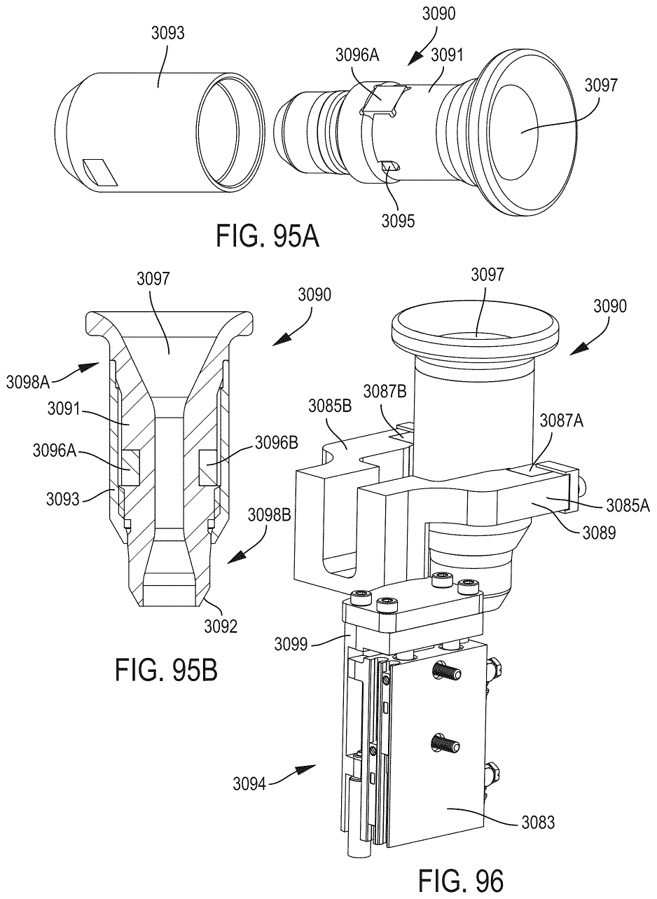

Referring now to FIGS. 95A-B, an exemplary clean air output 3090 is depicted. As shown, the clean air output 3090 may include a main body 3091 covered by a sleeve 3093. A set of magnets 3096A, B and a tracking body 3095 may be coupled to the main body 3091. The tracking body 3095 may be magnetic or ferromagnetic in certain examples. A bore 3097 may extend through the main body 3091. The bore 3097 may taper from a largest diameter at a first end region 3098A to a smallest diameter. The bore 3097 may taper from the smallest diameter to an intermediate diameter at a second end region 3098B opposite the first end region. The bore 3097 may be maintained at the smallest diameter through a portion of the main body 3091 intermediate the first and second end region 3098A, B. The diameter of the bore 3097 may be substantially constant over the region where the tapered end 3092 of the main body 3091 extends. Thus the bore 3079 may be arranged as a Venturi which increases flow rate while decreasing pressure. This may assist in keeping flow substantially laminar as passes through an airflow channel 2802 of a cartridge 2606 and into the processing chamber 4300.

Referring now also to FIGS. 96-98, the clean air output 3090 may be displaced via clean air output actuation assembly 3094 through a non-contact coupling. The clean air output actuation assembly 3094 may include a displacement stage 3099 with a yoke body 3089 coupled thereto. The displacement stage 3099 may be translationally displaced by a pneumatic actuator 3083 (though any other variety of actuator may be utilized). The yoke body 3089 may include a set of arms 3085A, B each including a respective magnet 3087A, B of the clean air output actuation assembly 3094. As the displacement stage 3099 is displaced, the clean air output 3090 may displace in tandem due to the magnetic attraction between the magnets 3096A, B of the clean air output 3090 and the magnets 3087A, B on the yoke body 3089.

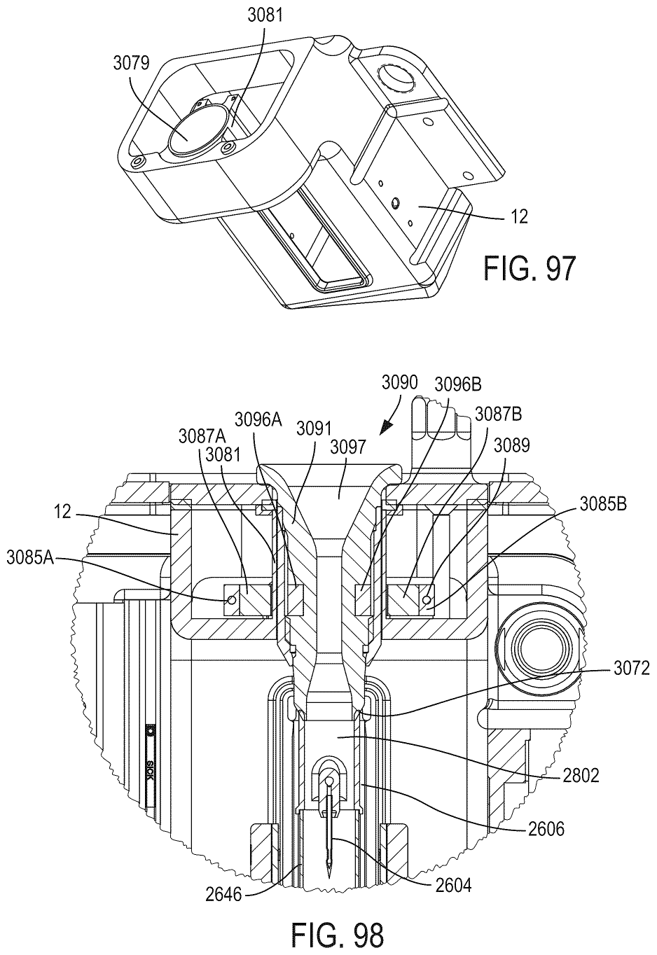

Referring now primarily to FIGS. 97-98, the enclosure 12 of the system 10 may be disposed intermediate the yoke body 3089 and the clean air output 3090. Thus, the clean air output actuation assembly 3094 may be disposed outside of the processing chamber 4300 and displace the clean air output 3090 inside the processing chamber 4300 through the enclosure 12 wall. A portion of the enclosure 12 is depicted in FIG. 97. A clean air output guide 3081 may be defined in the enclosure 12. The guide 3081 may include an interior passage 3079 with a diameter slightly larger than the outside diameter of the sleeve 3093 of the clean air output 3090. The clean air output 3090 may displace within this interior passage 3079. The yoke body 3089 may travel along the exterior surfaces of the guide 3081. The guide 3081 may be sufficiently thin that a robust magnetic coupling through the guide 3081 is created between the yoke body 3089 and the clean air output 3090.

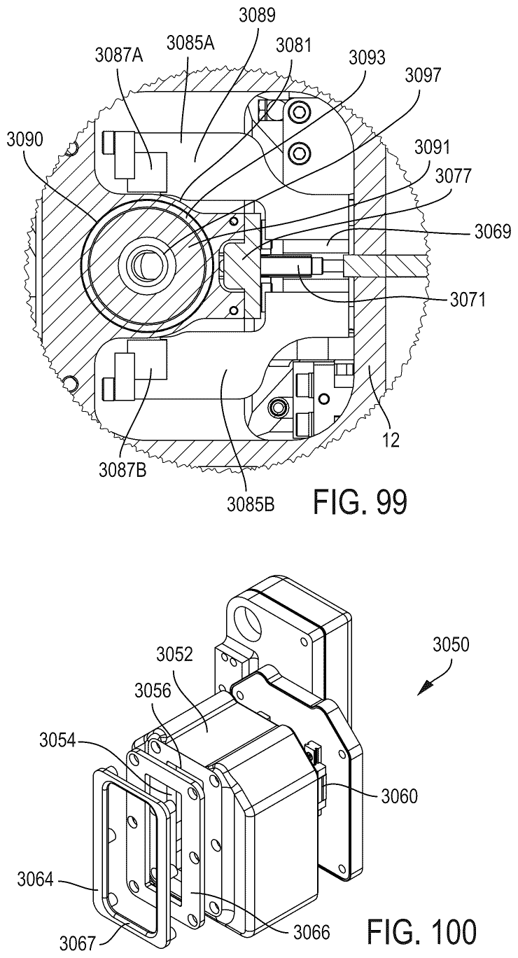

Referring now also to FIG. 99, the clean air output 3090 may be displaced between a raised position and a lowered position (see, e.g., FIG. 98) by displacing the yoke body 3089 via the pneumatic actuator 3038. In the raised position, the clean air output 3090 may provide clearance for a cover removal assembly 3050 to displace toward and away from a cartridge 2606. In the lowered position, the tapered end 3092 of the clean air output 3090 may be seated against the end of the air flow channel 2802 of the cartridge 2606. A sensor mount 3077 may be coupled to the guide 3081. One or more clean air output sensor 3071 may be coupled to the sensor mount 3077. The clean air output sensor(s) 3071 may be inductive sensors which generate an output signal which varies as the tracking body 3095 displaces. In some embodiments, a first clean air output sensor 3071 may be included substantially in line with the position of the tracking body 3095 when the clean air output 3090 is in the lowered position. A second clean air output sensor 3071 may be included and be substantially in line with the position of the tracking body 3095 when the clean air output 3090 is in the retracted or withdrawn position. The control system 15 may govern operation of the pneumatic actuator 3038 based on the output signals from the clean air output sensors 3071. The control system 15 may generate a fault if the clean air output sensors 3071 fail to register displacement of the clean air output 3090 when the actuator 3038 is powered. The yoke body 3089 may include a recessed channel 3069 which provides clearance for the clean air output sensors 3071 over the stroke of the yoke body 3089 between the raised and lowered positions.

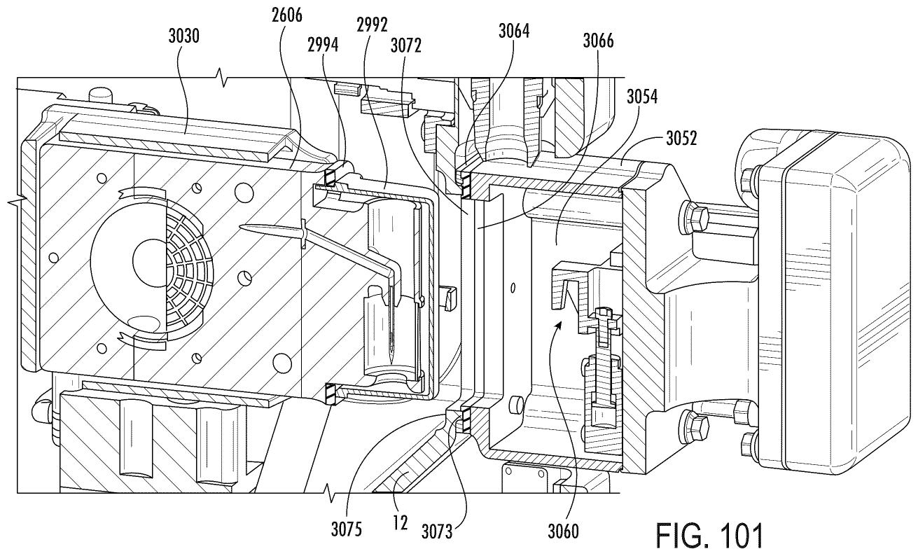

Referring now to FIG. 100, a portion of an example alternative cover removal assembly 3050 is depicted. The cover displacement assembly 3058 is hidden in FIG. 100 for sake of illustration, but may be the same as that depicted in FIGS. 881A-B. As shown, the housing 3052 may include a sealing member 3066 which is substantially planar. The sealing member 3066 may be coupled to the housing 3052 via a retainer plate 3064 and fasteners (though could alternatively be overmolded to the housing 3052). The retainer plate 3064 may include a central aperture 3067 which leaves a portion of the sealing member 3066 adjacent the bay ingress 3056 of the housing 3052 exposed. The walls of the central aperture 3067 may be chamfered or rounded.

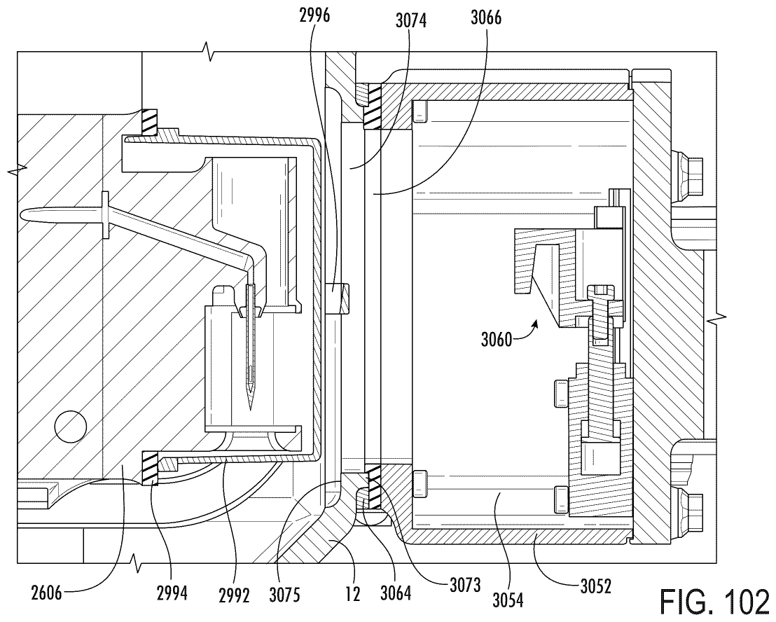

Referring now to FIGS. 101-102, cross-sectionals view of a portion of an example fill station 2600 are depicted. As shown, a cartridge 2606 is in place on the cartridge mount 3030, but has yet to be advanced to the access position. The cover removal assembly 3050 is that depicted in FIG. 100. As shown, the cover removal assembly 3050 may be advanced (via commands from the control system 15 to a cover displacement assembly 3058) to form a seal with respect to the enclosure 12. The example enclosure 12 includes a fenestration 3072 with a raised wall 3073 surrounding the periphery of the fenestration 3072 on the interior side of the enclosure 3072. The sealing member 3066 of the cover removal assembly 3050 may compress against the raised wall 3073 to establish seal which isolates the interior of the enclosure 12 from the exterior of the enclosure 12. As shown, the edge of the raised wall 3073 most distal the fenestration 3072 may be contoured to match the central aperture 3067 of the retaining plate 3064. When the sealing member 3066 is in a sealing relationship with the raised wall 3073, a portion of the sealing member 3066 immediately adjacent the bay ingress 3056 to the bay 3054 of the housing 3052 may remain exposed.

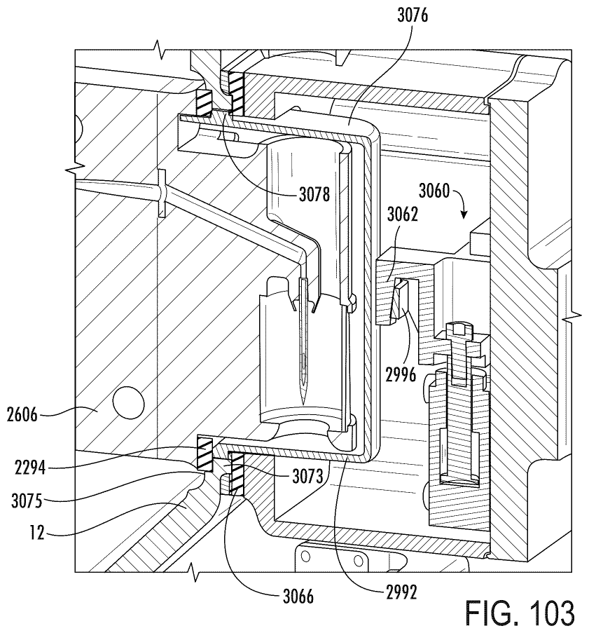

Referring now to FIG. 103, as the cartridge 2606 is advanced to the access position by the cartridge displacement assembly 3032, the sealing member 2994 of the cartridge 2606 may compress against a sealing surface 3075 of the enclosure 12. The sealing surface 3075 may surround the fenestration 3072. As the sealing member 2994 compresses against the sealing surface 3075 a seal which isolates the exterior of the enclosure 12 from the interior of the enclosure 12 may be formed. The exposed region of the sealing member 3066 on the housing 3052 of the cover removal assembly 3050 may compress against a face of a protrusion 3078 on the exterior surface 3076 of the cover 2992. The cover engagement assembly 3060 may be actuated via a command from the control system 15 to drive the engagement catch 3062 into an engaged state with the cover catch 2996. The control system 15 may then command displacement of the cover displacement assembly 3058 (see, e.g., FIG. 88A) to remove the cover 2992 from the cartridge 2606.

Referring now to FIG. 104, once the cover 2992 has been removed from the cartridge 2606, the seal between the sealing member 3066 on the housing 3052 of the cover removal assembly 3050 and the raised wall 3073 may be absent. The exterior of the enclosure 12 is still prevented from communicating with the interior of the enclosure 12 by the seal formed between the cartridge sealing member 2994 and the sealing surface 3075. Portions of the cover 2992 exposed to the environment on the exterior of the enclosure 12 are sealed within the bay 3054 of the housing 3052 of the cover removal assembly 3050 by the seal between the sealing member and the cover 2992 protrusion 3078.

Referring now primarily to FIG. 105, the irradiation assembly 2608 of the fill station 2600 may be displaceable between a retracted positions (shown in, e.g., FIG. 94) and a deployed position (shown in FIG. 105). The irradiation assembly 2608 may be coupled to an actuation assembly 3139 which may be commanded, via the control system 15, to displace the irradiation assembly 2608. Commands from the control system 15 may be based on a data signal from at least one position sensor 3137 monitoring the position of the irradiation assembly 2608. The irradiation assembly 2608 may be retracted so as to not infringe on the displacement path of the housing 3052 of the cover displacement assembly 3050 when a cartridge 2606 is being installed or exchanged. Once a cartridge 2606 is in the access position and the cover 2992 has been removed, the irradiation assembly 2608 may be displaced to the deployed position. In the deployed position the light emitters 2610 of the irradiation assembly 2608 may be aligned with the barrier 2646 (see, e.g., FIG. 104) of the cartridge 2606. In some embodiments, the light emitters 2610 may be mounted on a rigid flex PCB including a span of slack which may support displacement of the irradiation assembly 2608 between the retracted and deployed positions.

Referring now to FIGS. 106A-B, once a cartridge 2606 has been displaced to the access position, the connection port 2812 of the cartridge 2606 may be placed in fluid communication with a fluid source 2810 (see, e.g., FIG. 70). As shown in FIG. 106A, a fill station 2600 may include a supply manifold 2820 including a receptacle 2818 for receiving the connection port 2812. The supply manifold 2820 may be disposed on the exterior of the enclosure 12. The supply manifold 2820 may be coupled to a manifold displacement assembly 2821 (see, e.g., FIG. 87). The receptacle 2818 may include a spike 2822 at an end thereof. A disinfect outlet channel 2824 may also be included in the sidewall of the receptacle 2818.

Referring primarily to FIG. 106A, the supply manifold 2820 may be displaced toward the connection port 2812 until the connection port 2812 is in a partially received state within a receptacle 2818 of the supply manifold 2820. Displacement of the supply manifold 2820 may be governed by commands to the manifold displacement assembly 2821 generated by the control system 15. When in the partially received state, the frangible 2816 of the connection port 2812 may be positioned such that the disinfect outlet channel 2824 is intermediate the frangible 2816 and the spike 2822. A first sealing member 2814A of the connection port 2812 may form a seal against the sidewall of the receptacle 2818. Disinfect fluid may be passed through the receptacle 2818 and out of the disinfect outlet channel 2824 for a predefined period of time. In certain examples, the disinfect fluid may be injection quality water which has been heated to at least 60° C. This may disinfect portions of the connection port 2812 and receptacle 2818 before fluid communication with the sterilized interior of the cartridge 2606 is established.

In various examples, one or more fluid characteristic sensors 4054B, 4056 (see, e.g., FIG. 87) may be included in the supply manifold 2820. At least one temperature sensor may for example be included. Data from any temperatures sensors may be monitored by the control system 15 to ensure the disinfection fluid is maintained in a desired temperature range. In the event data from any temperature sensors indicates that the disinfect fluid temperature does not conform to the desired range, the control system 15 may generate an alert and/or prolong the time period which disinfect fluid is passed through the receptacle 2818. The fluid characteristic sensors 4054B, 4056 may include at least one pressure sensor in certain examples. A pressure sensor may provide information indicative of the state of a filter 2609 (see, e.g., FIG. 81B) of the cartridge 2606. If a pressure sensor outputs a signal outside of an expected range, the control system 15 may determine the filter 2609 requires replacement (e.g. has fouled). The control system 15 may generate an alert and require replacement of the cartridge 2606 before further bags 26 may be filled by the system 10. The fluid characteristic sensors 4054B, 4056 may include at least one conductivity sensor in certain examples. Data from any conductivity sensors may be monitored by the control system 15 to ensure the fluid entering the receptacle or cartridge 2606 conforms to preset conductivity criteria. In the event data from any conductivity sensors indicates that the fluid does not conform to the conductivity criteria, the control system 15 may generate an alert. Additionally, the control system 15 may ensure that any bag 26 which received the non-conforming fluid is handled so as to inhibit its use (e.g. labeled as rejected and/or segregated from other bags 26).

Referring now also to FIG. 106B, after flow of disinfection fluid through the receptacle 2818 and over the connection port 2812, the supply manifold 2820 may be displaced toward the cartridge 2606 until the connection port 2812 is in a fully installed position within the receptacle 2818. As this occurs, the spike 2822 may puncture the frangible 2816 sealing the connection port 2812. This may place the fluid source 2810 (see, e.g., FIG. 70) in fluid communication with the dispensing sharp 2604 through the cartridge 2606. The sealing members 2814A, B of the connection port 2812 may advance along the receptacle 2818 as the connection port 2812 is brought to the fully installed position. In this position, the disinfect outlet channel 2824 may be upstream of the sealing member 2814A, B and flow from the spike 2822 to the disinfect outlet channel 2824 may be inhibited.

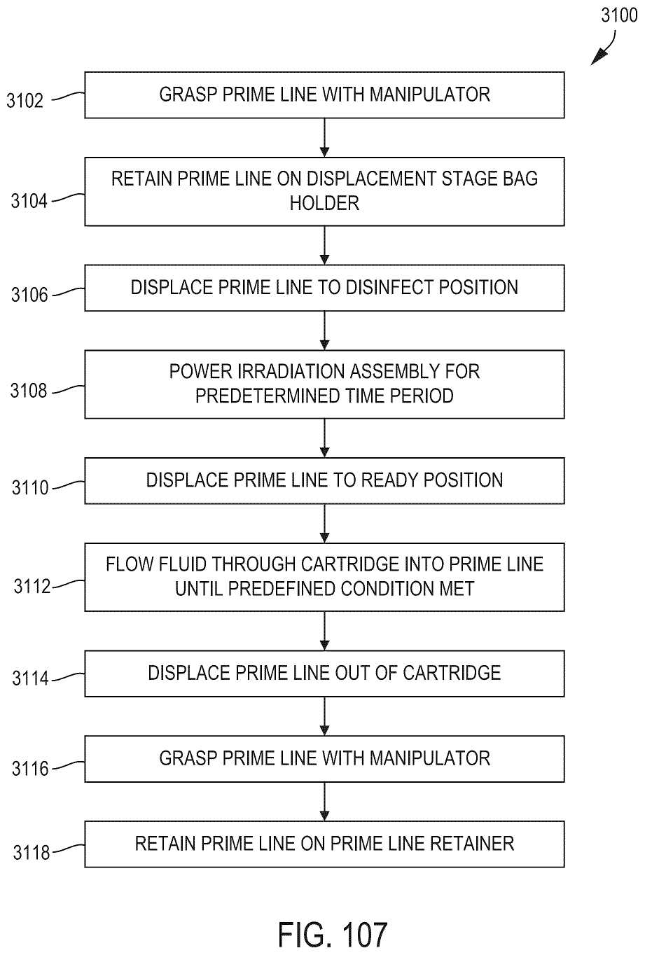

Referring now to FIG. 107, a flowchart 3100 detailing a number of example actions which may be executed to prime a freshly installed cartridge at a fill station 2600 is depicted. As shown, in block 3102 a priming line 3120 within the enclosure 12 may be grasped by a robotic gripper or manipulator (see, e.g., bag retainer assemblies 4306 of FIG. 47A). The priming line 3120 may be displaced to and retained on a displacement stage 3142 in block 3104 (see, e.g., FIG. 111). The priming line 3120 may be displaced, in block 3106, to a disinfect position. In block 3108, an irradiation assembly 2608 may be powered for a predetermined period of time. The prime line 3120 may be displaced to a priming position in block 3110 (see, e.g., FIG. 112). Fluid may be delivered through the cartridge 2606 and into the priming line 3120 through the dispensing sharp 2604 of the cartridge 2606 in block 3112. In some examples, a predetermined volume of fluid (based on data from a flow meter) may be delivered through the cartridge 2606 and into the priming line 3120. The priming line 3120 may be displaced out of the cartridge 2606 in block 3114. In block 3116, the prime line 3120 may be grasped by the robotic gripper or manipulator and removed from the retainer on the displacement stage 3142. The prime line 3120 may be returned to a prime line holder or dock in block 3118.

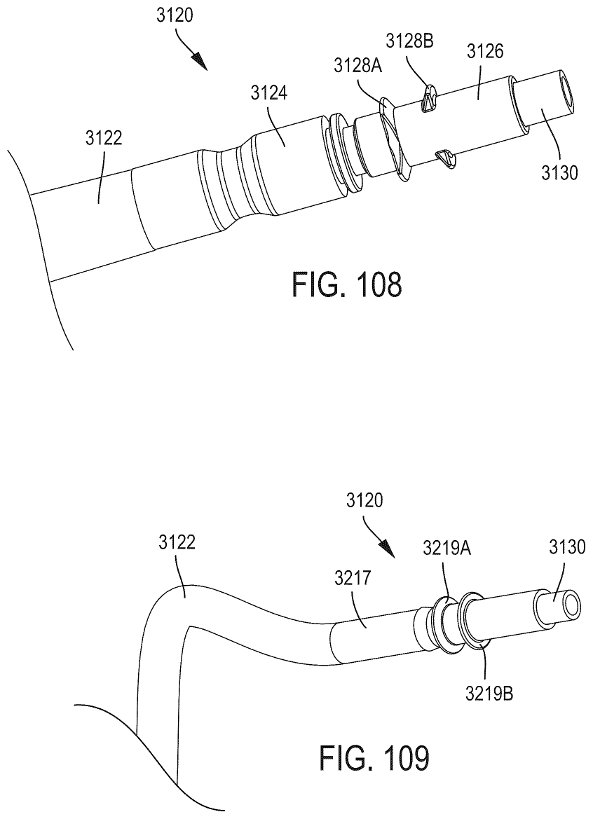

Referring now to FIG. 108, a perspective view of an example prime line 3120 is depicted. As shown, the prime line 3120 may include a section of flexible tubing 3122 which extends from a discard destination (e.g. drain or the input to the water treatment system, see, FIGS. 192A-B). The section of tubing 3122 may be coupled to a prime port hub 3124. A port replica 3126 may be coupled to and extend from the port hub 3124. The port replica 3126 may be shaped to mimic ports 392 of bags 26 for use with the system 10. In the example shown, the port replica 3124 includes retention projections 3128A, B mimicking the projections included on various bag 26 embodiments shown and described herein. The port replica 3126 may be constructed of materials which differ from the port 392. The port replica 3126 may, for instance, be constructed of rigid plastic, ceramic, metal, glass, etc. The terminal end of the prime line 3120 may be formed by a section of tubing 3130. The section of tubing 3130 may be formed of a UVC transparent or at least substantially transmissive material. In some examples, the section of tubing 3130 may be formed of the same material as the barrier 2646 of various cartridges 2606 described herein. Fused quartz or fused silica may be used to for the section of tubing 3130.

An alternative example prime line 3120 is depicted in FIG. 109. In place of a prime port hub 3124 and a port replica 3216, some example prime lines 3120 may include an elongate hollow body 3217 having a spaced set of ribs 3219A, B. The elongate hollow body 3127 may be constructed of rigid plastic, ceramic, metal, glass, etc. The ribs 3219A, B may from rings which project outwardly from the elongate hollow body 3217. The ribs 3219A, B may assist in retention of the prime line 3120 by a holder or automation end effector (see, e.g., bag retention assembly 4306 of FIG. 47B). Including ribs 3219A, B which encircle the elongate hollow body 3217 may allow the prime port 3120 to be grasped without concern for the rotational orientation of the prime port 3120 about the axis of the elongate hollow body 3217. A section of tubing 3130 (e.g. fused quartz) like that described in relation to FIG. 108 may extend from the terminal end of the elongate hollow body 3217 opposite that coupled to the section of tubing 3122.

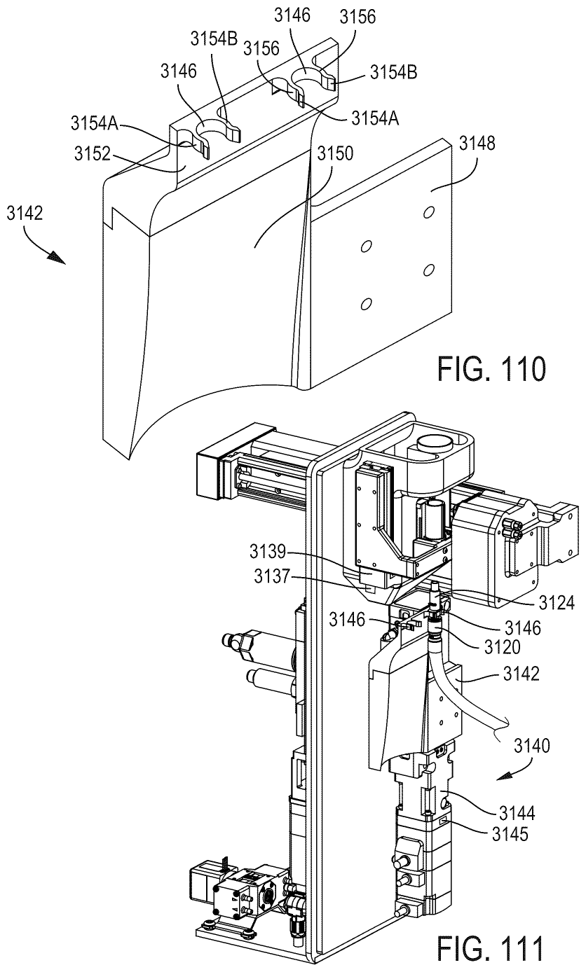

Referring now to FIG. 110-111, a perspective view of a fill displacement stage 3142 and an example fill station 2600 with a prime line 3120 retained on the fill displacement stage 3142 are respectively depicted. The fill displacement stage 3142 may be part of a bag displacement assembly 3140 including a bag displacement actuator 3144. The fill displacement stage 3142 may be coupled to the bag displacement actuator 3144 via a mounting plate 3148. The fill displacement stage 3142 may include support plate 3150 which may be shaped to cradle a filled bag 26. The bag displacement actuator 3144 may include an electromagnetic brake which may be engaged when a filled bag 26 in place on the fill displacement stage 3142. A position sensor 3145 which generates a signal which alters in relation to the position of the fill displacement stage 3142 may be included. For example, a motor encoder may be provided in association with the fill displacement actuator 3144.

Referring primarily to FIG. 110, at least one port retainer 3146 may also be included on the fill displacement stage 3146. In the example embodiment, two port retainers 3146 are depicted though the number of port retainers 3146 may typically match the number of ports 392 on bags 26 used by the system 10. The port retainers 3146 may passively hold ports 392 of a bag 26 which has been placed at the fill station 2600. As the prime line 3120 includes a port replica 3124, the port retainers 3146 may also passively hold the prime line 3120 in place as if it is a bag 26 port 392. Prime lines 3120 with annular ribs 3219A, B may similarly be passively retained. The following description of the fill displacement stage 3142 will refer to ports 392 for sake of brevity, but it should be understood that prime limes 3120 may be held in like manner by port retainers 3146.

In the example, each port retainer 3146 includes a pair of arms 3154A, B which are cradle shaped and able to clip around a port 392 installed in a port retainer 3146. The arms 3154A, B may splay outward from one another as a port 392 is pressed in between their unsupported ends. Thus the unsupported ends of the arms 3154A, B may from guide regions which assist in directing ports 392 into the port retainers 3146. The distance between the arms 3154A, B adjacent the guides regions may be smaller than the outer diameter of a port 392. The arms 3154A, B may be spread apart and/or a port 392 may be distorted as a port 392 is installed in a port retainer 3146. This may help prevent inadvertent dislodgement of a port 392 from a port retainer 3146 as some force may be required to remove the port 392 from the port retainer 3146. Additionally, the port retainers 3146 may include rest surfaces 3156. In the example embodiment, the rest surfaces 3156 are the top faces of the arms 3154A, B. When installed within a port retainer 3146, a retention projection 140 a port 392 (see, e.g., FIG. 21E) may abut against the rest surfaces 3156. This may create a mechanical interference which prevents a bag 26 from displacing in a direction parallel to the axial dimension of a port 392. Ribs 3219A, B of a prime line 3120 may similarly prevent axial displacement of the prime line 3120. In alternative embodiments, one or more active gripper (e.g. a pneumatically powered gripper) may be included on the displacement stage 3142 and may be opened and closed to grasp ports 392 or the prime line 3120.

Referring now primarily to FIGS. 111-112, with the prime line 3120 retained on the fill displacement stage 3142, the prime line 3120 may be displaced into the air flow channel 2802 of a cartridge 2606. Though not shown, the clean air output 3090 (see, e.g., FIG. 94) may be in place and clean air may be flowing through the air flow channel 2802 to achieve the desired level of environmental control in the fill zone volume. Before transferring fluid into the cartridge 2606 to prime the cartridge 2606, the prime line 3120 may be brought to a disinfect position. In the disinfect position the tubing section 3130 may be spaced from the dispensing sharp 2604. The irradiation assembly 2608 may be powered for a predetermined period of time to irradiate the tubing section 3130. The fill displacement stage 3142 may then be actuated to advance the tubing section 3130 over the dispensing sharp 2604 to a cartridge priming position. When the prime line 3120 is in the cartridge priming position, fluid may be delivered to the cartridge 2606 to prime the cartridge 2606. Any priming fluid which exits the cartridge 2606 via the dispensing sharp 2604 may be received by the prime line 3130 and directed to a discard destination through the tubing 3122 of the prime line 3120. In various examples, the control system 15 may command fluid to be delivered to the cartridge 2606 until a flow meter indicates at least a predefined volume of priming fluid has been dispensed to the cartridge 2606.

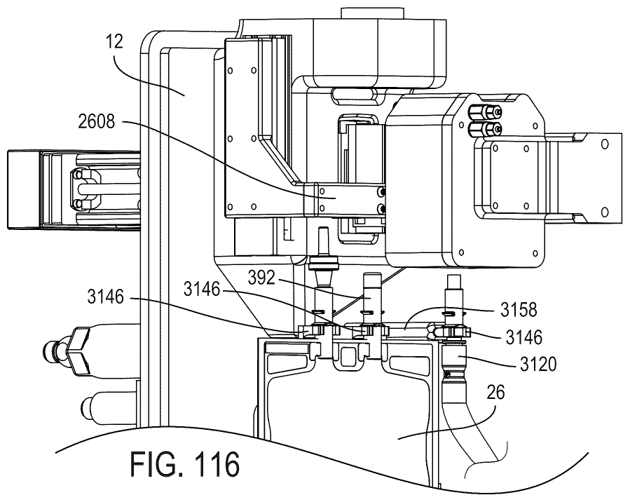

Referring now primarily to FIG. 116, once a cartridge 2606 has been primed, bags 26 may be filled by transferring fluid through the cartridge 2606 into a bag 26. As shown, the prime line 3120 may be withdrawn from the cartridge 2606 and placed on a prime line retainer 3158 once priming is complete. The prime line retainer 3158 may include a port retainer 3146 of the variety described above in relation to FIG. 110. The prime line 3130 may be collected from the fill displacement stage 3142 and stowed in the prime line retainer 3158 by a robotic gripper or manipulator (see, e.g., bag retention assembly 4306 of FIG. 47A).

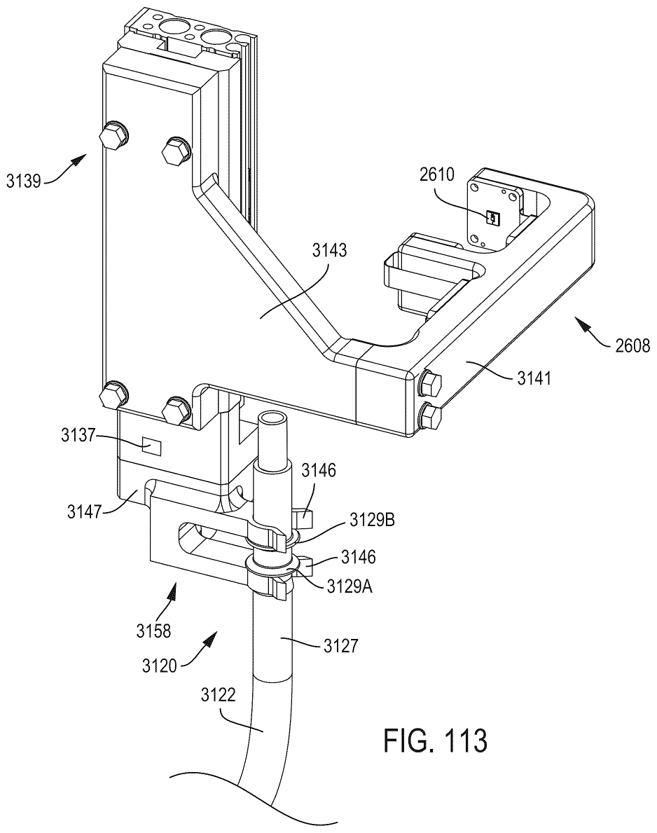

Referring now to FIG. 113, in certain examples, the prime line retainer 3158 may be coupled to the irradiation assembly 2608. As shown, the irradiation assembly 2608 includes an arm 3141 which is coupled to a displacement stage 3143 of the actuation assembly 3139. The prime line retainer 3158 includes a set of port retainers 3146 which extend from a base body 3147 coupled to the displacement stage 3143. As the actuation assembly 3139 is commanded to displace, the prime line retainer 3158 (and prime line 3120 if retained therein) will displace in tandem with the displacement stage 3143. This may, among other benefits, simplify routing and draining of the tubing segment 3122 of the prime port 3120. The port retainers 3146 may be spaced such that the ribs 3129 may be positioned between the port retainers 3146 when the prime line 3120 is retained on the prime line retainer 3158. The spacing between the most proximal faces of the opposing port retainers 3146 may be slightly greater (e.g. 5% or less) than the spacing between the greatest distance between the faces of the ribs 3129A, B. This may inhibit axial displacement of the prime line 3120.

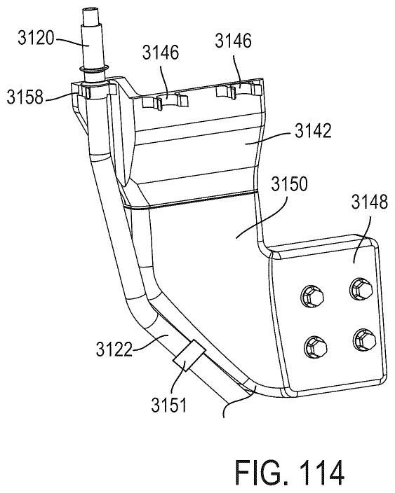

Referring now to FIG. 114, in still other embodiments, the prime line retainer 3158 may be formed as part of the fill displacement stage 3142 of a fill displacement assembly 3140. In some examples, the prime line retainer 3158 may be formed integrally to the fill displacement stage 3142. In such embodiments, the prime line 3120 may displace with the displacement stage 3142. It may also conveniently be ensured to be at even height with the port retainers 3146 on the fill displacement stage 3142. A clip, tether, or constraint member 3151 may be included as part of the fill displacement assembly 3140 to hold or route the tubing 3122 of the prime line 3120 in a desired manner. The constraint member 3151 in the example holds the tubing 3122 adjacent a support plate of the fill displacement assembly 3140. The constraint member 3151 may allow enough displacement of the prime line 3120 that it may be swapped between a port retainer 3146 on the fill displacement stage 3142 and the prime line retainer 3158.

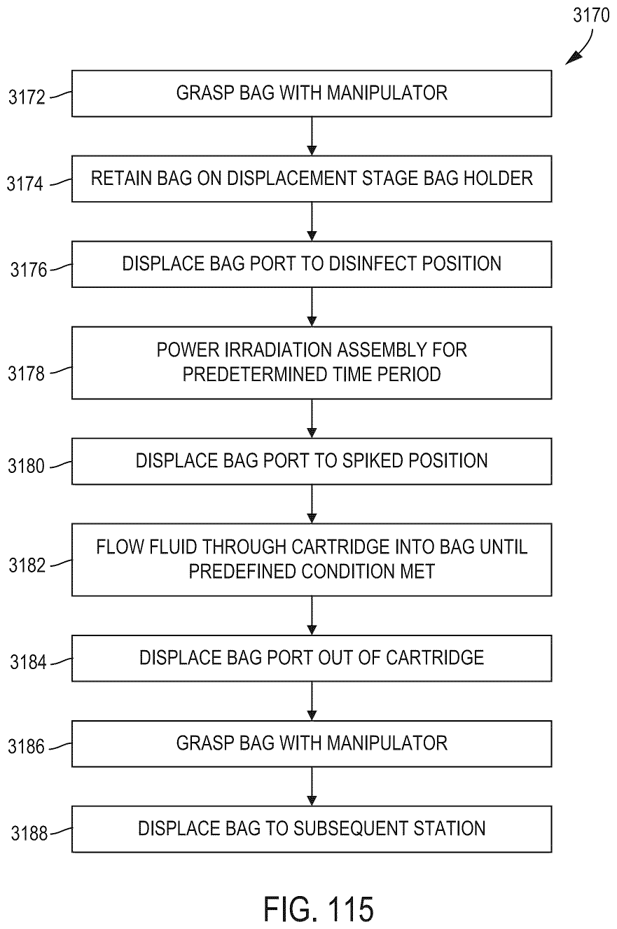

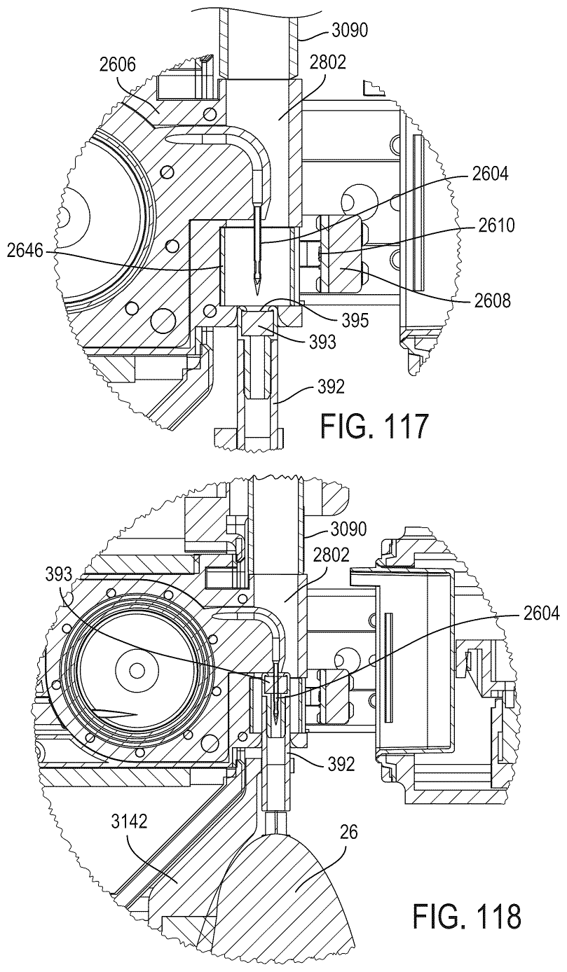

Referring now to FIG. 115, a flowchart 3170 detailing a number of example actions which may be executed to fill a bag 26 is depicted. As shown, in block 3172, a bag 26 may be grasped with a robotic grasper or manipulator (see, e.g., bag retention assembly 4306 of FIG. 47A). The bag 26 may be retained on the fill displacement stage 3142 in block 3174 (see, e.g., FIG. 116). The ports 392 of a bag 26 may, for example, be pressed into port retainers 3146 on the fill displacement stage 3142 to retain the bag 26 on the fill displacement stage 3142. In block 3176, a port 392 of the bag 26 may be displaced to a disinfect position (see, e.g., FIG. 117). The disinfect position may be a position in which the exposed surface 395 of the septum 393 of the bag 26 has been introduced into the air flow channel 2802 and is spaced from the dispensing sharp 2604. The control system 15 may command actuation of the bag displacement actuator 3144 to displace the bag 26 until the port 392 reaches the disinfect position. The irradiation assembly 2608 may be powered for a predetermined period of time in block 3178. The port 392 may be displaced to a spiked position in block 3180 (see, e.g., FIG. 118). Again this may be orchestrated via commands to the bag displacement actuator 3144 generated by the control system 15. Fluid may be delivered into the bag 26 through the dispensing sharp 2604 in block 3182. This may be done until a predefined condition has been met (e.g. the signal from a flow meter indicates a predefined volume of fluid has been dispensed). In block 3184, the port 392 of the bag 26 may be withdrawn from the cartridge 2606. This may be accomplished by commanding actuation of the bag displacement actuator 3144 with the control system 15. The ports 392 of the bag 26 may be grasped by a robotic grasper or manipulator in block 3186. The bag 26 may then be displaced to a subsequent station within the system 10 in block 3188.

Referring now to the progression of FIGS. 116-118, a bag 26 is shown being displaced from an initial position after being retained by the port retainers 3146 to a spiked position. Though not depicted in FIGS. 116-118, a clean air outlet 3090 (see, e.g., FIG. 97) may be in place and clean laminar air may be flowing through the air flow channel 2802 of the cartridge 2606 as described elsewhere herein. As shown in FIG. 117, when the bag 26 is displaced by the bag displacement actuator 2144 toward the cartridge 2606, a port 392 of the bag 26 may enter the downstream end of the air flow channel 2802. The exposed portion 395 of the septum 393 in the port 392 may be in the field of illumination of the light emitters 2610 of the irradiation assembly 2608 when the port 392 is in the disinfect position. The port 392 may be illuminated by the irradiation assembly 2608 for a period of time and the port 392 may then be displaced into the dispensing sharp 2604. Fluid may be dispensed through the cartridge 2606 into the bag 26 until the bag 26 is filled as shown in FIG. 118.

The fill station 2606 may continue to fill bags 26 with the installed cartridge 2606 until the cartridge 2606 is to be replaced. The cartridge 2606 may be swapped on a usage based schedule. The control system 15 may, for example, monitor the number of septa 393 pierced by the dispensing sharp 2604 and may require the cartridge 2606 be exchanged after a predefined threshold number of bags 26 have been filled. In some examples, the control system 15 may also require that the cartridge 2606 be exchanged if a predetermined period of time has elapsed since a cartridge 2606 was installed in the fill station 2600. The control system 15 also require the cartridge 2606 be exchanged in the event that certain fault conditions are determined to be present. For example, if an occlusion is detected downstream of the supply manifold 2820 (see, e.g., FIG. 106A), the control system 15 may require the existing cartridge 2606 be replaced. The control system 15 may receive flow rate and pressure data from sensors monitoring the flow of fluid to the cartridge 2606. The control system 15 may generate an alert and/or require a filter be replaced in the event that analysis of this data indicates that the filter 2609 has failed or become fouled. A failed filter 2609 may be determined in the event that a target flow rate may be achieved at a pressure which is below an expected threshold. A fouled filter 2609 may be detected in the event that pressure rises above a threshold or when the pressure required to maintain a target flow rate exceeds an expected threshold. The control system 15 may also require replacement of the cartridge 2606 in the event that the environment within the processing chamber 4300 does not conform to quality standards or is accessed by service personnel.

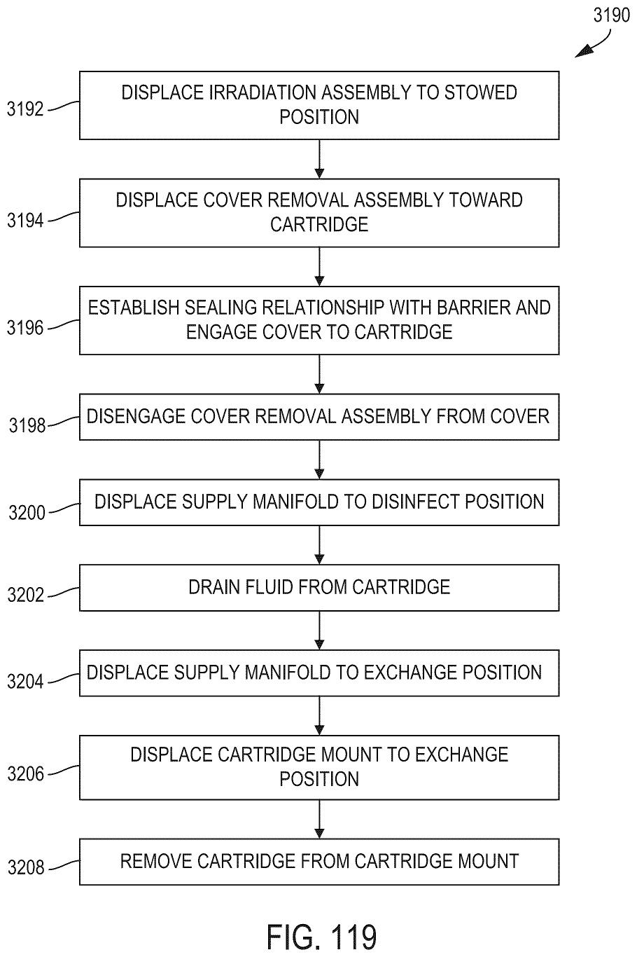

Referring now to FIG. 119, a flowchart 3190 detailing a number of example actions which may be executed to extract a cartridge 2606 from a fill station 2600 is depicted. As shown, the irradiation assembly 2608 may be displaced to a stowed position in block 3192. The housing 3052 of the cover removal assembly 3050 may be displaced toward the cartridge 2606 in block 3194. In block 3196, a sealing relationship may be established against enclosure 12 with the sealing member 3066 of the housing 3052. The cover 2992 may additionally be reengaged to and form a seal against the cartridge 2606 in block 3196. The cover removal assembly 3050 may be disengaged from the cover 2992 in block 3198. In block 3200 the supply manifold 2820 may be displaced to the disinfect position. The cartridge 2606 may be drained in block 3202. This may be accomplished by powering a pump in communication with a fluid line leading from the disinfect outlet channel 2824 of the supply manifold 2820. The supply manifold 2820 may be displaced such that the connection port 2812 is in the partially installed position in the receptacle 2818 for this purpose. In certain examples, the cartridge 2606 may not be drained. This may depend on the type of filter 2609 (if any) included in the cartridge 2606. The supply manifold 2820 may be displaced to a stowed or exchange position in block 3204. In block 3206, the cartridge mount 3030 may be displaced to the exchange position. The cartridge 2606 may be removed from the cartridge mount 3030 in block 3208.

Referring now to FIGS. 120A-C, once a bag 26 has been filled at a filling station 2600 it may be retrieved from the filling station 2600 and displaced through the processing chamber 4300 to a transfer chamber 3506 of the system 10. A top plan view of a processing chamber 4300 and transfer chamber 3506 are depicted in FIG. 120A. A filled bag 26 is shown in place at the filling station 2600 in FIGS. 120B-C(the chain 2670 is hidden). A bag 26 may be collected by the downstream displacement assembly 4304 after filling. The bag retention assembly 4306 of the downstream displacement assembly 4304 may be extended toward the fill displacement stage 4132. The jaws 4308A, B of the bag retention assembly 4306 may be closed around the ports 392 of the filled bag 26. At least one set of ribs 140 on the port 392 may be disposed above the jaws 4308A, B of the bag retention assembly 4306 (best shown in FIG. 120C). The bag retention assembly 4306 may then be displaced at least partially toward the retracted position. This may dislodge the ports 392 of the filled bag 26 from the port retainers 3146 on the fill displacement stage 3142. The ribs 140 (or other protrusions) on the ports 392 may assist in ensuring the filled bag 26 is robustly held by the bag retention assembly 4306. The ribs 140 may inhibit the bag 26 from falling through the bag retention assembly 4306 and may allow the bag retention assembly 4306 to only lightly grip the ports 392 despite the weight of the filled bag 26. This may allow greater latitude in selection of actuators for the jaws 4308A, B.

Referring primarily to FIGS. 120B-C, the doors 4700, 4702 of the transfer chamber 3506 may make a fluid tight seal against walls of the transfer chamber 3506. Each door 4700, 4702 may include a sealing member 4708 near a peripheral edge of the face 4714 of the door 4700, 4702 most proximal the wall against which it is to seal. The walls of the transfer chamber 3506 may optionally have a rib 4710 surrounding the fenestration 4712 in the wall associated with the door 4700, 4702. Each door 4700, 4702 may be pivotally displaceable. The doors 4700, 4702 may each be coupled to a respective rotary door actuator 4716 which may be powered by the control system 15 to displace the coupled door 4700, 4702. In the example, the rotary door actuators 4716 are disposed outside of the transfer chamber 3506 and transmit rotation to the doors 4700, 4702 via a sealed pass-through in the wall of the transfer chamber 3506. Preferably, the doors 4700, 4702 and associated fenestrations 4712 in the transfer chamber 3506 are keep as small as is practicable. Fenestrations 4712 may be sized to accept a bag retention assembly 4306 holding a filled bag 26 with the bag retention assembly 4306 in a fully retracted state.

As mentioned elsewhere herein, the control system 15 may prohibit both doors 4700, 4702 being in an open state at the same time. When one door 4700, 4702 is opened, the other door 4700, 4702 would be in a closed state. After a door 4700, 4702 is transitioned to a closed state, a recovery period may be imposed by the control system 15 before another door 4700, 4702 is permitted to be opened. In some examples, the recovery period may only be present (or may be longer) when the door 4700 to the processing compartment 4300 is to be opened after the door 4702 to the outfeed compartment 4202 has been closed.

Referring now to FIG. 121, the door 4700 to the transfer chamber 3506 may be actuated to an open position and the downstream displacement assembly 4304 may be driven at least partially into the transfer chamber 3506. The bag retention assembly 4306 may be in a fully retracted state as it is displaced through the fenestration 4712. The door 4700 may be opened relatively slowly so as to mitigate perturbation of airflow through the processing compartment 4300.

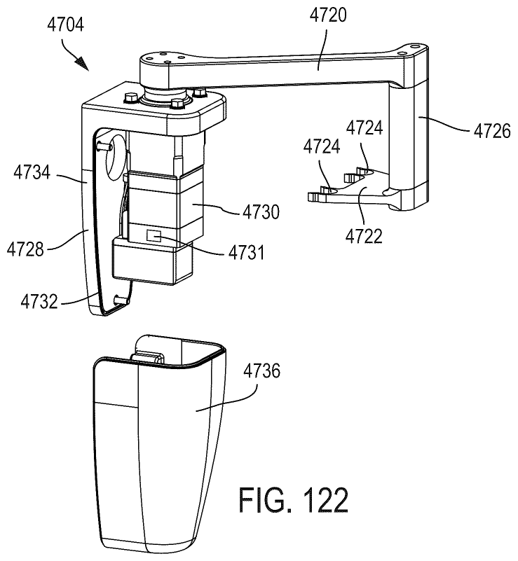

Referring now also to FIG. 122, a bag retainer 4704 may be disposed in the transfer chamber 3506. The bag retainer 4704 may include an arm 4720 to which a retention plate 4722 is coupled. The retention plate 4722 may include a set of port retainers 4724. The port retainers 4724 may be the same as the port retainers 3146 on the fill displacement stage 3142 (see, e.g., FIG. 110). In the example shown in FIG. 122, the retention plate 4722 is coupled to the arm 4720 by a standoff 4726 which disposes the port retainers 4724 slightly above or below the jaws 4308A, B of the bag retention assembly 4306 of the downstream displacement assembly 4304. Though the bag retainer 4704 is shown as including passive retention features for holding a bag 26 in alternative embodiments an actuatable gripper may be included. A pneumatically actuated set of jaws 4308A, B similar to those included in the bag displacement assembly 2618 (see, e.g., FIG. 47A) may, for example, be included.

The arm 4720 is operatively coupled with a rotary actuator 4730. The rotary actuator 4730 may include a sensor 4731 such as a motor encoder or the like which is in data communication with the control system 15. The control system 15 may generate commands to the rotary actuator 4730 based on data from the motor encoder to drive the arm 4720 and retention plate 4722 to a desired position. The rotary actuator 4730 may include a motor brake which may be engaged when the arm 4720 has been positioned as desired. As shown, the rotary actuator 4730 may be enclosed within a housing 4728 (shown exploded apart in FIG. 122). The housing 4728 may include a base 4734 and a cover 4736. A sealing member 4732 such as an o-ring or gasket may be included to ensure the interface between the base 4734 and cover 4736 is air tight. In FIG. 122, the sealing member 4732 is coupled to the base 4734.

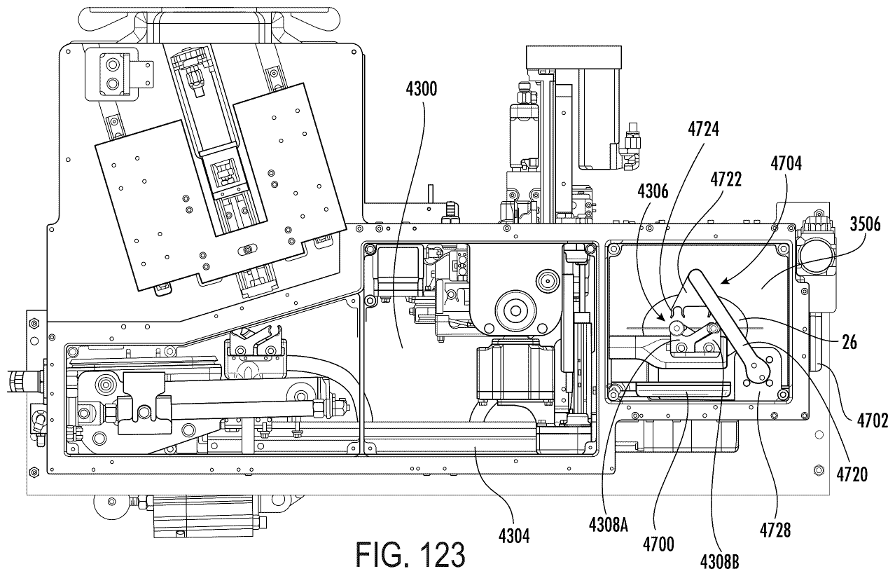

Referring now also to FIG. 123, the rotary actuator 4730 of the bag retainer 4704 may be powered to drive the retention plate 4722 to a first handoff position. In the first handoff position, the bag retainers 4724 of the retention plate 4722 are aligned with the ports 392 of the bag 26 held by the bag retention assembly 4306 of the downstream displacement assembly 4304. The bag retention assembly 4306 of the downstream displacement assembly 4304 may then be displaced to an extended state as shown in FIG. 124. This may press the ports 392 of the filled bag 26 into engagement with the port retainers 4724 of the retention plate 4722. The bag retention assembly 4306 may then be retracted away from the retention plate 4722. At least one set of ribs 140 on each port 392 may be above the port retainers 4724 of the retention plate 4722 to assist in ensuring that the fill bag 26 will not slip through the port retainers 4724.

Referring now to FIG. 125, once the filled bag 26 has been handed off to the bag retainer 4704, the downstream displacement assembly 4304 may be driven out of the transfer chamber 3506. The bag retainer 4704 may be displaced to a second handoff position. The door 4700 between the transfer chamber 3506 and processing chamber 4300 may be actuated closed. The door 4702 between the transfer chamber 3506 and outfeed compartment 4202 may then be opened (optionally after a recovery condition is met). A gripper assembly 4204 of the gantry assembly 4200 may be introduced through the fenestration 4712 associated with the door 4702. Jaws 4205A, B of the gripper assembly 4204 may be closed about the ports 392 of the bag 26 as shown in FIG. 126. The gantry assembly 4200 may then be commanded by the control system 15 to displace the filled bag 26 out of the port retainers 4724 and extract the bag 26 from the transfer chamber 3506 as shown in FIG. 127. At least one of the sets of ribs 140 on each port 392 may be disposed above the jaws 4205A, B of the gantry gripper 4204. This may assist in ensuring the bag 26 is robustly held even if loosely gripped. The door 4702 may then be actuated closed to isolate the transfer chamber 3506. The control system 15 may ensure a recovery period or a recovery condition has been met before opening the door 4700 to receive a next bag 26 from the processing chamber 4300.

Referring now to FIGS. 128A-130, a number of exemplary mix assisting assemblies 2500 and bags 26 are depicted. Mix assisting assemblies 2500 may be included in systems 10 where the bags 26 include a concentrate. The concentrate may be a solid (e.g. powder, crystalline concentrate, lyophilized medicament, etc.) or liquid (e.g. concentrated medical solution, brine, etc.). In certain implementations, a mix assisting assembly 2500 may be included in systems 10 which includes a bag 26 with a plurality of internal chambers which are user or machine interruptible, though use with bags 26 having a single, continuous interior volume is also possible. Example mix assisting assemblies 2500 may act upon an exterior of a bag 26 to encourage mixing the contents of the bag 26. Alternatively or additionally, mix assisting assemblies 2500 may also displace an entire bag 26 to encourage mixing of the contents of the bag 26. In certain embodiments, an example mix assisting assembly 2500 may be operated until a solution formed in a bag 26 has substantially uniform characteristics throughout the bag 26. Mix assisting assemblies 2500 may, for example, mix concentrate with fluid, excipient, or diluent (e.g. Water for Injection) dispensed into a bag 26. In embodiments where the concentrate is a solid (e.g. crystalline salt) the mix assisting assembly 2500 may also encourage dissolution of the concentrate into fluid dispensed into the bag 26. A mix assisting assembly 2500 may further cause any particulate within a bag 26 to displace within the bag 26. Thus, the mix assisting assembly 2500 may also be a particulate identification assist assembly where bags 26 are checked for particulate via a machine vision system. A mix assisting assembly 2500 may be included in any location within a system 10, however, in certain examples, a mix assisting assembly 2500 may be included as a part of any fill station 2600 (see, e.g., FIG. 116) described herein. Alternatively, a mix assisting assembly 2500 may be a separate station which a bag 26 may be passed to after a fill station 2600. This may allow a bag 26 to be mixed while another bag 26 is being filled at a given fill station 2600.

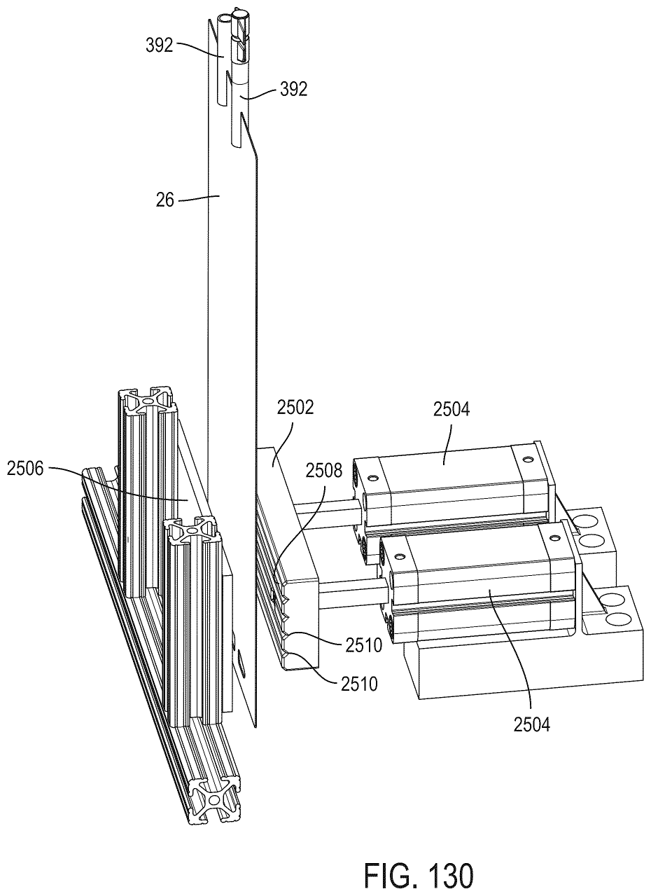

Certain mix assisting assemblies 2500 may include at least one displaceable body 2502 which may be driven against and away from the exterior of a bag 26 to displace fluid within the bag 26. At least a portion of a bag 26 may rest against a plate 2506 (e.g. back plate) as the mix assisting assembly 2500 is operated to mix fluid within the bag 26. The mix assisting assembly 2500 may include one or more actuator 2504. Each of the at least one displaceable body 2502 may be coupled to an actuator 2504 such that the actuator 2504 may be powered by the control system 15 to drive displacement of that displaceable body 2502. Displaceable bodies 2502 may be displaced against the bag 26 along a variety of displacement paths. For example, the displaceable bodies 2502 may be pivoted about a rotation axis into the bag 26 (see, e.g., FIGS. 128A-B). In such embodiments, a displaceable body 2502 may follow a curved or arcuate pathway as it is displaced toward and away from a bag 26. Alternatively (see, e.g. FIGS. 129A-130), displaceable bodies 2502 may be displaced along a substantially straight displacement path (e.g. perpendicular to side seams of the bag 26). In some examples, a single displaceable body 2502 may be driven toward and away from the bag 26 by one (see, e.g., FIG. 128A) or more (see, e.g., FIG. 130) actuators 2504. In some examples, multiple displaceable bodies 2502 (see, e.g., FIG. 129A) may be displaced against the bag 26 in some synchronized relationship governed by the control system 15. For example, one displaceable body 2502 may be displaced with respect to a bag 26 out of phase with a second displaceable body 2502 by a predefined amount. One displaceable body 2502 may be displaced against a bag 26 while the other is retracted and vice versa, thus the displaceable bodies 2502 may be displaced 180° out of phase with one another. Any other phase relationship or a varying relationship may be used.

Displaceable bodies 2502 may be displaced against any desired portion or portions of a bag 26. In the example embodiments, the displaceable bodies 2502 are displaceable toward and away from a portion of the bags 26 most distal to the ports 392 (the bottom of the bags 26 with respect to pull of gravity in FIGS. 128A-130). Where multiple displaceable bodies 2502 are displaced with respect to a bag 26, they may be displaced against the same region (e.g. bottom) of the bag 26 or one may be displaced against a first region of the bag 26 and another may be displaced against a second region of the bag 26.

Displaceable bodies 2502 may include a contact face 2508 which may press against the exterior of a bag 26 during operation. The contact face 2508 may include one or more raised and/or recessed feature which may help to encourage or direct mixing of contents in a bag 26. The contact face 2508 may include an arrangement of channels 2510 like those shown in FIG. 130. In other embodiments, the contact face 2508 may include a set of raised and recessed features. Such features may be disposed in a repeating pattern. In some examples, the contact faces 2508 may include raised and recessed features in an egg crate type pattern. As best shown in the example in FIG. 129B, raised convex features 2512 and recessed concave features 2514 may be defined on the contact face 2508. In various examples, and as shown in FIG. 129C, the plate 2506 against which the bag 26 rests may also include one or more raised or recess feature. The features of the plate 2506 and contact face 2508 may be arranged offset to one another so as to interdigitate or intermesh with one another when a displaceable body 2502 reaches an end of its displacement range.

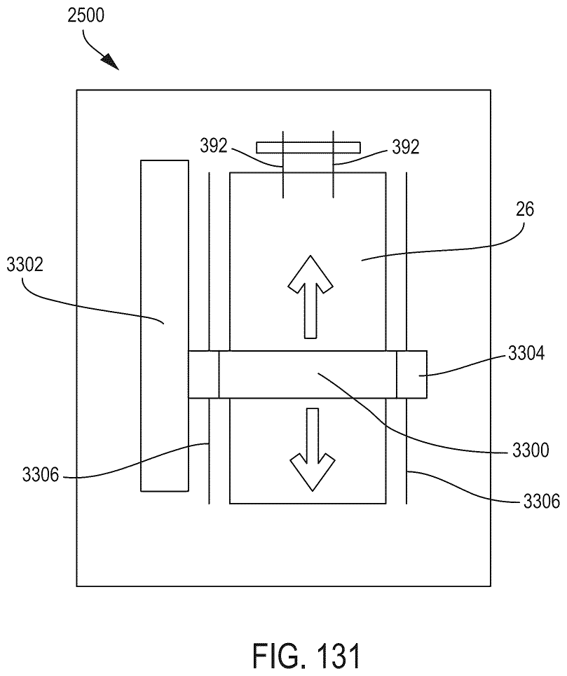

Referring now to FIG. 131, another example mix assisting assembly 2500 is depicted. Certain mix assisting assemblies 2500 may be displaced against a bag 26 and may be driven to adjust an area of the bag 26 which is locally depressed. In such examples, the mix assisting assembly 2500 may include at least one roller 3300. Each of the at least one roller 3300 may be attached to a roller actuator 3302 which may be powered to displace the roller(s) 3300 along the bag 26. The roller(s) 3300 may be coupled to a mount 3304 which may displace along a set of tracks 3306 included in the mix assisting assembly 2500. In some instances, the roller(s) 3300 may be spring biased against the bag 26. For example, a roller 3300 may be coupled to a trunnion which is spring biased towards the bag 26. The trunnion may displaced along guides included in the mount 3304 under the bias of the springs. In the example embodiment, a single roller 3300 is included.

The roller 3300 may be driven along the length of the bag 26 under the direction of control system 15 commands issued to the roller actuator 3302. In certain examples, the roller 3300 may be disposed at a starting position near the ports 392 when a bag 26 initially begins to be filled. The roller 3300 may press against the bag 26 so as to prohibit flow of fluid past the roller 3300 as the bag 26 is filled. As fluid is dispensed into the bag 26, the roller 3300 may be displaced to one or more additional position against the bag 26. The roller 3300 may be displaced quickly and in stepwise manner to the additional positions. This may cause fluid initially filled into the bag 26 to turbulently drop encouraging mixing as the roller 3300 is relocated. Alternatively, the roller 3300 may be displaced in continuous manner as the bag 26 is filled with fluid. This may ensure any concentrate in the bag 26 is kept in motion and does not take on a substantially stationary position at the end of the bag 26 opposite the ports 392 shortly after filling begins. In some examples, the roller 3300 may be displaced proximal and distal the ports 392 to promote mixing as the bag 26 is filled. Alternatively, the roller 3300 may be positioned against the bag 26 at a position opposite the ports 392 and displaced toward the ports 392 as the bag 26 is filled. In some examples, a fraction of the intended fill volume may be delivered to the bag 26 and filling of the bag 26 may be paused. The roller 3300 may be actuated to displace fluid within the bag 26 (in any of the above described manners) to assist in creating a homogenous solution in the bag 26. Filling may subsequently resume. Filling may be paused multiple times as a bag 26 is filled to mix fluid within the bag 26 via a mix assisting assembly 2500 (any of those described herein).

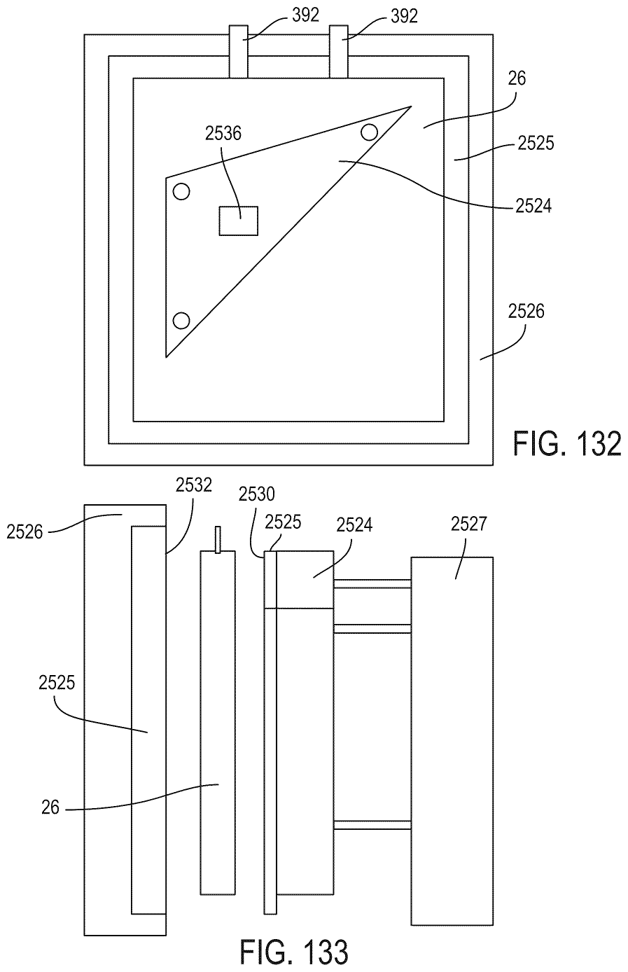

Referring now to FIGS. 132-133, another exemplary mix assisting assembly 2500 is depicted. In certain embodiments, select regions of a bag 26 may be blocked off as a bag 26 is filled with fluid from a dispensing sharp 2604. For example, desired regions of a bag 26 may be clamped or pressed closed via the exterior of the bag 26 to define a desired flow path for incoming fluid as the bag 26 is filled. The desired flow path may be a temporary flow path which is imposed upon a bag 26 until the bag 26 has been filled with at least some volume of fluid. The desired flow path may be a tortuous flow path which is defined to engender turbulent flow and bolster mixing within the bag 26 as fluid travels along the temporary flow path. Alternatively or additionally, at least a portion of the imposed flow path may create a small passage within the bag 26 through which fluid may flow. This may cause the velocity of the fluid to increase in any such areas. The high velocity fluid may be directed to a region of the bag 26 to agitate fluid within the bag 26. The above described externally imposed flow paths may aid in dissolving and mixing any concentrate within the bag 26, and help ensure a uniform solution is formed as a bag 26 is filled with fluid. At least a portion of the bag 26 may be unclamped as the fill level of the bag 26 increases and any temporary flow path in that portion of the bag 26 may be removed. The bag 26 may be completely unclamped and the temporary flow path may be completely removed when the bag 26 is full or nearly full. Data from a flow sensor in communication with the control system 15 may be monitored to determine when certain fill thresholds have been met. The control system 15 may send commands to unclamp the bag 26 when certain fill threshold criteria is/are satisfied.

As shown in the block diagram depicted in FIGS. 132-133, a bag 26 may be displaced to a fill station 2600. The fill station 2600 may include a first plate 2524 and opposing second plate 2526. At least one of the plates 2524, 2526 may be displaceable between a deployed and a retracted position. The bag 26 may be disposed between the first and second plates 2524, 2526 and at least one of the plates 2524, 2526 may be displaced to capture or sandwich the bag 26 between the plates 2524, 2526 during filling. Each plate 2524, 2526 may include a contact face 2530, 2532 which may at least partially abut a bag 26 as the bag 26 is filled. Contact face 2530, 2532 described herein may include at least one compliant member 2525 (e.g. gasket, overmolded compliant material, etc.). With the bag 26 captured between the plates 2524, 2526, the walls of the bag 26 defining the interior volume of the bag 26 may be pressed or clamped together in regions between the contact faces 2530, 2532. These regions may be substantially sealed or blocked off to fluid flow as fluid is transferred into the bag 26. The first and second plate 2524, 2526 may be held together in any suitable manner. In some embodiments, at least one actuator may be included to drive at least one of the first and second plate 2524, 2526 toward the other. In alternative embodiments, and as shown, the plates 2524, 2526 may be held together magnetically with one or more magnet 2536. In some embodiments, the plates 2524, 2526 may clamp the bag 26 via magnetic attraction and may be forced apart as sufficient fluid has been dispensed into the bag 26. At least one of the plates 2524, 2526 may be on a guide assembly 2527 (partially hidden in FIG. 132) which directs motion of the plate 2524, 2526 toward and away from the bag 26.

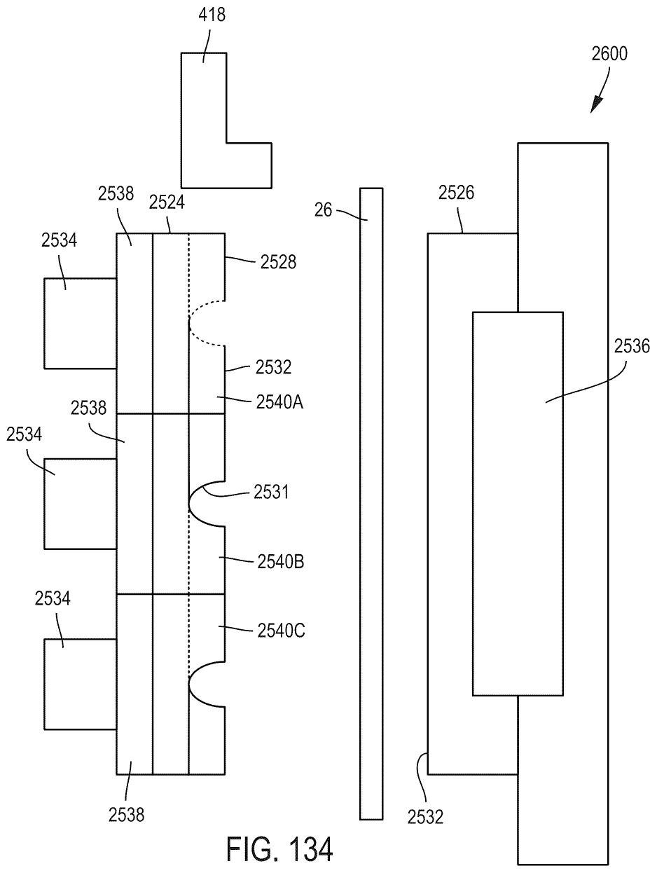

Referring now primarily to FIG. 134, in some embodiments, unclamping of a bag 26 as the bag 26 is filled may occur in stages. For example, a first portion of the bag 26 may be unclamped once a first amount of fluid has been filled into the bag 26. A second portion of the bag 26 may be unclamped once a second amount of fluid has been filled into the bag 26. Any number of additional portions of the bag 26 may be unclamped as the fill level of the bag 26 reaches thresholds defined for each respective portion. Commands may be sent from the control system 15 to unclamp appropriate regions of the bag 26 as respective fill thresholds are met. In such embodiments, one of the plates 2524, 2526 may be divided into a number of units 2540A-C which may be displaceable in tandem as well as independent of one another.

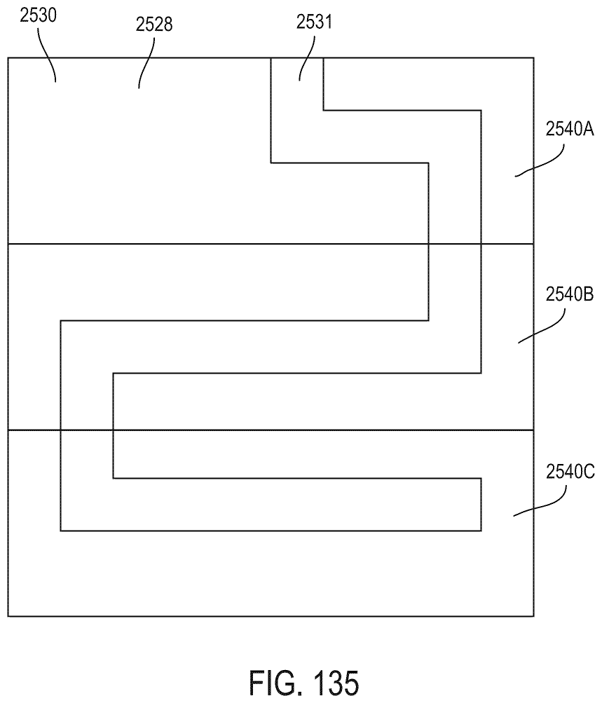

Additionally, in certain examples, the contact face 2530, 2532 of at least one of the plates 2524, 2526 may include a raised face 2528 and at least one recessed portion 2531. Fluid introduced to the bag 26 may travel along a flow path through the bag 26 in regions of the bag 26 present between the recessed portion 2531 and the opposing contact face 2532. Thus, a desired temporary flow path may be imposed upon a bag 26 from the exterior of the bag 26. A view of an example contact face 2530 is depicted it FIG. 135. The layout of the recessed portion 2531 is arranged to impose a flow path on the bag 26 which meanders back and forth across the width of the bag 26. Any desired flow path may be imposed by adjusting the layout of the recessed portion 2531. The recessed portion 2531 has a constant width, though could alter in width at at least one region to adjust the flow velocity within the imposed flow path.

Referring to both FIGS. 134-135, the plates 2524, 2526 may be held together magnetically. The fill station 2600 may include at least one retention magnet 2536 and at least one retraction magnet 2534. The retention magnets 2536 may be associated with the second plate 2526. The retraction magnets 2534 may be disposed adjacent a retracted position of the first plate 2524. The first plate 2524 may include at least one metallic body 2538 which may be attracted by the retention and retraction magnets 2534, 2536. A gripper 418, which may be included on a gantry or robotic arm, may transfer a bag 26 to the fill station 2600. The gripper 418 may also collect the first plate 2524 and disengage the first plate 2524 from the at least one retraction magnet 2534. The first plate 2524 or each unit 2540A-C of the first plate 2524 may be displaced (e.g. along one or more guide of a guide assembly 2527) by the gripper 418 toward the second plate 2526. The retention magnets 2536 may magnetically attract and hold the first plate 2524 or units 2540A-C thereof against the second plate 2526 capturing a bag 26 between the plates 2524, 2526. This position of the first plate 2524 may be referred to as a deployed position. As the bag 26 is filled, the fluid filled into the bag 26 may eventually push the first plate 2524 away from the second plate 2526 and toward the retracted position as the bag 26 increases in volume. The first plate 2524 (or units 2540A-C thereof) may be displaced by the expanding bag 26 a distance sufficient for the attraction of the retraction magnet(s) 2534 to pull the first plate 2524 to the retracted position.

As mentioned above, the first plate 2524 may be divided into a set of individually displaceable units 2540A-C. Though three are shown, any number of individually displaceable units 2540A-C is possible in other embodiment. Each of the units 2540A-C may be disengaged from the at least one retention magnet(s) 2536 and moved to a retracted position as the bag 26 reaches a respective fill volume. Thus the temporary flow path imposed by the plates 2524, 2526 may be removed in stages. In certain examples, the displaceable units 2540A-C may be retracted in order of their proximity to the ports 392 of the bag 26. The displaceable unit 2540A-C most proximal the ports 392 may be retracted first and the displaceable unit 2540A-C most distal the ports 392 being retracted last.

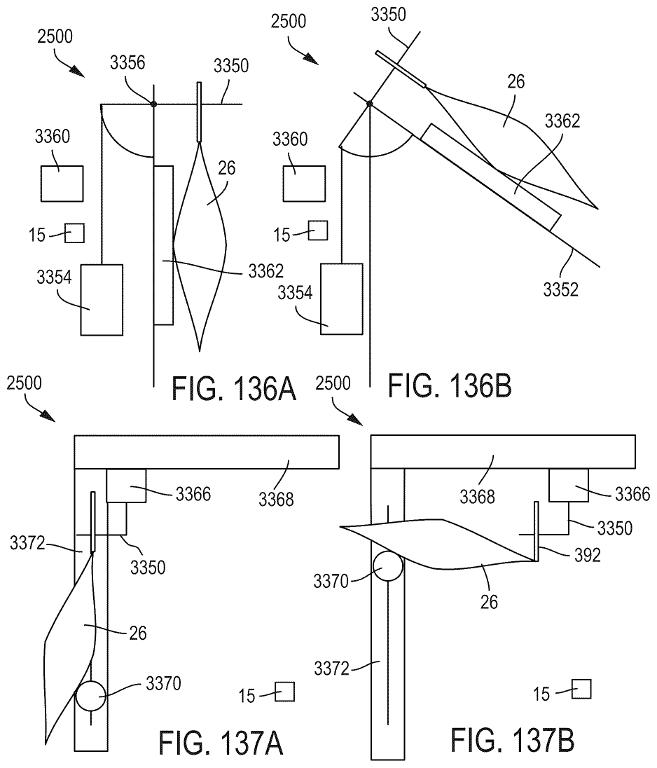

In some examples, the bag 26 may be manipulated in one or more additional manner while a mix assisting assembly 2500 imposes the flow path on the bag 26. For example, the bag 26 may be displaced such that the end of the bag 26 distal to the ports 392 is disposed above the ports 392 (see, e.g. FIGS. 136-138C). Alternatively or additionally, one or more displaceable body 2502 may be displaced against and away from the bag 26.

Certain example mix assisting assemblies 2500 may displace the entire bag 26 in order to encourage generation of a homogenous solution within the bag 26. The bag 26 may for example be rotated about an axis by the mix assisting assembly 2500 to engender movement of the fluid within the bag 26. This movement may generate eddies which may persist after the bag 26 has been rendered stationary helping to thoroughly mix contents of the bag 26.

An example mix assisting assembly 2500 which displaces a bag 26 to encourage mixing is depicted in FIGS. 136A-B. As shown, the mix assisting assembly 2500 may include a bag retainer 3350. The ports 392 of the bag 26 may be placed into the bag retainer 3350 to hold the bag 26 in place. The bag 26 may rest against a support 3352 when in the bag retainer 3350. The bag retainer 3350 may be disposed on the support 3352 in certain examples. The support 3352 may be coupled to a pivot actuator 3354 and may be pivotally displaceable about a pivot 3356. The pivot actuator 3354 may be powered to displace the support 3352 about the axis of the pivot 3356. In the example, the axis of the pivot 3356 is generally parallel to the width dimension of the bag 26 and outside of the footprint of the bag 26. Fluid in the bag 26 may be encouraged to mix by displacing the support 3352 relative to a back plate 3358 of the mix assisting assembly 2500. The support 3352 may, for example, be pivoted toward and away from the back plate 3358 a predefined number of times by the pivot actuator 3354 to mix fluid within the bag 26. The control system 15 may displace the support 3352 to preset angular positions (e.g. based on feedback from a support position sensor 3360). Each displacement away from the back plate 3358 may be to a respective preset angle. At least one of the preset angles may be greater than 90°. Each displacement toward the back plate 3358 may be to a preset angle or may return the support 3352 all the way to a home position (see, e.g. FIG. 136A) in which the support 3352 is in line with the back plate 3358. Sidewalls 3362 may be included on the back plate 3352 to prevent displacement of the bag 26 in undesired directions.

Referring now to FIGS. 137A-B, another example mix assisting assembly 2500 which displaces a bag 26 is depicted. The example mix assisting assembly of FIGS. 137A-B is arranged to rotate the bag 26 about an axis which extends parallel to the width dimension of the bag 26 and proximate the ports 392. As shown, the bag 26 may be held by a bag retainer 3350 which may be coupled to a carriage 3366 on a gantry 3368. The carriage 3366 may be displaced along the gantry 3366 from a first end of the gantry 3368 to the second end of the gantry 3368. The mix assisting assembly 2500 may also include a rest 3370. The rest 3370 may be a plate, bar, rod, or the like. The rest 3370 may be coupled to a linear displacement stage 3372. The rest 3370 may be brought to a stowed position at a first end of the displacement range of the linear stage 3372. The carriage 3366 may be displaced along the gantry 3368 to position a bag 26 in a ready position. As shown in FIG. 137A, the rest 3370 may then be brought into contact with the bag 26. The rest 3370 and carriage 3366 may then be displaced in coordination with one another to rotate the bag 26 about the rotation axis. As indicated in FIG. 137B, the rest 3370 may be displaced to a second end of its displacement range as the carriage 3366 is displaced toward the opposing end of the gantry 3368. Thus, the end of the bag 26 opposite the ports 392 may be raised while the end of the bag 26 including the ports 392 remains at substantially the same height. Preferably, rest 3370 may raise the end of the bag 26 opposite the ports 392 to a location higher than the ports 392. The carriage 3366 and rest 3370 may be displaced in reverse directions (back to their positions in FIG. 137A) to lower the bag 26. The control system 15 may issue commands to the linear displacement stage 3372 and gantry 3368 to repeatedly displace the bag 26 between raised and lowered states to engender mixing of fluid within the bag 26.

Referring now to FIGS. 138A-C, another exemplary mix assisting assembly 2500 is depicted. The example mix assisting assembly 2500 displaces the entire bag 26 to engender mixing of solution within the bag 26. As shown in FIGS. 138A-C, the bag 26 may be held in place on a rotary displacement stage 3312 included in the mix assisting assembly 2500. A bag retainer assembly 3310 may, for example, be coupled to the rotary displacement stage 3312 to capture the bag 26. Example bag retainer assemblies 3310 may have arms or clips which hold the bag 26 in place. A gripper or the like may be included to hold the ports 392 of the bag 26 in certain examples. A cradle 3311 or the like may also be included in the bag retention assembly 3310. The cradle 3311 may be coupled to the rotary displacement stage 3312 and may have a depression which is sized and shaped to accept at least a portion of a filled bag 26. The cradle 3311 and bag retention assembly 3310 may substantially prevent the bag 26 from displacing relative to the rotary displacement stage 3312. The gripper, clips, arms, etc. of the bag retention assembly 3310 may be mounted to the cradle 3311. One or more sensor 3314 which outputs a signal which varies in relation to the position of the rotary displacement stage 3312 may be monitored by a control system 15. The control system 15 may command displacement of the rotary displacement stage 3312 based upon the sensor 3314 output. In the example embodiment, the rotary displacement stage 3312 displaces the bag 26 such that the bag 26 rotates about an axis substantially perpendicular to a plane of the bag 26 in which the axes of the ports 392 fall. The rotation axis may be positioned so as to extend through a central location of the bag 26. The rotary displacement stage 3312 may be commanded to displace the bag 26 to one or more preset position. Typically, the bag 26 may be rotated to a sequence of predefined positions. The rotation may be alternated between clockwise and counterclockwise rotational directions between positions of the sequence of predefined positions. The bag 26 may be rotated at at least a certain rate as the bag 26 is rotated from one position to another. The bag 26 may remain stationary at each of the predefined positions for a period of time. In certain examples, the bag 26 may be rotated to a position at least 180° from its starting position (a fully inverted position) as the bag 26 is displaced with the mix assisting assembly 2500.

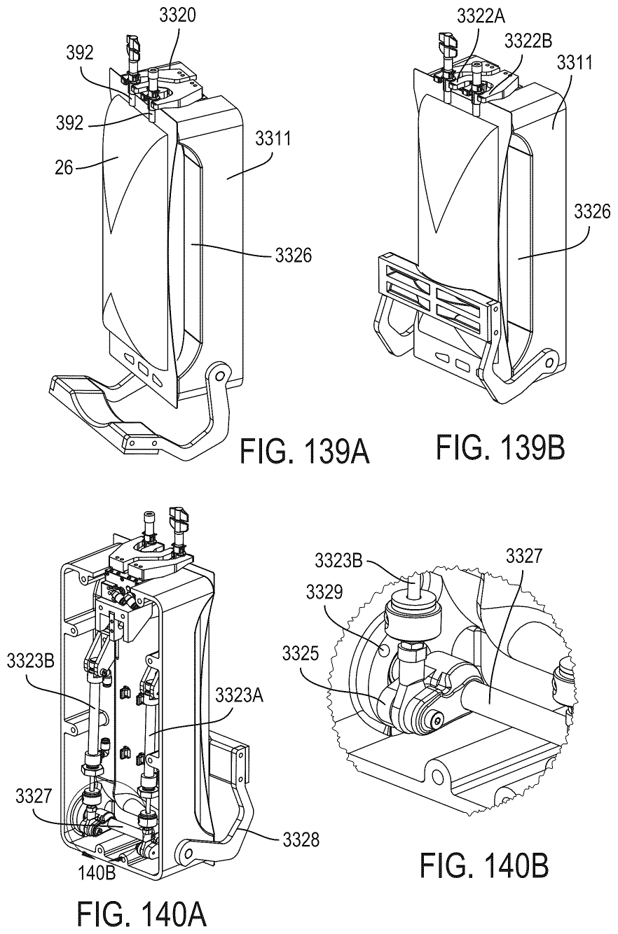

Referring now to FIGS. 139A-140B a number of views of an example bag retention assembly 3310 which may be included in a mix assisting assembly 2500 are depicted. As shown, the bag retention assembly 3310 includes a cradle 3311 which may include mounting points or hardware to couple the bag retention assembly 3310 to a rotary displacement stage 3312 (see, e.g., FIGS. 138A-B). The cradle 3311 may include a trough flanked by a set of opposing sidewalls 3326 which may support a bag 26 as the bag 26 is rotationally displaced. A gripper 3320 is attached to the cradle 3311 and may be actuated (e.g. pneumatically) to open and close a set of jaws 3322A, B for each port 392 included on the bag 26.

The bag retention assembly 3310 may also include a displaceable holder 3328 which may be displaced from a retracted position (see, e.g., FIG. 139A) and a deployed position (see, e.g., FIG. 139B). The holder 3328 may swing about an axis which runs substantially parallel to the width dimension of the bag 26. With the holder 3328 in the retracted position, the cradle 3311 may be accessible for a gantry or other robotic manipulate to install or remove a bag 26 from the mix assisting assembly 2500. Any imagers 3518 (see, e.g. FIG. 145) of a particulate inspection system 3500 (see, e.g. FIG. 145) may also have a clear field of view of the bag 26 when the holder 3328 is in the retracted position. In the deployed position, the holder 3328 may contact and press against the bag 26. This may firmly retain the bag 26 against the cradle 3311 to inhibit movement of the bag 26 relative to the cradle 3311 as the bag 26 is rotated. In some examples, the surface of the holder 3328 which contacts the bag 26 may be formed of or covered with a material with a high coefficient of friction against the bag 26 material. This may further assist in preventing undesired movement of the bag 26 as the bag 26 is rotated.

Referring now primarily to FIGS. 140A-B, the cradle 3311 may form a housing for one or more actuator 3323A, B (e.g. pneumatic cylinders) of the bag retention assembly 3310. A rear panel of the cradle 3311 is hidden in FIGS. 140A-B to depict the interior of the housing. The rotary displacement stage 3312 (see, e.g., FIGS. 138A-C) may couple to the rear panel when assembled. The actuators 3323A, B may be driven to displace respective linkages 3325 coupled to a pivot body 3327 to which the holder 3328 is fixedly coupled. As the actuators 3323A, B act on the linkages 3325 rotation of the pivot body 3327 and thus displacement of the holder 3328 is engendered. One or more position sensor 3329 may be included to monitor the position of the holder 3328. A rotary encoder may for example output a signal which varies in relation to the rotational position of the pivot body 3327 in certain examples. Alternatively, where the actuators 3323A, B are pneumatic cylinders, a cylinder proximity sensor (reed switch, Hall effect sensor, magnetoresistive sensor (AMR or GMR), or other magnetic sensor monitoring a magnet coupled to the cylinder) may be used.

Referring now to FIGS. 141A-142B, another example of a bag retention assembly 3310 which may be included in a mix assisting assembly 2500 is depicted. As shown, the bag retention assembly 3310 includes a cradle 3311 in which bags 26 may be partially seated when in place at a mix assisting assembly 2500. A gripper 3320 may be coupled to the cradle 3311. The gripper 3320 may have jaws 3322A, B which may be actuated (e.g. pneumatically) to open and close around ports 392 of a bag 26. Additionally, the bag retention assembly 3310 includes a holder in the form of a set of doors 3400A, B. Each door 3400A, B may swing about a pivot point which runs substantially parallel to the longitudinal axis of the bag 26. The doors 3400A, B may be displaceable from an open state (see, e.g., FIG. 141A) to a closed state (see, e.g., FIG. 142A). In the open state, a robotic manipulator or gantry may have a clear path to deposit or retrieve a bag 26 from the bag retention assembly 3310. In the closed state the bag 26 may be firmly held against the cradle 3311.

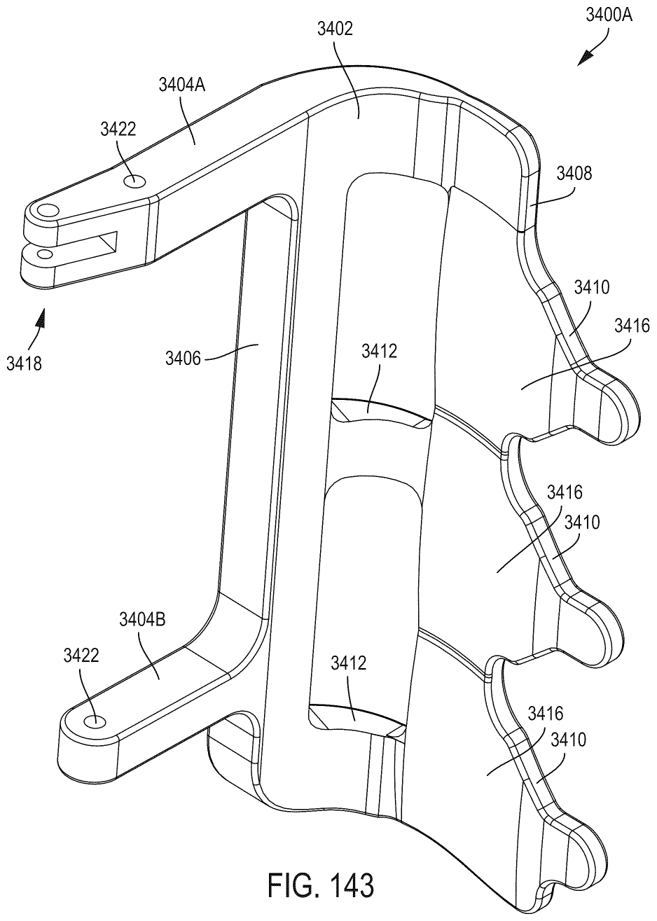

Referring now also to FIG. 143, a perspective view of a door 3400A in isolation is depicted. Each of the doors 3400A, B may be identical to one another for sake of simplicity, though this need not be the case in all examples. In examples where the doors 3400A, B are identical, the doors 3400A, B may be installed in a state where they have been flipped 180° from one another on opposing sides of the cradle 3311. The doors 3400A, B may be coupled to the cradle 3311 so as to swing in symmetric displacement paths lateral to the cradle 3311.

Still referring to FIGS. 141A-143, each door 3400A, B may include a main body 3402. The main body 3402 may, though need not, include one or more aperture 3412. A set of arms 3404A, B may project from opposing end regions of a first side 3406 of the main body 3402 of each door 3400A, B. One arm 3404A may be longer than the other and include an actuator coupling 3418 at its terminal end for coupling the arm 3404A to the output 3422 of a door actuator 3420A, B. Each arm 3404A, B may include a pivot pin hole 3422 via which the respective arm 3404A, B may be pivotally coupled to the cradle 3311. The pivot pin holes 3422 may be substantially coaxial.

A plurality of protrusions 3410 may extend from a second, opposing side 3408 of the main body 3402. The protrusions 3410 may be spaced apart by gaps which mimic the shape of the protrusions 3410. Thus, when the doors 3400A, B are closed (see, e.g., FIG. 142A), the protrusions 3410 of each door 3400A, B may be received in the gaps between the protrusions 3410 of the opposing door 3400A, B. This interlocking arrangement may assist in preventing pinching of the bag 26 when the doors 3400A, B are actuated. As shown, the main body 3402 may be arcuate in cross section such that the arms 3404A, B extend in a direction which is 80-100° from the direction of extension of the protrusions 3410. A portion of the main body 3402 and protrusions 3410 may include a contact surface which abuts a bag 26 in the mix assisting assembly 2500 when the doors 3400A, B are in a closed state. As shown, one or more panel of gripping material 3416 which has a high friction coefficient with respect to the bag 26 may be placed on the contact surface. Additionally, the protrusions 3410 may at least partially extend in a plane which is offset from the second side of the main body 3402. When the doors 3400A, B are in a closed state, the portion of the doors 3400A, B formed by the protrusions 3410 may thus be more proximate the midplane of the bag 26 in which the ports 392 fall. Force exerted by the doors 3400A, B against the bag 26 may thus be concentrated along a center line of the bag 26. This may depress the medial portion of the bag 26 pushing fluid within the bag 26 laterally.

As shown best in FIG. 141A and FIG. 142B, the output 3424 of each door actuator 3420A, B may be coupled to an actuator coupling 3418 on a respective door 3400A, B. In the example, the outputs 3424 are pivotally coupled such that the respective door 3400A, B may pivot relative to the output 3424 to which it is coupled. Each door actuator 3420A, B may also be pivotally coupled to the cradle 3311. Each door actuator 3420A, B may pivot relative to the cradle 3311 as the door 3400A, B is driven through its displacement range by the door actuator 3420A, B. In the example embodiment, the end of each door actuator 3420A, B opposite the output 3424 is coupled to a hinge 3430 extending laterally from the cradle 3311. A position sensor 3426 may be associated with each door actuator 3420A, B and may output a signal indicative of the position of the respective door 3400A, B as the door actuator 3420A, B is driven. In the example, the door actuators 3420A, B are pneumatic actuators and the position sensors 3426 may be magnetic sensors tracking the position of a magnetic body on the pneumatic cylinders. Any such sensor variety described herein may be used. Additionally shown in FIG. 141B and FIG. 142B is a mount point 3428 for coupling of the cradle 3311 to a rotary displacement stage 3312 or assembly. The mount point 3428 is shown coupled to a rotary actuator 3470 in FIG. 146C for example.

Referring now to FIG. 144, a flowchart 3380 is depicted detailing a number of example actions which may be executed to displace a bag 26 to encourage creation of a homogenous solution within the bag 26. As shown, in block 3381 a bag 26 may be displaced to the mix assisting assembly 2500. This may be accomplished by a robotic gripper or gantry under direction of the control system 15. In block 3382, the bag 26 may be retained in the mix assisting assembly 2500 by a bag retention assembly 3310.

In the example shown in FIG. 144, the bag 26 may be rotated between pairs of preset clockwise and counterclockwise positions. The order in which the bag 26 is displaced to the clockwise position and counterclockwise position in each pair may differ from embodiment to embodiment. The bag 26 may be displaced in a first rotational direction to the first position of a pair and rotated in a second, opposing rotational direction to the second position in that pair. FIG. 144 describes displacing the bag 26 to the clockwise position and then to the counterclockwise position though this merely exemplary.

The bag 26 may be rotated between each position in a pair some preset number of times. For some pairs, the number of iterations may be only a single iteration. For other pairs, the bag 26 may be rotated between each position in a pair a plurality of times (e.g. three times). A control system 15 may govern operation of a rotary actuator 3470 (see, e.g. FIG. 145) based on data from at least one rotational position sensor 3472 (see, e.g., FIG. 145) to rotate the bag 26 to any preset positions. The rotation rate of the bag 26 may be controlled to a predefined rate. In certain examples, the bag 26 may be rotated at a rate of 200-300 degrees per second (e.g. 250 degrees per second) during transitions between all positions. In certain examples, the bag 26 may be displaced between preset positions at rates specific to each individual transition between positions. The specified rates may differ depending on the transition, though at least some of the individual transitions may be specified to occur at the same rate. There may be a dwell period where the bag 26 is kept substantially stationary. This dwell period may elapse after the bag 26 is rotated to each preset position. In the example, a predefined dwell period is allowed to elapse each time the bag 26 is displaced to a new position (see, e.g., blocks 3383, 3384, 3387, 3388). The dwell time period may be specified for each individual displacement of the bag 26 or a dwell time for use with each pair of positions may be specified in non-limiting examples. A set of position pairs, rotation rates, and dwell times may be referred to as a motion profile.

In some examples, the type of bag 26 in place at the mix assisting assembly 2500 may be known. For example, the bag 26 may have an identifier which is read by an imager, barcode reader, etc. in communication with the control system 15. Bag 26 identifying information may also be manually input via a user interface of the system 10 in certain examples. The motion profile used for a given bag 26 may be chosen by the control system 15 based on the type of bag 26 in place at the mix assisting assembly 2500. A look-up table or the like may be used to facilitate selection of a motion profile based on a bag 26 identity. For example, the position pairs may be held constant across bags 26. Maintaining the same dwell times for each rotation pair, the rotational rate may be increased as the volume of the bag 26 increases. Alternatively, dwell times could be increased while maintaining the rotational rate constant for each position pair as bag 26 volumes increase. It is not necessary that only one of the dwell time and rotation rate values be adjusted; certain implementations may adjust both values as bag 26 volume increases.

Without being tied to any particular theory, it is believed that rotating the bag 26 to a given position generates primary or initial eddies within the fluid contained in the bag 26. The size of the primary eddies may generally be a factor of the amount and rate of angular displacement for a given reservoir (e.g. bag 26). As the bag 26 dwells in position, the primary eddies may decay into smaller eddies due to inertial instabilities. These eddies have a smaller Reynolds number and thus are less responsive to changes in momentum of the bag 26. These eddies may primarily respond to the viscosity of the surrounding solution rather than rotation of the bag 26. When the bag 26 is rotated to the opposing position of a position pair, the intervening dwell period may allow more of the energy from the counter-rotation to go towards creating new primary eddies instead of devoting some of the energy to slowing down existing primary eddies. Additionally, the remaining smaller eddies from previous preset positions may feed into the advective mixing action engendered by the primary eddies induced as the bag 26 is rotated to subsequent preset positions. As the bag 26 continues to be rotated between positions, the eddies formed within the bag 26 may mix fluid within the bag 26 with greater and greater vigor. The primary eddies formed may act on the fluid in conjunction with the mixing effects provided by secondary, tertiary, quaternary, etc. eddies from previous rotations. Additionally, as the bag 26 is rotated a greater magnitude from the starting position, the primary eddies formed may become larger resulting in larger child eddies (and longer cascades of progeny child eddies) as they break down. Thus repeated displacement of the bag 26 between positions of increasing (though not necessarily strictly increasing) magnitude may efficiently and quickly homogenize fluid within a bag 26 and dissolve any solid constituent within the bag 26.

Still referring to FIG. 144, the bag 26 may be rotated clockwise from a starting position to a first preset position in block 3383. The bag 26 may be rotated counterclockwise to a second preset position in block 3384. In some examples, the first preset position may be 40° from the starting position and the second preset position may be −40° from the starting position. The magnitude of rotational displacement from the starting position for the clockwise and counterclockwise position for each position pair may not be equal in all embodiments. In certain examples, the bag 26 may dwell at each of the first and second preset positions for less than half a second (e.g. 0.275-0.325 seconds or 0.390-0.410 seconds) for a one liter bag 26. The control system 15 may determine any dwell times (and/or rotation rates) based on bag 26 volume in certain embodiments (e.g. via a look up table).

If, in block 3385, the preset number of displacement iterations between the first and second position has not been met, the bag 26 may again be rotated between the first and second position in blocks 3383, 3384 and the accompanying dwell periods may be allowed to elapse. In some examples, the bag 26 may be displaced three times between the first and second positions. In certain implementations, the number of iterations may depend on the type of concentrate included in the bag 26. A greater number of iterations may be used for bags 26 which were filled with solid constituent. Additionally, a greater number of iterations may be used in the event that the bag 26 was filled with liquid concentrate and a particulate inspection system 3500 (see, e.g., FIG. 145) determined the presence of solid precipitate.

After the preset number of displacement iterations has been satisfied in block 3385, the bag 26 may be rotated clockwise and counterclockwise to the next preset positions in blocks 3387, 3388 (if in block 3386 there are additional preset positions). Dwell periods associated with the positions for blocks 3387, 3388 may be allowed to elapse. The bag 26 may be rotated between this next pair of positions until a preset number of displacement iterations has been achieved in block 3389. This may repeat until the bag 26 has been displaced to all predefined positions.

Typically, the magnitude of rotational displacement may increase with each subsequent pair of preset positions. The dwell time may also increase as the magnitude of displacement increases. In certain embodiments, the bag 26 may be rotated to a third and fourth position. The third position may be 85° from the starting position and the fourth position may be −85° from the starting position. The bag 26 may dwell at each of the third and fourth position for less than 0.75 seconds (e.g. 0.6-0.7 seconds). The bag 26 may also be rotated to fifth and sixth positions. The fifth position may be 120° from the starting position and the sixth position may be −120° from the starting position. The bag 26 may dwell at each of the fifth and sixth position for less than a second (e.g. 0.775-0.825 seconds). The bag 26 may further be rotated between seventh and eight positions. The seventh position may be 180° from the starting position and the eighth position may be −180° from the starting position. The dwell time at each of the seventh and eighth positions may be less than seven seconds (e.g. 4-6 seconds). In other examples, a lesser or greater number of positions pairs may be used.

The number of displacement iterations between each pair of positions may decrease (though non-strictly in certain examples) as the magnitude of rotational displacement increases. The number of displacement iterations between the last pair of positions may be lower than the number of displacement iterations for the first pair of positions. At least for bags 26 where the constituent within the bag 26 is a crystalline solid or powder, the number of displacement iterations may be greater for pairs of positions where the bag 26 is rotated less than 90° from its starting position. This may prevent constituent from displacing and lodging into a port 392 of the bag 26.

Still referring to FIG. 144, once, in block 3386, the bag 26 has been displaced through all preset positions, the bag 26 may be returned to the starting position in block 3390. Depending on the embodiment, the bag 26 may be monitored for particulate in block 3391. A wait period may optionally be allowed to elapse prior to any such monitoring. A control system 15 may, for example, analyze one or more image of the bag 26 supplied by one or more imager 3518 (see, e.g., FIG. 145) to determine whether particulate is present. Particulate monitoring will be further described later in the specification (see, e.g., FIG. 145). The bag 26 may also be checked to determine whether any solid constituent present in the bag 26 has dissolved in block 3391. In certain embodiments, the bag 26 may be rotationally displaced to further positions in the event that undissolved constituent is determined to be present within the bag 26. This may repeat until the control system 15 determines all solid constituent in the bag 26 has been dissolved in block 3391.

In alternative embodiments, the bag 26 may be rotated between a set of positions or sets of positions prior to block 3383 and the bag 26 may be subsequently monitored for particulate. This may create movement of particulate within the bag 26 which may assist in detection of the particulate with a particulate detection system 3500 (see, e.g., FIG. 145). The number of rotation iterations for each position pair may be adjusted by the control system 15 based upon the particulate analysis. The control system 15 may also halt operation of the mix assisting assembly 2500 in the event that certain undesired particulate is determined to be present. For example, in the event that insoluble foreign particulate is detected, the control system 15 may flag the bag 26 as rejected and the bag 26 may be directed to quarantine without mixing.

Referring now to FIG. 145, a diagram of an example particulate inspection system 3500 is depicted. Though example particulate inspection systems 3500 are described in relation to embodiments of systems 10 described herein, example particulate inspection systems 3500 may be implemented as stand-alone systems or be integrated into other systems. Additionally, the example particulate inspection systems 3500 are described in relation to flexible reservoirs (e.g. IV bags) typical of the variety used in in medical settings. These reservoirs are generally described in the context of injectable fluids. This is merely exemplary. The example particulate inspection systems 3500 described herein may be utilized with other varieties of reservoirs used in a wide variety of applications. For example, rigid reservoirs such as vials, jars, bottles, etc. may be used. The example particulate inspection systems 3500 described herein may also be used with reservoirs which include both rigid and flexible portions. Reservoir retention hardware of the particulate inspection systems 3500 may be adapted to retain the desired reservoir variety. Additionally, the displacement profile during mixing may be adjusted based on the subject reservoir. Applications may include preparation of medical solutions, laboratory solutions, and biological applications such as cell culturing, biomanufacturing, etc. Applications may also include particulate detection for industrial products (e.g. oils conforming to a stringent ISO cleanliness code). Examples described herein are generally described in relation to liquids, though may be used to detect particulate in other fluids such as gases. Though referred to herein as particulate inspection systems 3500, it will be clear that such systems are also capable of detecting, for instance, bubbles and may be utilized as bubble detection systems for reservoirs. Particulate inspection systems 3500 may also be referred to herein as reservoir content detecting and/or differentiating systems. Particulate inspection systems 3500 described herein typically detect, track, and classify contents of interest within reservoirs. In certain alternatives, a particulate inspection system 3500 may perform a subset of these activities. Some particulate inspection systems 3500 may detect and optionally classify components of interest without necessarily tracking them.

In general, particulate inspection (or content detection and differentiating in general) of reservoirs is a particularly difficult challenge. Commonly it is accomplished with a human inspector which engenders a high degree of subjectivity. Best practices require frequent breaks, recurring training, and other recurring reverification (e.g. eye exams) for inspectors. Even so, FDA data indicates that around one third of recalls for sterile injectables are related to the presence of particulate. Within the time period of 2010-2021 there were between 6 and 25 recall events per year relating to visible particulate in sterile injectables. A relatively small footprint automated particulate inspection system which is not prohibitively expensive would be welcome.

Particles or other content of interest for identification may be quite small. For example, it may be desired that a particulate inspection system 3500 identify particles of 200 μm or less (e.g. 100 μm or less or even 50 μm or less) at a level which at least achieves parity with a human inspector. These particles may exist in a solution which also contains gas bubbles. Some microbubbles within the solution may be in the same size range as the particulate of interest making differentiation between particulate and bubbles a challenge. False rejection of a reservoir due to misidentification of an air bubble as particulate is undesirable. It may be particularly undesired in scenarios where storage for rejected reservoirs is limited and is access controlled or in an environmentally controlled enclosure. Excessive false rejection may require a user intervention with a fluid packaging system and may limit throughput of a parent system 10.

Adding to the challenge, certain particulate may possess properties which are not ideal for visual detection. Some particulate (e.g. particulate from IV bag material) may be substantially transparent or have a high degree of translucence. Other particulate may absorb or reflect substantial amounts of light making it difficult to view against certain backgrounds. The density of particulates may also present challenge as certain particulate may tend to collect at the top or bottom of a reservoir. Head space in a reservoir may further complicate detection. The type of reservoir can also present optical challenges. IV bags, for example, are flexible and malleable. Each bag 26 will tend to crease and seat differently when installed in a particulate inspection system 3500 giving respective bags 26 differing optical properties. Reservoirs may also include print (e.g. text, logos, etc.) which may obfuscate view into the reservoir. Some reservoirs such as IV bags may also display a tendency to settle or shift over time while observations are made.

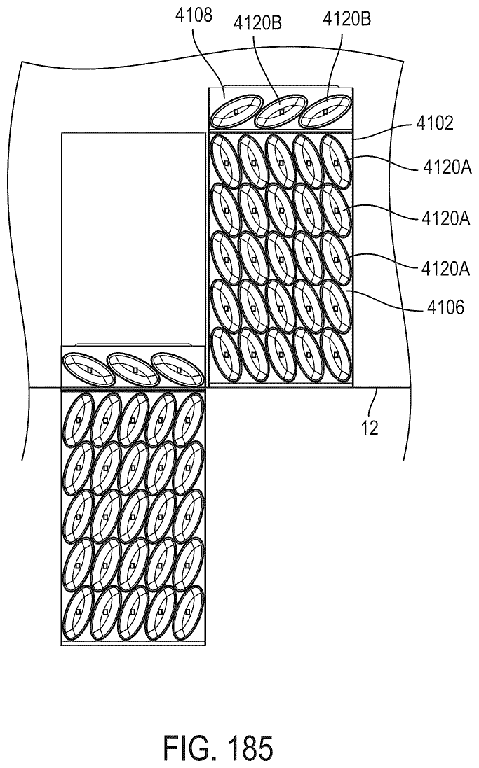

Exemplary particulate inspection systems 3500 described herein may image a filled bag 26 and perform machine vision analyses to identify contents of interest within the fluid contained in a bag 26. Particulate inspection systems 3500 may also differentiate between different types of contents of interest within the fluid. Bubbles of air or gas may be differentiated from solid particulate for example. In certain embodiments, particulate inspection systems 3500 may also differentiate between different types of particulate. A particle of undissolved constituent (e.g. salt, sugar, etc.) may be differentiated from other types of particulate for instance. Any determination as to the presence of at least certain contents of interest may be documented in a log which may be committed to a database 3502 or other memory. A determination as to whether the subject bag 26 meets one or more acceptance criteria may also be made. This determination, any raw data, analyzes, digests thereof, summaries, etc. may be included in the log communicated to the database 3502. In the event that the bag 26 fails acceptance criteria, the bag 26 may be routed to a discard or quarantine destination in the system 10. This could for example be dedicated, access controlled receptacles 4120B or an outfeed drawer 4102 in a system 10 (see, e.g., FIG. 185). The bag 26 may fail acceptance criteria in the event that analysis is indicative that undesired contents of interest such as particulate are determined to be present in the bag 26.

As shown, example particulate inspection systems 3500 may be disposed within an enclosure 12. The enclosure 12 may be substantially light tight. Thus ambient light may be obstructed from reaching the interior of the particulate inspection system 3500. The interior of the enclosure 12 may be unlit, but for light generated by components of the particulate inspection system 3500. In some embodiments, the enclosure 12 may house one or more additional station of a system 10 (e.g. a marking assembly 3700, outfeed assembly 4100, etc.). In such embodiments, light generating components in these stations may be minimized. There may for example be one or more small, low lumen output LED indicator light on components in the enclosure 12 while still considering the enclosure 12 to be unlit. To the extent other stations which utilize lighting are present within the enclosure 12, the particulate inspection system 3500 may not image bags 26 coincident with lighting in other stations being powered. Shielding or masking of light emitting components within the enclosure 12 may also be implemented. The particulate inspection system 3500 may be within a partitioned portion of the enclosure 12 separate from light producing components. An irradiation assembly 2608 with antimicrobial light emitters may be in a processing compartment 4300 while the particulate inspection system 3500 is in a separate outfeed compartment 4202 for example.

The enclosure 12 may be environmentally controlled to limit microbes, detritus, and humidity in certain examples. Where the particulate inspection system 3500 receives bags 26 from a fill station 2600, the enclosure 12 in which the particulate inspection system 3500 is disposed may be environmentally controlled to a less stringent level than the enclosure 12 in which the fill station 2600 (see, e.g., FIG. 85) is disposed. Alternatively, the enclosure 12 may not be subjected to environmental control. A transfer chamber 3506 (see, e.g., FIG. 2) may be disposed intermediate a processing compartment 4300 of the enclosure 12 including the fill station 2600 and compartment of the enclosure 12 including the particulate inspection system 3500 (see e.g., outfeed compartment 4202 of FIG. 2). The transfer chamber 3506 may include a set of doors 4700, 4702 which may opened via respective actuators under control of the control system 15. The control system 15 may inhibit both of the doors 4700, 4702 from being in an open state at the same time.

The particulate inspection systems 3500 may include a retainer assembly for holding a bag 26. In the example embodiments described herein, the retainer assembly is described as a mix assisting assembly 2500 (further described in relation to FIGS. 141A-144). Where a mix assisting assembly 2500 is described as part of a particulate inspection system 3500, it shall be understood that this is merely exemplary. The retainer assembly of a particulate inspection system 3500 may be a dedicated assembly and a system 10 may include a separate mix assisting assembly 2500. Features of mix assisting assemblies 2500 described in relation to example particulate inspection systems 3500 disclosed herein may be included in a dedicated retainer assembly for a particulate inspection system 3500. Additionally, any of the features of the mix assisting assemblies 2500 described in relation to the particulate inspection system 3500 may be included in any other mix assisting assemblies 2500 shown or described herein.

As shown, the mix assisting assembly 2500 may include a cradle 3311 against which the bag 26 may be placed. A gripper 3320 may be attached to the cradle 3311 and may be actuated (e.g. pneumatically) to open and close a set of jaws around respective ports 392 of the bag 26. The cradle 3311 may be attached to a rotary actuator 3470 via a mount point 3428 (see, e.g., FIG. 141B). A motor encoder or other rotational position sensor 3470 may be included and may output a signal indicative of the rotational position of the cradle 3311. A holder may be attached to the cradle 3311. Any holder described herein may be used, though in the example embodiment, a set of doors 3400A, B (only one shown in FIG. 145, see, e.g., FIG. 141A) are included. The holder may be actuated to firmly retain the bag 26 against the cradle 3311 when the rotary actuator 3470 is driven.

The cradle 3311 may include a rest body 3510 which a surface of the bag 26 may contact when retained at the cradle 3311. The rest body 3510 may be contoured to mimic the shape of a filled bag 26. The rest body 3510 may be transparent or at least partially translucent. For example, rest bodies 3510 may be constructed of a transparent or at least partially translucent material. Alternatively, the rest body 3510 may be constructed of a transparent material to which a surface treatment is applied. The rest body 3510 may, for instance, be frosted. The cradle 3311 may also include an illuminator 3512. The illuminator 3512 may include at least one light source and may provide substantially uniform illumination of the rest body 3510. A diffuser may also be included. When the illuminator 3512 is powered, a bag 26 in place on the cradle 3311 may be backlit. As shown in FIG. 145, the illuminator 3512 is positioned opposite the rest body 3510. Alternatively or additionally, the rest body 3510 may be side lit and/or otherwise lit from another vantage point. The illuminator 3512 may be a side emitting panel type light source with a built in diffuser. The illuminator 3512 may emit white light, though in some embodiments, the illuminator 3512 may emit specified wavelengths or may be adjusted to emit a selection of different color light(s) under the direction of a processor of the control system 15. The illumination output intensity of the illuminator 3512 may be adjustable.

The rest panel 3510 may be patterned. The pattern may include a collection of dark 3514A and light regions 3515B (see, e.g., FIG. 146A). The dark regions 3514A may be formed by masking or otherwise obstructing the passage of light through the rest body 3510. Thus, in various examples, the rest panel 3510 may include a collection of light obscuring regions and regions which permit passage of light. The dark regions 3514A may be black when the illuminator 3512 is powered. The light regions 3514B may be left uncovered or be unaltered regions of the rest body 3510. The light regions 3514B may be white (or substantially the color output by the illuminator 3512) when the illuminator 3512 is powered. The pattern may consist of alternating dark and light regions 3514A, B. In certain examples, a checker or chessboard pattern may be used. Other example patterns may include spirals, horizontal lines, vertical lines, polka dot, herringbone, houndstooth, a tessellation, zebra-pattern stripes, etc. In some preferred embodiments, a checkered pattern with 6-8 mm squares (e.g. 7 mm) may be utilized. The illuminator 3512 may light the rest panel 3510 at a value of at least 3000 lux.

In alternative embodiments, the illuminator 3512 may be otherwise controlled to generate contrast. For example, the illuminator 3512 may be powered to generate contrast in backlight color over time. In one example, no pattern may be included on the rest panel 3510, and the illuminator 3512 may be rapidly switched on and off, transitioned through different colors, or transitioned through different light output intensities at a high rate. This would similarly generate a contrasting light and dark background albeit with a temporal offset. The speed at which different illuminator 3512 set points are transitioned through may be dependent on the frame rate of any imagers 3518. The frame rate of the imagers 3518 may similarly be synchronized with the illumination transitions of the illuminator 3512. A transition between illuminator 3512 set points may occur a plurality of times per second. In some examples, ten or more transitions per second may occur.

An external illuminator 3516 may also be included in certain examples. The external illuminator 3516 may be separate from the cradle 3311 and may be positioned to direct light into the bag 26. In the example embodiment, the external illuminator 3516 is an underlight. The external illuminator 3516 may emit collimated light. In certain examples, the external illuminator 3516 may include a number of light emitters (e.g. LEDs) and one or more lens. The lens may include collimating lenses for each of the light emitters. Additionally, in certain examples, at least one polarizer 3517 may be included. A polarizer 3517 may be included for the external illuminator 3516 and for each of the imagers 3518. Polarized light reduces glare off of certain reservoirs such as bags 26. Polarized light may also tend to better highlight air bubbles within a reservoir.

The external illuminator 3516 may produce light of a specific color, wavelength, or band of wavelengths. For example, the external illuminator 3516 may produce red or orange light. In some embodiments, the external illuminator 3516 may output light in the 600-630 nm range. The color of light selected for the external illuminator 3516 may be chosen based on potential anticipated sources of particulate. Preferably, the color may be selected to differ from anticipated sources of potential particulate. The intensity of the light emitted by the external illuminator 3516 may be greater than the intensity of light emitted by the illuminator 3512 in the cradle 3311. In alternative examples, the color of light emitted by the external illuminator 3516 may be adjustable and may be user specified. Different colors may be emitted by the external illuminator 3516 at different time points during inspection of a bag 26 or other reservoir. The external illuminator 3516 may produce an illuminance of at least 20,000 lux (e.g. 23,000-25,000 lux). Each light emitter assembly 3522 (see, e.g., FIG. 146C) of the external illuminator 3516 may also emit at a narrow beam angle such as 5-15° (e.g. 10°).

Still referring to FIG. 145, exemplary particulate inspection systems 3500 may include at least one imager 3518. Each of the at least one imager 3518 may be positioned in opposition to the rest body 3510 such that a bag 26 is disposed intermediate the rest body 3510 and imager(s) 3518 when in place at the cradle 3311. Thus the pattern may be provided on a first side of the reservoir while the imager(s) 3518 may be positioned on a second, opposing side of the reservoir. Each of the at least one imager 3518 may include a CCD or CMOS sensor and may capture monochrome or color image data. Each imager 3518 may have a depth of field which is at least equal to the thickness of a filled bag 26. The f-number for the imager(s) 3518 may be kept under f-8 and preferably lower. This may limit the amount of diffractive blur introduced to any images generated by the imager(s) 3518. Each imager 3518 may preferably have an at least 10 megapixel camera (e.g. 12 megapixel). Each pixel may correspond to a square region at the midplane of a nominal bag 26 which includes the ports 392. For exemplary 1 liter bags 26, a 100 μm particle may fill a pixel of an image generated by an example imager 3518.

In the example embodiment shown in FIG. 145, three imagers 3518 are included. The imagers 3518 are positioned at an angle other than perpendicular to the midplane of the bag 26 including the ports 392. In the example, the imagers 3518 are disposed such that the optical axis or viewing axis of each imager 3518 is inclined 30-35° (e.g. 32°) from an orientation perpendicular to the midplane of the bag 26 including the ports 392 or height dimension of the cradle 3311. A hypothetical spherical lens within the bag 26 receiving collimated light from an underlight type external illuminator 3516 may produce a light return which is particularly strong at this angle.

The imagers 3518 may each have a field of view which includes a portion of the bag 26. A first of the imagers 3518 may have a field of view including a portion of the bag 26 most proximal to the ports 392. Another of the imagers 3518 may have a field of view encompassing a portion of the bag 26 most distal to the ports 392. The remaining imager 3518 may have a field of view which captures the central portion of the bag 26 intermediate the fields of view of the former imagers 3518. Typically the field of view of each imager 3518 may overlap with that of at least one other imager 3518. In some embodiments, the field of view of the imager 3518 dedicated to the central portion of the bag 26 may overlap with the respective fields of view of the adjacent imagers 3518 by at least 5% (e.g. 5-10%). Including multiple imagers 3518 may allow the particulate inspection system 3500 to remain relatively compact, however, fewer (e.g. a single imager 3518) may be used by spacing the imager 3518 a greater distance from the bag 26. In such examples, the imager sensor may have a greater pixel density (e.g. 20-30 megapixel or higher). Other or additional variables such as lens focal length may be adjusted to alter the number of imagers 3518 without necessarily changing the footprint of the particulate inspection system 3500. The focal length of one or more imager 3518 included in a particulate inspection system 3500 may be adjustable in certain embodiments. Such imagers 3518 may sweep through their focal length range as image data of the bag 26 is captured to collect in focus data at across various depths within the bag 26. The bag 26 may be placed in the particulate inspection system 3500 with any text or graphics of the bag 26 adjacent the rest body 3510 so that they are not intermediate the imagers 3518 and the interior of the bag 26. Any embodiments described or shown herein as having a certain number of imagers 3518 may be modified to include a greater of fewer number of imagers 3518.

In certain examples, each of the imagers 3518 may be associated with at least one filter 3542. For example, imagers 3518 may each be paired with a neutral density filter in some examples. Alternatively or additionally, a polarizer 3517 may be placed in front of the lens for each imager 3518. Where polarizers 3517 are used, the polarizers 3517 for each imager 3518 may be oriented at a lensed light transmitting orientation. This orientation is an angle related to the polarization angle of the light emitted from the external illuminator 3516. This orientation may differ for each imager 3518 and may substantially block light from the external illuminator 3516 reflecting off bag material and particulate within the bag 26. The lensed light transmitting orientation may be selected to permit transmission polarized light emitted from the external illuminator 3516 and lensed by a hypothetical spherical lens within the bag 26.

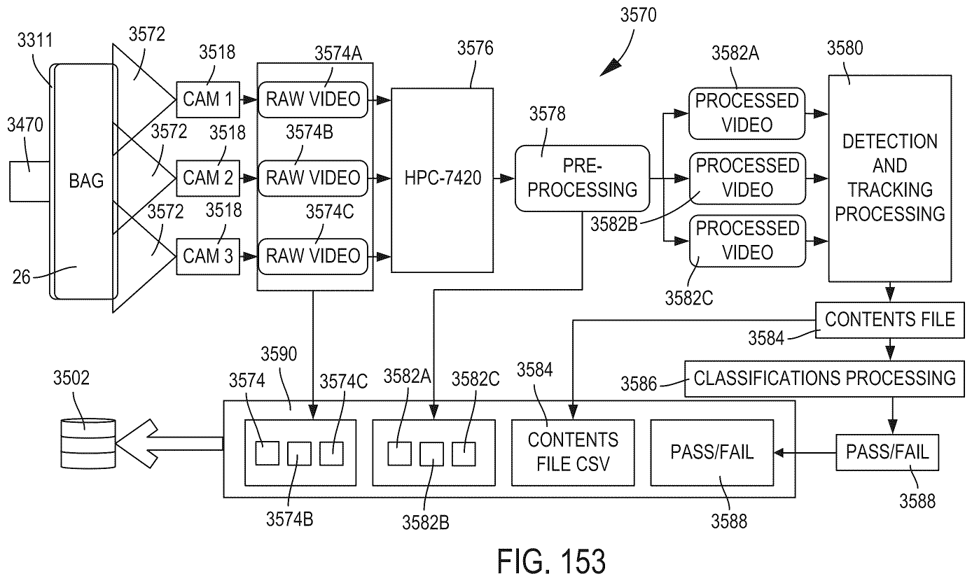

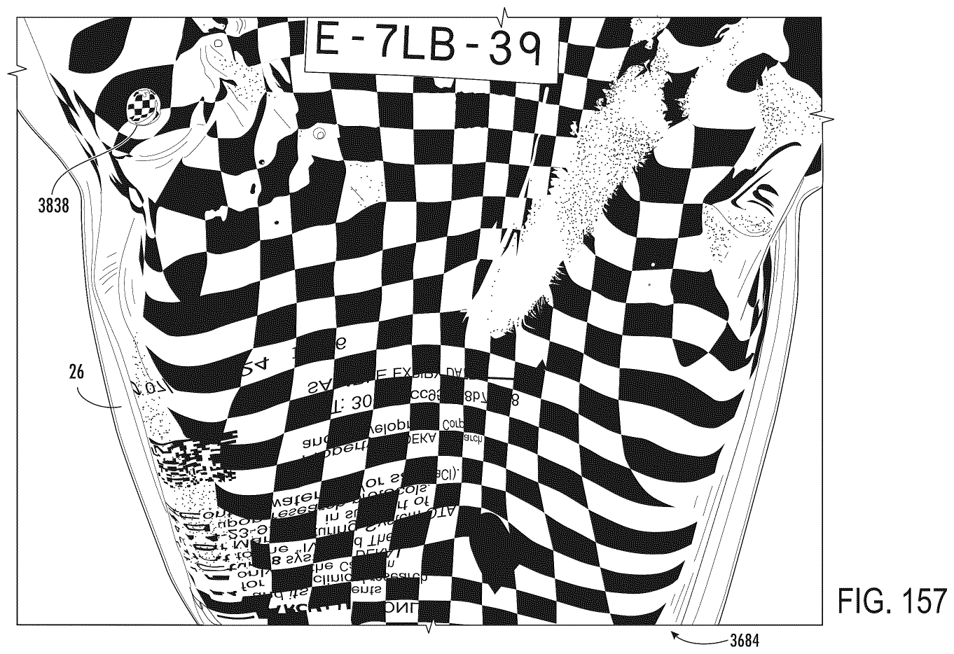

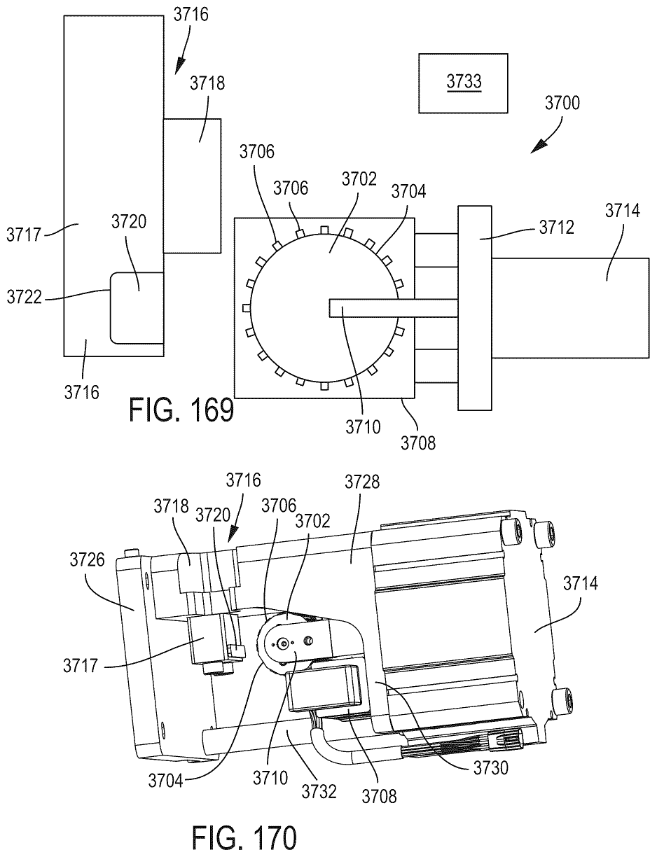

The control system 15 may command the rotary actuator 3470 to displace the bag 26 with the doors 3400A, B actuated closed upon the bag 26. In some embodiments, the control system 15 may command displacement of the bag 26 as described in relation to FIG. 144 and may mix fluid within the bag 26. The bag 26 may be returned to a starting position and the doors 3400A, B may be opened to provide a clear field of view for the imagers 3518. After a wait period has elapsed (e.g. 5-10 seconds) the control system 15 may command the imager(s) 3518 to capture frames of the bag 26. Depending on the embodiment, frames may be captured at a rate of at least 10 frames per second (though higher or lower capture rates are possible). Frames may be captured for at least 10 seconds (though capture periods greater than or less than 10 seconds are also possible). The control system 15 may process the captured frames from each imager 3518 to determine the presence of one or more contents of interest in the bag 26. In some examples, the control system 15 may include an FPGA or dedicated processor for this task. The control system 15 may create an inspection log 3590 (see, e.g., FIG. 153) which may be communicated to a database 3502 or other memory. Each inspection log 3590 may include at least one of the raw frames 3684 (see, e.g., FIG. 157) from the imagers 3518, analysis results for the frames (type of content identified, number of particles, size of particles, location of particles, etc.), information about the bag 26 (e.g. lot, unique identifier, solution type within bag 26), and a pass/fail determination for the bag 26. The system 10 may ensure that bags 26 which are determined to have failed inspection criteria are routed to a discard or quarantine destination after leaving the particulate inspection system 3500. The system 10 may additionally ensure that such bags 26 are clearly labeled as rejected (see, e.g., FIGS. 169-181B and FIG. 176 and associated description).

As shown in FIG. 145, a particulate inspection system 3500 may also include an indicia reader 3543 for an indicium 56 on the bag 26. The indicia reader 3543 may be an imager, barcode reader, QR code reader, RFID interrogator, NFC interrogator, etc. In certain examples, the bag 26 may include a GS-1 code as the indicium 56 and the indicia reader 3543 may be an imager. In alternative embodiments, one or more of the imagers 3518 may be utilized as the indicia reader 3543 and a dedicated indicia reader 3543 may be omitted. The control system 15 may determine at least a unique identifier for the bag 26 from data captured by the indicia reader 3543 (or one or more imager 3518) and may associate any particulate inspection records with that unique identifier when records are communication to a database 3502. In some embodiments such an indicia reader 3543 may also be disposed in the processing compartment 4300. The indicia reader 3543 may determine various information from the indicium 56 (e.g. concentrate type, volume, mass, etc.) which may be used to inform dispensing of fluid into the bag 26 from a filling station 2600.

Referring now to FIG. 146A-C, a number of illustrations of an example particulate inspection system 3500 are depicted. The example particulate inspection system 3500 includes the mix assisting assembly 2500 depicted in FIGS. 141A-142B. As shown, the rest body 3510 includes a checker pattern or repeating dark and light regions 3514A, B. This pattern, though distorted by the bag 26 (see, e.g., FIG. 146B), may be visible through the bag 26 from perspective of the imagers 3518. The light and dark regions 3514A, B may be an appliqué which is placed on the rest body 3510 (e.g. the exterior surface of the rest body 3510). In alternative examples, the pattern may be generated on the rest body 3510 by, hydro dip painting, stenciling or screen printing, laser etching the pattern into a painted rest body 3510. Laser etching may also be used to generate roughness in a pattern on a rest body 3510 which is otherwise too smooth for paint to adhere. The rest body 3510 would then be painted and the paint may be removed from the unetched surface. A photoreactive coating could also be applied, exposed to light, and developed to generate the desire pattern.

The particulate inspection system 3500 may include a mount assembly 3520 to which the imager(s) 3518 may be coupled. The mount assembly 3520 may be coupled to the enclosure 12 and may ensure that the imagers 3518 are positioned at a prescribed angle (e.g. 32°) to the medial transverse plane of a bag 26. As shown, each of the imagers 3518 may be associated with a filter 3542. In various embodiments, the filter 3542 may be neutral density filter. Alternatively or additionally, a polarizer 3517 may be associated with each imager 3518 (see, e.g., FIG. 145).

The external illuminator 3516 is also depicted in FIGS. 146A-C. As best seen in FIG. 146C, the external illuminator 3516 may include a plurality of light emitter assemblies 3522. Each light emitter assembly 3522 may include an LED and collimating lens. The LED's and PCB 3524 to which they are coupled may be disposed within a housing 3526. The housing 3526 may include one or a series of sealing members 3528 (e.g. o-rings) which may inhibit ingress of any liquid into the housing 3526. The sealing member(s) 3528 may be formed of a compliant material which may be compressed by a face member or plate 3532 coupled to a main section 3534 of the housing 3526. This may facilitate placement of the external illuminator 3516 under the bag 26 within a particulate inspection assembly 3500. The external illuminator 3516 may also include a polarizer 3517. The polarizer 3517 may form part of the housing 3526 and span across a light emission aperture 3536 of the housing 3526. A heat sink 3538 may be coupled to the housing 3538 to assist in dissipating heat generated by the light emitter assemblies 3522. The housing 3526 may include a mount 3540 via which the external illuminator 3516 may be fixed in place relative to the imagers 3518. The mount 3540 may, for example, couple to the enclosure 12 (see, e.g., FIG. 145).

Depending on the layout of the array of individual light emitting assemblies 3522 in an external illuminator 3516, the angle of the light with respect to the height axis of the bubble 3550 may change. In the example shown in FIG. 146C for instance, the light emitting assemblies 3522 of the external illuminator 3516 are arrayed in two rows. The collimated light from these rows may be generally directed at the midplane of a bag 26 retained in the particulate inspection system 3500. To accomplish this, the light emitting assemblies 3522 may be positioned to emit light at an angle non-parallel to the midplane. For certain external illuminators 3516, the light emitting assemblies 3522 in each row of the array may be spaced an even amount from respective opposing sides of the midplane. The light emitting assemblies 3522 may emit collimated light at an angle of 15° to the midplane with each row tilted in opposite directions. In other embodiments with additional rows or different light emitting assembly 3522 array layouts, the light emitting assemblies 3522 may be angled to emit collimated light at a center point or central plane of a bag 26.

The light emitter assemblies 3522 may be wired in series in certain examples (though this is not necessary in all embodiments). With such an arrangement, the failure of one light emitter assembly 3522 would result in failure of the entire external illuminator 3516. This prohibits a scenario in which one or more light emitter assembly 3522 fails and is not detected. Thus, the external illuminator 3516 may be ensured to operate at only 100% output. Detection of a light emitter assembly 3522 failure would also be simplified as no light would be generated when the external illuminator 3516 is commanded on.

In some embodiments a photodetector in data communication with the control system 15 may be positioned opposite the external illuminator 3516. In the event the signal output by the photodetector is less than a threshold, the control system 15 may generate a fault. Alternatively, image data from the imagers 3518 may be utilized to detect a failure of the external illuminator 3516. The control system 15 may, for example determine an overall light intensity value for the field of view of an imager 3518 and may generate a fault if the field of view is below a darkness threshold when the external illuminator 3516 is commanded on. In some embodiments, the control system 15 may additionally or instead determine failure of the external illuminator 3516 by analyzing the color space values for image data from an imager 3518. The control system 15 may compare the image data to expected color space value ranges (e.g. RGB color space). If the external illuminator 3516 emits red light, for instance, a high R value and lower G and B values would be expected to be observed in at least portions of an image In the event that the color space values observed are unexpected (e.g. substantially uniformly low RGB values) the control system 15 may generate a fault. Alternatively, a neural net may be trained with images where the external illuminator 3516 is powered and verified to be functional. The neural net would also be trained with images taken when the external illuminator 3516 is unpowered and in a non-illuminating state. An image may periodically be supplied for neural net analysis to check for failures of the external illuminator 3516. A fault may be generated by the control system 15 in the event of a determination by the neural network that the external illuminator 3516 has failed. Where a fault is generated, the control system 15 may generate a notification for display on the user interface 6100 (see, e.g., FIG. 1) communicating the external illuminator 3516 failure.

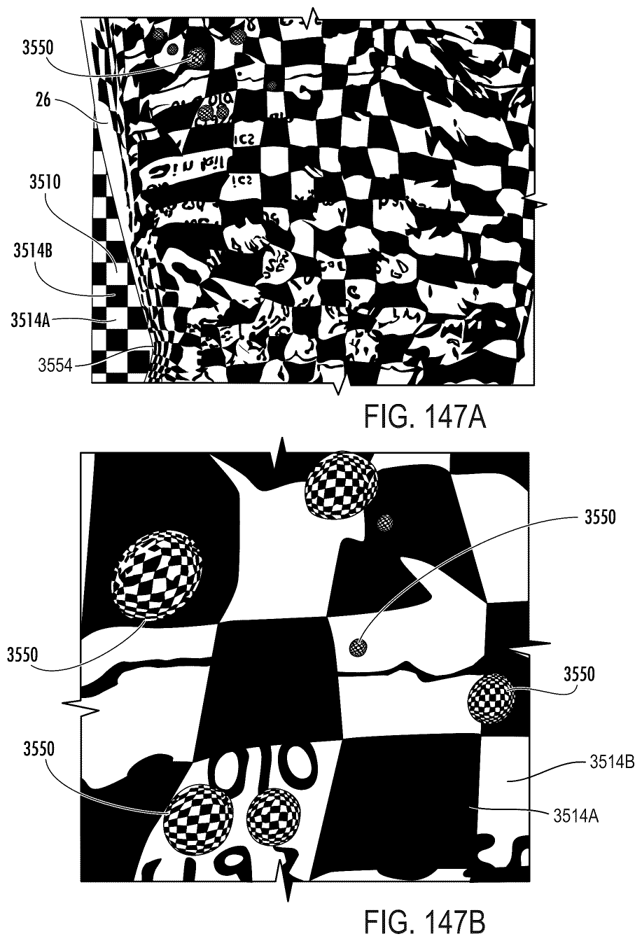

Referring now to FIGS. 147A-149D, a particle inspection system 3500 may differentiate between certain contents of interest within a bag 26. Bubbles 3550 of air or gas may be commonplace within bags 26, especially after the bag 26 has been agitated by a mix assisting assembly 2500. Bubble 3550 content should be benign and the presence of bubbles 3550 alone preferably would not trigger a bag 26 to fail inspection. The external emitter 3516, background pattern, and imager(s) 3518 may be selected, outfitted, and positioned to help ensure bubbles 3550 within the solution contained in a bag 26 are readily differentiable from other contents of interest.

Referring to FIGS. 147A-B, illustrations of portions of a bag 26 in place at a cradle 3311 of a particulate inspection system 3500 are depicted. The illustrations are representative of what would be seen from an imager 3518, but not exact reproductions of actual images. A representational frame is depicted in FIG. 147A. An enlarged portion of the representational frame of FIG. 147A is depicted in FIG. 147B. The dark and light regions 3514A, B of the rest body 3510 pattern are also visible in FIGS. 147A-B. As shown, the bag 26 may distort this pattern as light from the back light transits through the bag 26. A portion of that pattern unadulterated by passage through bag 26 is visible lateral to a crinkle or fold 3554 in the side of the bag 26 in FIG. 147A.

Still referring to FIGS. 147A-B, a number of large bubbles 3550 are present in the bag 26 and positioned against the wall of the bag 26 material. As shown, the optical properties of the bubbles 3550 distorts the backlight pattern in a similar manner for each of the bubbles 3550. Each of the bubbles 3550 creates a distorted version of a section of the pattern. In the example, the pattern is a chessboard pattern and a distorted checkered pattern is visible in each of the bubbles 3550. Bubbles 3550 suspended in solution may also distort the background pattern in a consistent manner. As the distorted versions of the background pattern are hallmarks indicating the existence of bubbles 3550, images may be analyzed for the presence of these specific patterns in order to identify the presence of bubbles 3550 within a bag 26. The control system 15 may employ a pattern recognition algorithm such as a statistical pattern recognition algorithm or syntactic pattern recognition algorithm. Template matching may for example be used to match instances of the distorted background pattern to an expected distorted background pattern template. A neural network may also be trained on images of bubbles 3550 creating the distorted checkered pattern and employed to detect the presence of such bubbles 3550 based on presence of the pattern.

The resolution of the imager 3518 capturing the image frame limits the size of bubble 3550 which may be identified by the presence of the distorted background patterns. Higher resolution imagers 3518 may detect smaller bubbles 3550 by analyzing frames for the presence of the distorted background pattern. In some embodiments, recognition of the distorted background pattern may be used to differentiate relatively large volume bubbles 3550 from other large contents of interest.

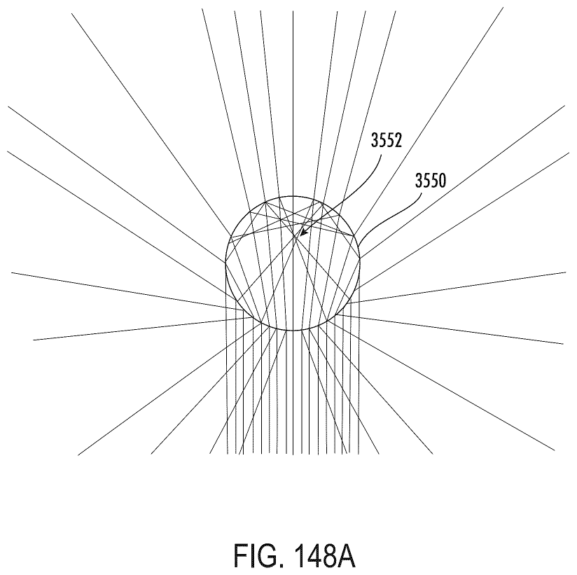

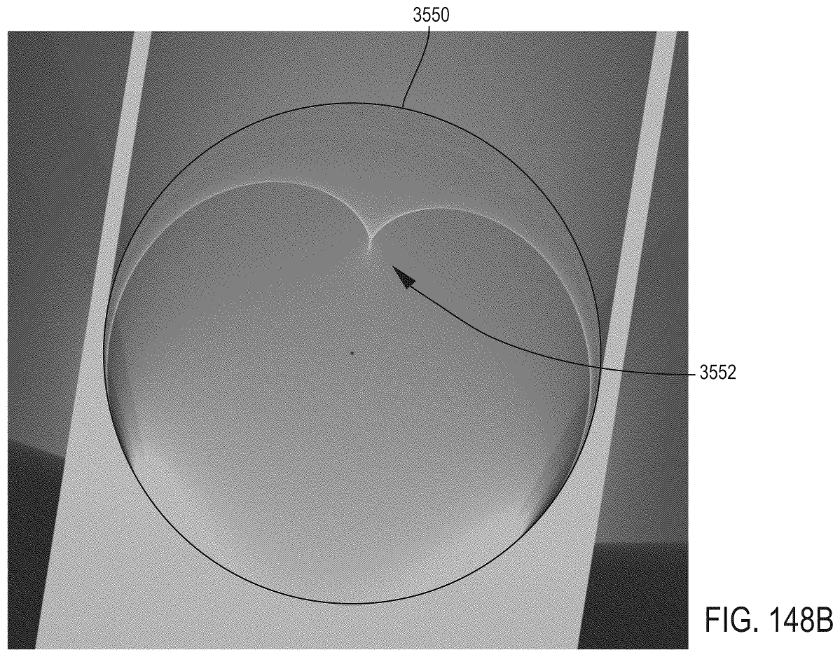

Referring now to FIGS. 148A-B, bubbles 3550 may be detected based on the manner in which they interact with light emitted from an external illuminator 3516. This may be particularly useful for identifying small bubbles and differentiating them from other similarly sized contents of interest. Representational diagrams of bubbles 3550 are depicted in FIGS. 148A-B. In general, due to the constant and evenly distributed pressures on the inside and outside of the bubbles 3550, a bubble 3550 takes on a shape which minimize its surface area. Thus, bubbles 3550 are typically spherical. Other contents of interest, however, have a very low likelihood of being as close to spherical as any bubbles 3550 present in a bag 26. The optical properties bestowed by the spherical shape of a bubble 3550 may be exploited to cause bubbles 3550 to have a consistent and highly perceptible appearance when imaged by a particulate inspection system 3500.

FIG. 148A depicts an example illustrative diagram of a bubble 3550 being illuminated with collimated light (e.g. from an external illuminator 3516 of the type described in relation to FIG. 145). The light may approach the bubble 3550 in collimated manner as shown. As mentioned elsewhere herein, the light may also be polarized. As required by Snell's Law, the path of the light will be perturbed by the bubble 3550. An illustration based on a computer simulation of the same is provided in FIG. 148B. The collimated light is directed at the bubble 3550 at an angle of 15° in FIG. 148B.

As shown, in each of FIGS. 148A-B, the light reflected within the bubble 3550 may be concentrated at a focused region 3552. This ultimately causes bubbles 3550 to create bright points of light within the bag 26. These bright points of light may be particularly discernable when viewed from certain angles (e.g. 30-35° inclined from an axis perpendicular to the bag 26 midplane). Bright points engendered by bubbles 3350 may be significantly brighter than other contents of interest within the bag 26. The color emitted by the external illuminator 3516 may also be selected to be different from that of any potential anticipated source of particulate. Thus, not only will bubbles 3550 generate bright points within a bag 26, these points may be in a known, predefined, and controllable in color. The color preferably is selected to be a color which would not be expected from any other contents of interest with a potential to be present in the bag 26. Bright points may be generated regardless of the volume of a bubble 3550. Large volume bubbles 3550 may generate bright points of light as well as very small microbubbles (e.g. 50-100 μm diameter bubbles 3550 or smaller).

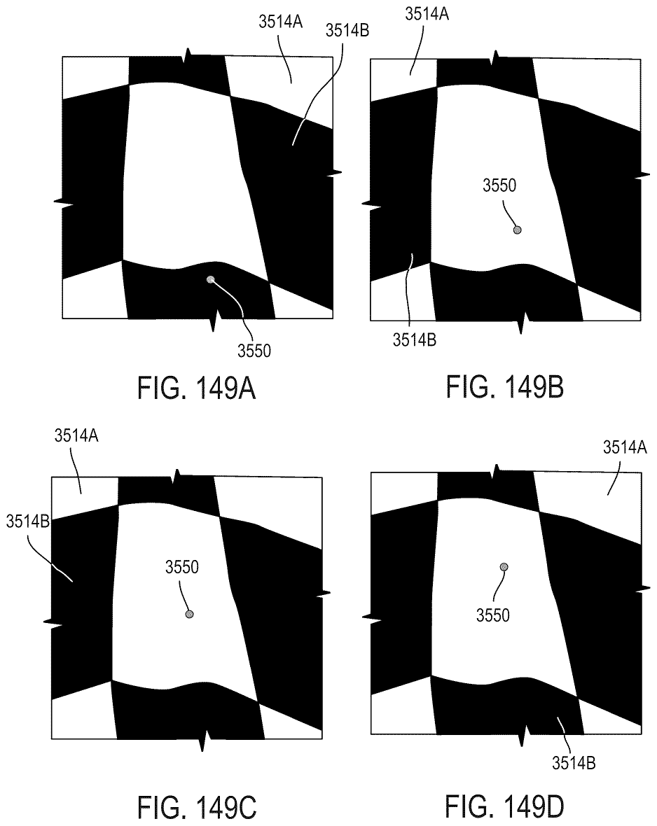

Referring now primarily to FIGS. 149A-D, a number of illustrations representative (though not exact reproductions) of portions of a bag 26 seen from an imager 3518 are depicted. Each of the illustrations depicts a bubble 3550 illuminated by an external illuminator 3516 such as that shown in FIG. 146C. The progression of FIGS. 149A-D depict the bubble 3550 displacing through the bag 26 due to, for example, buoyancy and/or agitation of the bag 26. The bubble 3550 is depicted as a grey circle which is representative of the bright light points described above. As shown, the bubble 3550 is readily distinguishable against light regions 3514A and dark regions 3514B of the background pattern.

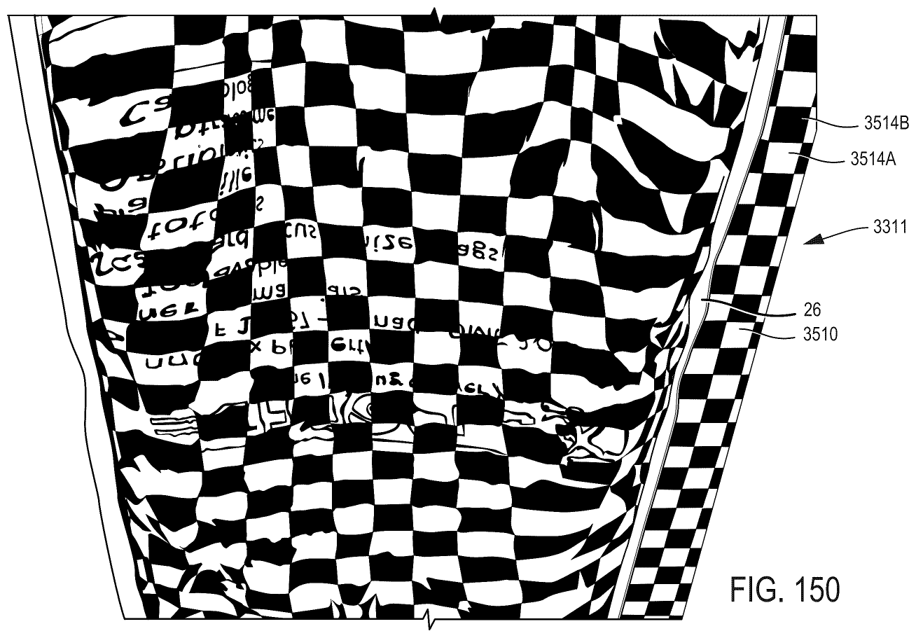

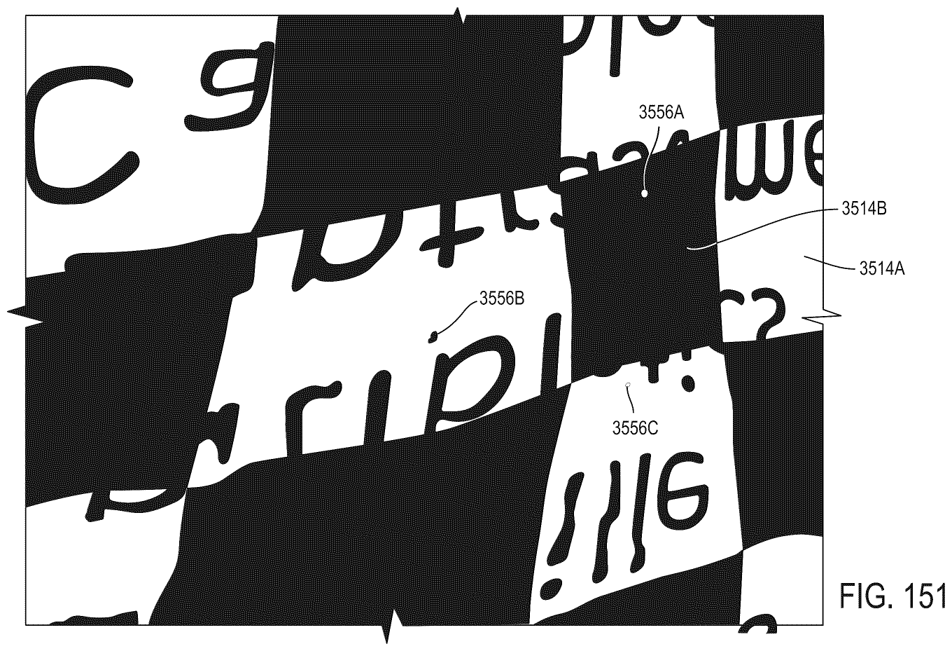

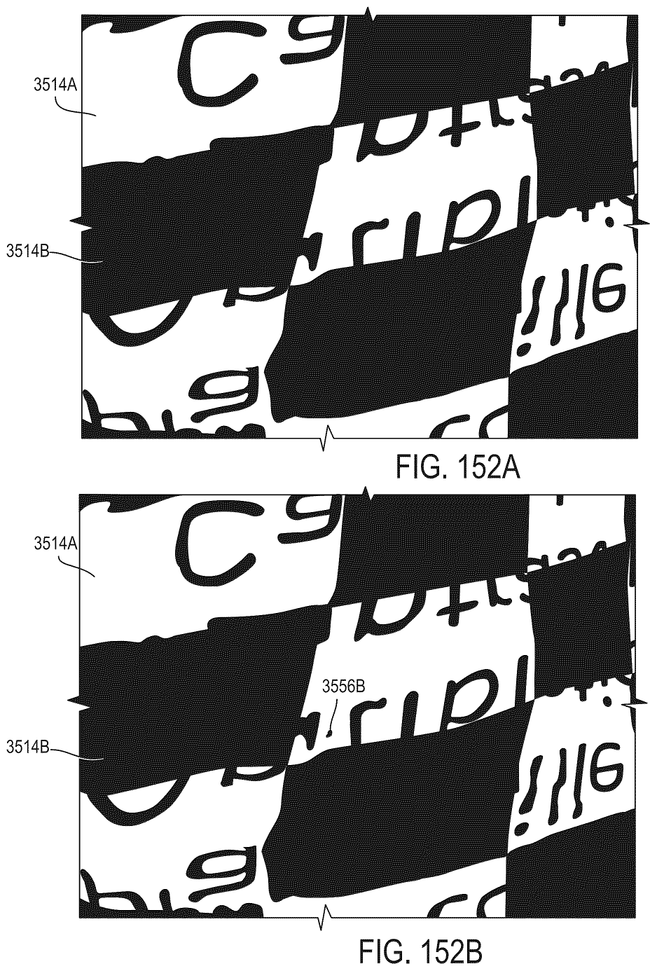

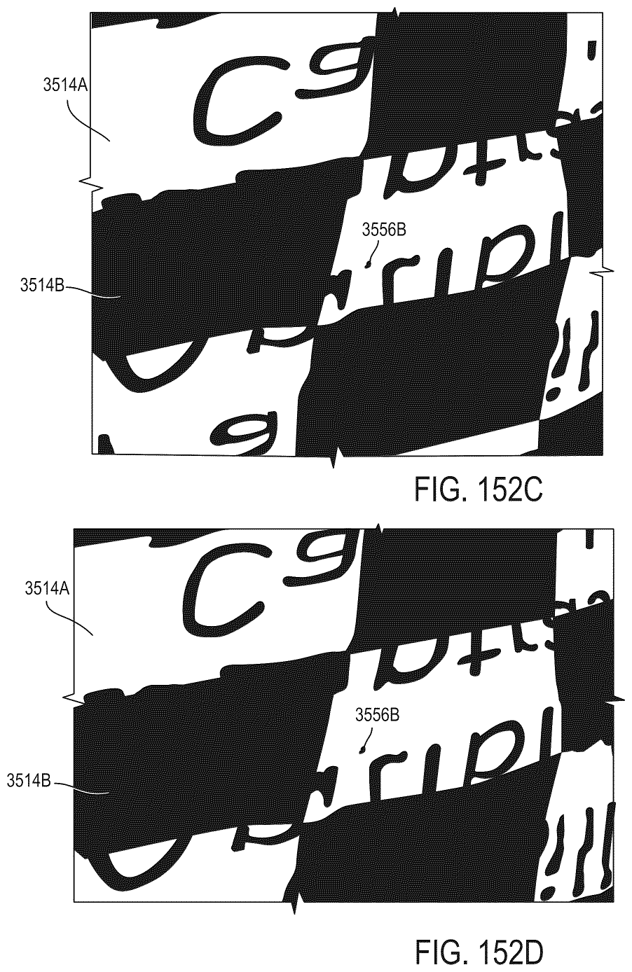

Referring to FIGS. 150-152D, further illustrations of portions of a bag 26 in place at a cradle 3311 of a particulate inspection system 3500 are depicted. The illustrations are representative of what would be seen from an imager 3518, but not exact reproductions of actual images. A representational frame is depicted in FIG. 150. An enlarged portion of the representational frame of FIG. 150 is depicted in FIG. 151. The dark and light regions 3514A, B of the rest body 3510 pattern are also visible in FIGS. 150-151. FIGS. 152A-D depict the portion of FIG. 150 shown in FIG. 151 over a period of time with an illustrative piece of particulate present (other particles in FIGS. 150-151 have been removed in FIGS. 152A-D).

Referring specifically to FIGS. 150-151, a number of pieces of particulate 3556A-C of differing colors are shown. For sake of illustration white particulate 3556A, black particulate 3556B, and clear particulate 3556C are depicted. These particulate colors are selected as worst case colors in order to illustrate various advantageous aspects of example particulate inspection systems 3500 described herein. Colors of particulate from potential particulate sources in a system 10 may have greater variety and may not include the colors shown.

As shown, the backlight pattern (or a backlight otherwise controlled to generate contrast, e.g., temporally) may facilitate visualization of various pieces of particulate 3556A-C as they displace within the bag 26. This may be true regardless of the color of a particular piece of particulate 3556A-C. Prior to capturing frames with the imagers 3518 of the particulate inspection system 3500, the rotary actuator 3470 (see, e.g., FIG. 146C) may be commanded to rotate the cradle 3311 and bag 26 through an agitation sequence or motion profile. The agitation sequence may, in some examples, be a series of rotations as described in relation to FIG. 144. In such embodiments, mixing of the fluid within the bag 26 may also serve to agitate the fluid within the bag 26 for the particulate inspection system 3500. In alternative embodiments, the agitation sequence may occur at a different time point (e.g. subsequent) mixing. In such embodiments, the agitation sequence may include serial rotations between pairs of angular position. The rotation rate commanded by the control system 15 to the rotary actuator 3470 may be lower than the rotation rate used during mixing. The rotation rate used for agitation may be a function of the frame capture rate of the imagers 3518.

As best shown in FIGS. 152A-D, the agitation sequence may cause particulate within the bag 26 to displace. As the cradle 3311 includes a pattern of repeating dark and light regions 3514A, B, a particle may displace across contrasting regions as a result of the agitation. Thus, particles which may be difficult to visualize on one background color may transit over a second background color against which they may be more easily seen. Providing contrast by temporally adjusting an illuminator 3512 may similarly facilitate visualization of particles which are difficult to see against certain background colors. FIGS. 152A-D depict a black particle 3556B for sake of example. The black particle 3556B is not visible in FIG. 152A as it is in alignment with a dark region 3514B of the background pattern. Due to the agitation of the fluid within the bag 26, the black particle 3556B transits over light regions 3514A of the background pattern as time progresses. As an imager 3518 captures additional frames with the black particle 3556B over light regions of the background pattern, the black particle 3556B is readily distinguishable. This is best shown in FIGS. 152B-D. The size of the light and dark regions 3514A, B may typically be made relatively small to assist in maximizing the number of transitions across light and dark regions 3514A, B for a given particle. A white or light colored particle would complimentarily be readily distinguishable as it moves over dark regions 3514B of the background pattern.

With respect to substantially transparent particles, movement of the particle may similar assist in visualizing the particle within the reservoir or bag 26. The transparent particle will distort light passing through it. The reflected or refracted light would be able to be visualized against the background pattern as the particle displaces. Transparent particles will also distort the background pattern. Again, this may assist in allowing visualization of such particles.

Referring now to FIG. 153, an example data flow diagram 3570 of a particulate inspection system 3500 is depicted. As shown, a number of imagers 3518 are included and each have a field of view 3572 which includes a portion of a bag 26 in place at a cradle 3311. Each of the fields of view 3572 overlaps with that of at least one other imager 3518. The imagers 3518 may capture raw video streams 3574A, B, C. The raw video streams 3574A, B, C may be committed to a log file 3590 associated with the subject bag 26 via a unique identifier for the bag 26. The log file 3590 may also include other identifying information. For example, the log file 3590 may include a date and timestamp. Other potential information may include a unique identifier specific to the individual system 10 in which the particulate detection system 3500 is included or for the particulate detection system 3500 itself. The type of solution in the bag 26 may be included in some embodiments. Software version for the system 10, particulate detection system 3500, and/or neural network version (further described elsewhere herein), any calibration data or settings, user ID information, etc. may also be included in a log file 3590.

In the example, each of the raw video streams 3574A, B, C is also communicated to a server 3576. In other examples, the server 3576 may be replaced with a microprocessor, graphical processing unit, application specific integrated circuit, programmable logic controller, complex programmable logic device, field programmable gate array, or other dedicated processing hardware, and combinations thereof. Dedicated hardware such as an FPGA may be desirable as it may speed processing and remove burden from other processors in the control system 15. Communication may be via a wireless protocol or communication may be wired (e.g. via USB 3.2) depending on the embodiment. The server 3576 may, in some examples, be remote (e.g. cloud) and may receive data from a plurality of client systems 10. Distributed computing environments may also be used.

The server 3576 may fed the raw video stream 3574A, B, C from each imager 3518 into a respective queue. Frames may be extracted from the respective queues and fed into a respective thread. Frames from each thread may then be analyzed for the presence of particles. Analysis on all frames corresponding to a subject bag 26 may be required to be completed before data from another bag 26 is analyzed. In some embodiments, frames of a given bag 26 from each imager 3518 may be processed in series. In other examples, threads of frames from each imager 3518 for a given bag 26 may be processed concurrently.

Analysis of the video may include pre-processing 3578 and detections and tracking processing 3580 (see, e.g., FIGS. 154-156 and FIG. 166). The pre-processing 3578 may include background subtraction, foreground isolation, filtering with a foreground mask, kernel morphological transformations such as dilations, erosions, openings, closings, morphological gradients, image noise reduction filtering, etc. The pre-processing 3578 may generate processed video streams 3582A, B, C from the raw video streams 3574A, B, C. The processed video streams 3582A, B, C may also be committed to the log file 3590. The pre-processing may also include an analysis of the image data to identify features captured in the frames which are to be determined invalid candidates for further analysis. For example, the pre-processing may identify features which are defined by more than a predetermined number of constituent pixels and flag them as invalid.

The detection and tracking processing 3580 may utilize the processed video streams 3582A, B, C and generate a contents analysis file 3584 (e.g. CSV). The contents analysis file 3584 may specify displacement paths or tracks for any regions of interest within frames that are identified in the processed video streams 3582A, B, C. Image regions of interest may be pixels or pixel collections that appear to displace across the background from frame to frame. Tracks may be determined by comparing adjacent or temporally proximate frames for a pixel cluster that has moved between the frames. If, for instance, the temporally proximate frame includes a pixel cluster within a threshold distance from a pixel cluster's location in the earlier frame, it may be identified as a displacing region of interest. A prediction could be made (e.g. via a Kalman filter) for a pixel cluster's position in a temporally proximate frame and if a pixel cluster in the proximate frame sufficiently corresponds with the prediction, a displacing region of interest may be identified or declared. Clusters of pixels which move across the background may be documented in the contents analysis file 3584, though the contents analysis file 3584 may also include data on single pixel size outputs that displace in this manner as well. The displacement path may be a set of coordinates for each frame in the processed video stream 3582A, B, C. Snapshots of the regions of interest in each frame may also be placed in the contents analysis file 3584. The content analysis file 3584 may also be committed to the log file 3590.

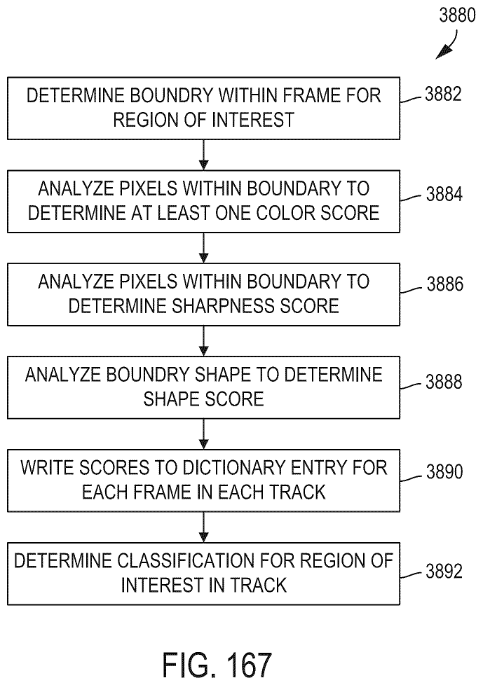

Classifications processing 3586 may be performed to analyze the contents analysis file 3854 to determine if the subject bag 26 includes contents of a first classification, second classification, and potentially further classifications (further described in relation to FIG. 167). The classifications may determine if any of the image regions interest meet one or more undesirable content identification criteria. Regions of interest may be assigned classifications by the classification processing 3586. Classifications may be binary (e.g. benign or undesirable, particle or bubble, first classification or other, bubble or not bubble) or may include additional information. For example, certain embodiments may classify a region of interest in a genus and potentially a species. For example, the classification processing may identify a region of interest as a particle (genus) of undissolved concentrate (species). Alternatively, the classifications processing could class a region of interest as a particle (genus) and a fiber, hair, or elongate particle (species), or particle of a particular color (species). Various other genus and species type classifications are also possible. The above are merely non-limiting examples. An inspection pass/fail indication 3588 may be generated based on the classifications and output by the classification processing 3586. In the event that no image regions of interest are detected or that none of the image regions of interest meet an undesirable content identification criteria, the classifications processing 3586 may determine the bag 26 is acceptable. In the event that one or more region of interest meets an undesirable content identification criterion, the classifications processing 3586 may determine the bag 26 fails inspection. The classifications processing 3586 may in some embodiments be performed by a convolutional neural network which receives as input a cropped image of every region or pixel cluster of interest associated with a given track. Alternatively or additionally, regions of interest may be analyzed by the classifications processing 3586 and assigned various scores (color, blurriness, shape, size, brightness, trajectory, etc.). The scores may be analyzed to generate a classification of the region of interest.

Where a convolutional neural network is used, the convolutional neural network may be trained using bags 26 with known contents. The system 10 used to fill the bags 26 may be reviewed to determine potential sources of particulate. Potential sources of particulate from the bag 26 (or other reservoir) manufacturing process or bag 26 itself may also be identified. Identified potential particulates may then be deliberately introduced into, included in, or created within training bags 26 which are then placed in a particulate inspection system 3500. The training particulate would be representative (size, aspect ratio, density, buoyancy, solubility, color, roughness, material type, etc.) of any particulate encountered during true usage scenarios.

Additionally, the training bags 26 may be generated to entirely or substantially remove confounding contents of interest. For example, in bags 26 dosed with training particulate, the bags 26 may be filled with fluid which has been filtered and degassed. For example, the fluid may be degassed via heating, ultrasonic degassing, vacuum, or some combination thereof. Additionally, for any training bags 26 including particulate, a syringe or similar implement may be introduced into the bag 26 once filled. Remaining air in the bag 26 is withdrawn with the syringe to eliminate or substantially eliminate any headspace in the bag 26. The bag 26 may be utilized for training relatively quickly to prevent any transmission of gas through bag 26 material.

For undissolved concentrate, bags 26 may be dosed with concentrate to their saturation point and additional concentrate may then be added. Alternatively, water vapor may be allowed or encouraged to evaporate through the bag 26 material until, for example, at least some concentrate in a brine contained with the bag 26 falls out of solution. Degassed, filtered water may be added to the bags 26. The bags 26 may be agitated, though not agitated aggressively enough to redissolve the crystallized concentrate and quickly utilized for training to prevent the crystallized concentrate from fully dissolving. Alternatively or for additional training bags 26, a filtered and degassed saturated solution of the same variety as the concentrate already in the bag 26 may be introduced to prevent or mitigate redissolution of the crystallized concentrate.

Training bags 26 containing bubbles but no particulate may also be generated. Two bags 26 may for example be placed into communication with one another. A fluid path from a first to the second bag may be present and may include a check valve upstream of a filter. Fluid from the first bag may be passed through the filter to the second bag. A fluid path from the second bag to the first bag may be present and may include a check valve upstream of a filter. Fluid may be passed from the second bag to the first bag. This may be repeated a number of times. The check valves may ensure flow through each filter is unidirectional. Thus, any particulate in the bags 26 may be collected by the filters and removed from the liquid in the bags 26. Integrity of the filters may be subsequently verified (e.g. with a bubble point test). This may allow a bag 26 which contains air bubbles, but substantially no particulate, to be produced for training.

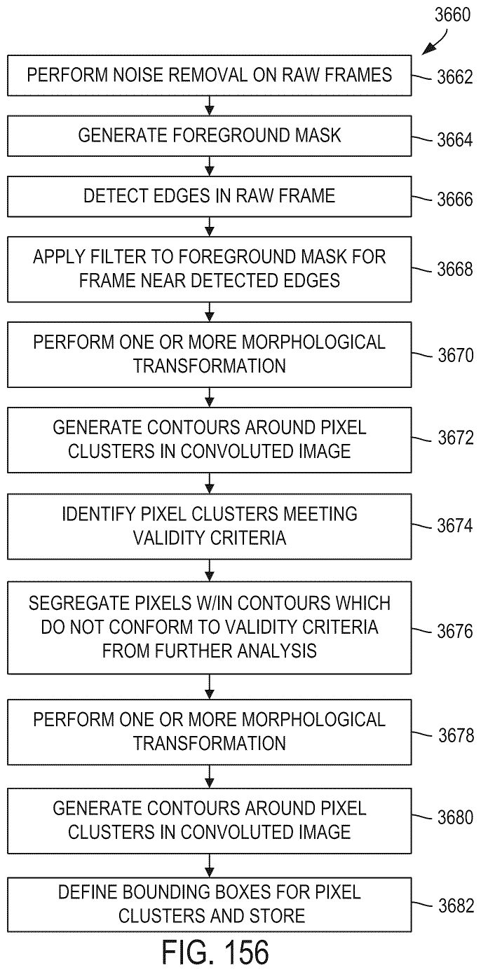

The training bags 26 may be displaced in a mix assisting assembly 2500 according to the displacement profile used during normal operation and images may be captured of the bag 26. Illumination, imager 3518 placement, lens filters, etc. may be kept consistent with true usage conditions. Data from such images may be used as ground truth datasets to train the convolutional neural network. Regions of interest corresponding to the known bag 26 contents may be detected (see, e.g., FIG. 156) and input to the convolutional neural network as training data.

A pass or fail indication from the classifications processing 3568 may be written to the log file 3590. In the event the bag 26 fails inspection it may be marked as rejected and placed in a quarantine or discard location after removal from the particulate inspection system 3500. The log file 3590 may be communicated to a database 3589 for remote review and analysis.

In some embodiments, a notification may be generated in the event a fail indication is determined. The notification may be generated for display on a graphical user interface of the system 10. Depending on the classification, a suggestion may also be made (and potentially displayed in the notification) as to a likely source (or sources) for the particulate. For instance, a processor of the control system 15 may check the classification against a list of potential sources of particulate. The list could include, for example, score sets for respective potential sources determined using bags deliberately dosed with particulate from those sources (or representative of those sources). Scores closely matching those of an item in the list may cause the suggestion to identify that specific item (or a set of best matches from the list). If the particulate is, for example, classified as green and the only potential green source of particulate is present in the manufacturing environment for the reservoir, the suggestion may indicate the source is likely the manufacturing environment (or a specific component therein).

In the event that excessive computation time has been required for analysis, a notification may similarly be generated for display. For example, if the control system 15 takes greater than a threshold amount of time to detect, track, and classify regions of interest in a bag 26, a fault may be triggered and a notification to that effect may be communicated to a user via a graphical user interface 6100. In the event that the number of regions of interest determined to be particles is higher than a threshold, the control system 15 may trigger a fault. A notification may, for example, be generated by the control system 15 indicating an upstream problem in the system 10 or manufacturing environment may be present.

Referring now to FIG. 154, a flowchart 3600 depicting a number of example actions which may be executed to detect the presence of contents of interest within a bag 26 is depicted. A particulate inspection system 3500 may agitate a bag 26 (or other reservoir) in block 3602. This may be accomplished by issuing commands from a control system 15 to a rotary actuator 3470 of a particulate inspection system 3500. A dwell time may then elapse in block 3604. The dwell time may vary from embodiment to embodiment, but may be 3-10 seconds (e.g. 5 seconds) in some examples. Once the dwell time has elapsed, the control system 15 may command capture of video frames by each of imager 3518 of the particulate inspection system 3500 in block 3606. At least 70 (e.g. 100) frames from each imager 3518 may be captured over some predetermined period of time for each bag 26. In other examples, less than 70 frames may be collected. Each raw video stream 3574A, B, C may, for example, be captured at a rate of 10 frames per second. Raw video streams 3574A, B, C captured from each imager 3518 for each bag 26 may be ten seconds in length. In block 3608, the raw video streams may be processed by a processor of the control system 15. The processed video frames may be analyzed by a processor of the control system in block 3610.

If, in block 3612, particulate identification criteria are not met, it may be determined that the bag 26 has passed inspection in block 3614. The control system 15 may document the pass and save a log file in block 3616. The control system 15, in block 3618, may command the bag 26 be collected from the particulate inspection system 3500 and displaced to a labeling or marking assembly 3700. The bag 26 may also be labeled with an indication that the bag 26 is acceptable (e.g. embossed with an expiration date) in block 3618. In block 3620, the bag 26 may be displaced to an outfeed from the system 10.

If, in block 3612, particulate identification criteria are met, it may be determined that the bag has failed inspection in block 3622. The control system 15 may document the failure and save a log file in block 3624. The control system 15, in block 3636, may command the bag 26 be collected from the particulate inspection system 3500 and displaced to a labeling or marking assembly 3700. The bag 26 may also be labeled with an indication that the bag 26 is not to be used (e.g. embossed with the word “REJECT”) in block 3626. In block 3628, the bag 26 may be segregated within the system 10. The bag 26 may be placed in a quarantine or discard receptacle, for instance (see, e.g., receptacles 4120B of FIG. 185).

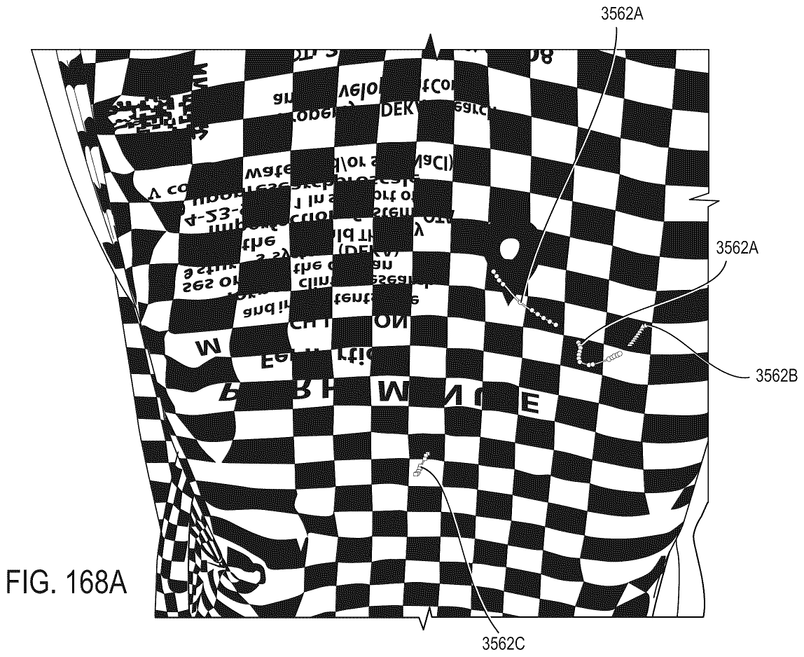

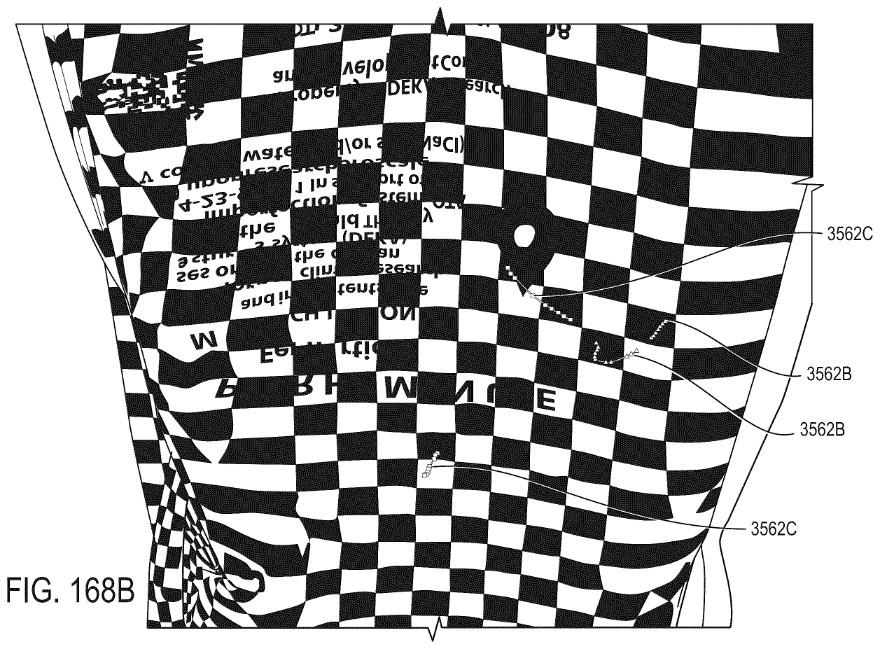

The log files 3590 saved in blocks 3616, 3624 may include any of the raw video, processed video(s), frames thereof, an analysis summary, pass/fail determination, bag 26 or lot identifying information, information about the contents of the bag 26, a unique identifier for the bag 26, etc. In some embodiments, the processed video streams 3582A, B, C may be scaled down before addition to the log file 3590. In other embodiments, a trail may be generated for each region of interest identified and may grow over each frame to show the historical position of the region of interest over the course of the video. The trail may be generated by interpolating between the coordinates of each specific region of interest over adjacent frames. In other examples, a summary may be generated for inclusion in the log 3590. In some examples, the summary may be an annotated version of a frame (e.g. the final captured frame) from each imager 3518. The annotated frame (see, e.g., FIG. 168B) may include a trail of any contents of interest identified in the video frames and a classification of the content of interest (e.g. bubble or particle, bubble/not bubble). Any inspection log files 3590 may be communicated to a database for storage and remote review. Summaries may be or include a data file (e.g. CSV) giving coordinates for each tracked content of interest and respective classification determinations.

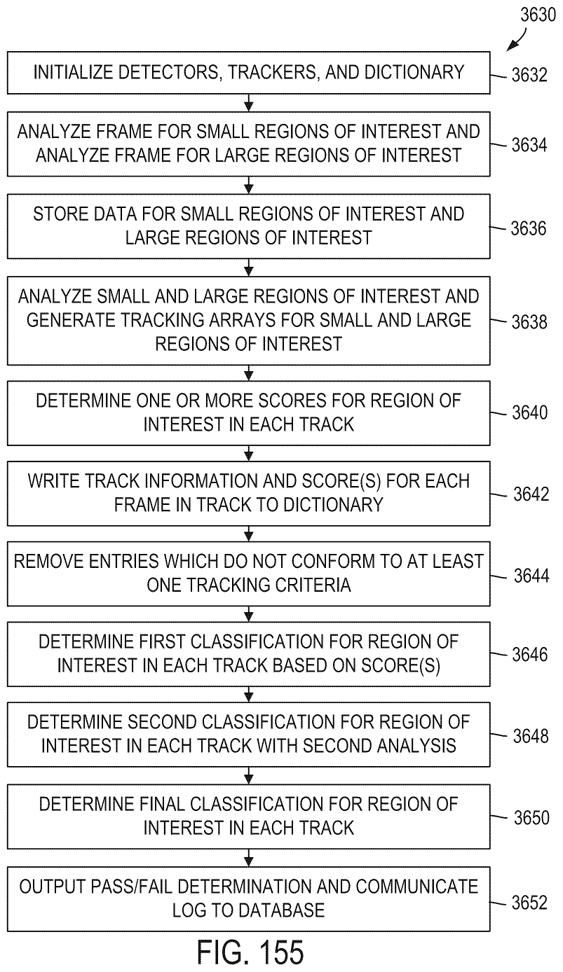

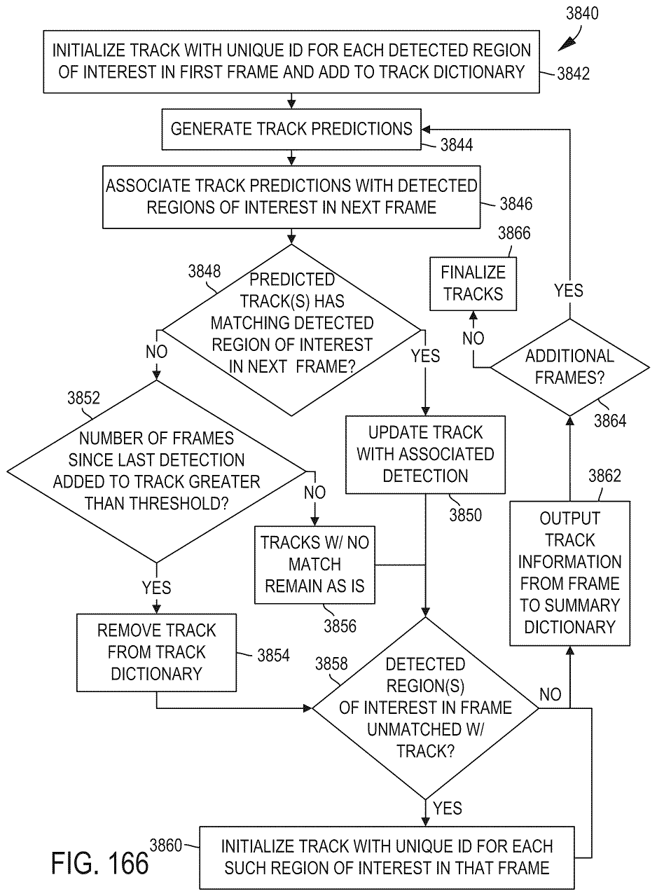

Referring now to FIG. 155, another flowchart 3630 detailing a number of exemplary actions which may be executed to detect and track contents of interest within a bag 26 over a number of video frames is depicted. In block 3632, a processor of the control system 15 may initialize a number of detectors (see, e.g., FIG. 156), trackers (see, e.g., FIG. 166), and at least one dictionary. In some embodiments, a detection dictionary (e.g. an array for storing detection information), a tracking dictionary (an array for storing track information during analysis), and a tracking record dictionary may be initialized. The tracking record dictionary may be a data repository including a selection of information relating to tracks for regions of interest in frames captured by imagers 3518 of a particulate inspection system 3500. Coordinates within a frame, various scores such as any of those discussed herein (see, e.g., FIG. 167), and a clipped snapshot of any regions of interest for each frame may for example be stored in the tracking record dictionary.

In block 3634, each frame from each imager 3518 may be analyzed for small regions of interest and large regions of interest. Frames may be analyzed sequentially and may be analyzed one imager 3518 at a time. Small regions of interest may be for example be those having an area of 5,000 pixels or less and large regions of interest may be those having an area greater than 5,000 pixels. Regions beyond a certain size (e.g. area greater than 20,000 pixels) may be ignored in certain embodiments. Alternatively each frame may be analyzed for additional region of interest size ranges (e.g. extra-large having an area greater than 20,000 pixels). Detection of regions of interest is further described in relation to FIG. 156.

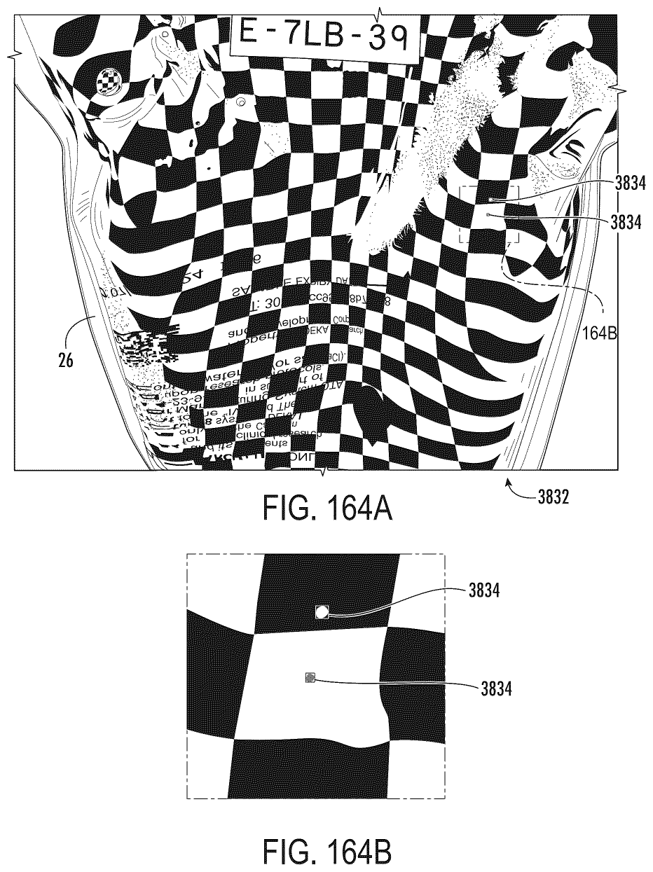

Each identified region of interest for each frame may be assigned a bounding box 3834 (see, e.g. FIGS. 164A-B) which delineates the region of interest. The bounding boxes 3834 may be stored (e.g. written to an array) in block 3636. Small and larger regions of interest may be analyzed by a processor of the control system 15 in block 3638 to identify displacement tracks for individual regions of interest across a plurality of frames. Tracking of regions of interest is further described in relation to FIG. 166. Any suitable tracking algorithm may be utilized. For example, a multiple object tracking algorithm may be utilized. In some implementations a SORT (Simple Object Realtime Tracking) algorithm, MHT (multiple hypothesis Tracking) algorithm, JPDA (Joint Probabilistic Data Association) algorithm, etc. may be used.

In block 3640, a processor of the control system 15 may analyze the tracks and assign one or more scores to each identified track. Scoring is further described in relation to FIG. 167. The track information and associated scores may be saved (e.g. written to a tracking record dictionary) in block 3642.

In some embodiments, and as shown in block 3644, entries which do not conform to one or more tracking criteria may be removed. A track may be required to persist over at least some predefined number of frames. A region of interest generating the track may also or instead be required to displace at least some predefined distance (e.g. number of pixels). Tracks which do not meet these criteria may be removed from further consideration. They may be deleted from a tracking record dictionary or separate dictionary used to facilitate region of interest tracking in certain example embodiments.

A first classification for the region of interest associated with each track may be determined based on the at least one score in block 3646. At least one additional classification for the region of interest associated with each track may be determined in block 3648. Each additional classification may be determined with a different variety of analysis. In certain embodiments, a convolutional neural network trained on images of bags 26 with known contents may be used. In block 3650, a final classification may be determined for the region of interest associated with each track. The final classification may be determined based on at least one of the first classification and additional classifications. Alternatively, data (e.g. scores) used to determine any of the non-final classifications may be analyzed to arrive at the final classification. Certain data from one analysis may be weighted heavily or be controlling on the classification determination. For example, in the event a shape score indicates the region of interest is highly elongate, the region of interest has a very low likelihood of being representative of a bubble. The shape score may become controlling or strongly predominate toward as identifying the region of interest as a non-bubble when it is indicative of an aspect ratio beyond a predetermined threshold.

An acceptability determination (e.g. pass/fail) may be made based on the final classification in block 3652. A log 3590 may also be generated in block 3652 and communicated to a database 3502 (see, e.g., FIG. 153) or other electronic storage medium. Electronic memories described herein may be any of a variety of types including optical memories (Blu-Ray, DVD, CD, etc.), USB sticks, flash drives, solid state storage devices, hard drives or other magnetic storage media, secure digital or SD card, database, EEPROM, etc.

The log 3590 (see, e.g., FIG. 153) may include a CSV of track identities and frame by frame coordinates for each region of interest. The log 3590 may also include raw images generated by the imager 3518. At least one set of processed frames (frames after background subtraction, kernel convolution, etc.) generated from the raw images may be included in a log 3590. The log 3590 may also include an annotated version of the final frame collected by each imager 3518 with the tracks overlaid thereon. Lines interpolating the travel path between frame by frame coordinates for each region of interest may be drawn over the image. The final classification may also be indicated on the annotated image. In some embodiments, the frames from each imager 3518 may be stitched together to form a single image of the entire reservoir. An annotated image (see, e.g., FIG. 168B) may be included in the log 3590.

Referring now to FIG. 156, a flowchart 3660 depicting a number of example actions which may be executed to detect regions of interest within images of a reservoir is depicted. Throughout the description of FIG. 156, reference is made to FIGS. 157-165B which provide representations of exemplary images relating to aspects of the flowchart 3660. The representations are not exact reproductions of actual images and are provided for illustrative purposes. Certain features may be removed and others adjusted or exaggerated to facilitate illustration and reproducibility. Where image is used herein to describe the content of a particular drawing, it should be understood the “images” are representative illustrations.

As shown, in block 3662, a processor of the control system 15 may receive each raw frame 3684 and denoise the frames. A representation of a raw frame 3684 is shown in FIG. 157. To denoise the image, values assigned to pixels may, for instance, be adjusted based on an average or weighted average of surrounding pixels. Some specific examples implement Gaussian smoothing for denoising raw frames 3648

The frames from each imager 3518 may be analyzed by a processor of the control system 15 to generate a foreground mask in block 3664. This may be accomplished in any suitable manner. In various examples, a Gaussian mixture based background/foreground segmentation algorithm may be used. An Open CV MOG or MOG2 algorithm may be utilized for instance. In other embodiments, statistical background image estimation combined with per pixel Bayesian segmentation may be used. Deep neural networks, robust principal component analysis (RPCA) segmentation, Dynamic RPCA, etc. are non-limiting alternative options.

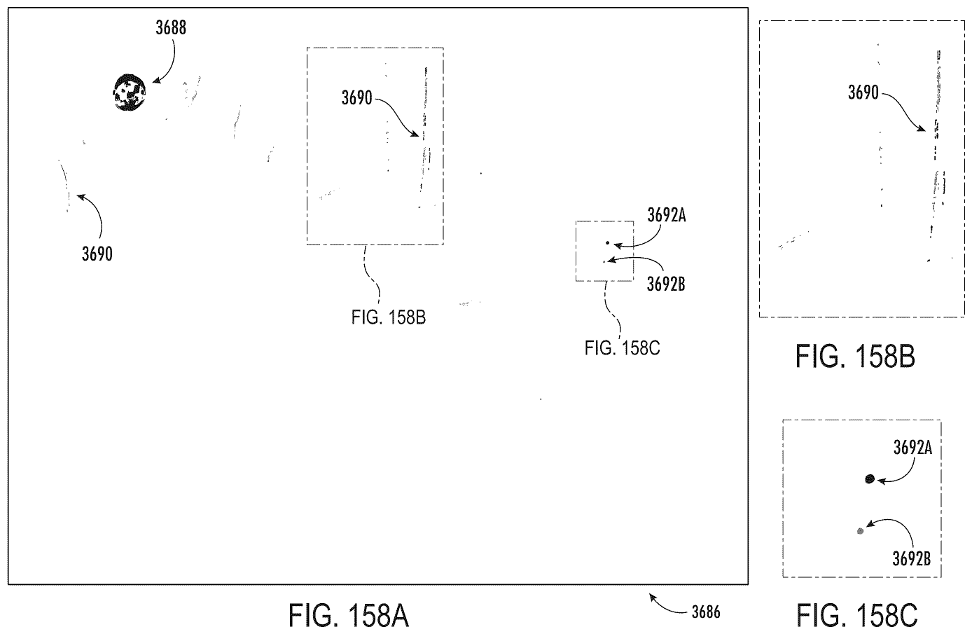

Referring now also to FIGS. 158A-C, a foreground segmented image 3686 representative of what would be generated from the raw frame 3684 depicted in FIG. 157 is depicted. As shown, the dark and light regions 3514A, B of the background pattern on the rest panel 3510 have been removed in the foreground segmented image 3686. Additionally, various edges, crinkles, and folds in the bag 26 or other stationary features are removed. Text on the bag, scratches, logos, appliqués, etc. would be removed. The representative foreground segmented image 3686 provided in FIG. 158A includes a first collection of pixels 3688 in a region corresponding to the location of a relatively large bubble 3838 in FIG. 157. The bubble 3838 is against the wall of the bag and the collection of pixels 3688 may be present due to slight movement of this bubble 3838 and/or settling of the bag 26 over time. As best shown in FIG. 158B, an enlarged portion of the indicated region in FIG. 158A, there may be some small remnants 3690 of the background in the foreground segmented image 3686. These remnants 3690 could be representative of features of the bag 26 or the pattern on the rest body 3510 for instance. The background remnants 3690 may be present, due to subtle settling or shifting movement(s) of the bag 26 over the progression of raw frames 3684 taken by an imager 3518. The representational background segmented image 3686 also includes some putative regions of interest 3692A, B as shown in FIG. 158C (an enlarged portion of the indicated region of FIG. 158A).

Again referring to FIG. 156, in block 3666, a processor of the control system 15 may analyze the raw frames 3684 and detect edges within these frames 3684. An edge detection algorithm may be used for this purpose. Any suitable algorithm may be used. In some example a multi-stage algorithm such as a Canny edge detection based algorithm may be used. Gradient based (e.g. Sobel, Scharr, Prewitt, Roberts Cross edge detection) or second order derivative type (e.g. Laplacian) edge detection algorithms may be used. An edge image may be created from each of the raw frames 3684. Binary thresholding may be applied to ensure the edge image is a black and white only output.

A filter may be applied to the foreground segmented image 3686 created from each raw frame 3684 near the detected edges in the respective raw frame 3684 in block 3668. Applying a filter to the foreground segmented image 3686 may assist in filtering out edges detected due to settling motion of flexible reservoirs (e.g. bags 26) over the imaging window. In some embodiments, a morphological transformation may be applied to the edge image. For example a dilation type kernel convolution may be applied. This may thicken the detected edges to better accommodate shifting of certain types of reservoirs over time.

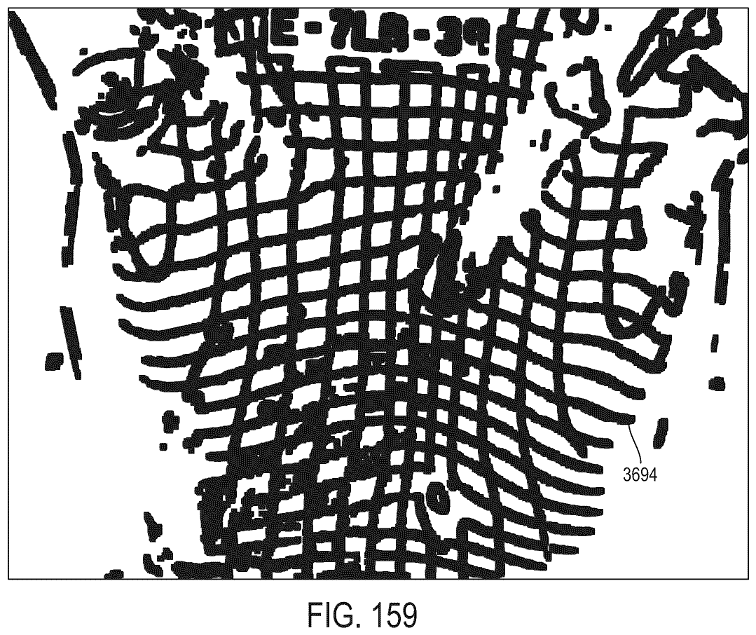

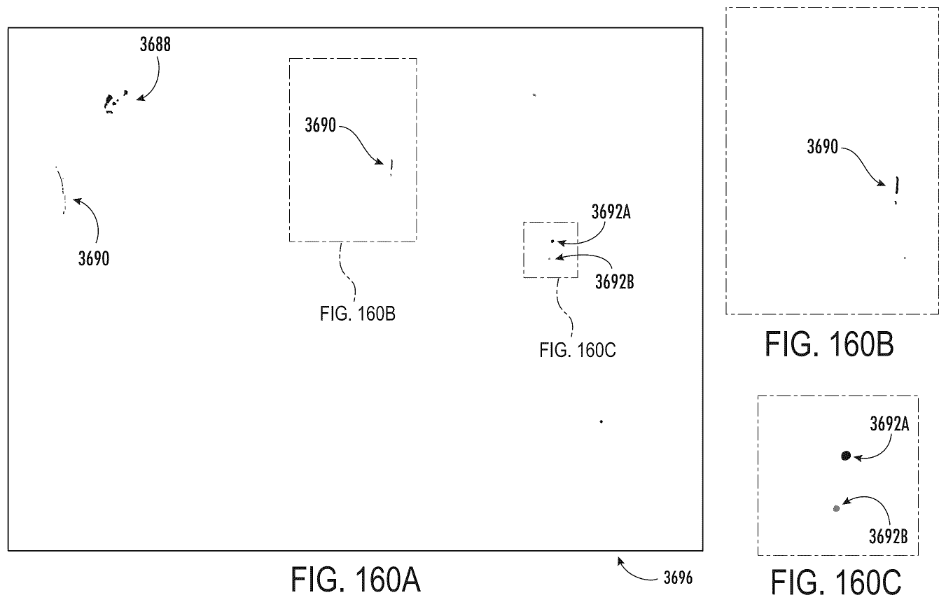

FIG. 159 depicts a visualization of detected edge regions 3694 (after dilation) in the raw frame 3684 represented by FIG. 157. Regions of the raw frame 3684 where edges are determined to be present are shown in black in FIG. 159. A representative near edge filtered foreground segmented image 3696 is depicted in FIG. 160A. The near edge filtered foreground segmented image 3696 is exemplary of what would be generated from the foreground segmented image 3686 of FIG. 158A. As shown best in FIG. 160B, the background remnants 3690 may be entirely removed or substantially diminished after applying filtering in regions of the image near detected edges. The example putative regions of interest 3692A, B may be relatively unaltered.

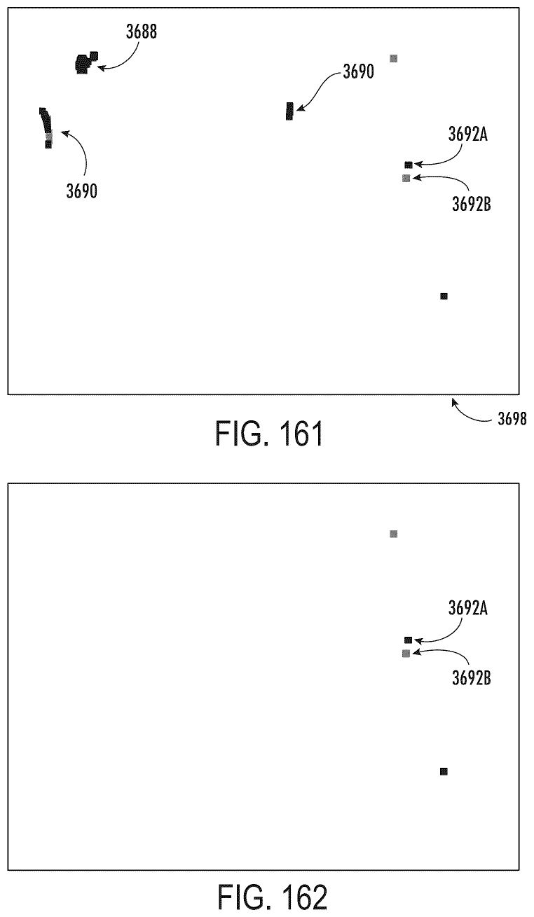

Referring again to FIG. 156, in block 3670 one or more morphological transformation is performed on the near edge filtered segmented foreground image 3696 corresponding to each raw frame 3684 by a processor of the control system 15. In certain implementations a kernel convolution such as a dilation may be performed. A representation of an exemplary dilated image 3698 generated from the near edge filtered foreground segmented image 3696 of FIG. 160A is depicted in FIG. 161. A dilation may make collections of pixels ultimately corresponding to large features in the raw image 3684 become one or more amalgamated regions of pixels. As shown, the collection of pixels 3688 corresponding to the large bubble 3838 in the raw frame 3684 (see, e.g., FIG. 157) is represented by a contiguous region of white pixels in the dilated image 3698. The background remnants 3690 are also dilated into continuous streaks of pixels. The regions of pixels defining the putative regions of interest 3692A, B are enlarged, but no so much as to merge.

With reference to FIG. 156, contours may be generated around pixel clusters of interest in the convoluted image in block 3672. Contours may be generated via a contour tracing algorithm such as a pixel or border following algorithm, a vertex following algorithm, or a run-data based algorithm. In some examples, a square tracing algorithm, Moore-Neighbor Tracing (e.g. with a Jacob's stopping criterion) algorithm, radial sweeping algorithm, Pavlidis algorithm may be used. The contours may be compared against one or more validity criteria in block 3674. The validity criteria may be a range for the total number of pixels, or area in pixels within the identified contour. If more than a threshold number of pixels are included within the bounds of a contour, the contour may be determined to be invalid. Alternatively or additionally, if less than a threshold number of pixels are included within the bounds of a contour, the contour may be determined to be invalid. Pixels in the dilated image 3698 corresponding to large features in the raw image 3684 and background remnants 3690 may typically be characterized as invalid due to their merger and resultant size. Pixels within contours which do not conform to the validity criteria may be removed from further analysis in block 3676. A representation of the dilated image 3698 of FIG. 161 with pixel clusters in invalid contours removed is shown in FIG. 162.

With reference to FIGS. 161-162, in some examples, a statistical analysis for each pixel cluster of interest may be determined by the control system 15. A confidence interval may, for example, be calculated for each pixel cluster of interest which is representative of the strength of the signal for that pixel cluster. Clusters with a lower signal to noise ratio (e.g. after Gaussian smoothing) would have a wider confidence interval. For sake of example, black is used to depict clusters of interest with tight confidence intervals and gray is used to depict clusters of interest with confidence intervals wider than some predefined threshold. In some examples, if a confidence interval calculation is wider than some predefined threshold, the pixel cluster of interest may be flagged as invalid and removed from further analysis. Alternatively, a confidence interval may be determined for each non-background pixel in an image (see, e.g., FIG. 158A) and carried through the rest of the detection analysis.

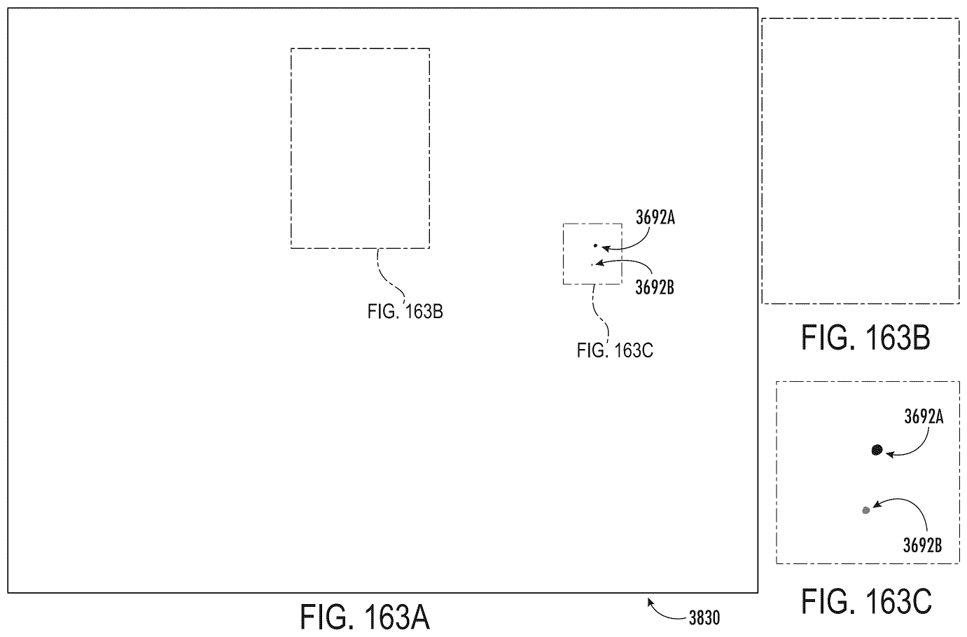

In block 3678, one or more morphological transformation different from that in block 3670 may be performed on the near edge filtered foreground segmented image 3696 created from each raw frame 3684. A kernel convolution such as an erosion may be used. A representation of an exemplary eroded image 3830 generated from the near edge filtered foreground segmented image 3696 of FIG. 160A is depicted in FIG. 163A. The erosion may return or substantially return pixel clusters to their original size and shape. At the same time, the erosion may also cause the pixel clusters have a sharper appearance. As shown, the eroded image 3830 includes the putative regions of interest 3692A, B (best shown in FIG. 163C) but the collection of pixels 3688 is absent. Additionally, as illustrated by FIG. 163B, the background remnants 3690 are absent as well.

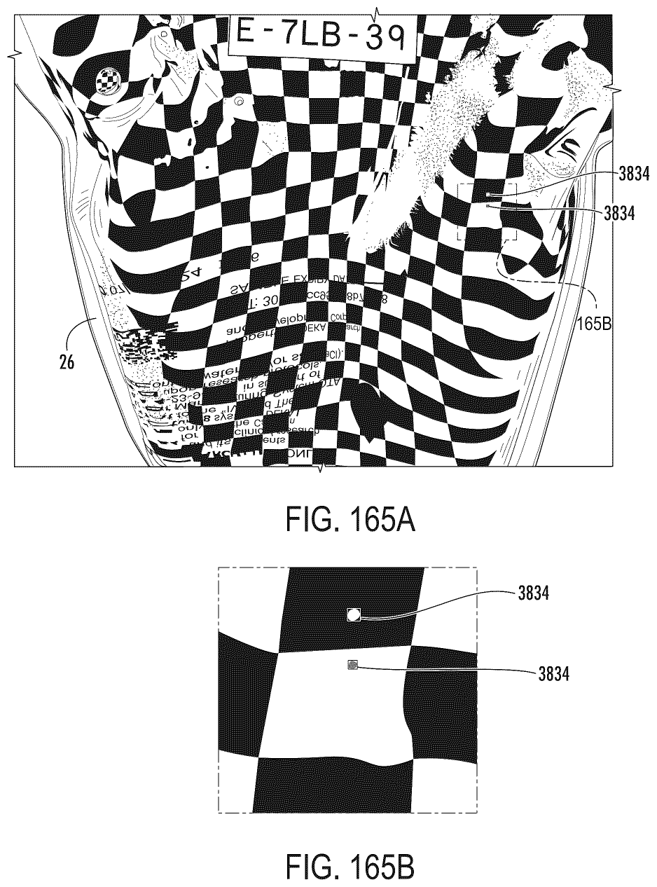

Contours may be generated around pixel clusters of interest in the convoluted image in block 3680. Though reference is made to pixel clusters, it should be understood that a single pixel could also provoke generation of a contour and a single pixel should be understood to be encompassed by the term pixel cluster. Bounding boxes 3834 for each pixel cluster of interest may be generated and stored (e.g. in an array) in block 3682. Bounding boxes 3834 may be defined based on a pixel at a corner of the bounding box 3834 along with a height and width in pixels for that bounding box 3834. A representative annotated image 3832 with bounding boxes 3834 superimposed thereon is depicted in FIG. 164A. An enlarged view of the portion of the image 3832 including bounding boxes 3834 is shown in FIG. 164B. Once pixel clusters are given a bounding box 3834 they transition from putative regions of interest 3692A, B to detected regions of interest. The detected regions of interest may be analyzed to determine respective tracks and classifications if warranted (e.g. are associated with tracks which satisfy validity criteria). As shown in FIGS. 165A-B165B, the bounding boxes 3834 associated with regions of interest may displace frame to frame. The annotated image 3836 in FIGS. 165A-B is generated from an analysis of a raw frame 3684 taken a number of frames after that shown in FIG. 157. The detected regions of interest may be used in multiple classifications. They may be scored (see, e.g., FIG. 167) and may be input to a neural net trained to classify regions of interest in specific embodiments.

Depending on the embodiment, each frame may be processed and analyzed to detect regions of interest a plurality of times. A first time may detect regions of interest which are within a first size range. A second time may detect regions of interest which are in a second size range different from the first (and so on). The pixel count within the area representing the region of interest may define the size of the region of interest. Different tuning may be used for processing and analysis of each frame depending on the size range of regions of interest to be identified. For example, the manner in which the foreground mask is generated or filtered may differ. Kernel convolutions may be more or less aggressive depending on the size range and/or the kernel convolutions may be bigger or small depending on the size range. For the first size range, the size of the kernel may be 20×20 pixels for example. For the second, larger size range, the size of the kernel may be 40×40 pixels. The validity criteria for the analysis of contours in block 3672 may also vary depending on the size range of regions of interest to be identified. The invalid contour criteria (see block 3674) may be arranged to ensure gross motion (e.g. of the bag 26 or large bubbles) is filtered out and not considered for later analysis. That is, regions of interest having a size beyond some predefined threshold may form invalid contours regardless of the size region of interest a particular detection analysis is tuned for. Regions of interest in the first size range may be deemed invalid when contours are generated and analyzed for detections of regions of interest in the second size range.

Referring now to FIG. 166, a flowchart 3840 is depicted detailing a number of example actions which may be executed to track regions of interest within images of a reservoir from an imager 3518. In some embodiments, as with detections, separate analyses may be conducted for regions of interest falling within each respective size range. The same actions may be executed, but would be differently tuned to cater to the respective size ranges for the detected regions of interest.

As shown, in block 3842, a track may be initialized and assigned a unique identifier for each detected region of interest in a first frame. A coordinate and velocity may be determined for each region of interest and associated with the respective track identity. The information may be stored in a tracking dictionary. This information may also be passed to a separate tracking record dictionary in block 3842. In block 3844, the position of the region of interest in the next frame may be predicted for each track. A Bayesian filter such as a Kalman filter may be utilized in certain examples. The track predictions may be associated with matching detected regions of interest identified in the next frame in block 3846. An assignment algorithm may be utilized for this purpose. For example, a bipartite matching algorithm or specifically the Hungarian Method algorithm may be utilized.

If, in block 3848, a predicted track has a matching detection in the following frame, the respective track may be updated with the associated detection in block 3850. The coordinates for the region of interest and the velocity of the region of interest for the frame may be added to the track. If a predicted track has no matching detection in block 3848, a check may be made as to the number of frames since a detection matching that track has been found.

In the event that the number of frames since the last detection assigned to a track is greater than a predefined threshold in block 3852, the track may be removed from the tracking dictionary in block 3854. This may decrease resource demand as predictions for this track would no longer be determined. It may also increase the rapidity with which frames may be analyzed for tracking purposes. Where the particulate inspection system 3500 is included in a fluid production and packaging system 10, this may facilitate an increase in system 10 throughput. If, in block 3852, the number of frames is less than the threshold, the track may be retained in the tracking dictionary, but not updated in block 3856.

If, in block 3858, there are detected regions of interest in the current frame which have not been matched with a track, respective new tracks with unique identities may be initialized in block 3860. In the event a frame includes a detection for a region of interest which generated a previously removed track (see block 3854), a new track would be initialized and the region of interest would be tracked under a different unique identity. Optionally, a processor of the control system 15 may assign removed tracks to tracks initialized in later frames. Thus separate tracks may be assembled into reconnected tracks under a single identity in certain embodiments. For example, if a detection several frames after a track has been terminated is within a predicted position range of the end of the terminated track, the terminated track may be connected to the track associated with that subsequent detection. In some examples, this may be done only if there are no other detections initializing new tracks in the predicted position range from the terminated track for a preset number of frames.

After initializing any new tracks in block 3860, or if no detections requiring new track initializations are present in block 3858, the track information for the frame may be output to the tracking record dictionary in block 3862. Thus, though tracks may be removed from the tracking dictionary, the tracking record dictionary would contain a record of all trackings with unique identifiers and frame by frame detection information for each track.

If, in block 3864, there are no additional frames, the tracks may be finalized in block 3866. If, in block 3864, additional frames are present, the flowchart 3840 returns to block 3844.

Referring now to FIG. 167, a flowchart 3880 is depicted detailing a number of example actions which may be executed to score regions of interest associated with tracks in images of a reservoir. In the following discussion, the score is generated based off of an analysis of each frame in a given track. In other embodiments, a subset of the frames or a single frame of the track (e.g. final frame) may be utilized. In block 3882, a processor of the control system 15 may define a scoring boundary around the region of interest in each frame from a track. The scoring boundary may be a fixed and preset size. For example, a scoring boundary of not more than 20×20 pixels centered on the region of interest may be used. The size of the scoring boundary may be chosen to ensure an entire region of interest would be captured by the scoring boundary. The scoring boundary size may differ in alternative embodiments.

In block 3884, a processor of the control system 15 may analyze the pixels within the scoring boundary for each frame to determine at least one color space score. In some implementations, the processor may determine a count for the number of pixels which have color space values which fall within predefined color space value ranges (e.g. ranges of RGB values). This count may be assigned as the color space score. As mentioned in relation to FIG. 145, an external illuminator 3516 may be selected to emit light in a color (e.g. red) which is selected to differ from the color of potential sources of particulates. In example embodiments, this helps to highlight bubbles within a bag 26 or other reservoir. The color space value ranges may be specified to correspond to the light color emitted by the external illuminator 3516. Thus, scoring boundaries yielding a high color score may be suggestive that the tracked region of interest is a bubble. The predefined color space value ranges may also be selected to correspond to bright regions with a reservoir. Again, due to the optical properties of bubbles, bubbles should appear particularly bright. Regions with a high brightness score may be suggestive that the tracked region of interest is a bubble.

In block 3886, a processor of the control system 15 may analyze the pixels within the scoring boundary to determine a sharpness score. A fast Fourier transform or the variance of the Laplacian of the image within the scoring boundary could be used. Bubbles may typically be relatively sharp due to their interaction with light from the light emitter 3516. A scoring box with a high sharpness score may be indicative that the tracked region of interest is a bubble.

In block 3888, a processor of the control system 15 may determine a shape score for the region of interest over the frames of a track. The shape score may, for example, be determined based on the bounding box generated from the contours of the region of interest when the region of interest was detected (see, e.g., blocks 3680, 3682 of FIG. 156). The shape score may be determined based upon the aspect ratio of the bounding box. As bubbles are substantially spherical, they should have an aspect ratio of 1:1 (or nearly 1:1). More rectangular aspect ratios are suggestive of particulate. The aspect ratio of the shape score for a region of interest may be averaged over all frames in a given track to determine an average shape score. This in turn may be used to determine the shape score. In some examples, additional or alternative statistical processing may be performed. For example, a standard deviation of the aspect ratios for the region of interest across frames in the track may be determined. Standard deviations above a certain threshold may be indicative of rotating particulate. In certain examples, invalid shape scores may be identified and the corresponding regions of interest may be excepted from further analysis. This captures artefacts created during filtering or other image processing allowing them to be removed from the analysis.

In block 3890, scores from each analysis may be stored (e.g. written to a tracking record dictionary). A classification for the tracked region of interest may be determined based on the scores in block 3892. Certain scores may be weighted more heavily than others. For example, if a very high color space score is present, it may heavily weight the determination towards classifying the region of interest as a bubble 3550. If a shape score indicative of a highly elongate region of interest is present, it may heavily weight the determination towards classifying the region of interest as particulate.

In some embodiments, additional scores may be determined. For example, a trajectory score may be determined. The frame to frame position data for a region of interest may be analyzed to determine a direction of motion characterization for the region of interest. Velocity data may further be analyzed. The trajectory score may be an indicator of whether the region of interest appears to be sinking or rising within the bag 26. Bubbles 3550, for example, may be particularly buoyant and may tend to rise while certain types of particulate may tend to sink due to their density. Additionally, trajectory scores may be an indicator of size. For example, a larger particle of dense material would be more likely to sink (or rapidly sink).

Referring now to FIG. 168A, a log file 3590 may be generated after analysis and classification of images. An example visualization 3560 of an analysis of frame captures from an imager 3518 monitoring a bag 26 including particulate is shown in FIG. 168A. The example visualization 3560 is an annotated image. The image selected for annotation may, for example, be a final frame capture of the raw video taken by an imager 3518. In some embodiments, the images from all imagers 3518 may be stitched together (e.g. corresponding frames taken at the same time point) to from the annotated image or individual annotated images for the frame sets output by each respective imager 3518 may be generated. As described in detail above, once a region of interest in a set of frame captures has been detected, its displacement path or track within the bag 26 may be determined. The control system 15 may make a classification determination on the region of interest. As shown, each trace 3562A-C within the visualization 3560 depicts the path of a region of interest within the bag 26. The traces 3562A-C included in the visualization 3560 may be drawn from the coordinates associated with any track identities present in the tracking record dictionary (further described in relation to FIG. 166) for a set of frames. The traces 3562A-C are given different indicia to communicate their classification. Circles, squares, and triangles are used in the example, however, color, text, symbols, or other indicators may instead or additionally be used. Such visualizations 3560 may be generated for each bag 26 and placed in a log 3590 (see, e.g., FIG. 153) associated with each bag 26. A unique identifier for each trace 3562A-C(e.g. the associated track identity in the tracking record dictionary) may be superimposed over the image in the visualization 3560. The unique identifier may also be used in the log file 3590 in association with data related to the region of interest forming the respective trace 3562A-C. The log 3590 may, for instance, include the data or at least a portion of the data from the tracking record dictionary. Where a bag 26 includes no particulate, the visualization 3560 may be devoid of traces 3562A-C. The annotated image may explicitly state no tracks were identified.

Referring now also to FIG. 168B, in certain embodiments, multiple classifications may be made for the region of interest data sets collected for each bag 26. One classification may, for example, be based off classification logic which determines a classification for each region of interest based on score characteristics determined for the region of interest. Another classification may be generated by a convolutional neural network trained on images of bags 26 with known contents. The multiple classifications for each respective region of interest may be analyzed to determine a final classification. This may be a weighted determination with the output of one or more of the classifications being more controlling than others. The annotated image in FIG. 168B may be representative of the final classifications determined for a given bag 26. Thus, each individual classification could be associated with a respective annotated image and an annotated image for the final classification may be all be included in the log 3590.

In some embodiments, a second classification may only be made for regions of interest with unclear classification or low confidence classifications. For example, the traces 3562A classed with a circle in FIG. 168A may represent regions of interest with an unclear classification. The data associated with these regions of interest may be passed to secondary classification processing which may attempt to assign a classification. As shown in FIG. 168B, no traces 3562A classed with a circle are present. The traces 3562A classed with a circle have been replaced by traces 3563B-C classed with squares and triangles. Using the example of an IV bag 26, the squares may represent particulate while the triangles may represent bubbles. Thus, a second of the multiple classifications may be used to clarify any regions of interest with unclear or low confidence classification.

Referring now to FIG. 169, a marking assembly 3700 may be included in various systems 10. The marking assembly 3700 may create one or more marking on a bag 26 before a bag 26 is dispensed from the system 10. Though described in relation to a bag 26, it should be understood marking assemblies 3700 described herein may be used for any of a variety of other target marking substrates. For example, marking assemblies 3700 described herein may be particularly well suited for use with flexible packaging, film packaging, blister packaging, etc. Description of the marking assembly 3700 in the context of bags 26 is non-limiting and merely exemplary.

Markings on, for example, bags 26 may be made in any of a variety of different manners. For example, the marking may be embossed to the bag 26, printed or stamped onto the bag 26, created on a label applied to the bag 26, generated via a laser, etc. Preferably, a marking assembly 3700 may mark the bag 26 without a consumable component (e.g. ink, adhesive backed labels, etc.). Additionally, preferred marking assemblies 3700 may not generate or generate minimal vapor, fumes, particulate, or other detritus when placing a marking on a bag 26. In certain examples, the marking assembly 3700 may mark the bag 26 by exerting a mechanical stress upon a portion of the bag 26 which is sufficient to alter an optical property of the bag 26. For example, an optical property of a region of the peripheral seal of the bag 26 may be subjected to mechanical stress sufficient to cause stress whitening of the bag 26 material. The marking assembly 3700 may emboss or peen the bag 26 to generate a marking.

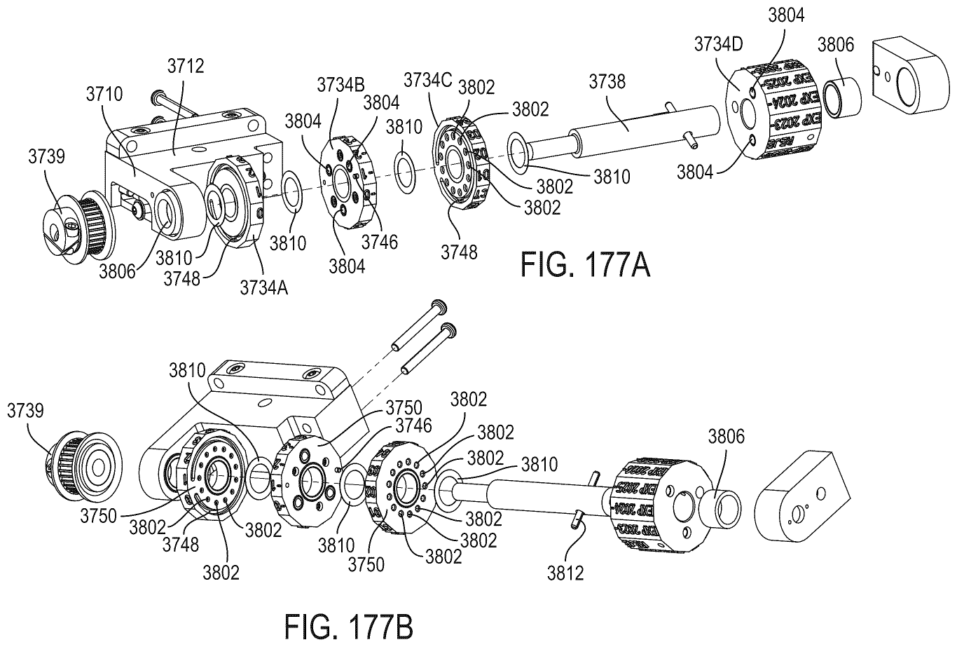

Still referring to FIG. 169, a block diagram of an example marking assembly 3700 with an embossing head 3702 is depicted. The embossing head 3702 may include an exterior surface 3704. The exterior surface 3704 may include a number of marking bodies 3706 raised therefrom. The marking bodies 3706 may include one or more typeset character. For examples, the marking bodies 3706 may include one or more alphabetic, numerical, or punctuation character. In alternative embodiments, the marking bodies 3706 may alternatively or instead include pictograms, symbols, or any other desired design. The embossing head 3702 may be rotatable such that different marking bodies 3706 may be displaced into a marking position depending on the mark desired to be created with the marking assembly 3700. In the example embodiment, a rotary actuator 3708 is coupled to the embossing head 3702 to rotate the embossing head 3702. Though the example embossing head 3702 is depicted as a round body, other embodiments (see, e.g., FIG. 177A) may include an embossing head 3702 which has a polygonal cross-section. The exterior surface 3704 may thus include a number of faces. Each face may include one or more marking bodies 3706 thereon.

As described in detail below, the embossing head 3702 may be divided into one or more independently displaceable segments. The segments may be individual rotors 3734A-D (see e.g. FIG. 177A) on a shaft 3738 of the embossing head 3702 in some embodiments. Each of the independently displaceable segments may be rotated to place a desired marking body 3706 into a marking position. In such examples, the independently displaceable segments may be displaced in order to create a desired combination of marking bodies 3706 in a marking position to create a specified mark. The mark may be a string of text (e.g. letters, numbers, punctuation, some combination thereof), may be a date, lot code, unique identifier for the bag 26 or system 10, indication of solution type within the bag, or a combination thereof. Preferably, the independently displaceable segments may each be driven through a single rotary actuator 3708.

The embossing head 3702 may be coupled to a trunnion 3710 including a base 3712. The trunnion 3710 may be coupled to an embossing actuator 3714. The embossing actuator 3714 may be any suitable variety of actuator and may in certain implementations include one or more pneumatic cylinder. Preferably, the embossing actuator 3714 may provide 750-1000 flb of force or more. Alternatively, the embossing actuator 3714 may provide up to 490 flbs. The embossing actuator 3714 may displace the embossing head 3702 and coupled components, via commands from the control system 15, from a retracted position to an embossing position against a bag 26 (or other work piece). The embossing actuator 3714 may hold the embossing head 3702 in an impressing position for a dwell period (e.g. less than a second) and then the control system 15 may command retraction of the embossing head 3702.

As shown in FIG. 169, a backstop assembly 3716 is included. The backstop assembly 3716 may include a backstop 3717 disposed opposite the embossing head 3702. The backstop 3717 may be a rigid member which is supported against deflection or other movement against any force exerted by the embossing actuator 3714. The target region of a bag 26 may be displaced into a gap between the backstop assembly 3716 and the embossing head 3702. In some examples, the backstop assembly 3716 may include one or more guide 3718 which may assist in leading the target region of the bag 26 into alignment with the embossing head 3702. The backstop assembly 3716 may include a compliant body 3720 coupled to the backstop 3717 and disposed directly opposite the embossing head 3702. As the embossing actuator 3714 drives the embossing head 3702 against the target region of the bag 26, the marking bodies 3706 in the marking position may press into the complaint body 3720 through the bag 26. The compliant body 3720 preferably may not permanently deform as the marking bodies 3706 press into the compliant body 3720. In some examples, the compliant body 3720 may be formed of a polyurethane material. In such examples a polyurethane with a shore durometer of 75D may be utilized.

In various examples, the complaint body 3720 may be disposed in a pocket 3722 in the backstop 3717. The width dimension of the pocket 3722 may be less than the width of the embossing head 3702, but greater in width than the greatest distance between any marking bodies 3706 in the marking position. The pocket 3722 may have a depth greater than the distance the marking bodies 3706 are raised from the exterior surface 3704 of the embossing head 3702. In the event the compliant body 3720 degrades, is dislodged, or otherwise compromised, unadorned edge portions of the embossing head 3702 may bottom out on the flanks of the pocket 3722 defined by the backstop 3717. This may establish a mechanical interference which prevents the marking bodies 3706 from being driven into the material at the bottom of the pocket 3722. Thus, damage to the marking bodies 3706 may be avoided. Alternatively or additionally, marking bodies 3706 may be positioned on a face of the exterior surface 3704 of the embossing head 3702 leaving an unadorned margin above and below the marking body 3706 on that face. That is the height of the marking bodies 3706 may be less than the height of the face of the exterior surface 3704 from which they project. The height dimension of the pocket 3722 for the complaint body 3720 may be greater than the height of the marking bodies 3706, but less than the height of the faces of the exterior surface 3704 on which the marking bodies 3706 are included. In the event of a compromised compliant body 3720, the margins above and below a marking body 3706 may bottom out on the material surrounding the pocket 3722. Again, this may inhibit marking bodies 3706 from being driven into the material at the bottom of the pocket 3722 similarly avoiding damage to the marking bodies 3706.

As shown, an imager 3733 may be included as part of the marking assembly 3700. The imager 3733 may capture an image of the marking made on the bag 26. The image may then be analyzed to ensure that the marking is as expected and is sufficiently visible. The control system 15 may, for example, perform an optical character recognition to determine the content of the marking. This determined marking content may be compared to the desired mark to ensure the marking on the bag 26 is acceptable.

Referring now to FIG. 170, a perspective view of an example embodiment of a marking assembly 3700 is depicted. As shown, the backstop assembly 3716 may be coupled to a mounting plate 3726. The mounting plate 3726 may couple the marking assembly 3700 to a portion of an enclosure 12 of a system 10. The backstop assembly 3716 may include a guide body 3728 which may include a flange 3730. The embossing actuator 3714 may be coupled to the flange 3730. The embossing actuator 3714 may also be coupled to the mounting plate 3726 via a post 3732. The guide 3718 may be defined in the guide body 3728. In the example, the guide 3718 is arranged to accept and direct ports 392 of a bag 26 into position as the bag 26 is introduced to the marking assembly 3702. A guide 3718 may be a slot in the guide body 3728 which tapers from a widest point at its open end to a smaller width at an end opposite the opening. The taper on the guide 3718 may tend to lead a bag 26 into place and aid in straightening out the flexible material of the bag 26 at and in the vicinity of the target region to be marked. Example guides 3718 may also include a stepwise change in width. The tiered guide 3718 show in FIG. 170 may provide space to accept various features present on the port 392 which alter the outer diameter of the port 392 over its length.

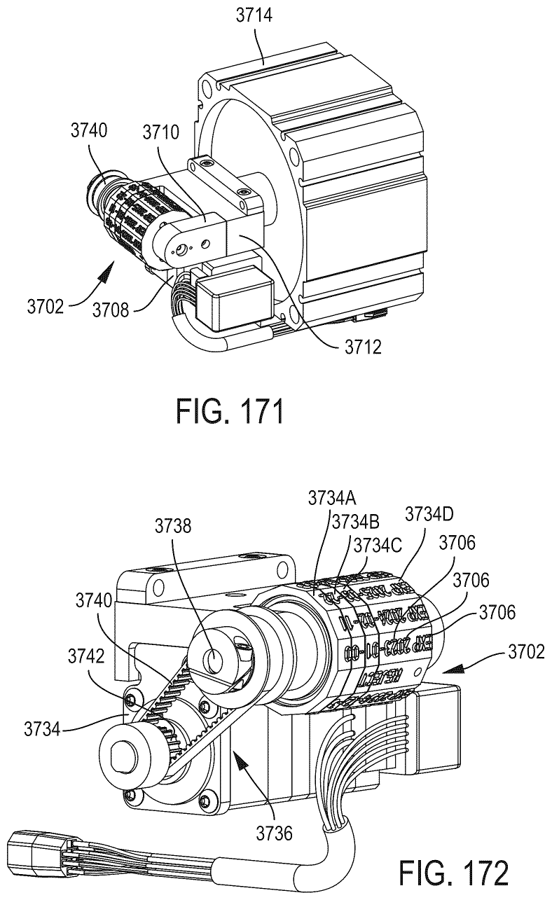

Referring now also to FIG. 171 and FIG. 172, perspective views of the marking assembly 3700 of FIG. 170 with the backstop assembly 3716 and mounting plate 3726 removed are depicted. The embossing actuator 3714 is also removed in FIG. 172. As shown, various marking assemblies 3700 may include an embossing head 3702 which may be segmented into a number of embossing head rotors 3734A-D. Though four embossing head rotors 3734A-D are shown, any suitable number embossing head rotors 3734A-D may be included. The embossing head rotors 3734A-D may be constructed of a metallic, rigid, hard, durable material. In some examples 416 stainless steel may be used. The embossing head rotors 3734A-D may be the same width or at least one of the embossing head rotors 3734A-D may have a width which differs from companion rotors 3734A-D of the embossing head 3702. Each of the example embossing head rotors 3734A-D has a polygon cross-section. As shown, the embossing head rotors 3734A-D are tridecagonal in cross-section, though any polygonal shape may be used. Each of the 13 faces of the exterior surface 3704 of each embossing head rotor 3734A-D may include one or more marking body 3706. Some faces of the exterior surface 3704 of each embossing head rotor 3734A-D may be nude, blank, or unadorned as shown in FIG. 172. In the example embodiment, the marking bodies 3706 include alphabetic, numeric, and punctuation characters. The embossing head rotors 3734A-D may be rotated such that the desired marking bodies 3706 are aligned at a marking position to create a desired string of characters for marking a bag 26. The face of the exterior surface 3704 of an embossing head rotor 3734A-D most distal the embossing actuator 3714 and normal to the displacement axis of the embossing head 3702 may be considered to be in the marking position.

For purposes of example, the marking bodies 3706 included on the depicted embossing head 3702 support the marking of an expiration date on the bag 26. The expiration date format is shown as “EXP YYYY-MM-DD”, though any desired date format could be used. The marking bodies 3706 may also include characters which may be arranged to mark the word “REJECT”, “DISCARD”, “NOT FOR HUMAN USE”, or the like on a bag 26 in the event the bag 26 is determined unacceptable (e.g. particulate has been determined to be present in the bag 26). Tables 1 and 2 below provide example marking body 3706 placements which may be included on embossing head rotors 3734A-D for an embossing head 3702. Preferably, the marking bodies 3706 may be positioned on the embossing head rotors 3734A-D such that force is substantially centered on the embossing head 3702 regardless of the character arrangement being used to mark. As depicted, for example, in FIG. 172, the “REJE” marking bodies 3706 on embossing rotor 3734A are justified proximal embossing rotor 3734B for this purpose.

TABLE 1

| Face | 3734D | 3734C | 3734B | 3734A |
|---|---|---|---|---|
| 1 | EXP(SPACE)2023- | 01 | −0 | 0 |
| 2 | EXP(SPACE)2024- | 02 | −1 | 1 |
| 3 | EXP(SPACE)2025- | 03 | −2 | 2 |
| 4 | EXP(SPACE)2026- | 04 | −3 | 3 |
| 5 | EXP(SPACE)2027- | 05 | −0 | 4 |
| 6 | EXP(SPACE)2028- | 06 | −1 | 5 |
| 7 | EXP(SPACE)2029- | 07 | −2 | 6 |
| 8 | EXP(SPACE)2030- | 08 | −3 | 7 |
| 9 | EXP(SPACE)2031- | 09 | −0 | 8 |
| 10 | EXP(SPACE)2032- | 10 | −1 | 9 |
| 11 | EXP(SPACE)2033- | 11 | −2 | (BLANK) |
| 12 | EXP(SPACE)2034- | 12 | −3 | (BLANK) |
| 13 | REJE | CT | (BLANK) | (BLANK) |

TABLE 2

| Face | 3734D | 3734C | 3734B | 3734A |
|---|---|---|---|---|
| 1 | REJEC | T | (BLANK) | (BLANK) |
| 2 | EXP(SPACE)2023- | 01 | −0 | 0 |
| 3 | EXP(SPACE)2024- | 02 | −1 | 1 |
| 4 | EXP(SPACE)2025- | 03 | −2 | 2 |
| 5 | EXP(SPACE)2026- | 04 | −3 | 3 |
| 6 | EXP(SPACE)2027- | 05 | −0 | 4 |
| 7 | EXP(SPACE)2028- | 06 | −1 | 5 |
| 8 | EXP(SPACE)2029- | 07 | −2 | 6 |
| 9 | EXP(SPACE)2030- | 08 | −3 | 7 |
| 10 | EXP(SPACE)2031- | 09 | −0 | 8 |
| 11 | EXP(SPACE)2032- | 10 | −1 | 9 |
| 12 | EXP(SPACE)2033- | 11 | −2 | (BLANK) |
| 13 | EXP(SPACE)2034- | 12 | −3 | (BLANK) |

The embossing head 3702 in FIGS. 171-172 includes marking bodies 3706 as specified in Table 1. As indicated in relation to rotor 3734B above, some rotors 3734A-D may have repeat, identical marking bodies 3706 on various faces of the exterior surface 3704. This may allow adjustments between desired strings of characters to be made more efficiently as multiple relative rotor positions may be acceptable to generate the same desired alignment of marking bodies 3706. Thus, less rotation may be needed to achieve a desired alignment of marking bodies 3706. In some embodiments, marking bodies 3706 which are rarely used (e.g. “3” for the tens place of a month) may be included less frequently on a rotor 3734A-D. Certain faces of rotors 3734A-D may also be left blank. Additionally, repeat marking bodies 3706 may increase life of the embossing head 3702. Where certain marking bodies 3706 are used with high frequency, it may be desired that duplicates be present. This may facilitate use of an alternative, equivalent marking body 3706 in the event a given marking body 3706 is determined to have reach a maximum defined number of embossing cycles. In some embodiments, the number of embossing cycles for each face of each rotor 3734A-D may be tracked and incremented by the control system 15 with each embossing operation. The control system 15 may use an alternative, equivalent marking body 3706 in the event that embossing cycles for another marking body 3706 is in breach of a predefined maximum threshold.

Still referring to FIGS. 171-172, a marking assembly 3700 may include a rotary actuator 3708 which may be powered to displace the various embossing head rotors 3734A-D of the embossing head 3702. As described in greater detail below, the rotary actuator 3708 may displace the embossing head rotors 3734A-D in tandem or may displace at least one embossing head rotor 3734A-D relative to another. A rotary position sensor 3724 may be included to monitor the position of a shaft 3738 on which the embossing head rotors 3734A-D are disposed. The rotary position sensor 3724 may be a rotary encoder or absolute rotary encoder monitoring the output of the rotary actuator 3708 in certain examples. In some embodiments, a rotary position sensor 3724 may instead or additionally directly monitor the rotational position of the shaft 3738. In certain examples, a transmission 3736 may be disposed intermediate the rotary actuator 3708 and the shaft 3738. Any transmission 3736 may be utilized and may include one or more gears, belts, and pulleys. In the example, a timing belt 3740 is included. The output of the rotary actuator 3708 and the shaft 3738 may each include a teethed region 3742 which may interdigitate with the teeth of the timing belt 3740.

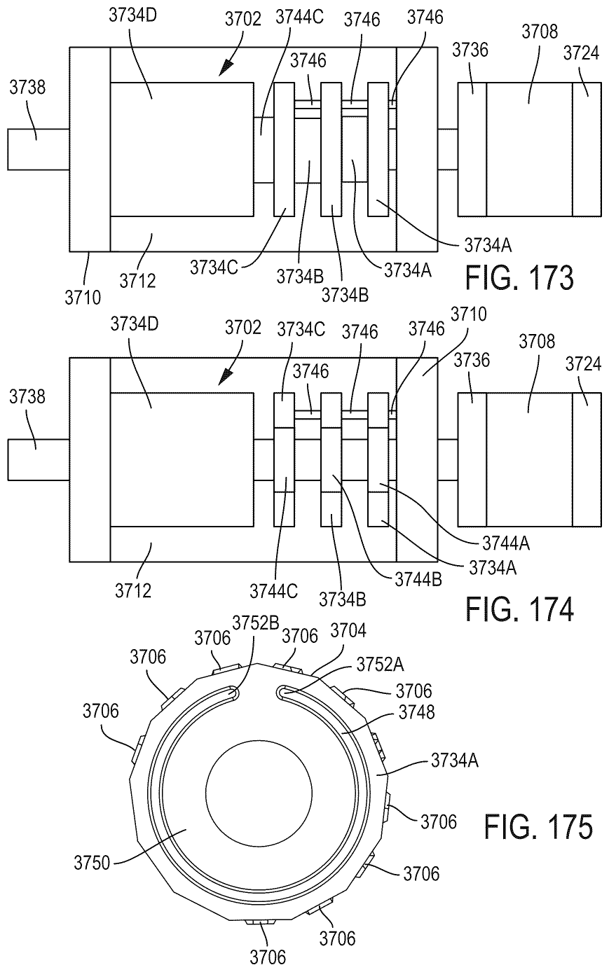

Referring now to FIGS. 173-174, two block diagrams of embossing heads 3702 are depicted. The embossing heads 3702 are operatively coupled to a rotary actuator 3708, optionally via a transmission 3736. A rotary positon sensor 3724 may be included and may generate a signal that varies in relation to the rotational position of the shaft 3738 on which each of the embossing head rotors 3734A-D is disposed. As shown, all but one of the embossing head rotors 3734A-D are paired with a clutch 3744A, B, C. The remaining embossing head rotor (rotor 3734D in the examples) may be fixedly retained on the shaft 3738 and rotate therewith. the clutches 3744A, B, C may be slip clutches. The example embodiment shown in FIG. 173 includes axial clutches 3744A, B, C which interact with adjacent embossing head rotors 3734A-D to constrain pairs of embossing head rotors 3734A-D to rotate in tandem. The example embodiment illustrated in FIG. 174 includes radial clutches 3744A, B, C. The radial clutches 3744A, B, C may constrain respective embossing head rotors 3734A-D to rotate in tandem with the shaft 3738. In either embodiment, the clutches 3744A, B, C may be made to slip to engender relative motion between an embossing head rotor 3434A-D and one or more of the companion embossing head rotors 3734A-D (and shaft 3738). Preferably, the clutches 3744A-C may generate minimal or no particulate.

Adjacent embossing head rotors 3734A-D may form a relative rotation limiter between them when the embossing head 3702 is assembled. The relative rotation limiter may prevent relative rotation between the adjacent rotors 3734A-D beyond a maximum amount in both the clockwise and counterclockwise directions. In certain examples, this may be established by a mechanical interference which is engaged as the relative rotation limit in the clockwise or counterclockwise direction has been reached. Slippage of clutches 3744A-C may occur once relative rotation has been inhibited by a respective relative rotation limiter.

Referring now also to FIG. 175, a view of a side face 3750 of an example embossing head rotor 3734A is depicted. Embossing head rotors 3734A-D may include an interrupted annular track 3748 in at least one side face 3750. In various embodiments, the interrupt may be present for an arc of (360°/n), where “n” is the number of side faces on the exterior surface 3704 of the embossing head rotors 3734A-D. The interrupted annular track 3748 may be a continuous track and may have first and second ends 3752A, B. Each interrupted annular track 3748 may span from a point aligned with the center a first face of the exterior surface 3704 of a respective embossing head rotor 3734 to a second point aligned with the center of last or “n”th face (adjacent the first face) of the embossing head rotor 3734A-D. Embossing head rotors 3734A-C may also include a pin 3746 projecting from at least one side face 3750. Any pins 3746 may extend into and travel along the interrupted annular track 3748 of an adjacent embossing head rotor 3734A-C. The interaction of the pin 3746 of one embossing head rotor 3734A-D with the interrupted annular channel 3748 of the adjacent embossing head rotor 3734A-D may form an example of a relative rotation limiter.

A pin 3746 may also project from the trunnion 3710 adjacent at least one of the embossing head rotors 3734A-D. Alternatively, the trunnion 3710 may include an interrupted annular track 3748. In such examples, the adjacent embossing head rotor 3734A may include a pin 3746 which travels within the interrupted annular track 3748 of the trunnion 3710. The pin 3746 or interrupted annular track 3748 in the trunnion 3710 may be stationary.

For sake of brevity, the following description refers to embodiments including a pin 3746 in the trunnion 3710 which rides along an interrupted annular channel 3748 in the adjacent rotor 3734A. In alternative embodiments, the annular interrupted channel 3748 may be in the trunnion 3710 and the pin 3746 may be disposed in the adjacent rotor 3734A. Similarly, where a pin 3746 is described as extending from an embossing head rotor 3734A-C to the interrupted annular track 3748 of an adjacent embossing head rotor 3734A-C, this is exemplary. The interrupted annular track 3748 could be included in the embossing head rotor 3734A-C and the pin 3746 could be disposed in the adjacent embossing head rotor 3734A-C instead in alternative embodiments.

As the shaft 3738 is rotated in a first direction, the embossing head rotors 3734A-D may rotate in tandem with the shaft 3738. One embossing head rotor 3734D may be fixedly retained on the shaft 3738. The other embossing head rotors 3734A-C may rotate in tandem with the shaft 3738 due to the presence of the clutches 3744A-C. The pins 3746 may be disposed in the interrupted annular tracks 3748 of the adjacent embossing head rotor 3734A-D (or trunnion 3710). As the pin 3746 in the trunnion 3710 is stationary, it may ride along the interrupted annular track 3748 of the adjacent rotor 3734A as rotation of the rotors 3734A-D occurs.

Eventually, as the shaft 3738 continues to rotate in the first direction, the pin 3746 of the trunnion 3710 may reach an end 3752A, B of the interrupted annular channel 3748 in the rotor 3734A adjacent the trunnion 3710. This may present a mechanical interference to additional rotation of the rotor 3734A (sometimes referred to herein as first rotor 3734A) as the shaft 3738 rotates further in the first direction. The relative rotation limiter may be said to be in an engaged state in the first rotation direction for the rotor 3734A adjacent the trunnion 3710 at this point. The clutch 3744A paired with the first rotor 3734A may slip allowing the shaft 3738 to continue to rotate in the first direction in tandem with the other rotors 3734B-D.

As the first rotor 3734A is rendered stationary by engagement of the respective relative rotation limiter, further rotation of the shaft 3738 in the first direction may eventually engage the relative rotation limiter between the first rotor 3734A and second rotor 3734B. Thus, the relative rotation limiter may be in an engaged state in the first rotation direction for the second rotor 3734B. In various examples, a pin 3746 extending from the second rotor 3748B may be displaced along the interrupted annular track 3748 in the adjacent face 3750 of the first rotor 3734A. This may occur until the pin 3746 is rotated into contact with an end 3752A, B of the interrupted annular track 3748 preventing further relative rotation of the second rotor 3734B relative to the first 3734A. The clutch 3744B paired with the second rotor 3734B may slip allowing the shaft 3738 to continue to rotate in the first direction in tandem with rotors 3734C-D.

With the first and second rotors 3734 A, B rendered stationary by engagement of the respective relative rotation limiters, further rotation of the shaft 3738 in the first direction may eventually engage the relative rotation limiter between the second rotor 3734B and third rotor 3734C. Thus, the relative rotation limiter may be in an engaged state in the first rotation direction for the third rotor 3734B. In various examples, an interrupted annular track 3748 of third rotor 3748B may be displaced over a stationary pin 3746 extending from the adjacent side face 3750 of the second rotor 3734A. This may occur until an end 3752A, B of the interrupted annular track 3748 contacts the pin 3746 preventing further relative rotation of the third rotor 3734C relative to the second 3734B. The clutch 3744C paired with the third rotor 3734C may slip allowing the shaft 3738 to continue to rotate in the first direction in unison with the fourth rotor 3734D.

With the relative rotation limiters of the first, second, and third rotors 3734A-C in engaged states, the remaining fourth rotor 3734D may rotate in tandem with the shaft 3738 as the shaft 3738 continues to rotationally displace in the first direction. The fourth rotor 3734D may not have an associated relative rotation limiter. As the remaining rotor 3734D rotates, the relative position of the fourth rotor 3734D may be specified relative to the third rotor 3734C. Once this relative position is specified, the shaft 3738 may then be rotated in a second direction opposite the first direction. As relative rotation limiters are engaged in the first rotation direction, rotation in the second direction may be permitted. The rotors 3734A-D may all rotate in tandem with the shaft 3738 in the second direction.

Eventually, the pin 3746 in the trunnion 3710 may contact the opposite end 3752A, B of the interrupted annular track 3748 of the first rotor 3734A. This may present a mechanical interference to additional rotation of the first rotor 3734A as the shaft 3738 rotates further in the second direction. The relative rotation limiter may be said to be in an engaged state in the second rotation direction for the rotor 3734A adjacent the trunnion 3710 at this point. The clutch 3744A paired with the first rotor 3734A may slip allowing the shaft 3738 to continue to rotate in the second direction in tandem with the other rotors 3734B-D.

With the first rotor 3734A being rendered stationary by engagement of the respective relative rotation limiter, further rotation of the shaft 3738 in the second direction may eventually engage the relative rotation limiter between the first rotor 3734A and second rotor 3734B. Thus, the relative rotation limiter may be in an engaged state in the second rotation direction for the second rotor 3734B. In various examples, a pin 3746 extending from the second rotor 3748B may displace along the interrupted annular track 3748 in the adjacent face 3750 of the first rotor 3734A. This may occur until the pin 3746 is rotated into contact with an end 3752A, B of the interrupted annular track 3748 preventing further relative rotation of the second rotor 3734B relative to the first 3734A. The clutch 3744B paired with the second rotor 3734B may slip allowing the shaft 3738 to continue to rotate in the second direction in tandem with rotors 3734C-D. As the first and second rotors 3734A, B are rendered stationary, further rotation of the shaft 3738 in the second direction may set the desired position of the third rotor 3734C relative to the second rotor 3734B.

The rotation direction of the shaft 3738 may be reversed until the relative rotation limiter for the first rotor 3734A is again engaged in the first rotation direction. Continued rotation in the first direction may establish a desired relative position of the second rotor 3734B to the first rotor 3734A. Thus, the marking bodies 3706 across the exterior surfaces 3704 of the embossing head rotors 3734A-D may be aligned in a desired character string. The shaft 3738 may then be rotated in the second direction. All rotors 3734A-D may be rotated in tandem with the shaft 3738 until the desired character string is disposed in the marking position. An embossing actuator 3714 may then be driven to displace the embossing head 3702 against a bag 26, other reservoir, or work piece.

The example embossing head 3702 may also be driven to a home position if necessary. The home position may provide a known position of each rotor 3734A-D relative to one another. Where the final rotor 3734D is fixed relative to the shaft 3738, the rotary position sensor 3724 may directly track to the position of the final rotor 3734D. The control system 15 may command the rotary actuator 3708 to rotate the shaft 3738 a predetermined amount. This amount may be a number of degrees which ensures that the relative rotation limiters for each rotor 3734A-D have been engaged in that rotation direction. As the rotation position of a given rotor 3734A-D may be known when the respective relative rotation limiter is engaged, this may allow the control system 15 to establish a known starting position for all rotors 3734A-D. This may, for example, be commanded by the control system 15 upon installation of a new embossing head 3702 or after an interruption of power to the system 10.

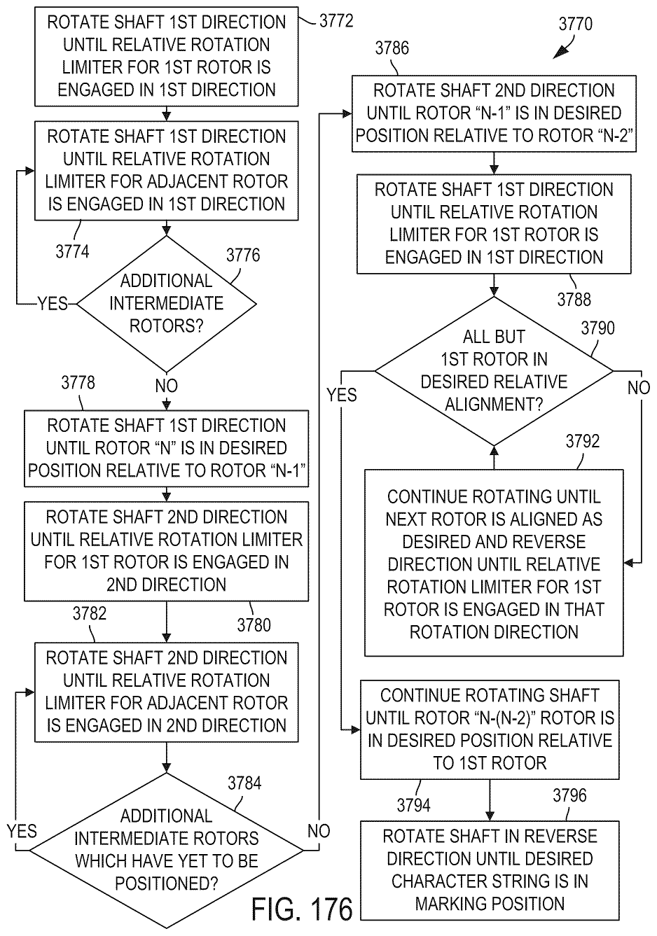

Referring now to FIG. 176, a flowchart 3770 depicting a number of example actions which may be executed to displace desired marking bodies 3706 on rotors 3734A-D of an embossing head 3702 into a marking position is depicted. Though four rotors 3734A-D are shown in the example embodiment, embossing heads 3702 may include a lesser or greater number of rotors 3734A-D in alternative embodiments. The flowchart 3770 describes placing desired marking bodies 3706 in position for an embossing head 3702 with “n” rotors where “n” is any desired number of rotors. Rotors of interest are described in relation to “n” within the flowchart 3770. For example, rotor “n−1” would be adjacent to rotor “n” and would be the penultimate rotor. Rotor “n-(n−2)” would be the rotor second most distal to rotor “n” and adjacent the first rotor of the embossing head 3702. As with various examples described herein, rotor “n” is fixed relative to the shaft 3738.

As shown, in block 3772 the shaft 3738 may be rotated in a first direction until a relative rotation limiter for the first rotor of the embossing head 3702 is engaged in the first direction. The first rotor may be rendered stationary relative to the trunnion 3710 with further rotation of the shaft 3738 in the first direction. The shaft 3738 may continue to be rotated in the first direction until a relative rotation limiter for the adjacent rotor (the rotor next most distal to rotor “n”) is engaged in the first direction in block 3774. If there are additional intermediate rotors (those between the first and last rotor) in block 3776, block 3774 may repeat. Once there are no further intermediate rotors in block 3776, the shaft 3738 may continue to be rotated in the first direction in block 3778 until the last rotor (rotor “n”) is in a desired position relative to the penultimate rotor (rotor “n−1”). The final rotor and the penultimate rotor may be considered to be positioned once block 3778 has completed. In block 3780, the shaft 3738 may be rotated in a second direction opposite the first direction until a relative rotation limiter for the first rotor is engaged in the second direction. The shaft 3738 may continue to be rotated in the second direction until a relative rotation limiter for the adjacent rotor (the rotor next most distal to rotor “n”) is engaged in the second direction in block 3782. If, in block 3784, there are additional intermediate rotors which have yet to be positioned, block 3782 may repeat. Once all intermediate rotors which were yet to be positioned have had their relative rotation locks engaged in block 3784, the shaft 3738 may continue to be rotated in the second direction until rotor “n−1” is in a desired relative position to rotor “n−2” in block 3786. In block 3788, the shaft 3738 may be rotated in the first direction until the relative rotation limiter for the first rotor is engaged in the first direction. If there are additional rotors (other than the first rotor) to be positioned in block 3790, rotation of the shaft 3738 may continue until the next rotor (the most proximal unpositioned rotor with respect to rotor “n”) is in the desired relative alignment with respect to the positioned rotors in block 3792. Also in block 3792, the rotation direction of the shaft 3738 may be reversed and the shaft 3738 may rotate until the relative rotation limiter for the first rotor is engaged in that rotation direction. Block 3792 may repeat until all but the first rotor have been positioned in block 3790. If, in block 3790, all but the first rotor are positioned as desired, the shaft 3738 may continue to be rotated until the “n-(n−2)” rotor is in the desired position relative to the first rotor in block 3794. The first rotor may be considered to be positioned at this point. With all rotors positioned, a desired string of characters to emboss will be in alignment with one another. The rotation direction of the shaft 3738 may be reversed and the rotors may be rotated until the desired character string is in the marking position in block 3796.

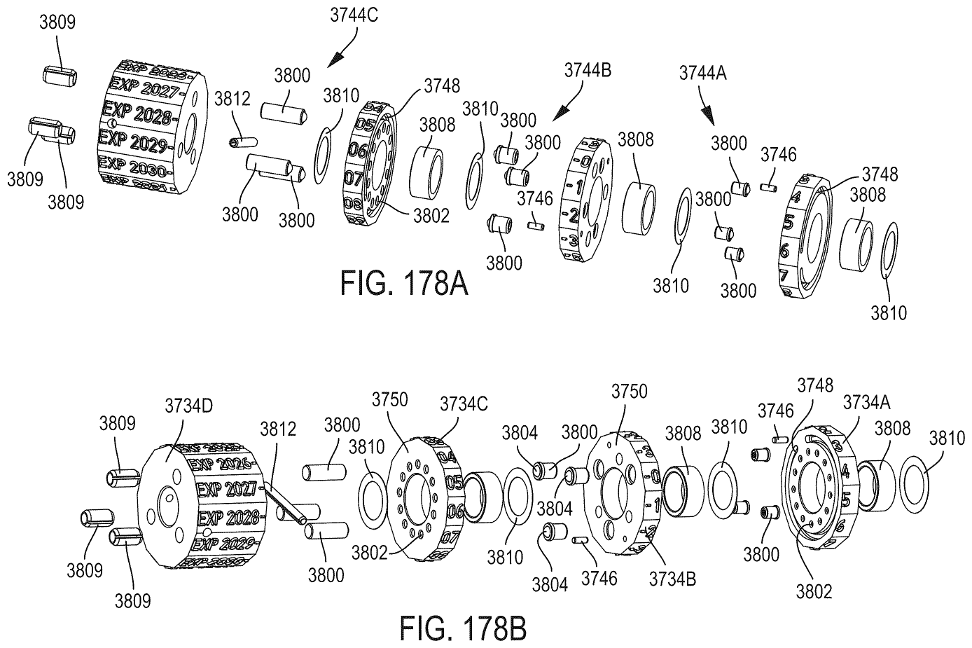

Referring now to FIGS. 177A-178B, exploded views of an example embossing head 3702 are depicted. An example trunnion 3710 and base 3712 are depicted in FIGS. 177A-B as well. The example embossing head 3702 of FIGS. 177A-178B is axially clutched. The final rotor 3734D is fixedly retained on the shaft 3738 by a pin 3812. In the example embodiment, the clutches 3744A-C of the embossing head 3702 each include at least one spring plunger 3800. The spring plungers 3800 may be ball spring plungers. As shown, the spring plungers 3800 may be disposed within certain of the rotors 3734A-D and be oriented parallel to the axial dimension of a rotor 3734A-D in which they are housed. The spring plungers 3800 may be coupled or anchored into respective rotors 3734A-D in any suitable fashion. In some examples, retaining compound may be used. Alternatively, the spring plungers 3800 may be provided with a flange having a diameter larger than at least a portion of a receiving orifice for the spring plunger 3800 in a given rotor 3734A-D. In such examples, the spring plungers 3800 may be held in place by the compression in the rotor stack. In certain examples, a spring pin may be introduced to the opposing side of a rotor 3734A-D to set the depth of the spring plunger 3800 within a given rotor 3734A-D (see, e.g. rotor 3734D of FIG. 178B). The side face 3750 of the adjacent rotor 3734A-D may include a set of detents 3802. The plungers 3804 of the spring plungers 3800 may be biased in a direction normal to the side face 3750 of the rotor 3734A-D in which they are housed. When the embossing head 3702 is assembled, the plungers 3804 may be biased into contact with the side face 3750 of the adjacent rotor 3734A-D. As relative rotation between the rotor 3734A-D housing the spring plungers 3800 and the adjacent rotor 3734A-D occurs, the detents 3802 may come into alignment with the plungers 3804. The plungers 3804 may be urged into the detents 3802 by the bias exerted by the spring 3820 (see, e.g., FIG. 180) of the spring plungers 3800. The detents 3802 may have a depth which is insufficient to permit the plungers 3804 to reach a resting state. This may ensure the plungers 3804 may be firmly held in position in the detents 3802 by the spring bias of the spring plungers 3800.

The detents 3802 may be spaced at even angular increments. Where the rotor 3734A-D has a polygon cross section with “n” sides, the spacing may be 360°/“n”. The transition from the side face 3750 to the detents 3802 may also be contoured such that the spring bias of the spring plungers 3800 tends to self-center the plungers 3804 in respective detents 3802. In the example embodiment, each clutch 3744A-C includes three spring plungers 3800. The number of spring plungers 3800 may differ in alternative examples. The spring plungers 3800 may be spaced at even or approximately even angular increments in order to help balance forces. Where the number of detents 3802 is not a multiple of the number of spring plungers 3800 in a given clutch 3744A-C, exact even spacing will not be possible. The spring plungers 3800 may be considered approximately evenly spaced when the spring plungers 3800 are spaced as close to even as the number of detents 3802 permit. The pins 3746 and interrupted annular tracks 3748 may be spaced radially inboard or outboard (as shown) with respect the detents 3802 and spring plungers 3800.

With plungers 3804 of a rotor 3734A-D pressed into respective detents 3802 of an adjacent rotor 3734A-D, relative rotation between the rotors 3734A-D may require sufficient force to overcome the bias of the spring plungers 3800 to depress the plungers 3804. Thus, the spring plungers 3800 and detents 3802 may act as a clutch. The rotors 3734A-D may tend to rotate in tandem with one another until a relative rotation limiter is engaged. With one of the rotors 3734A-D inhibited from further rotation, its respective clutch (provided by the interaction of the spring plungers 3800 and detents 3802) may slip as increasing force is applied to drive rotation of the shaft 3738. The embossing head 3702 may include a series of clutches which get progressively stronger as proximity to the final or “n”th rotor 3734D increases. This may ensure that the clutches slip in a prescribed order as the string of marking bodies 3706 is brought into a desired alignment. Strength of the axial clutches may be adjusted by altering the spring plunger 3800 (e.g. by adjusting the strength of the spring 3820). Alternatively or additionally, the strength of the clutches may be adjusted by altering the lead in angle to the detents 3802. The depth of the detents 3802 and/or the distance the plungers 3804 protrude from their respective rotor 3734A-D may be adjusted to alter the strength of a clutch. Sharper angles leading into the detents 3802 may increase the slip resistance of the respective clutch. The number of spring plungers 3800 may also be adjusted to alter the strength of a given axial clutch of the embossing head 3702. The radial distance from the rotation axis may also be adjusted. The greater the distance from the rotation axis, the more torque required to slip the clutch. In general, the force required to slip a particular clutch may be chosen to be less than that require to depress a plunger 3804 of the next weakest clutch. Thus, plungers 3804 of the next weakest clutch may remain engaged with respective detents 3802 while motion relative to the weaker clutch occurs. This may ensure deterministic movement of the rotors 3734A-D.

As shown, the embossing head 3702 includes a collet 3739. The collet 3739, in conjunction with the rotor 3734D fixedly coupled to the shaft 3738 may be used to ensure the rotor stack is under a desired amount of compression after assembly. The shaft 3738 may be passed through a portion of the trunnion 3710 such that the rotors 3734A-D are on a first side of the portion of the trunnion 3710 and a section of the shaft 3738 protrudes from an opposing side of the trunnion 3710. The protruding portion of the shaft 3738 may be displaced so as to protrude a greater distance from that side of the trunnion 3710 portion. Rotor 3734D may also be displaced as this occurs. This may cause the clutches 3744A-C to be placed under compression. The collet 3739 may then be tightened on the shaft 3738 locking the shaft 3738 position relative to the trunnion 3710. In some embodiments, a shim of a desired thickness may be placed in the rotor stack as the shaft 3738 position is adjusted. The shim may be removed after tightening the collet 3739 on the shaft 3738 into a clamping state. The gap created by the removal of the shim may propagate to the strongest clutch. In the example, the gap would propagate to the clutch between rotor 3734C and rotor 3734D.

Still referring to FIGS. 177A-178B, the trunnion 3710 may include bearings 3806 for the shaft 3738. A rotor bearing 3808 may also be included for the rotors 3734A-C not fixed to the shaft 3738. Each rotor 3734A-D may be separated from any adjacent components (e.g. rotors 3734A-D or trunnion 3710) by a thrust bearing 3810. In some examples, thrust bearings 3810 may be PTFE washers.

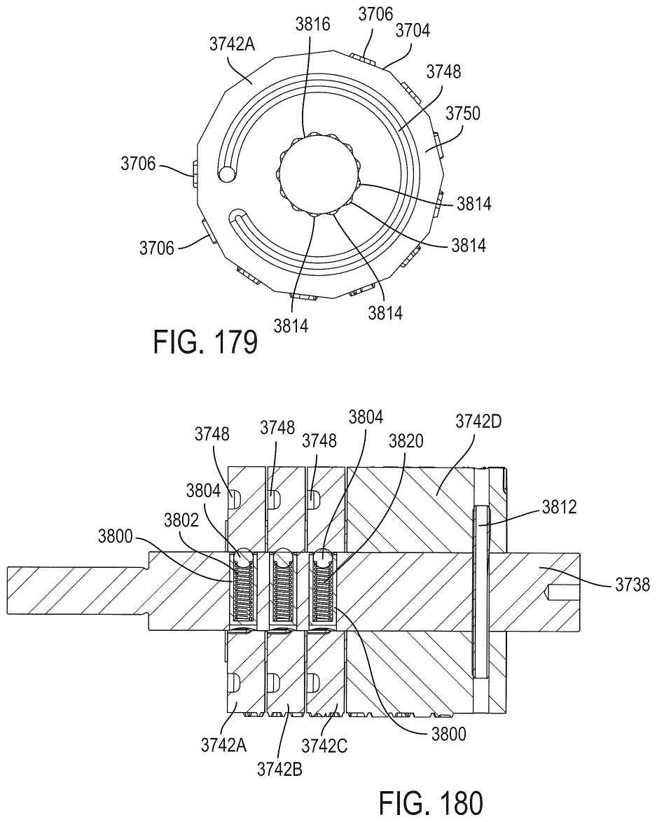

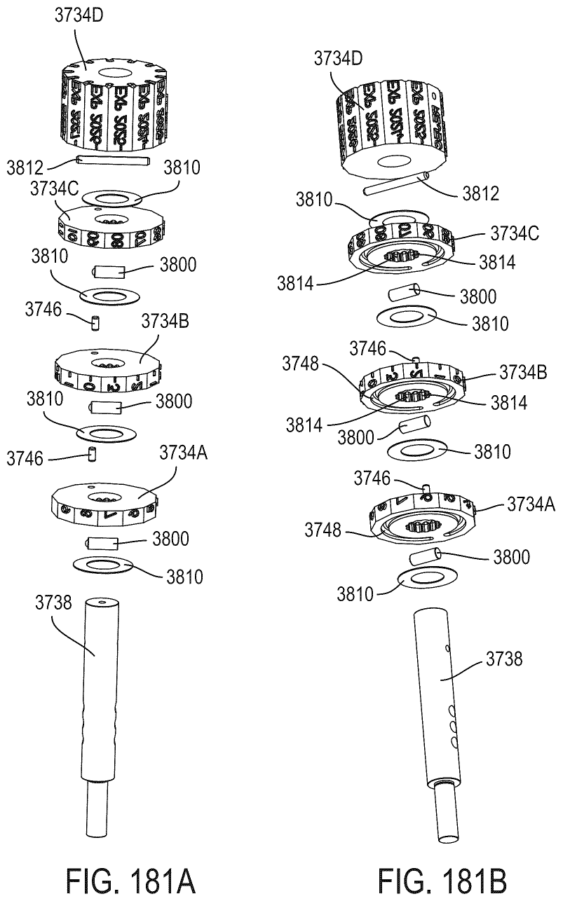

Referring now to FIGS. 179-181B, an example rotor 3734A and embossing head 3702 are depicted. FIG. 179 depicts a side view of an example rotor 3734A. A cross-sectional view of an embossing head 3702 is depicted in FIG. 180. Exploded views of the example embossing head 3702 are shown in FIGS. 181A-181B. The example embossing head 3702 of FIGS. 180-181B is radially clutched with the final rotor 3734D fixedly retained on the shaft 3738 by a pin 3812.

As best shown in FIG. 179, the side face 3750 of the example rotors 3734A-D may be devoid of detents 3802. Instead the radial detents 3814 may be included in the aperture 3816 of each rotor 3734A-D though which the shaft 3738 extends. In certain examples, the radial detents 3814 may be formed as depressions which extend from a first side face 3750 and partially toward the opposing side face 3750 (best shown in FIG. 181A). The number of radial detents 3814 may be equal to the number of faces of a rotor's 3734A-D cross-sectional shape. The shaft 3738 may include a number of spring plungers 3800 disposed therein. The plungers 3804 of the spring plungers 3800 may be proud of the surface of the shaft 3738. In the example the plungers 3804 are balls.

In certain examples, each rotor 3734A-D that rotates relative to the shaft 3738 may include a bushing insert for the shaft 3738. The radial detents 3814 may be provided in the bushing insert. The bushing insert may be made of a self-lubricating material. An oil containing bronze or other metallic material (e.g. Oilite) may be used in certain examples. In some embodiments, the bushing inserts may extend past each side of the parent rotor 3734A-D and may also serve as thrust bearings in certain implementations. A single sleeve bushing may also be placed over the shaft 3738 and may be accepted by the aperture 3816 of each rotor 3734A-D in alternative embodiments. The plungers 3804 may extend through and be proud of the sleeve bushing in embodiments where a sleeve bushing is used.

The springs 3820 of the spring plungers 3800 may bias the plunger 3804 into a radial detent 3814 of the paired rotor 3734A-D. The spring 3820 of each spring plunger 3800 may be under compression when the respective plunger 3804 is disposed in a radial detent 3814. This, in conjunction with the lead in to the radial detents 3814, may assist in self-centering the radial detent 3814 on the plunger 3804. When a plunger 3804 is disposed in a radial detent 3814, the rotor 3734A-D may rotate in tandem with the shaft 3738 until a relative rotation limiter is engaged in that direction. Thus, the spring plungers 3800 and radial detents 3814 may form radial clutches. Once a relative rotation limiter is engaged, further rotation of the shaft 3738 may cause slippage of the respective radial clutch.

The example embossing heads 3702 depicted in FIGS. 177A-181B may be particularly compact with minimal gap between the rotors 3734A-D. In some examples, the gap may be 0.011″ or less between rotors 3734A-D. This may allow for a maximized font size to be utilized with a given target impression area on a work piece such as a bag 26. Additionally, in various embodiments, the rotors 3734A-D may be under rigid as well as spring compression. This may inhibit canting of the rotors 3734A-D and help to ensure individual rotors 3734A-D remain out of contact with one another despite the tight spacing.

Referring now to FIG. 182A, in certain examples, a marking assembly 3700 may be paired with a mark verification assembly. The mark verification assembly may include at least one imager 3733. The imager 3733 may be positioned such that the marked region of the bag 26 (or other reservoir) is in the field of view of the imager 3733. Alternatively, the bag 26 may be gripped by a gripper assembly 4204 of a gantry assembly 4200 and the marking on the bag 26 may be displaced into the field of view of the imager 3733. As shown, the marking is in the enlarged region 36A of the peripheral seal 30 of the example bag 26. The marking could alternatively be placed in an uncoupled region 60. An image 3735 may be captured of the marking. Preferably, the imaged side of the bag 26 may be the side opposite that contacted by the embossing head 3702.

A representation of such an image 3735 is depicted in FIG. 182B. The raw image may be pre-processed (e.g. subjected to binary thresholding, despeckeled, de-skewed, etc.). An optical character recognition algorithm may then be used to determine the content of the marking on the bag 26. Any suitable optical character recognition algorithm such as a matrix matching or feature extraction type algorithm may be used. Alternatively, the image 3735 may be provided to a neural network trained on images of markings on bags 26 made from each of the marking bodies 3706 in the marking assembly 3700. Any character recognition may be constrained by a lexicon or dictionary of potential markings built from the marking bodies 3706 present in the marking assembly 3700. In the event that the determined marking from the image 3735 matches the desired mark, the bag 26 may be collected by a gantry assembly 4200 and displaced to an appropriate receptacle 4120A, B in an outfeed drawer 4102 for example. In the event that the determined marking does not match the desired mark (or the control system 15 cannot determine the content of the marking in the image 3735), the bag 26 may be re-marked at least one time by the marking assembly 3700. The subsequent marking(s) may indicate the bag 26 is rejected or may make any marking on the bag 26 unintelligible. In the latter scenario, several different markings may be made on top of any existing mark. The bag 26 may then be displaced to an access controlled receptacle 4120B of an outfeed assembly 4100. Alternatively, the marking may be rendered unintelligible as describe above and the bag 26 may be removed from the marking assembly 3700. The bag 26 may be rotated 180°, the opposing unmarked side of the bag 26 may be advanced into a marking assembly 2700, and an unmarked portion of the bag 26 on the opposing side may be marked to indicate the bag 26 is rejected.

Referring now to FIG. 182C, an annotated image 3737 may be generated in certain embodiments. The annotated image 3737 may include an indicator 3741 around each character recognized in the optical character recognition analysis. The indicator 3741 may be representative of the region analyzed for character recognition. A superimposed character determination 3743 indicative of the character determined to be present in the indicated region may be associated with each indicator 3741 in the annotated image 3737. A marking boundary 3745 indicative of where within the image the marking on the bag 26 was determined to be may also be included. An annotated image 3737 may be saved and provided in a log file associated with the unique identifier for each respective bag 26. Such log files may, for example, be stored on a database 3502.

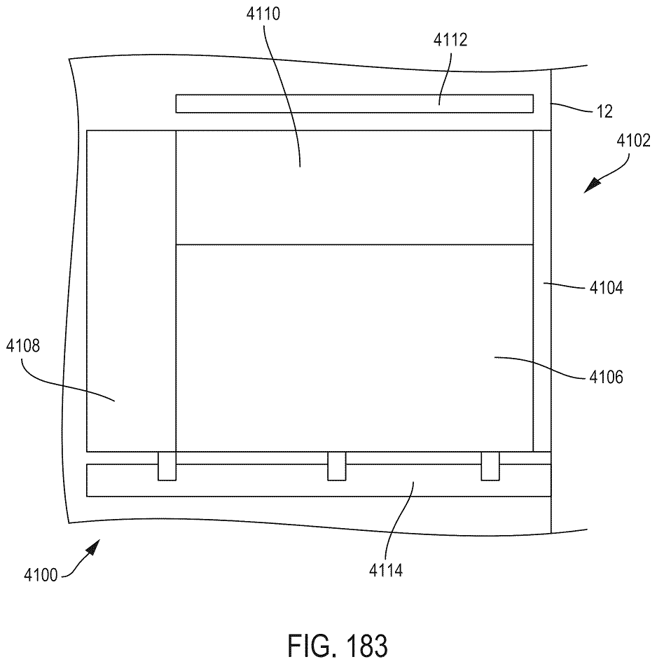

Referring now to FIG. 183, a block diagram of an example outfeed assembly 4100 is depicted. The example outfeed assembly 4100 may be included within an enclosure 12 of a system 10. The outfeed assembly 4100 may receive filled bags 26 which have been labeled for use and passed any required quality criteria. For example, bags 26 may pass one or more inspection described herein. Fluid dispensed into the bag 26 may also be required to have conformed to acceptability characteristics (e.g. predefined ranges for conductivity, temperature, etc.). The outfeed assembly 4100 may also receive and segregate filled bags 26 which have been rejected due to nonconformity to quality criteria. Acceptable and rejected bags 26 may be dispensed from the outfeed assembly 4100 with respective differing levels of access control. The outfeed assembly 4100 may prevent a typical user from physically accessing rejected bags 26. A specifically credentialed user may be required to collect rejected bags 26 from the system 10.

As shown in FIG. 183, an example outfeed assembly 4100 may include one or more outfeed drawer 4102. Each outfeed drawer 4102 may include an exterior panel 4104. The exterior panel 4104 may be flush with the exterior wall of the enclosure 12 when the outfeed drawer 4102 is in a closed state. A seal may be formed between the exterior panel 4104 and the enclosure 12 when the outfeed drawer 4102 is closed. A gasket or other sealing member may be coupled to the exterior panel 4104 for this purpose. A handle 4164 or other grasp features may be included on the exterior panel. Each outfeed drawer 4102 may include a first receptacle array 4106 and a second receptacle array 4108. The first receptacle array 4106 may include a plurality of receptacles 4120A (see, e.g., FIG. 185) sized to accept bags 26. The second receptacle array 4108 may also include a plurality, albeit smaller number, of receptacles 4120B (see, e.g., FIG. 189) for bags 26. Each outfeed drawer 4104 may be tiered such that the second receptacle array 4108 is raised or recessed with respect to the first receptacle array 4106. A transition wall 4118 may be present and form the step in height between the receptacle arrays 4106, 4108. The openings of the second receptacle array 4108 may be substantially even with the sidewall 4110 of the outfeed drawer 4102. The openings to the first receptacle array 4016 may be spaced from the top of the sidewall 4110 and recessed within the outfeed drawer 4102. The opposite may be true where the second receptacle array 4108 is recessed with respect to the first receptacle array 4106. In some embodiments, each receptacle array 4106, 4108 may be at even height and no tiered arrangement may be present. The first receptacle array 4106 may hold bags 26 which have been deemed acceptable for use. The second receptacle array 4108 may hold bags 26 which have been rejected. In certain embodiments, the first receptacle array 4106 may include twenty-five receptacles 4120A in a number of rows and the second receptacle array 4108 may include three receptacles 4120B in a single row. Other arrangements are possible. The receptacle arrays 4106, 4108 in each outfeed drawer 4102 may be mirrored with respect to one another. In some examples, the receptacles 4120A may be a first color (e.g. white or green) while the receptacles 4120B may be second color (e.g. red).

As shown, a warding plate or grid 4112 may be included in some examples. The warding grid 4112 may include apertures which align with the receptacles 4120A, B in the outfeed drawers 4102 when the outfeed drawers 4102 are in a closed state. Bags 26 may be dropped through the apertures in the warding grid 4112 into desired receptacles in the outfeed drawer 4102. When an outfeed drawer 4102 is in an open state, the warding grid 4112 may help inhibit a user from reaching into the enclosure 12.

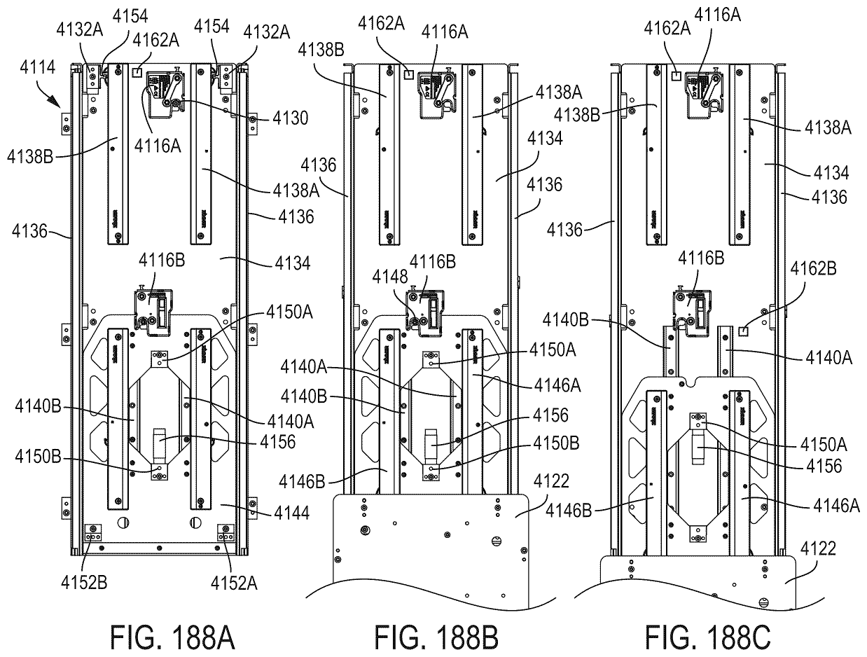

Each outfeed drawer 4102 may be coupled to a drawer slide assembly 4114. The drawer slide assembly 4114 may facilitate translational displacement of the associated outfeed drawer 4102 with respect to the enclosure 12. Each drawer slide assembly 4114 may include a plurality of lock assemblies 4116A, B (see, e.g., FIG. 188A). The lock assemblies 4116A, B may be actuated between a displacement permitting state and a displacement inhibiting state.

A user may present a credential (e.g. RFID badge, biometric such as a fingerprint, etc.) which is read by an access control assembly of the system 10 (RF interrogator, finger print scanner, etc.). Alternatively or additionally a user may key in a user identity and associated password on a user interface of the system 10 (e.g. GUI 6100 of FIG. 1). An access request may be input to the system 10 (e.g. via a button press) and one or more of the lock assemblies 4116A, B may be actuated to a displacement permitting state. The type of credential presented and verified by the system 10 may determine which lock assemblies 4116A, B may be actuated by the user. A standard user (e.g. pharmacist, nurse, or other medical practitioner) may be provided credentials that open a first lock assembly 4116A, B. Additional lock assemblies 4116A, B may require specialized credentials which may, for example, only be issued to system technicians or personnel with specific training. In some examples, the control system 15 may prohibit the lock assemblies 4116A, B from being in a displacement permitting state during at least one system 10 state. The control system 15 may prevent actuation of the lock assemblies 4116A, B of an outfeed drawer 4102 to a displacement permitting state until at least the first receptacle array 4106 is filled at least partially with bags 26.

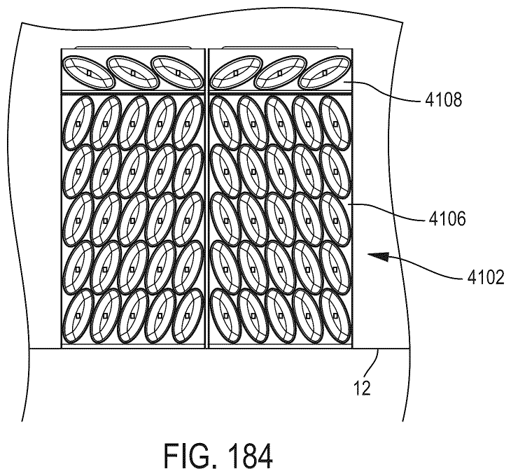

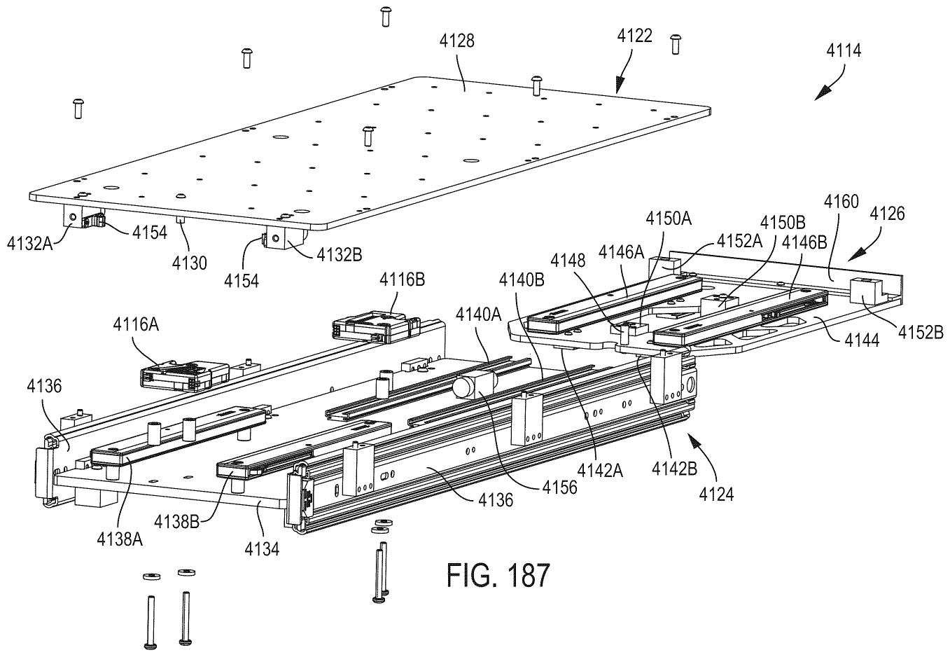

Referring now to FIGS. 184-186, illustrations of outfeed drawers 4102 in part of an example system 10 are shown. Components of the system 10 aside from the enclosure 12 and the outfeed drawers 4102 are hidden for sake of illustration. The top of the enclosure 12 has also been removed. As shown in FIG. 184, each outfeed drawer 4102 is depicted in a closed state. In the closed state, the interior of the enclosure 12 may be isolated from the exterior of the enclosure 12 by a seal formed between the enclosure 12 and the outfeed drawer 4102. Lock assemblies 4116A, B (see, e.g., FIG. 187) for each outfeed drawer 4102 may be in a displacement prohibiting state as a default.

Referring now primarily to FIG. 185, upon presentation and verification of a credential for a first access tier, the control system 15 may command actuation of a first lock assembly 4116A (see, e.g., FIG. 187) of a drawer assembly 4102 to a displacement permitting state. The outfeed drawer 4102 may be opened to a first stop position with the first lock assembly 4116A in a displacement permitting state. In the first stop position, the entire first receptacle array 4106 may be displaced out of the enclosure 12. The second receptacle array 4108 may remain within the enclosure 12. As mentioned above, the second receptacle array 4108 may be raised with respect to the first. The transition wall 4118 between the first and second receptacle array 4108 may be substantially even with the exterior wall of the enclosure 12 when the outfeed drawer 4102 is in the first stop position. Thus, the transition wall 4118 may block a user from reaching the second receptacle array 4108 and retrieving any of its contents. Opening of an outfeed drawer 4102 may be manual or alternatively may be under power of one or more electromechanical actuator.

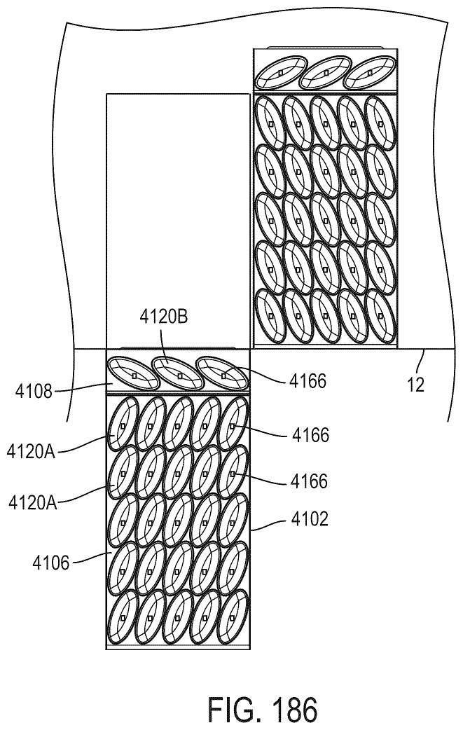

Referring now primarily to FIG. 186, upon presentation and verification of a credential for a second access tier, the control system 15 may command actuation of all lock assemblies 4116A, B (see, e.g., FIG. 187) of a drawer assembly 4102 to a displacement permitting state. The outfeed drawer 4102 may be opened to a second stop position with all lock assemblies 4116A, B in displacement permitting states. In the second stop position, the entirety of each of the first and second receptacle array 4106, 4108 may be displaced out of the enclosure 12.

As shown in FIG. 186, one or more of the receptacles 4120A, B may be associated with a receptacle sensor 4166. The receptacle sensor 4166 may output a data signal indicative of whether a bag 26 is present in the respective receptacle 4120A, B. Any suitable sensor may be used. In certain examples, reflective type proximity sensors, beam break sensors, ultrasonic proximity sensors, button type sensors, weight based sensors, etc. may be used. In alternative embodiments, a gantry assembly 4200 (see, e.g., FIG. 189) may include one or more imager which may serve as a receptacle sensor 4166 for each receptacle 4120A, B. The imager(s) may collect image data of the outfeed drawers 4102 for analysis by the control system 15. The control system 15 may analyze image data from the imager(s) to identify which receptacles 4120A, B have been filled with a bag 26.

Where multiple outfeed drawers 4102 are included, the control system 15 may generate a prompt (e.g. via a GUI 6100, see, e.g., FIG. 1) for a user to indicate which outfeed drawer 4102 they desire to access. The control system 15 may command actuation of a first lock assembly 4116A, B of the selected outfeed drawer 4102 upon receipt of a selection input via a user interface of the system 10.

Referring now to FIG. 187, an exploded perspective view of an example drawer slide assembly 4114 is depicted. A drawer slide assembly 4114 may include a carriage 4122, a base assembly 4124 and a telescoping assembly 4126. The carriage assembly 4114 may include a mounting body 4128 to which an outfeed drawer 4102 may be coupled. A carriage striker 4130 may be included at one end region of the mounting body 4128 and may be flanked on each side by a carriage bumper 4132A, B. Bumpers 4132A, B may include at least one rubber contact. The outfeed drawer 4102 may mount to the side of the mounting body 4128 opposite the carriage striker 4130 and bumpers 4132A, B.

The base assembly 4124 may include a base body 4134. Drawer slides 4136 may be coupled to opposing sides of the base body 4134. When assembled, the carriage 4122 may mount to the displaceable portion of each drawer slide 4136. A set of displacement dampers 4138A, B and a set of guides 4140A, B may be coupled to the base body 4134. Two lock assemblies 4116A, B may also be coupled to the base body 4134. A bumper 4156 for the telescoping assembly 4126 may also be included on the base body 4134.

The telescoping assembly 4126 may include a main body 4144. A set of bearings 4142A, B which may ride along the guides 4140A, B of the base assembly 4124, may be attached to the main body 4144. A set of displacement dampers 4146A, B may be coupled to the opposing side of the main body 4144. A telescoping assembly striker 4148 may be coupled to an end region of the main body 4144. Additionally, the telescoping assembly 4126 may include a first and second set of stops 4150A, B, 4152A, B.

Referring now also to FIGS. 188A-188C, a number of top plan views of an example drawer slide assembly 4114 are depicted. The example drawer slide 4114 is in a closed position in FIG. 188A and the mounting body 4128 of the carriage 4122 has been hidden. The exemplary drawer slide 4114 is shown at a first stop position in FIG. 188B and in a second stop position in FIG. 188C. In the closed position, the carriage striker 4130 and telescoping assembly striker 4148 may be in engaged states with respective lock assemblies 4116A, B. This may prohibit displacement of the carriage 4122 and opening of the outfeed drawer 4102.

With the first lock assembly 4116A commanded to an open state, the carriage striker 4130 may be released allowing displacement of the carriage 4122 and outfeed drawer 4102 coupled thereto to the first stop position. A trigger projection 4154 (see, e.g., FIG. 187) on each carriage bumper 4132A, B may activate the displacement dampers 4146A, B of the telescoping assembly 4126 as the carriage 4122 reaches an activation position near the first stop position. The displacement dampers 4146A, B may slow the travel of the carriage 4122 before the carriage 4122 reaches the first stop position. The displacement dampers 4146A, B may be self-close type drawer dampers and in such embodiments may automatically displace the carriage 4122 to the first stop position after the activation position is reached. The carriage bumpers 4132A, B may collide with the second set of stops 4152A, B of the telescoping assembly 4126 inhibiting further movement of the carriage 4122. As the telescoping assembly striker 4148 is engaged by the second lock assembly 4116B, the telescoping assembly 4126 may be inhibited from displacing and the outfeed drawer 4102 may be prevented from displacing to the second stop position. Thus, bags 26 cleared for use may be removed from the system 10 and distributed and rejected bags 26 may remain inaccessible.

In the event that the second lock assembly 4116B is actuated to a disengaged state, the telescoping assembly striker 4148 may be free to displace. The telescoping assembly 4126 may displace along the guides 4140A, B of the base assembly 4124 until the stop 4150A of the telescoping assembly 4126 contacts the bumper 4156 of the base assembly 4124. Though not shown, additional damper arrangements may be included to ensure that the telescoping assembly 4126 gently displaces to the end of its displacement range as the outfeed drawer 4102 reaches the second stop position.

Once any rejected bags 26 in the second receptacle array 4108 have been removed, the outfeed drawer 4102 may be displaced toward the closed state. The telescoping assembly 4126 may displace along the guides 4140 of the base assembly 4124 until the stop 4150B of the telescoping assembly 4126 contacts the bumper 4156 of the base assembly 4124. The trigger projections 4152 of the carriage 4122 may remain engaged with the displacement dampers 4146A, B of the telescoping assembly 4126 inhibiting displacement of the carriage 4122 relative to the telescoping assembly 4126. Once the stop 4150B collides with the bumper 4156, further force on the outfeed drawer 4102 may drive the trigger projections 4152 out of engagement with the displacement dampers 4146A, B displacing the carriage 4122 along the drawer slides 4136. As the carriage 4122 is displaced toward the closed position, the trigger projection 4154 (see, e.g., FIG. 187) on each carriage bumper 4132A, B may activate a respective carriage damper 4138A, B of the base assembly 4124. This may ensure that the drawer slide assembly 4114 does not slam into its closed position end stop. The carriage dampers 4138A, B may be of the self-closing variety and may help ensure that the carriage 4122 fully displaces to a repeatable closed position. A spring force may, for example, be exerted by the carriage dampers 4138A, B when the trigger projections 4154 are engaged. This may drive the carriage 4122 to the closed position. Additionally, if an outfeed drawer 4102 is released after a slight displacement in the opening direction, the carriage dampers 4138A, B may automatically return the outfeed drawer 4102 to the closed state. The telescoping assembly 4126 may include an end plate 4160 (see, e.g., FIG. 187). The outfeed drawer 4102 may include a projection, lip, etc. which contacts the end plate 4160 when the carriage 4122 is retracted to the closed position. This may ensure that the telescoping assembly 4126 is in a fully retracted state when the outfeed drawer 4102 is closed. This may also ensure that that the telescoping assembly striker 4148 will be engaged by the second lock assembly 4116B when the second lock assembly 4116B is in a locked state.

Still referring to FIGS. 188A-C, the outfeed assembly 4100 may include one or more position sensor 4162A, B for each outfeed drawer 4102. The control system 15 may monitor data from the position sensor 4162A, B to determine the position of the respective outfeed drawer 4102. A first position sensor 4162A may monitor the position of the carriage 4122. The signal output from the first position sensor 4162A may vary depending on whether the carriage 4122 is in a closed position or is at least partially open. The signal from a second position sensor 4162B may vary depending on whether the telescoping assembly 4126 is in its fully retracted position or has displaced from this position. The carriage 4122 and telescoping assembly 4126 may, for example, include magnetic bodies and the sensors 4162A, B may be Hall effect sensors. Microswitches which are actuated by projections on the carriage 4122 and telescoping assembly 4126 may be included. In some examples, a linear potentiometer may monitor the position of the carriage 4122 which may bear a wiper. Thus, the control system 15 may be able to continuously monitor the position of an outfeed drawer 4102 throughout its displacement range. These are merely examples, and any suitable sensors may be used.

Referring now to FIGS. 189-190, illustrations of outfeed drawers 4102 in part of an example system 10 are shown. For sake of illustration, certain components within the enclosure 12 are simplified or hidden. A gantry assembly 4200 may be included in an outfeed chamber 4202 of the enclosure 4200. The gantry assembly 4200 may collect bags 26 from the transfer chamber 3506 and displace the bags 26 throughout the outfeed chamber 4202. As described elsewhere herein, bags 26 may be mixed, subjected to particulate inspection, and labeled within the outfeed chamber 4202. The gantry assembly 4202 may shuttle bags 26 between stations for these purposes. The gantry assembly 4200 may include a gripper assembly 4204 which may be actuated open and closed around ports 392 of bags 26. With the ports 392 of a bag 26 held by the gripper assembly 4204, the gantry assembly 4200 may be actuated to displace to a coordinate which corresponds to a location within the outfeed chamber 4202. An X, Y coordinate may for example be specified and the control system 15 may command the gantry assembly 4200 to displace until it is determined that the specified coordinate has been reached. The gripper assembly 4204 may also be attached to a rotary actuator and may be displaceable to a specified rotational position.

The gantry assembly 4200 may displace bags 26 into alignment with a desired receptacle 4120A, B of an outfeed drawer 4102. The gripper assembly 4204 may then be commanded to an open state. The bag 26 then will drop into the targeted receptacle 4120A, B. The opening of the receptacle 4120A, B may be tapered or angled to help guide the bag 26 into the receptacle 4120A, B. In other embodiments, the gantry assembly 4200 may include a Z-axis displacement actuator and stage. In such embodiments, the gripper assembly 4204 may be displaced toward the target receptacle 4120A, B and the bag 26 may be released after being placed or at least partially introduced into the target receptacle 4120A, B. The target receptacle 4120A, B may be selected based on the bag's 26 conformity to one or more quality criteria. In the event that the bag 26 passes all requisite quality criteria, the target receptacle 4120A, B may be a receptacle 4120A of the first receptacle array 4106 (see FIG. 189). In the event the bag 26 fails at least one quality criteria, the target receptacle 4120A, B may be a receptacle 4120B in the second receptacle array 4108 (see FIG. 190). The control system 15 of the system 10 may store a record of which receptacles 4120A, B have already been populated with a bag 26. Alternatively or additionally, each receptacle 4120A, B may be associated with a receptacle sensor 4166 (see, e.g., FIG. 186) and the control system 15 may determine which receptacles 4120A, B are unfilled based on the signals from the receptacle sensors 4166. The target receptacle 4120A, B may always be an empty receptacle 4120A, B. The control system 15 may also generate a notification in the event that one of the receptacle arrays 4106, 4108 for an outfeed drawer is filled.

In some embodiments, the control system 15 may not prohibit further operation of the system 10 if a second receptacle array 4108 is filled and another second receptacle array 4108 has unpopulated receptacles 4120B. In the event that all receptacles 4120B in the outfeed chamber 4202 have been filled, the control system 15 may prevent further bags 26 from being processed by the system 10. The control system 15 may generate a notification that a properly credentialed user must empty the second receptacle arrays 4108 of the outfeed assembly 4100 and dispose of the bags 26 therein. The control system 15 may prohibit further operation of the system 10 in the event that all first receptacle arrays 4106 in the outfeed assembly 4100 have been filled. A notification for a properly credentialed user to empty the first receptacle arrays 4106 may be generated.

The control system 15 may check the signals from any receptacle sensors 4166 to ensure bags 26 have been removed after an outfeed drawer 4102 has opened. In the event that bags 26 remain in the first receptacle arrays 4106, but at least one receptacle 4120A is unpopulated, the control system 15 may command production activities to resume. If bags 26 remain in a second receptacle array 4108, however, the control system 15 may generate a notification that the bags 26 must be removed. In alternative embodiments, the control system 15 may command production activities resume so long as at least one receptacle 4120B is determined to be unfilled.

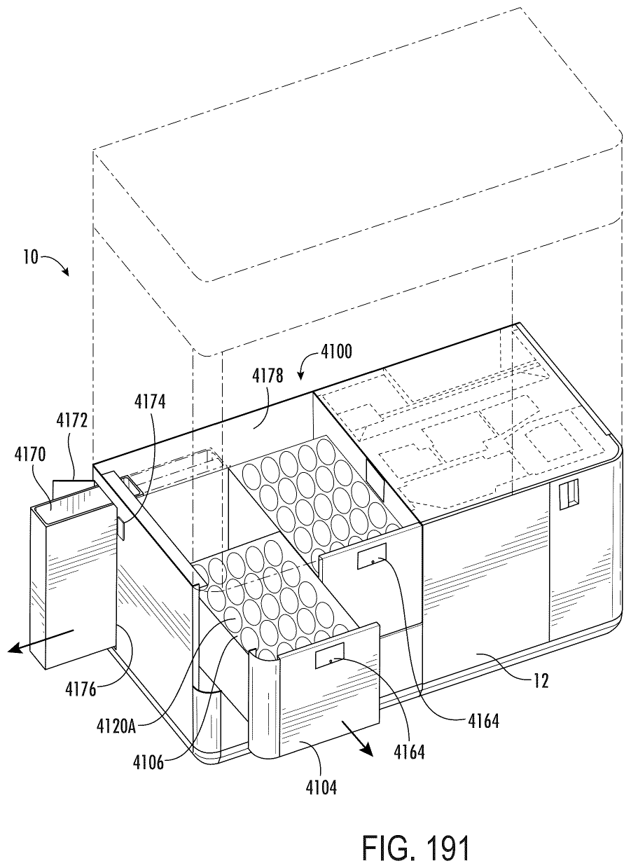

Referring now to FIG. 191, an alternative example outfeed assembly 4100 is depicted in an example system 10. The enclosure 12 of the system 10 is partially shown in phantom and some components of the system 10 have been hidden or simplified for sake of illustration. As shown, the outfeed assembly 4100 may include a plurality of outfeed drawers 4102 which include first arrays of receptacles 4106. The outfeed drawers 4102 may be coupled to drawer slide assemblies 4114 and may be opened to retrieve bags 26 out of the first receptacle arrays 4106. The outfeed drawers 4114 may be simplified variants of those shown in FIG. 187 and FIGS. 188A-C. The outfeed drawers 4114 may include a single lock assembly 4116A and may omit a telescoping portion. Acceptable bags 26 may be placed in the receptacles 4120A of the outfeed drawers 4102.

The outfeed assembly 4100 may include a discard receptacle 4170 which may be segregated from the outfeed drawers 4102. Any bags 26 which do not meet all required quality criteria may be transported to the discard receptacle 4170 by the gantry assembly 4200 and deposited therein. The discard receptacle 4170 may be displaced at least partially out of the enclosure 12 via a discard access 4172. The discard access 4172 may be a door or hatch which may be locked absent presentation and verification of a specialized credential and user input to the system 10 requesting the discard access 4172 be unlocked. A discard access state sensor 4174 may be included and may output a signal which varies depending on whether the discard access 4172 is opened or closed. When the discard access 4172 is opened, the discard receptacle 4170 may be drawn out of an aperture 4176 of the enclosure 12 and any contents may be removed and disposed of.

Referring now to FIGS. 192A-C, a block diagram of an example fluid handling system 3900 which may be included in a system 10 is depicted. The exemplary fluid handling system 3900 receives water from a water source 3902 and may generate a diluent or medical excipient from that water. The fluid handling system 3900 routes the diluent to a fill station 2600 such as any of those shown or described herein. The diluent produced in the fluid handling system 3900 may be dispensed into a reservoir such as a bag 26 via a dispensing sharp 2604 of a cartridge 2606 (see, e.g., FIG. 81A). The bag 26 may contain a concentrate and the diluent may be dispensed into the bag 26 in a volume sufficient to generate a solution with a desired concentration from the concentrate in the bag 26. The fluid handling system 3902 may include a variety of water treatment devices which may purify the water from the water source 3902 to a meet a predetermined set of criteria. For example, the fluid handling system 3900 may purify water from the water source into USP (or some other pharmacopeia) water for injection (WFI). Other USP monograph waters may be produced in alternative embodiments. Other example waters may include water for hemodialysis.

The fluid handling system 3900 may include a plurality of sensors for monitoring fluid within the fluid handling system 3900. The control system 15 may use data from the sensors to ensure the diluent produced by the fluid handling system 3900 complies with a predetermined set of quality criteria. The plurality of sensors may provide data used to monitor for changes in functionality of certain components within the fluid handling system 3900. The sensors may also provide data used by the control system 15 to govern control of pumps, valves, heaters, and other components within the fluid handling system 3900.

Example fluid handling systems 3900 may produce disinfection fluid which may be used to disinfect portions of the fluid handling system 3900 as well as portions of a cartridge 2606 (see, e.g., FIG. 81A). Disinfection fluid may be used to disinfect connection interfaces with various replaceable or consumable components. For example, disinfection fluid may be used to disinfect the connection interface for a cartridge 2606. The disinfection fluid may also disinfect a portion of the consumable component being installed such as a section of a connection port 2812 (see, e.g., FIG. 106A of a cartridge 2606). The disinfection fluid may be heated diluent in certain examples.

Referring primarily to FIG. 192A, the fluid handling system 3900 may receive water from a water source 3902. The water source 3902 may be a source of potable water and in some examples may be a municipal drinking water supply. An inlet fluid pressure sensor 3904 and inlet fluid conductivity sensor 3906 may be included to generate data relating respectively to the pressure and conductivity of incoming fluid. The pressure sensor 3904 data may be monitored by the control system 15 to ensure that the water source 3902 is supplying water or supplying water above a predetermine inlet fluid pressure threshold.

Conductivity sensor 3906 and other conductivity sensors described herein may include a temperature sensor which may output temperature data. The control system 15 may analyze the temperature data and conductivity data from each conductivity sensor (e.g. 3906) in order to determine a conductivity of the fluid monitored by a given conductivity sensor.

As shown, an inlet valve 3908 may be included with an input flow sensor 3910 being included downstream of the inlet valve 3908. Fluid may flow from the input flow sensor 3910 to at least one carbon filter 3912. The carbon filter 3912 may remove larger particulate as well as chlorine and chloramine from the incoming fluid. A sample valve 3914 may be disposed after the first carbon filter 3912 and may be commanded (e.g. when the control system 15 registers actuation of a dispense button) to an open state in order to dispense permeate from the carbon filter 3912 through a sample port 3918. The sample port 3918 may be accessible from an exterior of the enclosure 12 of a system 10. Fluid may be dispensed from the sample port 3918 into a reservoir 3920 to test for the presence of one or more contents of interest. For example, testing may be done on a periodic basis to ensure that the carbon filter 3912 is removing chlorine/chloramine from the incoming fluid.

After passing through the one or more carbon filter 3912, the fluid may pass a post carbon filtration pressure sensor 3922. The control system 15 may monitor data from the post carbon filtration pressure sensor 3922 and compare this data to data from the inlet pressure sensor 3904 and inlet flow sensor 3910. The control system 15 may ensure that a pressure drop across the one or more carbon filter 3912 which is within an expected range is observed. In the event that the pressure drop is outside of the expected range, the control system 15 may prevent dispensing of fluid to a fill station 2606 and may require the carbon filter(s) 3912 be replaced. After passing the post carbon filtration pressure sensor 3922, fluid may flow to a pressure regulator 3924 which may regulate downstream fluid pressure to some predefined value.

In various implementations, a flush conduit 3926 may be included. When a flush valve 3928 on the flush conduit 3926 is in an open state, a flow path may be established to a flushing drain 3930A. Fluid may be passed through the carbon filter(s) 3912 to flush the carbon filter(s) 3912. The control system 15 may command the flush valve 3828 to the open state and flow at least a preset flushing volume of fluid from the water source 3902 through the carbon filter(s) 3912 each time one or more carbon filter 3912 is replaced. The control system 15 may orchestrate flushing of the carbon filter(s) 3912 by monitoring data from the input flow sensor 3910. For example, the control system 15 may flush the carbon filter(s) 3912 until data from the input flow sensor 3910 indicates at least a preset amount of fluid has passed through the carbon filter(s) 3912.

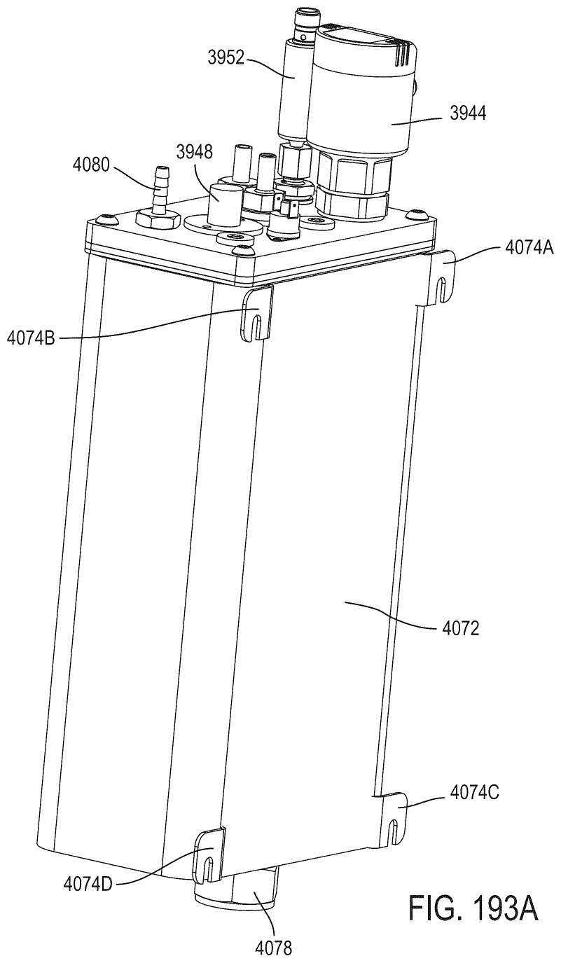

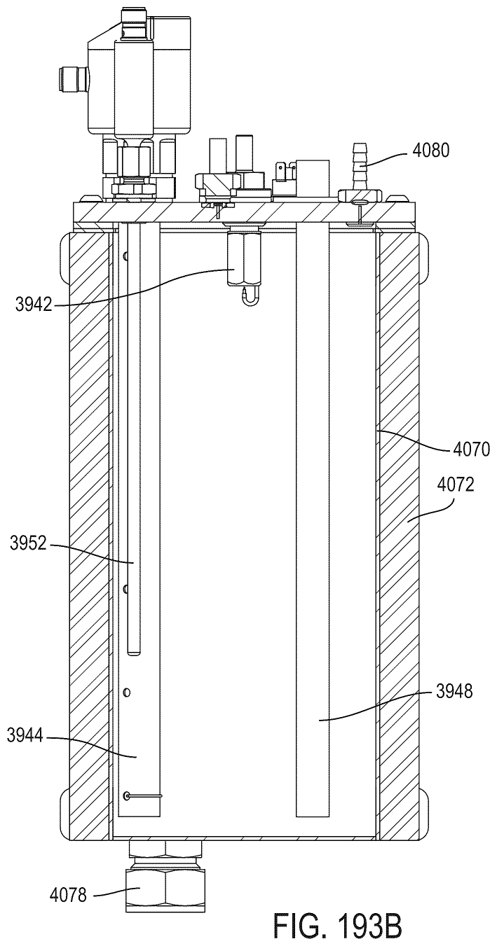

An accumulator inlet valve 3932 may be disposed downstream of the pressure regulator 3924. The control system 15 may close the accumulator inlet valve 3932 when flush valve 3928 is in an open state. The accumulator inlet valve 3932 may be opened to deliver fluid to an accumulator reservoir 3934 of the fluid handling system 3900. The example accumulator reservoir 3934 isolates the source pressure from the rest of the fluid handling system 3900. The accumulator reservoir 3934 may also be heated. This may kill microbes, inhibit microbial growth, and assist in deaerating water introduced to the fluid handling system 3900. The example accumulator reservoir 3934 assists in generating disinfection fluid by providing a source of elevated temperature water. An example accumulator reservoir 3934 is described in further detail in relation to FIGS. 193A-B.

As shown, the accumulator reservoir 3934 may be paired with one or more heat exchanger 3936. Fluid delivered to the accumulator reservoir 3934 may be routed through the heat exchanger(s) 3936 to recover heat from the fluid exiting the accumulator reservoir 3934. This will increase the temperature of fluid being introduced to the accumulator reservoir 3934 allowing the heating of fluid at the accumulator reservoir 3934 to be more efficient. The heat exchanger(s) 3936 also decrease the temperature of fluid leaving the accumulator reservoir 3934. Typically, fluid dispensed from the fill station 2600 may be in a range of 25-40° C. The heat exchanger(s) 3936 may reduce the temperature of fluid exiting the accumulator reservoir 3934 to at least the upper bound of this range. The heat exchanger(s) 3936 may be any suitable variety of heat exchanger 3936 though plate type heat exchangers may be particularly advantageous due to their compactness.

The fluid handling system 3900 may include a bypass flow path 3940. The bypass flow path 3940 may allow fluid to be routed around the heat exchanger(s) 3936 depending on the state of a heat exchanger bypass valve 3938. This may allow fluid exiting the accumulator reservoir 3936 to be kept at elevated temperature and used as a disinfect fluid.

As fluid enters the accumulator reservoir 3934, it may pass through a mister or atomizer 3942. As shown, an accumulator heater 3948 may additionally be included in the accumulator reservoir 3934. The atomizer 3942 in conjunction with the heat from the accumulator heater 3948 help to remove dissolved gases from the incoming water. The example accumulator reservoir 3934 includes a vent flow path 3946 which may also serve as an overfill relief flow path. The vent flow path 3946 may be in communication with an accumulator drain 3930B or other discard reservoir. Gas from deaeration of the incoming water may be vented through the vent flow path 3946.

The accumulator heater 3948 may be powered to heat fluid within the accumulator 3934 to a predefined temperature value. Signals from one or more accumulator temperature sensor 3952 may be utilized by the control system 15 to set and adjust a duty cycle for the accumulator heater 3948. For example, the control system 15 may alter a PWM command to the heater using a P, PI, or PID control loop informed by the accumulator temperature sensor 3952 data signal. In some examples, the predefined temperature value targeted for fluid in the accumulator may be 75-85° C. (e.g. 80° C.). A heater temperature sensor 3950 may also be included and the control system 15 may shut off power to the accumulator heater 3948 in the event that the heater temperature sensor 3950 indicates the accumulator heater 3948 is in breach of a predetermined over temperature threshold. Fluid exits the accumulator reservoir 3934 via an accumulator outlet flow path 3953 and passes to the heat exchanger(s) 3936.

A level sensor 3944 may be included and may output a signal which varies in relation to the level of a liquid held within the accumulator reservoir 3934. The level sensor 3944 may be any suitable variety such as a float type level sensor. The level of liquid within the accumulator reservoir 3934 may, for example, be maintained within a fill level range. The control system 15 may use data from the level sensor 3944 to govern operation of the accumulator fill valve 3932. This may facilitate maintaining the level of fluid within the accumulator reservoir 3934 at or within a range of a preset target level.

Referring now also to FIG. 192B, fluid may be drawn from the accumulator reservoir 3934 by powering a filter inlet pump 3954. Preferably, the accumulator reservoir 3934 may be placed above the filter inlet pump 3954 such that the head height of the accumulator reservoir 3934 provides fluid at positive pressure to the filter inlet pump 3954. This may help prevent cavitation within the fluid as the filter inlet pump 3954 is powered.

As fluid is drawn from the accumulator 3934, it may pass at least one irradiator 3956. The irradiator 3956 may include one or more UV lights, for example, LEDs which emit light in a UVC wavelength. Upstream of the irradiator 3956 may be at least one heat exchanger output temperature sensor 3957. The control system 15 may ensure that fluid leaving the heat exchanger 3936 is within an acceptable range based on data from the heat exchanger output temperature sensor 3957. The acceptable range may be determined based on the irradiator 3956 selected. This may ensure that the lumen output of the irradiator 3956 is above a preset threshold.

The filter inlet pump 3954 may be powered to drive fluid through a filter assembly 3962. In the example embodiment, the filter assembly 3962 includes a reverse osmosis filter 3964 and a filtration assembly heater 3966. The filter assembly heater 3966 may be a blanket type heater that at least partially surrounds the filter 3964 and fluid paths therethrough. A filtration assembly heater temperature sensor 3968 and a filter temperature sensor 3970 may be included in the filter assembly 3962. The control system 15 may alter a PWM command to the heater using a P, PI, or PID control loop informed by filter temperature sensor 3970 data signal to maintain the filter assembly 3962 at or within a range of a desired temperature set point. The control system 15 may shut off power to the filtration assembly heater 3966 in the event data from the filtration assembly heater temperature sensor 3968 indicates the filtration assembly heater 3966 temperature is in breach of an over temperature threshold. Intermediate the filter inlet pump 3954 and filter assembly 3962 may be a pump outlet pressure sensor 3958 and a conductivity sensor 3960.

Retentate from the filter assembly 3962 may pass to a recirculation flow path 3972 and may return to the filter inlet pump 3954 when a retentate flow valve 3978 is in an open state. Retentate may alternatively be delivered to a retentate drain 3930C when a retentate drain valve 3974 is transitioned from a closed to an open state. A drain flow rate sensor 3976 may output a signal which varies in relation to the flow rate of retentate to the drain 3930 when the retentate drain valve 3974 is in an open state.

Retentate passing from the filter assembly 3962 to the recirculation flow path 3972 may be monitored for pressure, flow rate, temperature, and conductivity. At least one retentate pressure sensor 3980, retentate flow rate sensor 3982, and conductivity sensor 3984 (which may also monitor and output temperature data) may be included for this purpose. A check valve 3986 may be included to ensure one directional flow within the recirculation flow path 3972. The control system 15 may monitor data from the retentate conductivity sensor 3984 and may adjust the state of the retentate drain valve 3974 to direct the retentate stream to the retentate drain 3930C when the conductivity of the retentate rises above a predefined threshold.

The flow rate of the retentate stream may be kept relatively high. The high retentate flow may rinse the input side of the filter 3964 membrane mitigating concentration polarization and related concerns. The control system 15 may monitor data from the retentate flow rate sensor 3982 and adjust the state of the retentate flow valve 3978 in order to achieve a target retentate flow rate or maintain the flow rate within a predetermined range thereof. The control system 15 may alter a PWM command to the retentate flow valve 3978 using a P, PI, or PID control loop informed by flow rate sensor 3982 data signal to maintain desired retentate flow.

Permeate from the filter assembly 3962 may pass from the filter assembly 3962 to a permeate flow path 3989. As shown, the pressure, flow rate, temperature, and conductivity of fluid may be sensed on the permeate flow path 3989. A permeate pressure sensor 3990, permeate flow rate sensor 3992, and permeate conductivity sensor 3994 (which may also monitor and output temperature data) may be included for this purpose.

Certain embodiments may include a pressure relief valve 3996 on the permeate flow path 3989. The pressure relief valve 3996 may be opened to establish a path to a pressure relief drain 3930D. The pressure relief valve 3996 may be selected to automatically open at a predetermined pressure (e.g. 45p.s.i.). The opening pressure for the pressure relief valve 3996 may be chosen to be lower than a maximum operating pressure of a downstream component. In certain examples, opening pressure may be lower than the lowest maximum operating pressure of any downstream component.

The permeate flow path 3989 may extend to one or more polishing unit 3988. An electrodeionization unit may be included as the polishing unit 3988 in certain examples. In such embodiments, after passing a check valve 3998, the permeate stream may furcate into a number of input flow streams to the electrodeionization unit. As shown, the permeate flow path 3989 may furcate into a feed stream flow path 4000, an electrode stream flow path 4002, and a concentrate stream flow path 4004. The product output of the polishing unit 3988 may be coupled to a polished fluid flow path 4014.

An electrode stream flow sensor 3999 may be included and may monitor the flow rate of fluid through the electrode stream flow path 4002. A polished fluid flow sensor 4019 may also monitor product flow exiting the electrodeionization unit through the polished fluid flow path 4014. The total flow to the electrodeionization unit indicated by the permeate flow rate sensor 3992, the electrode flow sensor 3999 output, and polished fluid flow sensor 4019 may be used to determine the concentrate stream flow rate.

Flow controllers 4006A-B may be included on each of the electrode stream flow path 4002 and concentrate stream flow path 4004. The flow controllers 4006A-B may set the flow of fluid into the electrode and concentrate flow paths 4002, 4004. In certain examples, the flow controllers 4006A, B may be orifice type flow restrictors. Valves which may be toggled between open and closed states by the control system 15 may alternatively be included.

Fluid from the electrode stream flow path 4002 may exit the polishing unit 3988 and be directed to a drain 3930E. A check valve 4008 may be included to prevent backflow. Fluid from the concentrate stream flow path 4004 may exit the polishing unit 3988 and be delivered to a drain 3930F. A check valve 4009 may be included to prevent backflow. In alternative embodiments, the concentrate stream flow path 4004 may be plumbed to return to the inlet side of the filter inlet pump 3954, accumulator reservoir 3934, or a dedicated break tank from which the filter inlet pump 3954 may draw.

Fluid from the feed stream flow path 4000 may exit the polishing unit 3988 and pass to polished fluid flow path 4014. At least one irradiator 4010 may be disposed intermediate the polishing unit 3988 and depyrogenation unit 4012. Example irradiators 4010 may, for example, emit UVC light and include one or more LED. In certain embodiments, the irradiator 4010 may be the same as irradiator 3956. The irradiator 4010 may be paired with a temperature sensor upstream of the irradiator 4010 in certain examples. The control system 15 may ensure that product fluid leaving the polishing unit 3988 is within an acceptable temperature range based on data from this temperature sensor. This may ensure that the lumen output of the irradiator 4010 is above a preset threshold.

A polished fluid flow sensor 4019, polished fluid pressure senor 4020, and polished fluid pre-heater temperature sensor 4022 may monitor fluid in the polished fluid flow path 4014 upstream of a polished fluid heater 4016.

A polished fluid output temperature sensor 4024 may monitor the temperature of fluid in the polished fluid flow path 4014 downstream of the polished fluid heater 4016. A polished fluid heater temperature sensor 4026 may also be included. The control system 15 may power the polished fluid heater 4016 to heat the polished fluid to or within a range of a predetermined temperature set point. The control system 15 may generate a duty cycle command to the polished fluid heater 4016 based on data signals from the polished fluid flow sensor 4018, polished fluid pre-heater temperature sensor 4022, and polished fluid output temperatures sensor 4024. The control system 15 may also monitor the data signal from the polished fluid heater temperature sensor 4026 and shut off power to the polished fluid heater 4016 in the event that a predefined over temperature threshold is breached.

Fluid in the polished fluid flow path 4014 may flow to a depyrogenation unit 4012 at the downstream end of the polished fluid flow path 4014. The depyrogenation unit 4012 in the example embodiment includes at least one ultrafilter. In examples where the depyrogenation unit 4012 includes one or more ultrafilter, retentate from the ultrafilter may pass to a return flow path 4028. A check valve 4030 may be included to ensure flow in the return flow path 4028 is unidirectional. A return flow valve 4032 may be included on the return flow path 4028 to control flow of fluid through the return flow path 4028. Fluid in the return flow path 4028 may be fed back to the filter assembly 3962 via filter inlet pump 3954.

Referring now also to FIG. 192C, permeate from the ultrafilter may pass to a dispensing flow path 4044 in a dispensing portion of the fluid handling system 3900. Fluid in the dispensing portion of the fluid handling system 3900 may be subjected to various quality characteristic sensing and directed either to a drain 3930D, E or dispensing sharp 2604 (see, e.g., FIG. 118) as appropriate. Fluid passing from the depyrogenation unit 4012 may be monitored for pressure and temperature by respective pressure and temperature sensors 4034, 4036. In examples including an ultrafilter, the control system 15 may check the dispensing portion inlet pressure sensor 4034 against the polished fluid pressure sensor 4020. In the event that a pressure drop less than a predetermined amount is detected, the control system 15 may prohibit delivery of fluid to the fill station 2600 and fluid may be directed to a drain 3930D. The control system 15 may generate a notification to change the depyrogenation unit 4012. The control system 15 may require confirmation that the depyrogenation unit 4012 has been replaced and may orchestrate a disinfect cycle for the fluid handling unit 3900 prior to allowing fluid to be routed to the fill station 2600. Provisioning of fluid to the fill station 2600 may be prohibited until the depyrogenation unit 4012 is replaced and disinfected.

A total organic carbon (TOC) sensor 4038 may be included in the fluid handling system 3900. In the example, the TOC sensor 4038 includes a conductivity sensor 4040 and temperature sensor 4042 to assist in generating the TOC data. The TOC sensor 4038 is provided on a slip stream 4046 off the dispensing flow path 4044 in the example depicted. The slip stream 4046 may be or may include a heat exchanger 4047. The heat exchanger 4047 may lower the temperature of the fluid en route to the TOC sensor 4038 to a temperature below the maximum operating temperature for the TOC sensor 4038. As mentioned above, high temperature disinfect fluid may be generated by the fluid handling system 3900. The heat exchanger 4047 may lower the temperature of this fluid below 70° C. (e.g. below 60-65° C.). In some embodiments, the slip stream 4046 may be or include a coil of metal (e.g. stainless steel) tubing which acts as the heat exchanger 4047. TOC data from the TOC sensor 4038 may be compared to a predefined threshold by the control system 15. In the event that the TOC data is in breach of the threshold, fluid may be directed to a drain 3930G and inhibited from passing to the fill station 2600.

A flow control valve 4048 may be included downstream of the furcation of the slip stream 4046 off of the dispensing flow path 4044. One or more sets of redundant sensors may be included downstream of the flow control valve 4048. In the example embodiment, a set of conductivity sensors 4050A, B are included. The conductivity sensors 4050A, B may be ultrapure water conductivity sensors in certain examples. The control system 15 may compare data from the conductivity sensors 4050A, B to ensure that the difference in conductivity indicated by data from each of the sensors 4050A, B is below a predetermined threshold. In the event the data from the conductivity sensors 4050A, B diverge from one another a sufficient amount to breach the threshold, the control system 15 may direct fluid in the dispensing flow path 4044 to a drain 3930D. Fluid may similarly be routed to a drain 3930G if the data from the conductivity sensors 4050A, B indicates that the conductivity of fluid in the dispensing flow path 4044 is in excess of a predefined value. The bag 26 in place at the fill station 2600 may be flagged by the control system 15. After the bag 26 is removed from the fill station 2600 the bag 26 may be marked as rejected. This may, for example, be accomplished with a marking assembly 3700 such as that depicted in FIG. 170. The bag 26 may be placed in a quarantine location after marking (see, e.g., receptacles 4120B of FIG. 185).

The control system 15 may prohibit filling of another bag 26 at the fill station until a flush of the dispensing flow path 4044 and cartridge 2606 has completed. The control system 15 may displace a prime line 3120 to the cartridge 2606. Example prime lines 3120 are further described in relation to FIG. 108. Fluid may be delivered into the prime line 3120 at least until the conductivity sensors 4050A, B indicate the conductivity of the fluid is below a threshold. A predefined flushing volume may be transferred through the cartridge 2606 and into the prime line 3120 after the conductivity value has decreased below the predefined conductivity threshold. A set of flow rate sensors 4052A, B may be monitored to determine when the flushing volume has been delivered. The prime line 3120 may then be removed and the control system 15 may resume filling of bags 26 at the fill station 2600.

A set of flow rate sensors 4052A, B may also be utilized to ensure bags 26 are filled to a desired amount. The control system 15 may monitor the signal from the flow rate sensors 4052A, B. Fluid may continue to be transferred into a bag 26 through the cartridge 2606 until the flow rate sensors 4052A, B indicate a target amount of fluid is dispensed into a bag 26 in place at the fill station 2600. As with the conductivity sensors 4050A, B, the control system 15 may also compare the data from each flow rate sensor 4052A, B. The control system 15 may prohibit filling of bags 26 in the event that the data from the flow rate sensors 4052A, B diverge by more than a certain amount. A set of cartridge input temperature sensors 4054A, B and a cartridge input pressure sensor 4056 may also be included downstream of the flow control valve 4048.

Fluid may be delivered from the dispensing flow path 4044 to an interface for a cartridge 2606 (see, e.g., FIG. 106B). In the example embodiment, the interface is shown as a receptacle 2818 of a supply manifold 2820 (further described elsewhere herein, see, e.g., FIGS. 106A-D). At least some of the fluid characteristic sensors 4050A, B, 4052A, B, 4054A, B, 4056 may be included in the supply manifold 2820 in certain embodiments. A supply manifold 2820 including a cartridge input temperature sensor 4054B and a cartridge input pressure sensor 4056 is depicted in FIG. 87.

As further described in relation to FIGS. 106A-B, a cartridge 2606 may include a connection port 2812 which may be covered by a frangible 2816. The connection port 2812 may be advanced into the receptacle 2818 an amount sufficient for a sealing member of the connection port 2812 to seal against the walls of the receptacle 2818 downstream of a disinfection outlet flow path 2824. Disinfection fluid may be delivered to the connection interface and may exit the connection interface through the disinfection outlet flow path 2824. This may bathe the frangible 2816 and a portion of the connection port 2812 in disinfection fluid. The cartridge input temperature sensors 4054A, B may be monitored to ensure that the disinfection fluid temperature is within a target set point or range at a point proximate the connection interface. The target temperature may be 75-85° C. (or 80° C. where a set point is used). Once the frangible 2816 and portion of the connection port 2812 have been bathed in disinfection fluid for a predetermined period of time, the dispensing sharp 2604 may be placed into fluid communication with the dispensing flow path 4044 via the cartridge 2606. This may be accomplished by further advancing the connection port 2812 within the receptacle 2818 until a spike 2822 in the receptacle 2818 punctures the frangible 2816. At least one sealing member on the connection port 2812 may be displaced upstream of the disinfection outlet flow path 2824 as the connection port 2812 is spiked. This may block flow from the dispensing flow path 4044 to the disinfection outlet flow path 2824.

During disinfection of the connection port 2812 and frangible 2816, fluid passing through the disinfection outlet flow path 2824 may be routed to a drain 3930H. Fluid delivered to the prime line 3120 may also be communicated to the drain 3930H. In some examples, there may be a valve upstream of the connection interface which may route fluid to the drain flow path 4060. This valve may be toggled by the control system 15 to direct fluid into the drain flow path 4060 in the event that data from one of the fluid characteristic sensors 4050A, B, 4052A, B, 4054A, B, 4056 indicates the fluid in the dispensing flow path 4044 is out of correspondence with a respective predefined criteria. As shown, a flow selector valve 4058 may be included and may control flow into the drain flow path 4060. The flow selector valve 4058 may close flow to the drain flow path 4060 or permit flow from either the prime line 3120 or dispensing fluid flow path 4044. A drain pressure sensor 4062 may be included on the drain flow path 4060 and may output a signal indicative of fluid pressure with the drain flow path 4060. A drain pump 4064 may also be in the drain flow path 4060. The drain pump 4064 may be powered to draw fluid out of a cartridge 2606 or prime line 3120. Fluid may be drawn out of the cartridge 2606 before the cartridge 2606 is removed from the fill station 2600. The drain pump 4064 may additionally be run during disinfection of the connection port 2812 for a newly installed cartridge 2606.

Referring now to FIGS. 192A-C, the fluid handling system 3900 may also generate and route disinfect fluid through the fluid handling system 3900 to disinfect the fluid handling system 3900. This may be done on some periodic basis and/or each time the cartridge 2606 or a filter of the fluid handling system 3900 is replaced. The disinfect fluid may be high temperature water in certain examples.

Referring now to FIGS. 193A-B, a perspective view of an example accumulator reservoir 3934 and a cross-sectional view showing the interior thereof are respectively shown. As show, the example accumulator reservoir 3934 includes a housing 4070 defining the interior volume of the accumulator reservoir 3934. The interior volume may vary from embodiment to embodiment, though in some embodiments, may be at least double the capacity of a reservoir (e.g. bag 26) to be filled at the filling station 2600 of the system 10. The interior volume may be two liters in some examples. The housing 4070 may be surrounded at least partially by insulation 4072. The housing 4070 includes mounting brackets 4074A-D for coupling the accumulator reservoir 3934 to a portion of an enclosure 12 of the system 10.

The accumulator reservoir 3934 includes an atomizer 3942 through which fluid may be fed into the accumulator reservoir 3934. The housing 4070 includes an interface panel 4076 which may be coupled to the rest of the housing 4070 with a gasket 4078 therebetween. A level sensor 3944, accumulator temperature sensor 3952, and accumulator heater 3948 may extend into the interior volume of the accumulator reservoir 3934 via the interface panel 4076. A vent fitting 4080 may also be included on the interface panel 4076 for coupling to the vent flow path 3946. An outlet port 4078 is also depicted and may be positioned at a low point or at the bottom of the accumulator reservoir 3934.

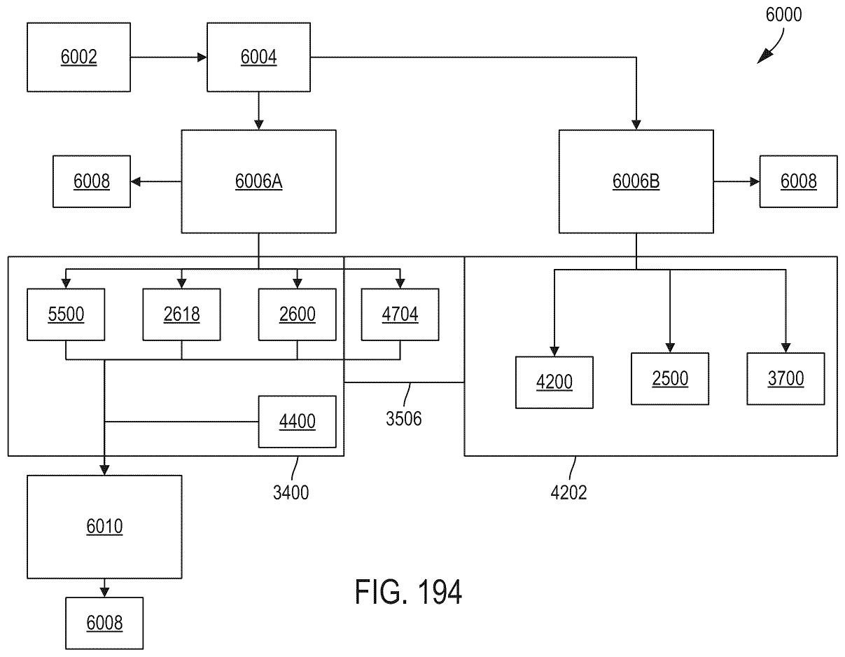

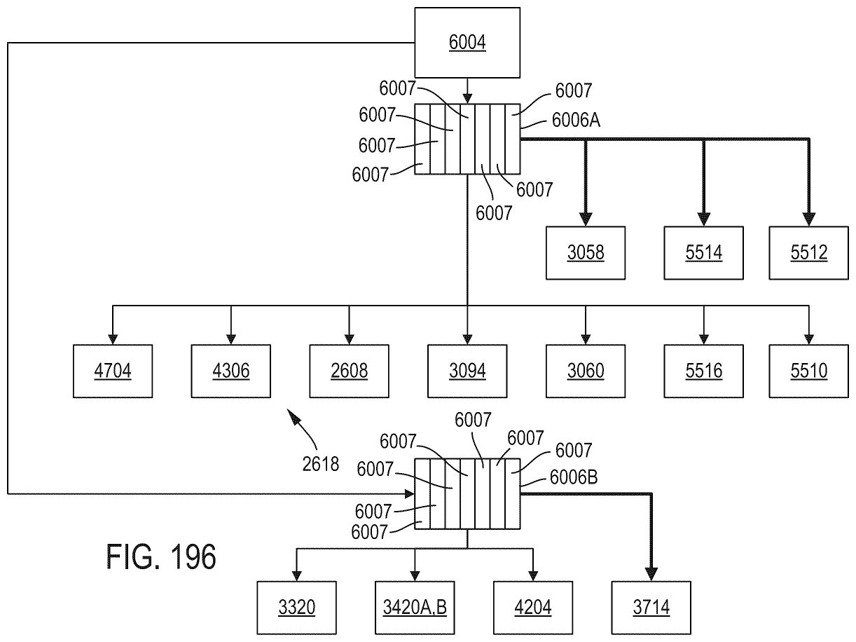

Referring now to FIG. 194, a block diagram of an example pneumatic distribution system 6000 which may be included in the systems 10 described herein is depicted. The pneumatic distribution system 6000 may receive air from a pressurized air source 6002. The pressurized air source 6002 may be a shop air system or other compressed air utility. The pressurized air source 6002 may provide pressurized air at a pressure between 80-120 psi in certain examples. Air from the pressurized air source 6002 may pass through a preparation assembly 6004 which may include various filters, driers, pressure sensor, and pressure regulators. Air from the preparation assembly 6004 may be plumbed to one or more valve bank 6006A, B. In some examples, and as depicted, a first valve bank 6006A may be included for controlling supply of air to components in the processing chamber 4300 (see, e.g., FIG. 2). A second valve bank 6006B may be included for provisioning air to other components (e.g. those in the outfeed compartment 4202). Each valve bank 6006A, B may include a plurality of pneumatic valves 6007 (see, e.g., FIG. 196) of the same or differing varieties. The valve banks 6006A, B may receive pressurized air regulated to a plurality of different pressures from the preparation assembly 6004.

Still referring to FIG. 194, the first valve bank 6006A may supply pressurized air to the sanitary interface assembly 5500, the bag displacement assembly 2618, and the fill station 2600. Where the splitter assembly 4406 of the bag individualization assembly 4400 is pneumatically driven, the bag individualization assembly 4400 may also receive pressurized air via the first valve bank 6006A. In certain examples, the first valve bank 6006A may further supply pressurized air to any components in the transfer chamber 3506. Where a pneumatic gripper is used in the bag retainer 4704 of the transfer chamber 3506, air to actuate the gripper may be supplied via the first valve bank 6006A. The second valve bank 6006B may supply pressurized air to the gantry assembly 4200, mix assisting assembly 2500, and marking assembly 3700.

A vacuum source 6010 may also be included in the pneumatic distribution system 6000. The vacuum source 6010 may, for example, be a vacuum pump. The vacuum source 6010 may be in communication with sanitary interface assembly 5500, the bag displacement assembly 2618, the fill station 2600, and the bag individualization assembly 4400. The vacuum source 6010 may also be plumbed into communication with the bag retainer 4704 of in the transfer chamber 3506. The negative pressure supplied to these components may be leveraged to draw particulate generated by these component out of the processing chamber 4300 or transfer chamber 3506. The valve banks 6006A, B and vacuum source 6010 may also be in communication with an exhaust 6008.

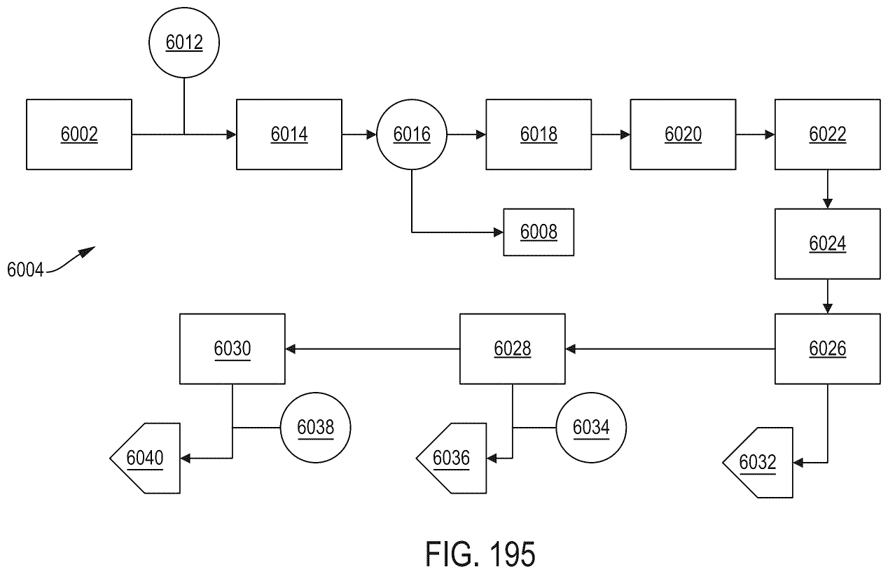

Referring now to FIG. 195, a block diagram of an example preparation assembly 6004 is depicted. The preparation assembly 6004 receives air from a pressurized air source 6002. The pressure of the air supplied from the pressurized air source 6002 may be monitored by at least one pressure sensor 6012. In the event that the pressure of air from the air source 6002 is not within a predefined range, a valve 6016 of the preparation assembly 6004 may be closed. A pressure regulator 6014 may be included to regulate the pressure of incoming air to a range or set point. The range or set point may be selected based upon pressure tolerance of downstream filters or other components.

After passing the pressure regulator 6014, air may be passed through a first filter 6018 and a second filter 6020. The first and second filters 6018, 6020 may remove particulate from the air supplied to the pneumatic distribution system 6000. The first filter 6018 may be a coarser filter than the second filter 6020. In some examples, the first filter 6018 may be a 1 micron filter and the second filter may be a 10 nm filter. The filtered air may then pass to a drier 6022 which may remove moisture content from the air. The drier 6022 may be a membrane type drier in certain embodiments. An additional filter 6024 (e.g. 10 nm) may be disposed downstream of the dryer 6022.

Dry filtered air may then be passed to a set of output regulators 6026, 6028, 6034. A greater or lesser number of output regulators 6026, 6028, 6034 may be included depending on the pressures desired to be supplied throughout the system 10. The first output regulator 6026 may provide pressurized air to a set of pilot air flow paths 6032 plumbed to the valve banks 6006A, B. The first output regulator 6026 may regulate air to a set point of 75-85 psi (e.g. 80 psi) in certain examples. In embodiments where the valve types used in the valve banks 6006A, B do not call for a pilot air source, the first output regulator 6026 and pilot air flow paths 6032 may be omitted. The second output regulator 6028 and third output regulator 6030 respectively provide high and low pressure air to various components in the system 10. The second output regulator 6028 may, for example, output 75-85 psi air to a set of high pressure flow paths 6036 to the valve banks 6006A, B. A pressure sensor 6034 may be included to monitor the pressure in the high pressure flow paths 6036. The second pressure regulator 6028 may be a soft start type regulator. The second pressure regulator 6028 may slowly ramp up the pressure in the high pressure flow paths 6036 to the high pressure set point. This may ensure that the pilot flow paths 6032 quickly attain their pressure set point while ensuring a lag is present in the high pressure flow paths 6032. The third output regulator 6030 may provide air at a pressure of 45-55 psi to a set of low pressure flow paths 6040 extending to the valve banks 6006A, B. A pressure sensor 6038 may be included to monitor pressure in the low pressure flow paths 6040. The control system 15 may monitor the output signal from the pressure sensors 6034, 6038 and may generate a fault in the event that the sensed pressure is in breach of a predefined expected range. The control system 15 may place the valves 6007 (see, e.g., FIG. 196) of the valve banks 6006A, B in a default state in the event an unexpected pressure is sensed.

Referring now to FIG. 196, different pressures may be supplied to different components of the system 10 via the valve banks 6006A, B. As shown, low pressure air may be supplied, via the first valve bank 6006A to the bag retainer 4704 in the transfer chamber 3506 (where the bag retainer 4704 includes a pneumatically actuated gripper). Low pressure air may also be supplied to the bag retention assemblies 4306 of the bag displacement assembly 2618. This air may be selectively supplied (by toggling valves 6007 in the valve bank 6006A) to the bag retention assemblies 4306 to actuator the jaws 4308A, B (see, e.g., FIG. 47A) of the bag retention assemblies 4306. Low pressure air may also be supplied to the irradiation assembly 2608 of the fill station 2600. This air may be selectively communicated to the actuation assembly 3139 (see, e.g., FIG. 111) in embodiments where the irradiation assembly 2608 is pneumatically driven through its displacement range. Low pressure air may also be selectively provided to the clean air output actuation assembly 3094 to displace the coupled displacement stage 3099 (see, e.g., FIG. 96). This may in turn engender a displacement of the clean air output 3090 (see, e.g., FIG. 98) to raise and lower the clean air output 3090 relative to an installed cartridge 2606. The cover engagement assembly 3060 (further described in relation to FIG. 88B) may also selectively receive low pressure air via the valve bank 6006A. A door rotation brake 5516 and a door latch 5510 of the sanitary interface assembly 5500 may additionally selectively receive low pressure air via the valve bank 6006A.

High pressure air may be supplied, via toggling of valves 6007 in the valve bank 6006A, to a cover displacement assembly 3058 of the cover removal assembly 3050. High pressure air may also be provisioned, via the valve bank 6006A to rotational and translational door displacement actuators 5512, 5514 of a sanitary interface assembly 5500.

The second valve bank 6006B may similarly supply air at a variety of pressure to components of the system 10. High pressure air may selectively be supplied to an embossing actuator 3714 of a marking assembly 3700 through the valve bank 6006B. Low pressure air may be selective passed to the gripper assembly 4204 of the gantry assembly 4200 as well as the gripper 3320 of the bag retention assembly 3310 of the mix assisting assembly 2500. The door actuators 3420A, B of the bag retention assembly 3310 may also selective receive low pressure air via the valve bank 6006B.

The valves 6007 of the valve banks 6006A, B may be selected based on the component they are paired with. In the event of a loss of electrical control, the valves 6007 may transition to a default state which places the component in a desired state.

Valves 6007 gating pneumatic pressure to bag holding components may be arranged to default to a valve state which supplies pressure that maintains the component in a holding state. Bag holding components, may include the jaws 4308A, B of the bag retention assemblies 4306, the jaws 4205A, B of the gantry assembly 4200, the gripper 3320 of the mix assisting assembly 2500, and the door actuators 3420A,B for each door 3400A, B of the mix assisting assembly 2500. Any other pneumatic grippers that may be included in the system 10 may similarly be paired with such a valve. Single solenoid 5/2 valves with a normally open or closed position may for example be used.

Any components which have a position which is always non-interfering with other components may be paired with a valve which defaults to a state in which the component is driven to non-interfering position. The clean air output actuation assembly 3094 may for example be paired with a valve 6007 which drives the clean air output 3090 to a raised position. Similarly components with an otherwise known desired default position may be paired with a valve 6007 that supplies pressure to drive the component to that position by default. The embossing actuator 3714 may for example be paired with a valve 6007 that supplies pressure to displace the 3702 to a retracted position by default. Single solenoid 5/2 valves with a normally open or closed position may for example be used.

Any components that position along a horizontal axis may be pair with valves 6007 that permit the components to stay in place when in their default state. Preferably, such components may be manually moved by service personnel. Center exhaust 5/3 valves may for example be used. Components which displace along a non-horizontal axis (e.g. vertical) may be paired with valves 6007 the hold them in place against gravity, but do not move them. The actuation assembly 3139 (see, e.g., FIG. 111) for the irradiation assembly 2608 may be paired with such a valve 6007. Center pressure 5/3 valves may for example be used.

Referring now to FIG. 197, a block diagram of an example negative pressure distribution assembly 6060 of the pneumatic distribution system 6000 is depicted. The example negative pressure distribution assembly 6060 includes a vacuum source 6010 which in the example embodiment is a pump. The vacuum source 6010 may include a temperature sensor 6044 which outputs a signal which varies in relation to the temperature of the vacuum source 6010. The control system 15 may generated a fault if the temperature indicated by the temperature sensor 6044 is outside of a predefined expected range. A muffling assembly 6041 may be included to mitigate noise generated by the vacuum source 6010. The muffling assembly 6041 may include an inline silencer and a vent silencer in series in certain examples. A condensate drain 6042 may be displaced intermediate the muffling assembly 6041 and the vacuum source 6010 in certain embodiments. Between the vacuum source 6010 and one or more pressure distribution manifold 6054 may be a relief valve 6046. The relief valve 6046 may be selected to open when a pressure in excess a predetermined limit is present. A valve 6048 may also be included intermediate the vacuum source 6010 and the at least one manifold 6054. The valve 6048 may be toggled to place the pressure source 6010 into communication with ambient 6050 if desired. A filter 6052 may be included between the valve 6048 and the manifold(s) 6054. The filter 6052 may capture any particulate which is evacuated from the system 10 via the negative pressure distribution assembly 6056. A pressure sensor 6056 may be disposed intermediate the filter 6052 and the manifold(s) 6052. The control system 15 may monitor the signal from the pressure sensor 6056 to confirm vacuum is being provided to the manifold(s) 6054 by the vacuum source 6010. This may allow the control system 15 to detect a fouled filter 6052 for example. A fault may be generated by the control system 15 if the data signal from the pressure sensor 6056 indicates a pressure of at least some predetermine magnitude cannot be maintained.

As shown, negative pressure may be supplied through the manifold(s) 6054 to a variety of components in the system 10. Vacuum may be supplied for a variety of reasons. Vacuum may be supplied to evacuate potential particulate generated by components from the processing compartment 4300, transfer chamber 3506, and optionally the outfeed compartment 4202. Vacuum may be supplied adjacent bearing and guide interfaces, in housings for motors or actuators, and into communication with vacuum ports on pneumatic displacement stages for removal of particulate. Vacuum may be supplied to certain components in order to assist in maintaining a controlled environment within the enclosure 12. Vacuum may be supplied to detect potential breaches of the controlled environment as well. The manifold(s) 6054 may include needle valves which may be adjusted to regulate the flow to each component. Alternatively, binary type solenoid valves may be included and may be operated based on a PWM signal provided from the control system 15 to regulate the pressure. Any other suitable valving arrangement such as variable orifice valves may be used.

One or more vacuum conduit 6058 may extend to the bag displacement assembly 2618. For example a vacuum conduit 6058 may be placed into communication with interior of the actuator housing 4328 (see e.g., FIG. 47B) for the extension actuator assembly 4330 for each bag retainer assembly 4306. Vacuum may also be supplied to the bag retention assemblies 4306 proximate the interface between the bearings 4325 and jaw bearing guide 4323 (see, e.g., FIG. 48A and FIG. 50A). A vacuum conduit may be routed to the interior of the housing 4728 for the rotary actuator of the bag retainer 4704 in the transfer chamber 3506. Where the bag retainer 4704 includes a gripper similar to those in example bag displacement assemblies 2618 described herein, vacuum may also be plumbed to any bearing interface for the gripper jaws. Vacuum may also be supplied to the cover engagement assembly 3060 in the vicinity of the bearing surfaces 3063 for the wing assemblies 3061. A vacuum conduit 6058 may also be plumbed to the bag displacement actuator 3144 for the bag displacement stage 3140 and the singulation actuator 4402 of the bag singulation assembly 4400. Vacuum may be supplied to various pneumatic displacement stages or actuators included within the system 10. For example, where the irradiation assembly 2608 is coupled to a pneumatic displacement stage, a vacuum conduit 6058 may be in communication with the actuation assembly 3139 (see, e.g., FIG. 111) for the irradiation assembly 2608. At least one vacuum conduit 6058 may also extend to the sanitary interface assembly 5500.

The bay 3054 of the housing 3052 (see, e.g., FIG. 88A) for the cover removal assembly 3050 (see, e.g., FIG. 88A) may be in selective communication with a vacuum conduit 6058 via a valve 6062. This may assist in retaining a cover 2996 (see, e.g., FIG. 93) within the bay 3054 of the housing 3052 when the cover engagement assembly 3060 (see, e.g., FIG. 88B) is in an engaged relationship with the cover 2996. One or more pressure sensor may be in communication with the bay 3054. The control system 15 may monitor the pressure indicated by the at least one pressure sensor 3051 to ensure a cover 2996 is sealed in place within the bay 3054 (described in greater detail in relation to FIG. 91B and FIG. 93). Thus, the vacuum source 6010 may assist in maintaining the controlled environment within the processing chamber 4300 and assist detection of a breach in the controlled environment.

Referring now to FIG. 198, a block diagram of an example air handling system 6200 which may be included in example systems 10 described herein is depicted. The example air handling system 6200 may be particularly compact while supporting the establishment and maintenance of a number of different zones which may be considered separate or different from an environmental control perspective. The zones may maintained at varying degrees of environmental control within the system 10. The air handling system 6200 may support transition between different levels of environmental control for a particular zone over time. The air handling system 6200 may also support merger of certain zones into the same environmental control regime and furcation of a zone into multiple zones controlled to differing levels of stringency.

Referring to now to FIGS. 198-200A, the air handling system 6200 may receive air from within the enclosure 12 of the system 10 as well as ambient air 6202 surrounding the system 10. Preferably the ambient air 6202 conforms to at least ISO 9 cleanroom standards. Ambient air 6202 (and air being recirculated within the enclosure 12) may pass to a pre-filter 6204. In various embodiments, the pre-filter 6204 is a coarse filter which removes large particles (e.g. 5 μm or larger) from incoming air. In various embodiments, the pre-filter 6204 may be have a minimum efficiency reporting value (MERV) of 11 or higher. After passing through the pre-filter 4202, air may optionally be passed through at least one of a muffler 6206 and a drier 6208. Air may then be drawn to a blower 6210. The blower 6210 may be of the centrifugal variety in certain implementations.

A pressure sensor 6302 and a particulate sensor 6304 may be associated with the pre-filter 6204. Any suitable pressure sensors 6302 may be used. Particulate sensors described herein may be non-viable particulate counters. The particulate counters may be multi-channel type counters which output signals indicative of counts for particulate in respective size ranges. For example, particulate counters may output data on particulate in first size range (e.g. 0.2-0.5 μm range) as well as counts for larger particulate (e.g. 5-30 μm size range). In some embodiments, counts for particulates in several (e.g. four-five) different size ranges may be output by the particulate sensors. For example, the pressure sensor 6302 and particulate sensor 6304 may be disposed downstream of the pre-filter 6204. The pressure from the pressure sensor 6302 may be compared to an output signal from an enclosure pressure sensor 6336 by the control system 15. In the event the control system 15 determines a pressure drop greater than a predefined amount is present through the pre-filter 6204, the control system 15 may generate a fault. Operation of the system 10 may be prohibited until the pre-filter 6204 has been replaced. The control system 15 may similarly generate a fault and inhibit further system 10 operation until service has been performed if data from the particulate sensor 6304 indicates particulate levels above a predefined threshold.

A humidity sensor 6300 may be included upstream of the drier 6208 in some examples. The control system 15 may monitor the data signal from the humidity sensor 6300 and may generate a fault in the event that the output from the humidity sensor 6300 indicates humidity has breached preset threshold (e.g. 70-80%). The control system 15 may also prevent operation of the system 10 in some examples. Any fault generated by the control system 15 may be accompanied by a notification generated by the controls system 15 for display on a graphical user interface 6100 of the system 10. As shown, the blower 6210 may further include a humidity sensor 6306. The control system 15 may compare the output from the upstream humidity sensor 6300 and blower humidity sensor 6306. In the event that the output from each humidity sensor 6300, 6306 is suggestive of an issue with the drier 6208 (e.g. the drier 6208 decreases the humidity less than a predetermined expected amount), the control system 15 may generate a fault.

The blower 6210 may also include a flowrate sensor 6308, temperature sensor 6310, and pressure sensor 6312. In various examples, the control system 15 may issue a command to the blower 6210 to output air at a certain flowrate. The blower 6210 may include an on-board controller 6211 which may utilize data from the blower sensors 6306, 6308, 6310, 6312 to adjust blower speed to achieve the commanded flow rate.

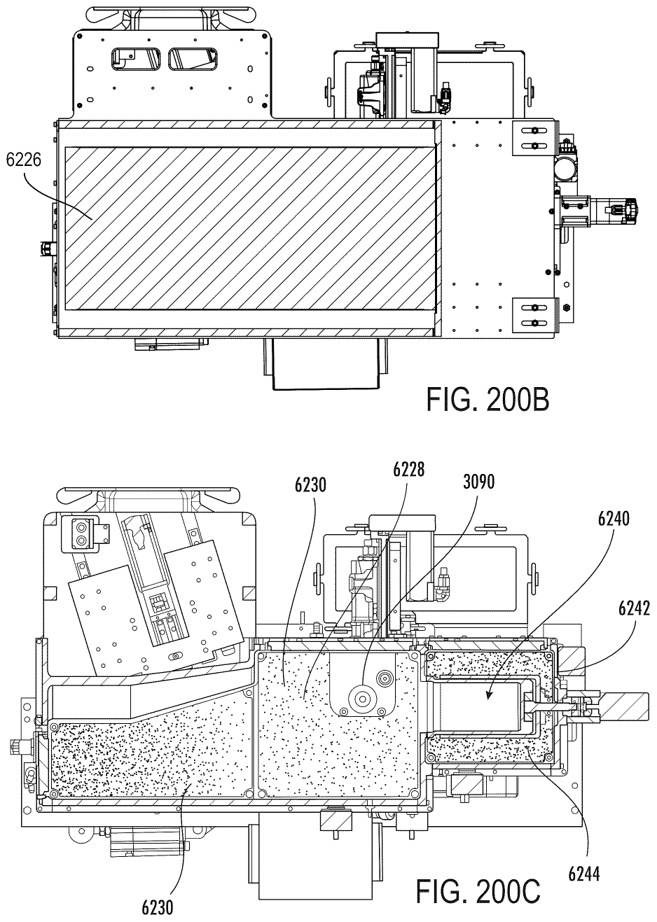

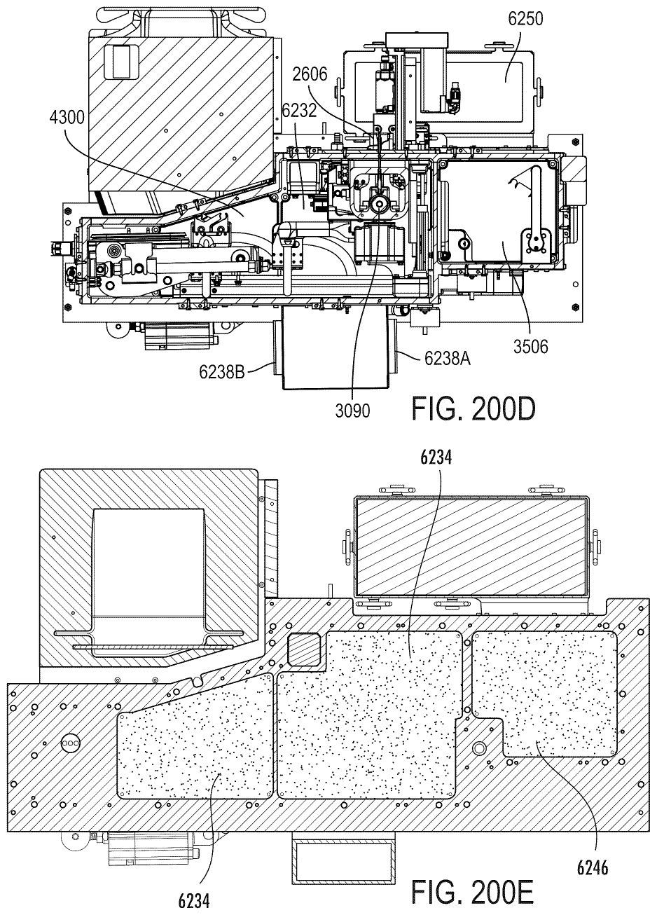

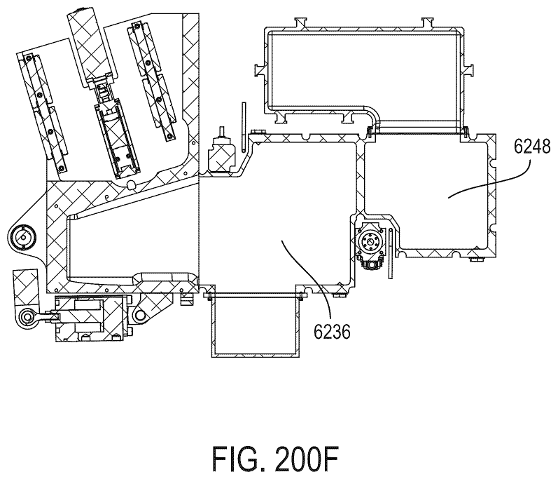

Still referring to FIGS. 198-200A, air from the blower 6210 may be directed into a guide passage 6212 leading to a flow straightener 6214. The walls of the guide passage 6212 may be angled to mitigate any turbulence in the airflow leaving the blower 6210 as the air is displaced through the guide passage 6212 to the flow straightener 6214. The flow straightener 6214 may assist in increasing the laminar character of the airflow out of the blower 6120. In certain embodiments, the flow straighten 6214 may include an array of elongate channels 6260 (see, e.g., FIG. 200A). The channels 6260 may, for instance, have rectangular or square cross-sections. The cross-sectional area of each of the channels 6260 may be substantially the same. The air may then pass through a first routing chamber 6216 and toward a first laminarizer 6218. The first routing chamber 6216 may form a bend in the airflow path. In the example shown in FIG. 200A, a substantially 90° bend is imposed by the first routing chamber 6216. The first laminarizer 6218 may also be an array of elongate channels 6262 (see, e.g., FIG. 200A). The channels 6262 may have a round or circular cross-section in various examples. The cross-sectional area of each of the channels 6262 may be substantially the same and smaller than the cross-sectional area of the channels 6260 in the flow straightener 6214. As air passes through the first laminarizer 6218, air may exit into a second routing chamber 6220. The second routing chamber 6220 may form a bend in the airflow path. As best shown in FIG. 200A, a substantially 90° bend is created by the second routing chamber 6220. A second laminarizer 6222 may be placed at the downstream end of the second routing chamber 6220. The second laminarizer 6222 may also include an array of elongate channels 6264 extending therethrough. The channels 6264 may have a round or circular cross-section in various examples. The cross-sectional area of each of the channels 6264 may be substantially the same and smaller than the cross-sectional area of the channels 6262 in the first laminarizer 6218.

Though the air flowing through the air handling system 6200 may have a relatively high Reynolds number (e.g. ˜10000), the serial placement of the flow straightener 6214 and laminarizers 6218, 6222 prevents the turbulent kinetic energy with the flow from increasing in an unchecked manner. Each of the flow straightener 6214 and laminarizers 6218, 6222 may act as a turbulent kinetic energy dampener which reduces the turbulent kinetic energy of the airflow. As a result, the airflow may possess a high Reynolds number, but behave in a generally laminar manner and be referred to as laminar or laminarized herein. Though three turbulent kinetic energy dampeners are shown, a greater or lesser number may be included in alternative embodiments.

Referring now to FIGS. 198-199 and FIG. 200B, air may pass through the second laminarizer 6222 to a filtration chamber 6224 in which a filter 6226 is housed. The filter 6226 may capture particulate of 0.2 μm or smaller (e.g. 0.12 μm). In certain examples, the filter 6226 may be an ultra-low particulate air (ULPA) filter.

Referring now to FIGS. 198-199 and FIG. 200C, filtered air from the filter 6226 may pass to a controlled environment supply plenum 6228. The controlled environment supply plenum 6228 may be disposed upstream of the processing chamber 4300 and transfer chamber 3506 of the system 10. Air may pass into the processing chamber 4300 through one or more processing chamber diffusion grid 6230. The processing chamber diffusion grids 6230 may be perforated panels which establish a pressure drop between the supply plenum 6228 and the processing chamber 4300. The size and arrangement of perforations for any diffusion grids described herein may be adjusted to generate the desired pressure drop at the minimum anticipated flowrate of air therethrough during operation. In some examples, the processing chamber diffusion grids 6230 may be arranged to be turbulent kinetic energy dampeners and include an array of channels similar to the laminarizers 6218, 6222. The pressure drop engendered by the processing chamber diffusion grid(s) 6230 may be a minimum of 5 Pa. In some embodiments, the pressure drop may be 7.5-15 Pa or higher (the same may be true for other diffusion grids described herein). In certain examples, the perforations in the processing chamber diffusion grids 6230 may be substantially uniform. Alternatively and as shown, the density of perforations or open area of the processing chamber diffusion grids 6230 may vary by grid or within a particular grid. Areas where more back pressure is expected in the processing chamber 4300 may have more open space or denser perforations in the aligned portion of the upstream diffusion gridding. Some regions of the processing chamber diffusion grids 6230 may optionally be solid or devoid or perforations (see, e.g. immediate vicinity of the clean air outlet 3090).

A pressure sensor 6314 may be in communication with the filtration chamber 6224 (e.g. upstream of the filter 6226) and may output a signal which is monitored by the control system 15. A pressure sensor 6316 and a particulate sensor 6318 may be included in the controlled environment supply plenum 6228 and may be in data communication with the control system 15. The control system 15 may compare the pre filter pressure sensor 6314 output to the post filter pressure sensor 6316 to confirm a predetermined expected pressure drop through the filter 6226 is observed. In the event that the pressure drop is less than a predefined expected value, the control system 15 may generate a fault and operation of the system 10 may be prohibited. The control system 15 may similarly generate and fault and inhibit operation of the system 10 in the event that the data signal from the post filter particulate sensor 6318 is indicative of a particulate count about a certain threshold.

As mentioned above, the example air handling system 6200 supports the establishment of multiple zones of varying environmental control stringency. In some examples, the processing chamber 4300 may be divided into a plurality of zones. A first zone may be established in the airflow channel 2802 (see, e.g., FIG. 98) of the cartridge 2606. The remainder of the processing chamber 4300 may be established as a second environmental control zone or supporting zone. The first zone may be more stringently controlled than the supporting zone.

The different zones may be differentiated based on one or more environmental control characteristics. The non-viable particle concentration in various zones may be controlled to differing levels. For example, the first zone may be controlled to have fewer than some threshold number of particles larger than 0.3 or 0.5 μm. The supporting zone may permit a greater number of such particles up to a second, larger predetermined threshold. The viable particulate concentration in various zones may be controlled to differing levels. The degree of unidirectionality of airflow in each zone may also differ. The speed of air flowing through the various zones may differ. For example, a high velocity may be present in the first zone while a slower velocity (e.g. 0.45 m/s+/−20%) may be maintained in the supporting zone. The pressure within each zone may be controlled to differing set points as well. For example, the more stringent zone (e.g. the first zone) may be at a higher pressure (at least 5 Pa) than an adjacent, less stringently controlled zone. The pressure delta and flow rate out of the more stringently control zone may be sufficient to establish an aerodynamic boundary. The number of air exchanges per unit time may differ between zones. Set points for any environmental control characteristics may be taken from an ISO clean room standard. At least some set points for the first zone may be borrowed from an ISO 5 standard while at least some set points for the supporting zone may be borrowed from an ISO 7 standard. The first zone may, for example, conform to particulate standards for an ISO 5 cleanroom and the supporting zone may comply with particle standards for an ISO 7 cleanroom.

Though each zone within the processing chamber 4300 may receive air from the supply plenum 6228, the shape of the bore 3097 of the clean air output 3090 may engender a different pressure and flowrate therethrough. Thus, the airflow channel 2802 of the cartridge 2606 may be maintained at a more stringent level of environmental control despite being in fluid communication with the supporting zone.

The first zone and supporting zone may be merged into a single zone in certain scenarios. For example, when a cartridge 2606 is replaced, the entire volume of the processing chamber 4300 may be merged into a single zone of environmental control. The entirety of the processing chamber 4300 may be maintained at or substantially at the level of stringency of the first zone. When a cover 2992 (see, e.g., FIG. 94) is removed from a new cartridge 2606, the airflow channel 2802 may be exposed, but be out of contact with the clean air output 3090. To support exposure of a space which would otherwise be part of the less stringently controlled supporting zone, the whole processing chamber 4300 may be held at the control stringency of the first zone. The clean air output 3090 may then be actuated into contact with the airflow channel 2802 of the cartridge 2606 (further described in relation to FIG. 96). The first and supporting zones may then diverge to different levels of environmental control.

The processing chamber 4300 may include at least one pressure sensor 6320 and at least one particulate sensor 6322 in data communication with the control system 15. The control system 15 may compare the pressure sensor 6320 output to the pressure data from the post filter pressure sensor 6314 in the controlled environment supply plenum 6228. In the event that the pressure drop indicated by the data from the pressure sensor 6320 and the post filter pressure sensor 6314 is outside of a predefined expected range, the control system 15 may trigger a fault. Further use of the system 10 may be prohibited. In the event that data from the particulate sensor 6322 indicates particulate levels above a predetermined threshold, the control system 15 may similar generate a fault and prohibit further use of the system 10.

Still referring to FIGS. 198-199 and FIG. 200C, air may also pass from the supply plenum 6228 to a transfer chamber plenum 6242 via a diversion valve assembly 6240. The diversion valve assembly 6240 may be actuated to adjust the amount of airflow which passes from the supply plenum 6228 to the transfer chamber plenum 6242. The diversion valve assembly 6240 may also be actuated to a sealing state which isolates the supply plenum 6228 from the transfer chamber plenum 6242. That is, the diversion valve assembly 6240 may be actuated to a state in which it establishes an aerodynamic boundary between its inlet and outlet. In the sealing state, the flowrate of air through the diversion valve assembly 6240 may be very rapid (e.g. 6 m/s) such that the diversion valve assembly 6240 inhibits any fluid communication from the transfer chamber plenum 6242 to the supply plenum 6228.

A pressure sensor 6324 and a particulate sensor 6326 may be provided in the transfer chamber plenum 6242. Each may be in data communication with the control system 15. The control system 15 may monitor the signal output by the particulate sensor 6326. In the event the data signal is indicative that particulate levels in the transfer chamber plenum 6242 have breached a predefined threshold, the control system 15 may generate a fault. Further operation of the system 10 may be inhibited. The diversion valve assembly 6240 may be actuated by the control system 15 based at least in part on the data from the pressure sensor 6324 in the transfer chamber plenum 6242 and other pressure sensors (e.g. 6316, 6320, 6324) in the air handing assembly 6200.

From the transfer chamber plenum 6242, air may flow into the transfer chamber 3506 through at least one transfer chamber diffusion grid 6244. The transfer chamber diffusion grid 6244 may be a perforated panel which establishes a pressure drop between the transfer chamber plenum 6242 and the transfer chamber 3506 (at least when the environment in the transfer chamber 3506 is controlled to certain set points). In some examples, the transfer chamber diffusion grid 6244 may be arranged to be a turbulent kinetic energy dampener and include an array of channels similar to the laminarizers 6218, 6222.

A pressure sensor 6330 and a particulate sensor 6332 may be in communication with the transfer chamber 3506. Each may be in data communication with the control system 15. The control system 15 may monitor the pressure delta between the transfer chamber plenum 6242 and the transfer chamber 3506. In the event that the pressure delta is outside of a predefined range, the control system 15 may generate a fault. The control system 15 may also inhibit further operation of the system 10. The output from the particulate sensor 6332 may also be monitored and compared against a predefined threshold by the control system 15. In the event that the data signal from the particulate sensor indicates particulate levels are in breach of the predefined threshold, the control system 15 may generate a fault. Further operation of the system 10 may be prohibited.

When the door 4702 between the transfer chamber 3506 and the outfeed chamber 4202 is opened, the environment within the transfer chamber 3506 may be uncontrolled. The diversion valve assembly 6240 may be adjusted to establish and maintain a control zone within the transfer chamber 3506 when the transfer chamber 3506 is isolated from the outfeed chamber 4202. In some examples, the transfer chamber 3506 may be brought to a level of environmental control substantially equivalent to the supporting zone in the processing chamber 4300. The transfer chamber 3506 may be held at this level of environmental control for a period of time before the control system 15 permits the door 4700 between the transfer chamber 3506 and the processing chamber 4300 to be opened. This period of time may be referred to herein as a recovery period. The recovery period may ensure that the transfer chamber 3506 is flushed with air and at a desired level of environmental control after exposure to the outfeed chamber 4202. The door actuator for door 4700 may be commanded to open the door 4700 relatively slowly. This may help to ensure minimal disruption of airflow unidirectionality. In some embodiments, the door 4700 may be opened at a rate of less than 15° per second (e.g. 10-8°/sec or less).

Referring now to FIGS. 198-199 and FIGS. 200D-E, air may pass through the processing chamber 4300 and transfer chamber 3506 and exit the chambers 4300, 3506 via respective exhaust gridding 6234, 6246. The exhaust gridding 6234, 6246 for each chamber or compartment may be perforated panels which establishes a pressure drop between the compartments and downstream exhaust chambers 6236, 6248.

Referring now to FIGS. 198-199 and FIGS. 200F, the exhaust chamber 6236 for the processing chamber 4300 may be partitioned from the exhaust chamber 6248 for the transfer chamber 3506. This may ensure that no communication between the two exhaust chambers 6236, 6248 is possible. Thus, a high pressure in one exhaust chamber 6236, 6248 would not cause air to backflow through the exhaust gridding 6234, 6246 in the other of the exhaust chambers 6236, 6248.

A pressure sensor 6328, 6334 may be in communication with each of the exhaust chambers 6236, 6248. The control system 15 may monitor an output signal from each pressure sensor 6328, 6334. These signals may be compared respectively to the output of the pressure sensors 6320, 6330 in the processing compartment 4300 and the transfer chamber 3506. The control system 15 may verify that a predefined expected pressure drop is present through the respective exhaust gridding 6234, 6246 associated with each exhaust chamber 6236, 6248. In the event that the pressure drop is less than the predefined expected amount, the control system 15 may generate a fault. The control system 15 may prohibit further operation of the system 10.

Each of the exhaust chambers 6236, 6248 may include at least one leak sensor 6338, 6340 in data communication with the control system 15. The leak sensors 6338, 6340 may, for example, be pairs of electrodes in certain examples. The leak sensors 6338, 6340 may be placed in a low point in the exhaust chambers 6236, 6248. In the event that liquid is present, the control system 15 may generate a fault and may require a service event before permitting further operation of the system 10. The outfeed chamber 4202 may include a catch tray, plate, or other guard positioned at the bottom of the compartment. The outfeed chambers 4202 may similarly include one or more leak sensor.

Air may flow through the processing compartment exhaust chamber 6236 to at least exhaust filter 6238A, B (two are shown). Air may flow through the transfer exhaust chamber 6248 to at least one exhaust filter 6250. Air exiting the exhaust filters 6238A, B, 6250 may pass into the outfeed compartment 4202 or another portion of the enclosure 12. This air may also be recirculated within the enclosure 12 and drawn back into the pre-filter 6204.

Various alternatives and modifications can be devised by those skilled in the art without departing from the disclosure. Accordingly, the present disclosure is intended to embrace all such alternatives, modifications and variances. Additionally, while several embodiments of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. And, those skilled in the art will envision other modifications within the scope and spirit of the claims appended hereto. Other elements, steps, methods and techniques that are insubstantially different from those described above and/or in the appended claims are also intended to be within the scope of the disclosure.

The embodiments shown in drawings are presented only to demonstrate certain examples of the disclosure. And, the drawings described are only illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B.

Furthermore, the terms “first”, “second”, “third” and the like, whether used in the description or in the claims, are provided for distinguishing between similar elements and not necessarily for describing a sequential or chronological order. It is to be understood that the terms so used are interchangeable under appropriate circumstances (unless clearly disclosed otherwise) and that the embodiments of the disclosure described herein are capable of operation in other sequences and/or arrangements than are described or illustrated herein.

What is claimed is:

1. A multi-compartment reservoir for medical agent comprising:
a first and second wall sealed to one another at a peripheral seal to define an interior volume of the reservoir;
a first port and a second port coupled into the peripheral seal, each of the first port and second port defining an interior flow path in communication with the interior volume, each of the first port and second port having a set of projections extending therefrom and at least partially surrounding the respective port;
a first compartment in fluid communication with the ports, the first compartment being collapsed and devoid of contents;
a second compartment containing a concentrate; and
a frangible partition separating the first and second compartment, first and second sheet being coupled together to form the frangible partition, the frangible portion being curved such that a central region of the frangible partition is most distal to the portion of the peripheral seal into which the first and second port are coupled.

2. The reservoir of claim 1, wherein the portion of the frangible partition most distal the peripheral seal into which the first and second port are coupled is disposed 5-40% of the length of the reservoir from the peripheral seal into which the ports are coupled.

3. The reservoir of claim 1, wherein a capacity of the second compartment is greater than a volume of the concentrate disposed in the second compartment.

4. The reservoir of claim 1, wherein the second compartment is filled with an at least partially liquid concentrate.

5. The reservoir of claim 4, wherein the at least partially liquid concentrate is selected from a list consisting of saline brine, sodium chloride brine, sugar solution, dialysate concentrate, sugar and saline solution, Ringer's solution concentrate, lactated Ringer's solution concentrate, Hartmann's solution concentrate, saturated solution, supersaturated solution, and unsaturated solution.

6. The reservoir of claim 1, wherein the second compartment is filled with a solid concentrate.

7. The reservoir of claim 6, wherein the solid concentrate is a concentrate for a solution selected from a list consisting of a saline solution, a sugar solution, a saline and sugar solution, normal saline, half normal saline, D5 W, peritoneal dialysate, hemodialysis dialysate, Ringer's solution, lactated Ringer's solution, Hartmann's Solution, hypotonic solution, isotonic solution, and hypertonic solution.

8. The reservoir of claim 6, wherein the solid concentrate is selected from a list consisting of, powder, lyophilized medical agent, crystalline concentrate, salt concentrate, sodium chloride concentrate, sugar concentrate, dextrose concentrate.

9. The reservoir of claim 1, wherein the projections in each set of projections are ribs.

10. The reservoir of claim 1, wherein the set of projections extending from each port includes at least one first projection and at least one second projection, the at least one second projection offset from the at least one first projection along an axial dimension of the port.

11. The reservoir of claim 1, wherein the set of projections extending from the first port are monolithically formed with the first port and the second of projections extending from the second port are monolithically formed with the second port.

12. The reservoir of claim 1, wherein the set of projections on each of the first port and the second port are included on a ribbing clip coupled to the first and second port.

13. The reservoir claim 1, wherein the set of projections on each of the first port and the second port are included on sets of ribbed rings coupled to each of the first and second ports.

14. The reservoir of claim 1, wherein the first and second port are formed of a rigid plastic.

15. The reservoir of claim 1, wherein the first port includes a septum disposed in an end of the port most distal the interior volume and the second port includes a stopper with a spike receptacle, the stopper disposed in an end of the port most distal the interior volume.

16. The reservoir of claim 1, wherein one of the first wall includes a pocket formed in the portion of the wall defining the second compartment, the pocket having a depth, a depth dimension of the pocket being substantially perpendicular to the second wall.

17. The reservoir of claim 1, wherein the reservoir further comprises a third compartment at an end of the reservoir opposite the first and second port, the third compartment being segregated from the second compartment by another frangible partition, the third compartment being collapsed and devoid of content.

18. The reservoir of claim 1, wherein the peripheral seal includes a first thickened region on one side of the reservoir and a second thickened region on an opposing side of the reservoir, the frangible partition extending from the first thickened region to the second thickened region.

19. A multi-compartment reservoir for medical agent comprising:
a first and second wall sealed to one another at a peripheral seal to define an interior volume of the reservoir;
a first port and a second port each formed of rigid material and defining an interior flow path in communication with the interior volume, each of the first port and second port having sets of integrally formed ribs extending therefrom and spaced apart along the axial dimension of the respective port, each set of ribs including a first rib and a second rib extending outwardly from opposing sides of the respective port, each of the ribs at least partially surrounding the respective port, the set of ribs on each port most distal the peripheral seal having a smallest cross-sectional area of any set of ribs on the respective port, each port including a coupling region having a pair of opposing spine projections, each port coupled into the peripheral seal at the coupling region;
a septum coupled to an end of the first port most distal to the peripheral seal;
a removal closure coupled to an end of the second port most distal to the peripheral seal a first compartment in fluid communication with the ports, the first compartment being collapsed and devoid of contents;
a second compartment containing a concentrate; and
a frangible partition separating the first and second compartment, first and second sheet being coupled together to form the frangible partition, the frangible portion being curved such that a central region of the frangible partition is most distal to the portion of the peripheral seal into which the first and second port are coupled, the peripheral seal including a first thickened region and a second thickened region on opposing sides of the reservoir, the frangible partition extending from the first thickened region to the second thickened region; and
wherein the peripheral seal includes a marking region along a side of the peripheral seal into which the ports are coupled, the marking region being an island of unsealed first and second wall material which is surrounded by the peripheral seal on all sides.

20. An IV bag access port for coupling into a peripheral seal of an IV bag and providing a fluid communication pathway into the IV bag comprising:
a port body extending along a longitudinal access, the port body having a bore extending therethrough, the bore of the port body having an Ra surface roughness of no greater than 0.1 μm, the port body being formed of a rigid, injection molded polymer,
a set of wings extending outwardly from a coupling region on an exterior surface of the port body proximate a first end of the port body, the set of wings including a first wing and a second wing projecting from opposing sides of the coupling region, each wing defined by a first concavely curved surface and a second, opposing, concavely curved surface, the first and second concavely curved surfaces approaching one another as distance from the port body increases and being parallel to one another along a plane extending through the longitudinal axis, each of the wings being monolithically formed with the port body;
a first set of ribs monolithically formed with the port body, the first set of ribs including a first rib and a second rib, the first rib and second rib extending outwardly from opposite sides of the port body such that the first set of ribs are symmetric about a plane of symmetry extending through the longitudinal axis of the port body; and
a second set of ribs monolithically formed with the port body, the second set of ribs spaced apart from the first set of ribs along longitudinal axis of the port body such that the second set of ribs is most proximate a second end of the port body opposite the first end and the first set of ribs is most proximate the set of wings, the second set of ribs including a third rib and a forth rib extending outwardly from opposite sides of the port body such that the second set of ribs are symmetric about the plane of symmetry; and
one of a list consisting of a septum and a removable closure coupled to the second end of the port body; and
wherein each of the first set of ribs extend outwardly from the port body along respective first arcs and each of the second set of ribs extend outwardly from the port body along respective second arcs, the second arcs having a smaller arc length than the first arcs.
